(19) United States
(12) Patent Application Publication
(10) Pub. No.: US 2014/0006307 A1
(43) Pub. Date: Jan. 2, 2014

(54) Consistent Interface for Customer - Message Set 3

(71) Applicants: Torsten Buecheler, Speyer (DE); Matthias Becker, Bruchsal (DE); Oliver Berger, Walldorf (DE); Knut Heusermann, Bad Schoenbom (DE); Christian Hohmann, Mannheim (DE); Steffen Witt, Heidelberg (DE); Esther Landes, Woerth (DE); Thomas Witzel, St Leon Rot (DE); Martin Haerterich, Wiesloch (DE)

(72) Inventors: Torsten Buecheler, Speyer (DE); Matthias Becker, Bruchsal (DE); Oliver Berger, Walldorf (DE); Knut Heusermann, Bad Schoenbom (DE); Christian Hohmann, Mannheim (DE); Steffen Witt, Heidelberg (DE); Esther Landes, Woerth (DE); Thomas Witzel, St Leon Rot (DE); Martin Haerterich, Wiesloch (DE)

(73) Assignee: SAP AG

(21) Appl. No.: 13/535,670

(22) Filed: Jun. 28, 2012

(51) Int. Cl. G06Q 10/00

(52) U.S. Cl. 705/345

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a customer business object.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

Some details of the subject matter of this specification are described in previously-filed U.S. patent application Ser. No. 11/803,178, entitled “Consistent Set of Interfaces Derived From a Business Object Model”, filed on May 11, 2007, which is hereby incorporated by reference.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a computer-readable medium includes program code for providing a message-based interface for exchanging information about customers. The medium comprises program code for receiving, via a message-based interface exposing at least one service as defined in a service registry and from a heterogeneous application executing in an environment of computer systems providing message-based services, a first message for querying information about customer data using a query by identification. The first message includes a message package hierarchically organized as a customer by identification query sync message entity, a customer selection by identification package including a customer selection by identification entity, a processing conditions package including a processing conditions entity, and a requested elements package including a requested elements entity. The medium further comprises program code for sending a second message to the heterogeneous application responsive to the first message.

Implementations can include the following. The customer selection by identification entity includes at least one of the following: at least one selection by internal identifier, at least one selection by UUID, at least one selection by category code, at least one selection by business partner identifier, at least one selection by party identifier type code, at least one selection by business partner name, at least one selection by business partner additional name, at least one selection by sorting formatted name, at least one selection by life cycle status code, and a selection by search text. The requested elements entity includes a customer.

In another aspect, a distributed system operates in a landscape of computer systems providing message-based services defined in a service registry. The system comprises a graphical user interface comprising computer readable instructions, embedded on tangible media, for querying information about customer data using a query by identification, the instructions using a request. The system further comprises a first memory storing a user interface controller for processing the request and involving a message including a message package hierarchically organized as a customer by identification query sync message entity, a customer selection by identification package including a customer selection by identification entity, a processing conditions package including a processing conditions entity, and a requested elements package including a requested elements entity. The system further comprises a second memory, remote from the graphical user interface, storing a plurality of service interfaces, wherein one of the service interfaces is operable to process the message via the service interface.

Implementations can include the following. The first memory is remote from the graphical user interface. The first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIGS. 32-1 through 32-3 collectively depict an example Customer Bundle Maintain Request Sync message data type.

FIG. 33 depicts an example Customer Bundle Maintain Confirmation Sync message data type.

FIGS. 34-1 through 34-3 collectively depict an example Customer Bundle Maintenance Check Request Sync message data type.

FIG. 35 depicts an example Customer Bundle Maintenance Check Confirmation Sync message data type.

FIG. 36 depicts an example Customer By Communication Data Query Sync message data type.

FIGS. 37-1 through 37-3 collectively depict an example Customer By Communication Data Response Sync message data type.

FIG. 38 depicts an example Customer By Elements Query Sync message data type.

FIGS. 39-1 through 39-3 collectively depict an example Customer By Elements Response Sync message data type.

FIG. 40 depicts an example Customer By Identification Query Sync message data type.

FIGS. 41-1 through 41-3 collectively depict an example Customer By Identification Response Sync message data type.

FIGS. 42-1 through 42-65 collectively depict an example Customer Bundle Maintain Request Sync element structure.

FIGS. 43-1 through 43-2 collectively depict an example Customer Bundle Maintain Confirmation Sync element structure.

FIGS. 44-1 through 44-65 collectively depict an example Customer Bundle Maintenance Check Request Sync element structure.

FIGS. 45-1 through 45-2 collectively depict an example Customer Bundle Maintenance Check Confirmation Sync element structure.

FIGS. 46-1 through 46-17 collectively depict an example Customer By Communication Data Query Sync element structure.

FIGS. 47-1 through 47-52 collectively depict an example Customer By Communication Data Response Sync element structure.

FIGS. 48-1 through 48-28 collectively depict an example Customer By Elements Query Sync element structure.

FIGS. 49-1 through 49-52 collectively depict an example Customer By Elements Response Sync element structure.

FIGS. 50-1 through 50-15 collectively depict an example Customer By Identification Query Sync element structure.

FIGS. 51-1 through 51-52 collectively depict an example Customer By Identification Response Sync element structure.

FIGS. 52-1 through 52-3 collectively depict an example Customer object model.

### DETAILED DESCRIPTION

### A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

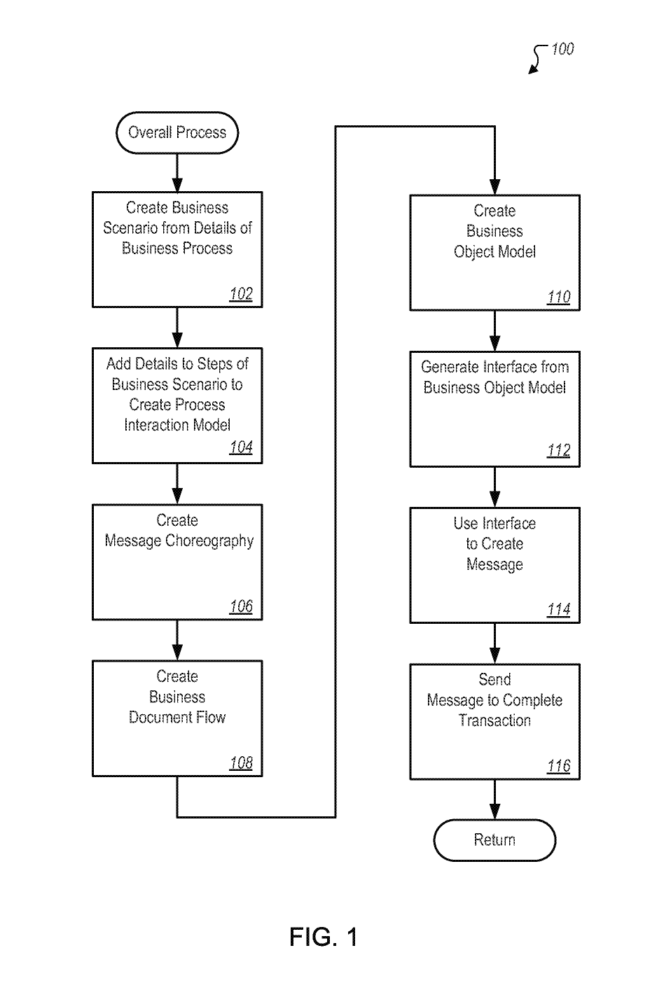

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

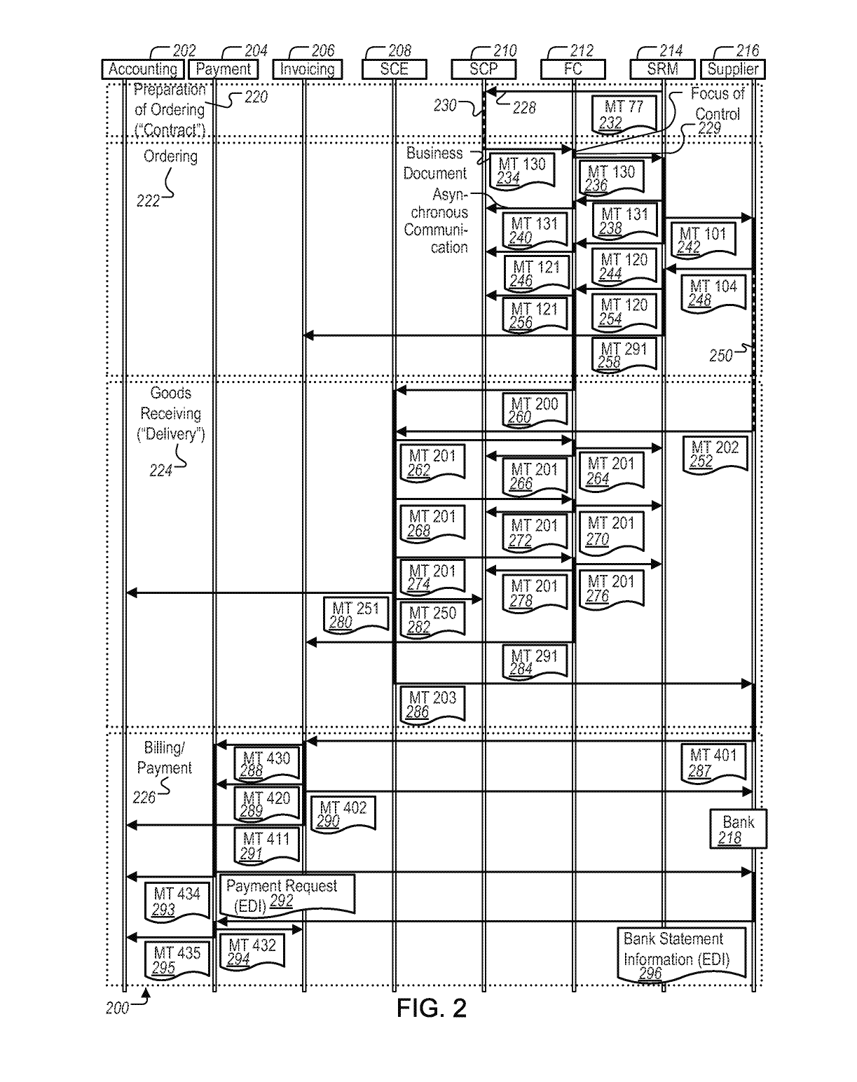

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

### B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

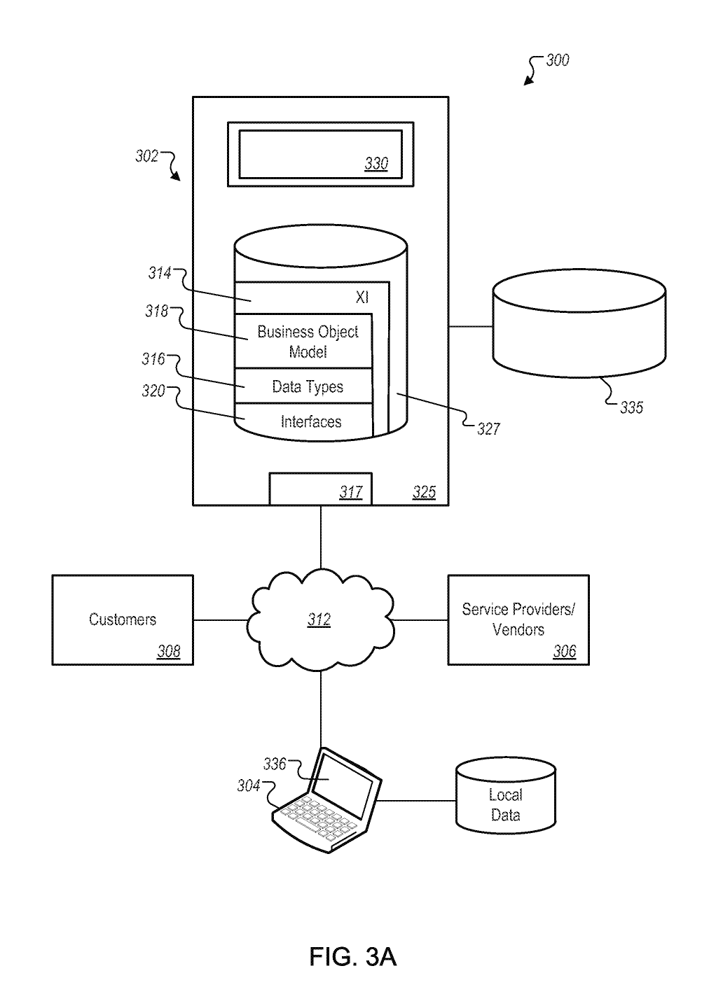

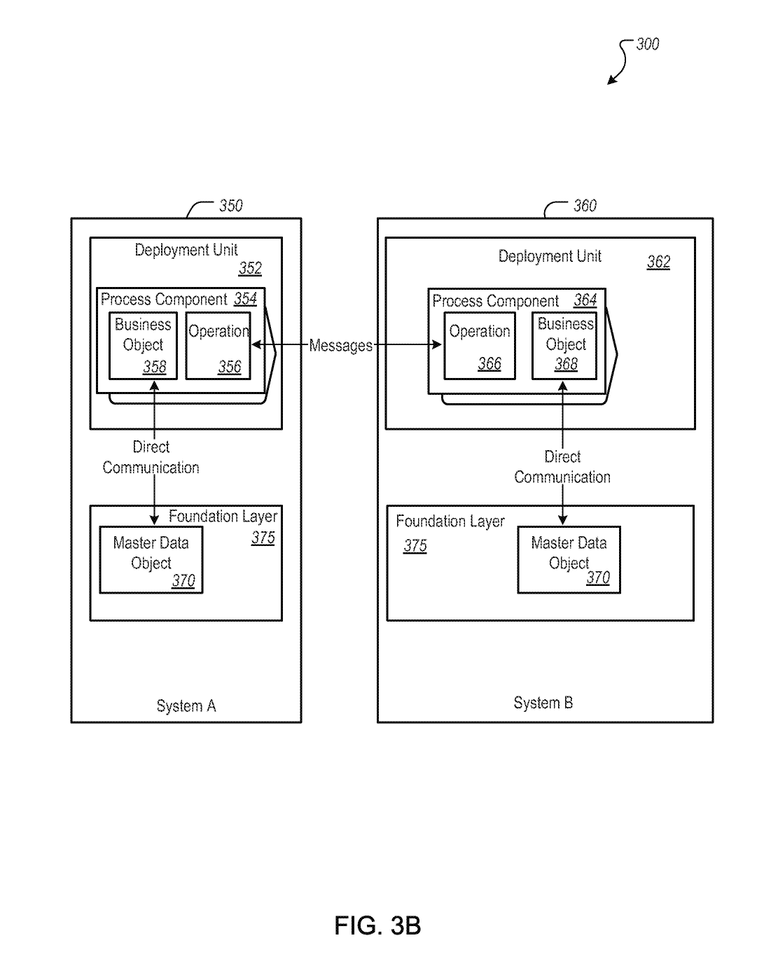

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

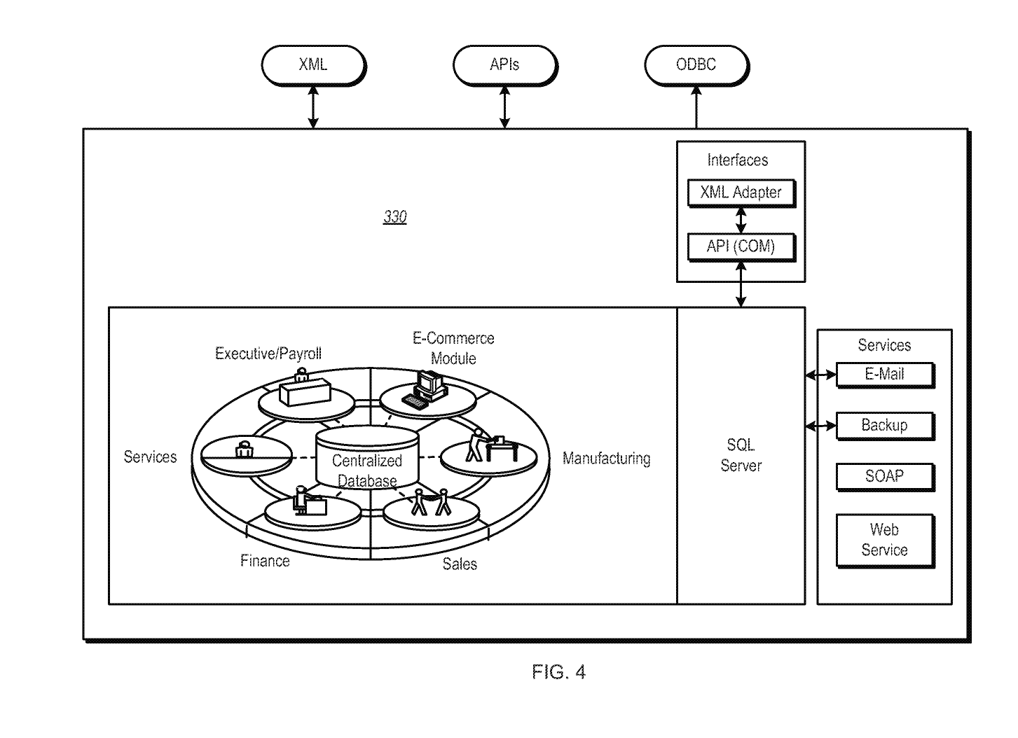

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

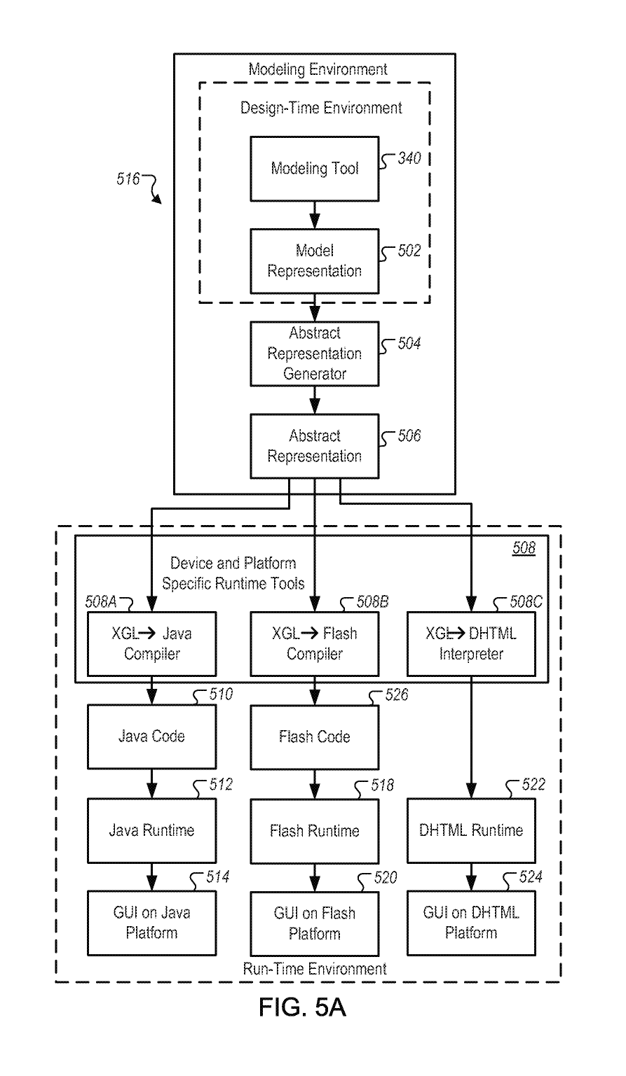

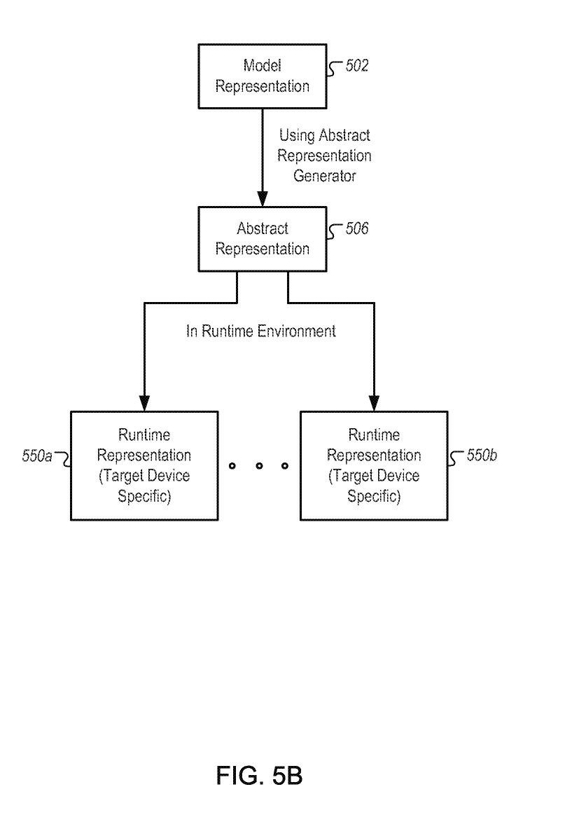

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

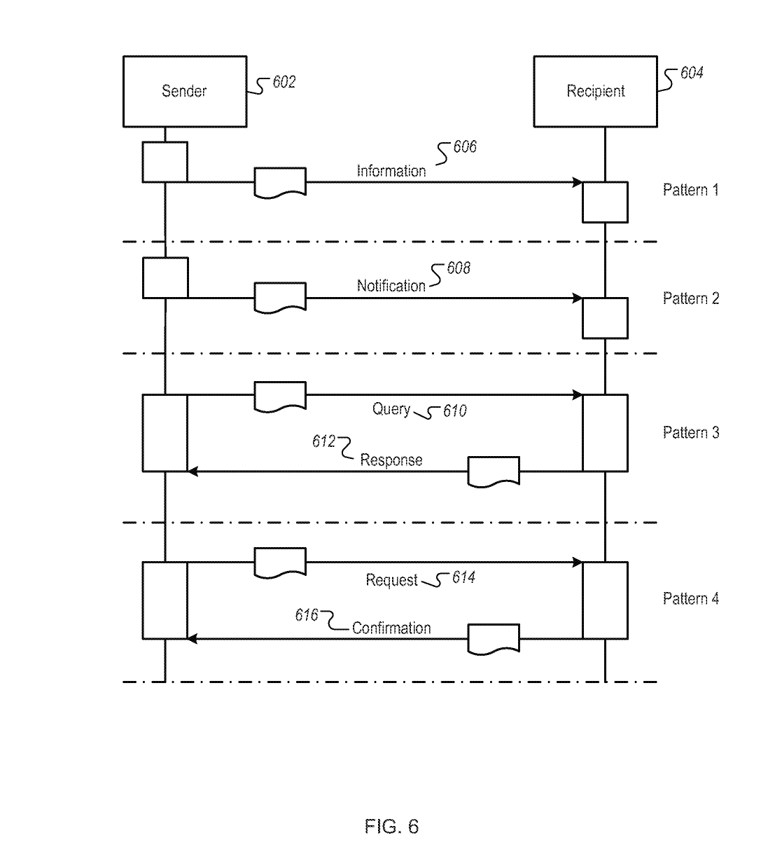

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

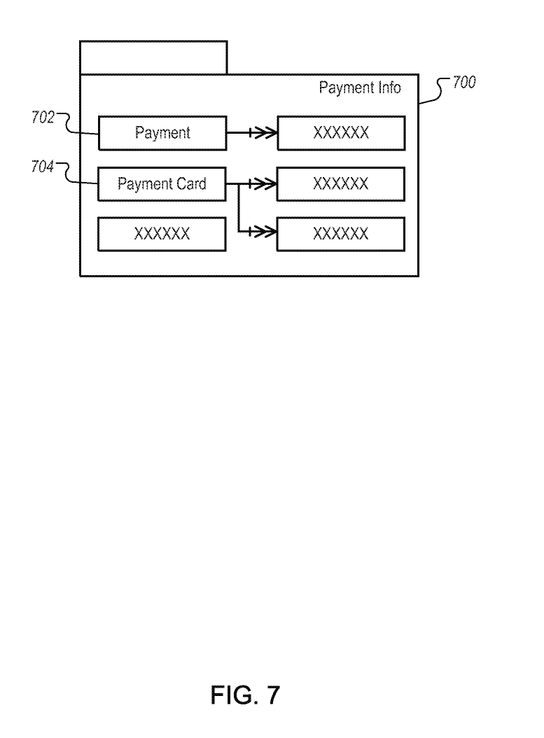

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

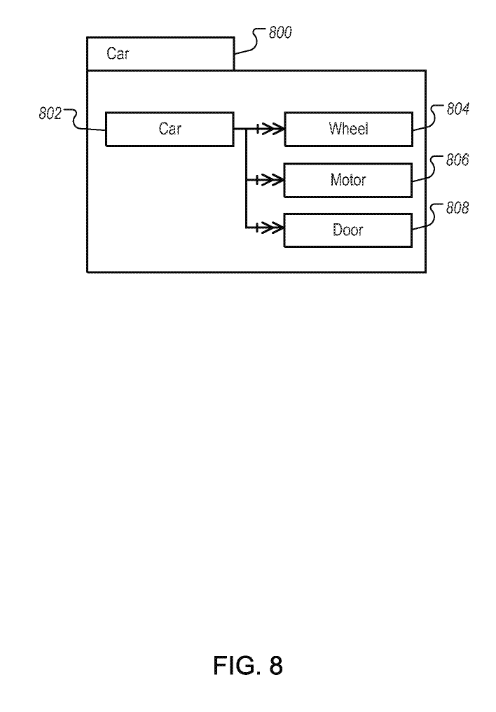

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

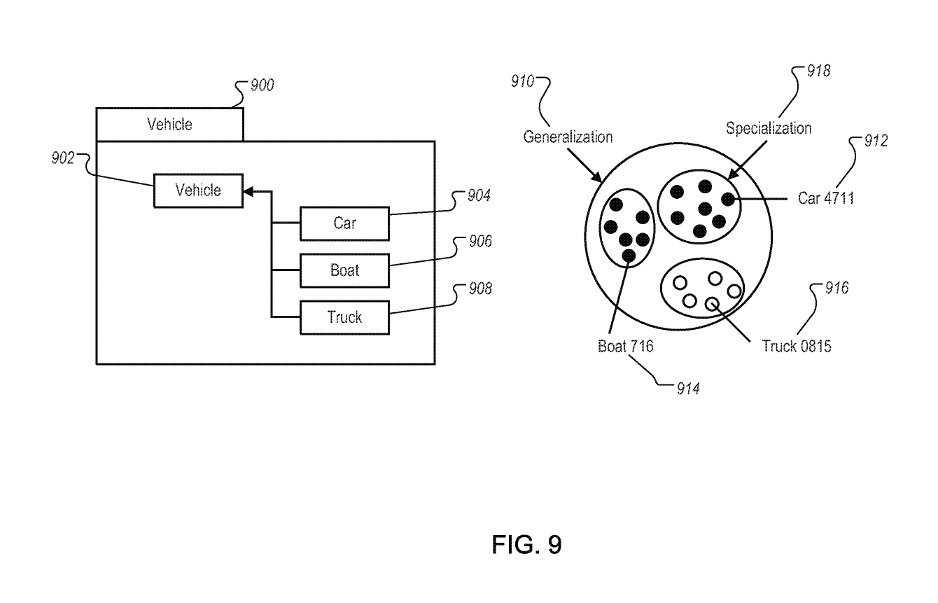

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

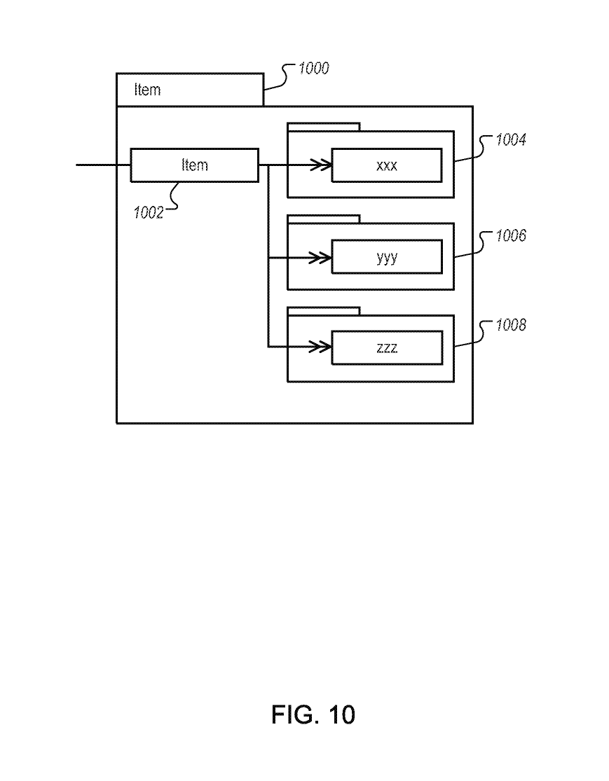

Packages also may be used to represent hierarchy levels. For example, as depicted in FIG. 10, the Item Package 1000 includes Item 1002 with subitem xxx 1004, subitem yyy 1006, and subitem zzz 1008.

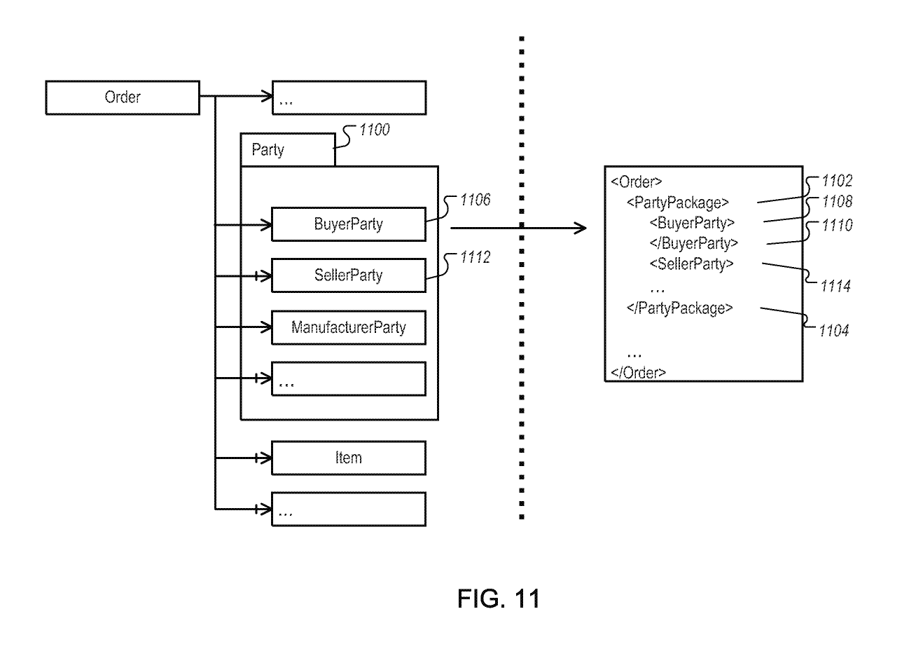

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

### (1) Cardinality of Relationships

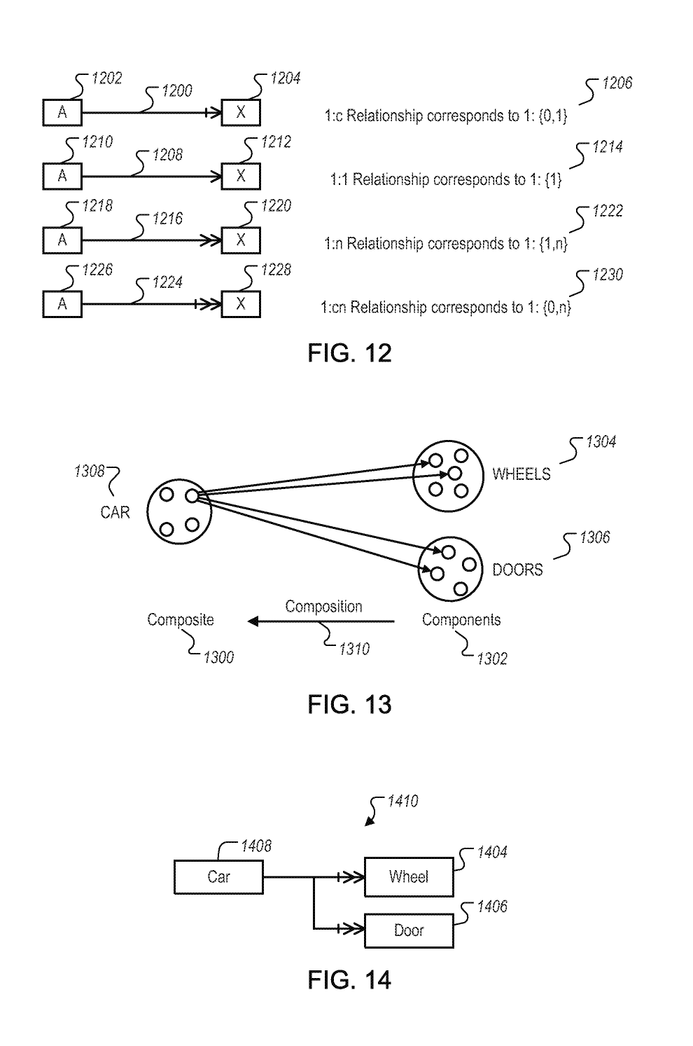

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

### (2) Types of Relationships

### (a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

### (b) Aggregation

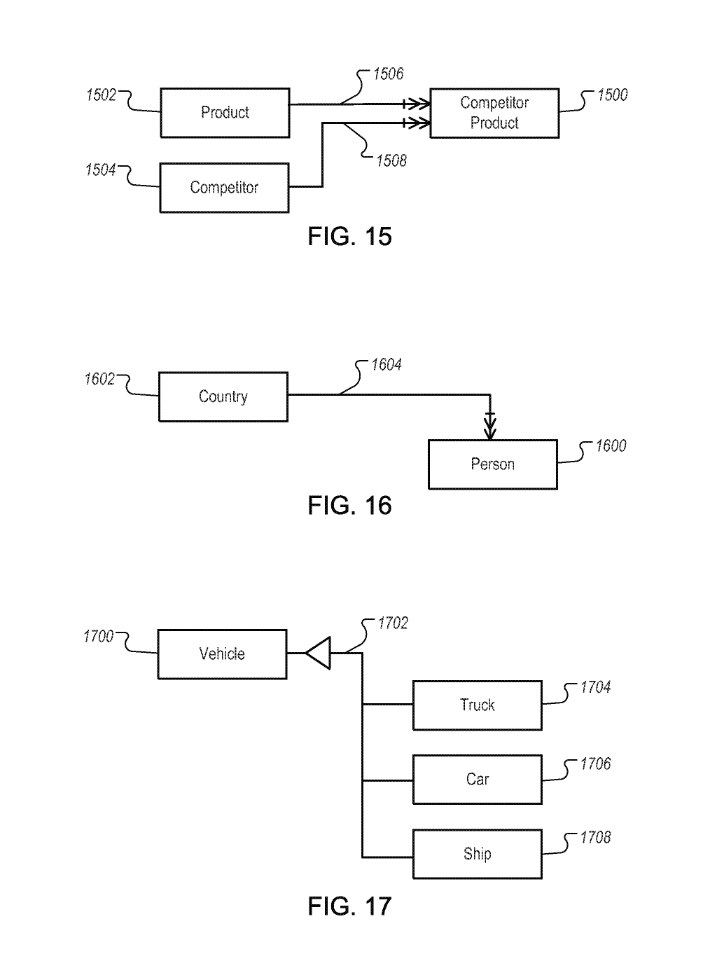

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

### (c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

### (3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

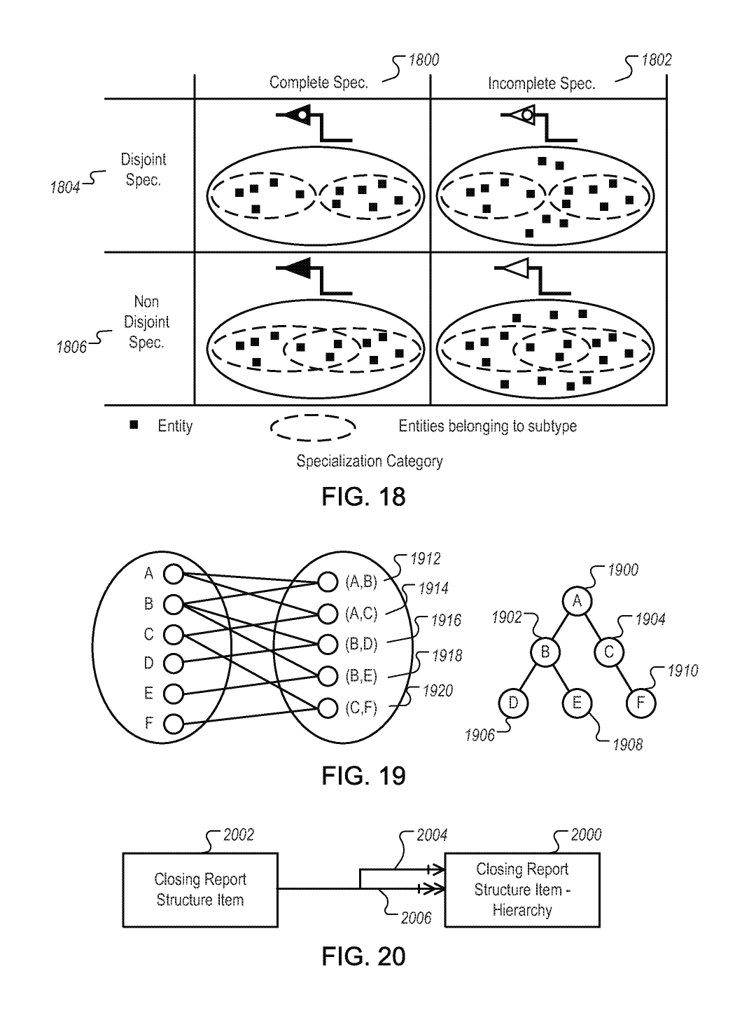

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

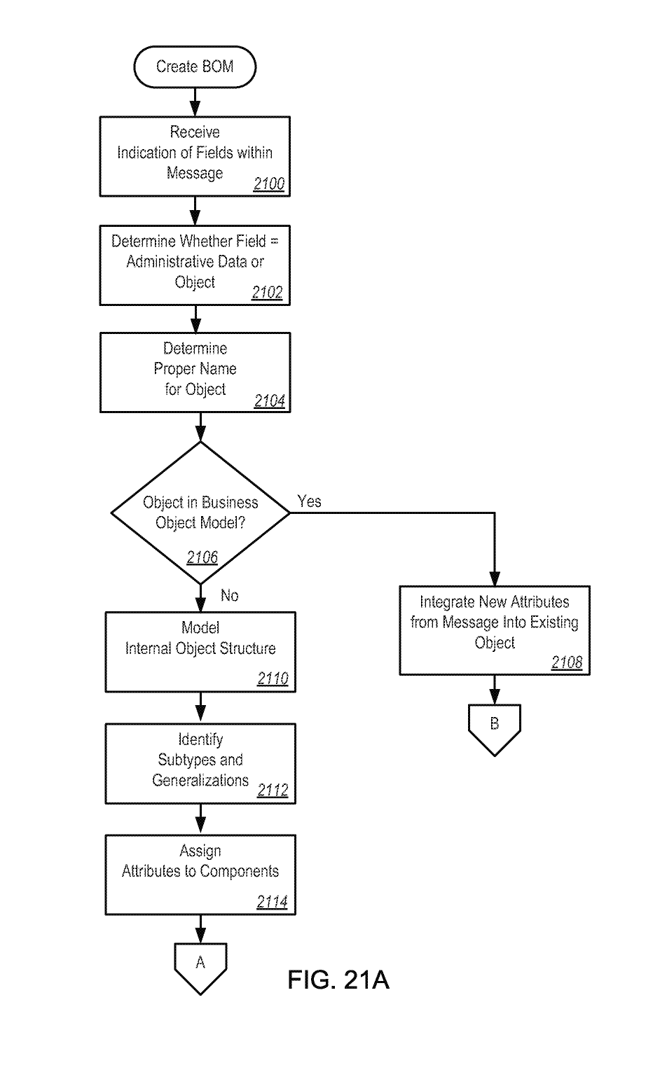

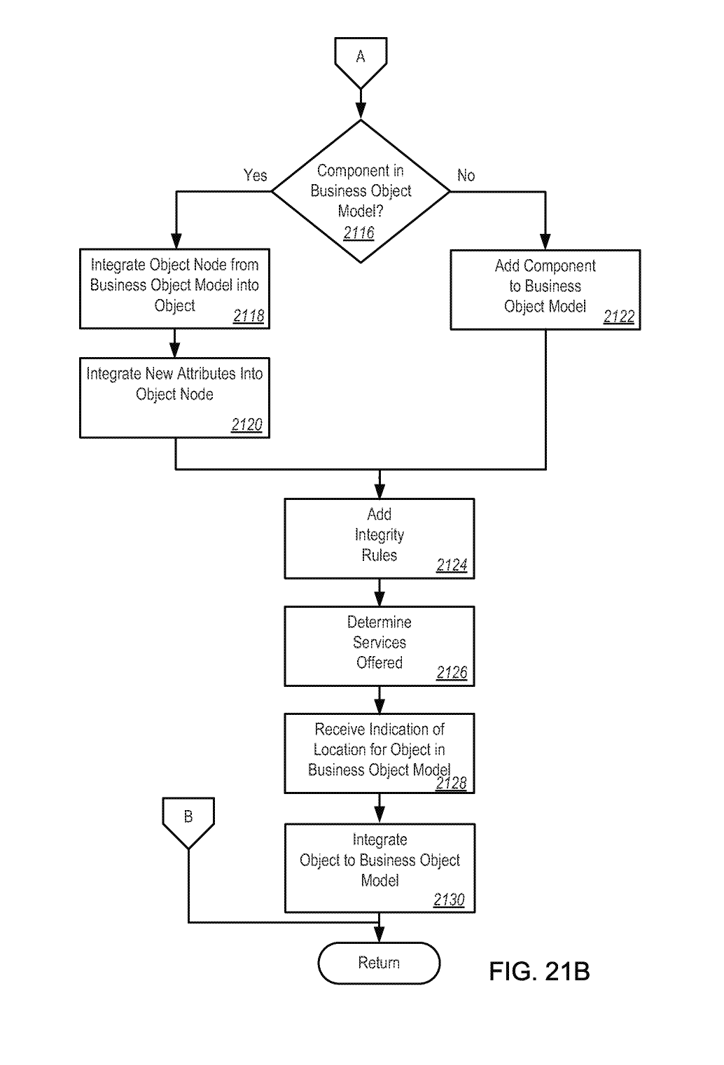

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | MainObject |
| AdditionalID | |
| PostingDate | |
| LastChangeDate | |
| AcceptanceStatus | |
| Note | |
| CompleteTransmissionIndicator | |
| Buyer | |
| BuyerOrganisationName | |
| PersonName | |
| FunctionalTitle | |
| DepartmentName | |
| CountryCode | |
| StreetPostalCode | |
| POBoxPostalCode | |
| CompanyPostalCode | |
| CityName | |
| DistrictName | |
| POBoxID | |
| POBoxIndicator | |
| POBoxCountryCode | |
| POBoxRegionCode | |
| POBoxCityName | |
| StreetName | |
| HouseID | |
| BuildingID | |
| FloorID | |
| RoomID | |
| CareOfName | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionofMessage | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| PersonName | |
| FunctionalTitle | |
| DepartmentName | |
| CountryCode | |
| StreetPostalCode | |
| POBoxPostalCode | |
| CompanyPostalCode | |
| CityName | |
| DistrictName | |
| POBoxID | |
| POBoxIndicator | |
| POBoxCountryCode | |
| POBoxRegionCode | |
| POBoxCityName | |
| StreetName | |
| HouseID | |
| BuildingID | |
| FloorID | |
| RoomID | |
| CareOfName | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | PurchaseOrder | | |
| AdditionalID | | | |
| PostingDate | | | |
| LastChangeDate | | | |
| AcceptanceStatus | | | |
| Note | | | |
| CompleteTransmissionIndicator | | | |
| Buyer | | Buyer | |
| BuyerOrganisationName | | | |
| PersonName | | | |
| FunctionalTitle | | | |
| DepartmentName | | | |
| CountryCode | | | |
| StreetPostalCode | | | |
| POBoxPostalCode | | | |
| CompanyPostalCode | | | |
| CityName | | | |
| DistrictName | | | |
| POBoxID | | | |
| POBoxIndicator | | | |
| POBoxCountryCode | | | |
| POBoxRegionCode | | | |
| POBoxCityName | | | |
| StreetName | | | |
| HouseID | | | |
| BuildingID | | | |
| FloorID | | | |
| RoomID | | | |
| CareOfName | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | DeliveryTerms | |
| DeliveryPriority | | | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionofMessage | | | |
| FollowUpActivity | | | |
| ItemID | | PurchaseOrderItem | |
| ParentItemID | | | |
| HierarchyType | | | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| PersonName | | | |
| FunctionalTitle | | | |
| DepartmentName | | | |
| CountryCode | | | |
| StreetPostalCode | | | |
| POBoxPostalCode | | | |
| CompanyPostalCode | | | |
| CityName | | | |
| DistrictName | | | |
| POBoxID | | | |
| POBoxIndicator | | | |
| POBoxCountryCode | | | |
| POBoxRegionCode | | | |
| POBoxCityName | | | |
| StreetName | | | |
| HouseID | | | |
| BuildingID | | | |
| FloorID | | | |
| RoomID | | | |
| CareOfName | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscountTerms | | | 0 . . . 1 |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | ConfirmationDescription | | | 0 . . . 1 |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| PurchaseOrder | | | | | 1 |
| | PurchaseOrderUpdate | | | | |
| | | PurchaseOrderRequest | | | |
| | | PurchaseOrderChange | | | |
| | | PurchaseOrder | | | |
| | | Confirmation | | | |
| | PurchaseOrderCancellation | | | | |
| | PurchaseOrderInformation | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscountTerms | | | | 0 . . . 1 |
| | | MaximumCashDiscount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipToLocation | | 0 . . . 1 |
| | | | ShipFromLocation | | 0 . . . 1 |
| | | DeliveryTerms | | | 0 . . . 1 |
| | | Attachment | | | 0 . . . n |
| | | Description | | | 0 . . . 1 |
| | | ConfirmationDescription | | | 0 . . . 1 |
| | | ScheduleLine | | | 0 . . . n |
| | | | DeliveryPeriod | | 1 |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase- | | | | 1 |
| Order | | | | |
| | ID | | | 1 |
| | SellerID | | | 0 . . . 1 |
| | BuyerPosting- | | | 0 . . . 1 |
| | DateTime | | | |
| | BuyerLast- | | | 0 . . . 1 |
| | ChangeDate- | | | |
| | Time | | | |
| | SellerPosting- | | | 0 . . . 1 |
| | DateTime | | | |
| | SellerLast- | | | 0 . . . 1 |
| | ChangeDate- | | | |
| | Time | | | |
| | Acceptance- | | | 0 . . . 1 |
| | StatusCode | | | |
| | Note | | | 0 . . . 1 |
| | ItemList- | | | 0 . . . 1 |
| | Complete- | | | |
| | Transmission- | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product- | | | 0 . . . 1 |
| | RecipientParty | | | |
| | VendorParty | | | 0 . . . 1 |
| | Manufacturer- | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo- | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom- | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

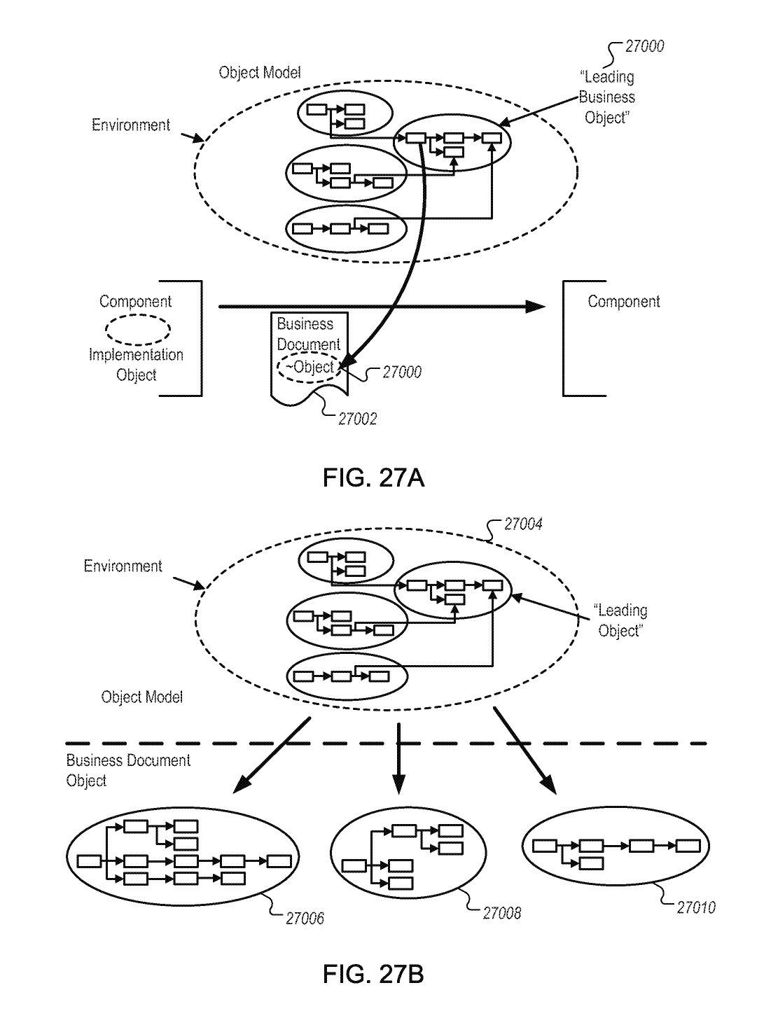

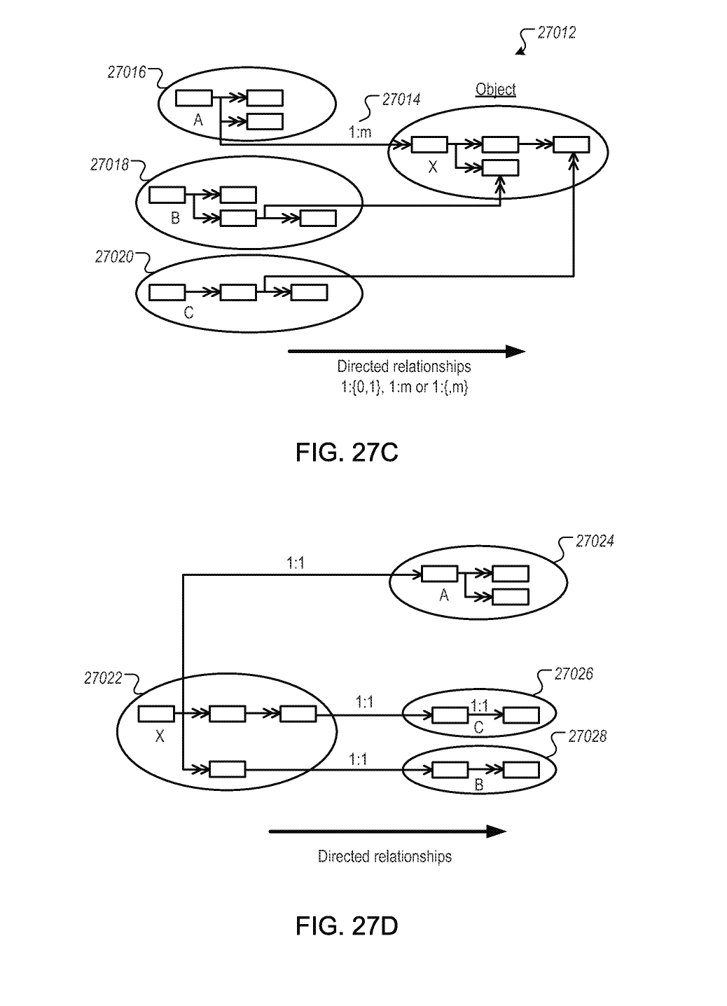

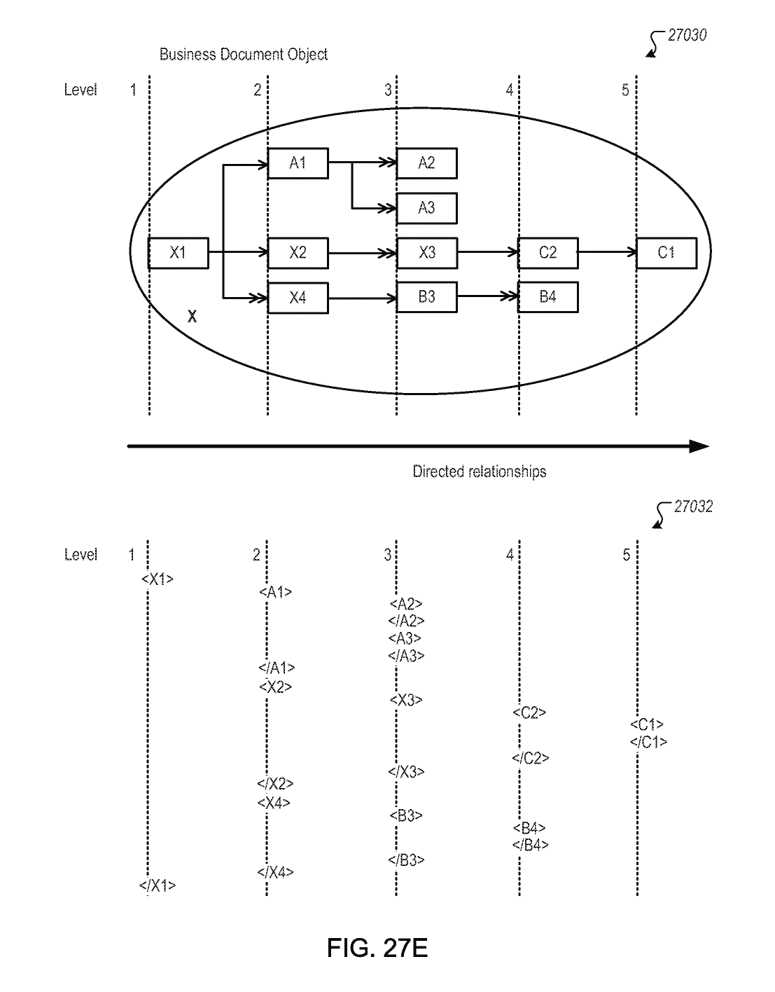

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

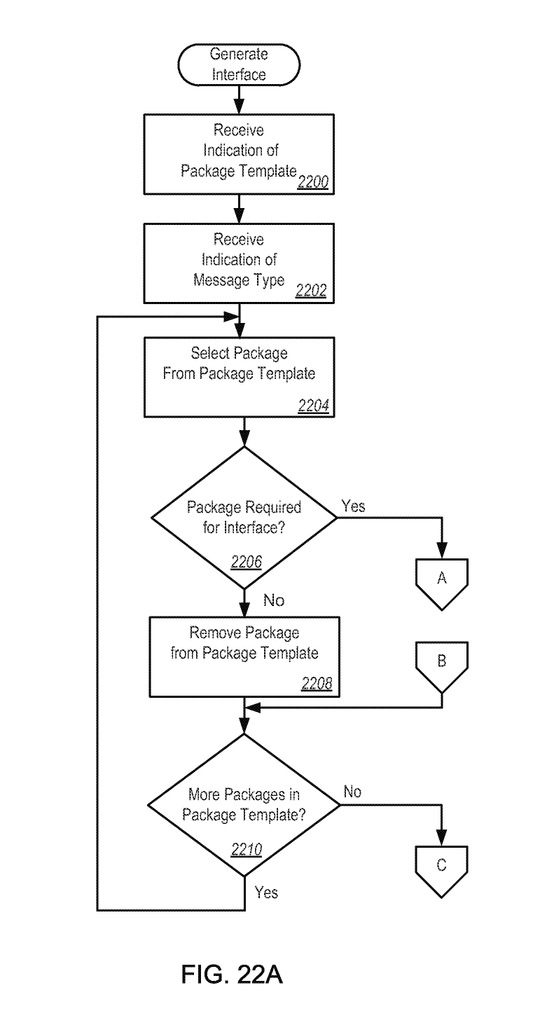

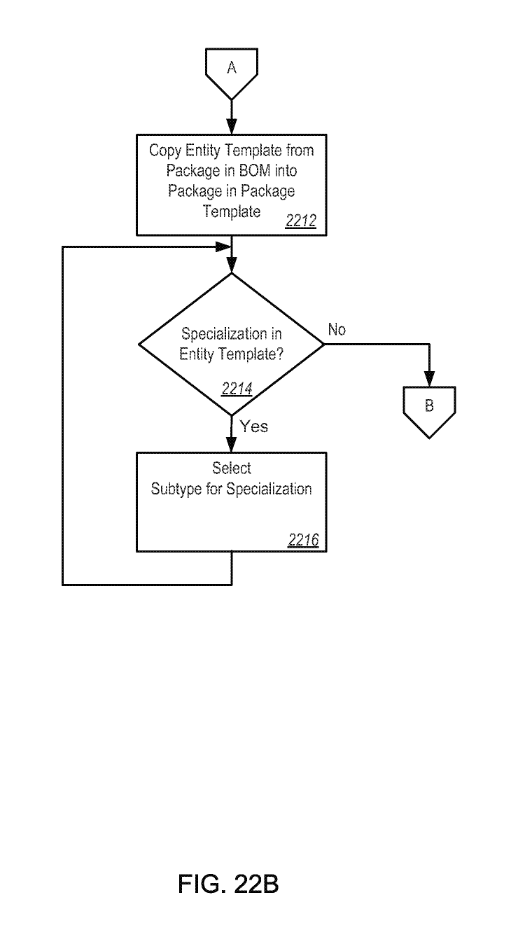

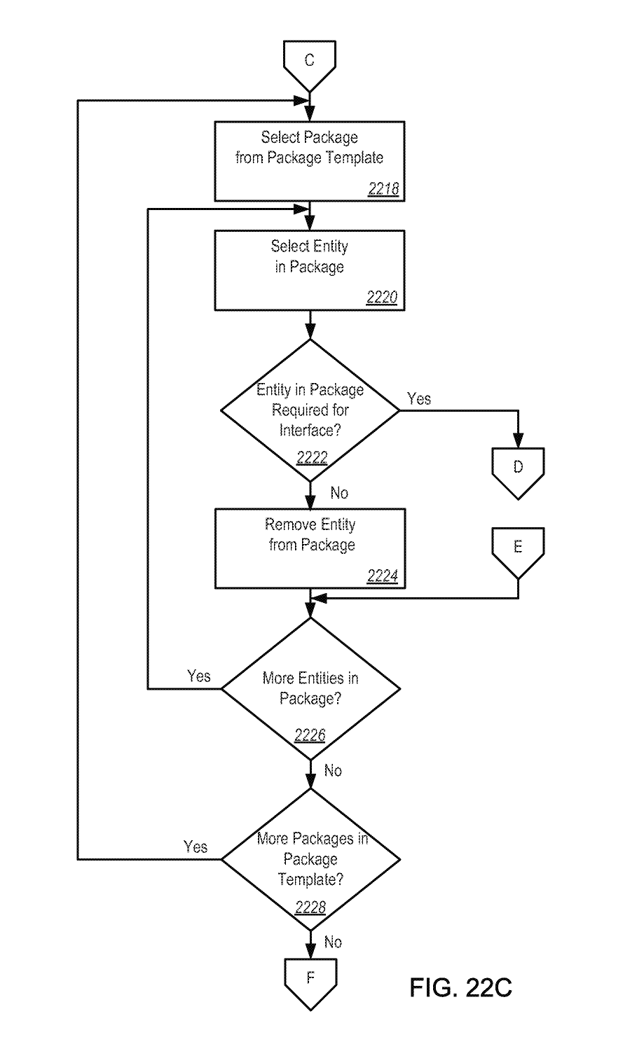

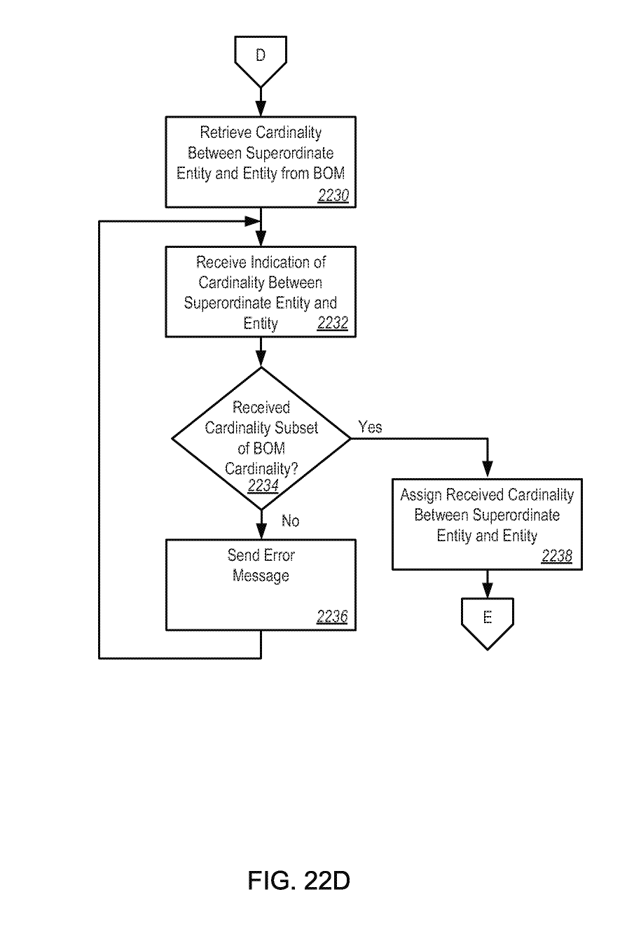

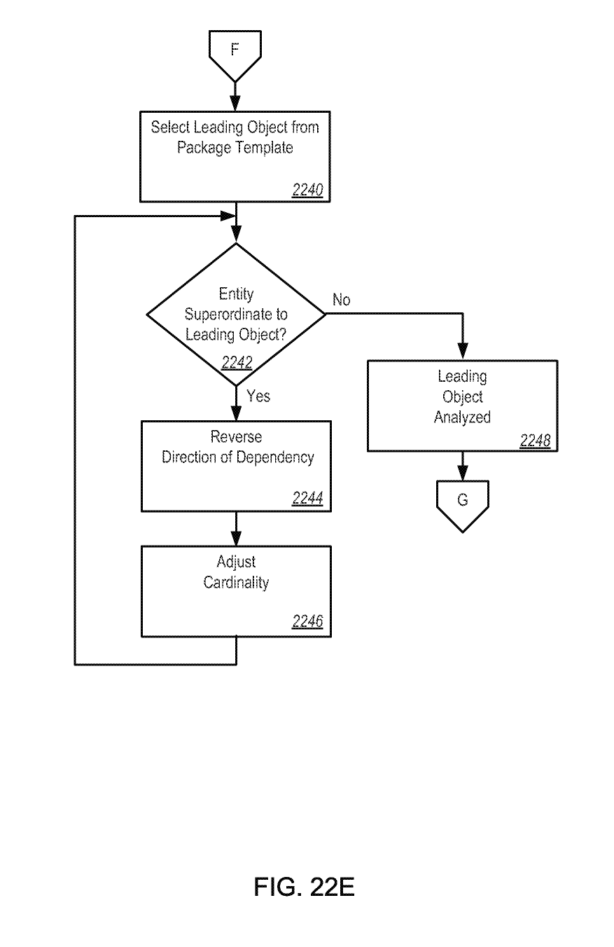

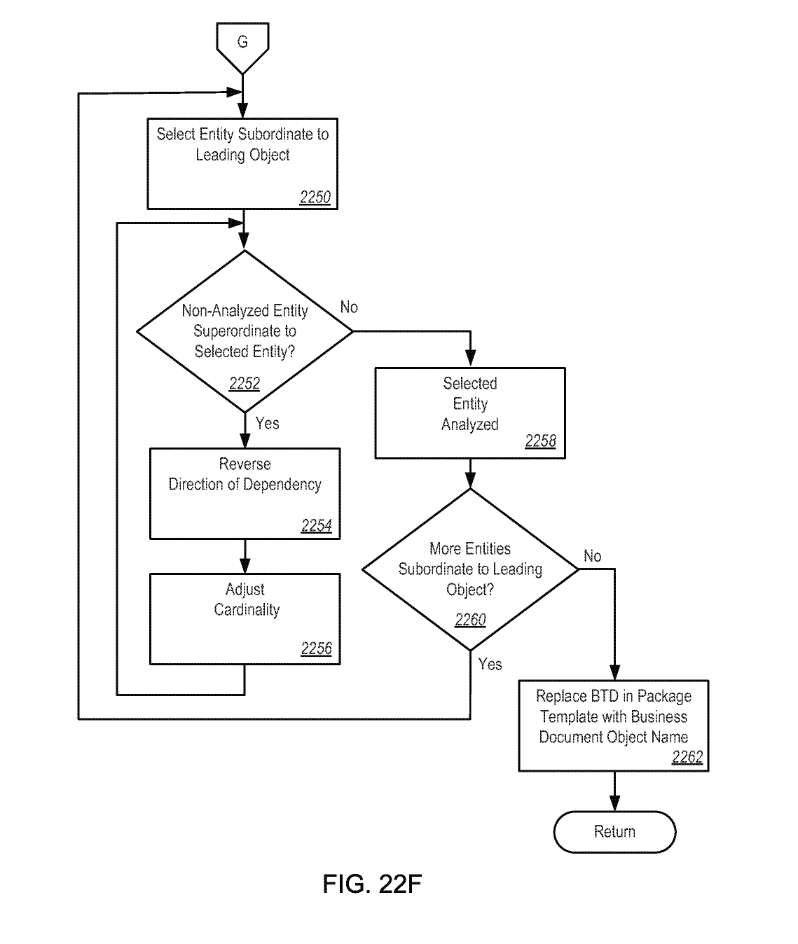

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

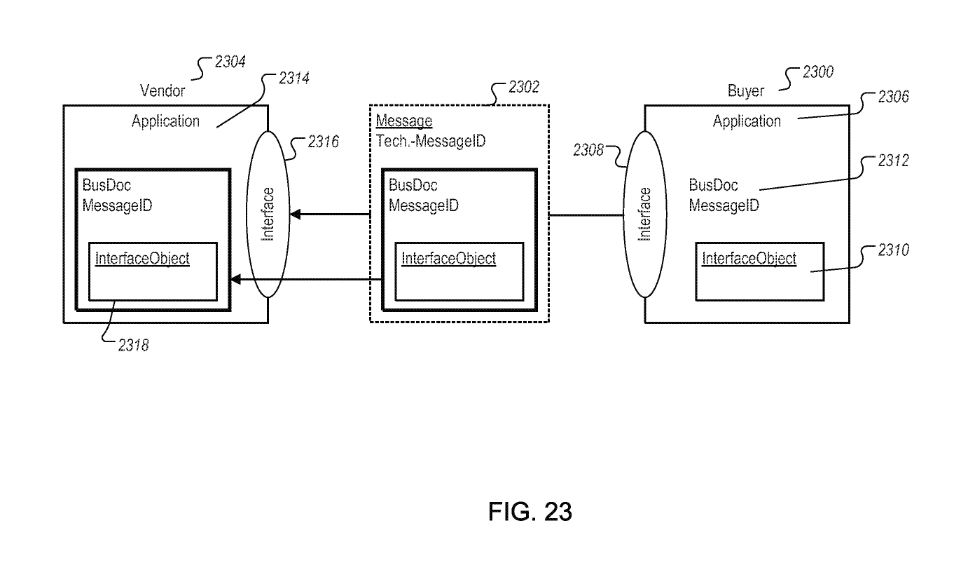

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

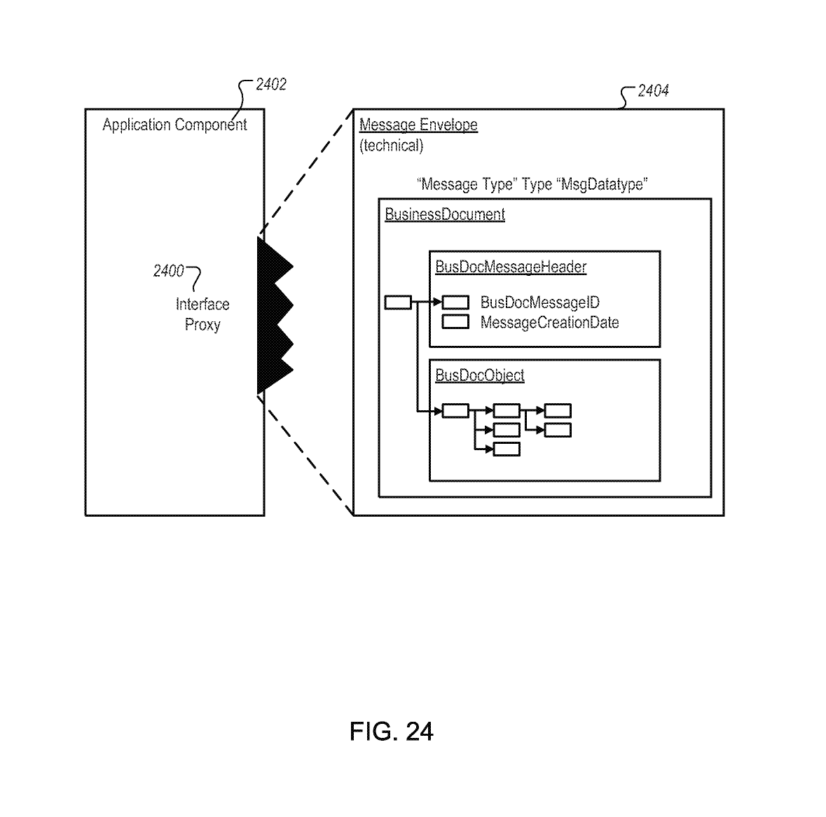

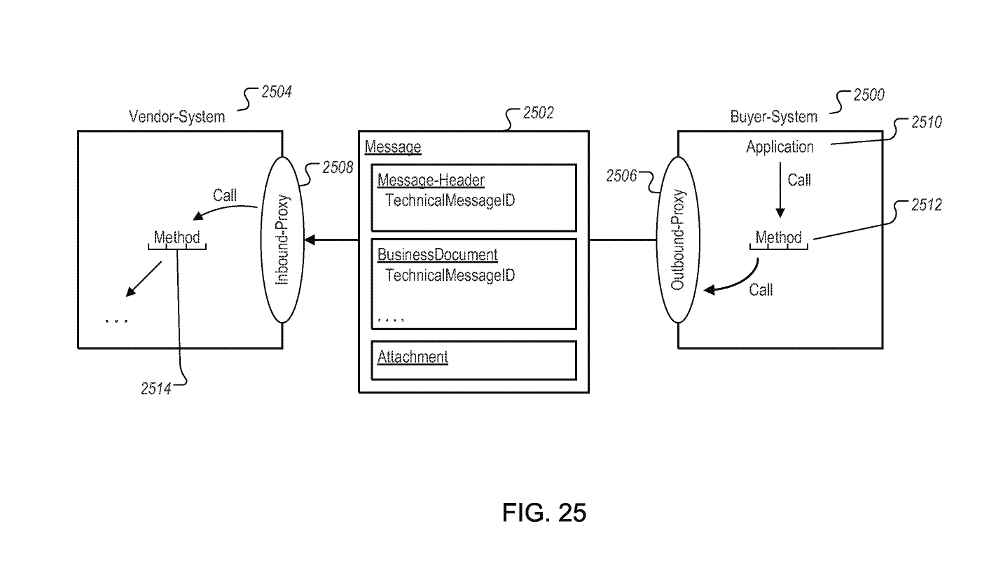

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

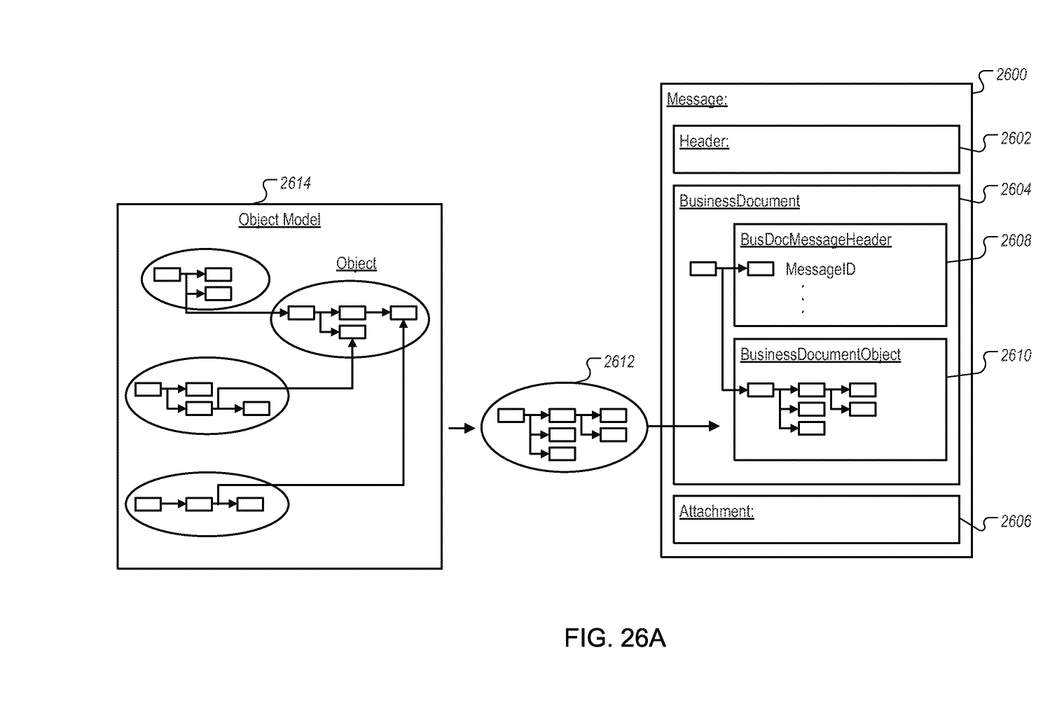

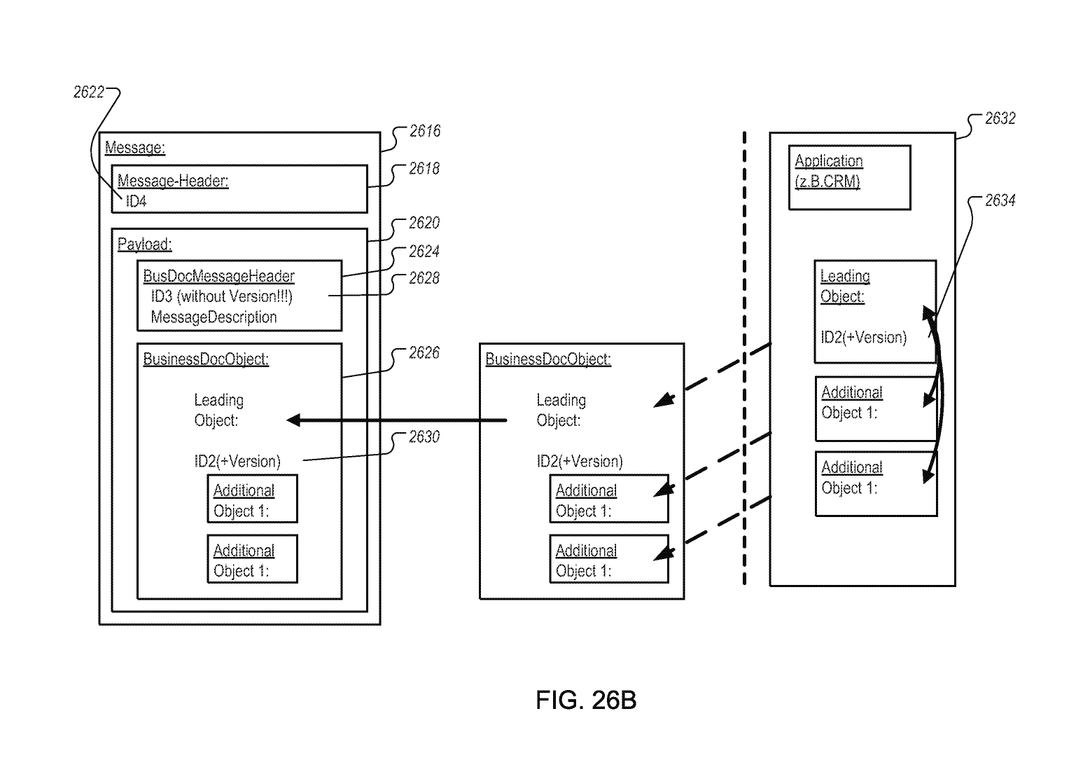

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

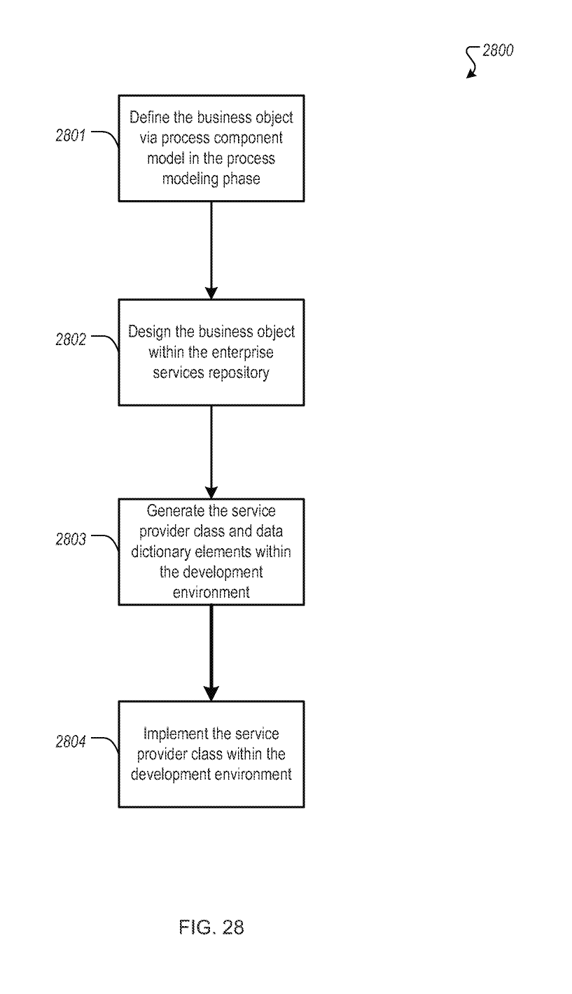

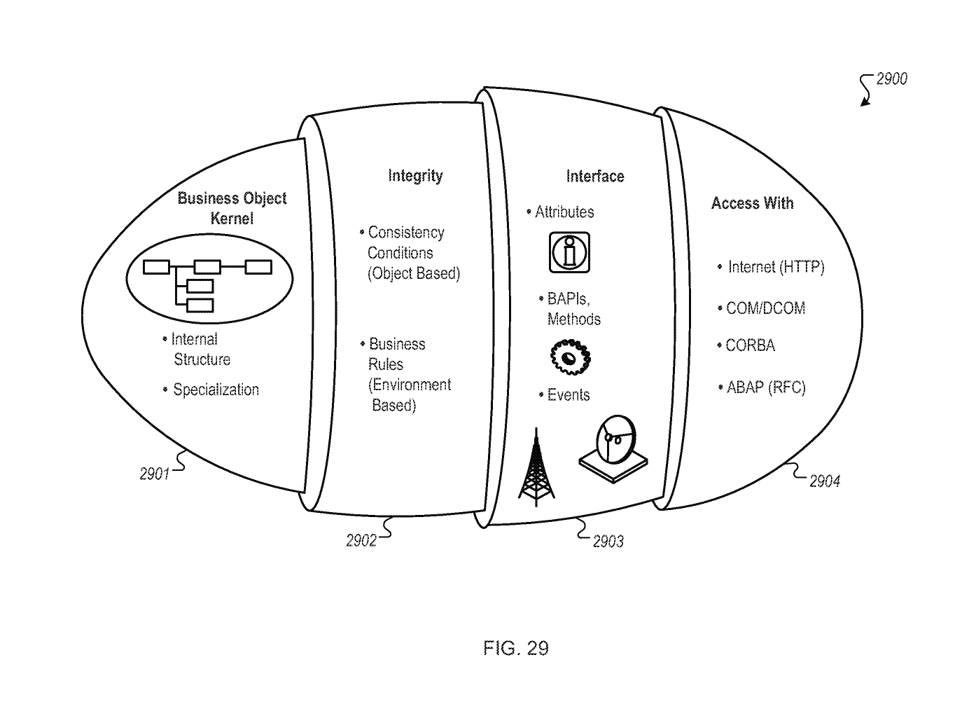

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

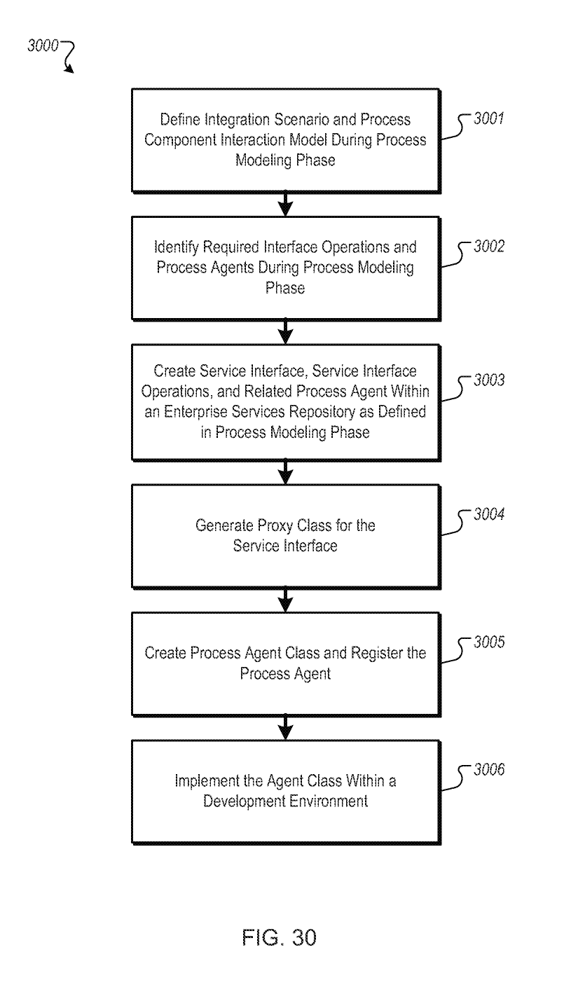

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

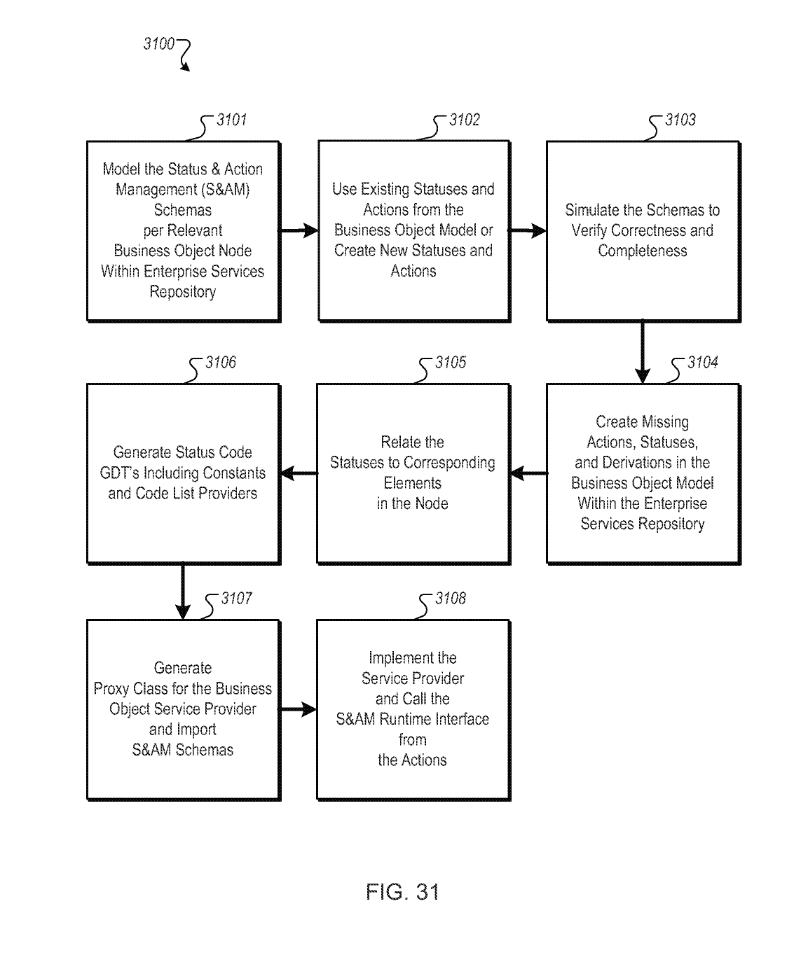

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

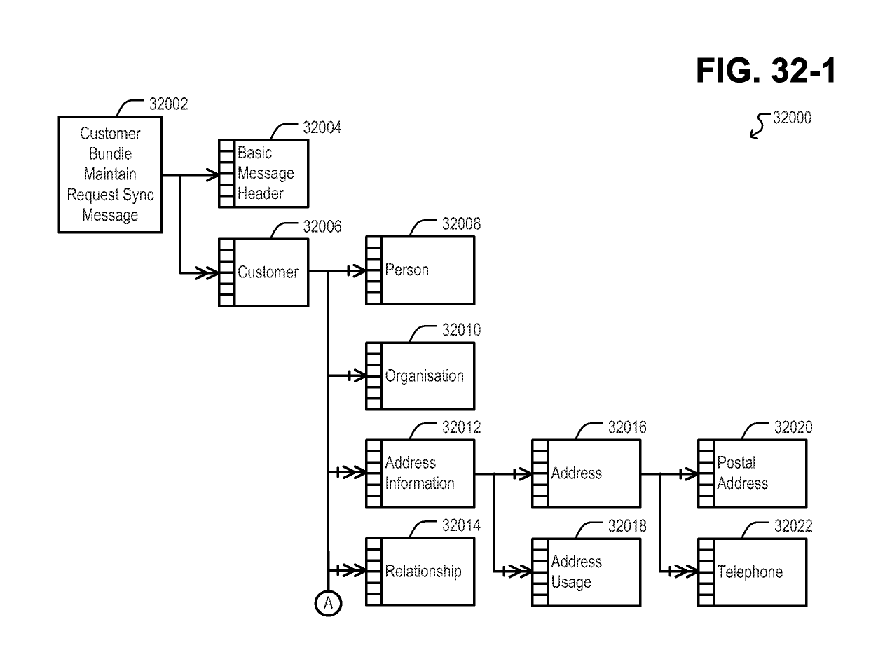

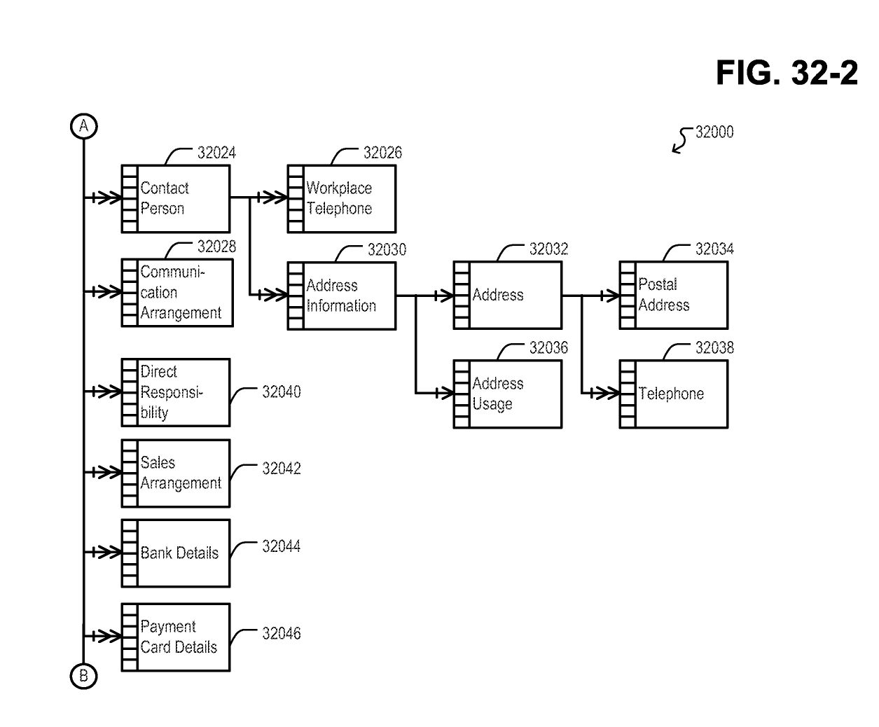

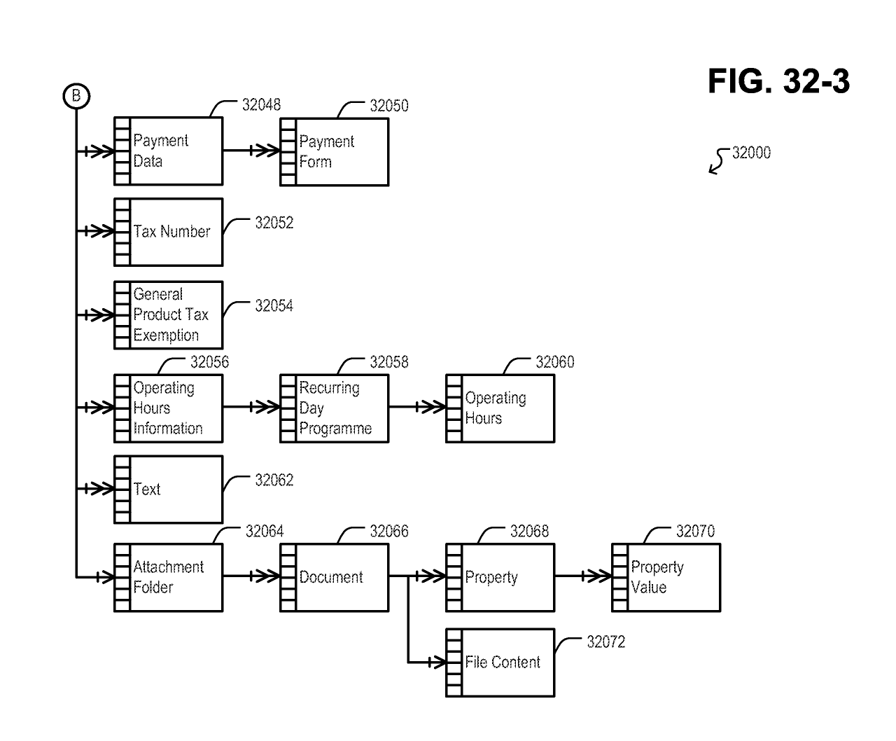

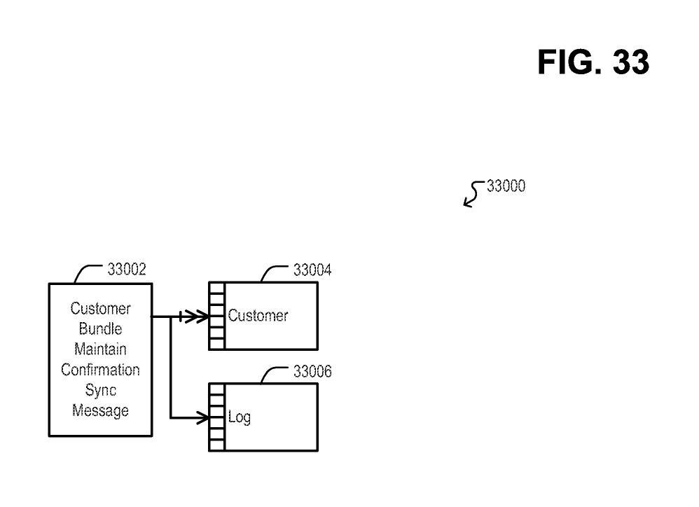

FIGS. 32-1 through 32-3 collectively illustrate one example logical configuration of a Customer Bundle Maintain Request Sync Message 32000. Specifically, these figures depict the arrangement and hierarchy of various components such as one or more levels of packages, entities, and data types, shown here as 32000 through 32072. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer Bundle Maintain Request Sync Message 32000 includes, among other things, one or more Customer entities 32006. Accordingly, heterogeneous applications may communicate using this consistent message configured as such.

The message type Customer Bundle Maintain Request_sync is derived from the business object Customer as a leading object together with its operation signature. The message type Customer Bundle Maintain Request_sync is a bundle request to migrate customer master data. The structure of the message type Customer Bundle Maintain Request_sync is determined by the message data type CustomerBundleMaintainRequestMessage_sync. The message data type CustomerBundleMaintainRequestMessage_sync includes the BasicMessageHeader package and the Customer package.

The package BasicMessageHeader includes the entity BasicMessageHeader. BasicMessageHeader is typed by datatype BusinessDocumentBasicMessageHeader. The package Customer includes the sub-packages Person, Organisation, AddressInformation, Relationship, ContactPerson, CommunicationArrangement, DirectResponsibility, SalesArrangement, BankDetails, PaymentCardDetails, PaymentData, TaxNumber, GeneralProductTaxExemption, OperatingHoursInformation, Text, and AttachmentFolder, and the entity Customer.

Customer includes the following attributes: actionCode, addressInformationListCompleteTransmissionIndicator, bankDetailsListCompleteTransmissionIndicator, communicationArrangementListCompleteTransmissionIndicator, directResponsibilityListCompleteTransmissionIndicator, operatingHoursInformationListCompleteTransmissionIndicator, paymentCardDetailsListCompleteTransmissionIndicator, relationshipListCompleteTransmissionIndicator, salesArrangementListCompleteTransmissionIndicator, taxNumberListCompleteTransmissionIndicator, generalProductTaxExemptionListCompleteTransmissionIndicator, contactPersonListCompleteTransmissionIndicator, paymentDataListCompleteTransmissionIndicator, and textListCompleteTransmissionIndicator.

The attribute actionCode may have a multiplicity of 1 and may be based on datatype BGDT:ActionCode. The attribute addressInformationListCompleteTransmissionIndicator may have a multiplicity of 0 . . . 1 and may be based on datatype CDT:Indicator. The attribute bankDetailsListCompleteTransmissionIndicator may have a multiplicity of 0 . . . 1 and may be based on datatype CDT:Indicator. The attribute communicationArrangementListCompleteTransmissionIndicator may have a multiplicity of 0 . . . 1 and may be based on datatype CDT:Indicator. The attribute directResponsibilityListCompleteTransmissionIndicator may have a multiplicity of 0 . . . 1 and may be based on datatype CDT:Indicator. The attribute operatingHoursInformationListCompleteTransmissionIndicator may have a multiplicity of 0 . . . 1 and may be based on datatype CDT:Indicator. The attribute paymentCardDetailsListCompleteTransmissionIndicator may have a multiplicity of 0 . . . 1 and may be based on datatype CDT:Indicator. The attribute relationshipListCompleteTransmissionIndicator may have a multiplicity of 0 . . . 1 and may be based on datatype CDT:Indicator. The attribute salesArrangementListCompleteTransmissionIndicator may have a multiplicity of 0 . . . 1 and may be based on datatype CDT:Indicator. The attribute taxNumberListCompleteTransmissionIndicator may have a multiplicity of 0 . . . 1 and may be based on datatype CDT:Indicator. The attribute generalProductTaxExemptionListCompleteTransmissionIndicator may have a multiplicity of 0 . . . 1 and may be based on datatype CDT:Indicator. The attribute contactPersonListCompleteTransmissionIndicator may have a multiplicity of 0 . . . 1 and may be based on datatype CDT:Indicator. The attribute paymentDataListCompleteTransmissionIndicator may have a multiplicity of 0 . . . 1 and may be based on datatype CDT:Indicator. The attribute textListCompleteTransmissionIndicator may have a multiplicity of 0 . . . 1 and may be based on datatype CDT:Indicator.

Customer includes the following non-node elements: ObjectNodeSenderTechnicalID, ChangeStateID, UUID, InternalID, CategoryCode, ProspectIndicator, CustomerIndicator, LifeCycleStatusCode, VerbalCommunicationLanguageCode, ContactAllowedCode, LegalCompetenceIndicator, DunAndBradstreetNumberID, GlobalLocationNumberID, ABCClassificationCode, NielsenRegionCode, IndustrialSectorCode, InvoicingBlockingReasonCode, CustomerTransactionDocumentFulfilmentBlockingReasonCode, CustomerBlockingReasonCode, DuplicateCheckApplyIndicator, and EnterpriseIdentificationNumber. ObjectNodeSenderTechnicalID may have a multiplicity of 0 . . . 1 and may be based on datatype BGDT:ObjectNodePartyTechnicalID. ChangeStateID may have a multiplicity of 0 . . . 1 and may be based on datatype BGDT:ChangeStateID. UUID may have a multiplicity of 0 . . . 1 and may be based on datatype BGDT:UUID. InternalID may have a multiplicity of 0 . . . 1 and may be based on datatype BGDT:BusinessPartnerInternalID. CategoryCode may have a multiplicity of 0 . . . 1 and may be based on datatype BGDT:BusinessPartnerCategoryCode. ProspectIndicator may have a multiplicity of 0 . . . 1 and may be based on datatype CDT:Indicator. CustomerIndicator may have a multiplicity of 0 . . . 1 and may be based on datatype CDT:Indicator. LifeCycleStatusCode may have a multiplicity of 0 . . . 1 and may be based on datatype BGDT:PartyLifeCycleStatusCode. VerbalCommunicationLanguageCode may have a multiplicity of 0 . . . 1 and may be based on datatype BGDT:LanguageCode. ContactAllowedCode may have a multiplicity of 0 . . . 1 and may be based on datatype BGDT:ContactAllowedCode. LegalCompetenceIndicator may have a multiplicity of 0 . . . 1 and may be based on datatype CDT:Indicator. DunAndBradstreetNumberID may have a multiplicity of 0 . . . 1 and may be based on datatype BGDT:BusinessPartnerID. GlobalLocationNumberID may have a multiplicity of 0 . . . 1 and may be based on datatype BGDT:BusinessPartnerID. ABCClassificationCode may have a multiplicity of 0 . . . 1 and may be based on datatype BGDT:CustomerABCClassificationCode. NielsenRegionCode may have a multiplicity of 0 . . . 1 and may be based on datatype BGDT:NielsenRegionCode. IndustrialSectorCode may have a multiplicity of 0 . . . 1 and may be based on datatype BGDT:IndustrialSectorCode. InvoicingBlockingReasonCode may have a multiplicity of 0 . . . 1 and may be based on datatype BGDT:InvoicingBlockingReasonCode. CustomerTransactionDocumentFulfilmentBlockingReasonCode may have a multiplicity of 0 . . . 1 and may be based on datatype BGDT:CustomerTransactionDocumentFulfilmentBlockingReasonCode. CustomerBlockingReasonCode may have a multiplicity of 0 . . . 1 and may be based on datatype BGDT:CustomerBlockingReasonCode. DuplicateCheckApplyIndicator may have a multiplicity of 0 . . . 1 and may be based on datatype CDT:Indicator. EnterpriseIdentificationNumber may have a multiplicity of 0 . . . 1 and may be based on datatype BGDT:BusinessPartnerID.

Customer includes the following node elements: Person, in a 1:C cardinality relationship; Organisation, in a 1:C cardinality relationship; AddressInformation, in a 1:CN cardinality relationship; Relationship, in a 1:CN cardinality relationship; ContactPerson, in a 1:CN cardinality relationship; CommunicationArrangement, in a 1:CN cardinality relationship; DirectResponsibility, in a 1:CN cardinality relationship; SalesArrangement, in a 1:CN cardinality relationship; BankDetails, in a 1:CN cardinality relationship; PaymentCardDetails, in a 1:CN cardinality relationship; PaymentData, in a 1:CN cardinality relationship; TaxNumber, in a 1:CN cardinality relationship; GeneralProductTaxExemption, in a 1:CN cardinality relationship; OperatingHoursInformation, in a 1:CN cardinality relationship; Text, in a 1:CN cardinality relationship; and AttachmentFolder, in a 1:C cardinality relationship.

The package CustomerPerson includes the entity Person. Person includes the following non-node elements: FormOfAddressCode, AcademicTitleCode, GivenName, MiddleName, FamilyName, BirthName, NickName, NameFormatCountryCode, GenderCode, BirthDate, NonVerbalCommunicationLanguageCode, and OccupationCode. FormOfAddressCode may have a multiplicity of 0 . . . 1 and may be based on datatype BGDT:FormOfAddressCode. AcademicTitleCode may have a multiplicity of 0 . . . 1 and may be based on datatype BGDT:AcademicTitleCode. GivenName may have a multiplicity of 0 . . . 1 and may be based on datatype CDT:LANGUAGEINDEPENDENT_MEDIUM_Name. MiddleName may have a multiplicity of 0 . . . 1 and may be based on datatype CDT:LANGUAGEINDEPENDENT_MEDIUM_Name. FamilyName may have a multiplicity of 0 . . . 1 and may be based on datatype CDT:LANGUAGEINDEPENDENT_MEDIUM_Name. BirthName may have a multiplicity of 0 . . . 1 and may be based on datatype CDT:LANGUAGEINDEPENDENT_MEDIUM_Name. NickName may have a multiplicity of 0 . . . 1 and may be based on datatype CDT:LANGUAGEINDEPENDENT_MEDIUM_Name. NameFormatCountryCode may have a multiplicity of 0 . . . 1 and may be based on datatype BGDT:CountryCode. GenderCode may have a multiplicity of 0 . . . 1 and may be based on datatype BGDT:GenderCode. BirthDate may have a multiplicity of 0 . . . 1 and may be based on datatype CDT:Date, with a qualifier of Birth. NonVerbalCommunicationLanguageCode may have a multiplicity of 0 . . . 1 and may be based on datatype BGDT:LanguageCode, with a qualifier of Communication. OccupationCode may have a multiplicity of 0 . . . 1 and may be based on datatype BGDT:OccupationCode.

The package CustomerOrganisation includes the entity Organisation. Organisation includes the following non-node elements: CompanyLegalFormCode, FirstLineName, and SecondLineName. CompanyLegalFormCode may have a multiplicity of 0 . . . 1 and may be based on datatype BGDT:CompanyLegalFormCode. FirstLineName may have a multiplicity of 0 . . . 1 and may be based on datatype CDT:LANGUAGEINDEPENDENT_MEDIUM_Name. SecondLineName may have a multiplicity of 0 . . . 1 and may be based on datatype CDT:LANGUAGEINDEPENDENT_MEDIUM_Name.

The package CustomerAddressInformation includes the sub-package AddressInformationUsage and the entity AddressInformation. AddressInformation includes the following attributes: actionCode and addressUsageListCompleteTransmissionIndicator. The attribute actionCode may have a multiplicity of 0 . . . 1 and may be based on datatype BGDT:ActionCode. The attribute addressUsageListCompleteTransmissionIndicator may have a multiplicity of 0 . . . 1 and may be based on datatype CDT:Indicator. AddressInformation includes the following non-node elements: ObjectNodeSenderTechnicalID and UUID. ObjectNodeSenderTechnicalID may have a multiplicity of 0 . . . 1 and may be based on datatype BGDT:ObjectNodePartyTechnicalID. UUID may have a multiplicity of 0 . . . 1 and may be based on datatype BGDT:UUID. AddressInformation includes the following node elements: Address, in a 1:C cardinality relationship; and AddressUsage, in a 1:CN cardinality relationship.

Address includes the following attributes: actionCode and telephoneListCompleteTransmissionIndicator. The attribute actionCode may have a multiplicity of 0 . . . 1 and may be based on datatype BGDT:ActionCode. The attribute telephoneListCompleteTransmissionIndicator may have a multiplicity of 0 . . . 1 and may be based on datatype CDT:Indicator. Address includes the following non-node elements: CorrespondenceLanguageCode, PreferredCommunicationMediumTypeCode, EmailURI, FacsimileFormattedNumberDescription, and WebURI. CorrespondenceLanguageCode may have a multiplicity of 0 . . . 1 and may be based on datatype BGDT:LanguageCode. PreferredCommunicationMediumTypeCode may have a multiplicity of 0 . . . 1 and may be based on datatype BGDT:CommunicationMediumTypeCode. EmailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. WebURI may have a multiplicity of 0 . . . 1 and may be based on datatype BGDT:WebURI. Address includes the following node elements: PostalAddress, in a 1:C cardinality relationship; Telephone, in a 1:CN cardinality relationship.

PostalAddress includes the following non-node elements: CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, CareOfName, POBoxDeviatingCountryCode, POBoxDeviatingRegionCode, POBoxDeviatingCityName, POBoxID, POBoxIndicator, TaxJurisdictionCode, and TimeZoneCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package CustomerAddressInformationAddressInformationAddress includes the entity Telephone. Telephone includes the following non-node elements: ObjectNodeSenderTechnicalID, FormattedNumberDescription, and MobilePhoneNumberIndicator. ObjectNodeSenderTechnicalID may have a multiplicity of 0 . . . 1 and may be based on datatype BGDT:ObjectNodePartyTechnicalID. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

The package CustomerAddressInformationAddressInformationUsage includes the entity AddressUsage. AddressUsage includes the actionCode attribute, which may have a multiplicity of 0 . . . 1 and may be based on datatype BGDT:ActionCode. AddressUsage includes the following non-node elements: ObjectNodeSenderTechnicalID, AddressUsageCode, and DefaultIndicator. ObjectNodeSenderTechnicalID may have a multiplicity of 0 . . . 1 and may be based on datatype BGDT:ObjectNodePartyTechnicalID. AddressUsageCode may have a multiplicity of 1 and may be based on datatype BGDT:AddressUsageCode. DefaultIndicator may have a multiplicity of 0 . . . 1 and may be based on datatype CDT:Indicator.

The package CustomerRelationship includes the entity Relationship. Relationship includes the actionCode attribute, which may have a multiplicity of 0 . . . 1 and may be based on datatype BGDT:ActionCode. Relationship includes the following non-node elements: ObjectNodeSenderTechnicalID, RelationshipBusinessPartnerUUID, RelationshipBusinessPartnerInternalID, and RoleCode. ObjectNodeSenderTechnicalID may have a multiplicity of 0 . . . 1 and may be based on datatype BGDT:ObjectNodePartyTechnicalID. RelationshipBusinessPartnerUUID may have a multiplicity of 0 . . . 1 and may be based on datatype BGDT:UUID. RelationshipBusinessPartnerInternalID may have a multiplicity of 0 . . . 1 and may be based on datatype BGDT:BusinessPartnerInternalID. RoleCode may have a multiplicity of 1 and may be based on datatype BGDT:BusinessPartnerRelationshipRoleCode.

The package CustomerContactPerson includes the sub-package AddressInformation and the entity ContactPerson. ContactPerson includes the following attributes: actionCode, workplaceTelephoneListCompleteTransmissionIndicator, and addressInformationListCompleteTransmissionIndicator. The attribute actionCode may have a multiplicity of 0 . . . 1 and may be based on datatype BGDT:ActionCode. The attribute workplaceTelephoneListCompleteTransmissionIndicator may have a multiplicity of 0 . . . 1 and may be based on datatype CDT:Indicator. The attribute addressInformationListCompleteTransmissionIndicator may have a multiplicity of 0 . . . 1 and may be based on datatype CDT:Indicator.

ContactPerson includes the following non-node elements: ObjectNodeSenderTechnicalID, BusinessPartnerContactUUID, BusinessPartnerContactlnternalID, DefaultContactPersonIndicator, FormOfAddressCode, AcademicTitleCode, GivenName, MiddleName, FamilyName, BirthName, NickName, GenderCode, BirthDate, NonVerbalCommunicationLanguageCode, OccupationCode, BusinessPartnerFunctionTypeCode, BusinessPartnerFunctionalAreaCode, VIPReasonCode, WorkplaceBusinessAddressUUID, WorkplacePreferredCommunicationMediumTypeCode, WorkplaceEmailURI, WorkplaceFacsimileFormattedNumberDescription, WorkplaceWebURI, WorkplaceFunctionalTitleName, WorkplaceDepartmentName, WorkplaceBuildingID, WorkplaceFloorID, WorkplaceRoomID, LifeCycleStatusCode, and MaritalStatusCode.

ObjectNodeSenderTechnicalID may have a multiplicity of 0 . . . 1 and may be based on datatype BGDT:ObjectNodePartyTechnicalID. BusinessPartnerContactUUID may have a multiplicity of 0 . . . 1 and may be based on datatype BGDT:UUID. BusinessPartnerContactlnternalID may have a multiplicity of 0 . . . 1 and may be based on datatype BGDT:BusinessPartnerInternalID. DefaultContactPersonIndicator may have a multiplicity of 0 . . . 1 and may be based on datatype CDT:Indicator. FormOfAddressCode may have a multiplicity of 0 . . . 1 and may be based on datatype BGDT:FormOfAddressCode. AcademicTitleCode may have a multiplicity of 0 . . . 1 and may be based on datatype BGDT:AcademicTitleCode. GivenName may have a multiplicity of 0 . . . 1 and may be based on datatype CDT:LANGUAGEINDEPENDENT_MEDIUM_Name. MiddleName may have a multiplicity of 0 . . . 1 and may be based on datatype CDT:LANGUAGEINDEPENDENT_MEDIUM_Name. FamilyName may have a multiplicity of 0 . . . 1 and may be based on datatype CDT:LANGUAGEINDEPENDENT_MEDIUM_Name. BirthName may have a multiplicity of 0 . . . 1 and may be based on datatype CDT:LANGUAGEINDEPENDENT_MEDIUM_Name. NickName may have a multiplicity of 0 . . . 1 and may be based on datatype CDT:LANGUAGEINDEPENDENT_MEDIUM_Name. GenderCode may have a multiplicity of 0 . . . 1 and may be based on datatype BGDT:GenderCode. BirthDate may have a multiplicity of 0 . . . 1 and may be based on datatype CDT:Date. NonVerbalCommunicationLanguageCode may have a multiplicity of 0 . . . 1 and may be based on datatype BGDT:LanguageCode. OccupationCode may have a multiplicity of 0 . . . 1 and may be based on datatype BGDT:OccupationCode. BusinessPartnerFunctionTypeCode may have a multiplicity of 0 . . . 1 and may be based on datatype BGDT:BusinessPartnerFunctionTypeCode. BusinessPartnerFunctionalAreaCode may have a multiplicity of 0 . . . 1 and may be based on datatype BGDT:BusinessPartnerFunctionalAreaCode. VIPReasonCode may have a multiplicity of 0 . . . 1 and may be based on datatype BGDT:VIPReasonCode. WorkplaceBusinessAddressUUID may have a multiplicity of 0 . . . 1 and may be based on datatype BGDT:UUID. WorkplacePreferredCommunicationMediumTypeCode may have a multiplicity of 0 . . . 1 and may be based on datatype BGDT:CommunicationMediumTypeCode. WorkplaceEmailURI may have a multiplicity of 0 . . . 1 and may be based on datatype BGDT:EmailURI. WorkplaceFacsimileFormattedNumberDescription may have a multiplicity of 0 . . . 1 and may be based on datatype BGDT:LANGUAGEINDEPENDENT_SHORT_Description. WorkplaceWebURI may have a multiplicity of 0 . . . 1 and may be based on datatype BGDT:WebURI. WorkplaceFunctionalTitleName may have a multiplicity of 0 . . . 1 and may be based on datatype CDT:LANGUAGEINDEPENDENT_MEDIUM_Name. WorkplaceDepartmentName may have a multiplicity of 0 . . . 1 and may be based on datatype CDT:LANGUAGEINDEPENDENT_MEDIUM_Name. WorkplaceBuildingID may have a multiplicity of 0 . . . 1 and may be based on datatype BGDT:BuildingID. WorkplaceFloorID may have a multiplicity of 0 . . . 1 and may be based on datatype BGDT:FloorID. WorkplaceRoomID may have a multiplicity of 0 . . . 1 and may be based on datatype BGDT:RoomID LifeCycleStatusCode may have a multiplicity of 0 . . . 1 and may be based on datatype BGDT:PartyLifeCycleStatusCode. MaritalStatusCode may have a multiplicity of 0 . . . 1 and may be based on datatype BGDT:MaritalStatusCode. ContactPerson includes the following node elements: WorkplaceTelephone, in a 1:CN cardinality relationship; and AddressInformation, in a 1:CN cardinality relationship.

The package CustomerContactPerson includes the entity WorkplaceTelephone. WorkplaceTelephone includes the following non-node elements: ObjectNodeSenderTechnicalID, FormattedNumberDescription, and MobilePhoneNumberIndicator. ObjectNodeSenderTechnicalID may have a multiplicity of 0 . . . 1 and may be based on datatype BGDT:ObjectNodePartyTechnicalID. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

The package CustomerContactPersonAddressInformation includes the entity AddressInformation. AddressInformation includes the actionCode attribute, which may have a multiplicity of 0 . . . 1 and may be based on datatype BGDT:ActionCode. AddressInformation includes the following non-node elements: ObjectNodeSenderTechnicalID and UUID. ObjectNodeSenderTechnicalID may have a multiplicity of 0 . . . 1 and may be based on datatype BGDT:ObjectNodePartyTechnicalID. UUID may have a multiplicity of 0 . . . 1 and may be based on datatype BGDT:UUID. AddressInformation includes the following node elements: Address, in a 1:C cardinality relationship; and AddressUsage, in a 1:C cardinality relationship.

Address includes the following attributes: telephoneListCompleteTransmissionIndicator and actionCode. The attribute actionCode may have a multiplicity of 0 . . . 1 and may be based on datatype BGDT:ActionCode. The attribute telephoneListCompleteTransmissionIndicator may have a multiplicity of 0 . . . 1 and may be based on datatype CDT:Indicator. Address includes the following non-node elements: ObjectNodeSenderTechnicalID, EmailURI, and FacsimileFormattedNumberDescription. ObjectNodeSenderTechnicalID may have a multiplicity of 0 . . . 1 and may be based on datatype BGDT:ObjectNodePartyTechnicalID. EmailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. Address includes the following node elements: PostalAddress, in a 1:C cardinality relationship; and Telephone, in a 1:CN cardinality relationship.

PostalAddress includes the following non-node elements: CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, CareOfName, POBoxDeviatingCountryCode, POBoxDeviatingRegionCode, POBoxDeviatingCityName, POBoxID, POBoxIndicator, TaxJurisdictionCode, and TimeZoneCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

Telephone includes the following non-node elements: ObjectNodeSenderTechnicalID, FormattedNumberDescription, and MobilePhoneNumberIndicator. ObjectNodeSenderTechnicalID may have a multiplicity of 0 . . . 1 and may be based on datatype BGDT:ObjectNodePartyTechnicalID. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

AddressUsage includes the actionCode attribute, which may have a multiplicity of 0 . . . 1 and may be based on datatype BGDT:ActionCode. AddressUsage includes the following non-node elements: ObjectNodeSenderTechnicalID, AddressUsageCode, and DefaultIndicator. ObjectNodeSenderTechnicalID may have a multiplicity of 0 . . . 1 and may be based on datatype BGDT:ObjectNodePartyTechnicalID. AddressUsageCode may have a multiplicity of 1 and may be based on datatype BGDT:AddressUsageCode. DefaultIndicator may have a multiplicity of 0 . . . 1 and may be based on datatype CDT:Indicator.

The package CustomerCommunicationArrangement includes the entity CommunicationArrangement. CommunicationArrangement includes the actionCode attribute, which may have a multiplicity of 0 . . . 1 and may be based on datatype BGDT:ActionCode. CommunicationArrangement includes the following non-node elements: ObjectNodeSenderTechnicalID, UUID, CompoundServiceInterfaceCode, EnabledIndicator, CommunicationMediumTypeCode, OutputRequestFormTemplateCode, EMailURI, FacsimileFormattedNumberDescription, and OutputCopyNumberValue. ObjectNodeSenderTechnicalID may have a multiplicity of 0 . . . 1 and may be based on datatype BGDT:ObjectNodePartyTechnicalID. UUID may have a multiplicity of 0 . . . 1 and may be based on datatype BGDT:UUID. CompoundServiceInterfaceCode may have a multiplicity of 0 . . . 1 and may be based on datatype BGDT:CompoundServiceInterfaceCode. EnabledIndicator may have a multiplicity of 0 . . . 1 and may be based on datatype CDT:Indicator. CommunicationMediumTypeCode may have a multiplicity of 0 . . . 1 and may be based on datatype BGDT:CommunicationMediumTypeCode. OutputRequestFormTemplateCode may have a multiplicity of 0 . . . 1 and may be based on datatype BGDT:OutputRequestFormTemplateCode. EMailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. OutputCopyNumberValue may have a multiplicity of 0 . . . 1 and may be based on datatype BGDT:NumberValue.

The package CustomerDirectResponsibility includes the entity DirectResponsibility. DirectResponsibility includes the actionCode attribute, which may have a multiplicity of 0 . . . 1 and may be based on datatype BGDT:ActionCode. DirectResponsibility includes the following non-node elements: ObjectNodeSenderTechnicalID, PartyRoleCode, and EmployeeID. ObjectNodeSenderTechnicalID may have a multiplicity of 0 . . . 1 and may be based on datatype BGDT:ObjectNodePartyTechnicalID. PartyRoleCode may have a multiplicity of 0 . . . 1 and may be based on datatype BGDT:PartyRoleCode. EmployeeID may have a multiplicity of 0 . . . 1 and may be based on datatype BGDT:EmployeeID.

The package CustomerSalesArrangement includes the entity SalesArrangement. SalesArrangement includes the actionCode attribute, which may have a multiplicity of 0 . . . 1 and may be based on datatype BGDT:ActionCode. SalesArrangement includes the following non-node elements: ObjectNodeSenderTechnicalID, SalesOrganisationID, DistributionChannelCode, Incoterms, DeliveryPriorityCode, CompleteDeliveryRequestedIndicator, CurrencyCode, CustomerGroupCode, and CashDiscountTermsCode. ObjectNodeSenderTechnicalID may have a multiplicity of 0 . . . 1 and may be based on datatype BGDT:ObjectNodePartyTechnicalID. SalesOrganisationID may have a multiplicity of 0 . . . 1 and may be based on datatype BGDT:OrganisationalCentreID. DistributionChannelCode may have a multiplicity of 0 . . . 1 and may be based on datatype BGDT:DistributionChannelCode. Incoterms may have a multiplicity of 0 . . . 1 and may be based on datatype AGDT:Incoterms. DeliveryPriorityCode may have a multiplicity of 0 . . . 1 and may be based on datatype BGDT:PriorityCode. CompleteDeliveryRequestedIndicator may have a multiplicity of 0 . . . 1 and may be based on datatype CDT:Indicator. CurrencyCode may have a multiplicity of 0 . . . 1 and may be based on datatype BGDT:CurrencyCode. CustomerGroupCode may have a multiplicity of 0 . . . 1 and may be based on datatype BGDT:CustomerGroupCode. CashDiscountTermsCode may have a multiplicity of 0 . . . 1 and may be based on datatype BGDT:CashDiscountTermsCode.

The package CustomerBankDetails includes the entity BankDetails. BankDetails includes the actionCode attribute, which may have a multiplicity of 0 . . . 1 and may be based on datatype BGDT:ActionCode. BankDetails includes the following non-node elements: ObjectNodeSenderTechnicalID, ID, BankUUID, BanklnternalID, BankRoutingID, BankRoutingIDTypeCode, BankStandardID, BankAccountID, BankAccountIDCheckDigitValue, BankAccountTypeCode, BankAccountHolderName, BankAccountStandardID, and ValidityPeriod. ObjectNodeSenderTechnicalID may have a multiplicity of 0 . . . 1 and may be based on datatype BGDT:ObjectNodePartyTechnicalID. ID may have a multiplicity of 0 . . . 1 and may be based on datatype BGDT:BusinessPartnerBankDetailsID. BankUUID may have a multiplicity of 0 . . . 1 and may be based on datatype BGDT:UUID. BankInternalID may have a multiplicity of 0 . . . 1 and may be based on datatype BGDT:BankInternalID. BankRoutingID may have a multiplicity of 0 . . . 1 and may be based on datatype BGDT:BankRoutingID. BankRoutingIDTypeCode may have a multiplicity of 0 . . . 1 and may be based on datatype BGDT:BankRoutingIDTypeCode. BankStandardID may have a multiplicity of 0 . . . 1 and may be based on datatype BGDT:BankStandardID. BankAccountID may have a multiplicity of 0 . . . 1 and may be based on datatype BGDT:BankAccountID. BankAccountIDCheckDigitValue may have a multiplicity of 0 . . . 1 and may be based on datatype BGDT:BankAccountIDCheckDigitValue. BankAccountTypeCode may have a multiplicity of 0 . . . 1 and may be based on datatype BGDT:BankAccountTypeCode. BankAccountHolderName may have a multiplicity of 0 . . . 1 and may be based on datatype BGDT:BankAccountHolderName_V1. BankAccountStandardID may have a multiplicity of 0 . . . 1 and may be based on datatype BGDT:BankAccountStandardID. ValidityPeriod may have a multiplicity of 0 . . . 1 and may be based on datatype AGDT:CLOSED_DatePeriod.

The package CustomerPaymentCardDetails includes the entity PaymentCardDetails. PaymentCardDetails includes the actionCode attribute, which may have a multiplicity of 0 . . . 1 and may be based on datatype BGDT:ActionCode. PaymentCardDetails includes the following non-node elements: ObjectNodeSenderTechnicalID, ID, PaymentCardTypeCode, PaymentCardID, PaymentCardHolderName, PaymentCardExpirationDate, DefaultIndicator, BlockingReasonCode, StreetName, HouseID, PostalCode, CityName, RegionCode, and CountryCode. ObjectNodeSenderTechnicalID may have a multiplicity of 0 . . . 1 and may be based on datatype BGDT:ObjectNodePartyTechnicalID. ID may have a multiplicity of 0 . . . 1 and may be based on datatype BGDT:BusinessPartnerPaymentCardDetailsID. PaymentCardTypeCode may have a multiplicity of 0 . . . 1 and may be based on datatype BGDT:PaymentCardTypeCode. PaymentCardID may have a multiplicity of 0 . . . 1 and may be based on datatype BGDT:PaymentCardID. PaymentCardHolderName may have a multiplicity of 0 . . . 1 and may be based on datatype CDT:LANGUAGEINDEPENDENT_MEDIUM_Name. PaymentCardExpirationDate may have a multiplicity of 0 . . . 1 and may be based on datatype CDT:Date, with a qualifier of Expiration. DefaultIndicator may have a multiplicity of 0 . . . 1 and may be based on datatype CDT:Indicator. BlockingReasonCode may have a multiplicity of 0 . . . 1 and may be based on datatype BGDT:PaymentCardBlockingReasonCode. StreetName may have a multiplicity of 0 . . . 1 and may be based on datatype BGDT:StreetName. HouseID may have a multiplicity of 0 . . . 1 and may be based on datatype BGDT:HouseID. PostalCode may have a multiplicity of 0 . . . 1 and may be based on datatype BGDT:PostalCode. CityName may have a multiplicity of 0 . . . 1 and may be based on datatype CDT:LANGUAGEINDEPENDENT_MEDIUM_Name. RegionCode may have a multiplicity of 0 . . . 1 and may be based on datatype BGDT:RegionCode. CountryCode may have a multiplicity of 0 . . . 1 and may be based on datatype BGDT:CountryCode.

The package CustomerPaymentData includes the entity PaymentData. PaymentData includes the following attributes: paymentFormListCompleteTransmissionIndicator and actionCode. The attribute actionCode may have a multiplicity of 0 . . . 1 and may be based on datatype BGDT:ActionCode. The attribute paymentFormListCompleteTransmissionIndicator may have a multiplicity of 0 . . . 1 and may be based on datatype CDT:Indicator. PaymentData includes the following non-node elements: ObjectNodeSenderTechnicalID, CompanyID, UUID, AccountDeterminationDebtorGroupCode, AccountDebtorExternalID, PaymentBlockingReasonCode, PaymentBlockExpirationDateTime, CreditLimitAmount, DirectDebitBankDetailsID, DirectDebitValidityPeriod, PaymentCardDetailsID, PaymentCardValidityPeriod, BillOfExchangeBankDetailsID, PaymentAdviceRequiredIndicator, FirstPaymentInstructionCode, SecondPaymentInstructionCode, ThirdPaymentInstructionCode, FourthPaymentInstructionCode, and BankChargeBearerCode. ObjectNodeSenderTechnicalID may have a multiplicity of 0 . . . 1 and may be based on datatype BGDT:ObjectNodePartyTechnicalID. CompanyID may have a multiplicity of 1 and may be based on datatype BGDT:OrganisationalCentreID. UUID may have a multiplicity of 0 . . . 1 and may be based on datatype BGDT:UUID. AccountDeterminationDebtorGroupCode may have a multiplicity of 0 . . . 1 and may be based on datatype BGDT:AccountDeterminationDebtorGroupCode. AccountDebtorExternalID may have a multiplicity of 0 . . . 1 and may be based on datatype BGDT:PartyPartyID. PaymentBlockingReasonCode may have a multiplicity of 0 . . . 1 and may be based on datatype BGDT:PaymentBlockingReasonCode. PaymentBlockExpirationDateTime may have a multiplicity of 0 . . . 1 and may be based on datatype CDT:GLOBAL_DateTime. CreditLimitAmount may have a multiplicity of 0 . . . 1 and may be based on datatype CDT:Amount. DirectDebitBankDetailsID may have a multiplicity of 0 . . . 1 and may be based on datatype BGDT:BusinessPartnerBankDetailsID. DirectDebitValidityPeriod may have a multiplicity of 0 . . . 1 and may be based on datatype AGDT:CLOSED_DatePeriod. PaymentCardDetailsID may have a multiplicity of 0 . . . 1 and may be based on datatype BGDT:BusinessPartnerPaymentCardDetailsID. PaymentCardValidityPeriod may have a multiplicity of 0 . . . 1 and may be based on datatype AGDT:CLOSED_DatePeriod. BillOfExchangeBankDetailsID may have a multiplicity of 0 . . . 1 and may be based on datatype BGDT:BusinessPartnerBankDetailsID. PaymentAdviceRequiredIndicator may have a multiplicity of 0 . . . 1 and may be based on datatype CDT:Indicator. FirstPaymentInstructionCode may have a multiplicity of 0 . . . 1 and may be based on datatype BGDT:PaymentInstructionTypeCode. SecondPaymentInstructionCode may have a multiplicity of 0 . . . 1 and may be based on datatype BGDT:PaymentInstructionTypeCode. ThirdPaymentInstructionCode may have a multiplicity of 0 . . . 1 and may be based on datatype BGDT:PaymentInstructionTypeCode. FourthPaymentInstructionCode may have a multiplicity of 0 . . . 1 and may be based on datatype BGDT:PaymentInstructionTypeCode. BankChargeBearerCode may have a multiplicity of 0 . . . 1 and may be based on datatype BGDT:BankChargeBearerCode. PaymentData includes the following node elements: PaymentForm, in a 1:CN cardinality relationship.

PaymentForm includes the actionCode attribute, which may have a multiplicity of 0 . . . 1 and may be based on datatype BGDT:ActionCode. PaymentForm includes the following non-node elements: ObjectNodeSenderTechnicalID and PaymentFormCode. ObjectNodeSenderTechnicalID may have a multiplicity of 0 . . . 1 and may be based on datatype BGDT:ObjectNodePartyTechnicalID. PaymentFormCode may have a multiplicity of 1 and may be based on datatype BGDT:PaymentFormCode.

The package CustomerTaxNumber includes the entity TaxNumber. TaxNumber includes the actionCode attribute, which may have a multiplicity of 0 . . . 1 and may be based on datatype BGDT:ActionCode. TaxNumber includes the following non-node elements: ObjectNodeSenderTechnicalID, CountryCode, TaxIdentificationNumberTypeCode, and PartyTaxID. ObjectNodeSenderTechnicalID may have a multiplicity of 0 . . . 1 and may be based on datatype BGDT:ObjectNodePartyTechnicalID. CountryCode may have a multiplicity of 1 and may be based on datatype BGDT:CountryCode. TaxIdentificationNumberTypeCode may have a multiplicity of 1 and may be based on datatype BGDT:TaxIdentificationNumberTypeCode. PartyTaxID may have a multiplicity of 0 . . . 1 and may be based on datatype BGDT:PartyTaxID.

The package CustomerGeneralProductTaxExemption includes the entity GeneralProductTaxExemption. GeneralProductTaxExemption includes the actionCode attribute, which may have a multiplicity of 0 . . . 1 and may be based on datatype BGDT:ActionCode. GeneralProductTaxExemption includes the following non-node elements: ObjectNodeSenderTechnicalID, CountryCode, RegionCode, TaxTypeCode, and ReasonCode. ObjectNodeSenderTechnicalID may have a multiplicity of 0 . . . 1 and may be based on datatype BGDT:ObjectNodePartyTechnicalID. CountryCode may have a multiplicity of 0 . . . 1 and may be based on datatype BGDT:CountryCode. RegionCode may have a multiplicity of 0 . . . 1 and may be based on datatype BGDT:RegionCode. TaxTypeCode may have a multiplicity of 0 . . . 1 and may be based on datatype BGDT:TaxTypeCode. ReasonCode may have a multiplicity of 0 . . . 1 and may be based on datatype BGDT:TaxExemptionReasonCode.

The package CustomerOperatingHoursInformation includes the entity OperatingHoursInformation. OperatingHoursInformation includes the following attributes: actionCode and recurringDayProgrammeListCompleteTransmissionIndicator. The attribute actionCode may have a multiplicity of 0 . . . 1 and may be based on datatype BGDT:ActionCode. The attribute recurringDayProgrammeListCompleteTransmissionIndicator may have a multiplicity of 0 . . . 1 and may be based on datatype CDT:Indicator. OperatingHoursInformation includes the following non-node elements: RoleCode and ObjectNodeSenderTechnicalID. ObjectNodeSenderTechnicalID may have a multiplicity of 0 . . . 1 and may be based on datatype BGDT:ObjectNodePartyTechnicalID. RoleCode may have a multiplicity of 1 and may be based on datatype BGDT:BUSINESSPARTNER_OperatingHoursRoleCode. OperatingHoursInformation includes the following node elements: RecurringDayProgramme, in a 1:CN cardinality relationship.

The package CustomerOperatingHoursInformation includes the entity RecurringDayProgramme RecurringDayProgramme includes the operatingHoursListCompleteTransmissionIndicator attribute, which may have a multiplicity of 0 . . . 1 and may be based on datatype CDT:Indicator. RecurringDayProgramme includes the following non-node elements: ObjectNodeSenderTechnicalID and WeekdaySelection. ObjectNodeSenderTechnicalID may have a multiplicity of 0 . . . 1 and may be based on datatype BGDT:ObjectNodePartyTechnicalID. WeekdaySelection may have a multiplicity of 0 . . . 1 and may be based on datatype AGDT:WeekdaySelection. RecurringDayProgramme includes the following node elements: OperatingHours, in a 1:CN cardinality relationship.

OperatingHours includes the following non-node elements: ObjectNodeSenderTechnicalID and TimePeriod. ObjectNodeSenderTechnicalID may have a multiplicity of 0 . . . 1 and may be based on datatype BGDT:ObjectNodePartyTechnicalID. TimePeriod may have a multiplicity of 1 and may be based on datatype AGDT:UPPEROPEN_TimePeriod.

The package CustomerText includes the entity Text. Text includes the actionCode attribute, which may have a multiplicity of 0 . . . 1 and may be based on datatype BGDT:ActionCode. Text includes the following non-node elements: ObjectNodeSenderTechnicalID, TypeCode, and ContentText. ObjectNodeSenderTechnicalID may have a multiplicity of 0 . . . 1 and may be based on datatype BGDT:ObjectNodePartyTechnicalID. TypeCode may have a multiplicity of 0 . . . 1 and may be based on datatype BGDT:TextCollectionTextTypeCode. ContentText may have a multiplicity of 0 . . . 1 and may be based on datatype CDT:LANGUAGEINDEPENDENT_Text.

The package CustomerAttachmentFolder includes the entity AttachmentFolder. AttachmentFolder includes the following attributes: ActionCode and DocumentListCompleteTransmissionIndicator. DocumentListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. AttachmentFolder includes the following non-node elements: UUID. UUID may have a multiplicity of 0 . . . 1 and may be based on datatype BGDT:UUID. AttachmentFolder includes the following node elements: Document, in a 1:CN cardinality relationship.

The package CustomerAttachmentFolder includes the entity Document. Document includes the following attributes: ActionCode and PropertyListCompleteTransmissionIndicator. PropertyListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. Document includes the following non-node elements: UUID, LinklnternalIndicator, VisibleIndicator, CategoryCode, TypeCode, MIMECode, Name, AlternativeName, InternalLinkUUID, Description, and ExternalLinkWebURI. UUID may have a multiplicity of 0 . . . 1 and may be based on datatype BGDT:UUID. LinkInternalIndicator may have a multiplicity of 0 . . . 1 and may be based on datatype CDT:Indicator. VisibleIndicator may have a multiplicity of 0 . . . 1 and may be based on datatype CDT:Indicator. CategoryCode may have a multiplicity of 0 . . . 1 and may be based on datatype BGDT:DocumentCategoryCode. TypeCode may have a multiplicity of 0 . . . 1 and may be based on datatype BGDT:DocumentTypeCode. MIMECode may have a multiplicity of 0 . . . 1 and may be based on datatype BGDT:MIMECode. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. Description may have a multiplicity of 0 . . . 1 and may be based on datatype BGDT:Description. ExternalLinkWebURI may have a multiplicity of 0 . . . 1 and may be based on datatype BGDT:WebURI. Document includes the following node elements: Property, in a 1:CN cardinality relationship; and FileContent, in a 1:C cardinality relationship.

Property includes the following attributes: ActionCode and PropertyValueListCompleteTransmissionIndicator. PropertyValueListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. Property includes the following non-node elements: TechnicalID, Name, DataTypeFormatCode, VisibleIndicator, ChangeAllowedIndicator, MultipleValueIndicator, NamespaceURI, Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0 . . . 1 and may be based on datatype BGDT:PropertyDataTypeFormatCode. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description. Property includes the following node elements: PropertyValue, in a 1:CN cardinality relationship.

PropertyValue includes the ActionCode attribute, which may have a multiplicity of 0 . . . 1 and may be based on datatype BGDT:ActionCode. PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

FileContent includes the ActionCode attribute, which may have a multiplicity of 0 . . . 1 and may be based on datatype BGDT:ActionCode. FileContent includes the following non-node elements: TechnicalID and BinaryObject. TechnicalID may have a multiplicity of 0 . . . 1 and may be based on datatype BGDT:ObjectNodeTechnicalID. BinaryObject may have a multiplicity of 0 . . . 1 and may be based on datatype CDT:BinaryObject.

FIG. 33 illustrates one example logical configuration of a Customer Bundle Maintain Confirmation Sync Message 33000. Specifically, this figure depicts the arrangement and hierarchy of various components such as one or more levels of packages, entities, and data types, shown here as 33000 through 33006. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer Bundle Maintain Confirmation Sync Message 33000 includes, among other things, one or more Customer entities 33004. Accordingly, heterogeneous applications may communicate using this consistent message configured as such.

The message type Customer Bundle Maintain Confirmation_sync is derived from the business object Customer as a leading object together with its operation signature. The message type Customer Bundle Maintain Confirmation_sync is a reply to a request to migrate customer master data, and includes individual replies to requests in a bundle, which can be positive or negative. The confirmation message can include the ID and UUID of the migrated customer. The structure of the message type Customer Bundle Maintain Confirmation_sync is determined by the message data type CustomerBundleMaintainConfirmationMessage_sync. The message data type CustomerBundleMaintainConfirmationMessage_sync includes the Customer package and the Log package. The package Log includes the entity Log. Log is typed by datatype Log.

The package Customer includes the entity Customer. Customer includes the following attributes: ReferenceObjectNodeSenderTechnicalID and ChangeStateID. ReferenceObjectNodeSenderTechnicalID may have a multiplicity of 1 and may be based on datatype BGDT:ObjectNodePartyTechnicalID. ChangeStateID may have a multiplicity of 1 and may be based on datatype BGDT:ChangeStateID. Customer includes the following non-node elements: InternalID and UUID. InternalID may have a multiplicity of 1 and may be based on datatype BGDT:BusinessPartnerInternalID. UUID may have a multiplicity of 1 and may be based on datatype BGDT:UUID.

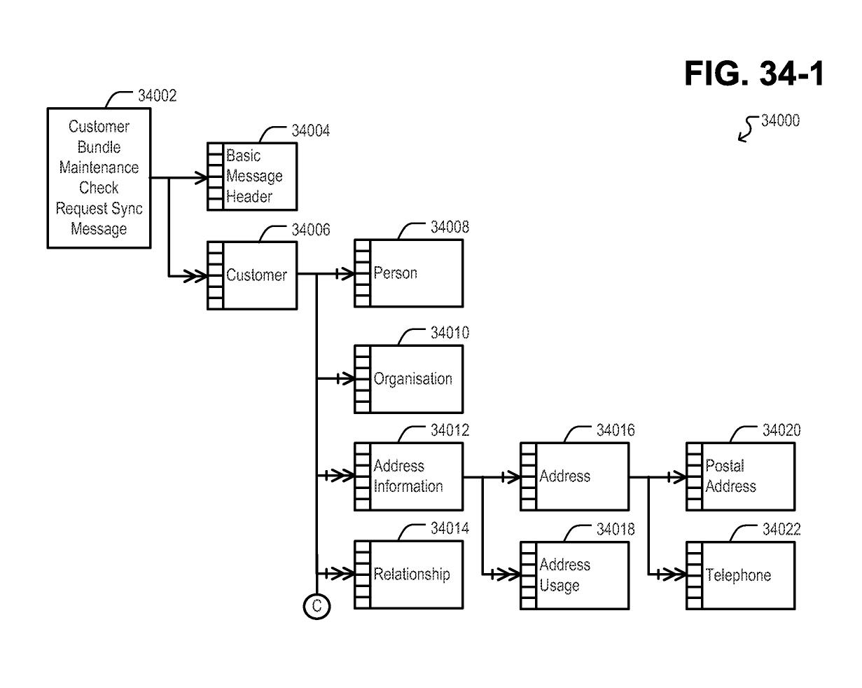

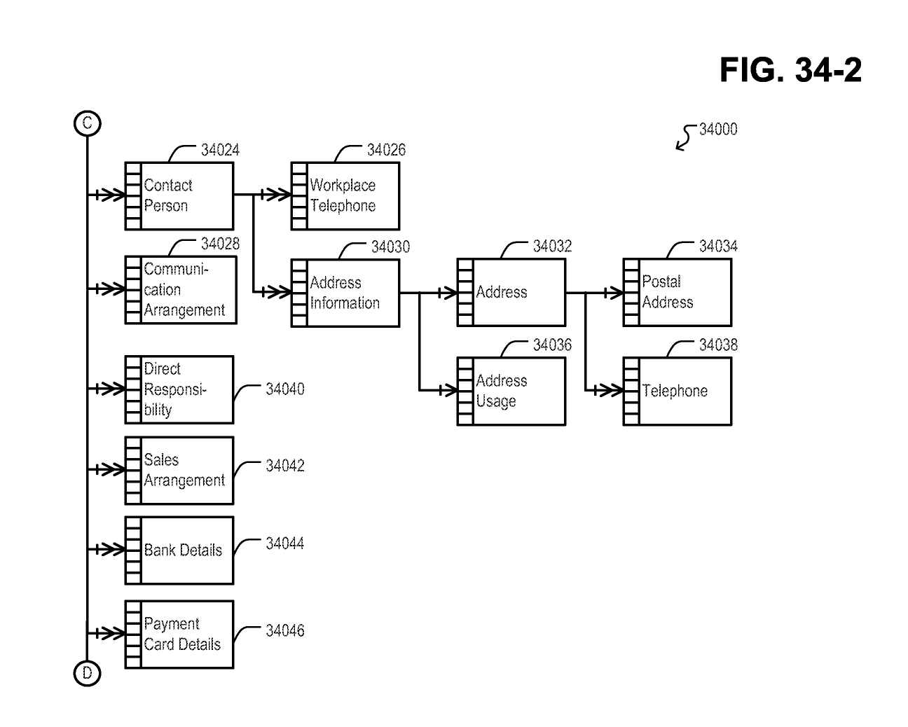

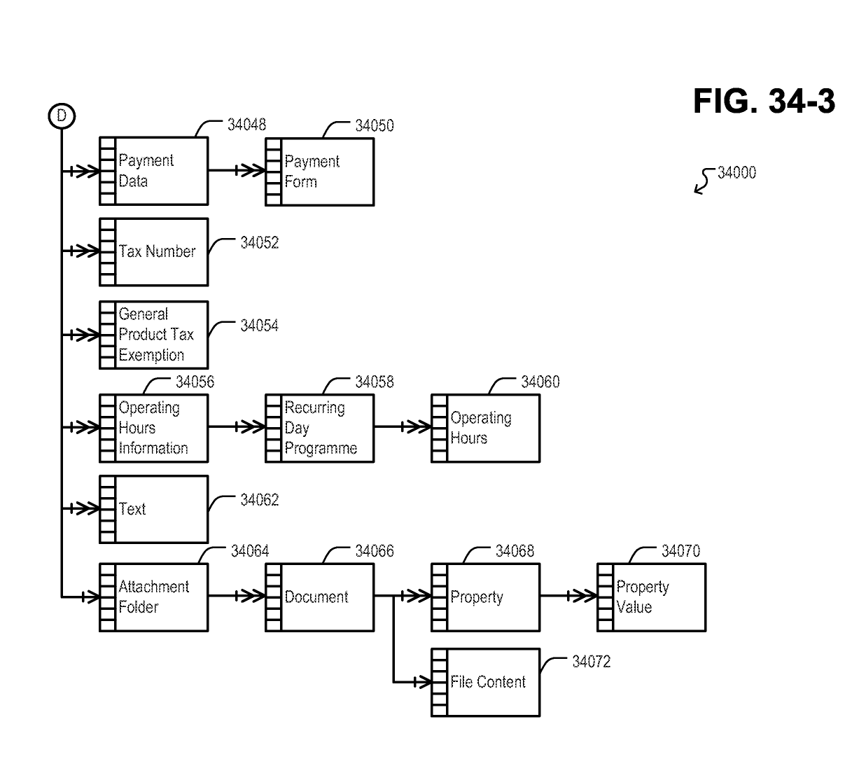

FIGS. 34-1 through 34-3 collectively illustrate one example logical configuration of a Customer Bundle Maintenance Check Request Sync Message 34000. Specifically, these figures depict the arrangement and hierarchy of various components such as one or more levels of packages, entities, and data types, shown here as 34000 through 34072. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer Bundle Maintenance Check Request Sync Message 34000 includes, among other things, one or more Customer entities 34006. Accordingly, heterogeneous applications may communicate using this consistent message configured as such.

The message type Customer Bundle Maintenance Check Request_sync_V1 is derived from the business object Customer as a leading object together with its operation signature. The message type Customer Bundle Maintenance Check Request_sync_V1 is a bundle request to check whether a create or update is possible for customer master data. The structure of the message type Customer Bundle Maintenance Check Request_sync_V1 is determined by the message data type CustomerBundleMaintainRequestMessage_sync_V1. The message data type CustomerBundleMaintainRequestMessage_sync_V1 includes the BasicMessageHeader package and the Customer package. The package BasicMessageHeader includes the entity BasicMessageHeader. BasicMessageHeader is typed by datatype BusinessDocumentBasicMessageHeader.

The package Customer includes the sub-packages Person, Organisation, AddressInformation, Relationship, ContactPerson, CommunicationArrangement, DirectResponsibility, SalesArrangement, BankDetails, PaymentCardDetails, PaymentData, TaxNumber, GeneralProductTaxExemption, OperatingHoursInformation, Text, and AttachmentFolder, and the entity Customer.

Customer includes the following attributes: actionCode, addressInformationListCompleteTransmissionIndicator, bankDetailsListCompleteTransmissionIndicator, communicationArrangementListCompleteTransmissionIndicator, directResponsibilityListCompleteTransmissionIndicator, operatingHoursInformationListCompleteTransmissionIndicator, paymentCardDetailsListCompleteTransmissionIndicator, relationshipListCompleteTransmissionIndicator, salesArrangementListCompleteTransmissionIndicator, taxNumberListCompleteTransmissionIndicator, generalProductTaxExemptionListCompleteTransmissionIndicator, contactPersonListCompleteTransmissionIndicator, paymentDataListCompleteTransmissionIndicator, and textListCompleteTransmissionIndicator.

The attribute actionCode may have a multiplicity of 1 and may be based on datatype BGDT:ActionCode. The attribute addressInformationListCompleteTransmissionIndicator may have a multiplicity of 0 . . . 1 and may be based on datatype CDT:Indicator. The attribute bankDetailsListCompleteTransmissionIndicator may have a multiplicity of 0 . . . 1 and may be based on datatype CDT:Indicator. The attribute communicationArrangementListCompleteTransmissionIndicator may have a multiplicity of 0 . . . 1 and may be based on datatype CDT:Indicator. The attribute directResponsibilityListCompleteTransmissionIndicator may have a multiplicity of 0 . . . 1 and may be based on datatype CDT:Indicator. The attribute operatingHoursInformationListCompleteTransmissionIndicator may have a multiplicity of 0 . . . 1 and may be based on datatype CDT:Indicator. The attribute paymentCardDetailsListCompleteTransmissionIndicator may have a multiplicity of 0 . . . 1 and may be based on datatype CDT:Indicator. The attribute relationshipListCompleteTransmissionIndicator may have a multiplicity of 0 . . . 1 and may be based on datatype CDT:Indicator. The attribute salesArrangementListCompleteTransmissionIndicator may have a multiplicity of 0 . . . 1 and may be based on datatype CDT:Indicator. The attribute taxNumberListCompleteTransmissionIndicator may have a multiplicity of 0 . . . 1 and may be based on datatype CDT:Indicator. The attribute generalProductTaxExemptionListCompleteTransmissionIndicator may have a multiplicity of 0 . . . 1 and may be based on datatype CDT:Indicator. The attribute contactPersonListCompleteTransmissionIndicator may have a multiplicity of 0 . . . 1 and may be based on datatype CDT:Indicator. The attribute paymentDataListCompleteTransmissionIndicator may have a multiplicity of 0 . . . 1 and may be based on datatype CDT:Indicator. The attribute textListCompleteTransmissionIndicator may have a multiplicity of 0 . . . 1 and may be based on datatype CDT:Indicator.

Customer includes the following non-node elements: ObjectNodeSenderTechnicalID, ChangeStateID, UUID, InternalID, CategoryCode, ProspectIndicator, CustomerIndicator, LifeCycleStatusCode, VerbalCommunicationLanguageCode, ContactAllowedCode, LegalCompetenceIndicator, DunAndBradstreetNumberID, GlobalLocationNumberID, ABCClassificationCode, NielsenRegionCode, IndustrialSectorCode, InvoicingBlockingReasonCode, CustomerTransactionDocumentFulfilmentBlockingReasonCode, CustomerBlockingReasonCode, DuplicateCheckApplyIndicator, and EnterpriseIdentificationNumber.

ObjectNodeSenderTechnicalID may have a multiplicity of 0 . . . 1 and may be based on datatype BGDT:ObjectNodePartyTechnicalID. ChangeStateID may have a multiplicity of 0 . . . 1 and may be based on datatype BGDT:ChangeStateID. UUID may have a multiplicity of 0 . . . 1 and may be based on datatype BGDT:UUID. InternalID may have a multiplicity of 0 . . . 1 and may be based on datatype BGDT:BusinessPartnerInternalID. CategoryCode may have a multiplicity of 0 . . . 1 and may be based on datatype BGDT:BusinessPartnerCategoryCode. ProspectIndicator may have a multiplicity of 0 . . . 1 and may be based on datatype CDT:Indicator. CustomerIndicator may have a multiplicity of 0 . . . 1 and may be based on datatype CDT:Indicator. LifeCycleStatusCode may have a multiplicity of 0 . . . 1 and may be based on datatype BGDT:PartyLifeCycleStatusCode. VerbalCommunicationLanguageCode may have a multiplicity of 0 . . . 1 and may be based on datatype BGDT:LanguageCode. ContactAllowedCode may have a multiplicity of 0 . . . 1 and may be based on datatype BGDT:ContactAllowedCode. LegalCompetenceIndicator may have a multiplicity of 0 . . . 1 and may be based on datatype CDT:Indicator. DunAndBradstreetNumberID may have a multiplicity of 0 . . . 1 and may be based on datatype BGDT:BusinessPartnerID. GlobalLocationNumberID may have a multiplicity of 0 . . . 1 and may be based on datatype BGDT:BusinessPartnerID. ABCClassificationCode may have a multiplicity of 0 . . . 1 and may be based on datatype BGDT:CustomerABCClassificationCode. NielsenRegionCode may have a multiplicity of 0 . . . 1 and may be based on datatype BGDT:NielsenRegionCode. IndustrialSectorCode may have a multiplicity of 0 . . . 1 and may be based on datatype BGDT:IndustrialSectorCode. InvoicingBlockingReasonCode may have a multiplicity of 0 . . . 1 and may be based on datatype BGDT:InvoicingBlockingReasonCode. CustomerTransactionDocumentFulfilmentBlockingReasonCode may have a multiplicity of 0 . . . 1 and may be based on datatype BGDT:CustomerTransactionDocumentFulfilmentBlockingReasonCode. CustomerBlockingReasonCode may have a multiplicity of 0 . . . 1 and may be based on datatype BGDT:CustomerBlockingReasonCode. DuplicateCheckApplyIndicator may have a multiplicity of 0 . . . 1 and may be based on datatype CDT:Indicator. EnterpriseIdentificationNumber may have a multiplicity of 0 . . . 1 and may be based on datatype BGDT:BusinessPartnerID.

Customer includes the following node elements: Person, with a cardinality of 1:C; Organisation, with a cardinality of 1:C; AddressInformation, with a cardinality of 1:CN; Relationship, with a cardinality of 1:CN; ContactPerson, with a cardinality of 1:CN; CommunicationArrangement, with a cardinality of 1:CN; DirectResponsibility, with a cardinality of 1:CN; SalesArrangement, with a cardinality of 1:CN; BankDetails, with a cardinality of 1:CN; PaymentCardDetails, with a cardinality of 1:CN; PaymentData, with a cardinality of 1:CN; TaxNumber, with a cardinality of 1:CN; GeneralProductTaxExemption, with a cardinality of 1:CN; OperatingHoursInformation, with a cardinality of 1:CN; Text, with a cardinality of 1:CN; and AttachmentFolder, with a cardinality of 1:C.

The package CustomerPerson includes the entity Person. Person includes the following non-node elements: FormOfAddressCode, AcademicTitleCode, GivenName, MiddleName, FamilyName, BirthName, NickName, NameFormatCountryCode, GenderCode, BirthDate, NonVerbalCommunicationLanguageCode, and OccupationCode. FormOfAddressCode may have a multiplicity of 0 . . . 1 and may be based on datatype BGDT:FormOfAddressCode. AcademicTitleCode may have a multiplicity of 0 . . . 1 and may be based on datatype BGDT:AcademicTitleCode. GivenName may have a multiplicity of 0 . . . 1 and may be based on datatype CDT:LANGUAGEINDEPENDENT_MEDIUM_Name. MiddleName may have a multiplicity of 0 . . . 1 and may be based on datatype CDT:LANGUAGEINDEPENDENT_MEDIUM_Name. FamilyName may have a multiplicity of 0 . . . 1 and may be based on datatype CDT:LANGUAGEINDEPENDENT_MEDIUM_Name. BirthName may have a multiplicity of 0 . . . 1 and may be based on datatype CDT:LANGUAGEINDEPENDENT_MEDIUM_Name. NickName may have a multiplicity of 0 . . . 1 and may be based on datatype CDT:LANGUAGEINDEPENDENT_MEDIUM_Name. NameFormatCountryCode may have a multiplicity of 0 . . . 1 and may be based on datatype BGDT:CountryCode. GenderCode may have a multiplicity of 0 . . . 1 and may be based on datatype BGDT:GenderCode. BirthDate may have a multiplicity of 0 . . . 1 and may be based on datatype CDT:Date, with a qualifier of Birth. NonVerbalCommunicationLanguageCode may have a multiplicity of 0 . . . 1 and may be based on datatype BGDT:LanguageCode, with a qualifier of Communication. OccupationCode may have a multiplicity of 0 . . . 1 and may be based on datatype BGDT:OccupationCode.

The package CustomerOrganisation includes the entity Organisation. Organisation includes the following non-node elements: CompanyLegalFormCode, FirstLineName, and SecondLineName. CompanyLegalFormCode may have a multiplicity of 0 . . . 1 and may be based on datatype BGDT:CompanyLegalFormCode. FirstLineName may have a multiplicity of 0 . . . 1 and may be based on datatype CDT:LANGUAGEINDEPENDENT_MEDIUM_Name. SecondLineName may have a multiplicity of 0 . . . 1 and may be based on datatype CDT:LANGUAGEINDEPENDENT_MEDIUM_Name.

The package CustomerAddressInformation includes the sub-package AddressInformationUsage and the entity AddressInformation. AddressInformation includes the following attributes: addressUsageListCompleteTransmissionIndicator and actionCode. The attribute actionCode may have a multiplicity of 0 . . . 1 and may be based on datatype BGDT:ActionCode. The attribute addressUsageListCompleteTransmissionIndicator may have a multiplicity of 0 . . . 1 and may be based on datatype CDT:Indicator. AddressInformation includes the following non-node elements: ObjectNodeSenderTechnicalID and UUID. ObjectNodeSenderTechnicalID may have a multiplicity of 0 . . . 1 and may be based on datatype BGDT:ObjectNodePartyTechnicalID. UUID may have a multiplicity of 0 . . . 1 and may be based on datatype BGDT:UUID. AddressInformation includes the following node elements: Address, with a cardinality of 1:C; and AddressUsage, with a cardinality of 1:CN.

Address includes the following attributes: telephoneListCompleteTransmissionIndicator and actionCode. The attribute actionCode may have a multiplicity of 0 . . . 1 and may be based on datatype BGDT:ActionCode. The attribute telephoneListCompleteTransmissionIndicator may have a multiplicity of 0 . . . 1 and may be based on datatype CDT:Indicator. Address includes the following non-node elements: CorrespondenceLanguageCode, PreferredCommunicationMediumTypeCode, EmailURI, FacsimileFormattedNumberDescription, and WebURI. CorrespondenceLanguageCode may have a multiplicity of 0 . . . 1 and may be based on datatype BGDT:LanguageCode. PreferredCommunicationMediumTypeCode may have a multiplicity of 0 . . . 1 and may be based on datatype BGDT:CommunicationMediumTypeCode. EmailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. WebURI may have a multiplicity of 0 . . . 1 and may be based on datatype BGDT:WebURI. Address includes the following node elements: PostalAddress, with a cardinality of 1:C; and Telephone, with a cardinality of 1:CN.

PostalAddress includes the following non-node elements: CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, CareOfName, POBoxDeviatingCountryCode, POBoxDeviatingRegionCode, POBoxDeviatingCityName, POBoxID, POBoxIndicator, TaxJurisdictionCode, and TimeZoneCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

The package CustomerAddressInformationAddressInformationAddress includes the entity Telephone. Telephone includes the following non-node elements: ObjectNodeSenderTechnicalID, FormattedNumberDescription, and MobilePhoneNumberIndicator. ObjectNodeSenderTechnicalID may have a multiplicity of 0 . . . 1 and may be based on datatype BGDT:ObjectNodePartyTechnicalID. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

The package CustomerAddressInformationAddressInformationUsage includes the entity AddressUsage. AddressUsage includes the actionCode attribute, which may have a multiplicity of 0 . . . 1 and may be based on datatype BGDT:ActionCode. AddressUsage includes the following non-node elements: ObjectNodeSenderTechnicalID, AddressUsageCode, and DefaultIndicator. ObjectNodeSenderTechnicalID may have a multiplicity of 0 . . . 1 and may be based on datatype BGDT:ObjectNodePartyTechnicalID. AddressUsageCode may have a multiplicity of 1 and may be based on datatype BGDT:AddressUsageCode. DefaultIndicator may have a multiplicity of 0 . . . 1 and may be based on datatype CDT:Indicator.

The package CustomerRelationship includes the entity Relationship. Relationship includes the actionCode attribute, which may have a multiplicity of 0 . . . 1 and may be based on datatype BGDT:ActionCode. Relationship includes the following non-node elements: ObjectNodeSenderTechnicalID, RelationshipBusinessPartnerUUID, RelationshipBusinessPartnerInternalID, and RoleCode. ObjectNodeSenderTechnicalID may have a multiplicity of 0 . . . 1 and may be based on datatype BGDT:ObjectNodePartyTechnicalID. RelationshipBusinessPartnerUUID may have a multiplicity of 0 . . . 1 and may be based on datatype BGDT:UUID. RelationshipBusinessPartnerInternalID may have a multiplicity of 0 . . . 1 and may be based on datatype BGDT:BusinessPartnerInternalID. RoleCode may have a multiplicity of 1 and may be based on datatype BGDT:BusinessPartnerRelationshipRoleCode.

The package CustomerContactPerson includes the sub-package AddressInformation and the entity ContactPerson. ContactPerson includes the following node elements: WorkplaceTelephone, in a 1:CN cardinality relationship; and AddressInformation, in a 1:CN cardinality relationship. ContactPerson includes the following attributes: actionCode, workplaceTelephoneListCompleteTransmissionIndicator, and addressInformationListCompleteTransmissionIndicator. The attribute actionCode may have a multiplicity of 0 . . . 1 and may be based on datatype BGDT:ActionCode. The attribute workplaceTelephoneListCompleteTransmissionIndicator may have a multiplicity of 0 . . . 1 and may be based on datatype CDT:Indicator. The attribute addressInformationListCompleteTransmissionIndicator may have a multiplicity of 0 . . . 1 and may be based on datatype CDT:Indicator. ContactPerson includes the following non-node elements: ObjectNodeSenderTechnicalID, BusinessPartnerContactUUID, BusinessPartnerContactInternalID, DefaultContactPersonIndicator, FormOfAddressCode, AcademicTitleCode, GivenName, MiddleName, FamilyName, BirthName, NickName, GenderCode, BirthDate, NonVerbalCommunicationLanguageCode, OccupationCode, BusinessPartnerFunctionTypeCode, BusinessPartnerFunctionalAreaCode, VIPReasonCode, WorkplaceBusinessAddressUUID, WorkplacePreferredCommunicationMediumTypeCode, WorkplaceEmailURI, WorkplaceFacsimileFormattedNumberDescription, WorkplaceWebURI, WorkplaceFunctionalTitleName, WorkplaceDepartmentName, WorkplaceBuildingID, WorkplaceFloorID, WorkplaceRoomID, LifeCycleStatusCode, and MaritalStatusCode.

ObjectNodeSenderTechnicalID may have a multiplicity of 0 . . . 1 and may be based on datatype BGDT:ObjectNodePartyTechnicalID. BusinessPartnerContactUUID may have a multiplicity of 0 . . . 1 and may be based on datatype BGDT:UUID. BusinessPartnerContactlnternalID may have a multiplicity of 0 . . . 1 and may be based on datatype BGDT:BusinessPartnerInternalID. DefaultContactPersonIndicator may have a multiplicity of 0 . . . 1 and may be based on datatype CDT:Indicator. FormOfAddressCode may have a multiplicity of 0 . . . 1 and may be based on datatype BGDT:FormOfAddressCode. AcademicTitleCode may have a multiplicity of 0 . . . 1 and may be based on datatype BGDT:AcademicTitleCode. GivenName may have a multiplicity of 0 . . . 1 and may be based on datatype CDT:LANGUAGEINDEPENDENT_MEDIUM_Name. MiddleName may have a multiplicity of 0 . . . 1 and may be based on datatype CDT:LANGUAGEINDEPENDENT_MEDIUM_Name. FamilyName may have a multiplicity of 0 . . . 1 and may be based on datatype CDT:LANGUAGEINDEPENDENT_MEDIUM_Name. BirthName may have a multiplicity of 0 . . . 1 and may be based on datatype CDT:LANGUAGEINDEPENDENT_MEDIUM_Name. NickName may have a multiplicity of 0 . . . 1 and may be based on datatype CDT:LANGUAGEINDEPENDENT_MEDIUM_Name. GenderCode may have a multiplicity of 0 . . . 1 and may be based on datatype BGDT:GenderCode. BirthDate may have a multiplicity of 0 . . . 1 and may be based on datatype CDT:Date. NonVerbalCommunicationLanguageCode may have a multiplicity of 0 . . . 1 and may be based on datatype BGDT:LanguageCode. OccupationCode may have a multiplicity of 0 . . . 1 and may be based on datatype BGDT:OccupationCode. BusinessPartnerFunctionTypeCode may have a multiplicity of 0 . . . 1 and may be based on datatype BGDT:BusinessPartnerFunctionTypeCode. BusinessPartnerFunctionalAreaCode may have a multiplicity of 0 . . . 1 and may be based on datatype BGDT:BusinessPartnerFunctionalAreaCode. VIPReasonCode may have a multiplicity of 0 . . . 1 and may be based on datatype BGDT:VIPReasonCode. WorkplaceBusinessAddressUUID may have a multiplicity of 0 . . . 1 and may be based on datatype BGDT:UUID. WorkplacePreferredCommunicationMediumTypeCode may have a multiplicity of 0 . . . 1 and may be based on datatype BGDT:CommunicationMediumTypeCode. WorkplaceEmailURI may have a multiplicity of 0 . . . 1 and may be based on datatype BGDT:EmailURI. WorkplaceFacsimileFormattedNumberDescription may have a multiplicity of 0 . . . 1 and may be based on datatype BGDT:LANGUAGEINDEPENDENT_SHORT_Description. WorkplaceWebURI may have a multiplicity of 0 . . . 1 and may be based on datatype BGDT:WebURI. WorkplaceFunctionalTitleName may have a multiplicity of 0 . . . 1 and may be based on datatype CDT:LANGUAGEINDEPENDENT_MEDIUM_Name. WorkplaceDepartmentName may have a multiplicity of 0 . . . 1 and may be based on datatype CDT:LANGUAGEINDEPENDENT_MEDIUM_Name. WorkplaceBuildingID may have a multiplicity of 0 . . . 1 and may be based on datatype BGDT:BuildingID. WorkplaceFloorID may have a multiplicity of 0 . . . 1 and may be based on datatype BGDT:FloorID. WorkplaceRoomID may have a multiplicity of 0 . . . 1 and may be based on datatype BGDT:RoomID LifeCycleStatusCode may have a multiplicity of 0 . . . 1 and may be based on datatype BGDT:PartyLifeCycleStatusCode. MaritalStatusCode may have a multiplicity of 0 . . . 1 and may be based on datatype BGDT:MaritalStatusCode.

The package CustomerContactPerson includes the entity WorkplaceTelephone. WorkplaceTelephone includes the following non-node elements: ObjectNodeSenderTechnicalID, FormattedNumberDescription, and MobilePhoneNumberIndicator. ObjectNodeSenderTechnicalID may have a multiplicity of 0 . . . 1 and may be based on datatype BGDT:ObjectNodePartyTechnicalID. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

The package CustomerContactPersonAddressInformation includes the entity AddressInformation. AddressInformation includes the actionCode attribute, which may have a multiplicity of 0 . . . 1 and may be based on datatype BGDT:ActionCode. AddressInformation includes the following non-node elements: ObjectNodeSenderTechnicalID and UUID. ObjectNodeSenderTechnicalID may have a multiplicity of 0 . . . 1 and may be based on datatype BGDT:ObjectNodePartyTechnicalID. UUID may have a multiplicity of 0 . . . 1 and may be based on datatype BGDT:UUID. AddressInformation includes the following node elements: Address, in a 1:C cardinality relationship; and AddressUsage, in a 1:C cardinality relationship.

Address includes the following attributes: actionCode and telephoneListCompleteTransmissionIndicator. The attribute actionCode may have a multiplicity of 0 . . . 1 and may be based on datatype BGDT:ActionCode. The attribute telephoneListCompleteTransmissionIndicator may have a multiplicity of 0 . . . 1 and may be based on datatype CDT:Indicator. Address includes the following non-node elements: ObjectNodeSenderTechnicalID, EmailURI, and FacsimileFormattedNumberDescription. ObjectNodeSenderTechnicalID may have a multiplicity of 0 . . . 1 and may be based on datatype BGDT:ObjectNodePartyTechnicalID. EmailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. Address includes the following node elements: PostalAddress, in a 1:C cardinality relationship; and Telephone, in a 1:CN cardinality relationship.

PostalAddress includes the following non-node elements: CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, CareOfName, POBoxDeviatingCountryCode, POBoxDeviatingRegionCode, POBoxDeviatingCityName, POBoxID, POBoxIndicator, TaxJurisdictionCode, and TimeZoneCode. CountryCode may have a multiplicity of 0 . . . 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

Telephone includes the following non-node elements: ObjectNodeSenderTechnicalID, FormattedNumberDescription, and MobilePhoneNumberIndicator. ObjectNodeSenderTechnicalID may have a multiplicity of 0 . . . 1 and may be based on datatype BGDT:ObjectNodePartyTechnicalID. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

AddressUsage includes the actionCode attribute, which may have a multiplicity of 0 . . . 1 and may be based on datatype BGDT:ActionCode. AddressUsage includes the following non-node elements: ObjectNodeSenderTechnicalID, AddressUsageCode, and DefaultIndicator. ObjectNodeSenderTechnicalID may have a multiplicity of 0 . . . 1 and may be based on datatype BGDT:ObjectNodePartyTechnicalID. AddressUsageCode may have a multiplicity of 1 and may be based on datatype BGDT:AddressUsageCode. DefaultIndicator may have a multiplicity of 0 . . . 1 and may be based on datatype CDT:Indicator.

The package CustomerCommunicationArrangement includes the entity CommunicationArrangement. CommunicationArrangement includes the actionCode attribute, which may have a multiplicity of 0 . . . 1 and may be based on datatype BGDT:ActionCode. CommunicationArrangement includes the following non-node elements: ObjectNodeSenderTechnicalID, UUID, CompoundServiceInterfaceCode, EnabledIndicator, CommunicationMediumTypeCode, OutputRequestFormTemplateCode, EMailURI, FacsimileFormattedNumberDescription, and OutputCopyNumberValue. ObjectNodeSenderTechnicalID may have a multiplicity of 0 . . . 1 and may be based on datatype BGDT:ObjectNodePartyTechnicalID. UUID may have a multiplicity of 0 . . . 1 and may be based on datatype BGDT:UUID. CompoundServiceInterfaceCode may have a multiplicity of 0 . . . 1 and may be based on datatype BGDT:CompoundServiceInterfaceCode. EnabledIndicator may have a multiplicity of 0 . . . 1 and may be based on datatype CDT:Indicator. CommunicationMediumTypeCode may have a multiplicity of 0 . . . 1 and may be based on datatype BGDT:CommunicationMediumTypeCode. OutputRequestFormTemplateCode may have a multiplicity of 0 . . . 1 and may be based on datatype BGDT:OutputRequestFormTemplateCode. EMailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. OutputCopyNumberValue may have a multiplicity of 0 . . . 1 and may be based on datatype BGDT:NumberValue.

The package CustomerDirectResponsibility includes the entity DirectResponsibility. DirectResponsibility includes the actionCode attribute, which may have a multiplicity of 0 . . . 1 and may be based on datatype BGDT:ActionCode. DirectResponsibility includes the following non-node elements: ObjectNodeSenderTechnicalID, PartyRoleCode, and EmployeeID. ObjectNodeSenderTechnicalID may have a multiplicity of 0 . . . 1 and may be based on datatype BGDT:ObjectNodePartyTechnicalID. PartyRoleCode may have a multiplicity of 0 . . . 1 and may be based on datatype BGDT:PartyRoleCode. EmployeeID may have a multiplicity of 0 . . . 1 and may be based on datatype BGDT:EmployeeID.

The package CustomerSalesArrangement includes the entity SalesArrangement. SalesArrangement includes the actionCode attribute, which may have a multiplicity of 0 . . . 1 and may be based on datatype BGDT:ActionCode. SalesArrangement includes the following non-node elements: ObjectNodeSenderTechnicalID, SalesOrganisationID, DistributionChannelCode, Incoterms, DeliveryPriorityCode, CompleteDeliveryRequestedIndicator, CurrencyCode, CustomerGroupCode, and CashDiscountTermsCode. ObjectNodeSenderTechnicalID may have a multiplicity of 0 . . . 1 and may be based on datatype BGDT:ObjectNodePartyTechnicalID. SalesOrganisationID may have a multiplicity of 0 . . . 1 and may be based on datatype BGDT:OrganisationalCentreID. DistributionChannelCode may have a multiplicity of 0 . . . 1 and may be based on datatype BGDT:DistributionChannelCode. Incoterms may have a multiplicity of 0 . . . 1 and may be based on datatype AGDT:Incoterms. DeliveryPriorityCode may have a multiplicity of 0 . . . 1 and may be based on datatype BGDT:PriorityCode. CompleteDeliveryRequestedIndicator may have a multiplicity of 0 . . . 1 and may be based on datatype CDT:Indicator. CurrencyCode may have a multiplicity of 0 . . . 1 and may be based on datatype BGDT:CurrencyCode. CustomerGroupCode may have a multiplicity of 0 . . . 1 and may be based on datatype BGDT:CustomerGroupCode. CashDiscountTermsCode may have a multiplicity of 0 . . . 1 and may be based on datatype BGDT:CashDiscountTermsCode.

The package CustomerBankDetails includes the entity BankDetails. BankDetails includes the actionCode attribute, which may have a multiplicity of 0 . . . 1 and may be based on datatype BGDT:ActionCode. BankDetails includes the following non-node elements: ObjectNodeSenderTechnicalID, ID, BankUUID, BanklnternalID, BankRoutingID, BankRoutingIDTypeCode, BankStandardID, BankAccountID, BankAccountIDCheckDigitValue, BankAccountTypeCode, BankAccountHolderName, BankAccountStandardID, and ValidityPeriod. ObjectNodeSenderTechnicalID may have a multiplicity of 0 . . . 1 and may be based on datatype BGDT:ObjectNodePartyTechnicalID. ID may have a multiplicity of 0 . . . 1 and may be based on datatype BGDT:BusinessPartnerBankDetailsID. BankUUID may have a multiplicity of 0 . . . 1 and may be based on datatype BGDT:UUID. BankInternalID may have a multiplicity of 0 . . . 1 and may be based on datatype BGDT:BankInternalID. BankRoutingID may have a multiplicity of 0 . . . 1 and may be based on datatype BGDT:BankRoutingID. BankRoutingIDTypeCode may have a multiplicity of 0 . . . 1 and may be based on datatype BGDT:BankRoutingIDTypeCode. BankStandardID may have a multiplicity of 0 . . . 1 and may be based on datatype BGDT:BankStandardID. BankAccountID may have a multiplicity of 0 . . . 1 and may be based on datatype BGDT:BankAccountID. BankAccountIDCheckDigitValue may have a multiplicity of 0 . . . 1 and may be based on datatype BGDT:BankAccountIDCheckDigitValue. BankAccountTypeCode may have a multiplicity of 0 . . . 1 and may be based on datatype BGDT:BankAccountTypeCode. BankAccountHolderName may have a multiplicity of 0 . . . 1 and may be based on datatype BGDT:BankAccountHolderName_V1. BankAccountStandardID may have a multiplicity of 0 . . . 1 and may be based on datatype BGDT:BankAccountStandardID. ValidityPeriod may have a multiplicity of 0 . . . 1 and may be based on datatype AGDT:CLOSED_DatePeriod.

The package CustomerPaymentCardDetails includes the entity PaymentCardDetails. PaymentCardDetails includes the actionCode attribute, which may have a multiplicity of 0 . . . 1 and may be based on datatype BGDT:ActionCode. PaymentCardDetails includes the following non-node elements: ObjectNodeSenderTechnicalID, ID, PaymentCardTypeCode, PaymentCardID, PaymentCardHolderName, PaymentCardExpirationDate, DefaultIndicator, BlockingReasonCode, StreetName, HouseID, PostalCode, CityName, RegionCode, and CountryCode. ObjectNodeSenderTechnicalID may have a multiplicity of 0 . . . 1 and may be based on datatype BGDT:ObjectNodePartyTechnicalID. ID may have a multiplicity of 0 . . . 1 and may be based on datatype BGDT:BusinessPartnerPaymentCardDetailsID. PaymentCardTypeCode may have a multiplicity of 0 . . . 1 and may be based on datatype BGDT:PaymentCardTypeCode. PaymentCardID may have a multiplicity of 0 . . . 1 and may be based on datatype BGDT:PaymentCardID. PaymentCardHolderName may have a multiplicity of 0 . . . 1 and may be based on datatype CDT:LANGUAGEINDEPENDENT_MEDIUM_Name. PaymentCardExpirationDate may have a multiplicity of 0 . . . 1 and may be based on datatype CDT:Date, with a qualifier of Expiration. DefaultIndicator may have a multiplicity of 0 . . . 1 and may be based on datatype CDT:Indicator. BlockingReasonCode may have a multiplicity of 0 . . . 1 and may be based on datatype BGDT:PaymentCardBlockingReasonCode. StreetName may have a multiplicity of 0 . . . 1 and may be based on datatype BGDT:StreetName. HouseID may have a multiplicity of 0 . . . 1 and may be based on datatype BGDT:HouseID. PostalCode may have a multiplicity of 0 . . . 1 and may be based on datatype BGDT:PostalCode. CityName may have a multiplicity of 0 . . . 1 and may be based on datatype CDT:LANGUAGEINDEPENDENT_MEDIUM_Name. RegionCode may have a multiplicity of 0 . . . 1 and may be based on datatype BGDT:RegionCode. CountryCode may have a multiplicity of 0 . . . 1 and may be based on datatype BGDT:CountryCode.

The package CustomerPaymentData includes the entity PaymentData. PaymentData includes the following attributes: paymentFormListCompleteTransmissionIndicator and actionCode. The attribute actionCode may have a multiplicity of 0 . . . 1 and may be based on datatype BGDT:ActionCode. The attribute paymentFormListCompleteTransmissionIndicator may have a multiplicity of 0 . . . 1 and may be based on datatype CDT:Indicator. PaymentData includes the following non-node elements: ObjectNodeSenderTechnicalID, CompanyID, UUID, AccountDeterminationDebtorGroupCode, AccountDebtorExternalID, PaymentBlockingReasonCode, PaymentBlockExpirationDateTime, CreditLimitAmount, DirectDebitBankDetailsID, DirectDebitValidityPeriod, PaymentCardDetailsID, PaymentCardValidityPeriod, BillOfExchangeBankDetailsID, PaymentAdviceRequiredIndicator, FirstPaymentInstructionCode, SecondPaymentInstructionCode, ThirdPaymentInstructionCode, FourthPaymentInstructionCode, and BankChargeBearerCode. ObjectNodeSenderTechnicalID may have a multiplicity of 0 . . . 1 and may be based on datatype BGDT:ObjectNodePartyTechnicalID. CompanyID may have a multiplicity of 1 and may be based on datatype BGDT:OrganisationalCentreID. UUID may have a multiplicity of 0 . . . 1 and may be based on datatype BGDT:UUID. AccountDeterminationDebtorGroupCode may have a multiplicity of 0 . . . 1 and may be based on datatype BGDT:AccountDeterminationDebtorGroupCode. AccountDebtorExternalID may have a multiplicity of 0 . . . 1 and may be based on datatype BGDT:PartyPartyID. PaymentBlockingReasonCode may have a multiplicity of 0 . . . 1 and may be based on datatype BGDT:PaymentBlockingReasonCode. PaymentBlockExpirationDateTime may have a multiplicity of 0 . . . 1 and may be based on datatype CDT:GLOBAL_DateTime. CreditLimitAmount may have a multiplicity of 0 . . . 1 and may be based on datatype CDT:Amount. DirectDebitBankDetailsID may have a multiplicity of 0 . . . 1 and may be based on datatype BGDT:BusinessPartnerBankDetailsID. DirectDebitValidityPeriod may have a multiplicity of 0 . . . 1 and may be based on datatype AGDT:CLOSED_DatePeriod. PaymentCardDetailsID may have a multiplicity of 0 . . . 1 and may be based on datatype BGDT:BusinessPartnerPaymentCardDetailsID. PaymentCardValidityPeriod may have a multiplicity of 0 . . . 1 and may be based on datatype AGDT:CLOSED_DatePeriod. BillOfExchangeBankDetailsID may have a multiplicity of 0 . . . 1 and may be based on datatype BGDT:BusinessPartnerBankDetailsID. PaymentAdviceRequiredIndicator may have a multiplicity of 0 . . . 1 and may be based on datatype CDT:Indicator. FirstPaymentInstructionCode may have a multiplicity of 0 . . . 1 and may be based on datatype BGDT:PaymentInstructionTypeCode. SecondPaymentInstructionCode may have a multiplicity of 0 . . . 1 and may be based on datatype BGDT:PaymentInstructionTypeCode. ThirdPaymentInstructionCode may have a multiplicity of 0 . . . 1 and may be based on datatype BGDT:PaymentInstructionTypeCode. FourthPaymentInstructionCode may have a multiplicity of 0 . . . 1 and may be based on datatype BGDT:PaymentInstructionTypeCode. BankChargeBearerCode may have a multiplicity of 0 . . . 1 and may be based on datatype BGDT:BankChargeBearerCode. PaymentData includes the following node elements: PaymentForm, in a 1:CN cardinality relationship.

PaymentForm includes the actionCode attribute, which may have a multiplicity of 0 . . . 1 and may be based on datatype BGDT:ActionCode. PaymentForm includes the following non-node elements: PaymentFormCode and ObjectNodeSenderTechnicalID. ObjectNodeSenderTechnicalID may have a multiplicity of 0 . . . 1 and may be based on datatype BGDT:ObjectNodePartyTechnicalID. PaymentFormCode may have a multiplicity of 1 and may be based on datatype BGDT:PaymentFormCode.

The package CustomerTaxNumber includes the entity TaxNumber. TaxNumber includes actionCode attribute, which may have a multiplicity of 0 . . . 1 and may be based on datatype BGDT:ActionCode. TaxNumber includes the following non-node elements: ObjectNodeSenderTechnicalID, CountryCode, TaxIdentificationNumberTypeCode, and PartyTaxID. ObjectNodeSenderTechnicalID may have a multiplicity of 0 . . . 1 and may be based on datatype BGDT:ObjectNodePartyTechnicalID. CountryCode may have a multiplicity of 1 and may be based on datatype BGDT:CountryCode. TaxIdentificationNumberTypeCode may have a multiplicity of 1 and may be based on datatype BGDT:TaxIdentificationNumberTypeCode. PartyTaxID may have a multiplicity of 0 . . . 1 and may be based on datatype BGDT:PartyTaxID.

The package CustomerGeneralProductTaxExemption includes the entity GeneralProductTaxExemption. GeneralProductTaxExemption includes the actionCode attribute, which may have a multiplicity of 0 . . . 1 and may be based on datatype BGDT:ActionCode. GeneralProductTaxExemption includes the following non-node elements: ObjectNodeSenderTechnicalID, CountryCode, RegionCode, TaxTypeCode, and ReasonCode. ObjectNodeSenderTechnicalID may have a multiplicity of 0 . . . 1 and may be based on datatype BGDT:ObjectNodePartyTechnicalID. CountryCode may have a multiplicity of 0 . . . 1 and may be based on datatype BGDT:CountryCode. RegionCode may have a multiplicity of 0 . . . 1 and may be based on datatype BGDT:RegionCode. TaxTypeCode may have a multiplicity of 0 . . . 1 and may be based on datatype BGDT:TaxTypeCode. ReasonCode may have a multiplicity of 0 . . . 1 and may be based on datatype BGDT:TaxExemptionReasonCode.

The package CustomerOperatingHoursInformation includes the entity OperatingHoursInformation. OperatingHoursInformation includes the following attributes: actionCode and recurringDayProgrammeListCompleteTransmissionIndicator. The attribute actionCode may have a multiplicity of 0 . . . 1 and may be based on datatype BGDT:ActionCode. The attribute recurringDayProgrammeListCompleteTransmissionIndicator may have a multiplicity of 0 . . . 1 and may be based on datatype CDT:Indicator. OperatingHoursInformation includes the following non-node elements: RoleCode and ObjectNodeSenderTechnicalID. ObjectNodeSenderTechnicalID may have a multiplicity of 0 . . . 1 and may be based on datatype BGDT:ObjectNodePartyTechnicalID. RoleCode may have a multiplicity of 1 and may be based on datatype BGDT:BUSINESSPARTNER_OperatingHoursRoleCode. OperatingHoursInformation includes the following node elements: RecurringDayProgramme, in a 1:CN cardinality relationship.

The package CustomerOperatingHoursInformation includes the entity RecurringDayProgramme RecurringDayProgramme includes the operatingHoursListCompleteTransmissionIndicator attribute, which may have a multiplicity of 0 . . . 1 and may be based on datatype CDT:Indicator. RecurringDayProgramme includes the following non-node elements: WeekdaySelection and ObjectNodeSenderTechnicalID. ObjectNodeSenderTechnicalID may have a multiplicity of 0 . . . 1 and may be based on datatype BGDT:ObjectNodePartyTechnicalID. WeekdaySelection may have a multiplicity of 0 . . . 1 and may be based on datatype AGDT:WeekdaySelection.

RecurringDayProgramme includes the following node elements: OperatingHours, in a 1:CN cardinality relationship. OperatingHours includes the following non-node elements: TimePeriod and ObjectNodeSenderTechnicalID. ObjectNodeSenderTechnicalID may have a multiplicity of 0 . . . 1 and may be based on datatype BGDT:ObjectNodePartyTechnicalID. TimePeriod may have a multiplicity of 1 and may be based on datatype AGDT:UPPEROPEN_TimePeriod.

The package CustomerText includes the entity Text. Text includes the actionCode attribute, which may have a multiplicity of 0 . . . 1 and may be based on datatype BGDT:ActionCode. Text includes the following non-node elements: ObjectNodeSenderTechnicalID, TypeCode, and ContentText. ObjectNodeSenderTechnicalID may have a multiplicity of 0 . . . 1 and may be based on datatype BGDT:ObjectNodePartyTechnicalID. TypeCode may have a multiplicity of 0 . . . 1 and may be based on datatype BGDT:TextCollectionTextTypeCode. ContentText may have a multiplicity of 0 . . . 1 and may be based on datatype CDT:LANGUAGEINDEPENDENT_Text.

The package CustomerAttachmentFolder includes the entity AttachmentFolder. AttachmentFolder includes the following attributes: ActionCode and DocumentListCompleteTransmissionIndicator. DocumentListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. AttachmentFolder includes the following non-node elements: UUID. UUID may have a multiplicity of 0 . . . 1 and may be based on datatype BGDT:UUID. AttachmentFolder includes the following node elements: Document, in a 1:CN cardinality relationship.

The package CustomerAttachmentFolder includes the entity Document. Document includes the following attributes: ActionCode and PropertyListCompleteTransmissionIndicator. PropertyListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. Document includes the following non-node elements: UUID, LinklnternalIndicator, VisibleIndicator, CategoryCode, TypeCode, MIMECode, Name, AlternativeName, InternalLinkUUID, Description, and ExternalLinkWebURI. UUID may have a multiplicity of 0 . . . 1 and may be based on datatype BGDT:UUID. LinkInternalIndicator may have a multiplicity of 0 . . . 1 and may be based on datatype CDT:Indicator. VisibleIndicator may have a multiplicity of 0 . . . 1 and may be based on datatype CDT:Indicator. CategoryCode may have a multiplicity of 0 . . . 1 and may be based on datatype BGDT:DocumentCategoryCode. TypeCode may have a multiplicity of 0 . . . 1 and may be based on datatype BGDT:DocumentTypeCode. MIMECode may have a multiplicity of 0 . . . 1 and may be based on datatype BGDT:MIMECode. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. Description may have a multiplicity of 0 . . . 1 and may be based on datatype BGDT:Description. ExternalLinkWebURI may have a multiplicity of 0 . . . 1 and may be based on datatype BGDT:WebURI. Document includes the following node elements: Property, in a 1:CN cardinality relationship; and FileContent, in a 1:C cardinality relationship.

Property includes the following attributes: ActionCode and PropertyValueListCompleteTransmissionIndicator. PropertyValueListCompleteTransmissionIndicator may have a multiplicity of 0 . . . 1 and may be based on datatype CDT:Indicator. ActionCode may have a multiplicity of 0 . . . 1 and may be based on datatype BGDT:ActionCode. Property includes the following non-node elements: TechnicalID, Name, DataTypeFormatCode, VisibleIndicator, ChangeAllowedIndicator, MultipleValueIndicator, NamespaceURI, and Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0 . . . 1 and may be based on datatype BGDT:PropertyDataTypeFormatCode. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description. Property includes the following node elements: PropertyValue, in a 1:CN cardinality relationship.

PropertyValue includes the ActionCode attribute, which may have a multiplicity of 0 . . . 1 and may be based on datatype BGDT:ActionCode. PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

FileContent includes the ActionCode attribute, which may have a multiplicity of 0 . . . 1 and may be based on datatype BGDT:ActionCode. FileContent includes the following non-node elements: TechnicalID and BinaryObject. TechnicalID may have a multiplicity of 0 . . . 1 and may be based on datatype BGDT:ObjectNodeTechnicalID. BinaryObject may have a multiplicity of 0 . . . 1 and may be based on datatype CDT:BinaryObject.

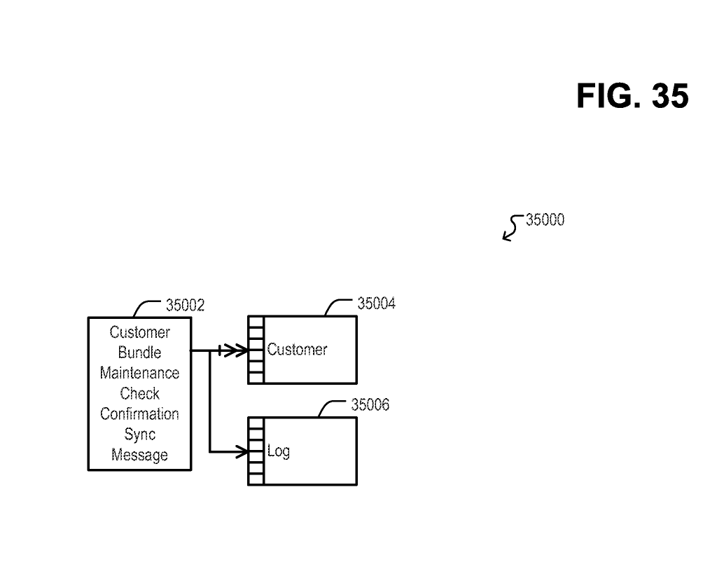

FIG. 35 illustrates one example logical configuration of a Customer Bundle Maintenance Check Confirmation Sync Message 35000. Specifically, this figure depicts the arrangement and hierarchy of various components such as one or more levels of packages, entities, and data types, shown here as 35000 through 35006. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer Bundle Maintenance Check Confirmation Sync Message 35000 includes, among other things, one or more Customer entities 35004. Accordingly, heterogeneous applications may communicate using this consistent message configured as such.

The message type Customer Bundle Maintenance Check Confirmation_sync is derived from the business object Customer as a leading object together with its operation signature. The message type Customer Bundle Maintenance Check Confirmation_sync is a reply to a request to check whether a migration is possible, and includes individual replies to requests in a bundle, which can be positive or negative. A confirmation message can include the ID and UUID of a migrated customer. The structure of the message type Customer Bundle Maintenance Check Confirmation_sync is determined by the message data type CustomerBundleMaintainConfirmationMessage_sync. The message data type CustomerBundleMaintainConfirmationMessage_sync includes the Customer package and the Log package. The package Log includes the entity Log. Log is typed by datatype Log.

The package Customer includes the entity Customer. Customer includes the following attributes: ChangeStateID and ReferenceObjectNodeSenderTechnicalID. ReferenceObjectNodeSenderTechnicalID may have a multiplicity of 1 and may be based on datatype BGDT:ObjectNodePartyTechnicalID. ChangeStateID may have a multiplicity of 1 and may be based on datatype BGDT:ChangeStateID. Customer includes the following non-node elements: UUID and InternalID. InternalID may have a multiplicity of 1 and may be based on datatype BGDT:BusinessPartnerInternalID. UUID may have a multiplicity of 1 and may be based on datatype BGDT:UUID.

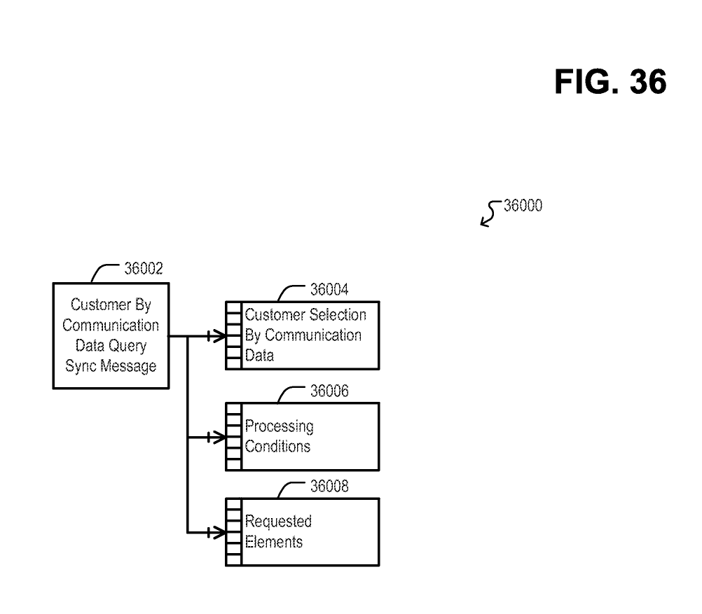

FIG. 36 illustrates one example logical configuration of a Customer By Communication Data Query Sync Message 36000. Specifically, this figure depicts the arrangement and hierarchy of various components such as one or more levels of packages, entities, and data types, shown here as 36000 through 36008. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer By Communication Data Query Sync Message 36000 includes, among other things, the Customer Selection By Communication Data entity 36004. Accordingly, heterogeneous applications may communicate using this consistent message configured as such.

The message type Customer By Communication Data Query_sync is derived from the business object Customer as a leading object together with its operation signature. The message type Customer By Communication Data Query_sync is a query about customer data by communication data. The structure of the message type Customer By Communication Data Query_sync is determined by the message data type CustomerByCommunicationDataQueryMessage_sync. The message data type CustomerByCommunicationDataQueryMessage_sync includes the CustomerSelectionByCommunicationData package, the ProcessingConditions package, and the RequestedElements package.

The package CustomerSelectionByCommunicationData includes the entity CustomerSelectionByCommunicationData. CustomerSelectionByCommunicationData includes the following non-node elements: SelectionByNormalisedTelephoneNumber, SelectionByNormalisedFacsimileNumber, SelectionByEmailURI, SelectionByInternalID, SelectionByUUID, SelectionByCategoryCode, SelectionByBusinessCharacterCode, SelectionByBusinessPartnerName, SelectionByBusinessPartnerAdditionalName, SelectionBySortingFormattedName, SelectionByLifeCycleStatusCode, and SelectionBySearchText.

SelectionByNormalisedTelephoneNumber may have a multiplicity of 0 . . . * and may be based on datatype MIDT:CustomerSelectionByNormalisedTelephoneNumber. SelectionByNormalisedTelephoneNumber may include InclusionExclusionCode, IntervalBoundaryTypeCode, LowerBoundaryNormalisedTelephoneNumber, and UpperBoundaryNormalisedTelephoneNumber. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryNormalisedTelephoneNumber may have a multiplicity of 0 . . . 1 and may be based on datatype BGDT:LANGUAGEINDEPENDENT_SHORT_Description. UpperBoundaryNormalisedTelephoneNumber may have a multiplicity of 0 . . . 1 and may be based on datatype BGDT:LANGUAGEINDEPENDENT_SHORT_Description.

SelectionByNormalisedFacsimileNumber may have a multiplicity of 0 . . . * and may be based on datatype MIDT:CustomerSelectionByNormalisedFacsimileNumber. SelectionByNormalisedFacsimileNumber may include InclusionExclusionCode, IntervalBoundaryTypeCode, LowerBoundaryNormalisedFacsimileNumber, and UpperBoundaryNormalisedFacsimileNumber. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryNormalisedFacsimileNumber may have a multiplicity of 0 . . . 1 and may be based on datatype BGDT:LANGUAGEINDEPENDENT_SHORT_Description. UpperBoundaryNormalisedFacsimileNumber may have a multiplicity of 0 . . . 1 and may be based on datatype BGDT:LANGUAGEINDEPENDENT_SHORT_Description.

SelectionByEmailURI may have a multiplicity of 0 . . . * and may be based on datatype MIDT:CustomerSelectionByEmailURI. SelectionByEmailURI may include InclusionExclusionCode, IntervalBoundaryTypeCode, LowerBoundaryEmailURI, and UpperBoundaryEmailURI. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryEmailURI may have a multiplicity of 0 . . . 1 and may be based on datatype BGDT:EmailURI. UpperBoundaryEmailURI may have a multiplicity of 0 . . . 1 and may be based on datatype BGDT:EmailURI.

SelectionByInternalID may have a multiplicity of 0 . . . * and may be based on datatype MIDT:CustomerSelectionByInternalID. SelectionByInternalID may include InclusionExclusionCode, IntervalBoundaryTypeCode, LowerBoundaryInternalID, and UpperBoundaryInternalID. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryInternalID may have a multiplicity of 0 . . . 1 and may be based on datatype BGDT:BusinessPartnerInternalID. UpperBoundarylnternalID may have a multiplicity of 0 . . . 1 and may be based on datatype BGDT:BusinessPartnerInternalID.

SelectionByUUID may have a multiplicity of 0 . . . * and may be based on datatype MIDT:CustomerSelectionByUUID. SelectionByUUID may include InclusionExclusionCode, IntervalBoundaryTypeCode, LowerBoundaryUUID, and UpperBoundaryUUID. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryUUID may have a multiplicity of 0 . . . 1 and may be based on datatype BGDT:UUID. UpperBoundaryUUID may have a multiplicity of 0 . . . 1 and may be based on datatype BGDT:UUID.

SelectionByCategoryCode may have a multiplicity of 0 . . . * and may be based on datatype MIDT:CustomerSelectionByCategoryCode. SelectionByCategoryCode may include InclusionExclusionCode, IntervalBoundaryTypeCode, LowerBoundaryCategoryCode, and UpperBoundaryCategoryCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryCategoryCode may have a multiplicity of 0 . . . 1 and may be based on datatype BGDT:BusinessPartnerCategoryCode. UpperBoundaryCategoryCode may have a multiplicity of 0 . . . 1 and may be based on datatype BGDT:BusinessPartnerCategoryCode.

SelectionByBusinessCharacterCode may have a multiplicity of 0 . . . * and may be based on datatype MIDT:CustomerSelectionByBusinessCharacterCode. SelectionByBusinessCharacterCode may include InclusionExclusionCode, IntervalBoundaryTypeCode, LowerBoundaryBusinessCharacterCode, and UpperBoundaryBusinessCharacterCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryBusinessCharacterCode may have a multiplicity of 0 . . . 1 and may be based on datatype BGDT:BUSINESSPARTNER_PartyBusinessCharacterCode. UpperBoundaryBusinessCharacterCode may have a multiplicity of 0 . . . 1 and may be based on datatype BGDT:BUSINESSPARTNER_PartyBusinessCharacterCode.

SelectionByBusinessPartnerName may have a multiplicity of 0 . . . * and may be based on datatype MIDT:CustomerSelectionByBusinessPartnerName. SelectionByBusinessPartnerName may include InclusionExclusionCode, IntervalBoundaryTypeCode, LowerBoundaryBusinessPartnerName, and UpperBoundaryBusinessPartnerName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryBusinessPartnerName may have a multiplicity of 0 . . . 1 and may be based on datatype CDT:LANGUAGEINDEPENDENT_MEDIUM_Name. UpperBoundaryBusinessPartnerName may have a multiplicity of 0 . . . 1 and may be based on datatype CDT:LANGUAGEINDEPENDENT_MEDIUM_Name.

SelectionByBusinessPartnerAdditionalName may have a multiplicity of 0 . . . * and may be based on datatype MIDT:CustomerSelectionByBusinessPartnerAdditionalName. SelectionByBusinessPartnerAdditionalName may include InclusionExclusionCode, IntervalBoundaryTypeCode, LowerBoundaryBusinessPartnerAdditionalName, and UpperBoundaryBusinessPartnerAdditionalName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryBusinessPartnerAdditionalName may have a multiplicity of 0 . . . 1 and may be based on datatype CDT:LANGUAGEINDEPENDENT_MEDIUM_Name. UpperBoundaryBusinessPartnerAdditionalName may have a multiplicity of 0 . . . 1 and may be based on datatype CDT:LANGUAGEINDEPENDENT_MEDIUM_Name.

SelectionBySortingFormattedName may have a multiplicity of 0 . . . * and may be based on datatype MIDT:CustomerSelectionBySortingFormattedName. SelectionBySortingFormattedName may include InclusionExclusionCode, IntervalBoundaryTypeCode, LowerBoundarySortingFormattedName, and UpperBoundarySortingFormattedName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundarySortingFormattedName may have a multiplicity of 0 . . . 1 and may be based on datatype CDT:LANGUAGEINDEPENDENT_LONG_Name. UpperBoundarySortingFormattedName may have a multiplicity of 0 . . . 1 and may be based on datatype CDT:LANGUAGEINDEPENDENT_LONG_Name.

SelectionByLifeCycleStatusCode may have a multiplicity of 0 . . . * and may be based on datatype MIDT:CustomerSelectionByLifeCycleStatusCode. SelectionByLifeCycleStatusCode may include InclusionExclusionCode, IntervalBoundaryTypeCode, LowerBoundaryLifeCycleStatusCode, and UpperBoundaryLifeCycleStatusCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryLifeCycleStatusCode may have a multiplicity of 0 . . . 1 and may be based on datatype BGDT:NOTDELETED_PartyLifeCycleStatusCode. UpperBoundaryLifeCycleStatusCode may have a multiplicity of 0 . . . 1 and may be based on datatype BGDT:NOTDELETED_PartyLifeCycleStatusCode. SelectionBySearchText may have a multiplicity of 0 . . . 1 and may be based on datatype BGDT:SearchText.

The package ProcessingConditions includes the entity ProcessingConditions. ProcessingConditions is typed by datatype QueryProcessingConditions.

The package RequestedElements includes the entity RequestedElements. RequestedElements includes the customerTransmissionRequestCode attribute, which may have a multiplicity of 0 . . . 1 and may be based on datatype BGDT:TransmissionRequestCode. RequestedElements includes the following non-node elements: Customer, AddressInformationTransmissionRequestCode, RelationshipTransmissionRequestCode, ContactPersonTransmissionRequestCode, CommunicationArrangementTransmissionRequestCode, DirectResponsibilityTransmissionRequestCode, SalesArrangementTransmissionRequestCode, BankDetailsTransmissionRequestCode, PaymentCardDetailsTransmissionRequestCode, PaymentDataTransmissionRequestCode, PersonTransmissionRequestCode, TaxNumberTransmissionRequestCode, GeneralProductTaxExemptionTransmissionRequestCode, OperatingHoursInfoTransmissionRequestCode, OrganisationTransmissionRequestCode, TextTransmissionRequestCode, and AttachmentFolderTransmissionRequestCode.

Customer may have a multiplicity of 0 . . . 1 and may be based on datatype MIDT:CustomerRequestedElementsCustomer. AddressInformationTransmissionRequestCode may have a multiplicity of 0 . . . 1 and may be based on datatype BGDT:TransmissionRequestCode. RelationshipTransmissionRequestCode may have a multiplicity of 0 . . . 1 and may be based on datatype BGDT:TransmissionRequestCode. contactPersonTransmissionRequestCode may have a multiplicity of 0 . . . 1 and may be based on datatype BGDT:TransmissionRequestCode. CommunicationArrangementTransmissionRequestCode may have a multiplicity of 0 . . . 1 and may be based on datatype BGDT:TransmissionRequestCode. DirectResponsibilityTransmissionRequestCode may have a multiplicity of 0 . . . 1 and may be based on datatype BGDT:TransmissionRequestCode. SalesArrangementTransmissionRequestCode may have a multiplicity of 0 . . . 1 and may be based on datatype BGDT:TransmissionRequestCode. BankDetailsTransmissionRequestCode may have a multiplicity of 0 . . . 1 and may be based on datatype BGDT:TransmissionRequestCode. PaymentCardDetailsTransmissionRequestCode may have a multiplicity of 0 . . . 1 and may be based on datatype BGDT:TransmissionRequestCode. PaymentDataTransmissionRequestCode may have a multiplicity of 0 . . . 1 and may be based on datatype BGDT:TransmissionRequestCode. PersonTransmissionRequestCode may have a multiplicity of 0 . . . 1 and may be based on datatype BGDT:TransmissionRequestCode. TaxNumberTransmissionRequestCode may have a multiplicity of 0 . . . 1 and may be based on datatype BGDT:TransmissionRequestCode. GeneralProductTaxExemptionTransmissionRequestCode may have a multiplicity of 0 . . . 1 and may be based on datatype BGDT:TransmissionRequestCode. OperatingHoursInfoTransmissionRequestCode may have a multiplicity of 0 . . . 1 and may be based on datatype BGDT:TransmissionRequestCode. OrganisationTransmissionRequestCode may have a multiplicity of 0 . . . 1 and may be based on datatype BGDT:TransmissionRequestCode. TextTransmissionRequestCode may have a multiplicity of 0 . . . 1 and may be based on datatype BGDT:TransmissionRequestCode. AttachmentFolderTransmissionRequestCode may have a multiplicity of 0 . . . 1 and may be based on datatype BGDT:TransmissionRequestCode.

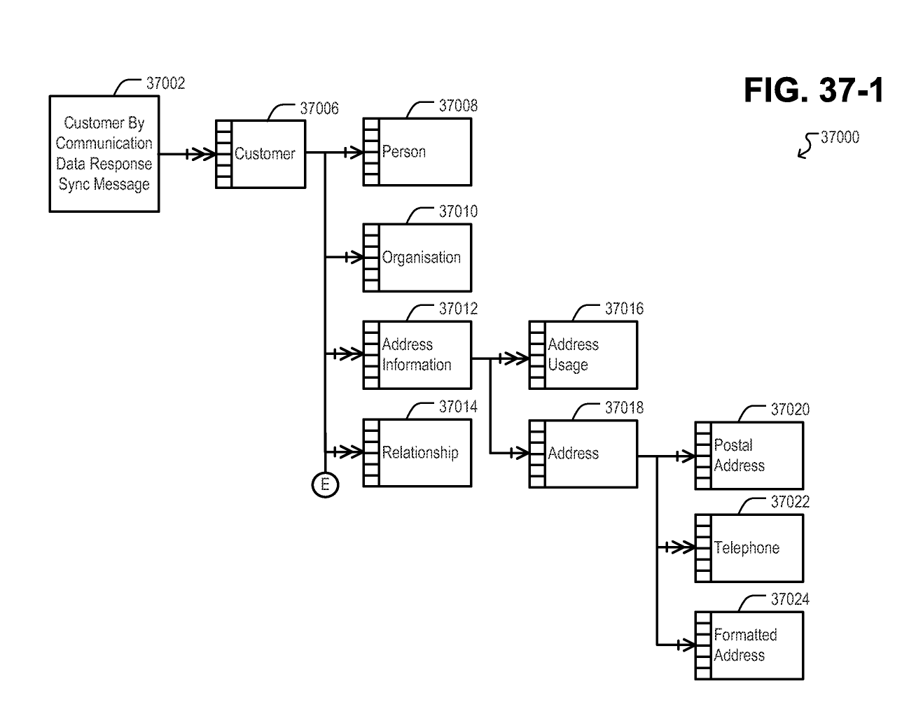

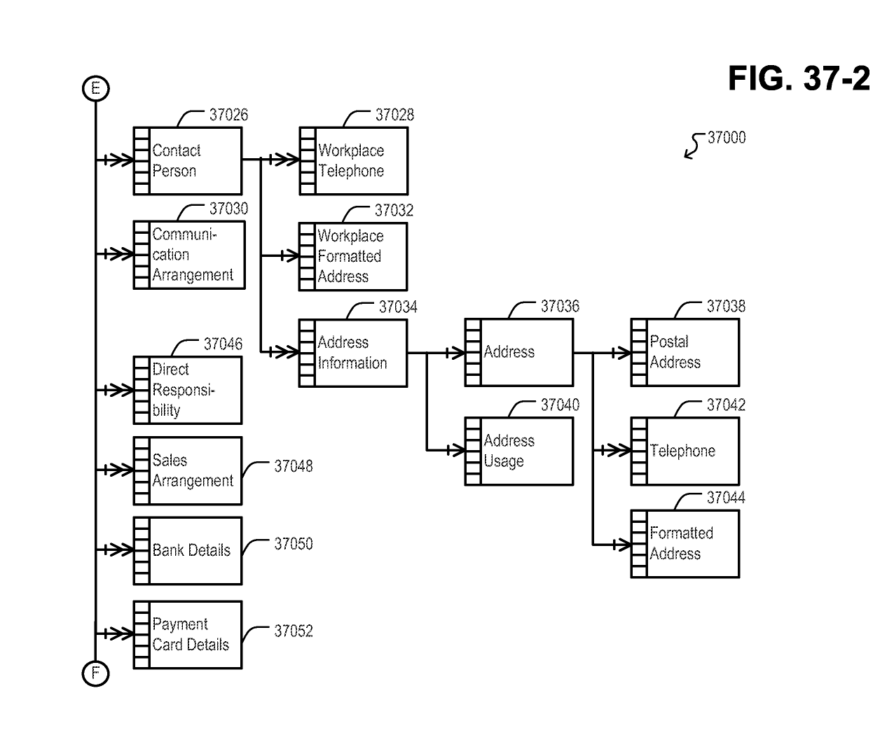

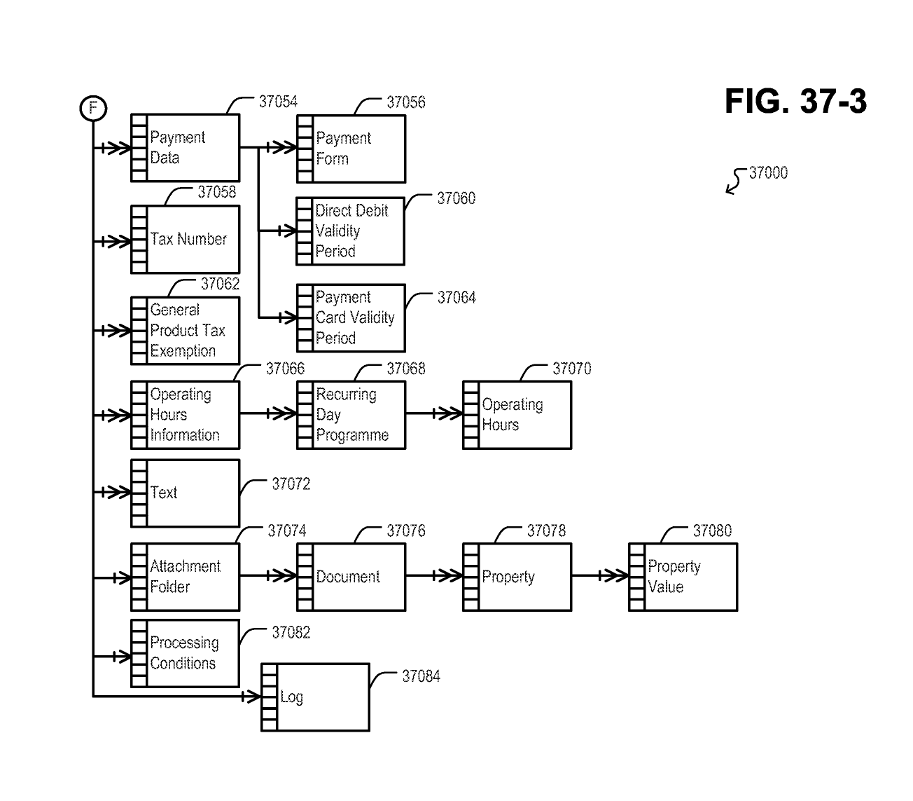

FIGS. 37-1 through 37-3 collectively illustrate one example logical configuration of a Customer By Communication Data Response Sync Message 37000. Specifically, these figures depict the arrangement and hierarchy of various components such as one or more levels of packages, entities, and data types, shown here as 37000 through 37084. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer By Communication Data Response Sync Message 37000 includes, among other things, the Person entity 37008. Accordingly, heterogeneous applications may communicate using this consistent message configured as such.

The message type Customer By Communication Data Response_sync is derived from the business object Customer as a leading object together with its operation signature. The message type Customer By Communication Data Response_sync is a response concerning an inquiry about customer data that includes requested customer data as well as processing conditions. Corresponding system messages can be provided as log items. The structure of the message type Customer By Communication Data Response_sync is determined by the message data type CustomerResponseMessage_sync. The message data type CustomerResponseMessage_sync includes the Customer package, the ProcessingConditions package, and the Log package.

The package Customer includes the sub-packages Person, Organisation, AddressInformation, Relationship, ContactPerson, CommunicationArrangement, DirectResponsibility, SalesArrangement, BankDetails, PaymentCardDetails, PaymentData, TaxNumber, GeneralProductTaxExemption, OperatingHoursInformation, Text, AttachmentFolder, and the entity Customer.

Customer includes the following non-node elements: ChangeStateID, UUID, InternalID, SystemAdministrativeData, CategoryCode, ProspectIndicator, CustomerIndicator, LifeCycleStatusCode, VerbalCommunicationLanguageCode, ContactAllowedCode, LegalCompetenceIndicator, DunAndBradstreetNumberID, GlobalLocationNumberID, ABCClassificationCode, NielsenRegionCode, IndustrialSectorCode, InvoicingBlockingReasonCode, CustomerTransactionDocumentFulfilmentBlockingReasonCode, CustomerBlockingReasonCode, and EnterpriseIdentificationNumber. ChangeStateID may have a multiplicity of 0 . . . 1 and may be based on datatype BGDT:ChangeStateID. UUID may have a multiplicity of 0 . . . 1 and may be based on datatype BGDT:UUID. InternalID may have a multiplicity of 0 . . . 1 and may be based on datatype BGDT:BusinessPartnerInternalID. SystemAdministrativeData may have a multiplicity of 0 . . . 1 and may be based on datatype AGDT:SystemAdministrativeData. CategoryCode may have a multiplicity of 0 . . . 1 and may be based on datatype BGDT:BusinessPartnerCategoryCode. ProspectIndicator may have a multiplicity of 0 . . . 1 and may be based on datatype CDT:Indicator. CustomerIndicator may have a multiplicity of 0 . . . 1 and may be based on datatype CDT:Indicator. LifeCycleStatusCode may have a multiplicity of 0 . . . 1 and may be based on datatype BGDT:PartyLifeCycleStatusCode. VerbalCommunicationLanguageCode may have a multiplicity of 0 . . . 1 and may be based on datatype BGDT:LanguageCode. ContactAllowedCode may have a multiplicity of 0 . . . 1 and may be based on datatype BGDT:ContactAllowedCode. LegalCompetenceIndicator may have a multiplicity of 0 . . . 1 and may be based on datatype CDT:Indicator. DunAndBradstreetNumberID may have a multiplicity of 0 . . . 1 and may be based on datatype BGDT:BusinessPartnerID. GlobalLocationNumberID may have a multiplicity of 0 . . . 1 and may be based on datatype BGDT:BusinessPartnerID. ABCClassificationCode may have a multiplicity of 0 . . . 1 and may be based on datatype BGDT:CustomerABCClassificationCode. NielsenRegionCode may have a multiplicity of 0 . . . 1 and may be based on datatype BGDT:NielsenRegionCode. IndustrialSectorCode may have a multiplicity of 0 . . . 1 and may be based on datatype BGDT:IndustrialSectorCode. InvoicingBlockingReasonCode may have a multiplicity of 0 . . . 1 and may be based on datatype BGDT:InvoicingBlockingReasonCode. CustomerTransactionDocumentFulfilmentBlockingReasonCode may have a multiplicity of 0 . . . 1 and may be based on datatype BGDT:CustomerTransactionDocumentFulfilmentBlockingReasonCode. CustomerBlockingReasonCode may have a multiplicity of 0 . . . 1 and may be based on datatype BGDT:CustomerBlockingReasonCode. EnterpriseIdentificationNumber may have a multiplicity of 0 . . . 1 and may be based on datatype BGDT:BusinessPartnerID.

Customer includes the following node elements: Person, in a 1:C cardinality relationship; Organisation, in a 1:C cardinality relationship; AddressInformation, in a 1:CN cardinality relationship; Relationship, in a 1:CN cardinality relationship; ContactPerson, in a 1:CN cardinality relationship; CommunicationArrangement, in a 1:CN cardinality relationship; DirectResponsibility, in a 1:CN cardinality relationship; SalesArrangement, in a 1:CN cardinality relationship; BankDetails, in a 1:CN cardinality relationship; PaymentCardDetails, in a 1:CN cardinality relationship; PaymentData, in a 1:CN cardinality relationship; TaxNumber, in a 1:CN cardinality relationship; GeneralProductTaxExemption, in a 1:CN cardinality relationship; OperatingHoursInformation, in a 1:CN cardinality relationship; Text, in a 1:CN cardinality relationship; and AttachmentFolder, in a 1:C cardinality relationship.

The package CustomerPerson includes the entity Person. Person includes the following non-node elements: FormOfAddressCode, AcademicTitleCode, GivenName, MiddleName, FamilyName, BirthName, NickName, NameFormatCountryCode, GenderCode, BirthDate, NonVerbalCommunicationLanguageCode, and OccupationCode. FormOfAddressCode may have a multiplicity of 0 . . . 1 and may be based on datatype BGDT:FormOfAddressCode. AcademicTitleCode may have a multiplicity of 0 . . . 1 and may be based on datatype BGDT:AcademicTitleCode. GivenName may have a multiplicity of 0 . . . 1 and may be based on datatype CDT:LANGUAGEINDEPENDENT_MEDIUM_Name. MiddleName may have a multiplicity of 0 . . . 1 and may be based on datatype CDT:LANGUAGEINDEPENDENT_MEDIUM_Name. FamilyName may have a multiplicity of 0 . . . 1 and may be based on datatype CDT:LANGUAGEINDEPENDENT_MEDIUM_Name. BirthName may have a multiplicity of 0 . . . 1 and may be based on datatype CDT:LANGUAGEINDEPENDENT_MEDIUM_Name. NickName may have a multiplicity of 0 . . . 1 and may be based on datatype CDT:LANGUAGEINDEPENDENT_MEDIUM_Name. NameFormatCountryCode may have a multiplicity of 0 . . . 1 and may be based on datatype BGDT:CountryCode. GenderCode may have a multiplicity of 0 . . . 1 and may be based on datatype BGDT:GenderCode. BirthDate may have a multiplicity of 0 . . . 1 and may be based on datatype CDT:Date, with a qualifier of Birth. NonVerbalCommunicationLanguageCode may have a multiplicity of 0 . . . 1 and may be based on datatype BGDT:LanguageCode, with a qualifier of Communication. OccupationCode may have a multiplicity of 0 . . . 1 and may be based on datatype BGDT:OccupationCode.

The package CustomerOrganisation includes the entity Organisation. Organisation includes the following non-node elements: CompanyLegalFormCode, FirstLineName, and SecondLineName. CompanyLegalFormCode may have a multiplicity of 0 . . . 1 and may be based on datatype BGDT:CompanyLegalFormCode. FirstLineName may have a multiplicity of 0 . . . 1 and may be based on datatype CDT:LANGUAGEINDEPENDENT_MEDIUM_Name. SecondLineName may have a multiplicity of 0 . . . 1 and may be based on datatype CDT:LANGUAGEINDEPENDENT_MEDIUM_Name.

The package CustomerAddressInformation includes the entity AddressInformation. AddressInformation includes the following non-node elements: UUID and CurrentAddressSnapshotUUID. UUID may have a multiplicity of 0 . . . 1 and may be based on datatype BGDT:UUID. CurrentAddressSnapshotUUID may have a multiplicity of 0 . . . 1 and may be based on datatype BGDT:UUID. AddressInformation includes the following node elements: AddressUsage, in a 1:CN cardinality relationship; and Address, in a 1:C cardinality relationship.

AddressUsage includes the following non-node elements: AddressUsageCode and DefaultIndicator. AddressUsageCode may have a multiplicity of 1 and may be based on datatype BGDT:AddressUsageCode. DefaultIndicator may have a multiplicity of 0 . . . 1 and may be based on datatype CDT:Indicator. Address includes the following non-node elements: CorrespondenceLanguageCode, PreferredCommunicationMediumTypeCode, EmailURI, FacsimileFormattedNumberDescription, and WebURI. CorrespondenceLanguageCode may have a multiplicity of 0 . . . 1 and may be based on datatype BGDT:LanguageCode. PreferredCommunicationMediumTypeCode may have a multiplicity of 0 . . . 1 and may be based on datatype BGDT:CommunicationMediumTypeCode. EmailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. WebURI may have a multiplicity of 0 . . . 1 and may be based on datatype BGDT:WebURI. Address includes the following node elements: PostalAddress, in a 1:C cardinality relationship; Telephone, in a 1:CN cardinality relationship; and FormattedAddress, in a 1:C cardinality relationship.

PostalAddress includes the following non-node elements: CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, CareOfName, POBoxDeviatingCountryCode, POBoxDeviatingRegionCode, POBoxDeviatingCityName, POBoxID, POBoxIndicator, TaxJurisdictionCode, and TimeZoneCode. CountryCode may have a multiplicity of 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

Telephone includes the following non-node elements: FormattedNumberDescription and MobilePhoneNumberIndicator. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

FormattedAddress includes the following non-node elements: FormattedAddressDescription, FormattedPostalAddressDescription, FormattedAddress, and FormattedPostalAddress. FormattedAddressDescription may have a multiplicity of 0 . . . 1 and may be based on datatype BGDT:LANGUAGEINDEPENDENT_MEDIUM_Description. FormattedPostalAddressDescription may have a multiplicity of 0 . . . 1 and may be based on datatype BGDT:LANGUAGEINDEPENDENT_MEDIUM_Description. FormattedAddress may have a multiplicity of 0 . . . 1 and may be based on datatype AGDT:FormattedAddress. FormattedPostalAddress may have a multiplicity of 0 . . . 1 and may be based on datatype AGDT:FormattedPostalAddress.

The package CustomerRelationship includes the entity Relationship. Relationship includes the following non-node elements: RelationshipBusinessPartnerUUID, RelationshipBusinessPartnerInternalID, and RoleCode. RelationshipBusinessPartnerUUID may have a multiplicity of 0 . . . 1 and may be based on datatype BGDT:UUID. RelationshipBusinessPartnerInternalID may have a multiplicity of 0 . . . 1 and may be based on datatype BGDT:BusinessPartnerInternalID. RoleCode may have a multiplicity of 1 and may be based on datatype BGDT:BusinessPartnerRelationshipRoleCode.

The package CustomerContactPerson includes the sub-package AddressInformation and the entity ContactPerson. ContactPerson includes the following non-node elements: BusinessPartnerContactUUID, BusinessPartnerContactInternalID, DefaultContactPersonIndicator, FormOfAddressCode, AcademicTitleCode, GivenName, MiddleName, FamilyName, BirthName, NickName, GenderCode, BirthDate, NonVerbalCommunicationLanguageCode, OccupationCode, BusinessPartnerFunctionTypeCode, BusinessPartnerFunctionalAreaCode, VIPReasonCode, CurrentWorkplaceAddressSnapshotUUID, WorkplaceBusinessAddressUUID, WorkplacePreferredCommunicationMediumTypeCode, WorkplaceEmailURI, WorkplaceFacsimileFormattedNumberDescription, WorkplaceWebURI, WorkplaceFunctionalTitleName, WorkplaceDepartmentName, WorkplaceBuildingID, WorkplaceFloorID, WorkplaceRoomID, LifeCycleStatusCode, and MaritalStatusCode. BusinessPartnerContactUUID may have a multiplicity of 0 . . . 1 and may be based on datatype BGDT:UUID. BusinessPartnerContactlnternalID may have a multiplicity of 0 . . . 1 and may be based on datatype BGDT:BusinessPartnerInternalID. DefaultContactPersonIndicator may have a multiplicity of 0 . . . 1 and may be based on datatype CDT:Indicator. FormOfAddressCode may have a multiplicity of 0 . . . 1 and may be based on datatype BGDT:FormOfAddressCode. AcademicTitleCode may have a multiplicity of 0 . . . 1 and may be based on datatype BGDT:AcademicTitleCode. GivenName may have a multiplicity of 0 . . . 1 and may be based on datatype CDT:LANGUAGEINDEPENDENT_MEDIUM_Name. MiddleName may have a multiplicity of 0 . . . 1 and may be based on datatype CDT:LANGUAGEINDEPENDENT_MEDIUM_Name. FamilyName may have a multiplicity of 0 . . . 1 and may be based on datatype CDT:LANGUAGEINDEPENDENT_MEDIUM_Name. BirthName may have a multiplicity of 0 . . . 1 and may be based on datatype CDT:LANGUAGEINDEPENDENT_MEDIUM_Name. NickName may have a multiplicity of 0 . . . 1 and may be based on datatype CDT:LANGUAGEINDEPENDENT_MEDIUM_Name. GenderCode may have a multiplicity of 0 . . . 1 and may be based on datatype BGDT:GenderCode. BirthDate may have a multiplicity of 0 . . . 1 and may be based on datatype CDT:Date. NonVerbalCommunicationLanguageCode may have a multiplicity of 0 . . . 1 and may be based on datatype BGDT:LanguageCode. OccupationCode may have a multiplicity of 0 . . . 1 and may be based on datatype BGDT:OccupationCode. BusinessPartnerFunctionTypeCode may have a multiplicity of 0 . . . 1 and may be based on datatype BGDT:BusinessPartnerFunctionTypeCode. BusinessPartnerFunctionalAreaCode may have a multiplicity of 0 . . . 1 and may be based on datatype BGDT:BusinessPartnerFunctionalAreaCode. VIPReasonCode may have a multiplicity of 0 . . . 1 and may be based on datatype BGDT:VIPReasonCode. CurrentWorkplaceAddressSnapshotUUID may have a multiplicity of 0 . . . 1 and may be based on datatype BGDT:UUID. WorkplaceBusinessAddressUUID may have a multiplicity of 0 . . . 1 and may be based on datatype BGDT:UUID. WorkplacePreferredCommunicationMediumTypeCode may have a multiplicity of 0 . . . 1 and may be based on datatype BGDT:CommunicationMediumTypeCode. WorkplaceEmailURI may have a multiplicity of 0 . . . 1 and may be based on datatype BGDT:EmailURI. WorkplaceFacsimileFormattedNumberDescription may have a multiplicity of 0 . . . 1 and may be based on datatype BGDT:LANGUAGEINDEPENDENT_SHORT_Description. WorkplaceWebURI may have a multiplicity of 0 . . . 1 and may be based on datatype BGDT:WebURI. WorkplaceFunctionalTitleName may have a multiplicity of 0 . . . 1 and may be based on datatype CDT:LANGUAGEINDEPENDENT_MEDIUM_Name. WorkplaceDepartmentName may have a multiplicity of 0 . . . 1 and may be based on datatype CDT:LANGUAGEINDEPENDENT_MEDIUM_Name. WorkplaceBuildingID may have a multiplicity of 0 . . . 1 and may be based on datatype BGDT:BuildingID. WorkplaceFloorID may have a multiplicity of 0 . . . 1 and may be based on datatype BGDT:FloorID. WorkplaceRoomID may have a multiplicity of 0 . . . 1 and may be based on datatype BGDT:RoomID LifeCycleStatusCode may have a multiplicity of 0 . . . 1 and may be based on datatype BGDT:PartyLifeCycleStatusCode. MaritalStatusCode may have a multiplicity of 0 . . . 1 and may be based on datatype BGDT:MaritalStatusCode. ContactPerson includes the following node elements: WorkplaceTelephone, in a 1:CN cardinality relationship; WorkplaceFormattedAddress, in a 1:C cardinality relationship; and AddressInformation, in a 1:CN cardinality relationship.

WorkplaceTelephone includes the following non-node elements: FormattedNumberDescription and MobilePhoneNumberIndicator. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

WorkplaceFormattedAddress includes the following non-node elements: FormattedAddressDescription, FormattedPostalAddressDescription, FormattedAddress, and FormattedPostalAddress. FormattedAddressDescription may have a multiplicity of 0 . . . 1 and may be based on datatype BGDT:LANGUAGEINDEPENDENT_MEDIUM_Description. FormattedPostalAddressDescription may have a multiplicity of 0 . . . 1 and may be based on datatype BGDT:LANGUAGEINDEPENDENT_MEDIUM_Description. FormattedAddress may have a multiplicity of 0 . . . 1 and may be based on datatype AGDT:FormattedAddress. FormattedPostalAddress may have a multiplicity of 0 . . . 1 and may be based on datatype AGDT:FormattedPostalAddress.

The package CustomerContactPersonAddressInformation includes the entity AddressInformation. AddressInformation includes the following non-node elements: UUID and CurrentAddressSnapshotUUID. UUID may have a multiplicity of 0 . . . 1 and may be based on datatype BGDT:UUID. CurrentAddressSnapshotUUID may have a multiplicity of 0 . . . 1 and may be based on datatype BGDT:UUID. AddressInformation includes the following node elements: Address, in a 1:C cardinality relationship; and AddressUsage, in a 1:C cardinality relationship.

Address includes the following non-node elements: EmailURI and FacsimileFormattedNumberDescription. EmailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. Address includes the following node elements: PostalAddress, in a 1:C cardinality relationship; Telephone, in a 1:CN cardinality relationship; and FormattedAddress, in a 1:C cardinality relationship.

PostalAddress includes the following non-node elements: CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, CareOfName, POBoxDeviatingCountryCode, POBoxDeviatingRegionCode, POBoxDeviatingCityName, POBoxID, POBoxIndicator, TaxJurisdictionCode, and TimeZoneCode. CountryCode may have a multiplicity of 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

Telephone includes the following non-node elements: FormattedNumberDescription and MobilePhoneNumberIndicator. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

The package CustomerContactPersonAddressInformation includes the entity FormattedAddress. FormattedAddress includes the following non-node elements:

FormattedAddressDescription, FormattedPostalAddressDescription, FormattedAddress, and FormattedPostalAddress. FormattedAddressDescription may have a multiplicity of 0 . . . 1 and may be based on datatype BGDT:LANGUAGEINDEPENDENT_MEDIUM_Description. FormattedPostalAddressDescription may have a multiplicity of 0 . . . 1 and may be based on datatype BGDT:LANGUAGEINDEPENDENT_MEDIUM_Description. FormattedAddress may have a multiplicity of 0 . . . 1 and may be based on datatype AGDT:FormattedAddress. FormattedPostalAddress may have a multiplicity of 0 . . . 1 and may be based on datatype AGDT:FormattedPostalAddress.

AddressUsage includes the following non-node elements: AddressUsageCode and DefaultIndicator. AddressUsageCode may have a multiplicity of 1 and may be based on datatype BGDT:AddressUsageCode. DefaultIndicator may have a multiplicity of 0 . . . 1 and may be based on datatype CDT:Indicator.

The package CustomerCommunicationArrangement includes the entity CommunicationArrangement. CommunicationArrangement includes the following non-node elements: UUID, CompoundServiceInterfaceCode, EnabledIndicator, CommunicationMediumTypeCode, OutputRequestFormTemplateCode, EMailURI, FacsimileFormattedNumberDescription, and OutputCopyNumberValue. UUID may have a multiplicity of 0 . . . 1 and may be based on datatype BGDT:UUID. CompoundServiceInterfaceCode may have a multiplicity of 0 . . . 1 and may be based on datatype BGDT:CompoundServiceInterfaceCode. EnabledIndicator may have a multiplicity of 0 . . . 1 and may be based on datatype CDT:Indicator. CommunicationMediumTypeCode may have a multiplicity of 0 . . . 1 and may be based on datatype BGDT:CommunicationMediumTypeCode. OutputRequestFormTemplateCode may have a multiplicity of 0 . . . 1 and may be based on datatype BGDT:OutputRequestFormTemplateCode. EMailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. OutputCopyNumberValue may have a multiplicity of 0 . . . 1 and may be based on datatype BGDT:NumberValue.

The package CustomerDirectResponsibility includes the entity DirectResponsibility. DirectResponsibility includes the following non-node elements: PartyRoleCode and EmployeeID. PartyRoleCode may have a multiplicity of 0 . . . 1 and may be based on datatype BGDT:PartyRoleCode. EmployeeID may have a multiplicity of 0 . . . 1 and may be based on datatype BGDT:EmployeeID.

The package CustomerSalesArrangement includes the entity SalesArrangement. SalesArrangement includes the following non-node elements: SalesOrganisationID, DistributionChannelCode, Incoterms, DeliveryPriorityCode, CompleteDeliveryRequestedIndicator, CurrencyCode, CustomerGroupCode, and CashDiscountTermsCode. SalesOrganisationID may have a multiplicity of 0 . . . 1 and may be based on datatype BGDT:OrganisationalCentreID. DistributionChannelCode may have a multiplicity of 0 . . . 1 and may be based on datatype BGDT:DistributionChannelCode. Incoterms may have a multiplicity of 0 . . . 1 and may be based on datatype AGDT:Incoterms. DeliveryPriorityCode may have a multiplicity of 0 . . . 1 and may be based on datatype BGDT:PriorityCode. CompleteDeliveryRequestedIndicator may have a multiplicity of 0 . . . 1 and may be based on datatype CDT:Indicator. CurrencyCode may have a multiplicity of 0 . . . 1 and may be based on datatype BGDT:CurrencyCode. CustomerGroupCode may have a multiplicity of 0 . . . 1 and may be based on datatype BGDT:CustomerGroupCode. CashDiscountTermsCode may have a multiplicity of 0 . . . 1 and may be based on datatype BGDT:CashDiscountTermsCode.

The package CustomerBankDetails includes the entity BankDetails. BankDetails includes the following non-node elements: ID, BankUUID, BankInternalID, BankRoutingID, BankRoutingIDTypeCode, BankStandardID, BankAccountID, BankAccountIDCheckDigitValue, BankAccountTypeCode, BankAccountHolderName, BankAccountStandardID, and ValidityPeriod. ID may have a multiplicity of 0 . . . 1 and may be based on datatype BGDT:BusinessPartnerBankDetailsID. BankUUID may have a multiplicity of 0 . . . 1 and may be based on datatype BGDT:UUID. BanklnternalID may have a multiplicity of 0 . . . 1 and may be based on datatype BGDT:BankInternalID. BankRoutingID may have a multiplicity of 0 . . . 1 and may be based on datatype BGDT:BankRoutingID. BankRoutingIDTypeCode may have a multiplicity of 0 . . . 1 and may be based on datatype BGDT:BankRoutingIDTypeCode. BankStandardID may have a multiplicity of 0 . . . 1 and may be based on datatype BGDT:BankStandardID. BankAccountID may have a multiplicity of 0 . . . 1 and may be based on datatype BGDT:BankAccountID. BankAccountIDCheckDigitValue may have a multiplicity of 0 . . . 1 and may be based on datatype BGDT:BankAccountIDCheckDigitValue. BankAccountTypeCode may have a multiplicity of 0 . . . 1 and may be based on datatype BGDT:BankAccountTypeCode. BankAccountHolderName may have a multiplicity of 0 . . . 1 and may be based on datatype BGDT:BankAccountHolderName_V 1. BankAccountStandardID may have a multiplicity of 0 . . . 1 and may be based on datatype BGDT:BankAccountStandardID. ValidityPeriod may have a multiplicity of 0 . . . 1 and may be based on datatype AGDT:CLOSED_DatePeriod.

The package CustomerPaymentCardDetails includes the entity PaymentCardDetails. PaymentCardDetails includes the following non-node elements: ID, PaymentCardTypeCode, PaymentCardID, PaymentCardHolderName, PaymentCardExpirationDate, DefaultIndicator, BlockingReasonCode, StreetName, HouseID, PostalCode, CityName, RegionCode, and CountryCode. ID may have a multiplicity of 0 . . . 1 and may be based on datatype BGDT:BusinessPartnerPaymentCardDetailsID. PaymentCardTypeCode may have a multiplicity of 0 . . . 1 and may be based on datatype BGDT:PaymentCardTypeCode. PaymentCardID may have a multiplicity of 0 . . . 1 and may be based on datatype BGDT:PaymentCardID. PaymentCardHolderName may have a multiplicity of 0 . . . 1 and may be based on datatype CDT:LANGUAGEINDEPENDENT_MEDIUM_Name. PaymentCardExpirationDate may have a multiplicity of 0 . . . 1 and may be based on datatype CDT:Date, with a qualifier of Expiration. DefaultIndicator may have a multiplicity of 0 . . . 1 and may be based on datatype CDT:Indicator. BlockingReasonCode may have a multiplicity of 0 . . . 1 and may be based on datatype BGDT:PaymentCardBlockingReasonCode. StreetName may have a multiplicity of 0 . . . 1 and may be based on datatype BGDT:StreetName. HouseID may have a multiplicity of 0 . . . 1 and may be based on datatype BGDT:HouseID. PostalCode may have a multiplicity of 0 . . . 1 and may be based on datatype BGDT:PostalCode. CityName may have a multiplicity of 0 . . . 1 and may be based on datatype CDT:LANGUAGEINDEPENDENT_MEDIUM_Name. RegionCode may have a multiplicity of 0 . . . 1 and may be based on datatype BGDT:RegionCode. CountryCode may have a multiplicity of 0 . . . 1 and may be based on datatype BGDT:CountryCode.

The package CustomerPaymentData includes the entity PaymentData. PaymentData includes the following non-node elements: CompanyID, UUID, AccountDeterminationDebtorGroupCode, AccountDebtorExternalID, PaymentBlockingReasonCode, PaymentBlockExpirationDateTime, CreditLimitAmount, DirectDebitBankDetailsID, PaymentCardDetailsID, BillOfExchangeBankDetailsID, PaymentAdviceRequiredIndicator, FirstPaymentInstructionCode, SecondPaymentInstructionCode, ThirdPaymentInstructionCode, FourthPaymentInstructionCode, and BankChargeBearerCode. CompanyID may have a multiplicity of 1 and may be based on datatype BGDT:OrganisationalCentreID. UUID may have a multiplicity of 0 . . . 1 and may be based on datatype BGDT:UUID. AccountDeterminationDebtorGroupCode may have a multiplicity of 0 . . . 1 and may be based on datatype BGDT:AccountDeterminationDebtorGroupCode. AccountDebtorExternalID may have a multiplicity of 0 . . . 1 and may be based on datatype BGDT:PartyPartyID. PaymentBlockingReasonCode may have a multiplicity of 0 . . . 1 and may be based on datatype BGDT:PaymentBlockingReasonCode. PaymentBlockExpirationDateTime may have a multiplicity of 0 . . . 1 and may be based on datatype CDT:GLOBAL_DateTime. CreditLimitAmount may have a multiplicity of 0 . . . 1 and may be based on datatype CDT:Amount. DirectDebitBankDetailsID may have a multiplicity of 0 . . . 1 and may be based on datatype BGDT:BusinessPartnerBankDetailsID. PaymentCardDetailsID may have a multiplicity of 0 . . . 1 and may be based on datatype BGDT:BusinessPartnerPaymentCardDetailsID. BillOfExchangeBankDetailsID may have a multiplicity of 0 . . . 1 and may be based on datatype BGDT:BusinessPartnerBankDetailsID. PaymentAdviceRequiredIndicator may have a multiplicity of 0 . . . 1 and may be based on datatype CDT:Indicator. FirstPaymentInstructionCode may have a multiplicity of 0 . . . 1 and may be based on datatype BGDT:PaymentInstructionTypeCode. SecondPaymentInstructionCode may have a multiplicity of 0 . . . 1 and may be based on datatype BGDT:PaymentInstructionTypeCode. ThirdPaymentInstructionCode may have a multiplicity of 0 . . . 1 and may be based on datatype BGDT:PaymentInstructionTypeCode. FourthPaymentInstructionCode may have a multiplicity of 0 . . . 1 and may be based on datatype BGDT:PaymentInstructionTypeCode. BankChargeBearerCode may have a multiplicity of 0 . . . 1 and may be based on datatype BGDT:BankChargeBearerCode. PaymentData includes the following node elements: PaymentForm, in a 1:CN cardinality relationship; DirectDebitValidityPeriod, in a 1:C cardinality relationship; and PaymentCardValidityPeriod, in a 1:C cardinality relationship. PaymentForm includes the following non-node elements: PaymentFormCode, which may have a multiplicity of 1 and may be based on datatype BGDT:PaymentFormCode.

The package CustomerPaymentData includes the entities DirectDebitValidityPeriod and PaymentCardValidityPeriod. DirectDebitValidityPeriod is typed by CLOSED_DatePeriod. PaymentCardValidityPeriod is typed by CLOSED_DatePeriod.

The package CustomerTaxNumber includes the entity TaxNumber. TaxNumber includes the following non-node elements: CountryCode, PartyTaxID, and TaxIdentificationNumberTypeCode. CountryCode may have a multiplicity of 1 and may be based on datatype BGDT:CountryCode. TaxIdentificationNumberTypeCode may have a multiplicity of 1 and may be based on datatype BGDT:TaxIdentificationNumberTypeCode. PartyTaxID may have a multiplicity of 0 . . . 1 and may be based on datatype BGDT:PartyTaxID.

The package CustomerGeneralProductTaxExemption includes the entity GeneralProductTaxExemption. GeneralProductTaxExemption includes the following non-node elements: CountryCode, RegionCode, TaxTypeCode, and ReasonCode. CountryCode may have a multiplicity of 0 . . . 1 and may be based on datatype BGDT:CountryCode. RegionCode may have a multiplicity of 0 . . . 1 and may be based on datatype BGDT:RegionCode. TaxTypeCode may have a multiplicity of 0 . . . 1 and may be based on datatype BGDT:TaxTypeCode. ReasonCode may have a multiplicity of 0 . . . 1 and may be based on datatype BGDT:TaxExemptionReasonCode.

The package CustomerOperatingHoursInformation includes the entity OperatingHoursInformation. OperatingHoursInformation includes the following non-node elements: RoleCode, which may have a multiplicity of 1 and may be based on datatype BGDT:BUSINESSPARTNER_OperatingHoursRoleCode. OperatingHoursInformation includes the following node elements: RecurringDayProgramme, in a 1:CN cardinality relationship.

The package CustomerOperatingHoursInformation includes the entity RecurringDayProgramme RecurringDayProgramme includes the following non-node elements: WeekdaySelection, which may have a multiplicity of 0 . . . 1 and may be based on datatype AGDT:WeekdaySelection. RecurringDayProgramme includes the following node elements: OperatingHours, in a 1:CN cardinality relationship. OperatingHours includes the following non-node elements: TimePeriod, which may have a multiplicity of 1 and may be based on datatype AGDT:UPPEROPEN_TimePeriod.

The package CustomerText includes the entity Text. Text includes the following non-node elements: TypeCode and ContentText. TypeCode may have a multiplicity of 0 . . . 1 and may be based on datatype BGDT:TextCollectionTextTypeCode. ContentText may have a multiplicity of 0 . . . 1 and may be based on datatype CDT:LANGUAGEINDEPENDENT_Text.

The package CustomerAttachmentFolder includes the entity AttachmentFolder. AttachmentFolder includes the following non-node elements: UUID, which may have a multiplicity of 0 . . . 1 and may be based on datatype BGDT:UUID. AttachmentFolder includes the following node elements: Document, in a 1:CN cardinality relationship.

The package CustomerAttachmentFolder includes the entity Document. Document includes the following non-node elements: UUID, VersionID, SystemAdministrativeData, LinkInternalIndicator, CheckedOutIndicator, VisibleIndicator, VersioningEnabledIndicator, CategoryCode, CategoryName, TypeCode, TypeName, MIMECode, MIMEName, PathName, Name, AlternativeName, InternalLinkUUID, Description, ExternalLinkWebURI, FileContentURI, and FilesizeMeasure. UUID may have a multiplicity of 0 . . . 1 and may be based on datatype BGDT:UUID. VersionID may have a multiplicity of 0 . . . 1 and may be based on datatype BGDT:VersionID. SystemAdministrativeData may have a multiplicity of 0 . . . 1 and may be based on datatype AGDT:SystemAdministrativeData. LinkInternalIndicator may have a multiplicity of 0 . . . 1 and may be based on datatype CDT:Indicator. CheckedOutIndicator may have a multiplicity of 0 . . . 1 and may be based on datatype CDT:Indicator. VisibleIndicator may have a multiplicity of 0 . . . 1 and may be based on datatype CDT:Indicator. VersioningEnabledIndicator may have a multiplicity of 0 . . . 1 and may be based on datatype CDT:Indicator. CategoryCode may have a multiplicity of 0 . . . 1 and may be based on datatype BGDT:DocumentCategoryCode. CategoryName may have a multiplicity of 0 . . . 1 and may be based on datatype CDT:LANGUAGEINDEPENDENT_LONG_Name. TypeCode may have a multiplicity of 0 . . . 1 and may be based on datatype BGDT:DocumentTypeCode. TypeName may have a multiplicity of 0 . . . 1 and may be based on datatype CDT:LANGUAGEINDEPENDENT_LONG_Name. MIMECode may have a multiplicity of 0 . . . 1 and may be based on datatype BGDT:MIMECode. MIMEName may have a multiplicity of 0 . . . 1 and may be based on datatype CDT:LANGUAGEINDEPENDENT_LONG_Name. PathName may have a multiplicity of 0 . . . 1 and may be based on datatype CDT:LANGUAGEINDEPENDENT_Name. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. Description may have a multiplicity of 0 . . . 1 and may be based on datatype BGDT:Description. ExternalLinkWebURI may have a multiplicity of 0 . . . 1 and may be based on datatype BGDT:WebURI. FileContentURI may have a multiplicity of 0 . . . 1 and may be based on datatype BGDT:URI. FilesizeMeasure may have a multiplicity of 0 . . . 1 and may be based on datatype CDT:Measure. Document includes the following node elements: Property, in a 1:CN cardinality relationship.

Property includes the following non-node elements: TechnicalID, Name, DataTypeFormatCode, DataTypeFormatName, VisibleIndicator, ChangeAllowedIndicator, MultipleValueIndicator, NamespaceURI, and Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0 . . . 1 and may be based on datatype BGDT:PropertyDataTypeFormatCode. DataTypeFormatName may have a multiplicity of 0 . . . 1 and may be based on datatype CDT:LANGUAGEINDEPENDENT_LONG_Name. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description. Property includes the following node elements: PropertyValue, in a 1:CN cardinality relationship.

PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

The package ProcessingConditions includes the entity ProcessingConditions. ProcessingConditions is typed by ResponseProcessingConditions. The package Log includes the entity Log. Log is typed by datatype Log.

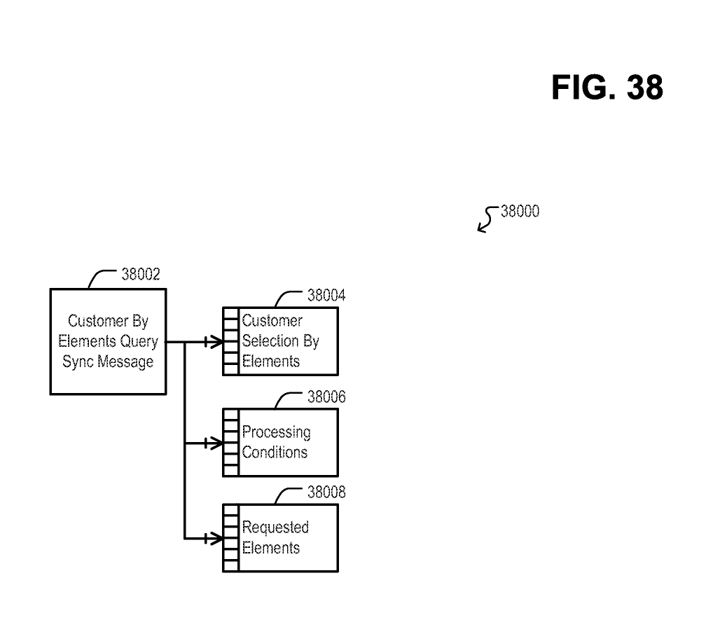

FIG. 38 illustrates one example logical configuration of a Customer By Elements Query Sync Message 38000. Specifically, this figure depicts the arrangement and hierarchy of various components such as one or more levels of packages, entities, and data types, shown here as 38000 through 38008. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer By Elements Query Sync Message 38000 includes, among other things, the Customer Selection By Elements entity 38004. Accordingly, heterogeneous applications may communicate using this consistent message configured as such.

The message type Customer By Elements Query_sync is derived from the business object Customer as a leading object together with its operation signature. The message type Customer By Elements Query_sync is a query about customer data by elements. The structure of the message type Customer By Elements Query_sync is determined by the message data type CustomerByElementsQueryMessage_sync.

The message data type CustomerByElementsQueryMessage_sync includes the CustomerSelectionByElements package and the RequestedElements package. The package CustomerSelectionByElements includes the entity CustomerSelectionByElements.

CustomerSelectionByElements includes the following non-node elements: SelectionByBusinessPartnerRoleCode, SelectionByInternalID, SelectionByUUID, SelectionByCategoryCode, SelectionByBusinessPartnerName, SelectionByBusinessPartnerAdditionalName, SelectionBySortingFormattedName, SelectionByLegalCompetenceIndicator, SelectionByAddressDefaultIndicator, SelectionByPostalAddressCityName, SelectionByPostalAddressStreetPostalCode, SelectionByPostalAddressCountryCode, SelectionByPostalAddressRegionCode, SelectionByABCClassificationCode, SelectionByIndustrialSectorCode, SelectionByContactPersonlnternalID, SelectionByContactPersonUUID, SelectionByContactPersonFamilyName, SelectionByContactPersonGivenName, SelectionByContactPersonSortingFormattedName, SelectionByContactPersonWorkplaceEmailURI, SelectionBySalesArrangementSalesOrganisationID, SelectionByCreatedSinceDate, and SelectionBySearchText.

SelectionByBusinessPartnerRoleCode may have a multiplicity of 0 . . . * and may be based on datatype MIDT:CustomerSelectionByBusinessPartnerRoleCode. SelectionByBusinessPartnerRoleCode may include InclusionExclusionCode, IntervalBoundaryTypeCode, LowerBoundaryRoleCode, and UpperBoundaryRoleCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryRoleCode may have a multiplicity of 0 . . . 1 and may be based on datatype BGDT:BusinessPartnerRoleCode. UpperBoundaryRoleCode may have a multiplicity of 0 . . . 1 and may be based on datatype BGDT:BusinessPartnerRoleCode.

SelectionByInternalID may have a multiplicity of 0 . . . * and may be based on datatype MIDT:CustomerSelectionByInternalID. SelectionByInternalID may include InclusionExclusionCode, IntervalBoundaryTypeCode, LowerBoundaryInternalID, and UpperBoundaryInternalID. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryInternalID may have a multiplicity of 0 . . . 1 and may be based on datatype BGDT:BusinessPartnerInternalID. UpperBoundarylnternalID may have a multiplicity of 0 . . . 1 and may be based on datatype BGDT:BusinessPartnerInternalID.

SelectionByUUID may have a multiplicity of 0 . . . * and may be based on datatype MIDT:CustomerSelectionByUUID. SelectionByUUID may include InclusionExclusionCode, LowerBoundaryUUID, IntervalBoundaryTypeCode, and UpperBoundaryUUID. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryUUID may have a multiplicity of 0 . . . 1 and may be based on datatype BGDT:UUID. UpperBoundaryUUID may have a multiplicity of 0 . . . 1 and may be based on datatype BGDT:UUID.

SelectionByCategoryCode may have a multiplicity of 0 . . . * and may be based on datatype MIDT:CustomerSelectionByCategoryCode. SelectionByCategoryCode may include InclusionExclusionCode, IntervalBoundaryTypeCode, LowerBoundaryCategoryCode, and UpperBoundaryCategoryCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryCategoryCode may have a multiplicity of 0 . . . 1 and may be based on datatype BGDT:BusinessPartnerCategoryCode. UpperBoundaryCategoryCode may have a multiplicity of 0 . . . 1 and may be based on datatype BGDT:BusinessPartnerCategoryCode.

SelectionByBusinessPartnerName may have a multiplicity of 0 . . . * and may be based on datatype MIDT:CustomerSelectionByBusinessPartnerName. SelectionByBusinessPartnerName may include InclusionExclusionCode, IntervalBoundaryTypeCode, LowerBoundaryBusinessPartnerName, and UpperBoundaryBusinessPartnerName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryBusinessPartnerName may have a multiplicity of 0 . . . 1 and may be based on datatype CDT:LANGUAGEINDEPENDENT_MEDIUM_Name. UpperBoundaryBusinessPartnerName may have a multiplicity of 0 . . . 1 and may be based on datatype CDT:LANGUAGEINDEPENDENT_MEDIUM_Name.

SelectionByBusinessPartnerAdditionalName may have a multiplicity of 0 . . . * and may be based on datatype MIDT:CustomerSelectionByBusinessPartnerAdditionalName. SelectionByBusinessPartnerAdditionalName may include InclusionExclusionCode, IntervalBoundaryTypeCode, LowerBoundaryBusinessPartnerAdditionalName, and UpperBoundaryBusinessPartnerAdditionalName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryBusinessPartnerAdditionalName may have a multiplicity of 0 . . . 1 and may be based on datatype CDT:LANGUAGEINDEPENDENT_MEDIUM_Name. UpperBoundaryBusinessPartnerAdditionalName may have a multiplicity of 0 . . . 1 and may be based on datatype CDT:LANGUAGEINDEPENDENT_MEDIUM_Name.

SelectionBySortingFormattedName may have a multiplicity of 0 . . . * and may be based on datatype MIDT:CustomerSelectionBySortingFormattedName. SelectionBySortingFormattedName may include InclusionExclusionCode, IntervalBoundaryTypeCode, LowerBoundarySortingFormattedName, and UpperBoundarySortingFormattedName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundarySortingFormattedName may have a multiplicity of 0 . . . 1 and may be based on datatype CDT:LANGUAGEINDEPENDENT_LONG_Name. UpperBoundarySortingFormattedName may have a multiplicity of 0 . . . 1 and may be based on datatype CDT:LANGUAGEINDEPENDENT_LONG_Name.

SelectionByLegalCompetenceIndicator may have a multiplicity of 0 . . . 1 and may be based on datatype CDT:Indicator SelectionByAddressDefaultIndicator may have a multiplicity of 0 . . . 1 and may be based on datatype CDT:Indicator. SelectionByPostalAddressCityName may have a multiplicity of 0 . . . * and may be based on datatype MIDT:CustomerSelectionByCityName. SelectionByPostalAddressCityName may include InclusionExclusionCode, IntervalBoundaryTypeCode, LowerBoundaryCityName, and UpperBoundaryCityName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryCityName may have a multiplicity of 0 . . . 1 and may be based on datatype CDT:LANGUAGEINDEPENDENT_MEDIUM_Name. UpperBoundaryCityName may have a multiplicity of 0 . . . 1 and may be based on datatype CDT:LANGUAGEINDEPENDENT_MEDIUM_Name.

SelectionByPostalAddressStreetPostalCode may have a multiplicity of 0 . . . * and may be based on datatype MIDT:CustomerSelectionByStreetPostalCode. SelectionByPostalAddressStreetPostalCode may include InclusionExclusionCode, IntervalBoundaryTypeCode, LowerBoundaryStreetPostalCode, and UpperBoundaryStreetPostalCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryStreetPostalCode may have a multiplicity of 0 . . . 1 and may be based on datatype BGDT:PostalCode. UpperBoundaryStreetPostalCode may have a multiplicity of 0 . . . 1 and may be based on datatype BGDT:PostalCode.

SelectionByPostalAddressCountryCode may have a multiplicity of 0 . . . * and may be based on datatype MIDT:CustomerSelectionByCountryCode. SelectionByPostalAddressCountryCode may include InclusionExclusionCode, IntervalBoundaryTypeCode, LowerBoundaryCountryCode, and UpperBoundaryCountryCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryCountryCode may have a multiplicity of 0 . . . 1 and may be based on datatype BGDT:CountryCode. UpperBoundaryCountryCode may have a multiplicity of 0 . . . 1 and may be based on datatype BGDT:CountryCode.

SelectionByPostalAddressRegionCode may have a multiplicity of 0 . . . * and may be based on datatype MIDT:CustomerSelectionByRegionCode. SelectionByPostalAddressRegionCode may include InclusionExclusionCode, IntervalBoundaryTypeCode, LowerBoundaryRegionCode, and UpperBoundaryRegionCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryRegionCode may have a multiplicity of 0 . . . 1 and may be based on datatype BGDT:RegionCode. UpperBoundaryRegionCode may have a multiplicity of 0 . . . 1 and may be based on datatype BGDT:RegionCode.

SelectionByABCClassificationCode may have a multiplicity of 0 . . . * and may be based on datatype MIDT:CustomerSelectionByCustomerABCClassificationCode. SelectionByABCClassificationCode may include InclusionExclusionCode, IntervalBoundaryTypeCode, LowerBoundaryCustomerABCClassificationCode, and UpperBoundaryCustomerABCClassificationCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryCustomerABCClassificationCode may have a multiplicity of 0 . . . 1 and may be based on datatype BGDT:CustomerABCClassificationCode. UpperBoundaryCustomerABCClassificationCode may have a multiplicity of 0 . . . 1 and may be based on datatype BGDT:CustomerABCClassificationCode.

SelectionBylndustrialSectorCode may have a multiplicity of 0 . . . * and may be based on datatype MIDT:CustomerSelectionByIndustrialSectorCode. SelectionBylndustrialSectorCode may include InclusionExclusionCode, IntervalBoundaryTypeCode, LowerBoundaryIndustrialSectorCode, and UpperBoundaryIndustrialSectorCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryIndustrialSectorCode may have a multiplicity of 0 . . . 1 and may be based on datatype BGDT:IndustrialSectorCode. UpperBoundaryIndustrialSectorCode may have a multiplicity of 0 . . . 1 and may be based on datatype BGDT:IndustrialSectorCode.

SelectionByContactPersonInternalID may have a multiplicity of 0 . . . * and may be based on datatype MIDT:CustomerSelectionByInternalID. SelectionByContactPersonInternalID may include InclusionExclusionCode, IntervalBoundaryTypeCode, LowerBoundaryInternalID, and UpperBoundarylnternalID. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryInternalID may have a multiplicity of 0 . . . 1 and may be based on datatype BGDT:BusinessPartnerInternalID. UpperBoundarylnternalID may have a multiplicity of 0 . . . 1 and may be based on datatype BGDT:BusinessPartnerInternalID.

SelectionByContactPersonUUID may have a multiplicity of 0 . . . * and may be based on datatype MIDT:CustomerSelectionByUUID. SelectionByContactPersonUUID may include InclusionExclusionCode, IntervalBoundaryTypeCode, LowerBoundaryUUID, and UpperBoundaryUUID. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryUUID may have a multiplicity of 0 . . . 1 and may be based on datatype BGDT:UUID. UpperBoundaryUUID may have a multiplicity of 0 . . . 1 and may be based on datatype BGDT:UUID.

SelectionByContactPersonFamilyName may have a multiplicity of 0 . . . * and may be based on datatype MIDT:CustomerSelectionByBusinessPartnerName. SelectionByContactPersonFamilyName may include InclusionExclusionCode, IntervalBoundaryTypeCode, LowerBoundaryBusinessPartnerName, and UpperBoundaryBusinessPartnerName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryBusinessPartnerName may have a multiplicity of 0 . . . 1 and may be based on datatype CDT:LANGUAGEINDEPENDENT_MEDIUM_Name. UpperBoundaryBusinessPartnerName may have a multiplicity of 0 . . . 1 and may be based on datatype CDT:LANGUAGEINDEPENDENT_MEDIUM_Name.

SelectionByContactPersonGivenName may have a multiplicity of 0 . . . * and may be based on datatype MIDT:CustomerSelectionByBusinessPartnerAdditionalName. SelectionByContactPersonGivenName may include InclusionExclusionCode, IntervalBoundaryTypeCode, LowerBoundaryBusinessPartnerAdditionalName, and UpperBoundaryBusinessPartnerAdditionalName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryBusinessPartnerAdditionalName may have a multiplicity of 0 . . . 1 and may be based on datatype CDT:LANGUAGEINDEPENDENT_MEDIUM_Name. UpperBoundaryBusinessPartnerAdditionalName may have a multiplicity of 0 . . . 1 and may be based on datatype CDT:LANGUAGEINDEPENDENT_MEDIUM_Name.

SelectionByContactPersonSortingFormattedName may have a multiplicity of 0 . . . * and may be based on datatype MIDT:CustomerSelectionBySortingFormattedName. SelectionByContactPersonSortingFormattedName may include InclusionExclusionCode, IntervalBoundaryTypeCode, LowerBoundarySortingFormattedName, and UpperBoundarySortingFormattedName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundarySortingFormattedName may have a multiplicity of 0 . . . 1 and may be based on datatype CDT:LANGUAGEINDEPENDENT_LONG_Name. UpperBoundarySortingFormattedName may have a multiplicity of 0 . . . 1 and may be based on datatype CDT:LANGUAGEINDEPENDENT_LONG_Name.

SelectionByContactPersonWorkplaceEmailURI may have a multiplicity of 0 . . . * and may be based on datatype MIDT:CustomerSelectionByEmailURI. SelectionByContactPersonWorkplaceEmailURI may include InclusionExclusionCode, IntervalBoundaryTypeCode, LowerBoundaryEmailURI, and UpperBoundaryEmailURI. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryEmailURI may have a multiplicity of 0 . . . 1 and may be based on datatype BGDT:EmailURI. UpperBoundaryEmailURI may have a multiplicity of 0 . . . 1 and may be based on datatype BGDT:EmailURI.

SelectionBySalesArrangementSalesOrganisationID may have a multiplicity of 0 . . . * and may be based on datatype MIDT:CustomerSelectionBySalesOrganisationID. SelectionBySalesArrangementSalesOrganisationID may include InclusionExclusionCode, IntervalBoundaryTypeCode, LowerBoundarySalesOrganisationID, and UpperBoundarySalesOrganisationID. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundarySalesOrganisationID may have a multiplicity of 0 . . . 1 and may be based on datatype BGDT:OrganisationalCentreID. UpperBoundarySalesOrganisationID may have a multiplicity of 0 . . . 1 and may be based on datatype BGDT:OrganisationalCentreID.

SelectionByCreatedSinceDate may have a multiplicity of 0 . . . 1 and may be based on datatype CDT:Date. SelectionByChangedSinceDate may have a multiplicity of 0 . . . 1 and may be based on datatype CDT:Date. SelectionByLifeCycleStatusCode may have a multiplicity of 0 . . . * and may be based on datatype MIDT:CustomerSelectionByLifeCycleStatusCode. SelectionByLifeCycleStatusCode may include InclusionExclusionCode, IntervalBoundaryTypeCode, LowerBoundaryLifeCycleStatusCode, and UpperBoundaryLifeCycleStatusCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryLifeCycleStatusCode may have a multiplicity of 0 . . . 1 and may be based on datatype BGDT:NOTDELETED_PartyLifeCycleStatusCode. UpperBoundaryLifeCycleStatusCode may have a multiplicity of 0 . . . 1 and may be based on datatype BGDT:NOTDELETED_PartyLifeCycleStatusCode. SelectionBySearchText may have a multiplicity of 0 . . . 1 and may be based on datatype BGDT:SearchText. ProcessingConditions is typed by QueryProcessingConditions.

The package RequestedElements includes the entity RequestedElements. RequestedElements includes the customerTransmissionRequestCode attribute, which may have a multiplicity of 0 . . . 1 and may be based on datatype BGDT:TransmissionRequestCode. RequestedElements includes the following non-node elements: Customer, AddressInformationTransmissionRequestCode, RelationshipTransmissionRequestCode, ContactPersonTransmissionRequestCode, CommunicationArrangementTransmissionRequestCode, DirectResponsibilityTransmissionRequestCode, SalesArrangementTransmissionRequestCode, BankDetailsTransmissionRequestCode, PaymentCardDetailsTransmissionRequestCode, PaymentDataTransmissionRequestCode, PersonTransmissionRequestCode, TaxNumberTransmissionRequestCode, GeneralProductTaxExemptionTransmissionRequestCode, OperatingHoursInfoTransmissionRequestCode, OrganisationTransmissionRequestCode, TextTransmissionRequestCode, and AttachmentFolderTransmissionRequestCode. Customer may have a multiplicity of 0 . . . 1 and may be based on datatype MIDT:CustomerRequestedElements Customer. AddressInformationTransmissionRequestCode may have a multiplicity of 0 . . . 1 and may be based on datatype BGDT:TransmissionRequestCode. RelationshipTransmissionRequestCode may have a multiplicity of 0 . . . 1 and may be based on datatype BGDT:TransmissionRequestCode. ContactPersonTransmissionRequestCode may have a multiplicity of 0 . . . 1 and may be based on datatype BGDT:TransmissionRequestCode. CommunicationArrangementTransmissionRequestCode may have a multiplicity of 0 . . . 1 and may be based on datatype BGDT:TransmissionRequestCode. DirectResponsibilityTransmissionRequestCode may have a multiplicity of 0 . . . 1 and may be based on datatype BGDT:TransmissionRequestCode. SalesArrangementTransmissionRequestCode may have a multiplicity of 0 . . . 1 and may be based on datatype BGDT:TransmissionRequestCode. BankDetailsTransmissionRequestCode may have a multiplicity of 0 . . . 1 and may be based on datatype BGDT:TransmissionRequestCode. PaymentCardDetailsTransmissionRequestCode may have a multiplicity of 0 . . . 1 and may be based on datatype BGDT:TransmissionRequestCode. PaymentDataTransmissionRequestCode may have a multiplicity of 0 . . . 1 and may be based on datatype BGDT:TransmissionRequestCode. PersonTransmissionRequestCode may have a multiplicity of 0 . . . 1 and may be based on datatype BGDT:TransmissionRequestCode. TaxNumberTransmissionRequestCode may have a multiplicity of 0 . . . 1 and may be based on datatype BGDT:TransmissionRequestCode. GeneralProductTaxExemptionTransmissionRequestCode may have a multiplicity of 0 . . . 1 and may be based on datatype BGDT:TransmissionRequestCode. OperatingHoursInfoTransmissionRequestCode may have a multiplicity of 0 . . . 1 and may be based on datatype BGDT:TransmissionRequestCode. OrganisationTransmissionRequestCode may have a multiplicity of 0 . . . 1 and may be based on datatype BGDT:TransmissionRequestCode. TextTransmissionRequestCode may have a multiplicity of 0 . . . 1 and may be based on datatype BGDT:TransmissionRequestCode. AttachmentFolderTransmissionRequestCode may have a multiplicity of 0 . . . 1 and may be based on datatype BGDT:TransmissionRequestCode.

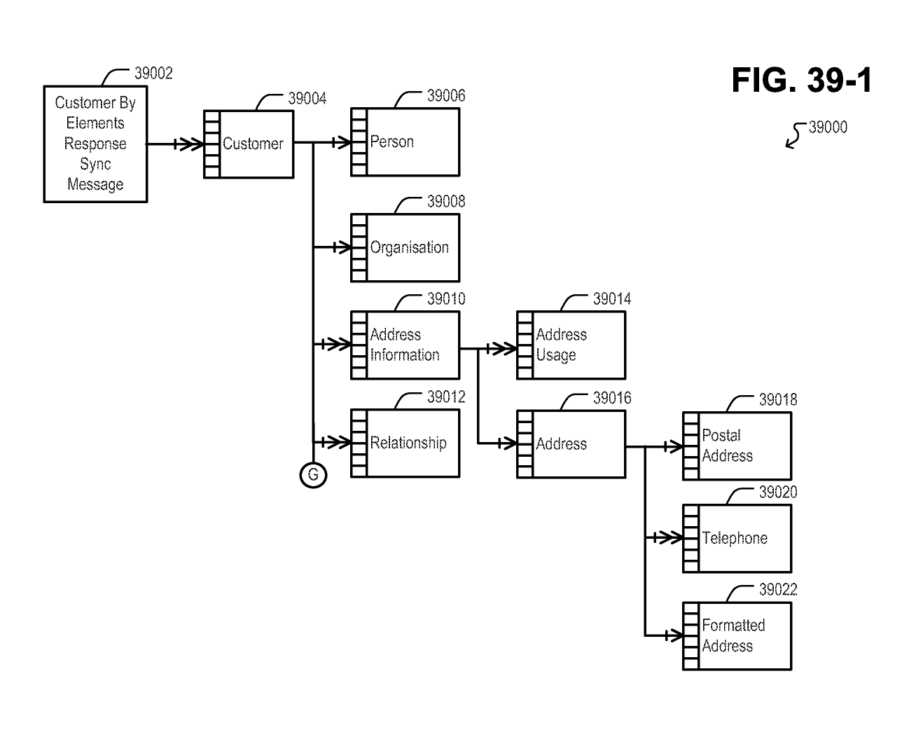

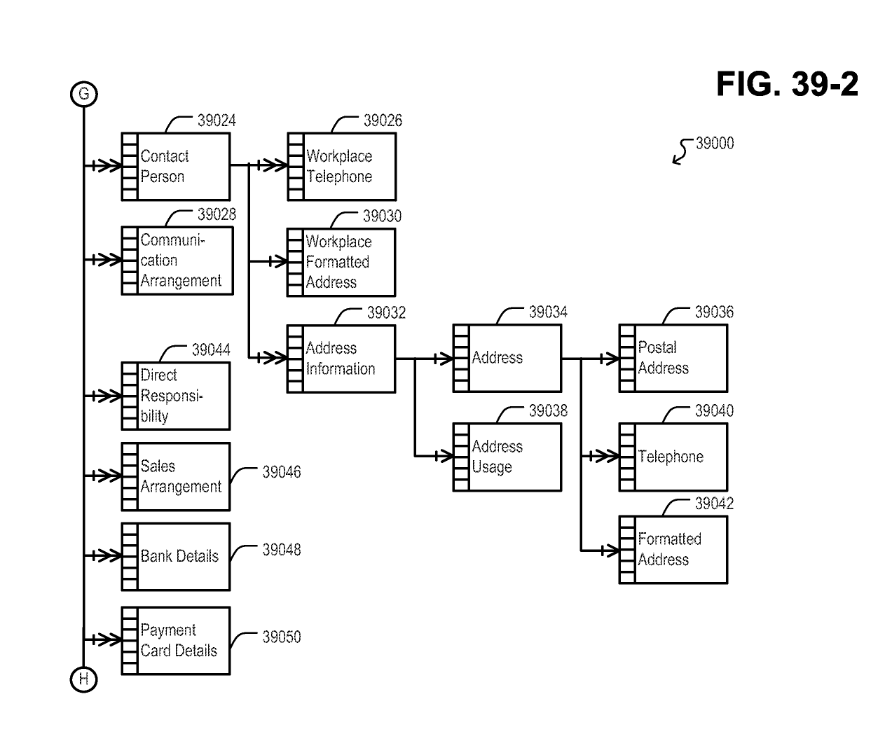

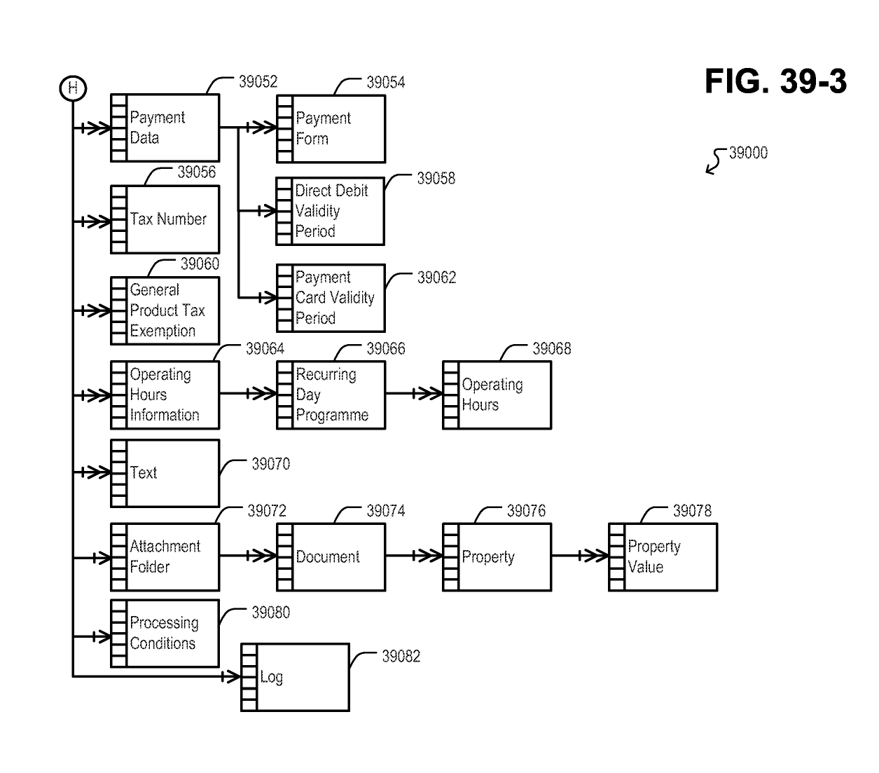

FIGS. 39-1 through 39-3 collectively illustrate one example logical configuration of a Customer By Elements Response Sync Message 39000. Specifically, these figures depict the arrangement and hierarchy of various components such as one or more levels of packages, entities, and data types, shown here as 39000 through 39082. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer By Elements Response Sync Message 39000 includes, among other things, the Person entity 39006. Accordingly, heterogeneous applications may communicate using this consistent message configured as such.

The message type Customer By Elements Response_sync is derived from the business object Customer as a leading object together with its operation signature. The message type Customer By Elements Response_sync is a response concerning an inquiry about customer data that includes the requested customer data as well as processing conditions. Corresponding system messages can be provided as log items. The structure of the message type Customer By Elements Response_sync is determined by the message data type CustomerResponseMessage_sync. The message data type CustomerResponseMessage_sync includes the Customer package, the ProcessingConditions package, and the Log package.

The package Customer includes the sub-packages Person, Organisation, AddressInformation, Relationship, ContactPerson, CommunicationArrangement, DirectResponsibility, SalesArrangement, BankDetails, PaymentCardDetails, PaymentData, TaxNumber, GeneralProductTaxExemption, OperatingHoursInformation, Text, and AttachmentFolder, and the entity Customer.

Customer includes the following non-node elements: ChangeStateID, UUID, InternalID, SystemAdministrativeData, CategoryCode, ProspectIndicator, CustomerIndicator, LifeCycleStatusCode, VerbalCommunicationLanguageCode, ContactAllowedCode, LegalCompetenceIndicator, DunAndBradstreetNumberID, GlobalLocationNumberID, ABCClassificationCode, NielsenRegionCode, IndustrialSectorCode, InvoicingBlockingReasonCode, CustomerTransactionDocumentFulfilmentBlockingReasonCode, CustomerBlockingReasonCode, and EnterpriseIdentificationNumber. ChangeStateID may have a multiplicity of 0 . . . 1 and may be based on datatype BGDT:ChangeStateID. UUID may have a multiplicity of 0 . . . 1 and may be based on datatype BGDT:UUID. InternalID may have a multiplicity of 0 . . . 1 and may be based on datatype BGDT:BusinessPartnerInternalID. SystemAdministrativeData may have a multiplicity of 0 . . . 1 and may be based on datatype AGDT:SystemAdministrativeData. CategoryCode may have a multiplicity of 0 . . . 1 and may be based on datatype BGDT:BusinessPartnerCategoryCode. ProspectIndicator may have a multiplicity of 0 . . . 1 and may be based on datatype CDT:Indicator. CustomerIndicator may have a multiplicity of 0 . . . 1 and may be based on datatype CDT:Indicator. LifeCycleStatusCode may have a multiplicity of 0 . . . 1 and may be based on datatype BGDT:PartyLifeCycleStatusCode. VerbalCommunicationLanguageCode may have a multiplicity of 0 . . . 1 and may be based on datatype BGDT:LanguageCode. ContactAllowedCode may have a multiplicity of 0 . . . 1 and may be based on datatype BGDT:ContactAllowedCode. LegalCompetenceIndicator may have a multiplicity of 0 . . . 1 and may be based on datatype CDT:Indicator. DunAndBradstreetNumberID may have a multiplicity of 0 . . . 1 and may be based on datatype BGDT:BusinessPartnerID. GlobalLocationNumberID may have a multiplicity of 0 . . . 1 and may be based on datatype BGDT:BusinessPartnerID. ABCClassificationCode may have a multiplicity of 0 . . . 1 and may be based on datatype BGDT:CustomerABCClassificationCode. NielsenRegionCode may have a multiplicity of 0 . . . 1 and may be based on datatype BGDT:NielsenRegionCode. IndustrialSectorCode may have a multiplicity of 0 . . . 1 and may be based on datatype BGDT:IndustrialSectorCode. InvoicingBlockingReasonCode may have a multiplicity of 0 . . . 1 and may be based on datatype BGDT:InvoicingBlockingReasonCode. CustomerTransactionDocumentFulfilmentBlockingReasonCode may have a multiplicity of 0 . . . 1 and may be based on datatype BGDT:CustomerTransactionDocumentFulfilmentBlockingReasonCode. CustomerBlockingReasonCode may have a multiplicity of 0 . . . 1 and may be based on datatype BGDT:CustomerBlockingReasonCode. EnterpriseIdentificationNumber may have a multiplicity of 0 . . . 1 and may be based on datatype BGDT:BusinessPartnerID.

Customer includes the following node elements: Person, with a cardinality of 1:C; Organisation, with a cardinality of 1:C; AddressInformation, with a cardinality of 1:CN; Relationship, with a cardinality of 1:CN; ContactPerson, with a cardinality of 1:CN; CommunicationArrangement, with a cardinality of 1:CN; DirectResponsibility, with a cardinality of 1:CN; SalesArrangement, with a cardinality of 1:CN; BankDetails, with a cardinality of 1:CN; PaymentCardDetails, with a cardinality of 1:CN; PaymentData, with a cardinality of 1:CN; TaxNumber, with a cardinality of 1:CN; GeneralProductTaxExemption, with a cardinality of 1:CN; OperatingHoursInformation, with a cardinality of 1:CN; Text, with a cardinality of 1:CN; and AttachmentFolder, with a cardinality of 1:C.

The package CustomerPerson includes the entity Person. Person includes the following non-node elements: FormOfAddressCode, AcademicTitleCode, GivenName, MiddleName, FamilyName, BirthName, NickName, NameFormatCountryCode, GenderCode, BirthDate, NonVerbalCommunicationLanguageCode, and OccupationCode. FormOfAddressCode may have a multiplicity of 0 . . . 1 and may be based on datatype BGDT:FormOfAddressCode. AcademicTitleCode may have a multiplicity of 0 . . . 1 and may be based on datatype BGDT:AcademicTitleCode. GivenName may have a multiplicity of 0 . . . 1 and may be based on datatype CDT:LANGUAGEINDEPENDENT_MEDIUM_Name. MiddleName may have a multiplicity of 0 . . . 1 and may be based on datatype CDT:LANGUAGEINDEPENDENT_MEDIUM_Name. FamilyName may have a multiplicity of 0 . . . 1 and may be based on datatype CDT:LANGUAGEINDEPENDENT_MEDIUM_Name. BirthName may have a multiplicity of 0 . . . 1 and may be based on datatype CDT:LANGUAGEINDEPENDENT_MEDIUM_Name. NickName may have a multiplicity of 0 . . . 1 and may be based on datatype CDT:LANGUAGEINDEPENDENT_MEDIUM_Name. NameFormatCountryCode may have a multiplicity of 0 . . . 1 and may be based on datatype BGDT:CountryCode. GenderCode may have a multiplicity of 0 . . . 1 and may be based on datatype BGDT:GenderCode. BirthDate may have a multiplicity of 0 . . . 1 and may be based on datatype CDT:Date, with a qualifier of Birth. NonVerbalCommunicationLanguageCode may have a multiplicity of 0 . . . 1 and may be based on datatype BGDT:LanguageCode, with a qualifier of Communication. OccupationCode may have a multiplicity of 0 . . . 1 and may be based on datatype BGDT:OccupationCode.

The package CustomerOrganisation includes the entity Organisation. Organisation includes the following non-node elements: CompanyLegalFormCode, FirstLineName, and SecondLineName. CompanyLegalFormCode may have a multiplicity of 0 . . . 1 and may be based on datatype BGDT:CompanyLegalFormCode. FirstLineName may have a multiplicity of 0 . . . 1 and may be based on datatype CDT:LANGUAGEINDEPENDENT_MEDIUM_Name. SecondLineName may have a multiplicity of 0 . . . 1 and may be based on datatype CDT:LANGUAGEINDEPENDENT_MEDIUM_Name.

The package CustomerAddressInformation includes the entity AddressInformation. AddressInformation includes the following non-node elements: UUID and CurrentAddressSnapshotUUID. UUID may have a multiplicity of 0 . . . 1 and may be based on datatype BGDT:UUID. CurrentAddressSnapshotUUID may have a multiplicity of 0 . . . 1 and may be based on datatype BGDT:UUID. AddressInformation includes the following node elements: AddressUsage, with a cardinality of 1:CN; and Address, with a cardinality of 1:C.

AddressUsage includes the following non-node elements: AddressUsageCode and DefaultIndicator. AddressUsageCode may have a multiplicity of 1 and may be based on datatype BGDT:AddressUsageCode. DefaultIndicator may have a multiplicity of 0 . . . 1 and may be based on datatype CDT:Indicator.

Address includes the following non-node elements: CorrespondenceLanguageCode, PreferredCommunicationMediumTypeCode, EmailURI, FacsimileFormattedNumberDescription, and WebURI. CorrespondenceLanguageCode may have a multiplicity of 0 . . . 1 and may be based on datatype BGDT:LanguageCode. PreferredCommunicationMediumTypeCode may have a multiplicity of 0 . . . 1 and may be based on datatype BGDT:CommunicationMediumTypeCode. EmailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. WebURI may have a multiplicity of 0 . . . 1 and may be based on datatype BGDT:WebURI. Address includes the following node elements: PostalAddress, with a cardinality of 1:C; Telephone, with a cardinality of 1:CN; and FormattedAddress, with a cardinality of 1:C.

PostalAddress includes the following non-node elements: CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, CareOfName, POBoxDeviatingCountryCode, POBoxDeviatingRegionCode, POBoxDeviatingCityName, POBoxID, POBoxIndicator, TaxJurisdictionCode, and TimeZoneCode. CountryCode may have a multiplicity of 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

Telephone includes the following non-node elements: FormattedNumberDescription and MobilePhoneNumberIndicator. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

FormattedAddress includes the following non-node elements: FormattedAddressDescription, FormattedPostalAddressDescription, FormattedAddress, and FormattedPostalAddress. FormattedAddressDescription may have a multiplicity of 0 . . . 1 and may be based on datatype BGDT:LANGUAGEINDEPENDENT_MEDIUM_Description. FormattedPostalAddressDescription may have a multiplicity of 0 . . . 1 and may be based on datatype BGDT:LANGUAGEINDEPENDENT_MEDIUM_Description. FormattedAddress may have a multiplicity of 0 . . . 1 and may be based on datatype AGDT:FormattedAddress. FormattedPostalAddress may have a multiplicity of 0 . . . 1 and may be based on datatype AGDT:FormattedPostalAddress.

The package CustomerRelationship includes the entity Relationship. Relationship includes the following non-node elements: RelationshipBusinessPartnerUUID, RelationshipBusinessPartnerInternalID, and RoleCode. RelationshipBusinessPartnerUUID may have a multiplicity of 0 . . . 1 and may be based on datatype BGDT:UUID. RelationshipBusinessPartnerInternalID may have a multiplicity of 0 . . . 1 and may be based on datatype BGDT:BusinessPartnerInternalID. RoleCode may have a multiplicity of 1 and may be based on datatype BGDT:BusinessPartnerRelationshipRoleCode.

The package CustomerContactPerson includes the sub-package AddressInformation and the entity ContactPerson. ContactPerson includes the following non-node elements: BusinessPartnerContactUUID, BusinessPartnerContactInternalID, DefaultContactPersonIndicator, FormOfAddressCode, AcademicTitleCode, GivenName, MiddleName, FamilyName, BirthName, NickName, GenderCode, BirthDate, NonVerbalCommunicationLanguageCode, OccupationCode, BusinessPartnerFunctionTypeCode, BusinessPartnerFunctionalAreaCode, VIPReasonCode, CurrentWorkplaceAddressSnapshotUUID, WorkplaceBusinessAddressUUID, WorkplacePreferredCommunicationMediumTypeCode, WorkplaceEmailURI, WorkplaceFacsimileFormattedNumberDescription, WorkplaceWebURI, WorkplaceFunctionalTitleName, WorkplaceDepartmentName, WorkplaceBuildingID, WorkplaceFloorID, WorkplaceRoomID, LifeCycleStatusCode, and MaritalStatusCode.

BusinessPartnerContactUUID may have a multiplicity of 0 . . . 1 and may be based on datatype BGDT:UUID. BusinessPartnerContactlnternalID may have a multiplicity of 0 . . . 1 and may be based on datatype BGDT:BusinessPartnerInternalID. DefaultContactPersonIndicator may have a multiplicity of 0 . . . 1 and may be based on datatype CDT:Indicator. FormOfAddressCode may have a multiplicity of 0 . . . 1 and may be based on datatype BGDT:FormOfAddressCode. AcademicTitleCode may have a multiplicity of 0 . . . 1 and may be based on datatype BGDT:AcademicTitleCode. GivenName may have a multiplicity of 0 . . . 1 and may be based on datatype CDT:LANGUAGEINDEPENDENT_MEDIUM_Name. MiddleName may have a multiplicity of 0 . . . 1 and may be based on datatype CDT:LANGUAGEINDEPENDENT_MEDIUM_Name. FamilyName may have a multiplicity of 0 . . . 1 and may be based on datatype CDT:LANGUAGEINDEPENDENT_MEDIUM_Name. BirthName may have a multiplicity of 0 . . . 1 and may be based on datatype CDT:LANGUAGEINDEPENDENT_MEDIUM_Name. NickName may have a multiplicity of 0 . . . 1 and may be based on datatype CDT:LANGUAGEINDEPENDENT_MEDIUM_Name. GenderCode may have a multiplicity of 0 . . . 1 and may be based on datatype BGDT:GenderCode. BirthDate may have a multiplicity of 0 . . . 1 and may be based on datatype CDT:Date. NonVerbalCommunicationLanguageCode may have a multiplicity of 0 . . . 1 and may be based on datatype BGDT:LanguageCode. OccupationCode may have a multiplicity of 0 . . . 1 and may be based on datatype BGDT:OccupationCode. BusinessPartnerFunctionTypeCode may have a multiplicity of 0 . . . 1 and may be based on datatype BGDT:BusinessPartnerFunctionTypeCode. BusinessPartnerFunctionalAreaCode may have a multiplicity of 0 . . . 1 and may be based on datatype BGDT:BusinessPartnerFunctionalAreaCode. VIPReasonCode may have a multiplicity of 0 . . . 1 and may be based on datatype BGDT:VIPReasonCode. CurrentWorkplaceAddressSnapshotUUID may have a multiplicity of 0 . . . 1 and may be based on datatype BGDT:UUID. WorkplaceBusinessAddressUUID may have a multiplicity of 0 . . . 1 and may be based on datatype BGDT:UUID. WorkplacePreferredCommunicationMediumTypeCode may have a multiplicity of 0 . . . 1 and may be based on datatype BGDT:CommunicationMediumTypeCode. WorkplaceEmailURI may have a multiplicity of 0 . . . 1 and may be based on datatype BGDT:EmailURI. WorkplaceFacsimileFormattedNumberDescription may have a multiplicity of 0 . . . 1 and may be based on datatype BGDT:LANGUAGEINDEPENDENT_SHORT_Description. WorkplaceWebURI may have a multiplicity of 0 . . . 1 and may be based on datatype BGDT:WebURI. WorkplaceFunctionalTitleName may have a multiplicity of 0 . . . 1 and may be based on datatype CDT:LANGUAGEINDEPENDENT_MEDIUM_Name. WorkplaceDepartmentName may have a multiplicity of 0 . . . 1 and may be based on datatype CDT:LANGUAGEINDEPENDENT_MEDIUM_Name. WorkplaceBuildingID may have a multiplicity of 0 . . . 1 and may be based on datatype BGDT:BuildingID. WorkplaceFloorID may have a multiplicity of 0 . . . 1 and may be based on datatype BGDT:FloorID. WorkplaceRoomID may have a multiplicity of 0 . . . 1 and may be based on datatype BGDT:RoomID LifeCycleStatusCode may have a multiplicity of 0 . . . 1 and may be based on datatype BGDT:PartyLifeCycleStatusCode. MaritalStatusCode may have a multiplicity of 0 . . . 1 and may be based on datatype BGDT:MaritalStatusCode. ContactPerson includes the following node elements: WorkplaceTelephone, with a cardinality of 1:CN; WorkplaceFormattedAddress, with a cardinality of 1:C; and AddressInformation, with a cardinality of 1:CN.

WorkplaceTelephone includes the following non-node elements: FormattedNumberDescription and MobilePhoneNumberIndicator. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

WorkplaceFormattedAddress includes the following non-node elements: FormattedAddressDescription, FormattedPostalAddressDescription, FormattedAddress, and FormattedPostalAddress. FormattedAddressDescription may have a multiplicity of 0 . . . 1 and may be based on datatype BGDT:LANGUAGEINDEPENDENT_MEDIUM_Description. FormattedPostalAddressDescription may have a multiplicity of 0 . . . 1 and may be based on datatype BGDT:LANGUAGEINDEPENDENT_MEDIUM_Description. FormattedAddress may have a multiplicity of 0 . . . 1 and may be based on datatype AGDT:FormattedAddress. FormattedPostalAddress may have a multiplicity of 0 . . . 1 and may be based on datatype AGDT:FormattedPostalAddress.

The package CustomerContactPersonAddressInformation includes the entity AddressInformation. AddressInformation includes the following non-node elements: UUID and CurrentAddressSnapshotUUID. UUID may have a multiplicity of 0 . . . 1 and may be based on datatype BGDT:UUID. CurrentAddressSnapshotUUID may have a multiplicity of 0 . . . 1 and may be based on datatype BGDT:UUID. AddressInformation includes the following node elements: Address, with a cardinality of 1:C; and AddressUsage, with a cardinality of 1:C.

Address includes the following non-node elements: EmailURI and FacsimileFormattedNumberDescription. EmailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. Address includes the following node elements: PostalAddress, with a cardinality of 1:C; Telephone, with a cardinality of 1:CN; and FormattedAddress, with a cardinality of 1:C.

PostalAddress includes the following non-node elements: CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, CareOfName, POBoxDeviatingCountryCode, POBoxDeviatingRegionCode, POBoxDeviatingCityName, POBoxID, POBoxIndicator, TaxJurisdictionCode, and TimeZoneCode. CountryCode may have a multiplicity of 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

Telephone includes the following non-node elements: FormattedNumberDescription and MobilePhoneNumberIndicator. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

The package CustomerContactPersonAddressInformation includes the entity FormattedAddress. FormattedAddress includes the following non-node elements: FormattedAddressDescription, FormattedPostalAddressDescription, FormattedAddress, and FormattedPostalAddress. FormattedAddressDescription may have a multiplicity of 0 . . . 1 and may be based on datatype BGDT:LANGUAGEINDEPENDENT_MEDIUM_Description. FormattedPostalAddressDescription may have a multiplicity of 0 . . . 1 and may be based on datatype BGDT:LANGUAGEINDEPENDENT_MEDIUM_Description. FormattedAddress may have a multiplicity of 0 . . . 1 and may be based on datatype AGDT:FormattedAddress. FormattedPostalAddress may have a multiplicity of 0 . . . 1 and may be based on datatype AGDT:FormattedPostalAddress.

AddressUsage includes the following non-node elements: AddressUsageCode and DefaultIndicator. AddressUsageCode may have a multiplicity of 1 and may be based on datatype BGDT:AddressUsageCode. DefaultIndicator may have a multiplicity of 0 . . . 1 and may be based on datatype CDT:Indicator.

The package CustomerCommunicationArrangement includes the entity CommunicationArrangement. CommunicationArrangement includes the following non-node elements: UUID, CompoundServiceInterfaceCode, EnabledIndicator, CommunicationMediumTypeCode, OutputRequestFormTemplateCode, EMailURI, FacsimileFormattedNumberDescription, and OutputCopyNumberValue. UUID may have a multiplicity of 0 . . . 1 and may be based on datatype BGDT:UUID. CompoundServiceInterfaceCode may have a multiplicity of 0 . . . 1 and may be based on datatype BGDT:CompoundServiceInterfaceCode. EnabledIndicator may have a multiplicity of 0 . . . 1 and may be based on datatype CDT:Indicator. CommunicationMediumTypeCode may have a multiplicity of 0 . . . 1 and may be based on datatype BGDT:CommunicationMediumTypeCode. OutputRequestFormTemplateCode may have a multiplicity of 0 . . . 1 and may be based on datatype BGDT:OutputRequestFormTemplateCode. EMailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. OutputCopyNumberValue may have a multiplicity of 0 . . . 1 and may be based on datatype BGDT:NumberValue.

The package CustomerDirectResponsibility includes the entity DirectResponsibility. DirectResponsibility includes the following non-node elements: PartyRoleCode and EmployeeID. PartyRoleCode may have a multiplicity of 0 . . . 1 and may be based on datatype BGDT:PartyRoleCode. EmployeeID may have a multiplicity of 0 . . . 1 and may be based on datatype BGDT:EmployeeID.

The package CustomerSalesArrangement includes the entity SalesArrangement. SalesArrangement includes the following non-node elements: SalesOrganisationID, DistributionChannelCode, Incoterms, DeliveryPriorityCode, CompleteDeliveryRequestedIndicator, CurrencyCode, CustomerGroupCode, and CashDiscountTermsCode. SalesOrganisationID may have a multiplicity of 0 . . . 1 and may be based on datatype BGDT:OrganisationalCentreID. DistributionChannelCode may have a multiplicity of 0 . . . 1 and may be based on datatype BGDT:DistributionChannelCode. Incoterms may have a multiplicity of 0 . . . 1 and may be based on datatype AGDT:Incoterms. DeliveryPriorityCode may have a multiplicity of 0 . . . 1 and may be based on datatype BGDT:PriorityCode. CompleteDeliveryRequestedIndicator may have a multiplicity of 0 . . . 1 and may be based on datatype CDT:Indicator. CurrencyCode may have a multiplicity of 0 . . . 1 and may be based on datatype BGDT:CurrencyCode. CustomerGroupCode may have a multiplicity of 0 . . . 1 and may be based on datatype BGDT:CustomerGroupCode. CashDiscountTermsCode may have a multiplicity of 0 . . . 1 and may be based on datatype BGDT:CashDiscountTermsCode.

The package CustomerBankDetails includes the entity BankDetails. BankDetails includes the following non-node elements: ID, BankUUID, BankInternalID, BankRoutingID, BankRoutingIDTypeCode, BankStandardID, BankAccountID, BankAccountIDCheckDigitValue, BankAccountTypeCode, BankAccountHolderName, BankAccountStandardID, and ValidityPeriod. ID may have a multiplicity of 0 . . . 1 and may be based on datatype BGDT:BusinessPartnerBankDetailsID. BankUUID may have a multiplicity of 0 . . . 1 and may be based on datatype BGDT:UUID. BanklnternalID may have a multiplicity of 0 . . . 1 and may be based on datatype BGDT:BankInternalID. BankRoutingID may have a multiplicity of 0 . . . 1 and may be based on datatype BGDT:BankRoutingID. BankRoutingIDTypeCode may have a multiplicity of 0 . . . 1 and may be based on datatype BGDT:BankRoutingIDTypeCode. BankStandardID may have a multiplicity of 0 . . . 1 and may be based on datatype BGDT:BankStandardID. BankAccountID may have a multiplicity of 0 . . . 1 and may be based on datatype BGDT:BankAccountID. BankAccountIDCheckDigitValue may have a multiplicity of 0 . . . 1 and may be based on datatype BGDT:BankAccountIDCheckDigitValue. BankAccountTypeCode may have a multiplicity of 0 . . . 1 and may be based on datatype BGDT:BankAccountTypeCode. BankAccountHolderName may have a multiplicity of 0 . . . 1 and may be based on datatype BGDT:BankAccountHolderName_V1. BankAccountStandardID may have a multiplicity of 0 . . . 1 and may be based on datatype BGDT:BankAccountStandardID. ValidityPeriod may have a multiplicity of 0 . . . 1 and may be based on datatype AGDT:CLOSED_DatePeriod.

The package CustomerPaymentCardDetails includes the entity PaymentCardDetails. PaymentCardDetails includes the following non-node elements: ID, PaymentCardTypeCode, PaymentCardID, PaymentCardHolderName, PaymentCardExpirationDate, DefaultIndicator, BlockingReasonCode, StreetName, HouseID, PostalCode, CityName, RegionCode, and CountryCode. ID may have a multiplicity of 0 . . . 1 and may be based on datatype BGDT:BusinessPartnerPaymentCardDetailsID. PaymentCardTypeCode may have a multiplicity of 0 . . . 1 and may be based on datatype BGDT:PaymentCardTypeCode. PaymentCardID may have a multiplicity of 0 . . . 1 and may be based on datatype BGDT:PaymentCardID. PaymentCardHolderName may have a multiplicity of 0 . . . 1 and may be based on datatype CDT:LANGUAGEINDEPENDENT_MEDIUM_Name. PaymentCardExpirationDate may have a multiplicity of 0 . . . 1 and may be based on datatype CDT:Date, with a qualifier of Expiration. DefaultIndicator may have a multiplicity of 0 . . . 1 and may be based on datatype CDT:Indicator. BlockingReasonCode may have a multiplicity of 0 . . . 1 and may be based on datatype BGDT:PaymentCardBlockingReasonCode. StreetName may have a multiplicity of 0 . . . 1 and may be based on datatype BGDT:StreetName. HouseID may have a multiplicity of 0 . . . 1 and may be based on datatype BGDT:HouseID. PostalCode may have a multiplicity of 0 . . . 1 and may be based on datatype BGDT:PostalCode. CityName may have a multiplicity of 0 . . . 1 and may be based on datatype CDT:LANGUAGEINDEPENDENT_MEDIUM_Name. RegionCode may have a multiplicity of 0 . . . 1 and may be based on datatype BGDT:RegionCode. CountryCode may have a multiplicity of 0 . . . 1 and may be based on datatype BGDT:CountryCode.

The package CustomerPaymentData includes the entity PaymentData. PaymentData includes the following non-node elements: CompanyID, UUID, AccountDeterminationDebtorGroupCode, AccountDebtorExternalID, PaymentBlockingReasonCode, PaymentBlockExpirationDateTime, CreditLimitAmount, DirectDebitBankDetailsID, PaymentCardDetailsID, BillOfExchangeBankDetailsID, PaymentAdviceRequiredIndicator, FirstPaymentInstructionCode, SecondPaymentInstructionCode, ThirdPaymentInstructionCode, FourthPaymentInstructionCode, and BankChargeBearerCode. CompanyID may have a multiplicity of 1 and may be based on datatype BGDT:OrganisationalCentreID. UUID may have a multiplicity of 0 . . . 1 and may be based on datatype BGDT:UUID. AccountDeterminationDebtorGroupCode may have a multiplicity of 0 . . . 1 and may be based on datatype BGDT:AccountDeterminationDebtorGroupCode. AccountDebtorExternalID may have a multiplicity of 0 . . . 1 and may be based on datatype BGDT:PartyPartyID. PaymentBlockingReasonCode may have a multiplicity of 0 . . . 1 and may be based on datatype BGDT:PaymentBlockingReasonCode. PaymentBlockExpirationDateTime may have a multiplicity of 0 . . . 1 and may be based on datatype CDT:GLOBAL_DateTime. CreditLimitAmount may have a multiplicity of 0 . . . 1 and may be based on datatype CDT:Amount. DirectDebitBankDetailsID may have a multiplicity of 0 . . . 1 and may be based on datatype BGDT:BusinessPartnerBankDetailsID. PaymentCardDetailsID may have a multiplicity of 0 . . . 1 and may be based on datatype BGDT:BusinessPartnerPaymentCardDetailsID. BillOfExchangeBankDetailsID may have a multiplicity of 0 . . . 1 and may be based on datatype BGDT:BusinessPartnerBankDetailsID. PaymentAdviceRequiredIndicator may have a multiplicity of 0 . . . 1 and may be based on datatype CDT:Indicator. FirstPaymentInstructionCode may have a multiplicity of 0 . . . 1 and may be based on datatype BGDT:PaymentInstructionTypeCode. SecondPaymentInstructionCode may have a multiplicity of 0 . . . 1 and may be based on datatype BGDT:PaymentInstructionTypeCode. ThirdPaymentInstructionCode may have a multiplicity of 0 . . . 1 and may be based on datatype BGDT:PaymentInstructionTypeCode. FourthPaymentInstructionCode may have a multiplicity of 0 . . . 1 and may be based on datatype BGDT:PaymentInstructionTypeCode. BankChargeBearerCode may have a multiplicity of 0 . . . 1 and may be based on datatype BGDT:BankChargeBearerCode. PaymentData includes the following node elements: PaymentForm, with a cardinality of 1:CN; DirectDebitValidityPeriod, with a cardinality of 1:C; and PaymentCardValidityPeriod, with a cardinality of 1:C.

PaymentForm includes a PaymentFormCode element, which may have a multiplicity of 1 and may be based on datatype BGDT:PaymentFormCode. The package CustomerPaymentData includes the entity DirectDebitValidityPeriod and PaymentCardValidityPeriod. DirectDebitValidityPeriod is typed by datatype CLOSED_DatePeriod. PaymentCardValidityPeriod is typed by datatype CLOSED_DatePeriod.

The package CustomerTaxNumber includes the entity TaxNumber. TaxNumber includes the following non-node elements: CountryCode, TaxIdentificationNumberTypeCode, and PartyTaxID. CountryCode may have a multiplicity of 1 and may be based on datatype BGDT:CountryCode. TaxIdentificationNumberTypeCode may have a multiplicity of 1 and may be based on datatype BGDT:TaxIdentificationNumberTypeCode. PartyTaxID may have a multiplicity of 0 . . . 1 and may be based on datatype BGDT:PartyTaxID.

The package CustomerGeneralProductTaxExemption includes the entity GeneralProductTaxExemption. GeneralProductTaxExemption includes the following non-node elements: CountryCode, RegionCode, TaxTypeCode, and ReasonCode. CountryCode may have a multiplicity of 0 . . . 1 and may be based on datatype BGDT:CountryCode. RegionCode may have a multiplicity of 0 . . . 1 and may be based on datatype BGDT:RegionCode. TaxTypeCode may have a multiplicity of 0 . . . 1 and may be based on datatype BGDT:TaxTypeCode. ReasonCode may have a multiplicity of 0 . . . 1 and may be based on datatype BGDT:TaxExemptionReasonCode.

The package CustomerOperatingHoursInformation includes the entity OperatingHoursInformation. OperatingHoursInformation includes RoleCode non-node element, which may have a multiplicity of 1 and may be based on datatype BGDT:BUSINESSPARTNER_OperatingHoursRoleCode. OperatingHoursInformation includes the following node elements: RecurringDayProgramme, with a cardinality of 1:CN.

The package CustomerOperatingHoursInformation includes the entity RecurringDayProgramme RecurringDayProgramme includes the WeekdaySelection non-node element, which may have a multiplicity of 0 . . . 1 and may be based on datatype AGDT:WeekdaySelection. RecurringDayProgramme includes the following node elements: OperatingHours, with a cardinality of 1:CN. OperatingHours includes the TimePeriod non-node element, which may have a multiplicity of 1 and may be based on datatype AGDT:UPPEROPEN_TimePeriod.

The package CustomerText includes the entity Text. Text includes the following non-node elements: TypeCode and ContentText. TypeCode may have a multiplicity of 0 . . . 1 and may be based on datatype BGDT:TextCollectionTextTypeCode. ContentText may have a multiplicity of 0 . . . 1 and may be based on datatype CDT:LANGUAGEINDEPENDENT_Text.

The package CustomerAttachmentFolder includes the entity AttachmentFolder. AttachmentFolder includes the UUID non-node element, which may have a multiplicity of 0 . . . 1 and may be based on datatype BGDT:UUID. AttachmentFolder includes the following node elements: Document, with a cardinality of 1:CN.

The package CustomerAttachmentFolder includes the entity Document. Document includes the following non-node elements: UUID, VersionID, SystemAdministrativeData, LinkInternalIndicator, CheckedOutIndicator, VisibleIndicator, VersioningEnabledIndicator, CategoryCode, CategoryName, TypeCode, TypeName, MIMECode, MIMEName, PathName, Name, AlternativeName, InternalLinkUUID, Description, ExternalLinkWebURI, FileContentURI, and FilesizeMeasure. UUID may have a multiplicity of 0 . . . 1 and may be based on datatype BGDT:UUID. VersionID may have a multiplicity of 0 . . . 1 and may be based on datatype BGDT:VersionID. SystemAdministrativeData may have a multiplicity of 0 . . . 1 and may be based on datatype AGDT:SystemAdministrativeData. LinkInternalIndicator may have a multiplicity of 0 . . . 1 and may be based on datatype CDT:Indicator. CheckedOutIndicator may have a multiplicity of 0 . . . 1 and may be based on datatype CDT:Indicator. VisibleIndicator may have a multiplicity of 0 . . . 1 and may be based on datatype CDT:Indicator. VersioningEnabledIndicator may have a multiplicity of 0 . . . 1 and may be based on datatype CDT:Indicator. CategoryCode may have a multiplicity of 0 . . . 1 and may be based on datatype BGDT:DocumentCategoryCode. CategoryName may have a multiplicity of 0 . . . 1 and may be based on datatype CDT:LANGUAGEINDEPENDENT_LONG_Name. TypeCode may have a multiplicity of 0 . . . 1 and may be based on datatype BGDT:DocumentTypeCode. TypeName may have a multiplicity of 0 . . . 1 and may be based on datatype CDT:LANGUAGEINDEPENDENT_LONG_Name. MIMECode may have a multiplicity of 0 . . . 1 and may be based on datatype BGDT:MIMECode. MIMEName may have a multiplicity of 0 . . . 1 and may be based on datatype CDT:LANGUAGEINDEPENDENT_LONG_Name. PathName may have a multiplicity of 0 . . . 1 and may be based on datatype CDT:LANGUAGEINDEPENDENT_Name. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. Description may have a multiplicity of 0 . . . 1 and may be based on datatype BGDT:Description. ExternalLinkWebURI may have a multiplicity of 0 . . . 1 and may be based on datatype BGDT:WebURI. FileContentURI may have a multiplicity of 0 . . . 1 and may be based on datatype BGDT:URI. FilesizeMeasure may have a multiplicity of 0 . . . 1 and may be based on datatype CDT:Measure.

Document includes the following node elements: Property, with a cardinality of 1:CN. Property includes the following non-node elements: TechnicalID, Name, DataTypeFormatCode, DataTypeFormatName, VisibleIndicator, ChangeAllowedIndicator, MultipleValueIndicator, NamespaceURI, and Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0 . . . 1 and may be based on datatype BGDT:PropertyDataTypeFormatCode. DataTypeFormatName may have a multiplicity of 0 . . . 1 and may be based on datatype CDT:LANGUAGEINDEPENDENT_LONG_Name. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description. Property includes the following node elements: PropertyValue, with a cardinality of 1:CN.

PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

The package ProcessingConditions includes the entity ProcessingConditions. ProcessingConditions is typed by datatype ResponseProcessingConditions. The package Log includes the entity Log, which is typed by datatype Log.

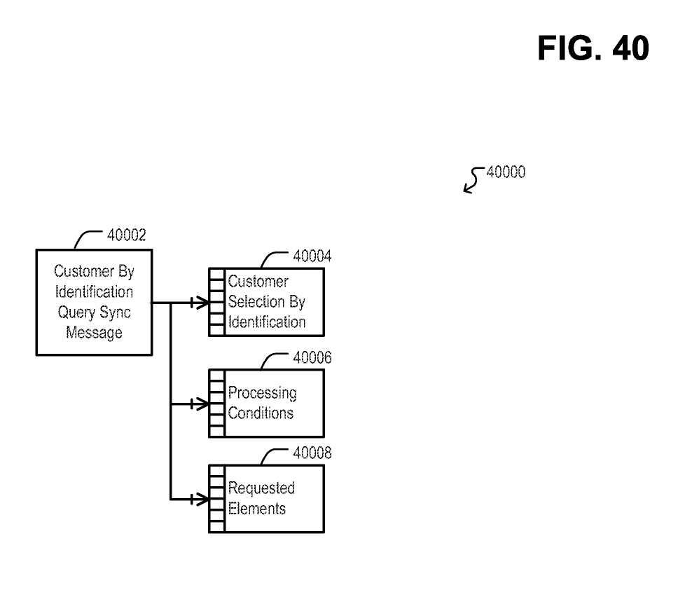

FIG. 40 illustrates one example logical configuration of a Customer By Identification Query Sync Message 40000. Specifically, this figure depicts the arrangement and hierarchy of various components such as one or more levels of packages, entities, and data types, shown here as 40000 through 40008. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer By Identification Query Sync Message 40000 includes, among other things, the Customer Selection By Identification entity 40004. Accordingly, heterogeneous applications may communicate using this consistent message configured as such.

The message type Customer By Identification Query_sync is derived from the business object Customer as a leading object together with its operation signature. The message type Customer By Identification Query_sync is a query about customer data by identification. The structure of the message type Customer By Identification Query_sync is determined by the message data type CustomerByIdentificationQueryMessage_sync. The message data type CustomerByIdentificationQueryMessage_sync includes typing data type for customer find request and includes a CustomerSelectionByIdentification package.

CustomerSelectionByIdentification includes the following non-node elements: SelectionByInternalID, SelectionByUUID, SelectionByCategoryCode, SelectionByBusinessPartnerID, SelectionByPartyidentifierTypeCode, SelectionByBusinessPartnerName, SelectionByBusinessPartnerAdditionalName, SelectionBySortingFormattedName, SelectionByLifeCycleStatusCode, and SelectionBySearchText.

SelectionByInternalID may have a multiplicity of 0 . . . * and may be based on datatype MIDT:CustomerSelectionByInternalID. SelectionByInternalID may include InclusionExclusionCode, IntervalBoundaryTypeCode, LowerBoundaryInternalID, and UpperBoundarylnternalID. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryInternalID may have a multiplicity of 0 . . . 1 and may be based on datatype BGDT:BusinessPartnerInternalID. UpperBoundarylnternalID may have a multiplicity of 0 . . . 1 and may be based on datatype BGDT:BusinessPartnerInternalID.

SelectionByUUID may have a multiplicity of 0 . . . * and may be based on datatype MIDT:CustomerSelectionByUUID. SelectionByUUID may include InclusionExclusionCode, IntervalBoundaryTypeCode, LowerBoundaryUUID, and UpperBoundaryUUID. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryUUID may have a multiplicity of 0 . . . 1 and may be based on datatype BGDT:UUID. UpperBoundaryUUID may have a multiplicity of 0 . . . 1 and may be based on datatype BGDT:UUID.

SelectionByCategoryCode may have a multiplicity of 0 . . . * and may be based on datatype MIDT:CustomerSelectionByCategoryCode. SelectionByCategoryCode may include InclusionExclusionCode, IntervalBoundaryTypeCode, LowerBoundaryCategoryCode, and UpperBoundaryCategoryCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryCategoryCode may have a multiplicity of 0 . . . 1 and may be based on datatype BGDT:BusinessPartnerCategoryCode. UpperBoundaryCategoryCode may have a multiplicity of 0 . . . 1 and may be based on datatype BGDT:BusinessPartnerCategoryCode.

SelectionByBusinessPartnerID may have a multiplicity of 0 . . . * and may be based on datatype MIDT:CustomerSelectionByBusinessPartnerID. SelectionByBusinessPartnerID may include InclusionExclusionCode, IntervalBoundaryTypeCode, LowerBoundaryBusinessPartnerID, and UpperBoundaryBusinessPartnerID. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryBusinessPartnerID may have a multiplicity of 0 . . . 1 and may be based on datatype BGDT:BusinessPartnerID. UpperBoundaryBusinessPartnerID may have a multiplicity of 0 . . . 1 and may be based on datatype BGDT:BusinessPartnerID.

SelectionByPartyidentifierTypeCode may have a multiplicity of 0 . . . * and may be based on datatype MIDT:CustomerSelectionByPartyidentifierTypeCode. SelectionByPartyidentifierTypeCode may include InclusionExclusionCode, IntervalBoundaryTypeCode, LowerBoundaryPartyidentifierTypeCode, and UpperBoundaryPartyidentifierTypeCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryPartyidentifierTypeCode may have a multiplicity of 0 . . . 1 and may be based on datatype BGDT:PartyidentifierTypeCode. UpperBoundaryPartyidentifierTypeCode may have a multiplicity of 0 . . . 1 and may be based on datatype BGDT:PartyidentifierTypeCode.

SelectionByBusinessPartnerName may have a multiplicity of 0 . . . * and may be based on datatype MIDT:CustomerSelectionByBusinessPartnerName. SelectionByBusinessPartnerName may include InclusionExclusionCode, IntervalBoundaryTypeCode, LowerBoundaryBusinessPartnerName, and UpperBoundaryBusinessPartnerName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryBusinessPartnerName may have a multiplicity of 0 . . . 1 and may be based on datatype CDT:LANGUAGEINDEPENDENT_MEDIUM_Name. UpperBoundaryBusinessPartnerName may have a multiplicity of 0 . . . 1 and may be based on datatype CDT:LANGUAGEINDEPENDENT_MEDIUM_Name.

SelectionByBusinessPartnerAdditionalName may have a multiplicity of 0 . . . * and may be based on datatype MIDT:CustomerSelectionByBusinessPartnerAdditionalName. SelectionByBusinessPartnerAdditionalName may include InclusionExclusionCode, IntervalBoundaryTypeCode, LowerBoundaryBusinessPartnerAdditionalName, and UpperBoundaryBusinessPartnerAdditionalName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryBusinessPartnerAdditionalName may have a multiplicity of 0 . . . 1 and may be based on datatype CDT:LANGUAGEINDEPENDENT_MEDIUM_Name. UpperBoundaryBusinessPartnerAdditionalName may have a multiplicity of 0 . . . 1 and may be based on datatype CDT:LANGUAGEINDEPENDENT_MEDIUM_Name.

SelectionBySortingFormattedName may have a multiplicity of 0 . . . * and may be based on datatype MIDT:CustomerSelectionBySortingFormattedName. SelectionBySortingFormattedName may include InclusionExclusionCode, IntervalBoundaryTypeCode, LowerBoundarySortingFormattedName, and UpperBoundarySortingFormattedName. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundarySortingFormattedName may have a multiplicity of 0 . . . 1 and may be based on datatype CDT:LANGUAGEINDEPENDENT_LONG_Name. UpperBoundarySortingFormattedName may have a multiplicity of 0 . . . 1 and may be based on datatype CDT:LANGUAGEINDEPENDENT_LONG_Name.

SelectionByLifeCycleStatusCode may have a multiplicity of 0 . . . * and may be based on datatype MIDT:CustomerSelectionByLifeCycleStatusCode. SelectionByLifeCycleStatusCode may include InclusionExclusionCode, IntervalBoundaryTypeCode, LowerBoundaryLifeCycleStatusCode, and UpperBoundaryLifeCycleStatusCode. InclusionExclusionCode may have a multiplicity of 0 . . . 1 and may be based on datatype BGDT:InclusionExclusionCode. IntervalBoundaryTypeCode may have a multiplicity of 0 . . . 1 and may be based on datatype BGDT:IntervalBoundaryTypeCode. LowerBoundaryLifeCycleStatusCode may have a multiplicity of 0 . . . 1 and may be based on datatype BGDT:NOTDELETED_PartyLifeCycleStatusCode. UpperBoundaryLifeCycleStatusCode may have a multiplicity of 0 . . . 1 and may be based on datatype BGDT:NOTDELETED_PartyLifeCycleStatusCode. SelectionBySearchText may have a multiplicity of 0 . . . 1 and may be based on datatype BGDT:SearchText.

RequestedElements includes the customerTransmissionRequestCode attribute, which may have a multiplicity of 0 . . . 1 and may be based on datatype BGDT:TransmissionRequestCode. RequestedElements includes the following non-node elements: Customer, AddressInformationTransmissionRequestCode, RelationshipTransmissionRequestCode, ContactPersonTransmissionRequestCode, CommunicationArrangementTransmissionRequestCode, DirectResponsibilityTransmissionRequestCode, SalesArrangementTransmissionRequestCode, BankDetailsTransmissionRequestCode, PaymentCardDetailsTransmissionRequestCode, PaymentDataTransmissionRequestCode, PersonTransmissionRequestCode, TaxNumberTransmissionRequestCode, GeneralProductTaxExemptionTransmissionRequestCode, OperatingHoursInfoTransmissionRequestCode, OrganisationTransmissionRequestCode, TextTransmissionRequestCode, and AttachmentFolderTransmissionRequestCode.

Customer may have a multiplicity of 0 . . . 1 and may be based on datatype MIDT: CustomerRequestedElementsCustomer. AddressInformationTransmissionRequestCode may have a multiplicity of 0 . . . 1 and may be based on datatype BGDT:TransmissionRequestCode. RelationshipTransmissionRequestCode may have a multiplicity of 0 . . . 1 and may be based on datatype BGDT:TransmissionRequestCode. ContactPersonTransmissionRequestCode may have a multiplicity of 0 . . . 1 and may be based on datatype BGDT:TransmissionRequestCode. CommunicationArrangementTransmissionRequestCode may have a multiplicity of 0 . . . 1 and may be based on datatype BGDT:TransmissionRequestCode. DirectResponsibilityTransmissionRequestCode may have a multiplicity of 0 . . . 1 and may be based on datatype BGDT:TransmissionRequestCode. SalesArrangementTransmissionRequestCode may have a multiplicity of 0 . . . 1 and may be based on datatype BGDT:TransmissionRequestCode. BankDetailsTransmissionRequestCode may have a multiplicity of 0 . . . 1 and may be based on datatype BGDT:TransmissionRequestCode. PaymentCardDetailsTransmissionRequestCode may have a multiplicity of 0 . . . 1 and may be based on datatype BGDT:TransmissionRequestCode. PaymentDataTransmissionRequestCode may have a multiplicity of 0 . . . 1 and may be based on datatype BGDT:TransmissionRequestCode. PersonTransmissionRequestCode may have a multiplicity of 0 . . . 1 and may be based on datatype BGDT:TransmissionRequestCode. TaxNumberTransmissionRequestCode may have a multiplicity of 0 . . . 1 and may be based on datatype BGDT:TransmissionRequestCode. GeneralProductTaxExemptionTransmissionRequestCode may have a multiplicity of 0 . . . 1 and may be based on datatype BGDT:TransmissionRequestCode. OperatingHoursInfoTransmissionRequestCode may have a multiplicity of 0 . . . 1 and may be based on datatype BGDT:TransmissionRequestCode. OrganisationTransmissionRequestCode may have a multiplicity of 0 . . . 1 and may be based on datatype BGDT:TransmissionRequestCode. TextTransmissionRequestCode may have a multiplicity of 0 . . . 1 and may be based on datatype BGDT:TransmissionRequestCode. AttachmentFolderTransmissionRequestCode may have a multiplicity of 0 . . . 1 and may be based on datatype BGDT:TransmissionRequestCode.

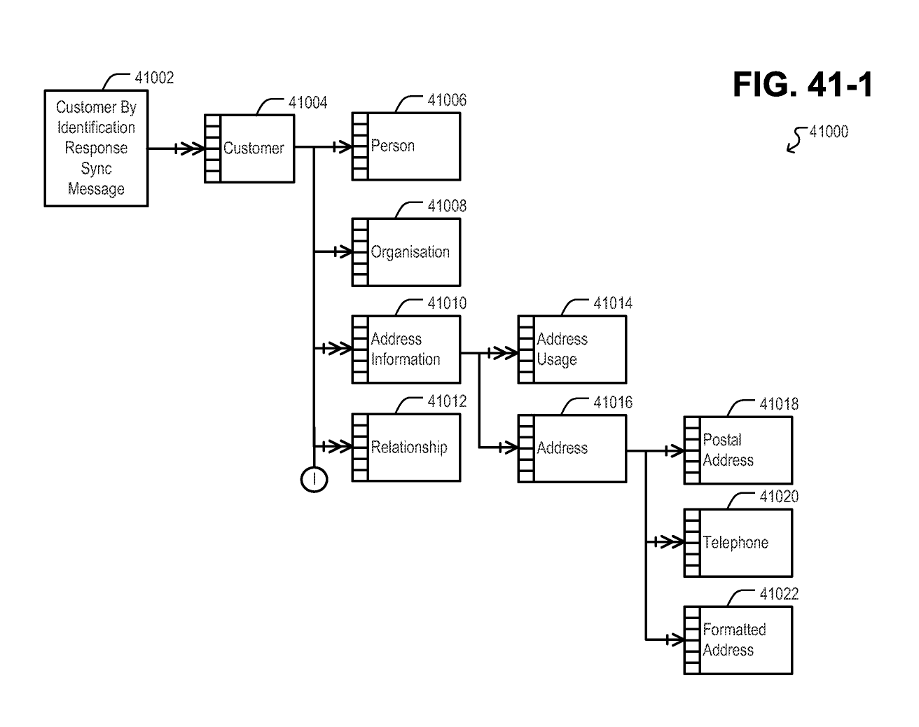

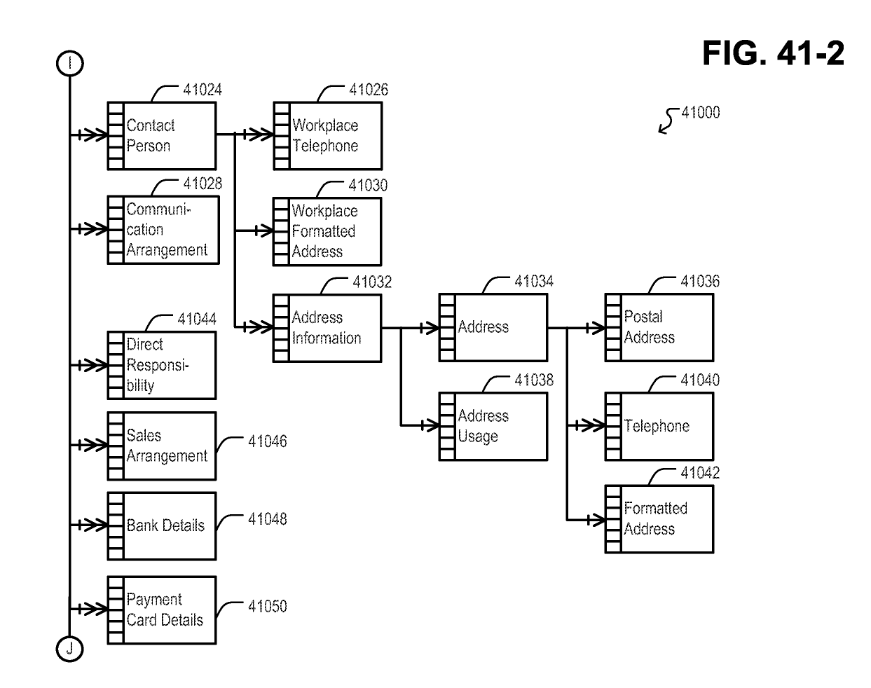

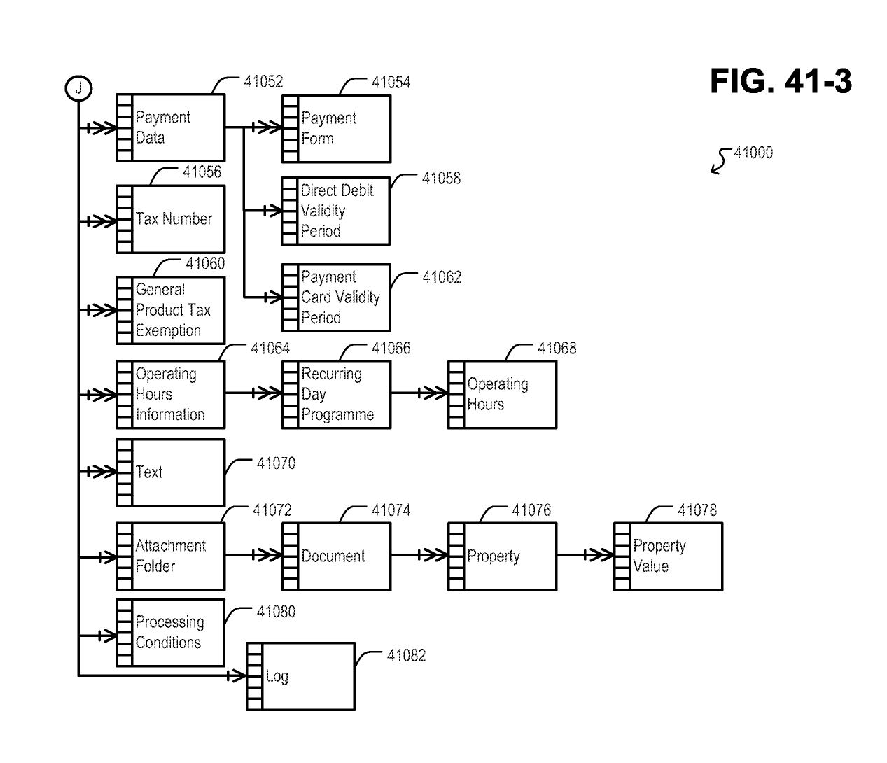

FIGS. 41-1 through 41-3 collectively illustrate one example logical configuration of a Customer By Identification Response Sync Message 41000. Specifically, these figures depict the arrangement and hierarchy of various components such as one or more levels of packages, entities, and data types, shown here as 41000 through 41082. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Customer By Identification Response Sync Message 41000 includes, among other things, the Person entity 41006. Accordingly, heterogeneous applications may communicate using this consistent message configured as such.

The message type Customer By Identification Response_sync is derived from the business object Customer as a leading object together with its operation signature. The message type Customer By Identification Response_sync is a response concerning an inquiry about customer data that includes requested customer data as well as processing conditions. Corresponding system messages can be provided as log items. The structure of the message type Customer By Identification Response_sync is determined by the message data type CustomerResponseMessage_sync. The message data type CustomerResponseMessage_sync includes the Customer package, the ProcessingConditions package, and the Log package.

The package Customer includes the sub-packages Person, Organisation, AddressInformation, Relationship, ContactPerson, CommunicationArrangement, DirectResponsibility, SalesArrangement, BankDetails, PaymentCardDetails, PaymentData, TaxNumber, GeneralProductTaxExemption, OperatingHoursInformation, Text, and AttachmentFolder, and the entity Customer. Customer includes the following non-node elements: ChangeStateID, UUID, InternalID, SystemAdministrativeData, CategoryCode, ProspectIndicator, CustomerIndicator, LifeCycleStatusCode, VerbalCommunicationLanguageCode, ContactAllowedCode, LegalCompetenceIndicator, DunAndBradstreetNumberID, GlobalLocationNumberID, ABCClassificationCode, NielsenRegionCode, IndustrialSectorCode, InvoicingBlockingReasonCode, CustomerTransactionDocumentFulfilmentBlockingReasonCode, CustomerBlockingReasonCode, and EnterpriseIdentificationNumber. ChangeStateID may have a multiplicity of 0 . . . 1 and may be based on datatype BGDT:ChangeStateID. UUID may have a multiplicity of 0 . . . 1 and may be based on datatype BGDT:UUID. InternalID may have a multiplicity of 0 . . . 1 and may be based on datatype BGDT:BusinessPartnerInternalID. SystemAdministrativeData may have a multiplicity of 0 . . . 1 and may be based on datatype AGDT:SystemAdministrativeData. CategoryCode may have a multiplicity of 0 . . . 1 and may be based on datatype BGDT:BusinessPartnerCategoryCode. ProspectIndicator may have a multiplicity of 0 . . . 1 and may be based on datatype CDT:Indicator. CustomerIndicator may have a multiplicity of 0 . . . 1 and may be based on datatype CDT:Indicator. LifeCycleStatusCode may have a multiplicity of 0 . . . 1 and may be based on datatype BGDT:PartyLifeCycleStatusCode. VerbalCommunicationLanguageCode may have a multiplicity of 0 . . . 1 and may be based on datatype BGDT:LanguageCode. ContactAllowedCode may have a multiplicity of 0 . . . 1 and may be based on datatype BGDT:ContactAllowedCode. LegalCompetenceIndicator may have a multiplicity of 0 . . . 1 and may be based on datatype CDT:Indicator. DunAndBradstreetNumberID may have a multiplicity of 0 . . . 1 and may be based on datatype BGDT:BusinessPartnerID. GlobalLocationNumberID may have a multiplicity of 0 . . . 1 and may be based on datatype BGDT:BusinessPartnerID. ABCClassificationCode may have a multiplicity of 0 . . . 1 and may be based on datatype BGDT:CustomerABCClassificationCode. NielsenRegionCode may have a multiplicity of 0 . . . 1 and may be based on datatype BGDT:NielsenRegionCode. IndustrialSectorCode may have a multiplicity of 0 . . . 1 and may be based on datatype BGDT:IndustrialSectorCode. InvoicingBlockingReasonCode may have a multiplicity of 0 . . . 1 and may be based on datatype BGDT:InvoicingBlockingReasonCode. CustomerTransactionDocumentFulfilmentBlockingReasonCode may have a multiplicity of 0 . . . 1 and may be based on datatype BGDT:CustomerTransactionDocumentFulfilmentBlockingReasonCode. CustomerBlockingReasonCode may have a multiplicity of 0 . . . 1 and may be based on datatype BGDT:CustomerBlockingReasonCode. EnterpriseIdentificationNumber may have a multiplicity of 0 . . . 1 and may be based on datatype BGDT:BusinessPartnerID.

Customer includes the following node elements: Person, in a 1:C cardinality relationship; Organisation, in a 1:C cardinality relationship; AddressInformation, in a 1:CN cardinality relationship; Relationship, in a 1:CN cardinality relationship; ContactPerson, in a 1:CN cardinality relationship; CommunicationArrangement, in a 1:CN cardinality relationship; DirectResponsibility, in a 1:CN cardinality relationship; SalesArrangement, in a 1:CN cardinality relationship; BankDetails, in a 1:CN cardinality relationship; PaymentCardDetails, in a 1:CN cardinality relationship; PaymentData, in a 1:CN cardinality relationship; TaxNumber, in a 1:CN cardinality relationship; GeneralProductTaxExemption, in a 1:CN cardinality relationship; OperatingHoursInformation, in a 1:CN cardinality relationship; Text, in a 1:CN cardinality relationship; and AttachmentFolder, in a 1:C cardinality relationship.

The package CustomerPerson includes the entity Person. Person includes the following non-node elements: FormOfAddressCode, AcademicTitleCode, GivenName, MiddleName, FamilyName, BirthName, NickName, NameFormatCountryCode, GenderCode, BirthDate, NonVerbalCommunicationLanguageCode, and OccupationCode. FormOfAddressCode may have a multiplicity of 0 . . . 1 and may be based on datatype BGDT:FormOfAddressCode. AcademicTitleCode may have a multiplicity of 0 . . . 1 and may be based on datatype BGDT:AcademicTitleCode. GivenName may have a multiplicity of 0 . . . 1 and may be based on datatype CDT:LANGUAGEINDEPENDENT_MEDIUM_Name. MiddleName may have a multiplicity of 0 . . . 1 and may be based on datatype CDT:LANGUAGEINDEPENDENT_MEDIUM_Name. FamilyName may have a multiplicity of 0 . . . 1 and may be based on datatype CDT:LANGUAGEINDEPENDENT_MEDIUM_Name. BirthName may have a multiplicity of 0 . . . 1 and may be based on datatype CDT:LANGUAGEINDEPENDENT_MEDIUM_Name. NickName may have a multiplicity of 0 . . . 1 and may be based on datatype CDT:LANGUAGEINDEPENDENT_MEDIUM_Name. NameFormatCountryCode may have a multiplicity of 0 . . . 1 and may be based on datatype BGDT:CountryCode. GenderCode may have a multiplicity of 0 . . . 1 and may be based on datatype BGDT:GenderCode. BirthDate may have a multiplicity of 0 . . . 1 and may be based on datatype CDT:Date, with a qualifier of Birth. NonVerbalCommunicationLanguageCode may have a multiplicity of 0 . . . 1 and may be based on datatype BGDT:LanguageCode, with a qualifier of Communication. OccupationCode may have a multiplicity of 0 . . . 1 and may be based on datatype BGDT:OccupationCode.

The package CustomerOrganisation includes the entity Organisation. Organisation includes the following non-node elements: CompanyLegalFormCode, FirstLineName, and SecondLineName. CompanyLegalFormCode may have a multiplicity of 0 . . . 1 and may be based on datatype BGDT:CompanyLegalFormCode. FirstLineName may have a multiplicity of 0 . . . 1 and may be based on datatype CDT:LANGUAGEINDEPENDENT_MEDIUM_Name. SecondLineName may have a multiplicity of 0 . . . 1 and may be based on datatype CDT:LANGUAGEINDEPENDENT_MEDIUM_Name.

The package CustomerAddressInformation includes the entity AddressInformation. AddressInformation includes the following non-node elements: UUID and CurrentAddressSnapshotUUID. UUID may have a multiplicity of 0 . . . 1 and may be based on datatype BGDT:UUID. CurrentAddressSnapshotUUID may have a multiplicity of 0 . . . 1 and may be based on datatype BGDT:UUID. AddressInformation includes the following node elements: AddressUsage, in a 1:CN cardinality relationship; and Address, in a 1:C cardinality relationship. AddressUsage includes the following non-node elements: AddressUsageCode and DefaultIndicator. AddressUsageCode may have a multiplicity of 1 and may be based on datatype BGDT:AddressUsageCode. DefaultIndicator may have a multiplicity of 0 . . . 1 and may be based on datatype CDT:Indicator.

Address includes the following non-node elements: CorrespondenceLanguageCode, PreferredCommunicationMediumTypeCode, EmailURI, FacsimileFormattedNumberDescription, and WebURI. CorrespondenceLanguageCode may have a multiplicity of 0 . . . 1 and may be based on datatype BGDT:LanguageCode. PreferredCommunicationMediumTypeCode may have a multiplicity of 0 . . . 1 and may be based on datatype BGDT:CommunicationMediumTypeCode. EmailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. WebURI may have a multiplicity of 0 . . . 1 and may be based on datatype BGDT:WebURI. Address includes the following node elements: PostalAddress, in a 1:C cardinality relationship; Telephone, in a 1:CN cardinality relationship; and FormattedAddress, in a 1:C cardinality relationship.

PostalAddress includes the following non-node elements: CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, CareOfName, POBoxDeviatingCountryCode, POBoxDeviatingRegionCode, POBoxDeviatingCityName, POBoxID, POBoxIndicator, TaxJurisdictionCode, and TimeZoneCode. CountryCode may have a multiplicity of 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

Telephone includes the following non-node elements: FormattedNumberDescription and MobilePhoneNumberIndicator. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

FormattedAddress includes the following non-node elements: FormattedAddressDescription, FormattedPostalAddressDescription, FormattedAddress, and FormattedPostalAddress. FormattedAddressDescription may have a multiplicity of 0 . . . 1 and may be based on datatype BGDT:LANGUAGEINDEPENDENT_MEDIUM_Description. FormattedPostalAddressDescription may have a multiplicity of 0 . . . 1 and may be based on datatype BGDT:LANGUAGEINDEPENDENT_MEDIUM_Description. FormattedAddress may have a multiplicity of 0 . . . 1 and may be based on datatype AGDT:FormattedAddress. FormattedPostalAddress may have a multiplicity of 0 . . . 1 and may be based on datatype AGDT:FormattedPostalAddress.

The package CustomerRelationship includes the entity Relationship. Relationship includes the following non-node elements: RelationshipBusinessPartnerUUID, RelationshipBusinessPartnerInternalID, and RoleCode. RelationshipBusinessPartnerUUID may have a multiplicity of 0 . . . 1 and may be based on datatype BGDT:UUID. RelationshipBusinessPartnerInternalID may have a multiplicity of 0 . . . 1 and may be based on datatype BGDT:BusinessPartnerInternalID. RoleCode may have a multiplicity of 1 and may be based on datatype BGDT:BusinessPartnerRelationshipRoleCode.

The package CustomerContactPerson includes the sub-package AddressInformation and the entity ContactPerson. ContactPerson includes the following non-node elements: BusinessPartnerContactUUID, BusinessPartnerContactInternalID, DefaultContactPersonIndicator, FormOfAddressCode, AcademicTitleCode, GivenName, MiddleName, FamilyName, BirthName, NickName, GenderCode, BirthDate, NonVerbalCommunicationLanguageCode, OccupationCode, BusinessPartnerFunctionTypeCode, BusinessPartnerFunctionalAreaCode, VIPReasonCode, CurrentWorkplaceAddressSnapshotUUID, WorkplaceBusinessAddressUUID, WorkplacePreferredCommunicationMediumTypeCode, WorkplaceEmailURI, WorkplaceFacsimileFormattedNumberDescription, WorkplaceWebURI, WorkplaceFunctionalTitleName, WorkplaceDepartmentName, WorkplaceBuildingID, WorkplaceFloorID, WorkplaceRoomID, LifeCycleStatusCode, and MaritalStatusCode. BusinessPartnerContactUUID may have a multiplicity of 0 . . . 1 and may be based on datatype BGDT:UUID. BusinessPartnerContactlnternalID may have a multiplicity of 0 . . . 1 and may be based on datatype BGDT:BusinessPartnerInternalID. DefaultContactPersonIndicator may have a multiplicity of 0 . . . 1 and may be based on datatype CDT:Indicator. FormOfAddressCode may have a multiplicity of 0 . . . 1 and may be based on datatype BGDT:FormOfAddressCode. AcademicTitleCode may have a multiplicity of 0 . . . 1 and may be based on datatype BGDT:AcademicTitleCode. GivenName may have a multiplicity of 0 . . . 1 and may be based on datatype CDT:LANGUAGEINDEPENDENT_MEDIUM_Name. MiddleName may have a multiplicity of 0 . . . 1 and may be based on datatype CDT:LANGUAGEINDEPENDENT_MEDIUM_Name. FamilyName may have a multiplicity of 0 . . . 1 and may be based on datatype CDT:LANGUAGEINDEPENDENT_MEDIUM_Name. BirthName may have a multiplicity of 0 . . . 1 and may be based on datatype CDT:LANGUAGEINDEPENDENT_MEDIUM_Name. NickName may have a multiplicity of 0 . . . 1 and may be based on datatype CDT:LANGUAGEINDEPENDENT_MEDIUM_Name. GenderCode may have a multiplicity of 0 . . . 1 and may be based on datatype BGDT:GenderCode. BirthDate may have a multiplicity of 0 . . . 1 and may be based on datatype CDT:Date. NonVerbalCommunicationLanguageCode may have a multiplicity of 0 . . . 1 and may be based on datatype BGDT:LanguageCode. OccupationCode may have a multiplicity of 0 . . . 1 and may be based on datatype BGDT:OccupationCode. BusinessPartnerFunctionTypeCode may have a multiplicity of 0 . . . 1 and may be based on datatype BGDT:BusinessPartnerFunctionTypeCode. BusinessPartnerFunctionalAreaCode may have a multiplicity of 0 . . . 1 and may be based on datatype BGDT:BusinessPartnerFunctionalAreaCode. VIPReasonCode may have a multiplicity of 0 . . . 1 and may be based on datatype BGDT:VIPReasonCode. CurrentWorkplaceAddressSnapshotUUID may have a multiplicity of 0 . . . 1 and may be based on datatype BGDT:UUID. WorkplaceBusinessAddressUUID may have a multiplicity of 0 . . . 1 and may be based on datatype BGDT:UUID. WorkplacePreferredCommunicationMediumTypeCode may have a multiplicity of 0 . . . 1 and may be based on datatype BGDT:CommunicationMediumTypeCode. WorkplaceEmailURI may have a multiplicity of 0 . . . 1 and may be based on datatype BGDT:EmailURI. WorkplaceFacsimileFormattedNumberDescription may have a multiplicity of 0 . . . 1 and may be based on datatype BGDT:LANGUAGEINDEPENDENT_SHORT_Description. WorkplaceWebURI may have a multiplicity of 0 . . . 1 and may be based on datatype BGDT:WebURI. WorkplaceFunctionalTitleName may have a multiplicity of 0 . . . 1 and may be based on datatype CDT:LANGUAGEINDEPENDENT_MEDIUM_Name. WorkplaceDepartmentName may have a multiplicity of 0 . . . 1 and may be based on datatype CDT:LANGUAGEINDEPENDENT_MEDIUM_Name. WorkplaceBuildingID may have a multiplicity of 0 . . . 1 and may be based on datatype BGDT:BuildingID. WorkplaceFloorID may have a multiplicity of 0 . . . 1 and may be based on datatype BGDT:FloorID. WorkplaceRoomID may have a multiplicity of 0 . . . 1 and may be based on datatype BGDT:RoomID LifeCycleStatusCode may have a multiplicity of 0 . . . 1 and may be based on datatype BGDT:PartyLifeCycleStatusCode. MaritalStatusCode may have a multiplicity of 0 . . . 1 and may be based on datatype BGDT:MaritalStatusCode. ContactPerson includes the following node elements: WorkplaceTelephone, in a 1:CN cardinality relationship; WorkplaceFormattedAddress, in a 1:C cardinality relationship; and AddressInformation, in a 1:CN cardinality relationship.

WorkplaceTelephone includes the following non-node elements: FormattedNumberDescription and MobilePhoneNumberIndicator. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

WorkplaceFormattedAddress includes the following non-node elements: FormattedAddressDescription, FormattedPostalAddressDescription, FormattedAddress, and FormattedPostalAddress. FormattedAddressDescription may have a multiplicity of 0 . . . 1 and may be based on datatype BGDT:LANGUAGEINDEPENDENT_MEDIUM_Description. FormattedPostalAddressDescription may have a multiplicity of 0 . . . 1 and may be based on datatype BGDT:LANGUAGEINDEPENDENT_MEDIUM_Description. FormattedAddress may have a multiplicity of 0 . . . 1 and may be based on datatype AGDT:FormattedAddress. FormattedPostalAddress may have a multiplicity of 0 . . . 1 and may be based on datatype AGDT:FormattedPostalAddress.

The package CustomerContactPersonAddressInformation includes the entity AddressInformation. AddressInformation includes the following non-node elements: UUID and CurrentAddressSnapshotUUID. UUID may have a multiplicity of 0 . . . 1 and may be based on datatype BGDT:UUID. CurrentAddressSnapshotUUID may have a multiplicity of 0 . . . 1 and may be based on datatype BGDT:UUID. AddressInformation includes the following node elements: Address, in a 1:C cardinality relationship; and AddressUsage, in a 1:C cardinality relationship.

Address includes the following non-node elements: EmailURI and FacsimileFormattedNumberDescription. EmailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. Address includes the following node elements: PostalAddress, in a 1:C cardinality relationship; Telephone, in a 1:CN cardinality relationship; and FormattedAddress, in a 1:C cardinality relationship.

PostalAddress includes the following non-node elements: CountryCode, RegionCode, CountyName, CityName, AdditionalCityName, DistrictName, StreetPostalCode, POBoxPostalCode, CompanyPostalCode, StreetPrefixName, AdditionalStreetPrefixName, StreetName, StreetSuffixName, AdditionalStreetSuffixName, HouseID, CareOfName, POBoxDeviatingCountryCode, POBoxDeviatingRegionCode, POBoxDeviatingCityName, POBoxID, POBoxIndicator, TaxJurisdictionCode, and TimeZoneCode. CountryCode may have a multiplicity of 1 and may be based on datatype BGDT:CountryCode. RegionCode may have a multiplicity of 0 . . . 1 and may be based on datatype BGDT:RegionCode. CountyName may have a multiplicity of 0 . . . 1 and may be based on datatype CDT:LANGUAGEINDEPENDENT_MEDIUM_Name. CityName may have a multiplicity of 0 . . . 1 and may be based on datatype CDT:LANGUAGEINDEPENDENT_MEDIUM_Name. AdditionalCityName may have a multiplicity of 0 . . . 1 and may be based on datatype CDT:LANGUAGEINDEPENDENT_MEDIUM_Name. DistrictName may have a multiplicity of 0 . . . 1 and may be based on datatype CDT:LANGUAGEINDEPENDENT_MEDIUM_Name. StreetPostalCode may have a multiplicity of 0 . . . 1 and may be based on datatype BGDT:PostalCode. POBoxPostalCode may have a multiplicity of 0 . . . 1 and may be based on datatype BGDT:PostalCode. CompanyPostalCode may have a multiplicity of 0 . . . 1 and may be based on datatype BGDT:PostalCode. StreetPrefixName may have a multiplicity of 0 . . . 1 and may be based on datatype CDT:LANGUAGEINDEPENDENT_MEDIUM_Name. AdditionalStreetPrefixName may have a multiplicity of 0 . . . 1 and may be based on datatype CDT:LANGUAGEINDEPENDENT_MEDIUM_Name. StreetName may have a multiplicity of 0 . . . 1 and may be based on datatype BGDT:StreetName. StreetSuffixName may have a multiplicity of 0 . . . 1 and may be based on datatype CDT:LANGUAGEINDEPENDENT_MEDIUM_Name. AdditionalStreetSuffixName may have a multiplicity of 0 . . . 1 and may be based on datatype CDT:LANGUAGEINDEPENDENT_MEDIUM_Name. HouseID may have a multiplicity of 0 . . . 1 and may be based on datatype BGDT:HouseID. CareOfName may have a multiplicity of 0 . . . 1 and may be based on datatype CDT:LANGUAGEINDEPENDENT_MEDIUM_Name. POBoxDeviatingCountryCode may have a multiplicity of 0 . . . 1 and may be based on datatype BGDT:CountryCode. POBoxDeviatingRegionCode may have a multiplicity of 0 . . . 1 and may be based on datatype BGDT:RegionCode. POBoxDeviatingCityName may have a multiplicity of 0 . . . 1 and may be based on datatype CDT:LANGUAGEINDEPENDENT_MEDIUM_Name. POBoxID may have a multiplicity of 0 . . . 1 and may be based on datatype BGDT:POBoxID. POBoxIndicator may have a multiplicity of 0 . . . 1 and may be based on datatype CDT:Indicator. TaxJurisdictionCode may have a multiplicity of 0 . . . 1 and may be based on datatype BGDT:TaxJurisdictionCode. TimeZoneCode may have a multiplicity of 0 . . . 1 and may be based on datatype BGDT:TimeZoneCode.

Telephone includes the following non-node elements: FormattedNumberDescription and MobilePhoneNumberIndicator. FormattedNumberDescription may have a multiplicity of 1 and may be based on datatype BGDT:LANGUAGEINDEPENDENT_SHORT_Description. MobilePhoneNumberIndicator may have a multiplicity of 0 . . . 1 and may be based on datatype CDT:Indicator.

The package CustomerContactPersonAddressInformation includes the entity FormattedAddress. FormattedAddress includes the following non-node elements: FormattedAddressDescription, FormattedPostalAddressDescription, FormattedAddress, and FormattedPostalAddress. FormattedAddressDescription may have a multiplicity of 0 . . . 1 and may be based on datatype BGDT:LANGUAGEINDEPENDENT_MEDIUM_Description. FormattedPostalAddressDescription may have a multiplicity of 0 . . . 1 and may be based on datatype BGDT:LANGUAGEINDEPENDENT_MEDIUM_Description. FormattedAddress may have a multiplicity of 0 . . . 1 and may be based on datatype AGDT:FormattedAddress. FormattedPostalAddress may have a multiplicity of 0 . . . 1 and may be based on datatype AGDT:FormattedPostalAddress.

AddressUsage includes the following non-node elements: AddressUsageCode and DefaultIndicator. AddressUsageCode may have a multiplicity of 1 and may be based on datatype BGDT:AddressUsageCode. DefaultIndicator may have a multiplicity of 0 . . . 1 and may be based on datatype CDT:Indicator.

The package CustomerCommunicationArrangement includes the entity CommunicationArrangement. CommunicationArrangement includes the following non-node elements: UUID, CompoundServiceInterfaceCode, EnabledIndicator, CommunicationMediumTypeCode, OutputRequestFormTemplateCode, EMailURI, FacsimileFormattedNumberDescription, and OutputCopyNumberValue. UUID may have a multiplicity of 0 . . . 1 and may be based on datatype BGDT:UUID. CompoundServiceInterfaceCode may have a multiplicity of 0 . . . 1 and may be based on datatype BGDT:CompoundServiceInterfaceCode. EnabledIndicator may have a multiplicity of 0 . . . 1 and may be based on datatype CDT:Indicator. CommunicationMediumTypeCode may have a multiplicity of 0 . . . 1 and may be based on datatype BGDT:CommunicationMediumTypeCode. OutputRequestFormTemplateCode may have a multiplicity of 0 . . . 1 and may be based on datatype BGDT:OutputRequestFormTemplateCode. EMailURI may have a multiplicity of 0 . . . 1 and may be based on datatype BGDT:EmailURI. FacsimileFormattedNumberDescription may have a multiplicity of 0 . . . 1 and may be based on datatype BGDT:LANGUAGEINDEPENDENT_SHORT_Description. OutputCopyNumberValue may have a multiplicity of 0 . . . 1 and may be based on datatype BGDT:NumberValue.

The package CustomerDirectResponsibility includes the entity DirectResponsibility. DirectResponsibility includes the following non-node elements: PartyRoleCode and EmployeeID. PartyRoleCode may have a multiplicity of 0 . . . 1 and may be based on datatype BGDT:PartyRoleCode. EmployeeID may have a multiplicity of 0 . . . 1 and may be based on datatype BGDT:EmployeeID.

The package CustomerSalesArrangement includes the entity SalesArrangement. SalesArrangement includes the following non-node elements: SalesOrganisationID, DistributionChannelCode, Incoterms, DeliveryPriorityCode, CompleteDeliveryRequestedIndicator, CurrencyCode, CustomerGroupCode, and CashDiscountTermsCode. SalesOrganisationID may have a multiplicity of 0 . . . 1 and may be based on datatype BGDT:OrganisationalCentreID. DistributionChannelCode may have a multiplicity of 0 . . . 1 and may be based on datatype BGDT:DistributionChannelCode. Incoterms may have a multiplicity of 0 . . . 1 and may be based on datatype AGDT:Incoterms. DeliveryPriorityCode may have a multiplicity of 0 . . . 1 and may be based on datatype BGDT:PriorityCode. CompleteDeliveryRequestedIndicator may have a multiplicity of 0 . . . 1 and may be based on datatype CDT:Indicator. CurrencyCode may have a multiplicity of 0 . . . 1 and may be based on datatype BGDT:CurrencyCode. CustomerGroupCode may have a multiplicity of 0 . . . 1 and may be based on datatype BGDT:CustomerGroupCode. CashDiscountTermsCode may have a multiplicity of 0 . . . 1 and may be based on datatype BGDT:CashDiscountTermsCode.

The package CustomerBankDetails includes the entity BankDetails. BankDetails includes the following non-node elements: ID, BankUUID, BankInternalID, BankRoutingID, BankRoutingIDTypeCode, BankStandardID, BankAccountID, BankAccountIDCheckDigitValue, BankAccountTypeCode, BankAccountHolderName, BankAccountStandardID, and ValidityPeriod. ID may have a multiplicity of 0 . . . 1 and may be based on datatype BGDT:BusinessPartnerBankDetailsID. BankUUID may have a multiplicity of 0 . . . 1 and may be based on datatype BGDT:UUID. BanklnternalID may have a multiplicity of 0 . . . 1 and may be based on datatype BGDT:BankInternalID. BankRoutingID may have a multiplicity of 0 . . . 1 and may be based on datatype BGDT:BankRoutingID. BankRoutingIDTypeCode may have a multiplicity of 0 . . . 1 and may be based on datatype BGDT:BankRoutingIDTypeCode. BankStandardID may have a multiplicity of 0 . . . 1 and may be based on datatype BGDT:BankStandardID. BankAccountID may have a multiplicity of 0 . . . 1 and may be based on datatype BGDT:BankAccountID. BankAccountIDCheckDigitValue may have a multiplicity of 0 . . . 1 and may be based on datatype BGDT:BankAccountIDCheckDigitValue. BankAccountTypeCode may have a multiplicity of 0 . . . 1 and may be based on datatype BGDT:BankAccountTypeCode. BankAccountHolderName may have a multiplicity of 0 . . . 1 and may be based on datatype BGDT:BankAccountHolderName_V1. BankAccountStandardID may have a multiplicity of 0 . . . 1 and may be based on datatype BGDT:BankAccountStandardID. ValidityPeriod may have a multiplicity of 0 . . . 1 and may be based on datatype AGDT:CLOSED_DatePeriod.

The package CustomerPaymentCardDetails includes the entity PaymentCardDetails. PaymentCardDetails includes the following non-node elements: ID, PaymentCardTypeCode, PaymentCardID, PaymentCardHolderName, PaymentCardExpirationDate, DefaultIndicator, BlockingReasonCode, StreetName, HouseID, PostalCode, CityName, RegionCode, and CountryCode. ID may have a multiplicity of 0 . . . 1 and may be based on datatype BGDT:BusinessPartnerPaymentCardDetailsID. PaymentCardTypeCode may have a multiplicity of 0 . . . 1 and may be based on datatype BGDT:PaymentCardTypeCode. PaymentCardID may have a multiplicity of 0 . . . 1 and may be based on datatype BGDT:PaymentCardID. PaymentCardHolderName may have a multiplicity of 0 . . . 1 and may be based on datatype CDT:LANGUAGEINDEPENDENT_MEDIUM_Name. PaymentCardExpirationDate may have a multiplicity of 0 . . . 1 and may be based on datatype CDT:Date, with a qualifier of Expiration. DefaultIndicator may have a multiplicity of 0 . . . 1 and may be based on datatype CDT:Indicator. BlockingReasonCode may have a multiplicity of 0 . . . 1 and may be based on datatype BGDT:PaymentCardBlockingReasonCode. StreetName may have a multiplicity of 0 . . . 1 and may be based on datatype BGDT:StreetName. HouseID may have a multiplicity of 0 . . . 1 and may be based on datatype BGDT:HouseID. PostalCode may have a multiplicity of 0 . . . 1 and may be based on datatype BGDT:PostalCode. CityName may have a multiplicity of 0 . . . 1 and may be based on datatype CDT:LANGUAGEINDEPENDENT_MEDIUM_Name. RegionCode may have a multiplicity of 0 . . . 1 and may be based on datatype BGDT:RegionCode. CountryCode may have a multiplicity of 0 . . . 1 and may be based on datatype BGDT:CountryCode.

The package CustomerPaymentData includes the entity PaymentData. PaymentData includes the following non-node elements: CompanyID, UUID, AccountDeterminationDebtorGroupCode, AccountDebtorExternalID, PaymentBlockingReasonCode, PaymentBlockExpirationDateTime, CreditLimitAmount, DirectDebitBankDetailsID, PaymentCardDetailsID, BillOfExchangeBankDetailsID, PaymentAdviceRequiredIndicator, FirstPaymentInstructionCode, SecondPaymentInstructionCode, ThirdPaymentInstructionCode, FourthPaymentInstructionCode, and BankChargeBearerCode. CompanyID may have a multiplicity of 1 and may be based on datatype BGDT:OrganisationalCentreID. UUID may have a multiplicity of 0 . . . 1 and may be based on datatype BGDT:UUID. AccountDeterminationDebtorGroupCode may have a multiplicity of 0 . . . 1 and may be based on datatype BGDT:AccountDeterminationDebtorGroupCode. AccountDebtorExternalID may have a multiplicity of 0 . . . 1 and may be based on datatype BGDT:PartyPartyID. PaymentBlockingReasonCode may have a multiplicity of 0 . . . 1 and may be based on datatype BGDT:PaymentBlockingReasonCode. PaymentBlockExpirationDateTime may have a multiplicity of 0 . . . 1 and may be based on datatype CDT:GLOBAL_DateTime. CreditLimitAmount may have a multiplicity of 0 . . . 1 and may be based on datatype CDT:Amount. DirectDebitBankDetailsID may have a multiplicity of 0 . . . 1 and may be based on datatype BGDT:BusinessPartnerBankDetailsID. PaymentCardDetailsID may have a multiplicity of 0 . . . 1 and may be based on datatype BGDT:BusinessPartnerPaymentCardDetailsID. BillOfExchangeBankDetailsID may have a multiplicity of 0 . . . 1 and may be based on datatype BGDT:BusinessPartnerBankDetailsID. PaymentAdviceRequiredIndicator may have a multiplicity of 0 . . . 1 and may be based on datatype CDT:Indicator. FirstPaymentInstructionCode may have a multiplicity of 0 . . . 1 and may be based on datatype BGDT:PaymentInstructionTypeCode. SecondPaymentInstructionCode may have a multiplicity of 0 . . . 1 and may be based on datatype BGDT:PaymentInstructionTypeCode. ThirdPaymentInstructionCode may have a multiplicity of 0 . . . 1 and may be based on datatype BGDT:PaymentInstructionTypeCode. FourthPaymentInstructionCode may have a multiplicity of 0 . . . 1 and may be based on datatype BGDT:PaymentInstructionTypeCode. BankChargeBearerCode may have a multiplicity of 0 . . . 1 and may be based on datatype BGDT:BankChargeBearerCode. PaymentData includes the following node elements: PaymentForm, in a 1:CN cardinality relationship; DirectDebitValidityPeriod, in a 1:C cardinality relationship; and PaymentCardValidityPeriod, in a 1:C cardinality relationship.

PaymentForm includes the PaymentFormCode non-node element, which may have a multiplicity of 1 and may be based on datatype BGDT:PaymentFormCode. The package CustomerPaymentData includes the entities DirectDebitValidityPeriod and PaymentCardValidityPeriod. DirectDebitValidityPeriod is typed by datatype CLOSED_DatePeriod. PaymentCardValidityPeriod is typed by datatype CLOSED_DatePeriod.

The package CustomerTaxNumber includes the entity TaxNumber. TaxNumber includes the following non-node elements: CountryCode, TaxIdentificationNumberTypeCode, and PartyTaxID. CountryCode may have a multiplicity of 1 and may be based on datatype BGDT:CountryCode. TaxIdentificationNumberTypeCode may have a multiplicity of 1 and may be based on datatype BGDT:TaxIdentificationNumberTypeCode. PartyTaxID may have a multiplicity of 0 . . . 1 and may be based on datatype BGDT:PartyTaxID.

The package CustomerGeneralProductTaxExemption includes the entity GeneralProductTaxExemption. GeneralProductTaxExemption includes the following non-node elements: CountryCode, RegionCode, TaxTypeCode, and ReasonCode. CountryCode may have a multiplicity of 0 . . . 1 and may be based on datatype BGDT:CountryCode. RegionCode may have a multiplicity of 0 . . . 1 and may be based on datatype BGDT:RegionCode. TaxTypeCode may have a multiplicity of 0 . . . 1 and may be based on datatype BGDT:TaxTypeCode. ReasonCode may have a multiplicity of 0 . . . 1 and may be based on datatype BGDT:TaxExemptionReasonCode.

The package CustomerOperatingHoursInformation includes the entity OperatingHoursInformation. OperatingHoursInformation includes the RoleCode non-node element, which may have a multiplicity of 1 and may be based on datatype BGDT:BUSINESSPARTNER_OperatingHoursRoleCode. OperatingHoursInformation includes the following node elements: RecurringDayProgramme, in a 1:CN cardinality relationship.

The package CustomerOperatingHoursInformation includes the entity RecurringDayProgramme RecurringDayProgramme includes the WeekdaySelection non-node element, which may have a multiplicity of 0 . . . 1 and may be based on datatype AGDT:WeekdaySelection. RecurringDayProgramme includes the following node elements: OperatingHours, in a 1:CN cardinality relationship. OperatingHours includes the TimePeriod non-node element, which may have a multiplicity of 1 and may be based on datatype AGDT:UPPEROPEN_TimePeriod.

The package CustomerText includes the entity Text. Text includes the following non-node elements: TypeCode and ContentText. TypeCode may have a multiplicity of 0 . . . 1 and may be based on datatype BGDT:TextCollectionTextTypeCode. ContentText may have a multiplicity of 0 . . . 1 and may be based on datatype CDT:LANGUAGEINDEPENDENT_Text.

The package CustomerAttachmentFolder includes the entity AttachmentFolder. AttachmentFolder includes the UUID non-node element, which may have a multiplicity of 0 . . . 1 and may be based on datatype BGDT:UUID. AttachmentFolder includes the following node elements: Document, in a 1:CN cardinality relationship.

The package CustomerAttachmentFolder includes the entity Document. Document includes the following non-node elements: UUID, VersionID, SystemAdministrativeData, LinkInternalIndicator, CheckedOutIndicator, VisibleIndicator, VersioningEnabledIndicator, CategoryCode, CategoryName, TypeCode, TypeName, MIMECode, MIMEName, PathName, Name, AlternativeName, InternalLinkUUID, Description, ExternalLinkWebURI, FileContentURI, and FilesizeMeasure. UUID may have a multiplicity of 0 . . . 1 and may be based on datatype BGDT:UUID. VersionID may have a multiplicity of 0 . . . 1 and may be based on datatype BGDT:VersionID. SystemAdministrativeData may have a multiplicity of 0 . . . 1 and may be based on datatype AGDT:SystemAdministrativeData. LinkInternalIndicator may have a multiplicity of 0 . . . 1 and may be based on datatype CDT:Indicator. CheckedOutIndicator may have a multiplicity of 0 . . . 1 and may be based on datatype CDT:Indicator. VisibleIndicator may have a multiplicity of 0 . . . 1 and may be based on datatype CDT:Indicator. VersioningEnabledIndicator may have a multiplicity of 0 . . . 1 and may be based on datatype CDT:Indicator. CategoryCode may have a multiplicity of 0 . . . 1 and may be based on datatype BGDT:DocumentCategoryCode. CategoryName may have a multiplicity of 0 . . . 1 and may be based on datatype CDT:LANGUAGEINDEPENDENT_LONG_Name. TypeCode may have a multiplicity of 0 . . . 1 and may be based on datatype BGDT:DocumentTypeCode. TypeName may have a multiplicity of 0 . . . 1 and may be based on datatype CDT:LANGUAGEINDEPENDENT_LONG_Name. MIMECode may have a multiplicity of 0 . . . 1 and may be based on datatype BGDT:MIMECode. MIMEName may have a multiplicity of 0 . . . 1 and may be based on datatype CDT:LANGUAGEINDEPENDENT_LONG_Name. PathName may have a multiplicity of 0 . . . 1 and may be based on datatype CDT:LANGUAGEINDEPENDENT_Name. Name may have a multiplicity of 0 . . . 1 and may be based on datatype CDT:LANGUAGEINDEPENDENT_Name. AlternativeName may have a multiplicity of 0 . . . 1 and may be based on datatype CDT:LANGUAGEINDEPENDENT_Name. InternalLinkUUID may have a multiplicity of 0 . . . 1 and may be based on datatype BGDT:UUID. Description may have a multiplicity of 0 . . . 1 and may be based on datatype BGDT:Description. ExternalLinkWebURI may have a multiplicity of 0 . . . 1 and may be based on datatype BGDT:WebURI. FileContentURI may have a multiplicity of 0 . . . 1 and may be based on datatype BGDT:URI. FilesizeMeasure may have a multiplicity of 0 . . . 1 and may be based on datatype CDT:Measure. Document includes the following node elements: Property, in a 1:CN cardinality relationship.

Property includes the following non-node elements: TechnicalID, Name, DataTypeFormatCode, DataTypeFormatName, VisibleIndicator, ChangeAllowedIndicator, MultipleValueIndicator, NamespaceURI, and Description. TechnicalID may have a multiplicity of 0 . . . 1 and may be based on datatype BGDT:ObjectNodeTechnicalID. Name may have a multiplicity of 0 . . . 1 and may be based on datatype CDT:LANGUAGEINDEPENDENT_Name. DataTypeFormatCode may have a multiplicity of 0 . . . 1 and may be based on datatype BGDT:PropertyDataTypeFormatCode. DataTypeFormatName may have a multiplicity of 0 . . . 1 and may be based on datatype CDT:LANGUAGEINDEPENDENT_LONG_Name. VisibleIndicator may have a multiplicity of 0 . . . 1 and may be based on datatype CDT:Indicator. ChangeAllowedIndicator may have a multiplicity of 0 . . . 1 and may be based on datatype CDT:Indicator. MultipleValueIndicator may have a multiplicity of 0 . . . 1 and may be based on datatype CDT:Indicator. NamespaceURI may have a multiplicity of 0 . . . 1 and may be based on datatype BGDT:NamespaceURI. Description may have a multiplicity of 0 . . . 1 and may be based on datatype BGDT:Description.

Property includes the following node elements: PropertyValue, with a cardinality of 1:CN. PropertyValue includes the following non-node elements: TechnicalID, Text, Indicator, DateTime, and IntegerValue. TechnicalID may have a multiplicity of 0 . . . 1 and may be based on datatype BGDT:ObjectNodeTechnicalID. Text may have a multiplicity of 0 . . . 1 and may be based on datatype CDT:LANGUAGEINDEPENDENT_Text. Indicator may have a multiplicity of 0 . . . 1 and may be based on datatype CDT:Indicator. DateTime may have a multiplicity of 0 . . . 1 and may be based on datatype CDT:GLOBAL_DateTime. IntegerValue may have a multiplicity of 0 . . . 1 and may be based on datatype BGDT:IntegerValue.

The package ProcessingConditions includes the entity ProcessingConditions. ProcessingConditions is typed by datatype ResponseProcessingConditions. The package Log includes the entity Log. Log is typed by datatype Log.

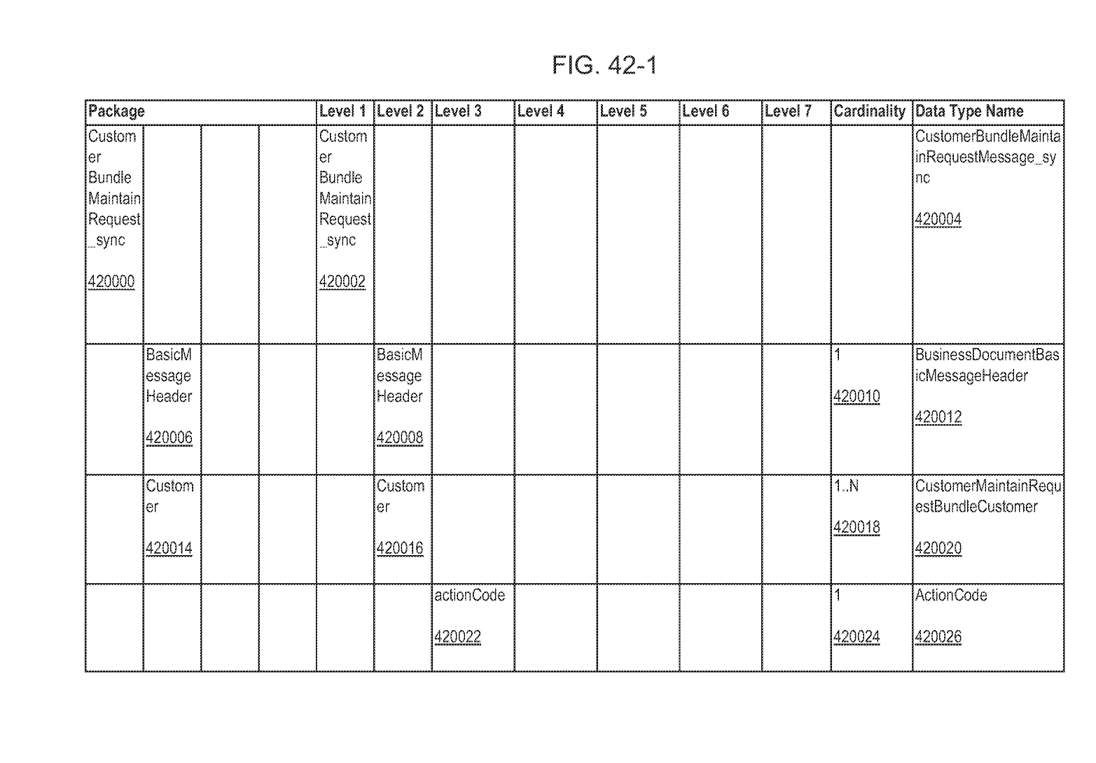

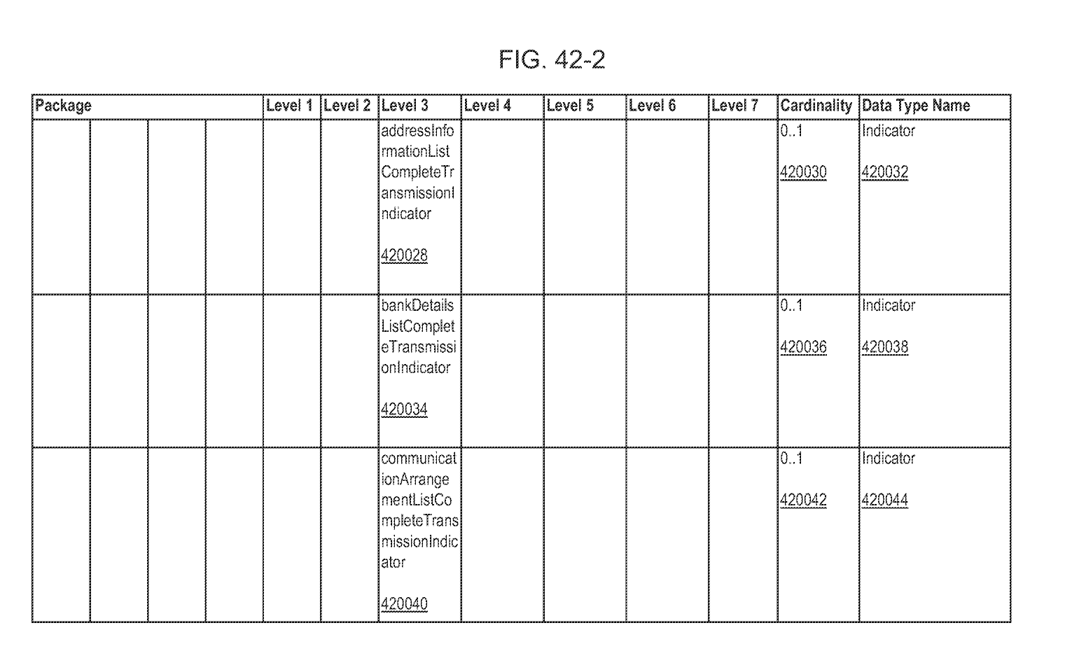

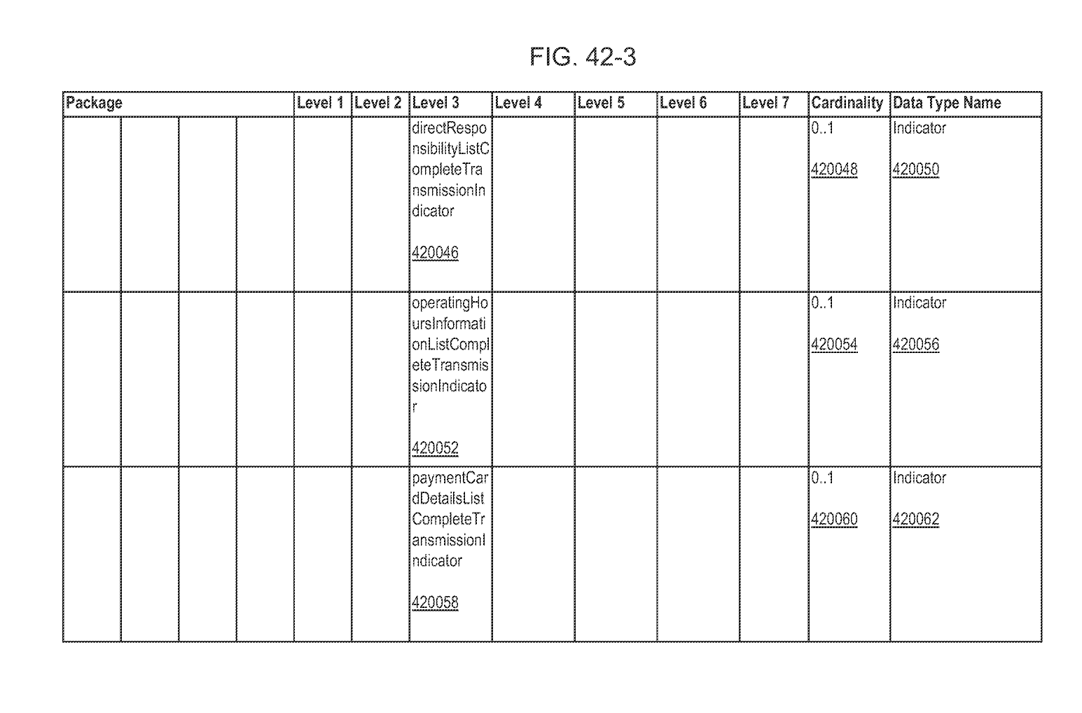

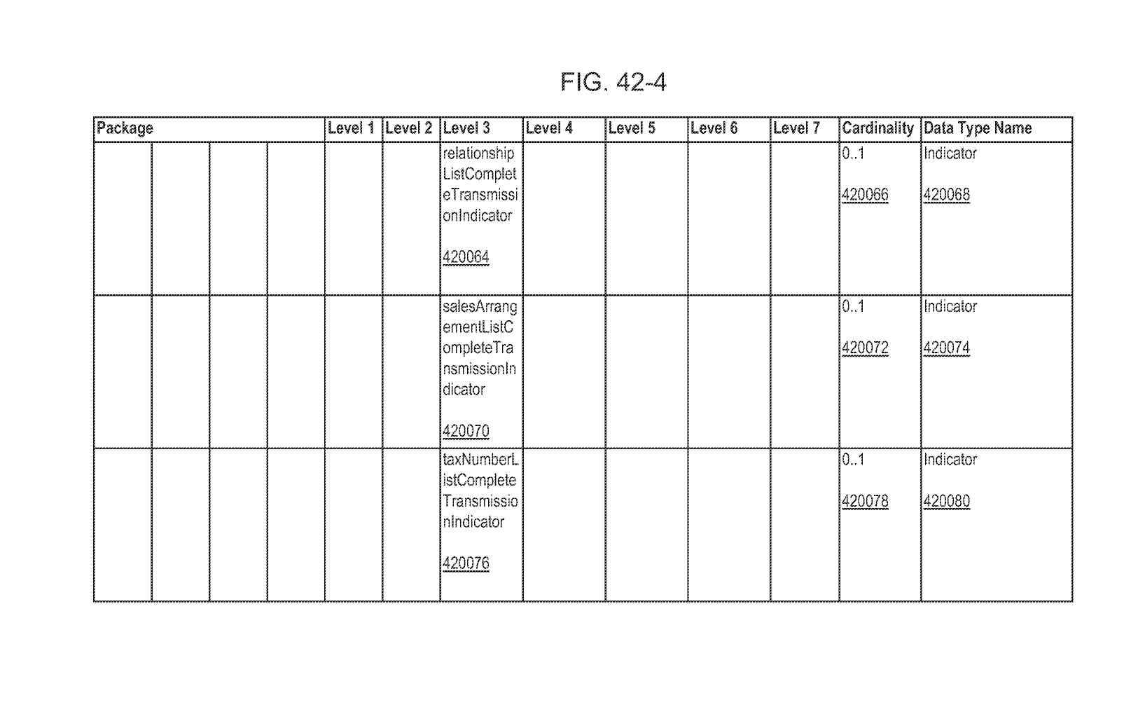

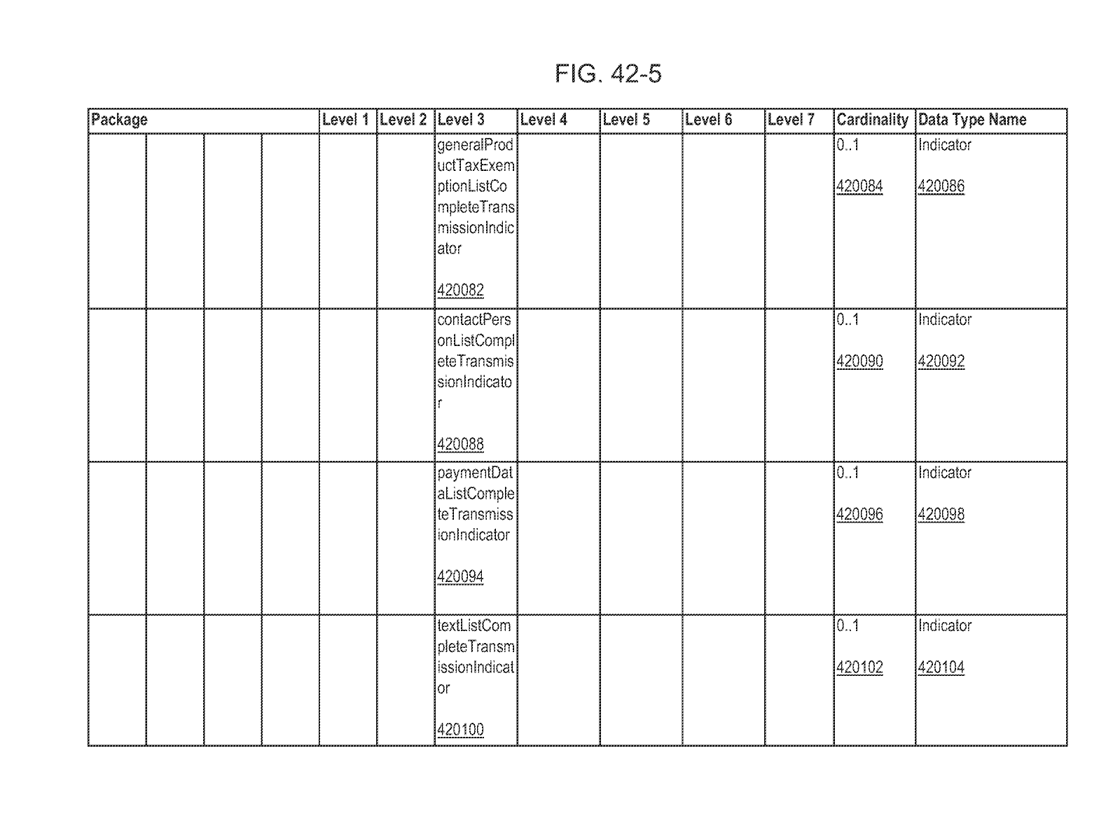

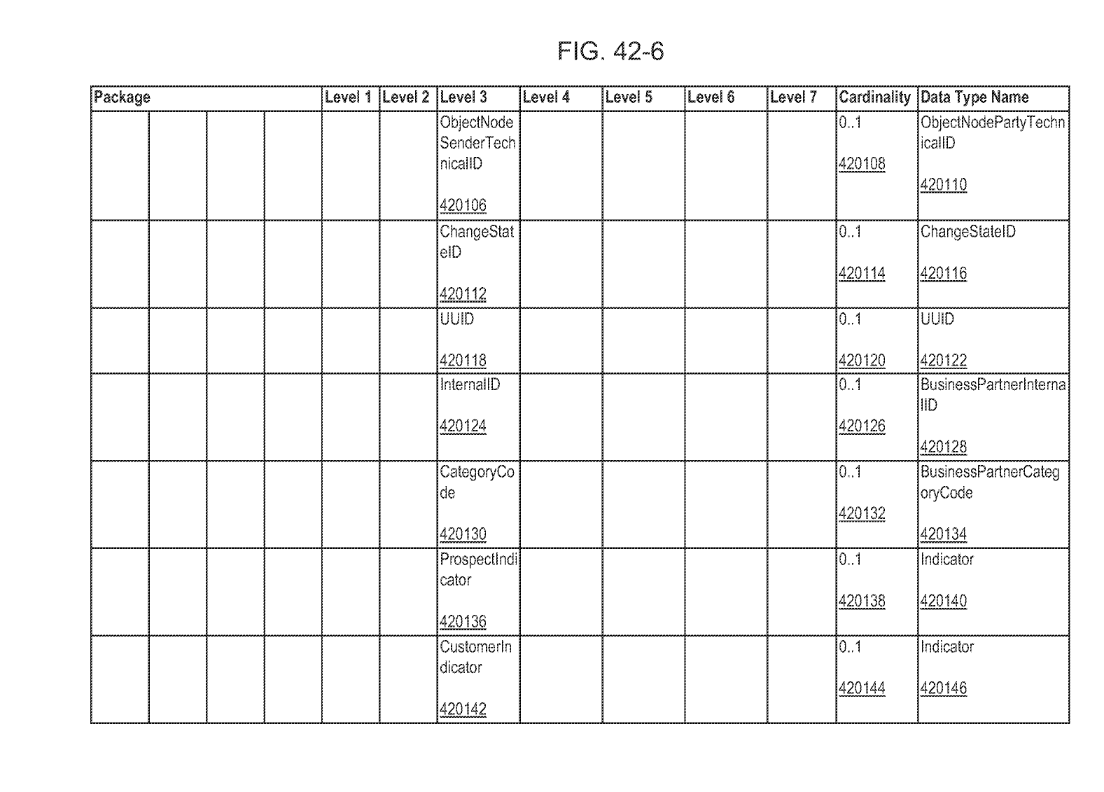

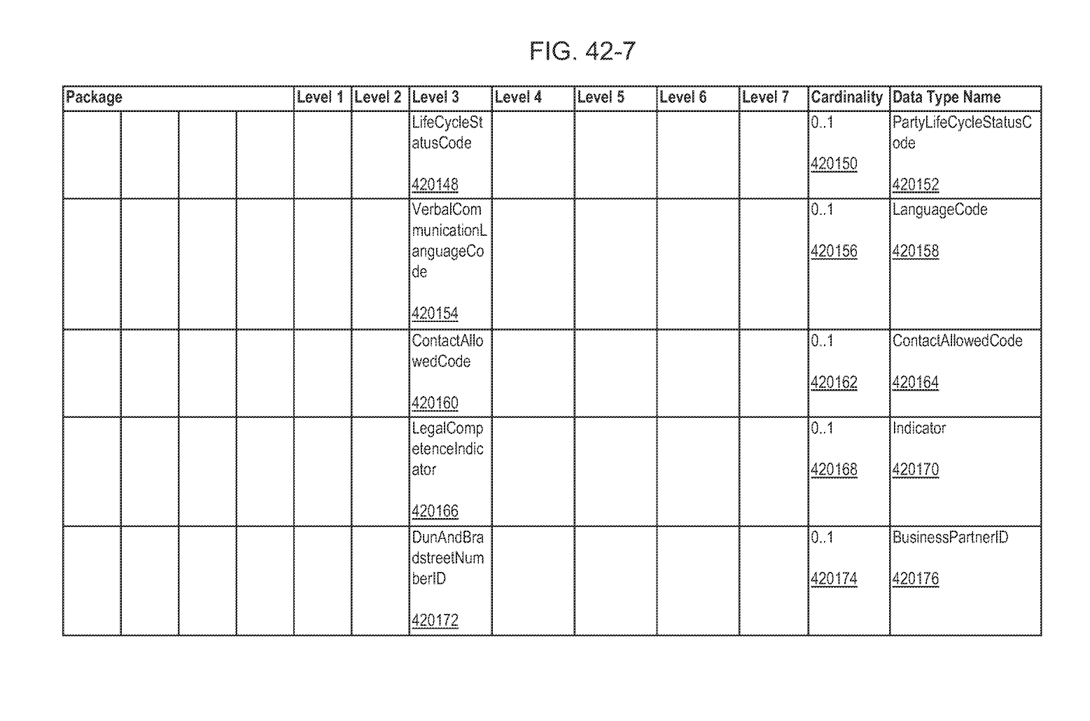

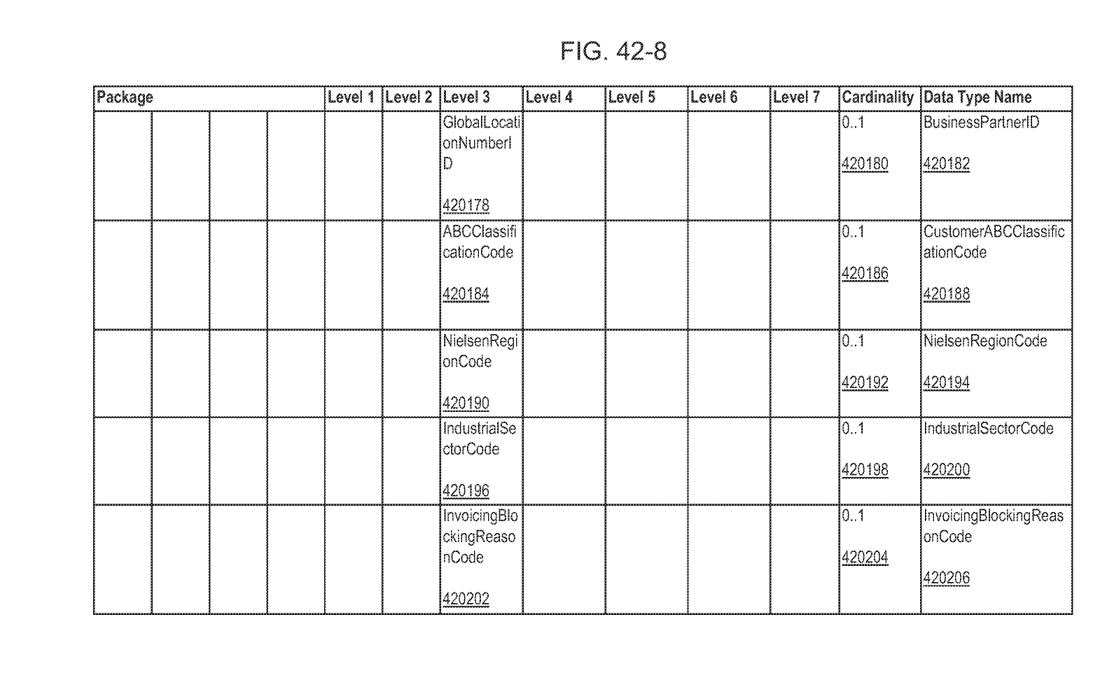

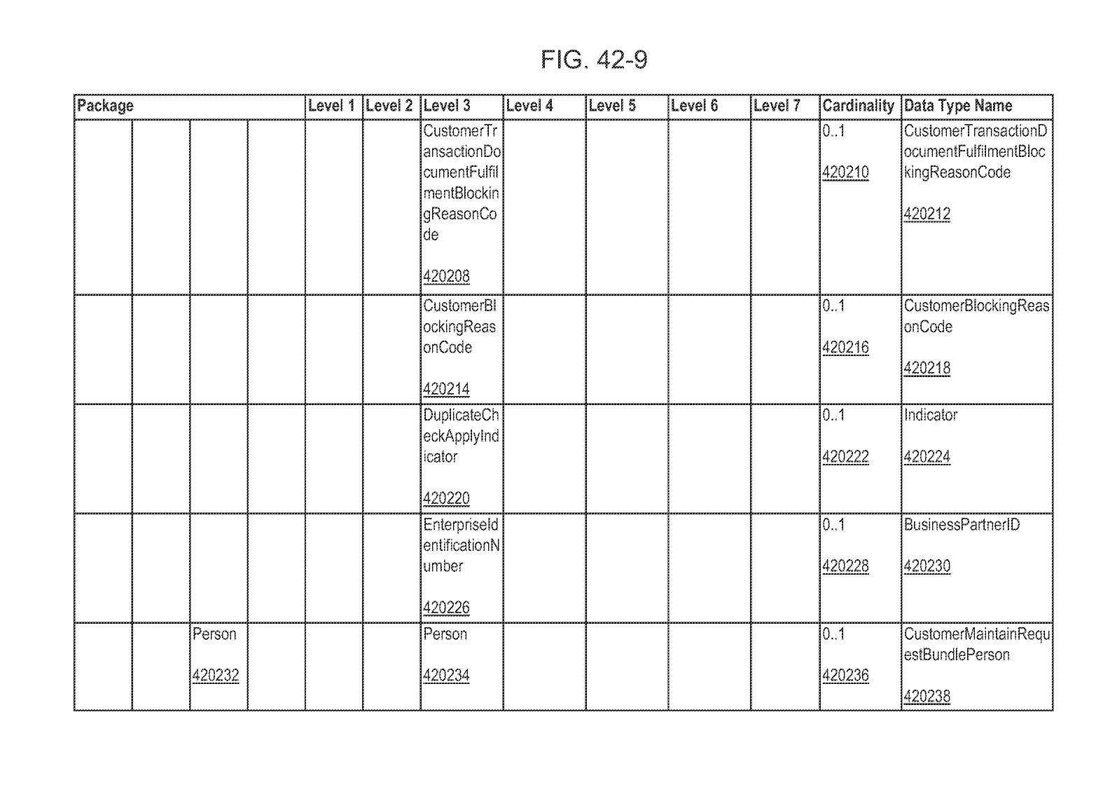

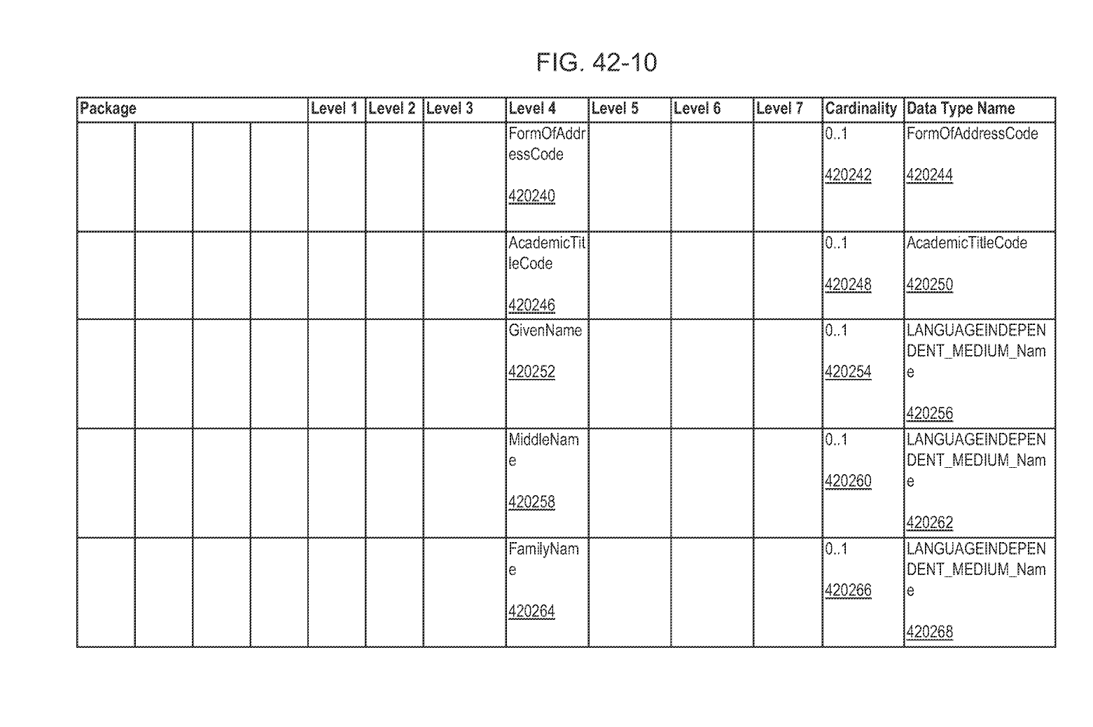

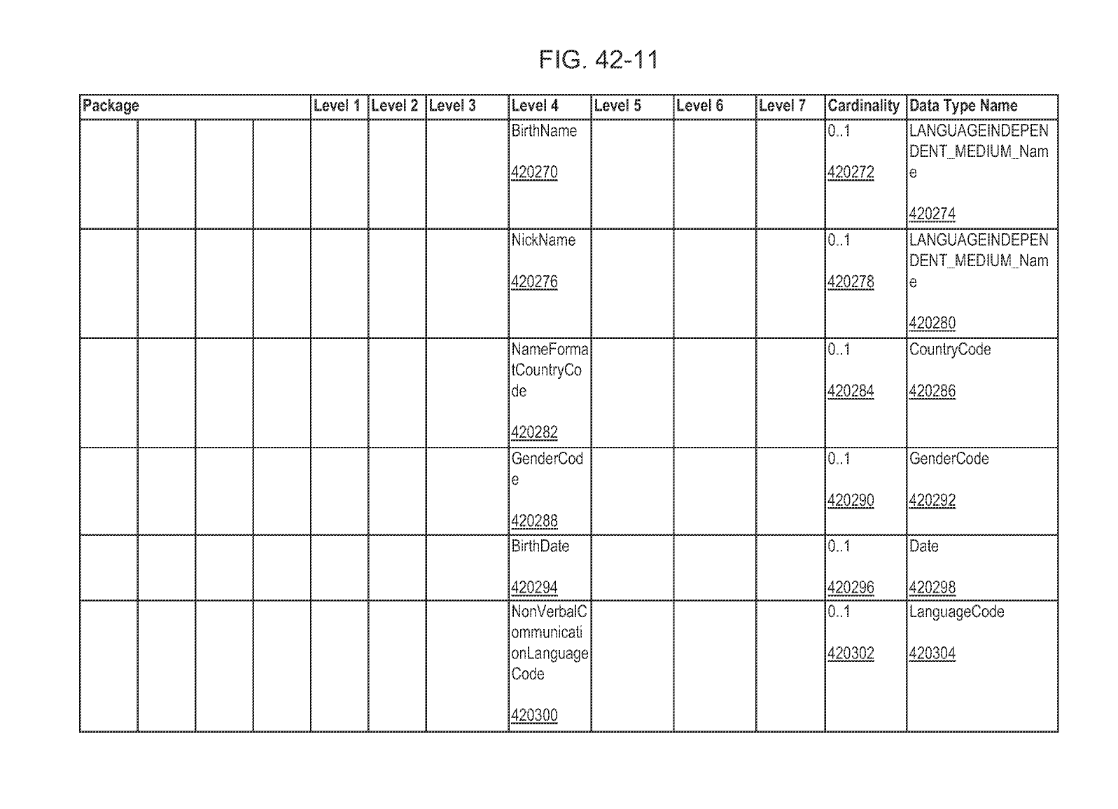

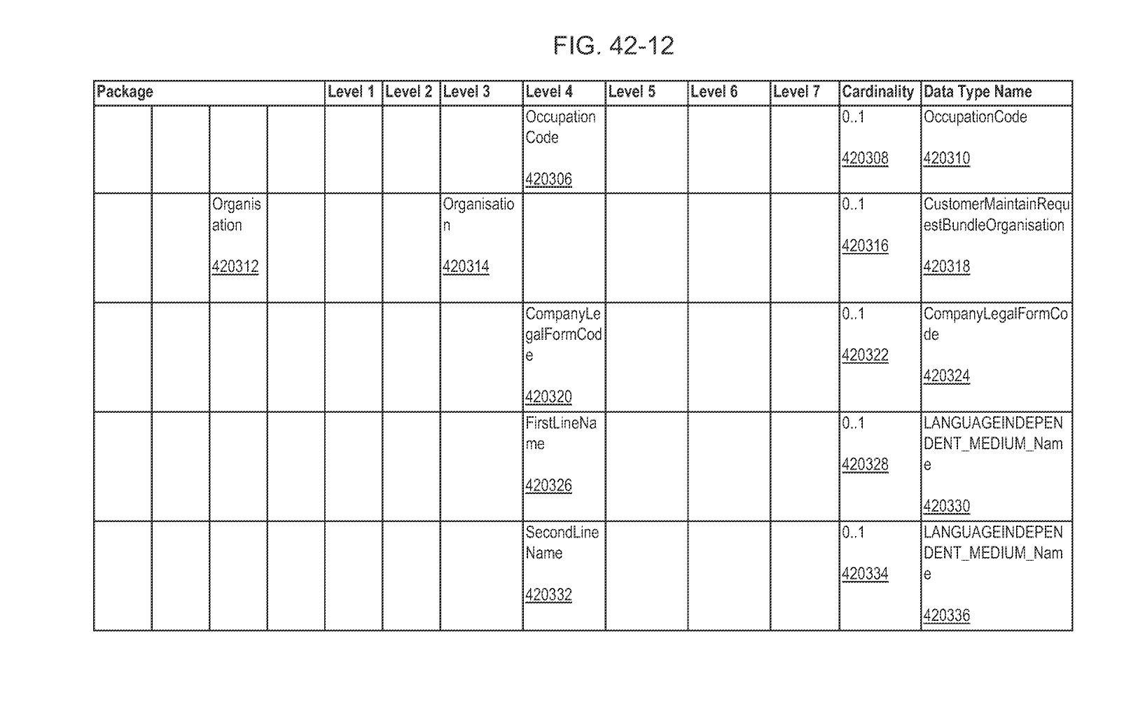

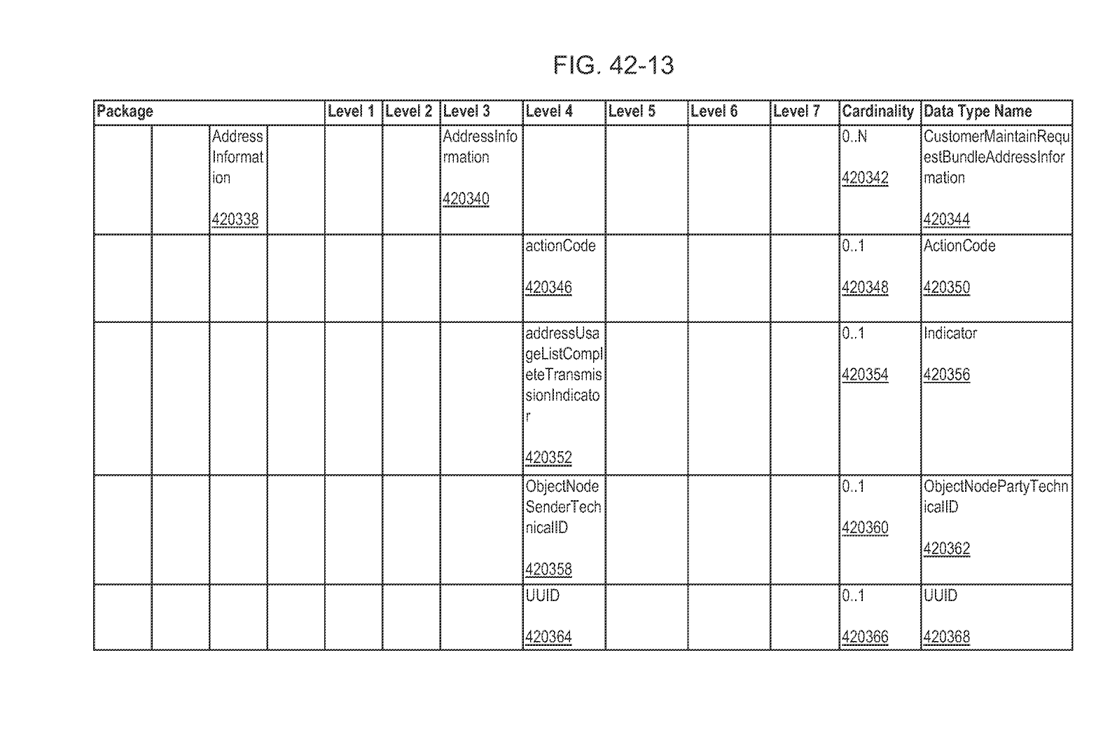

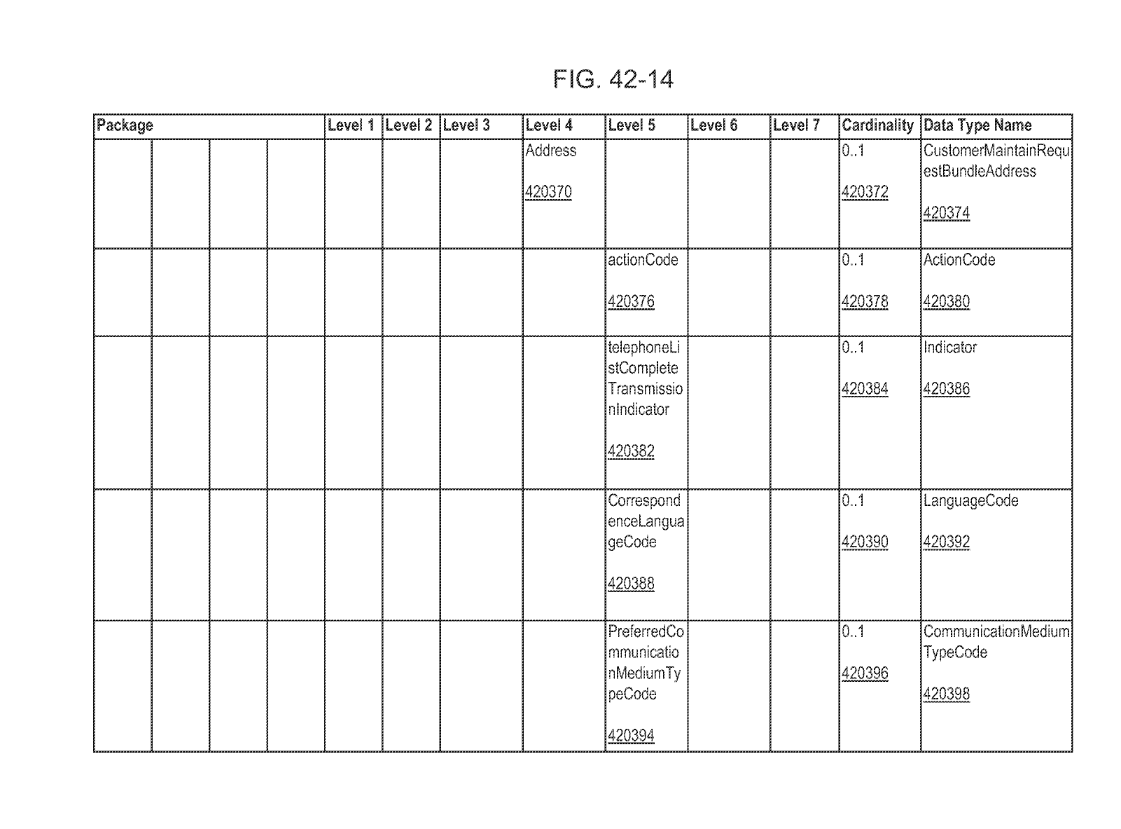

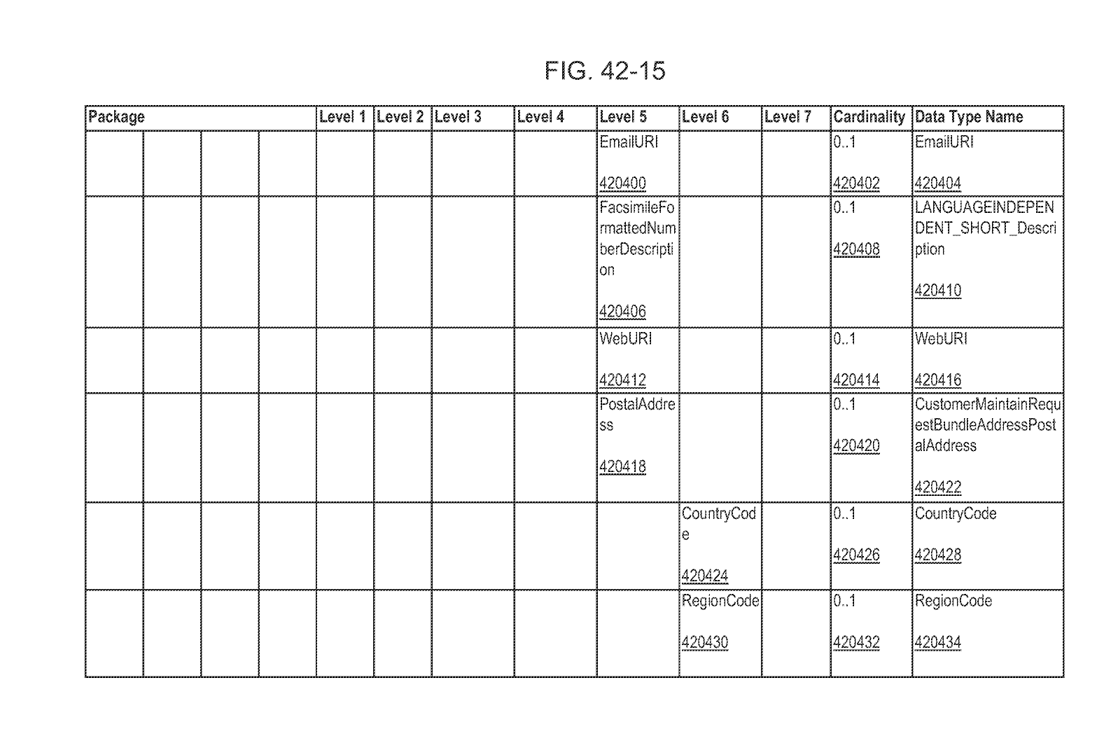

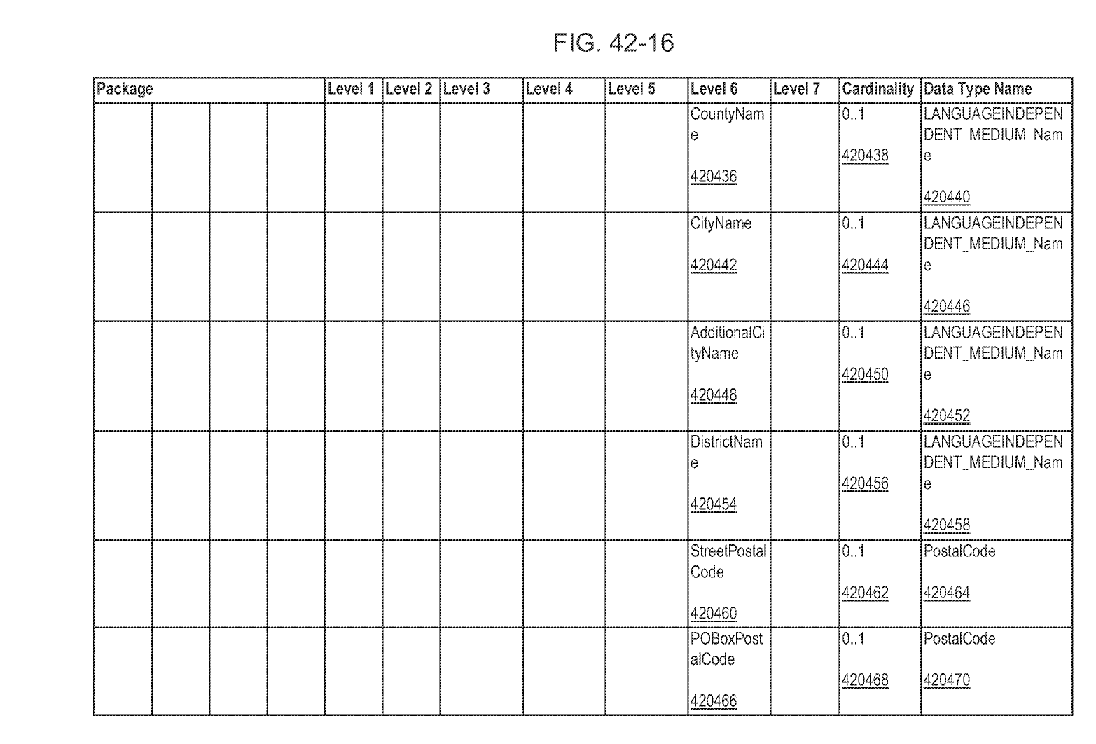

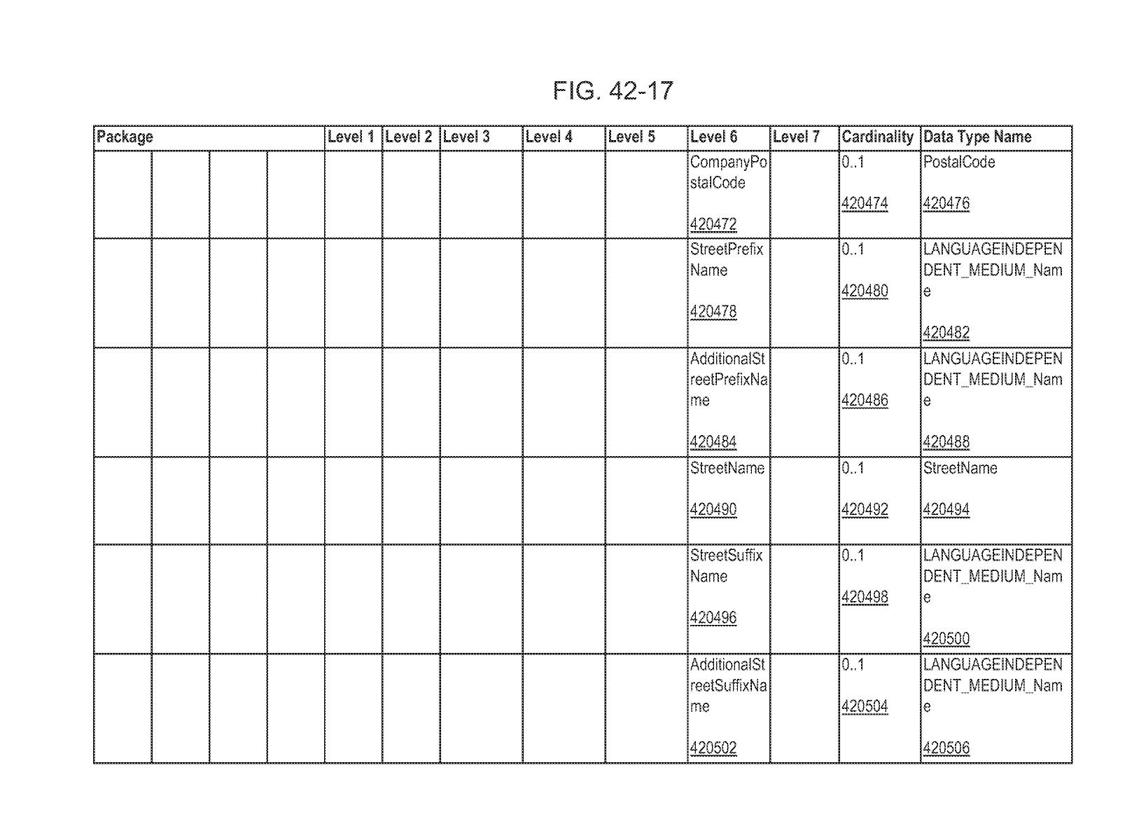

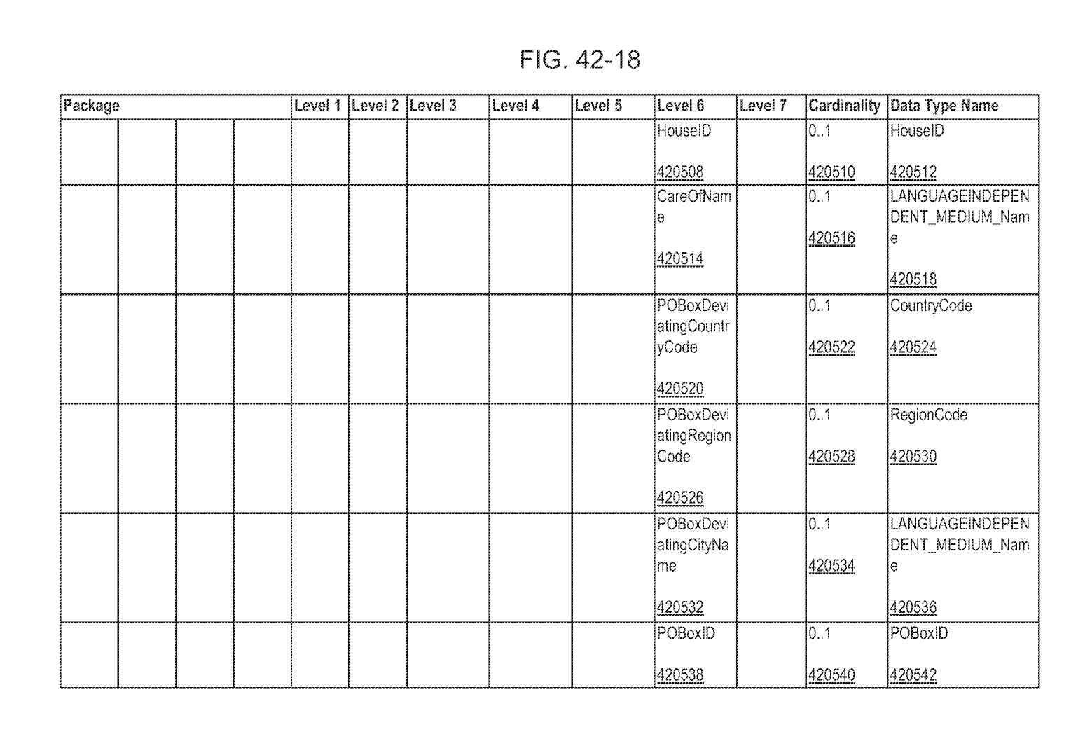

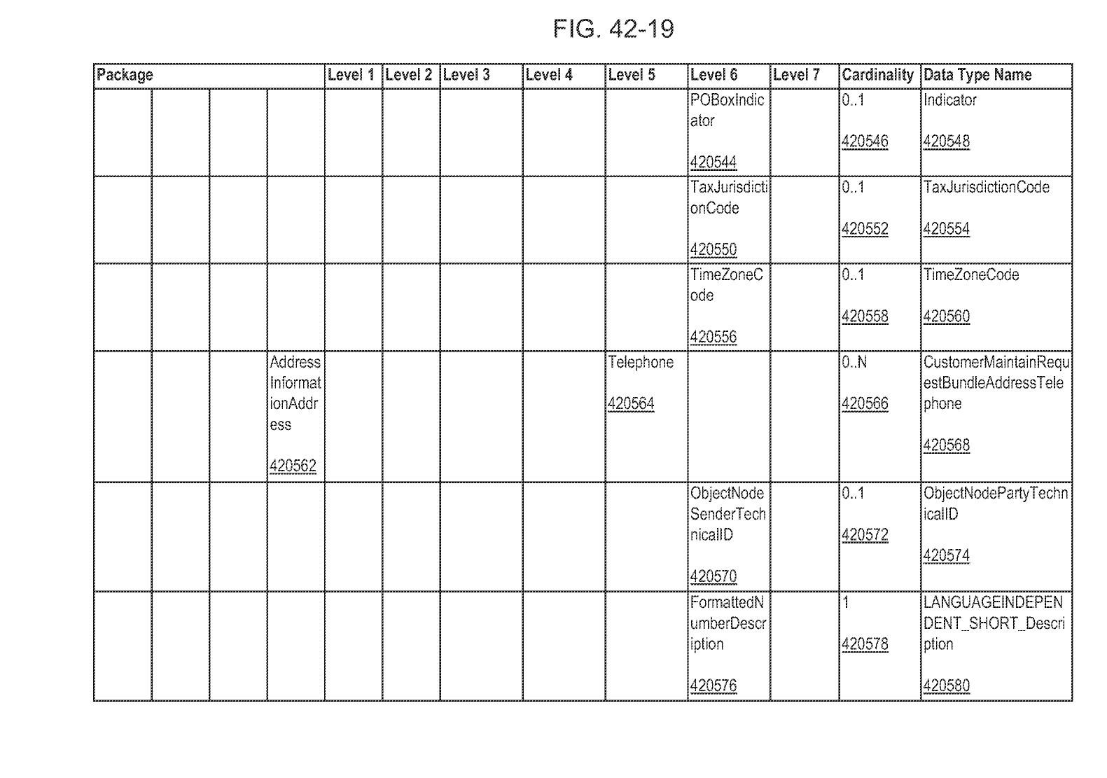

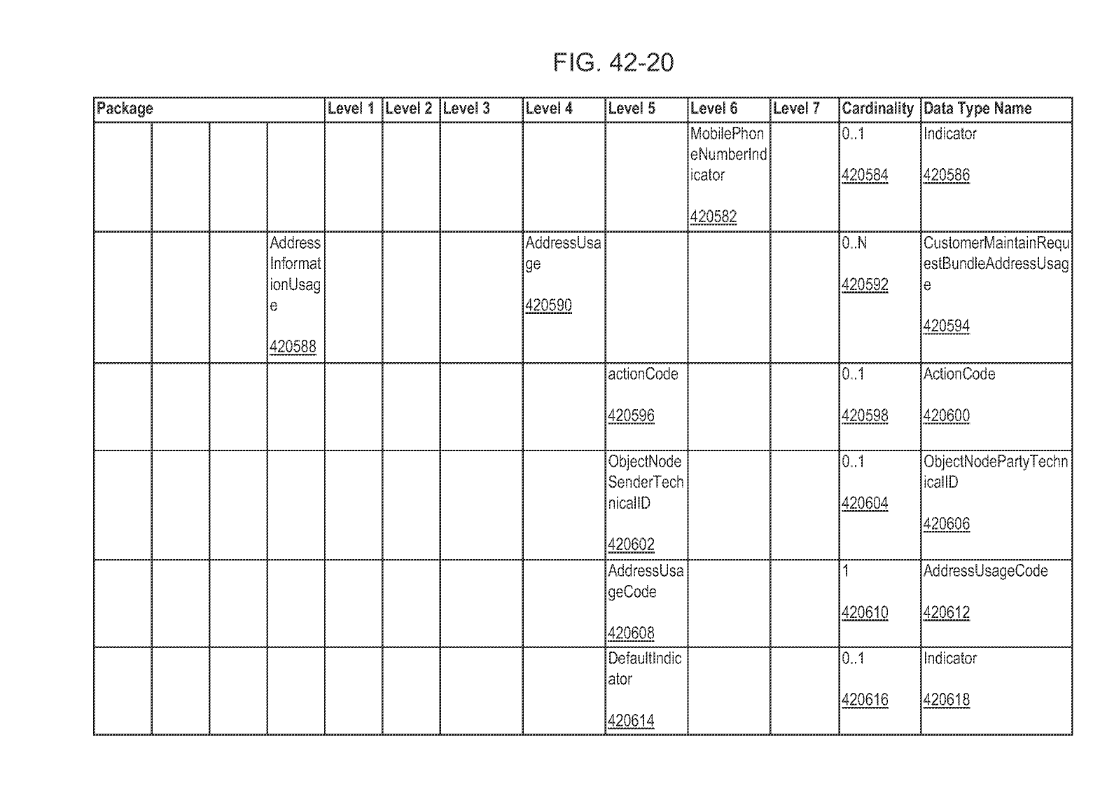

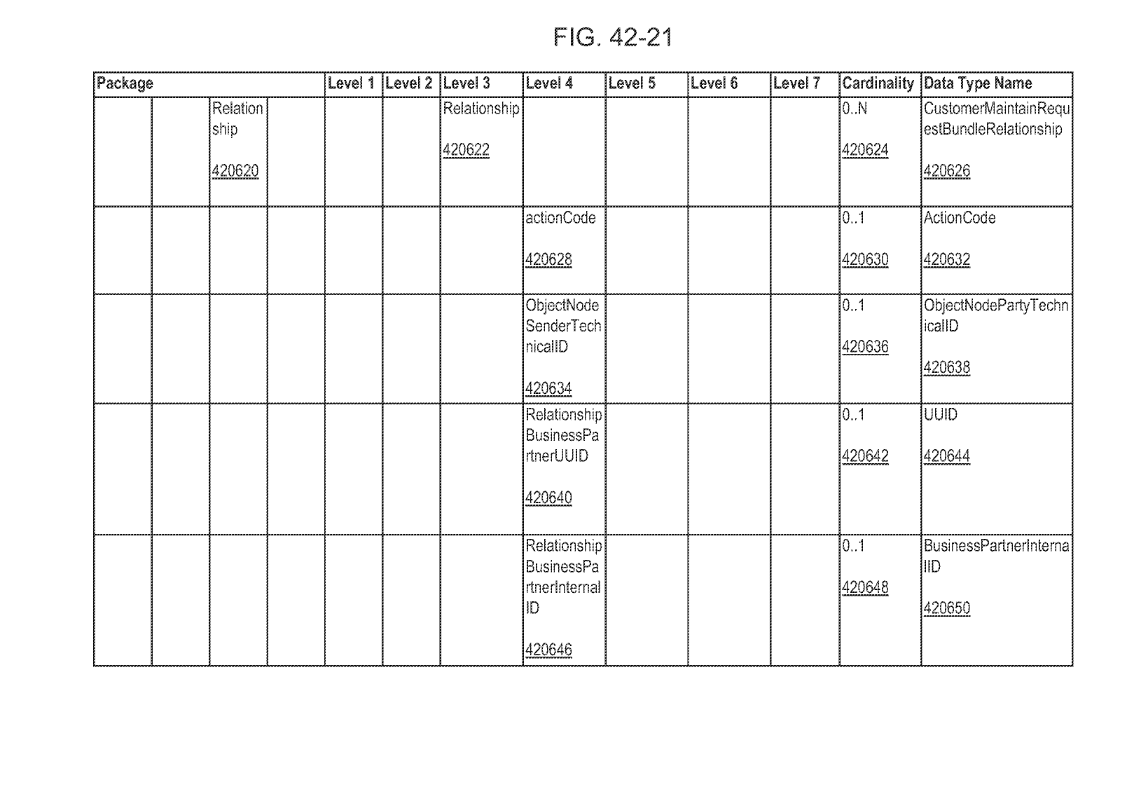

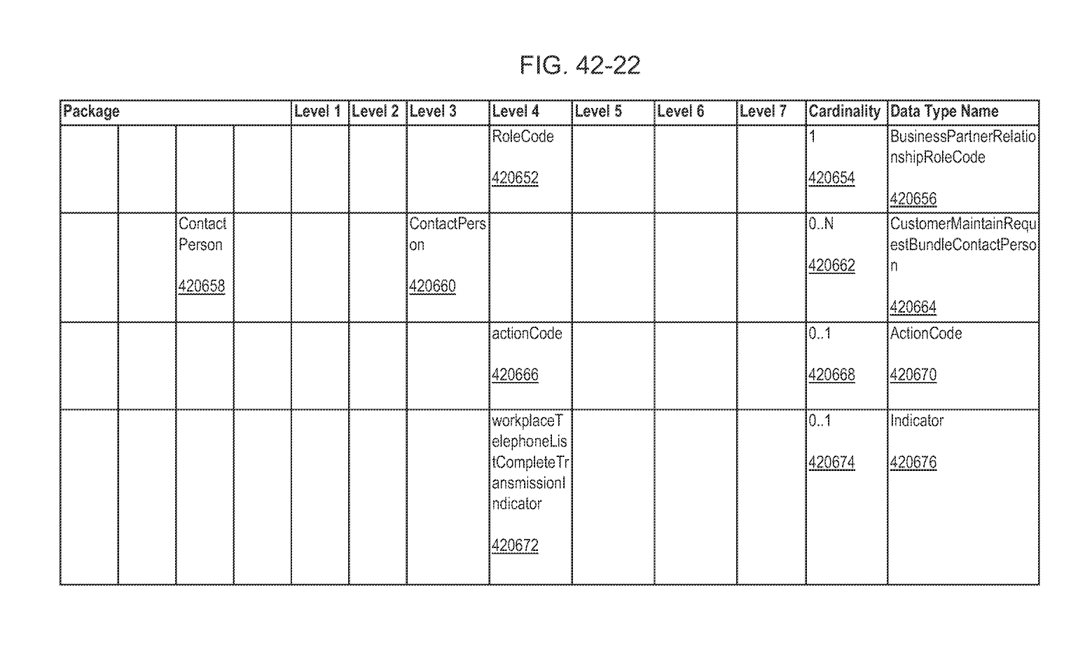

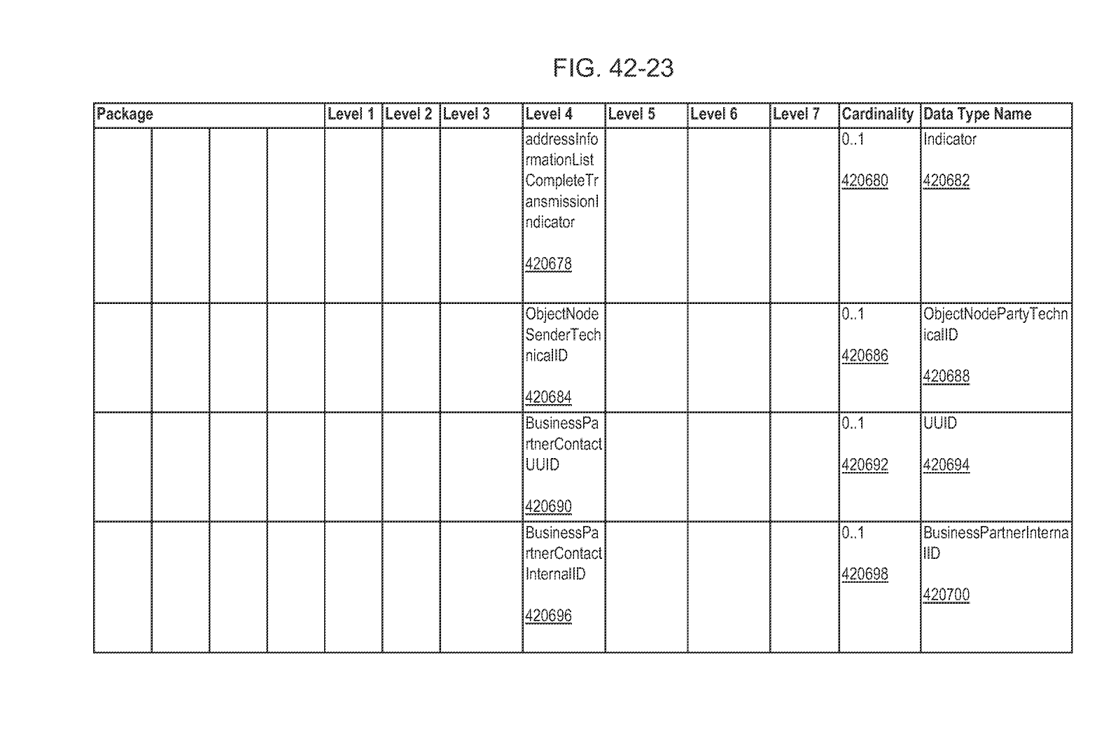

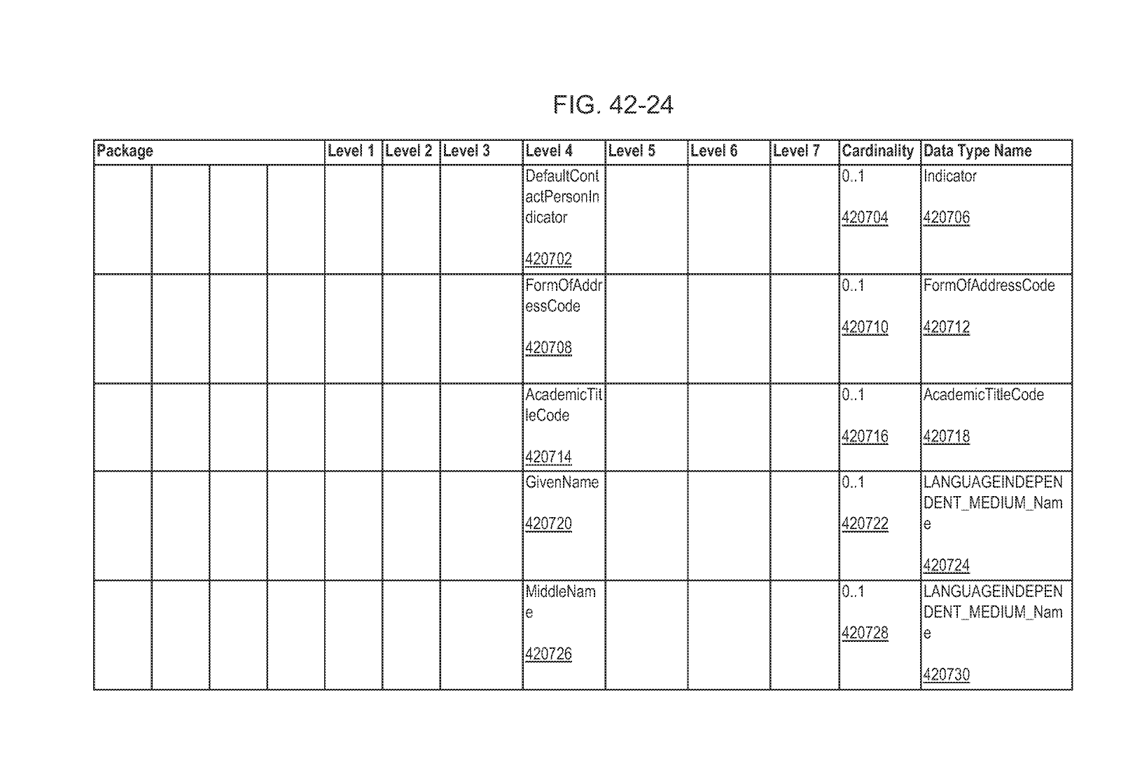

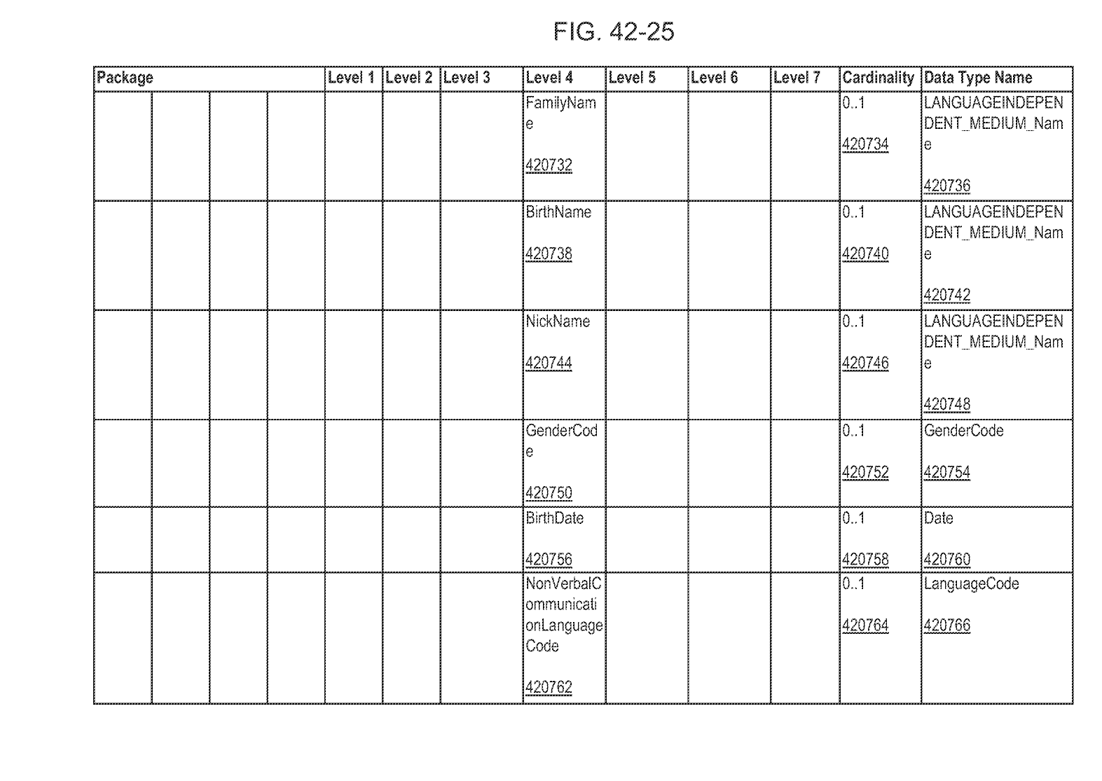

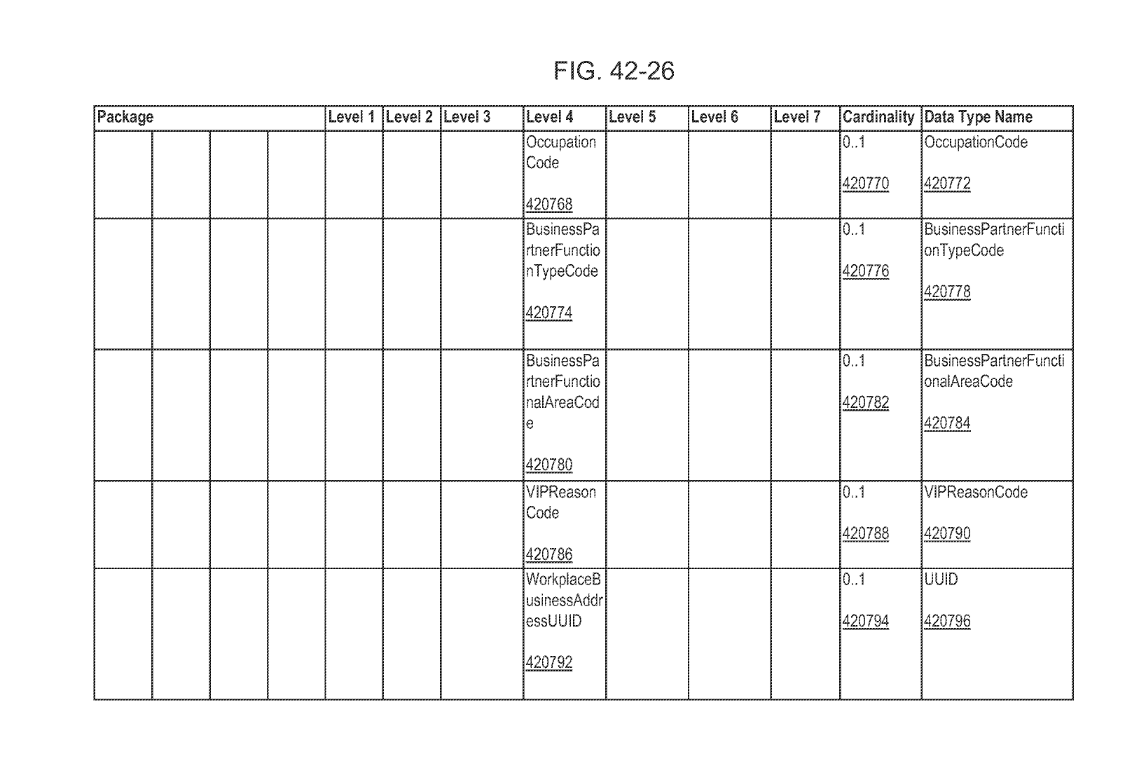

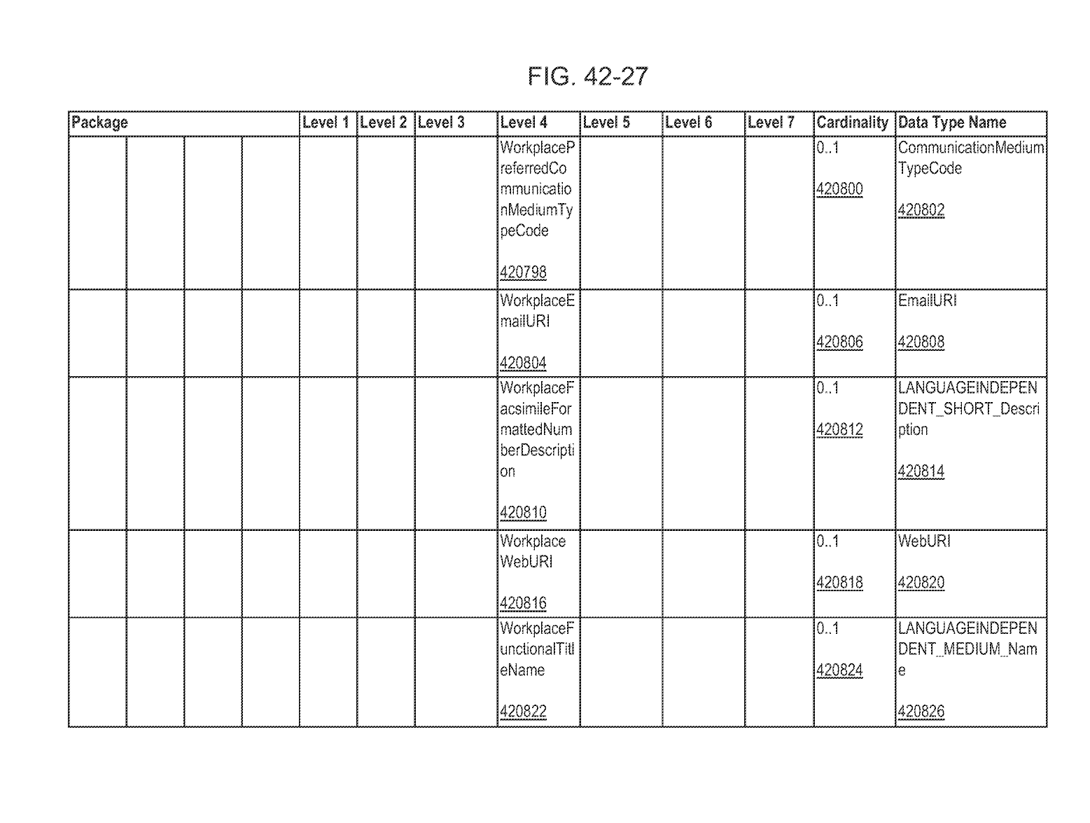

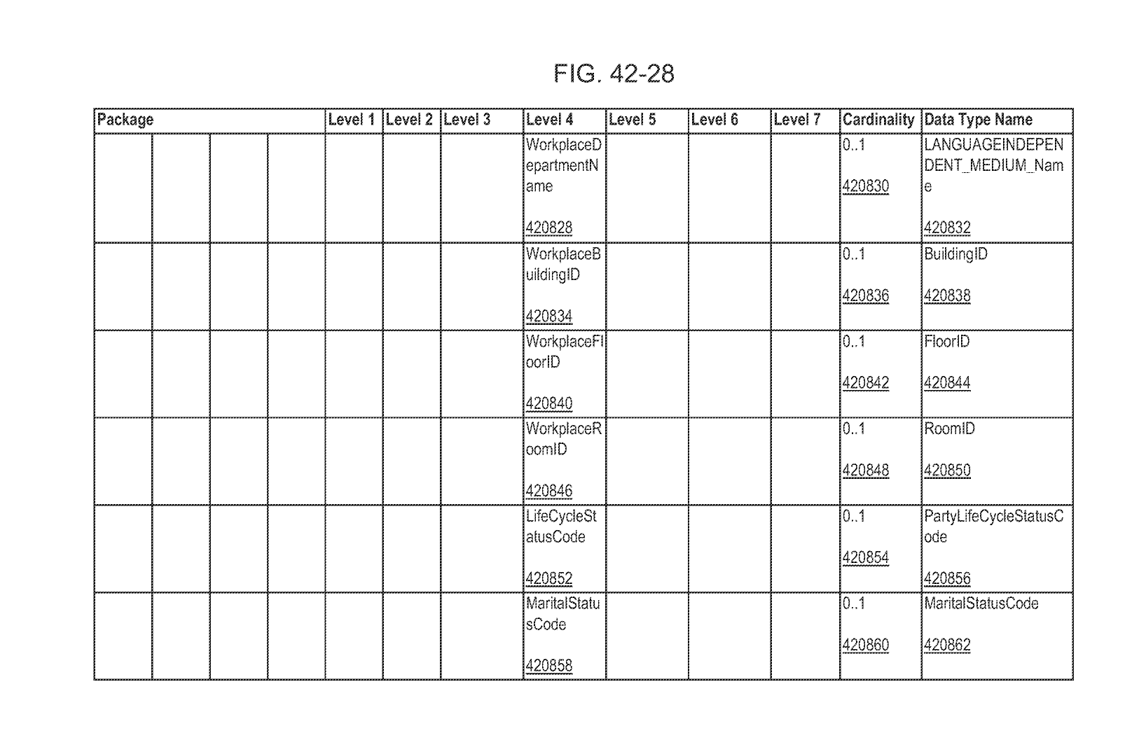

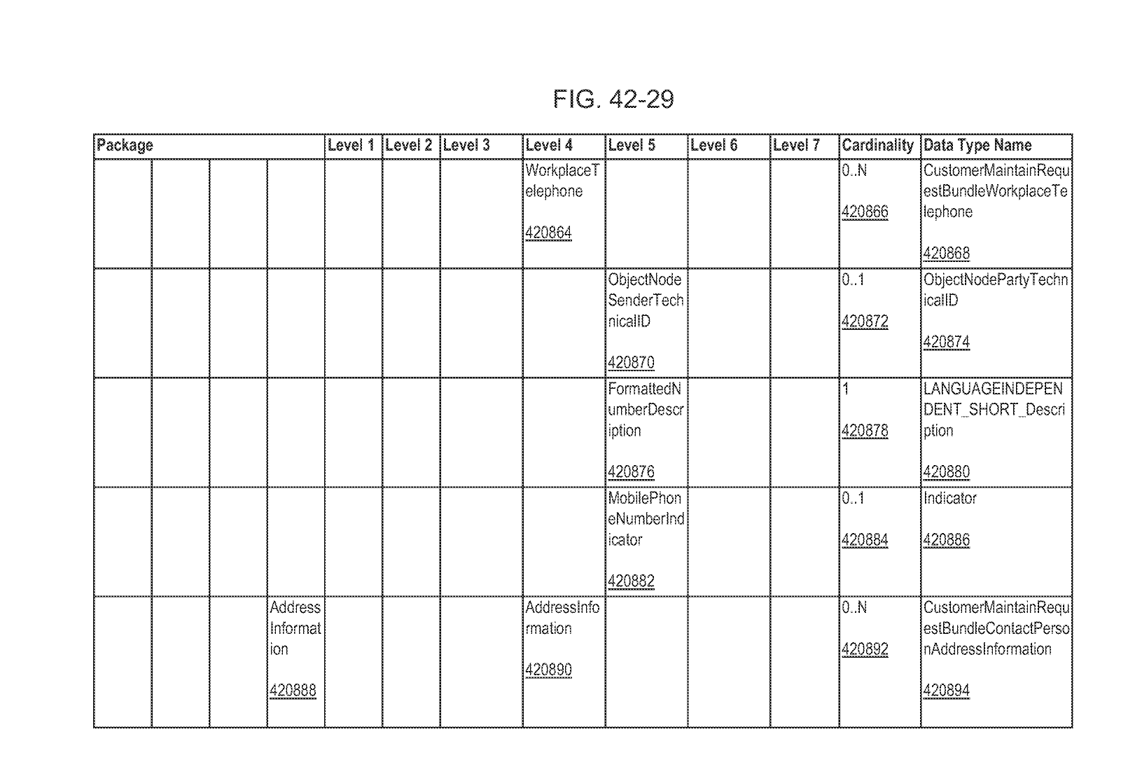

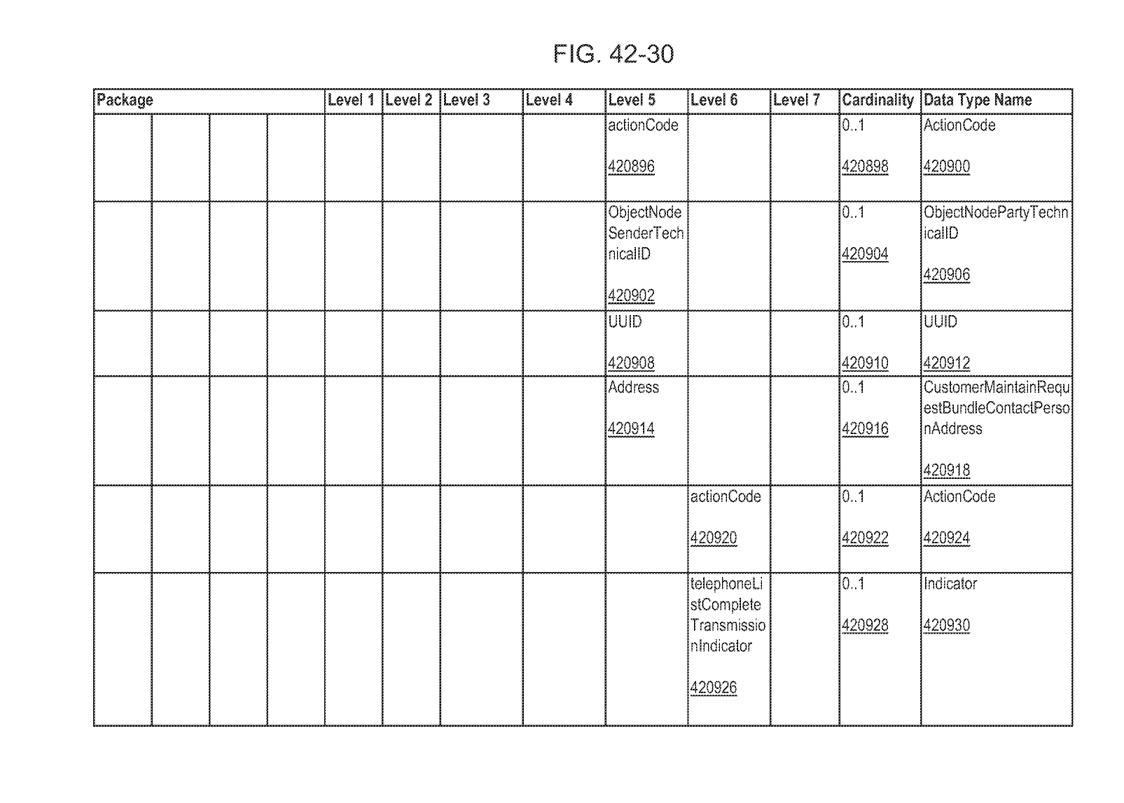

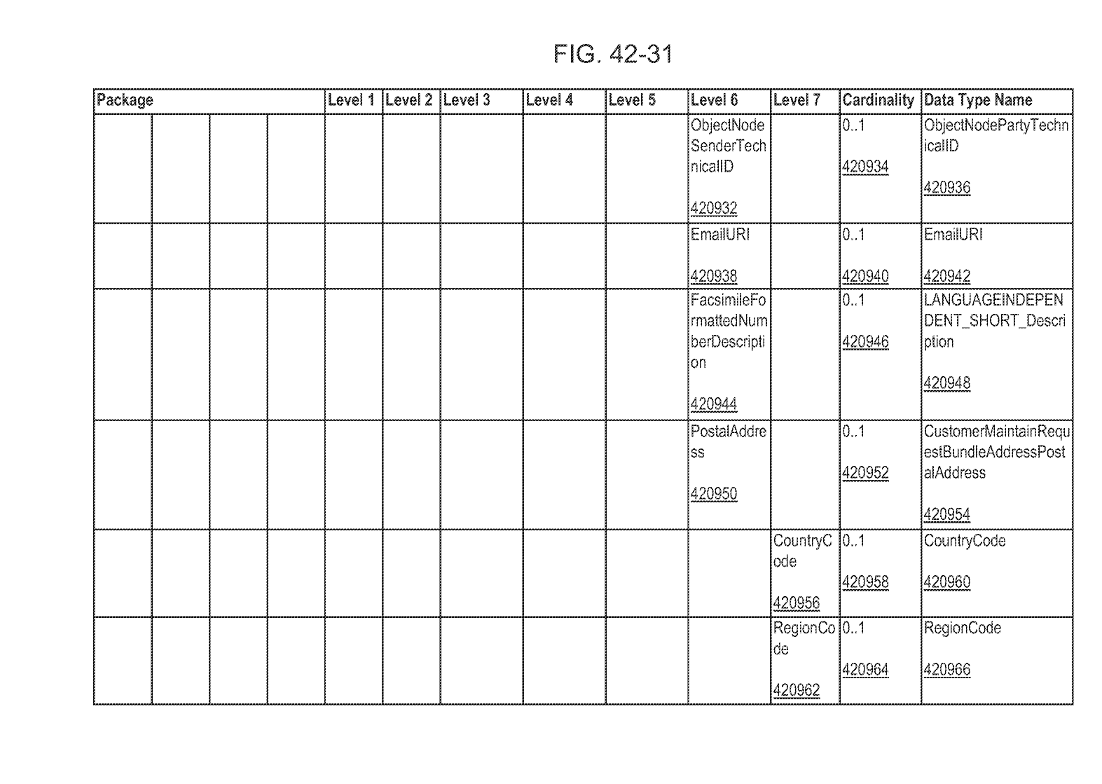

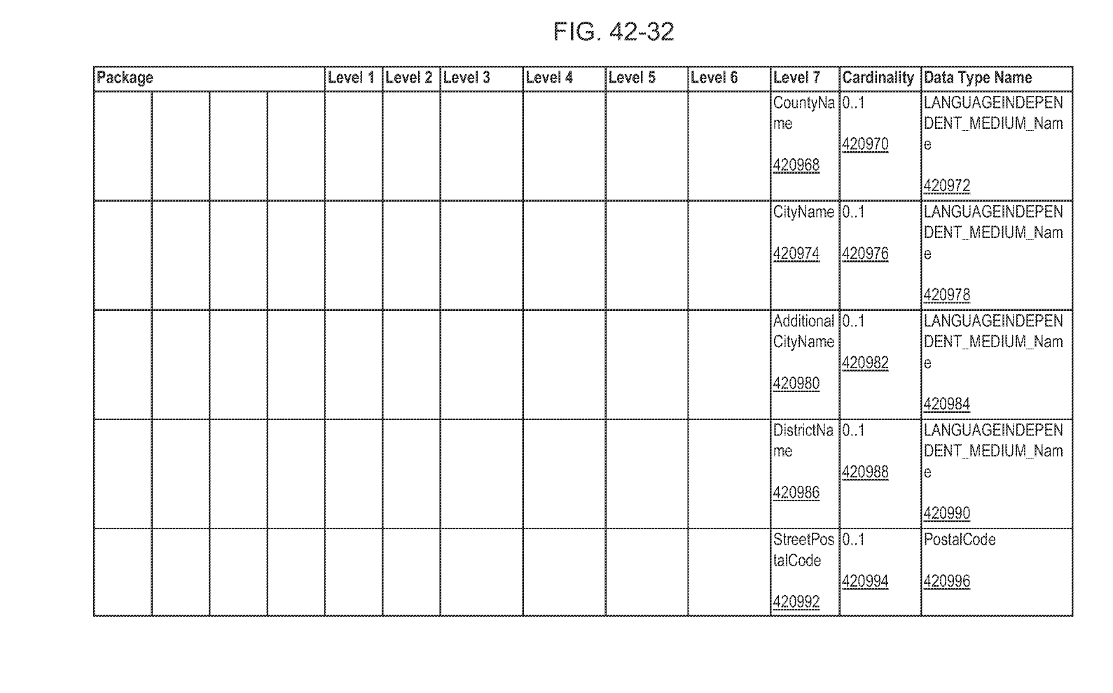

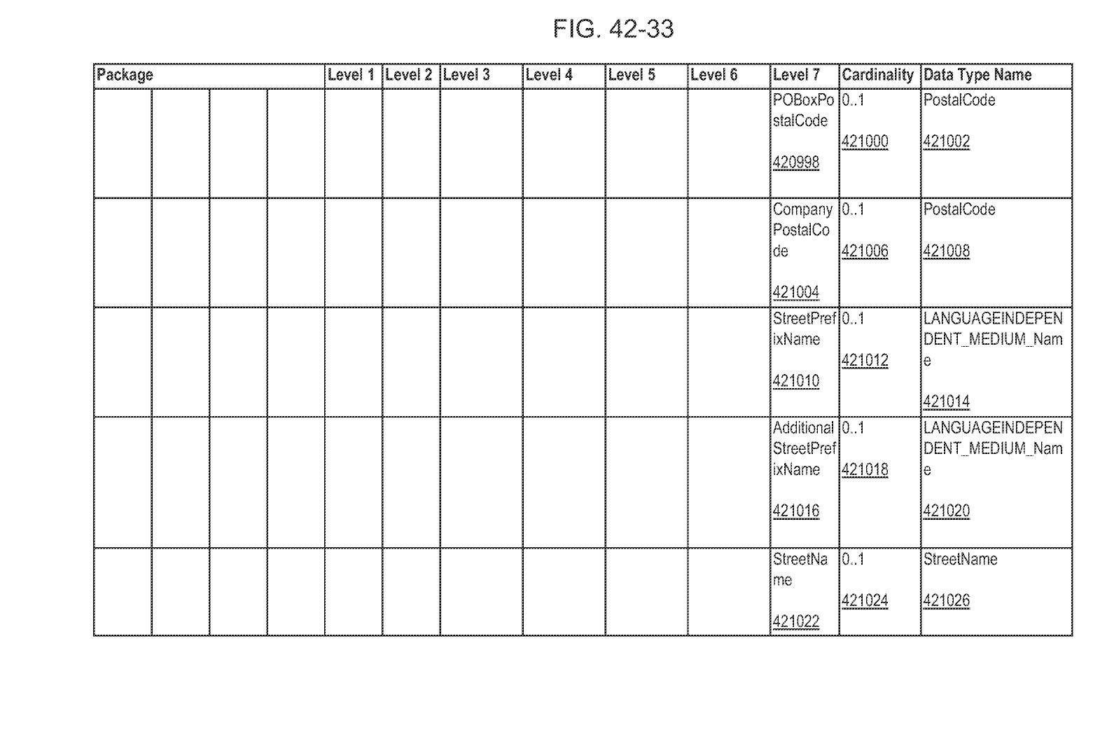

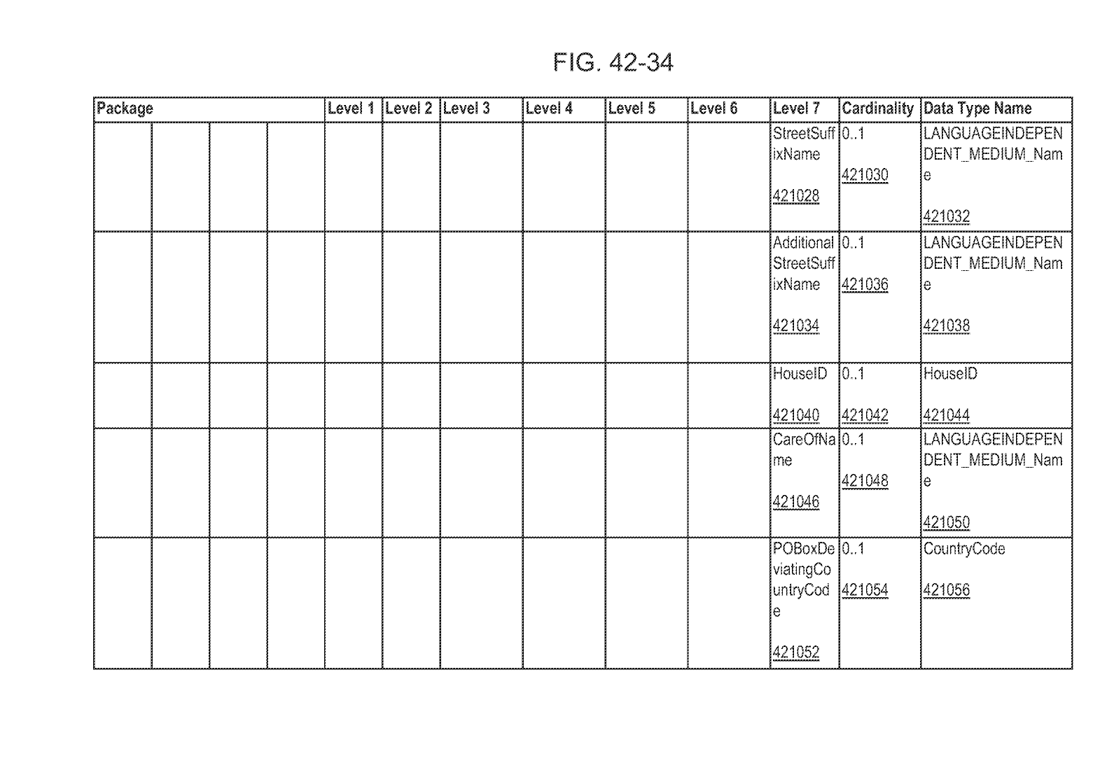

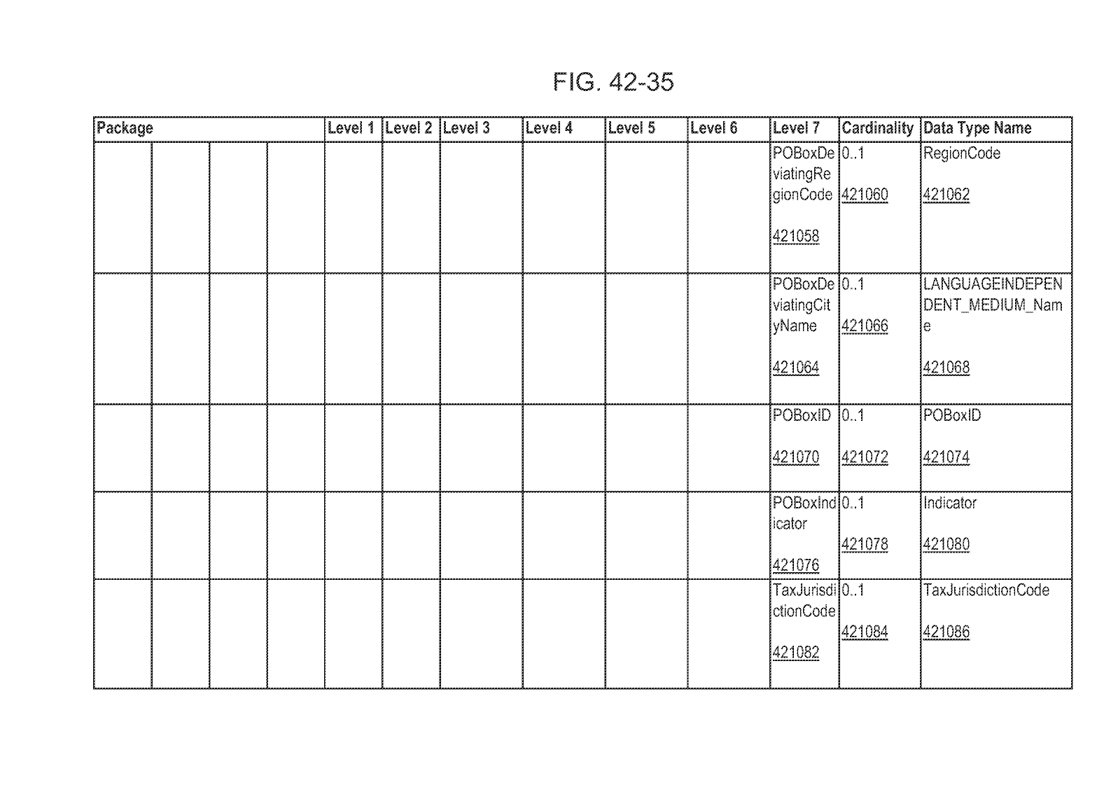

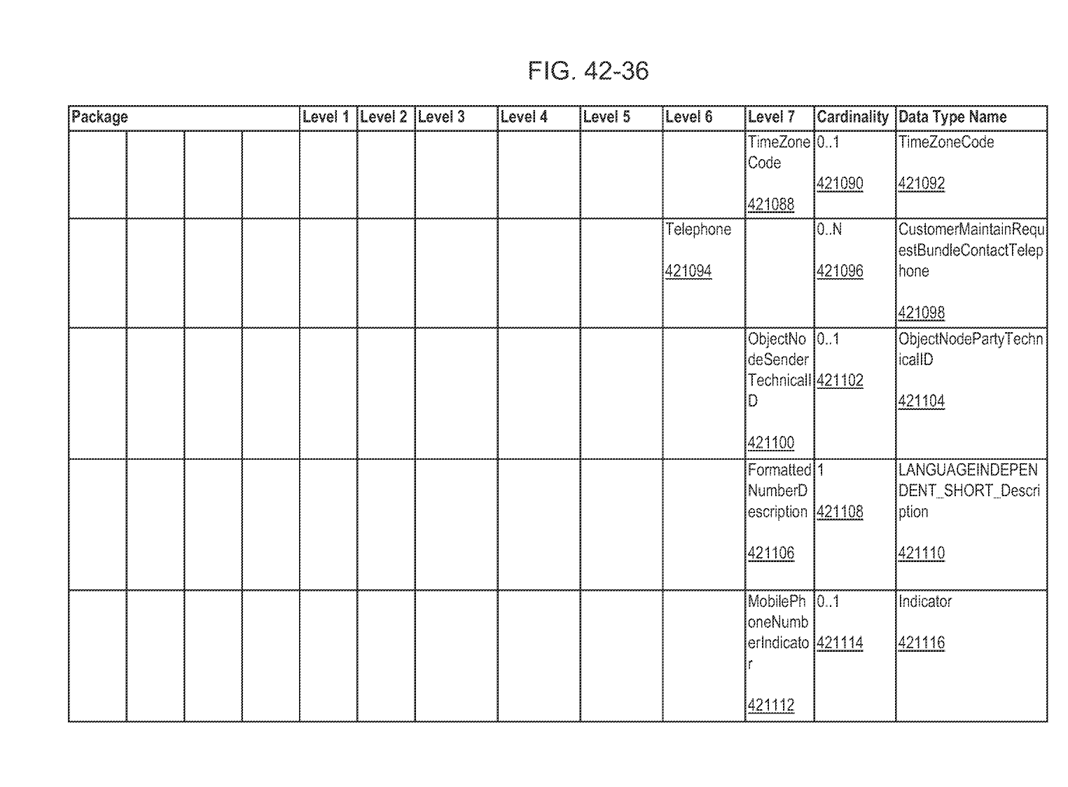

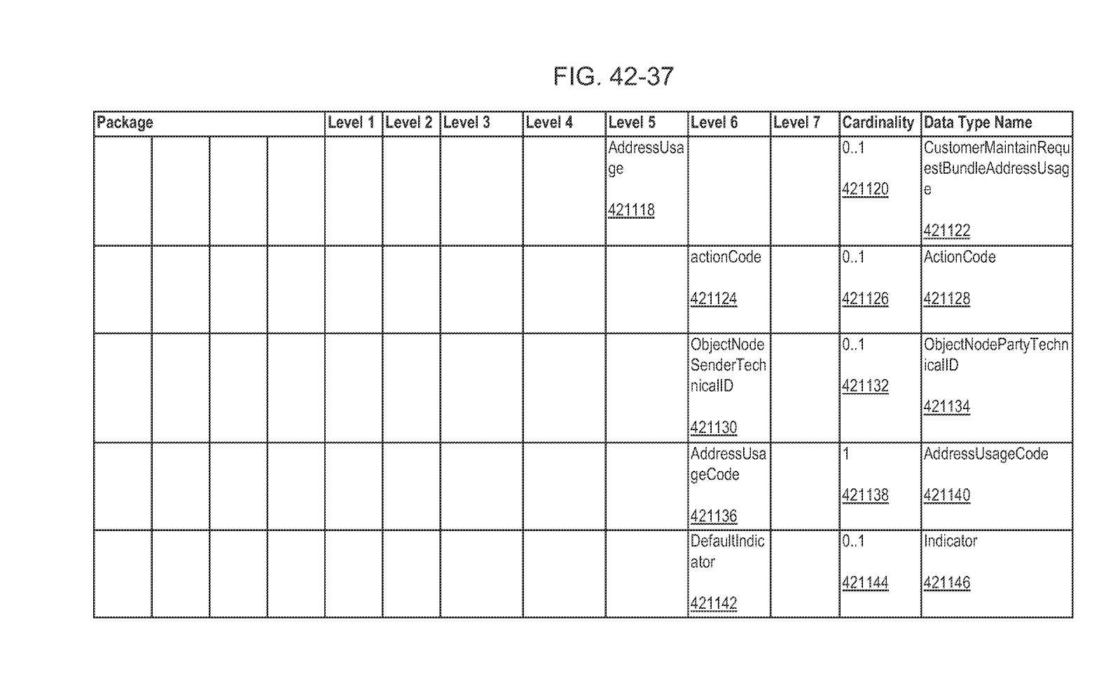

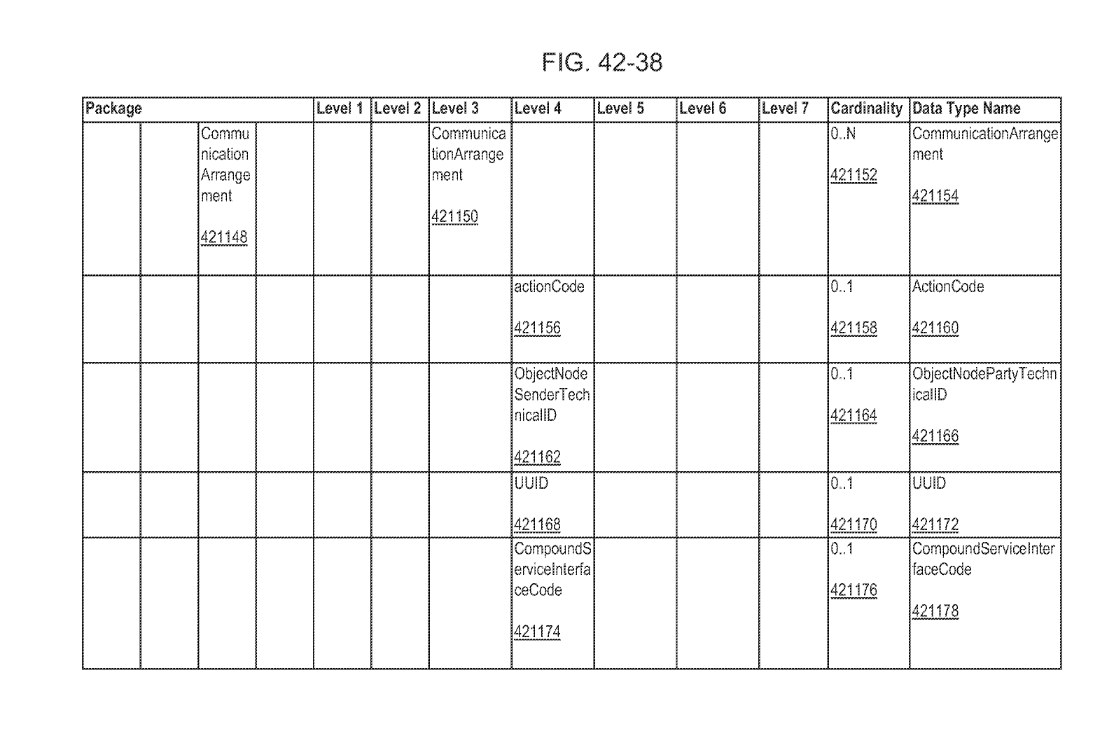

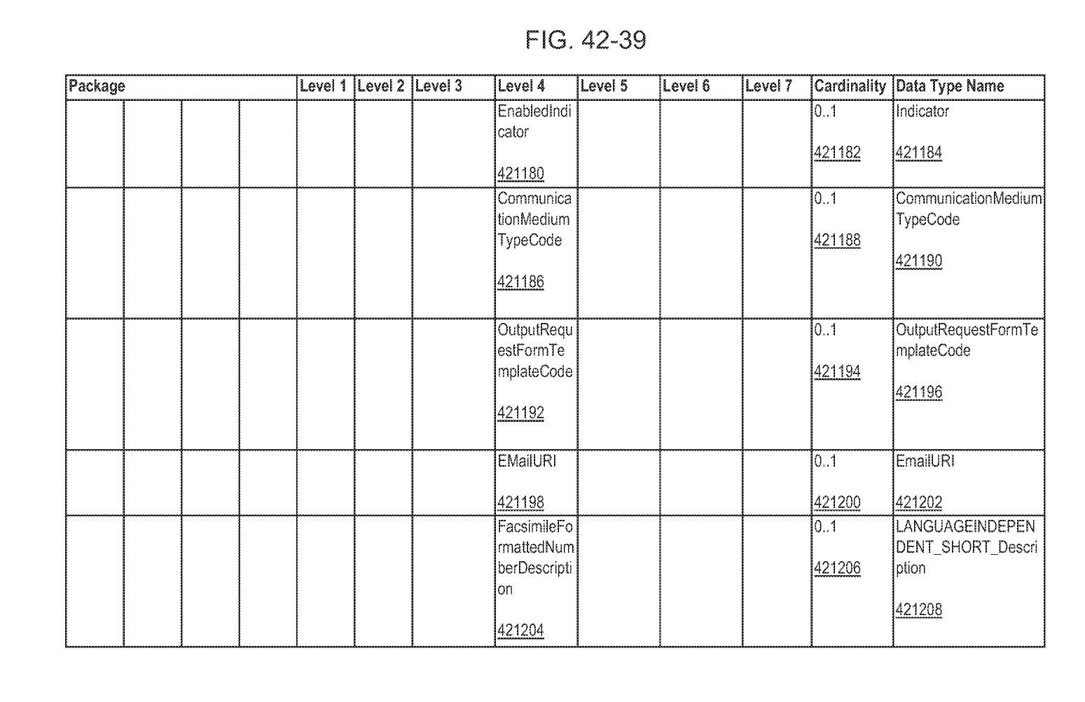

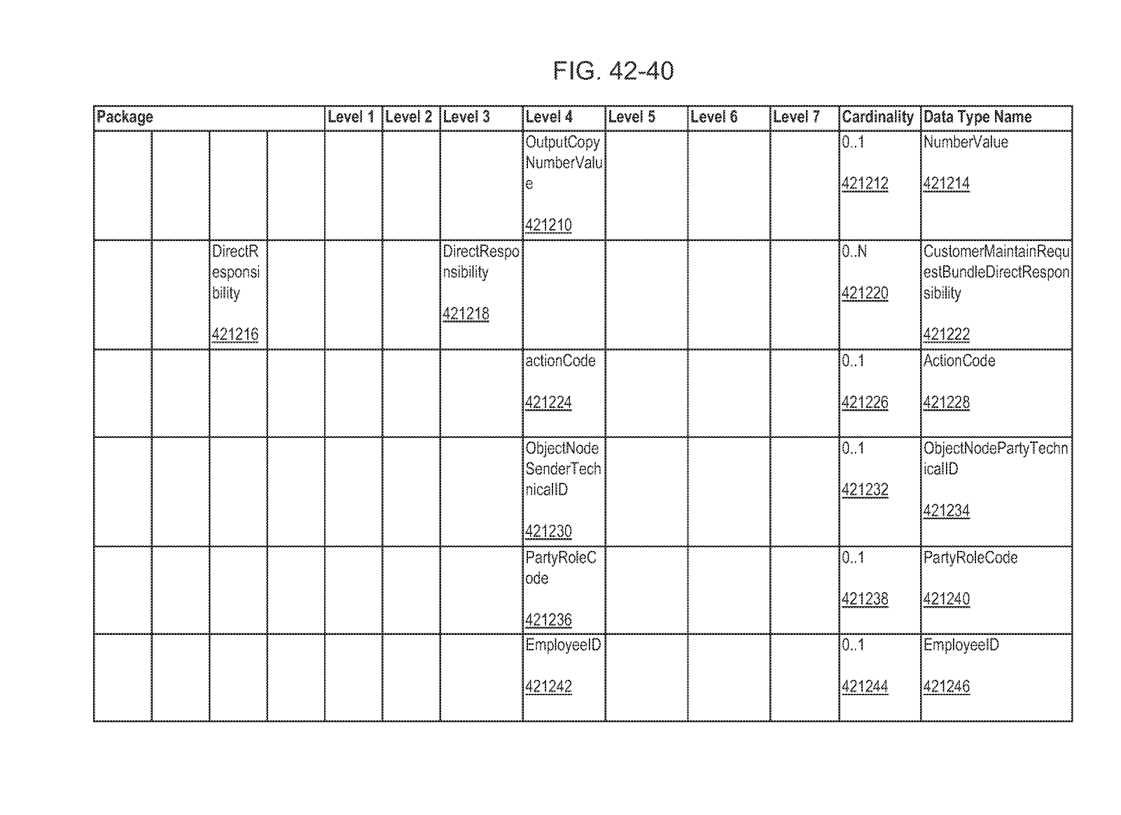

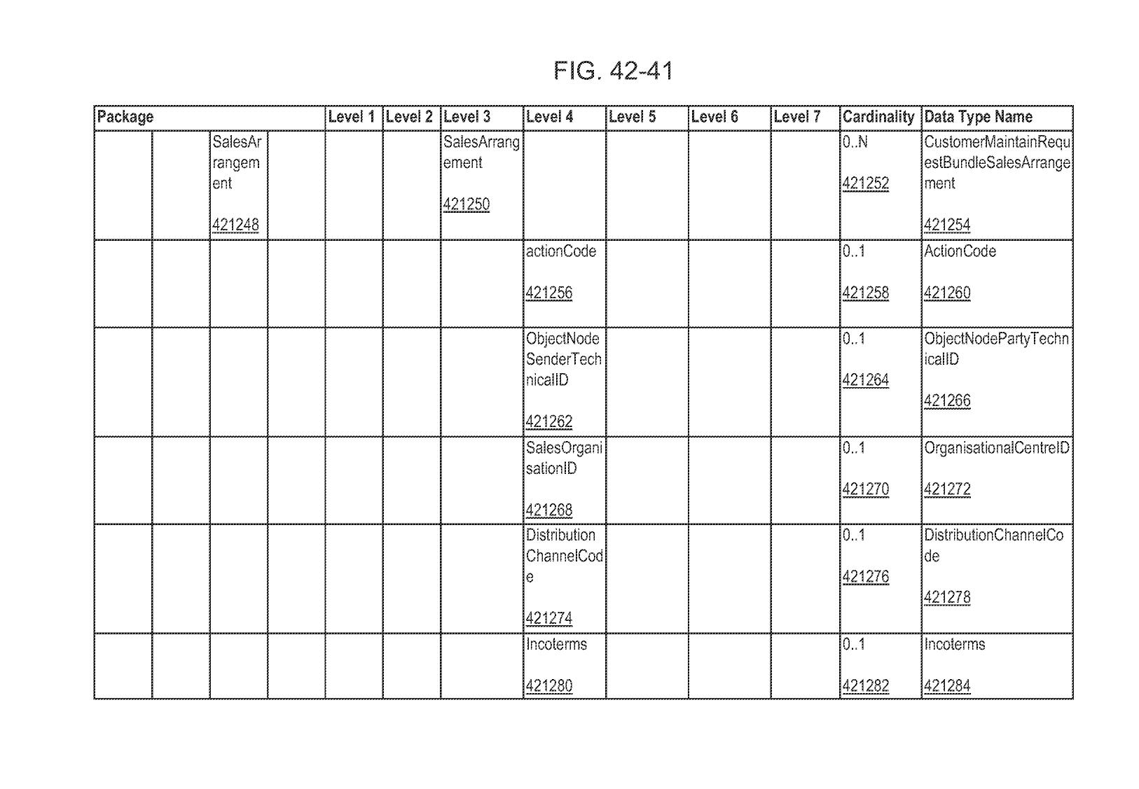

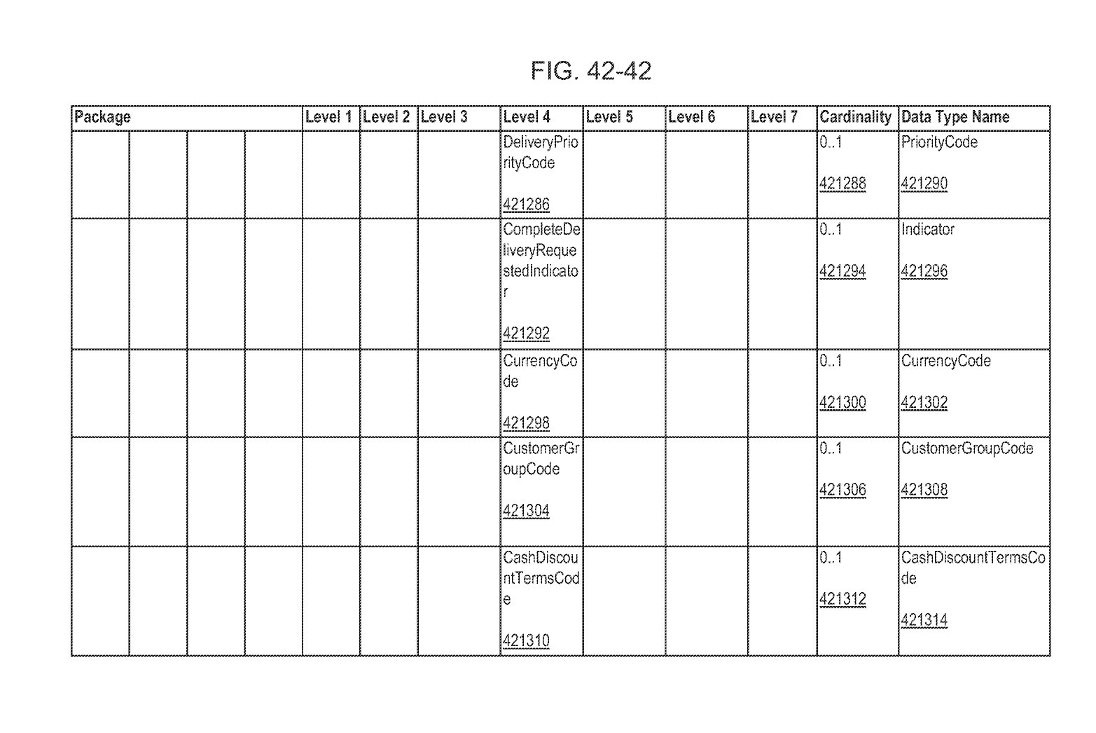

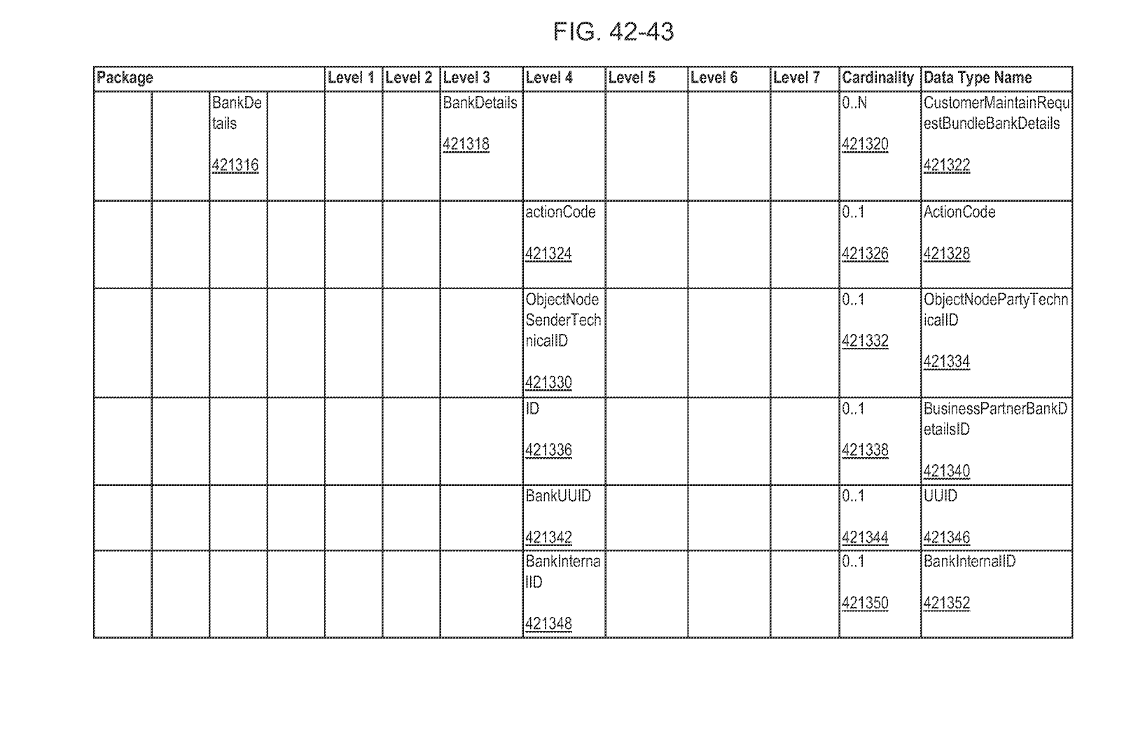

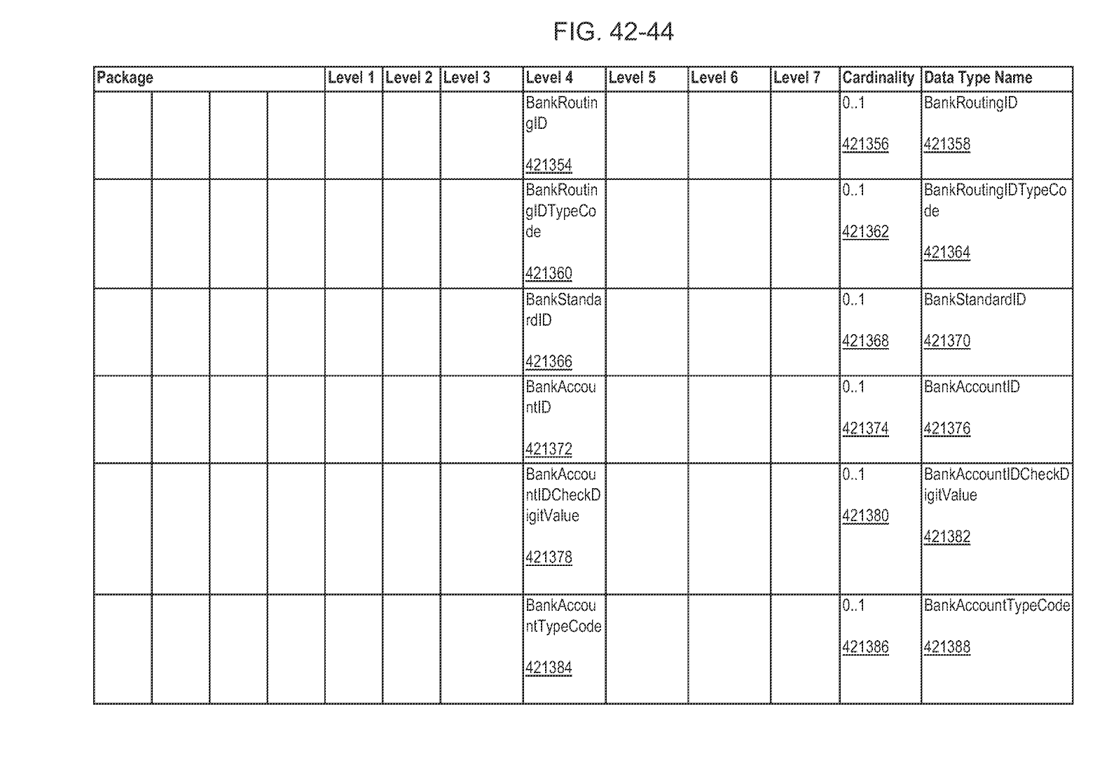

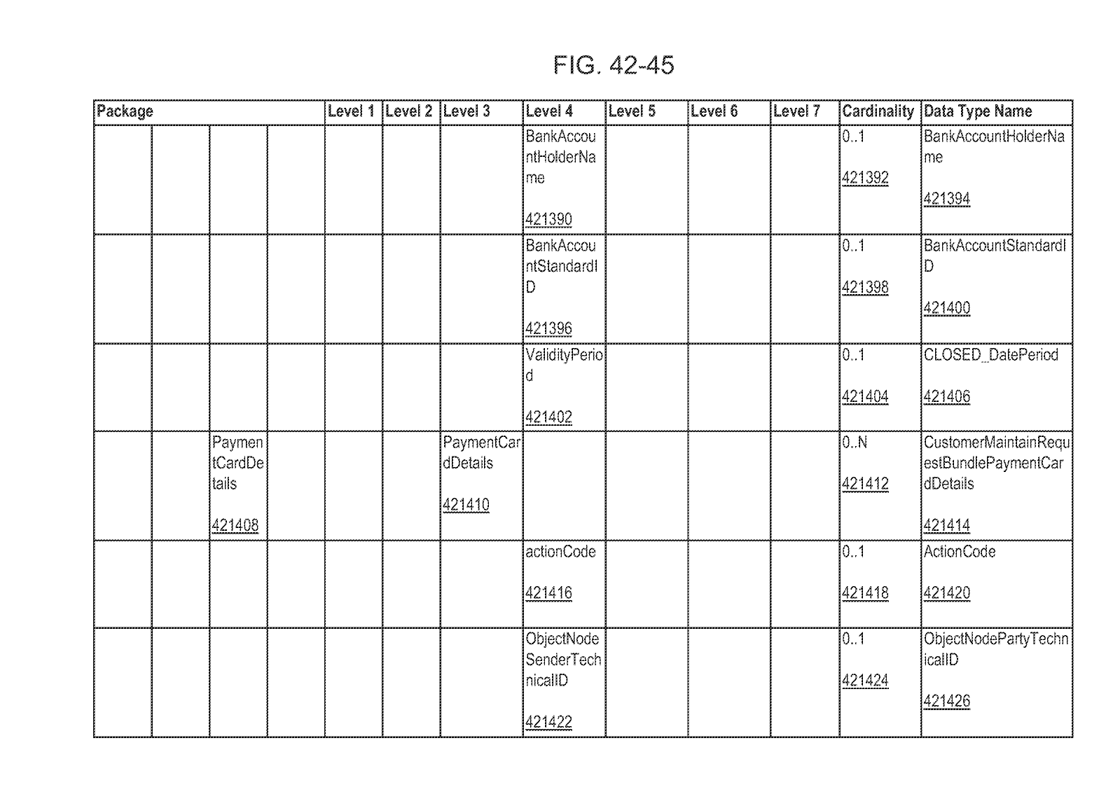

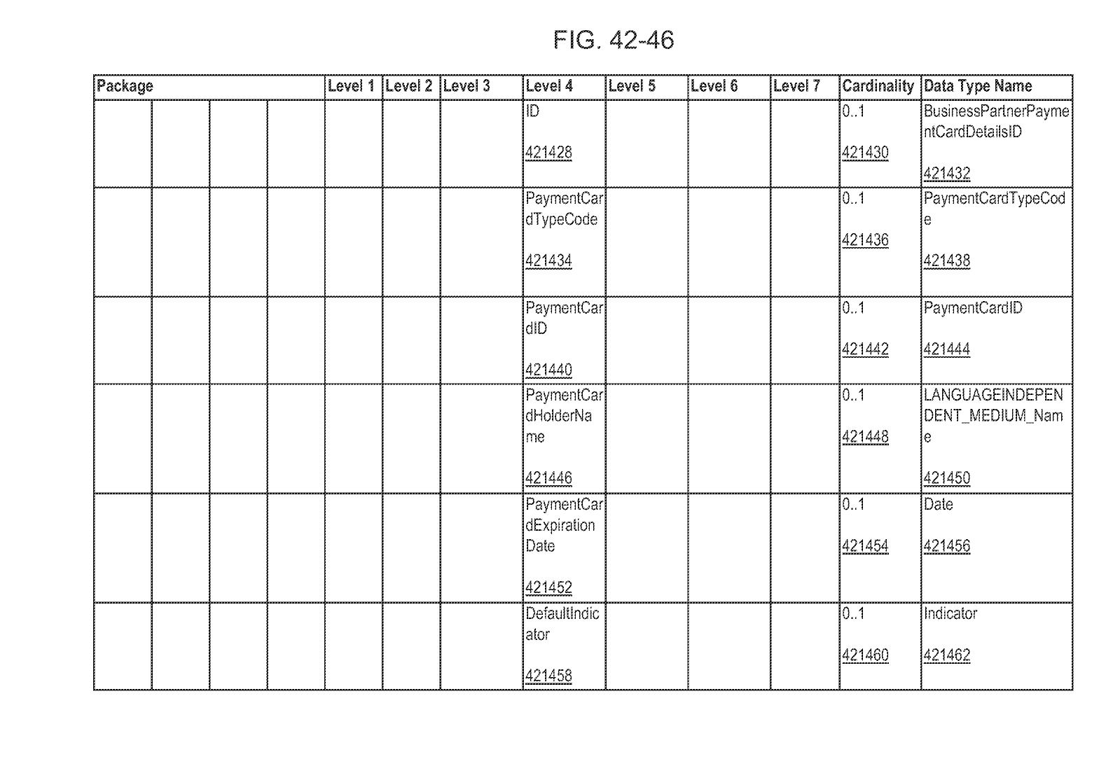

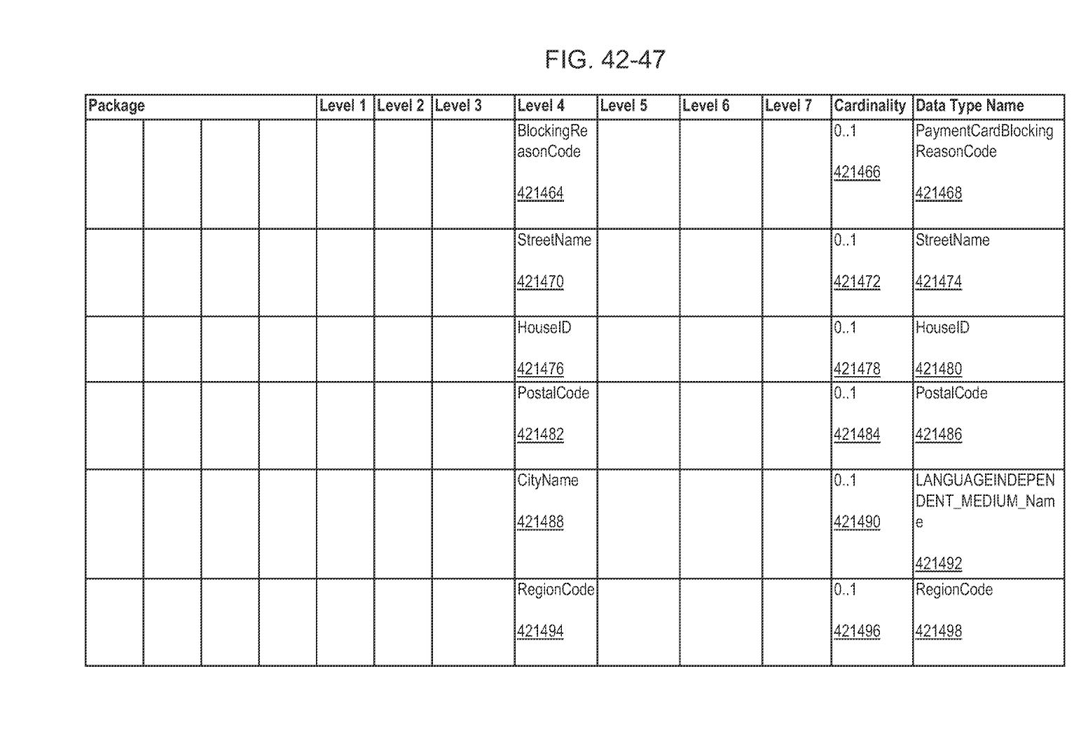

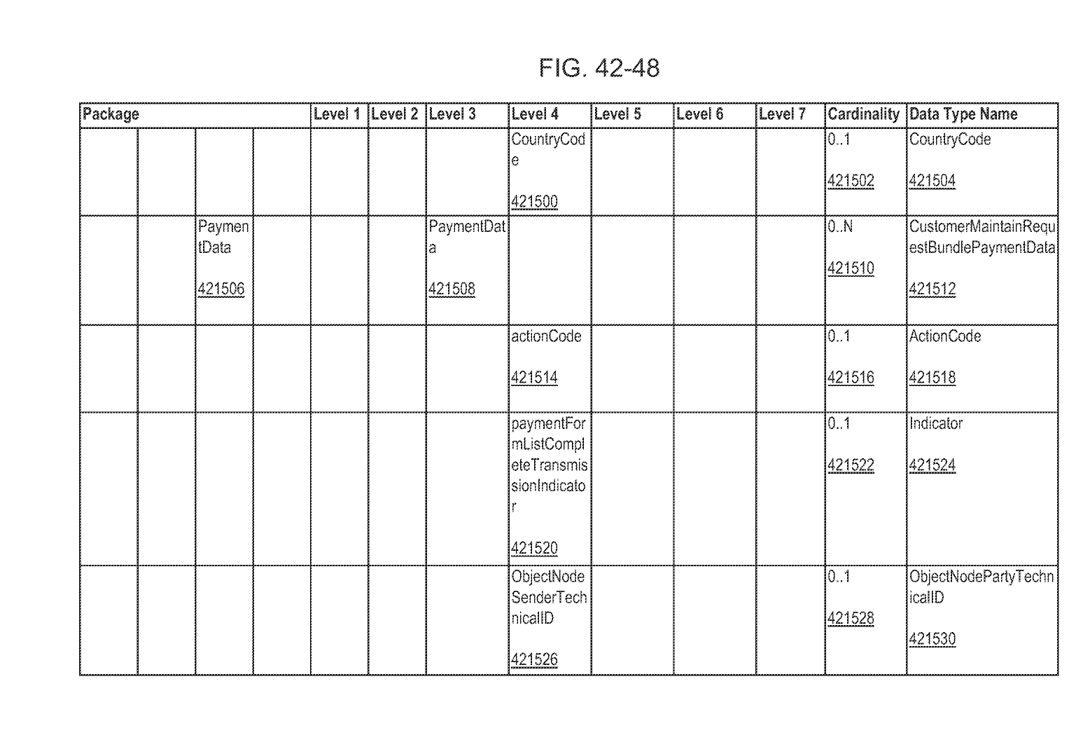

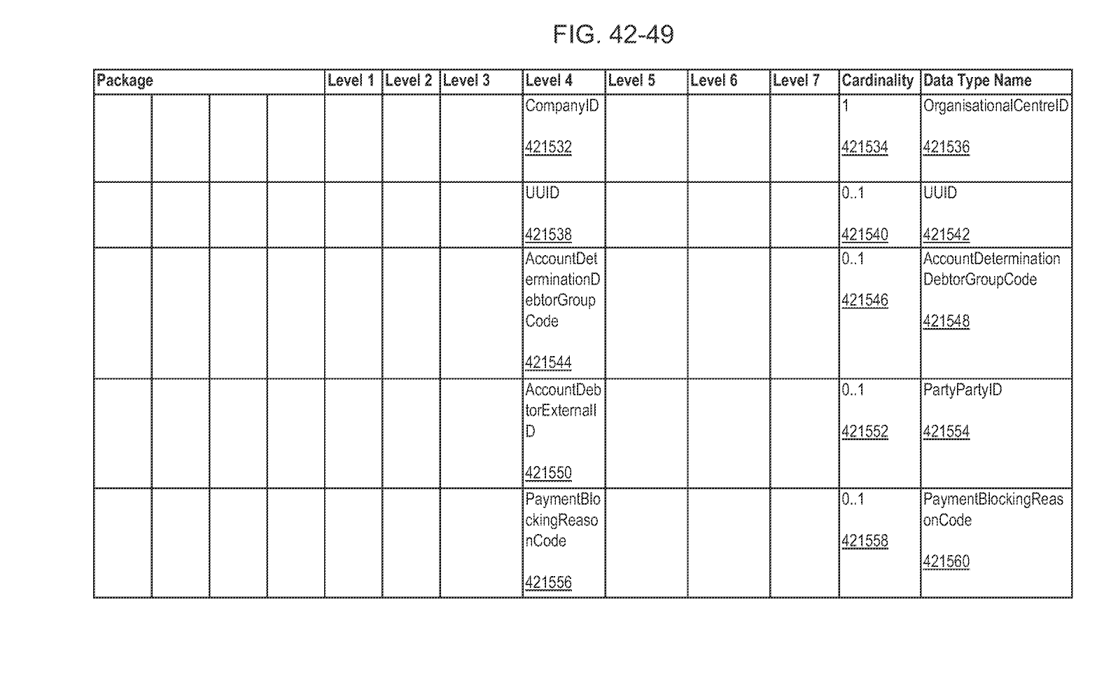

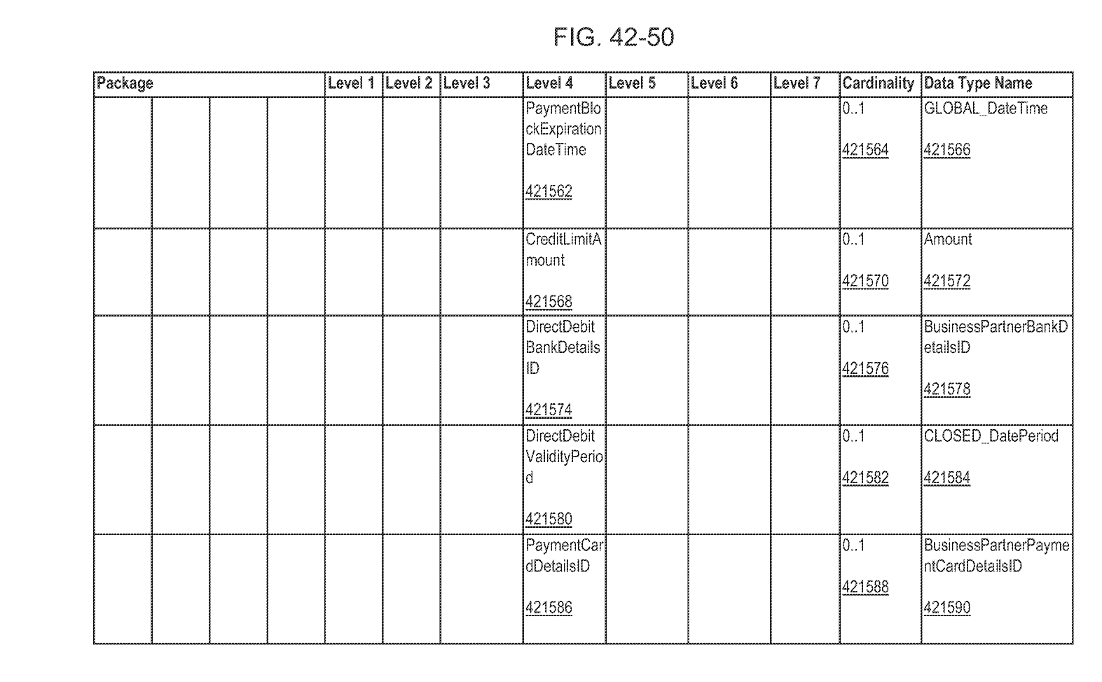

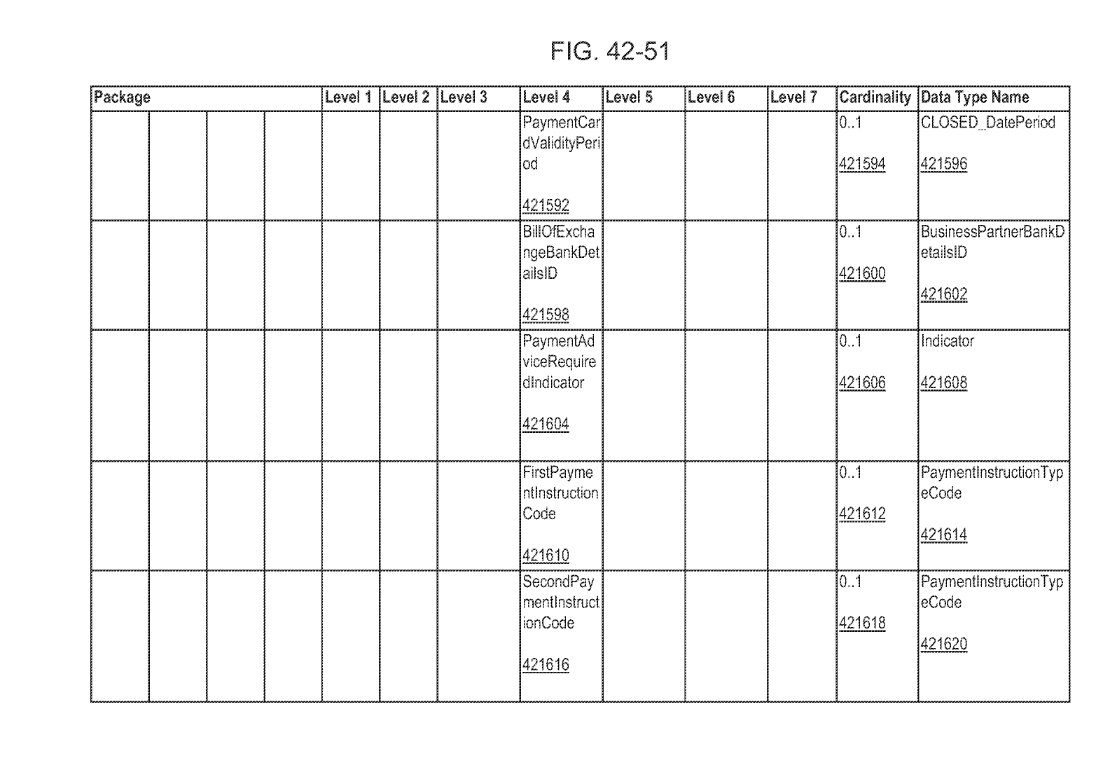

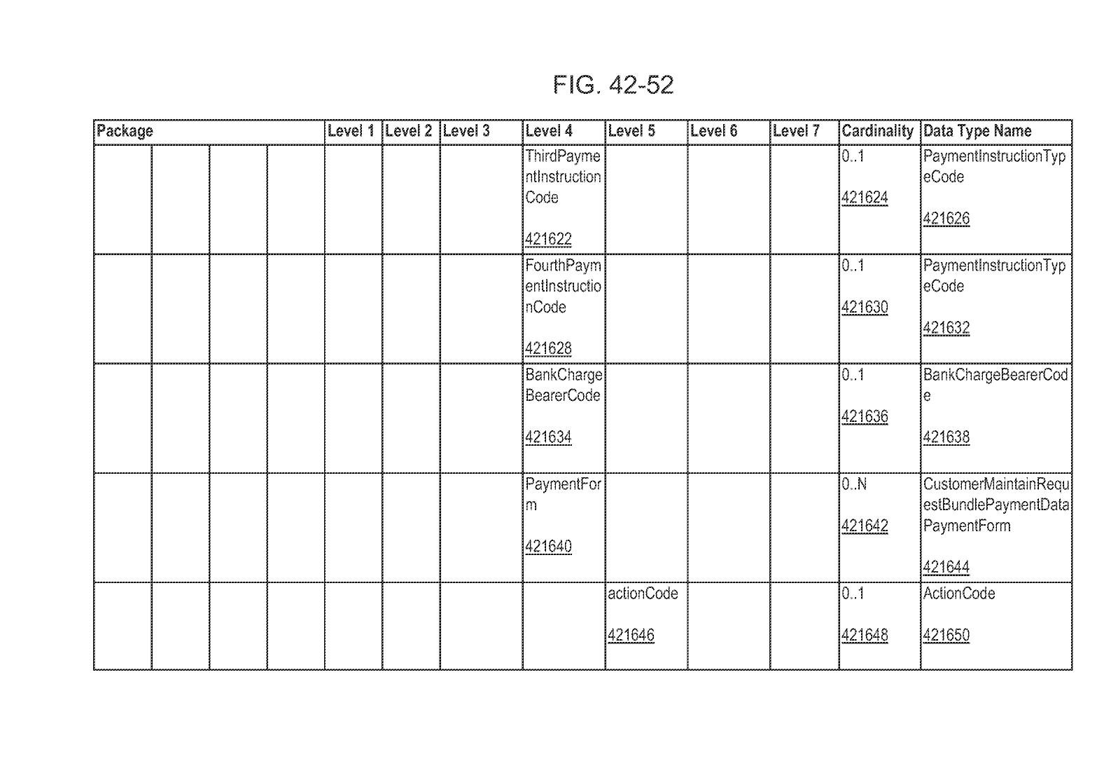

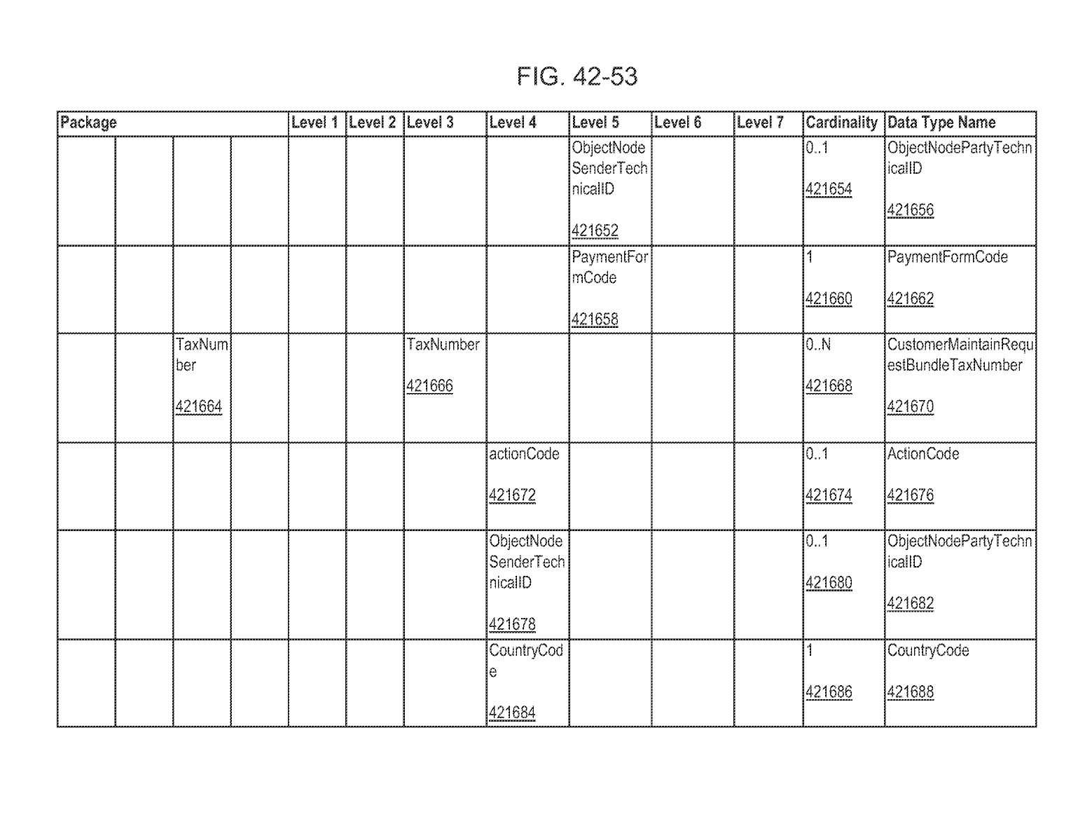

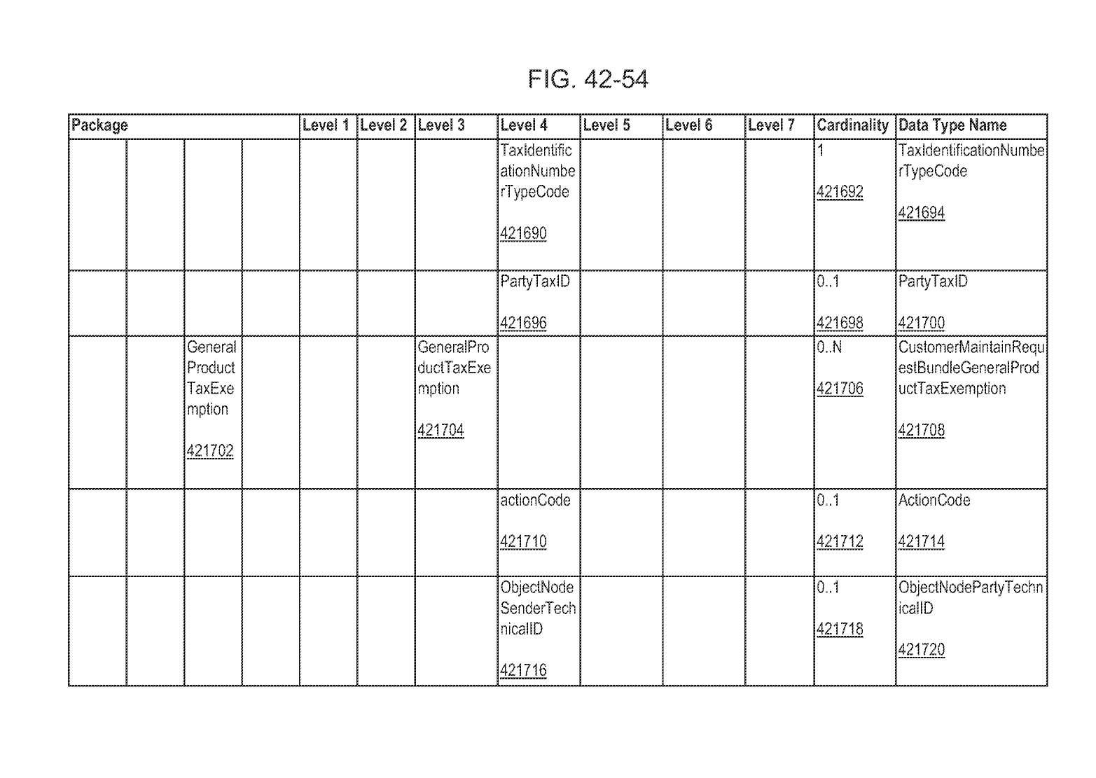

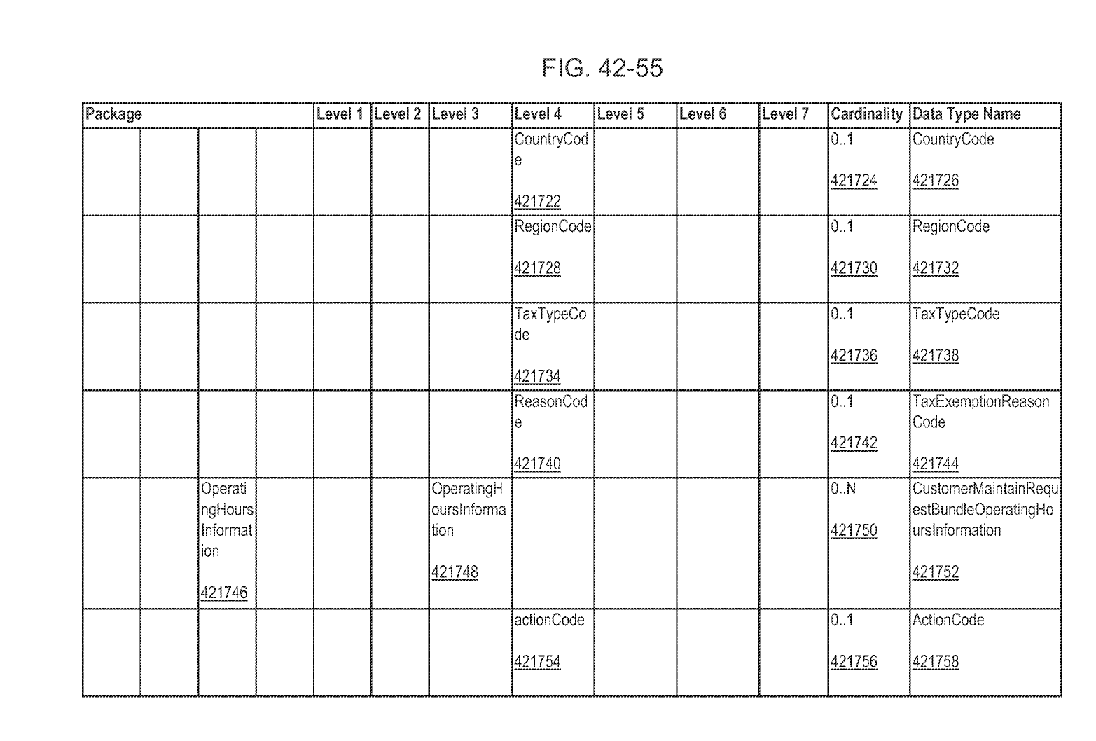

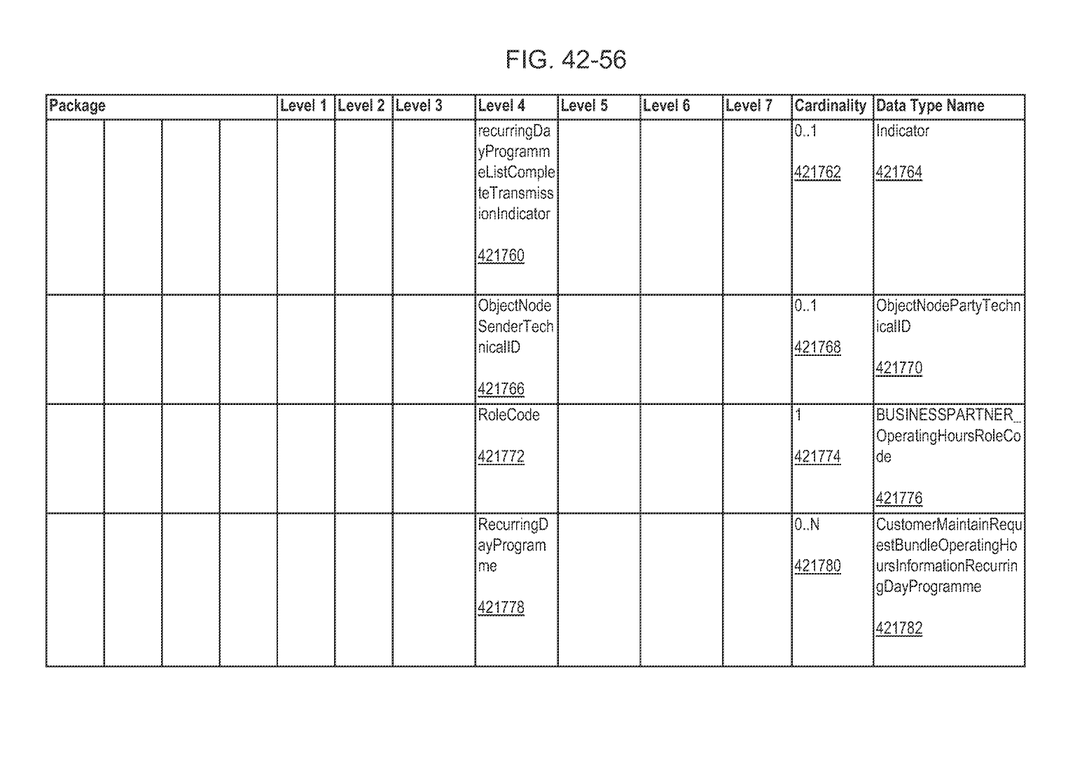

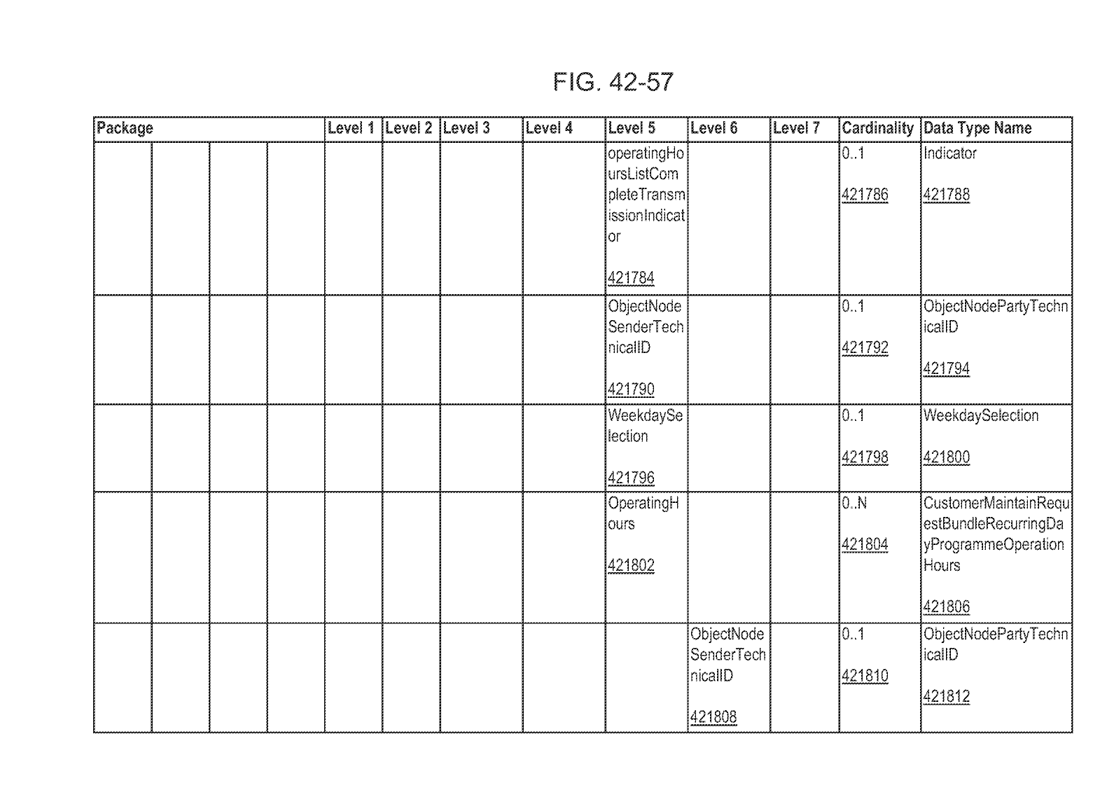

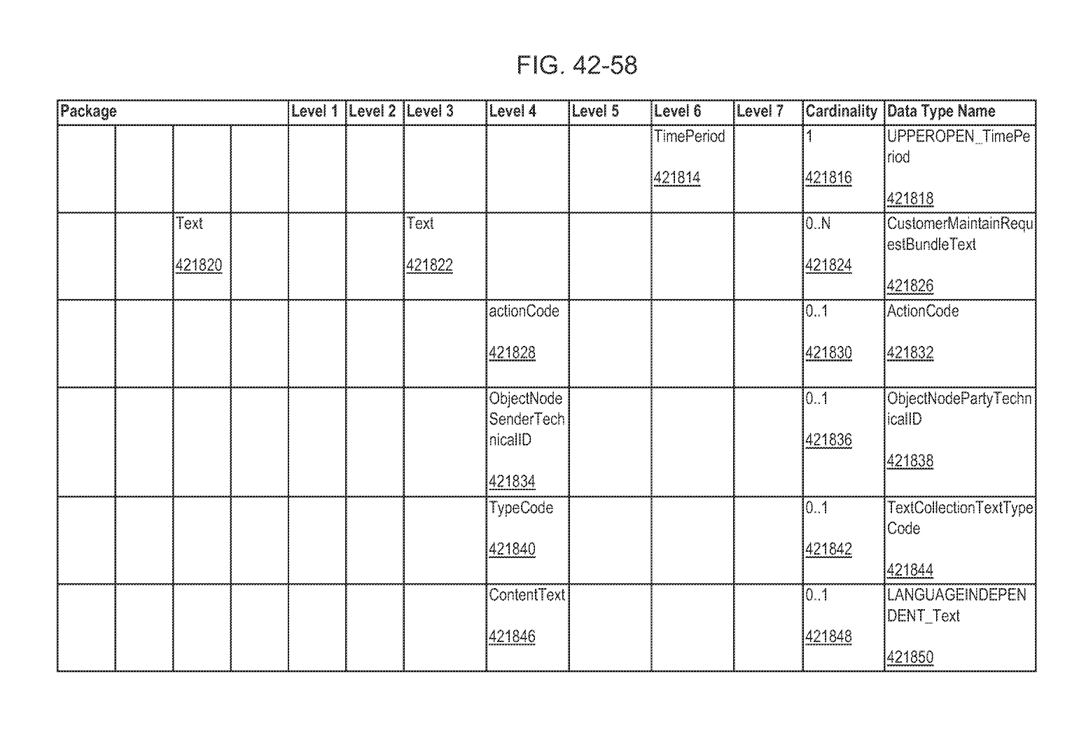

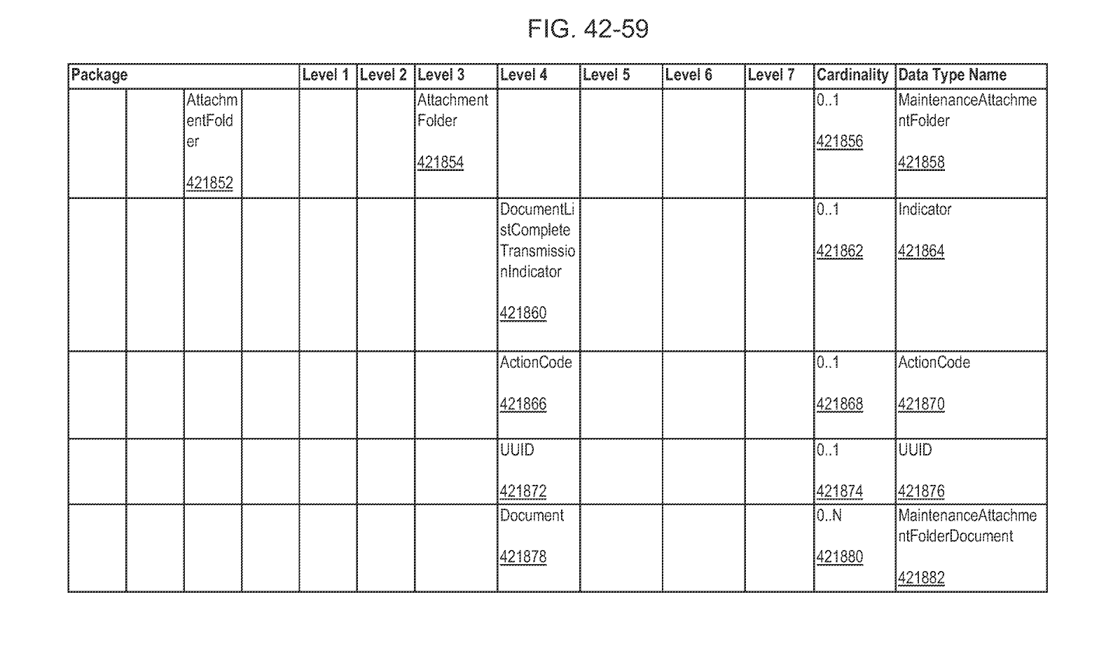

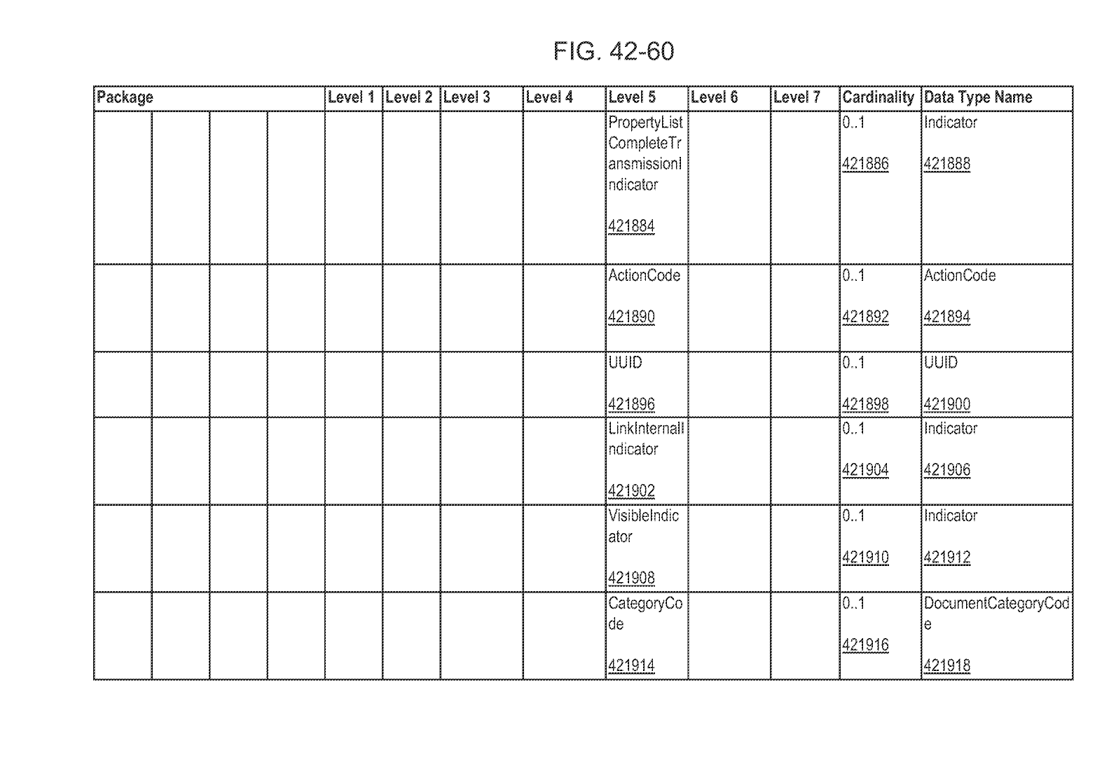

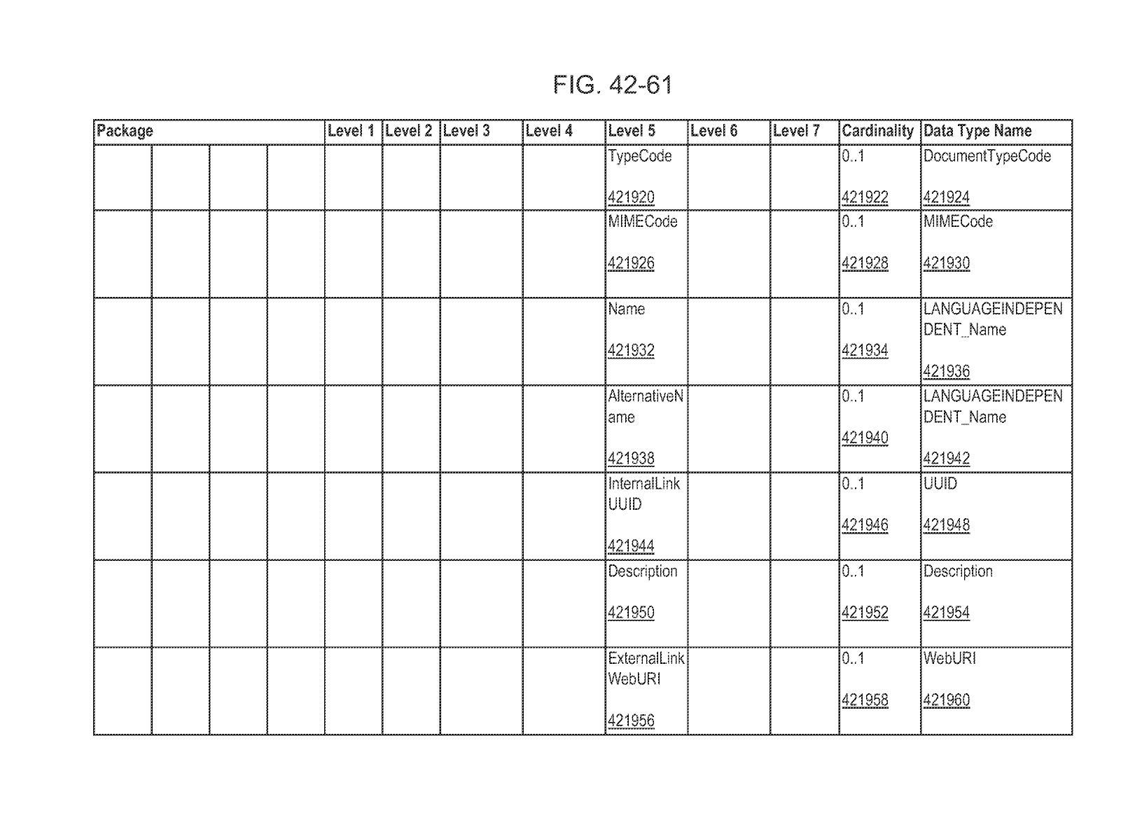

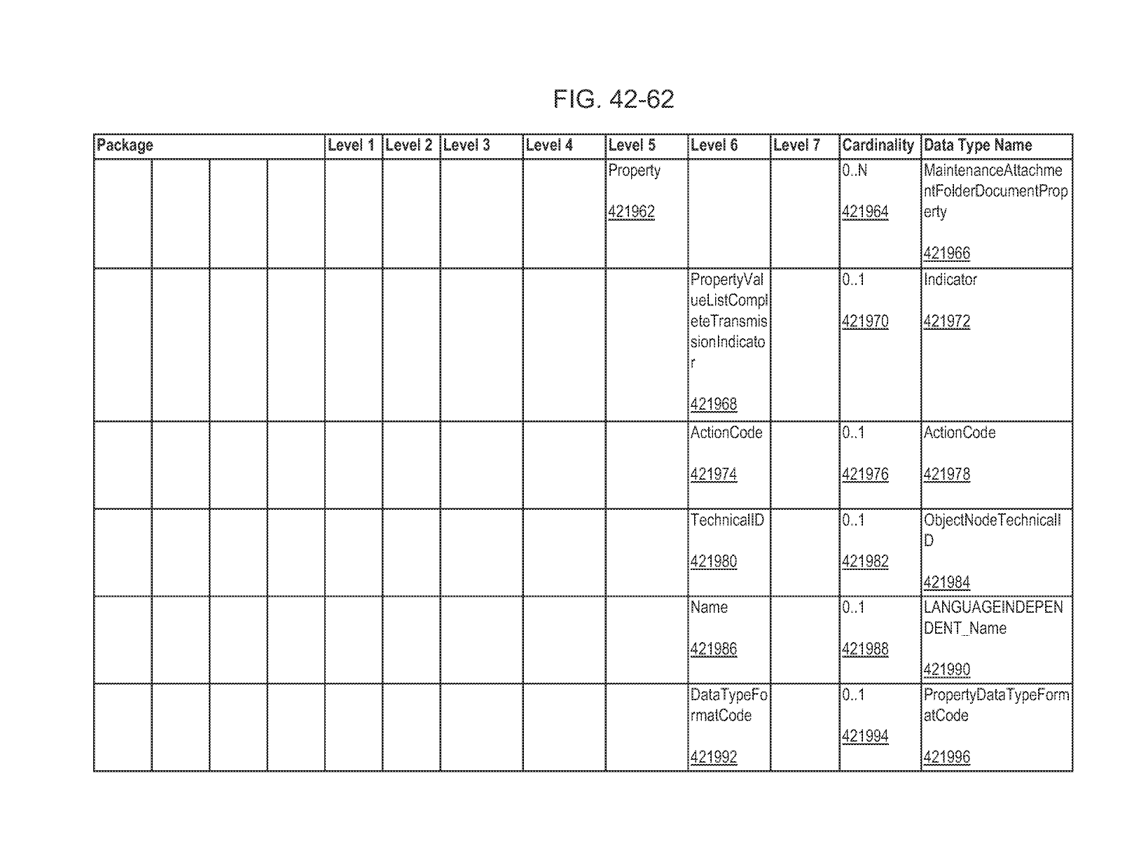

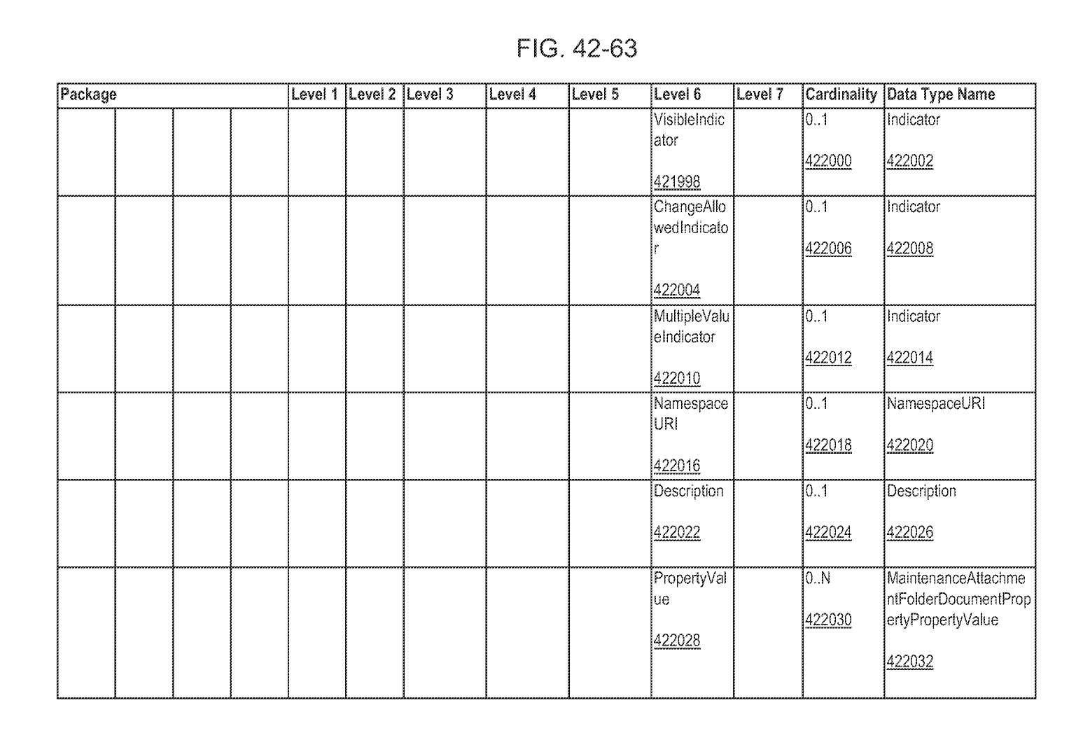

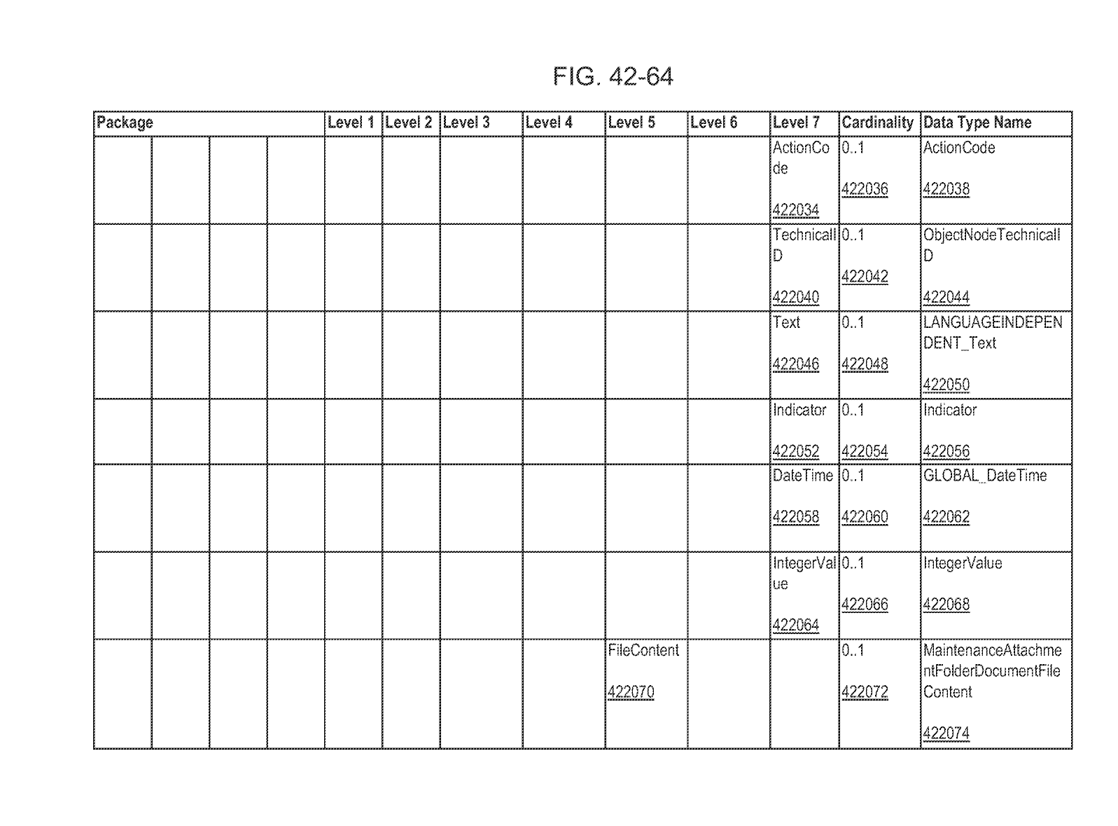

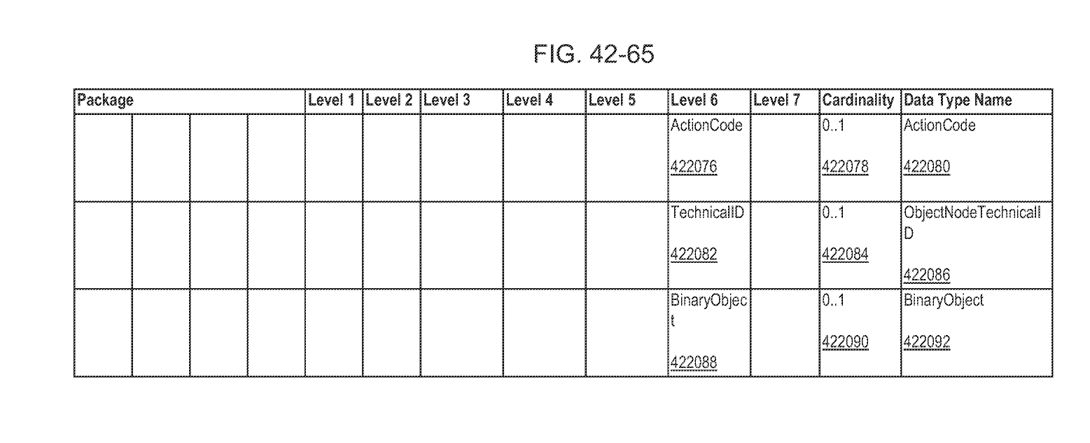

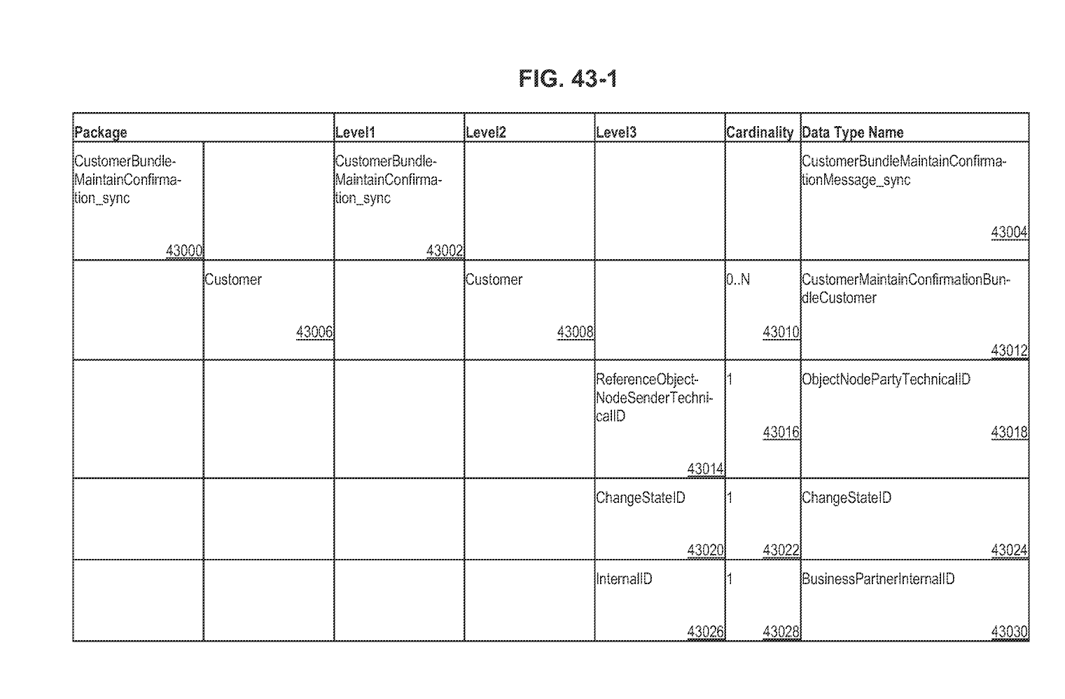

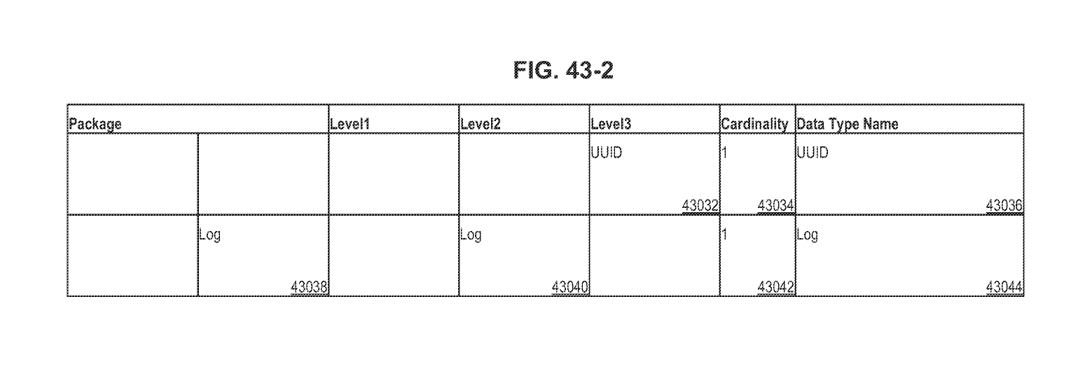

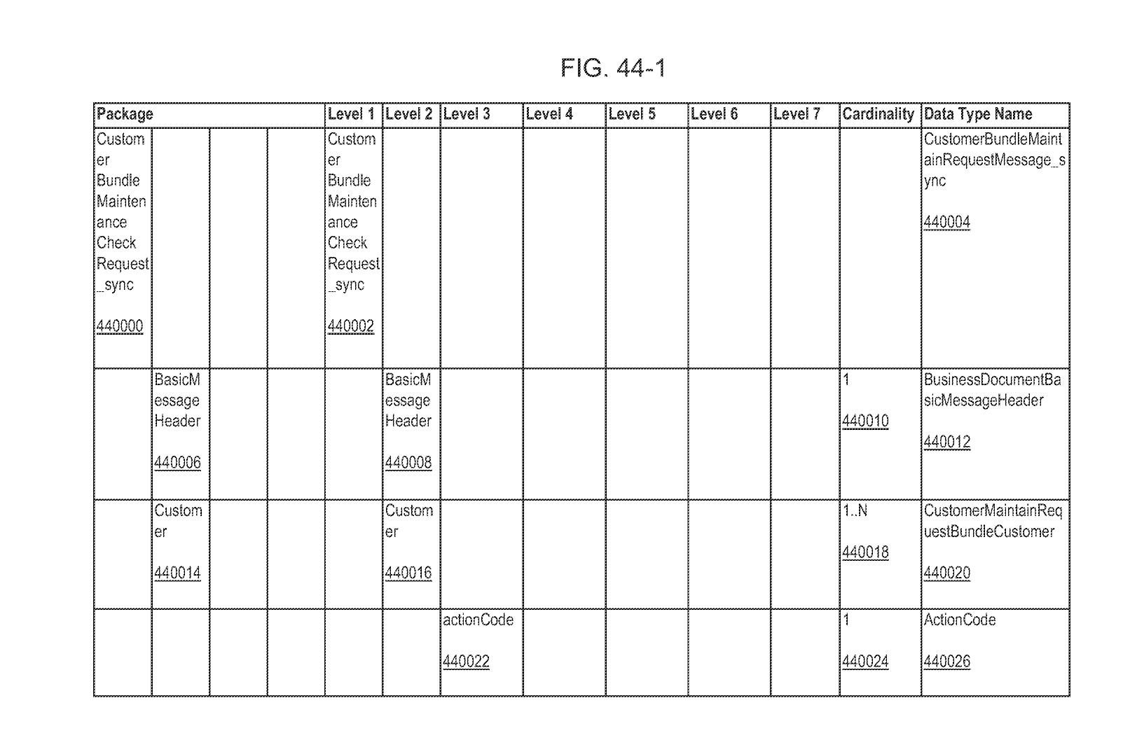

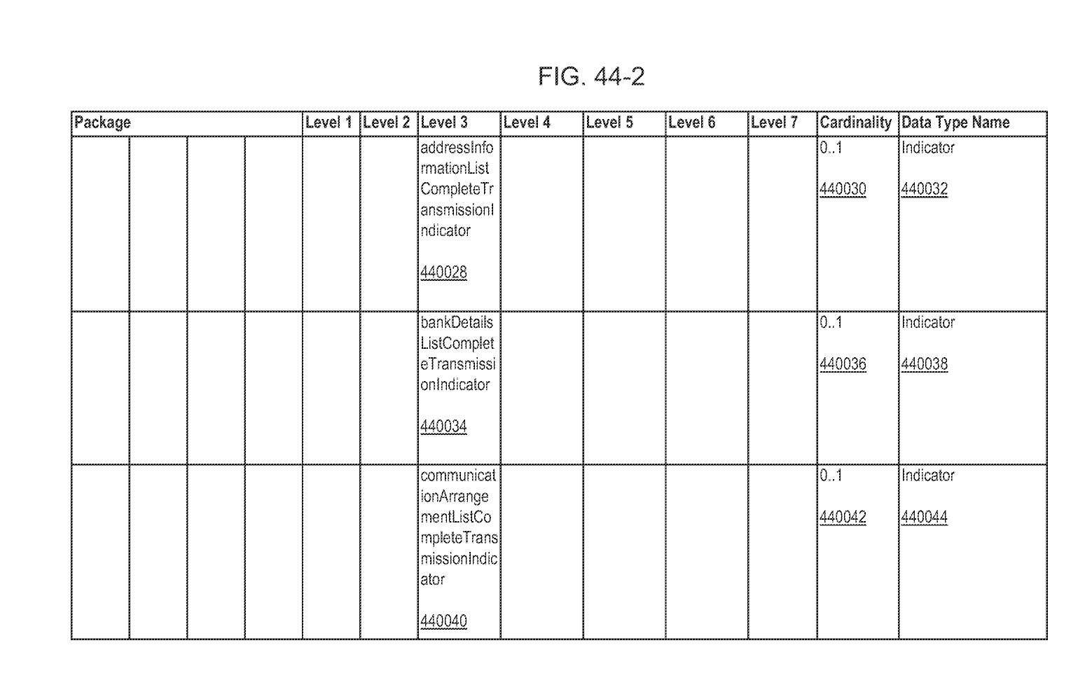

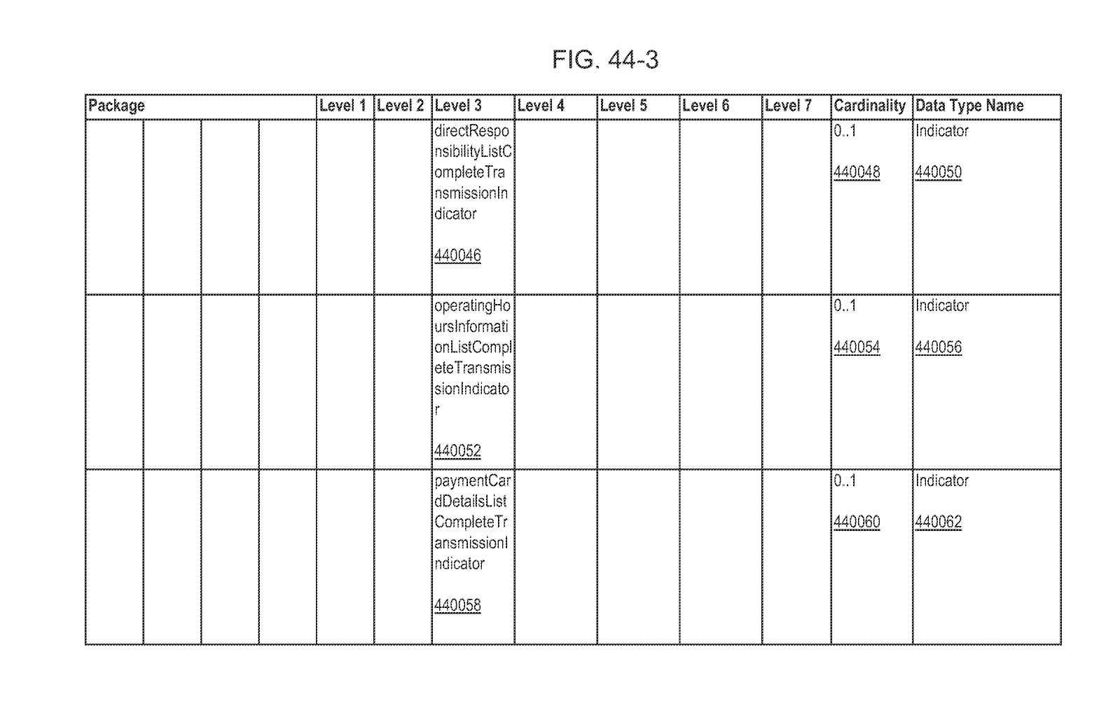

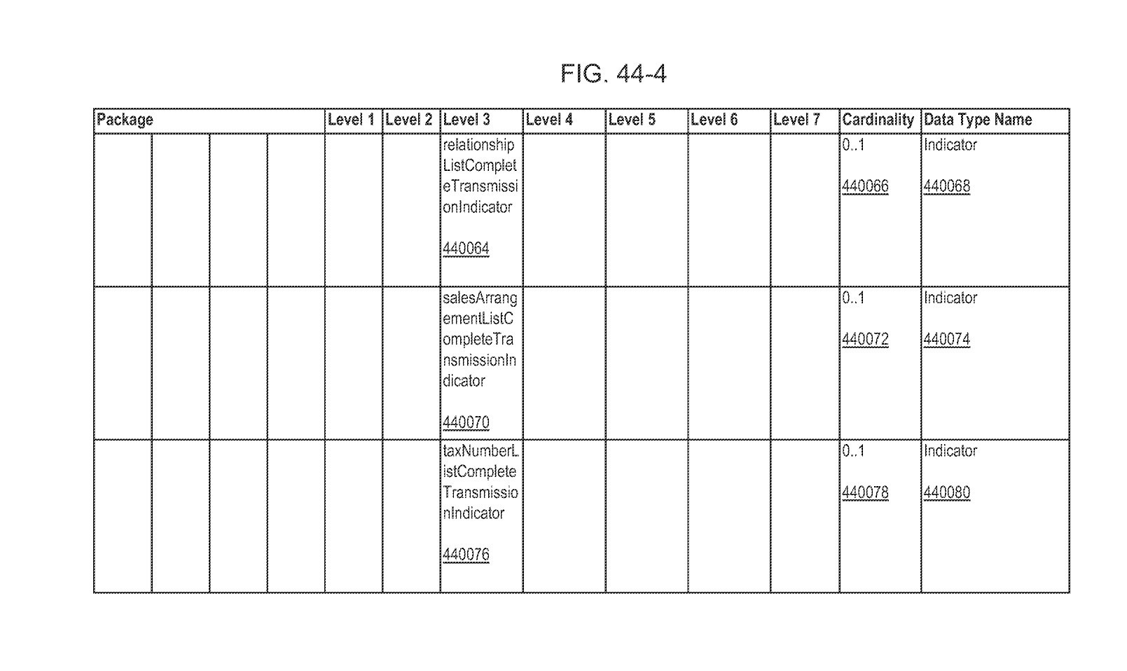

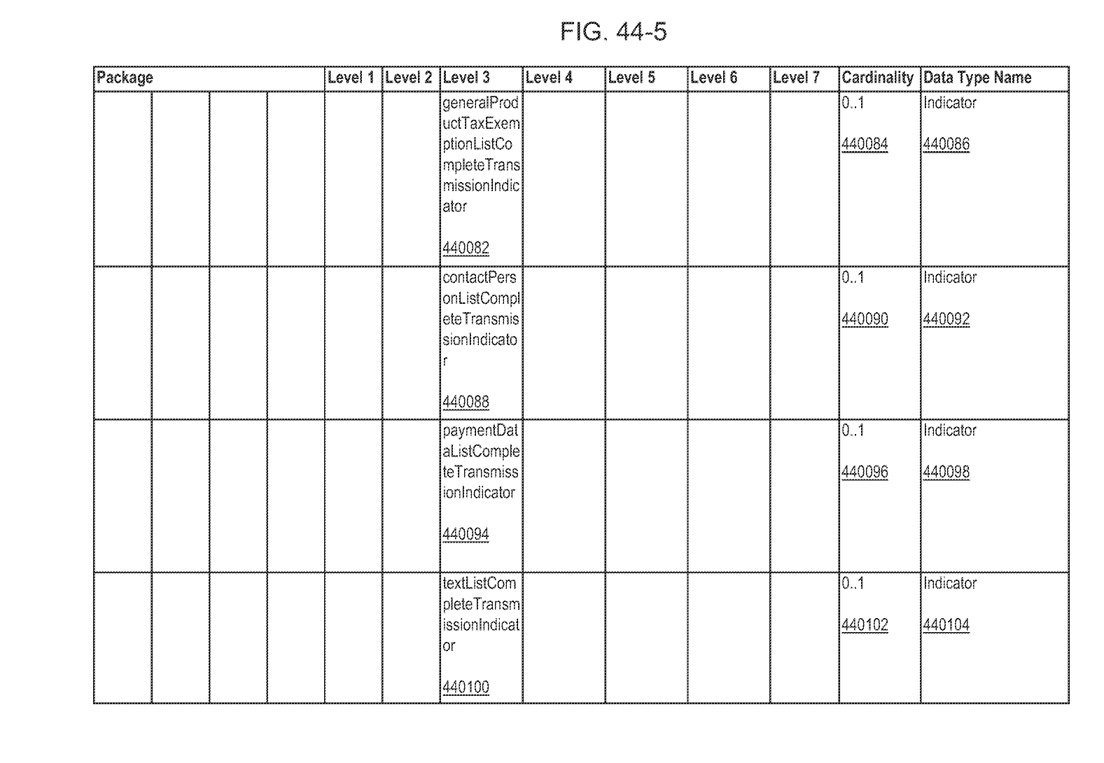

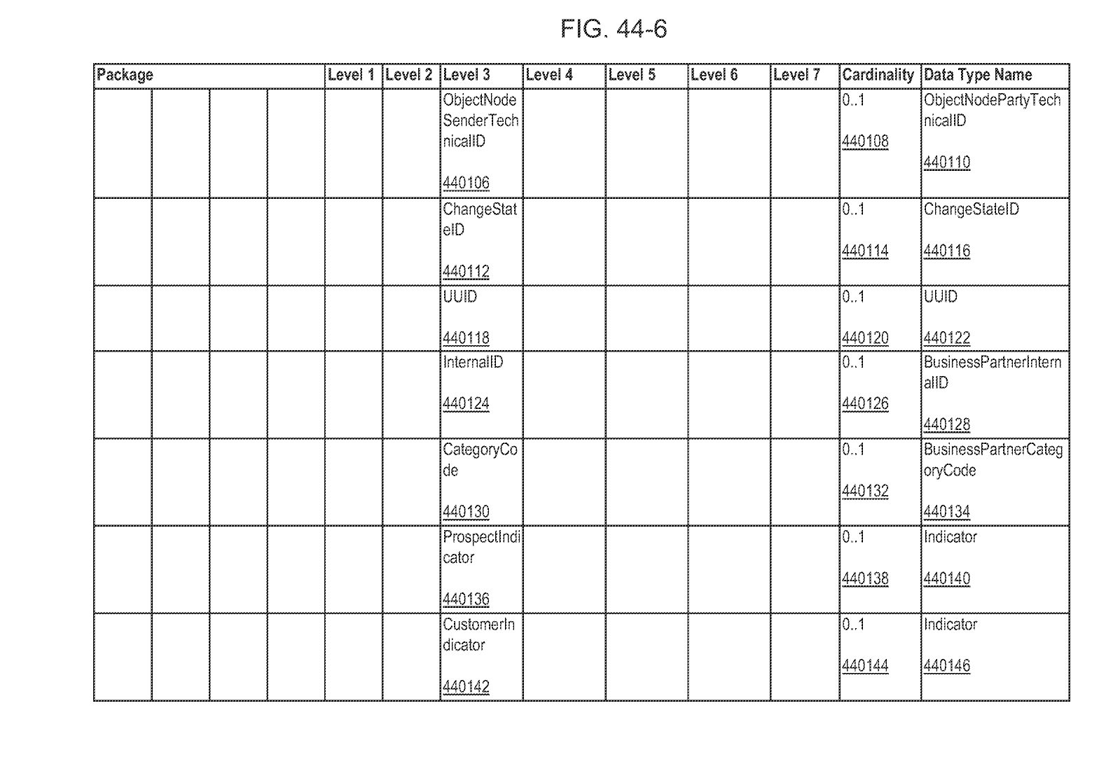

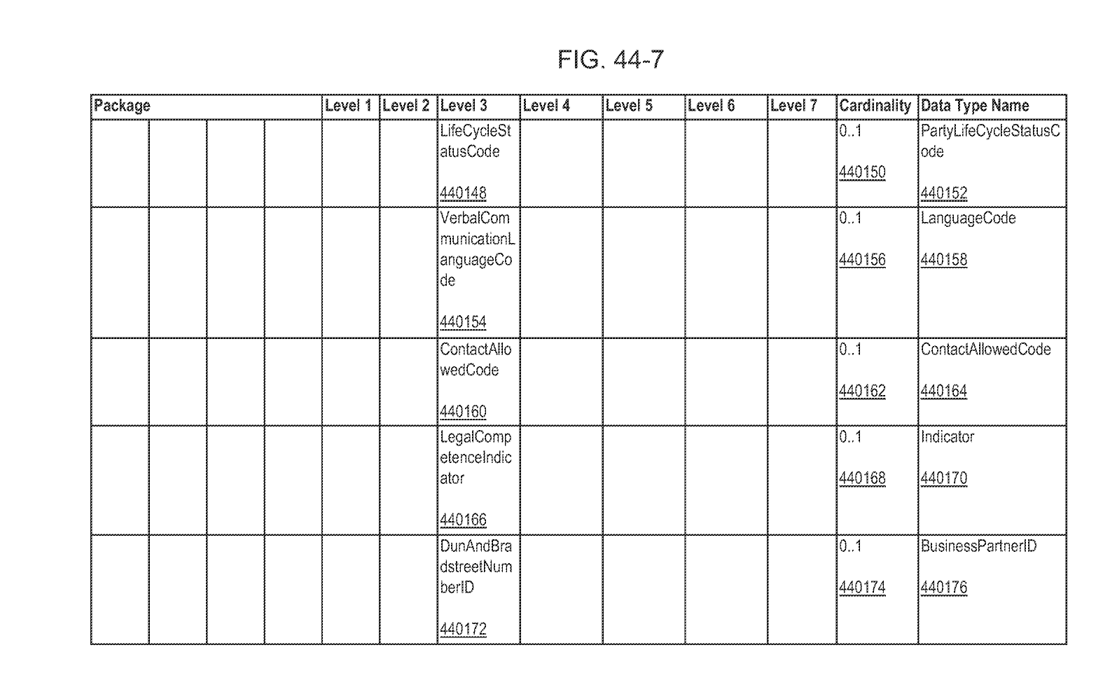

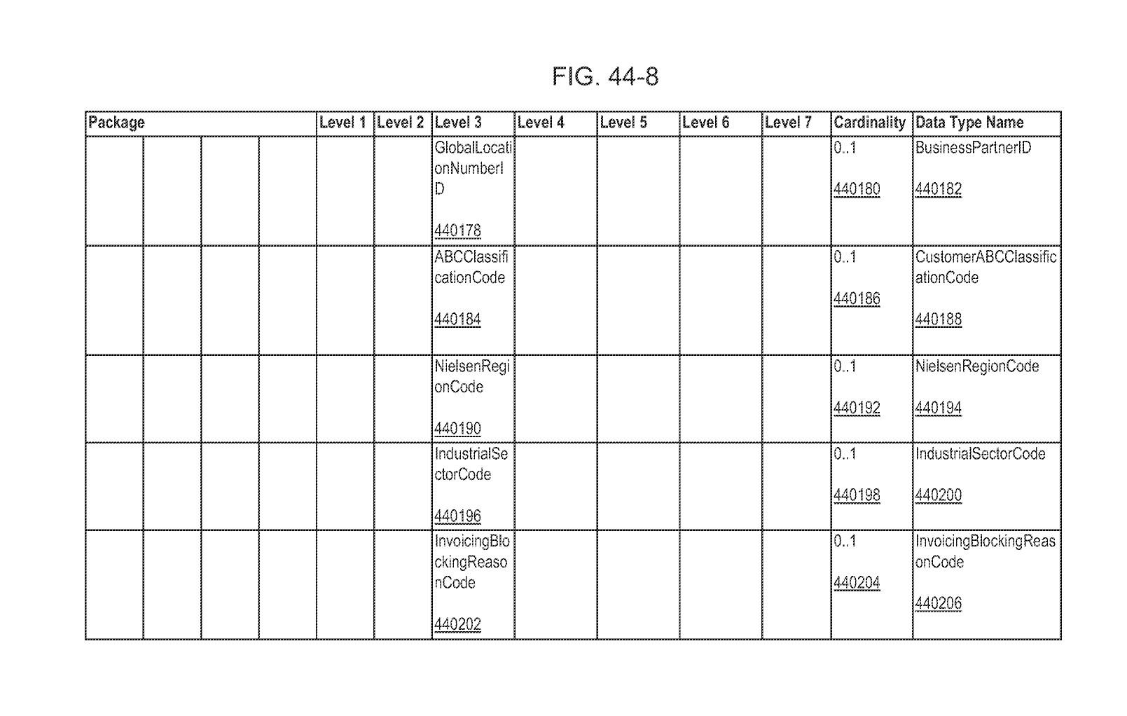

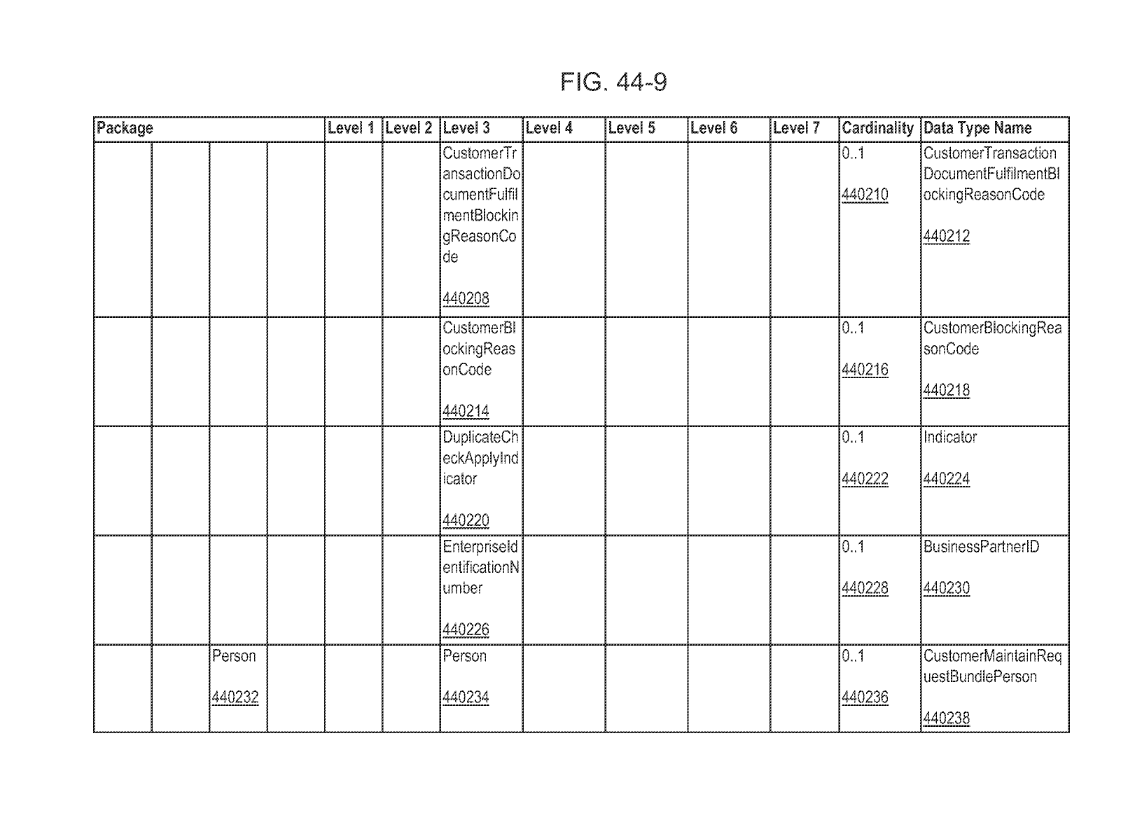

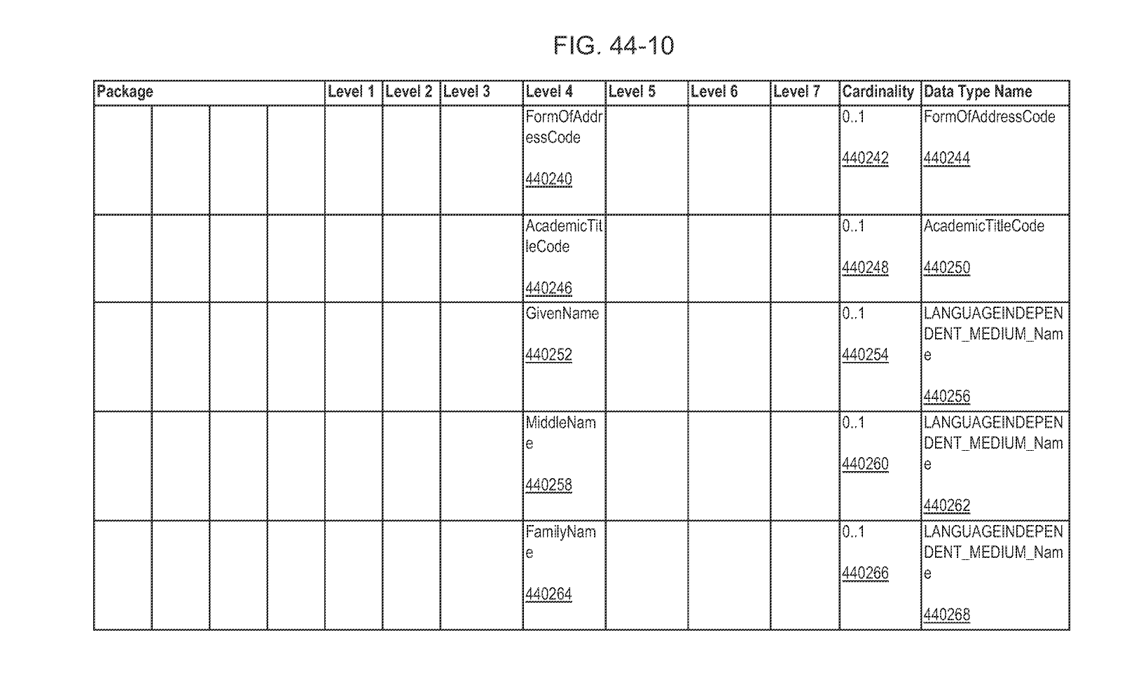

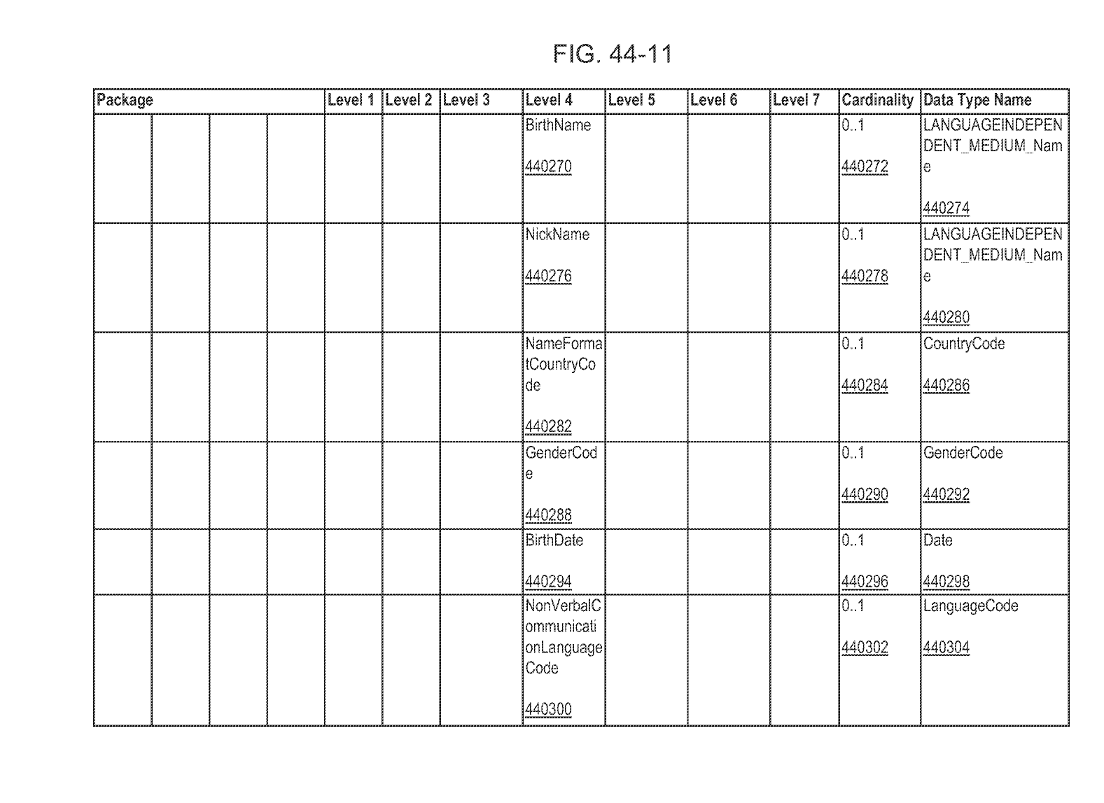

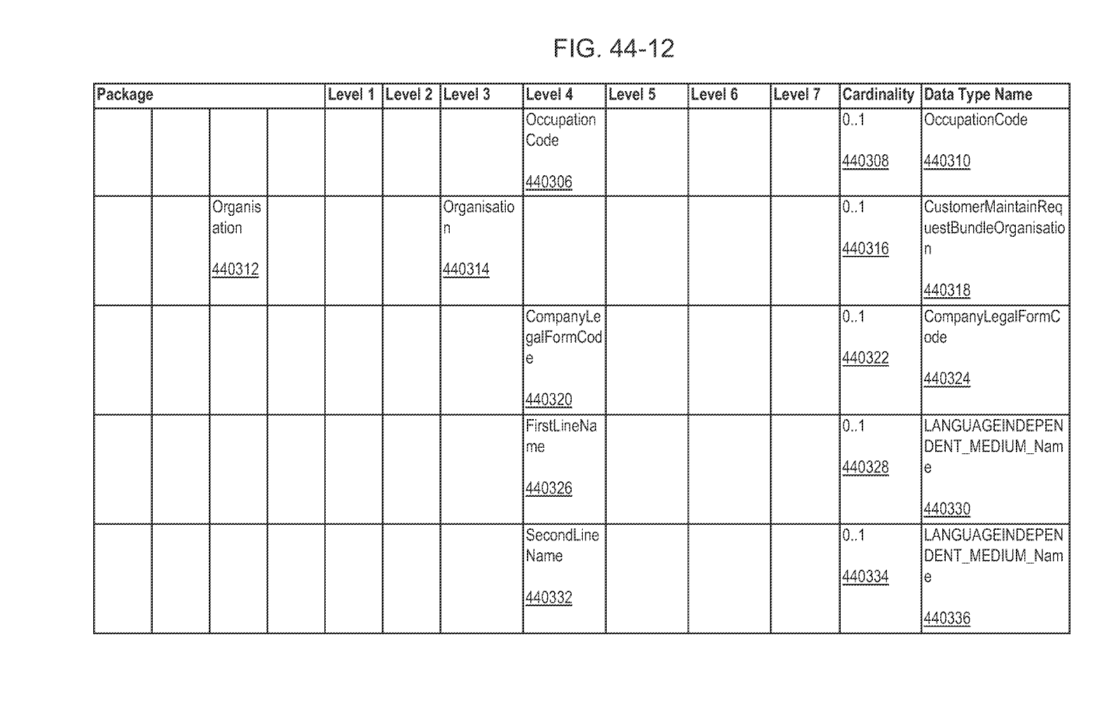

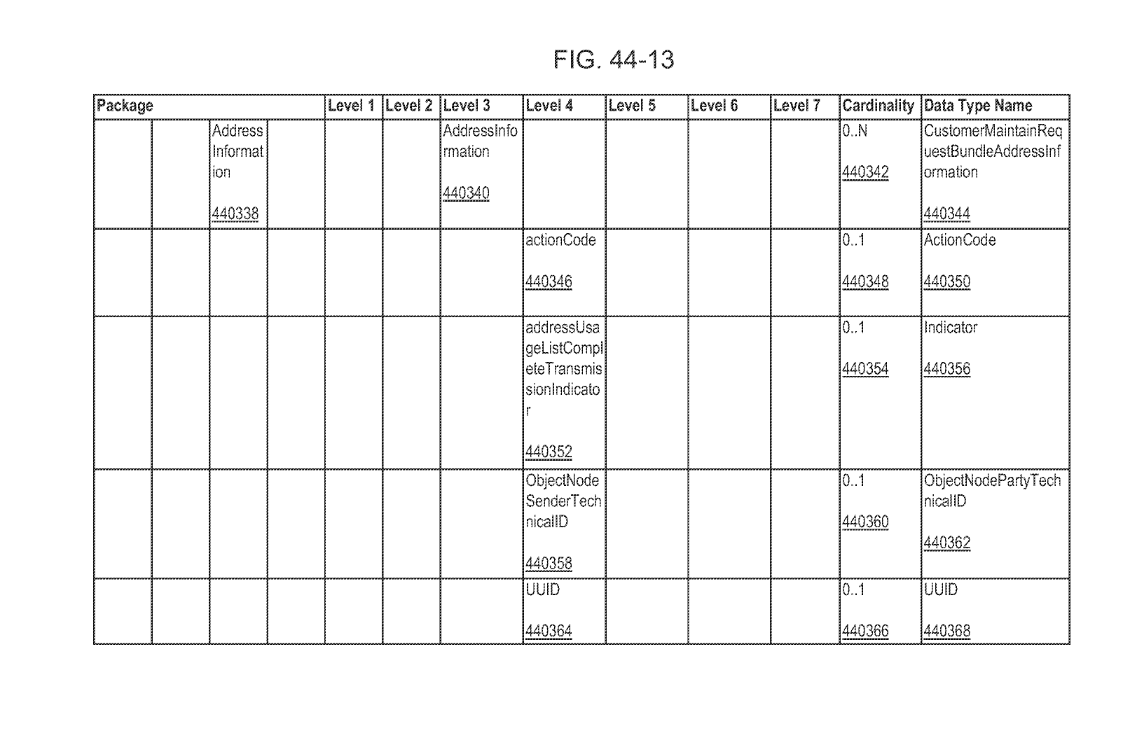

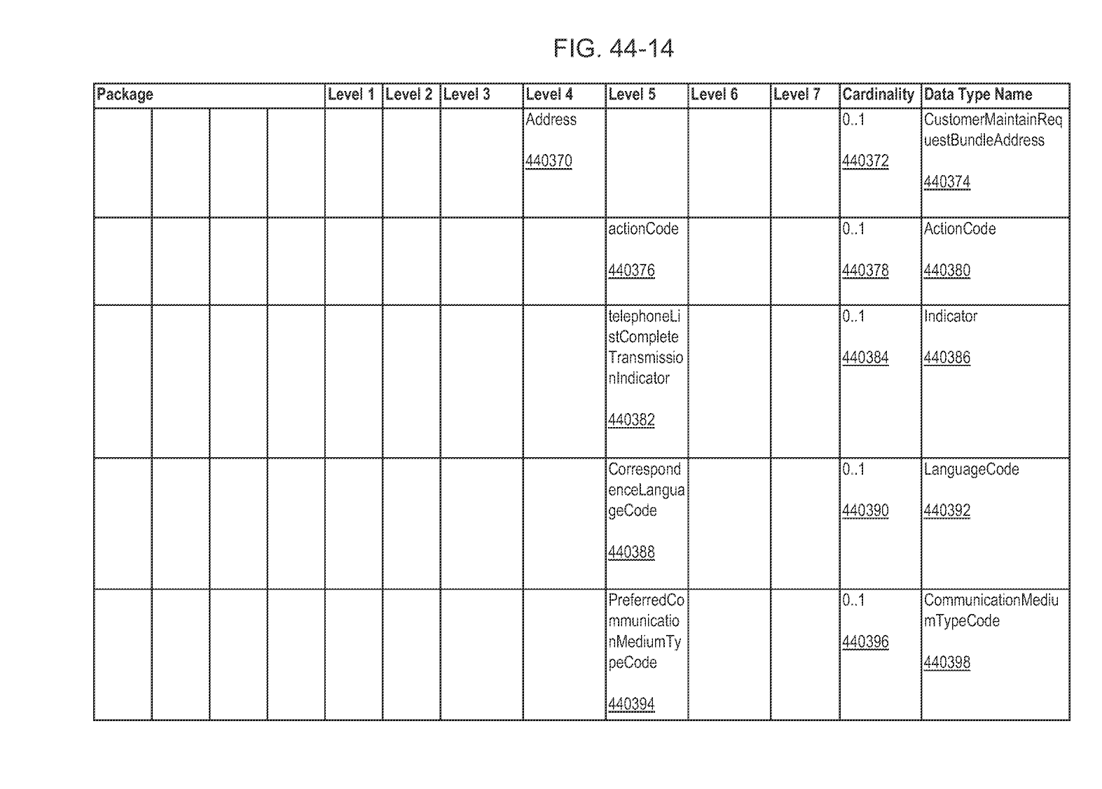

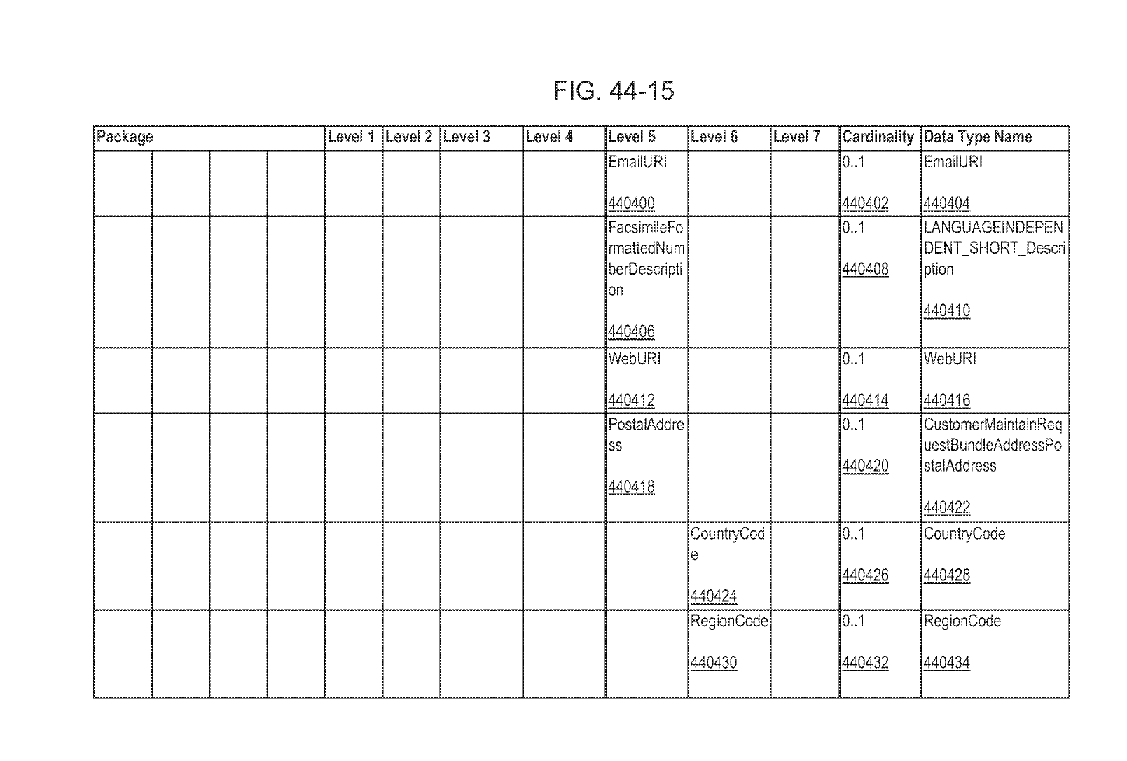

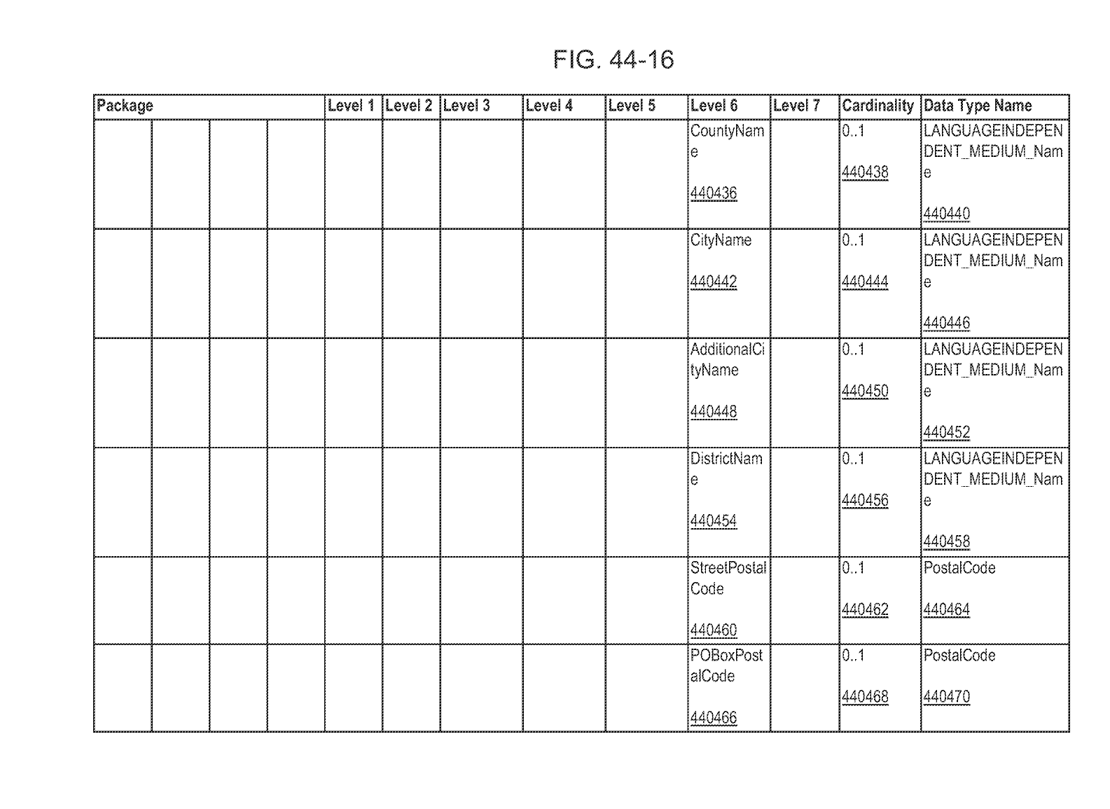

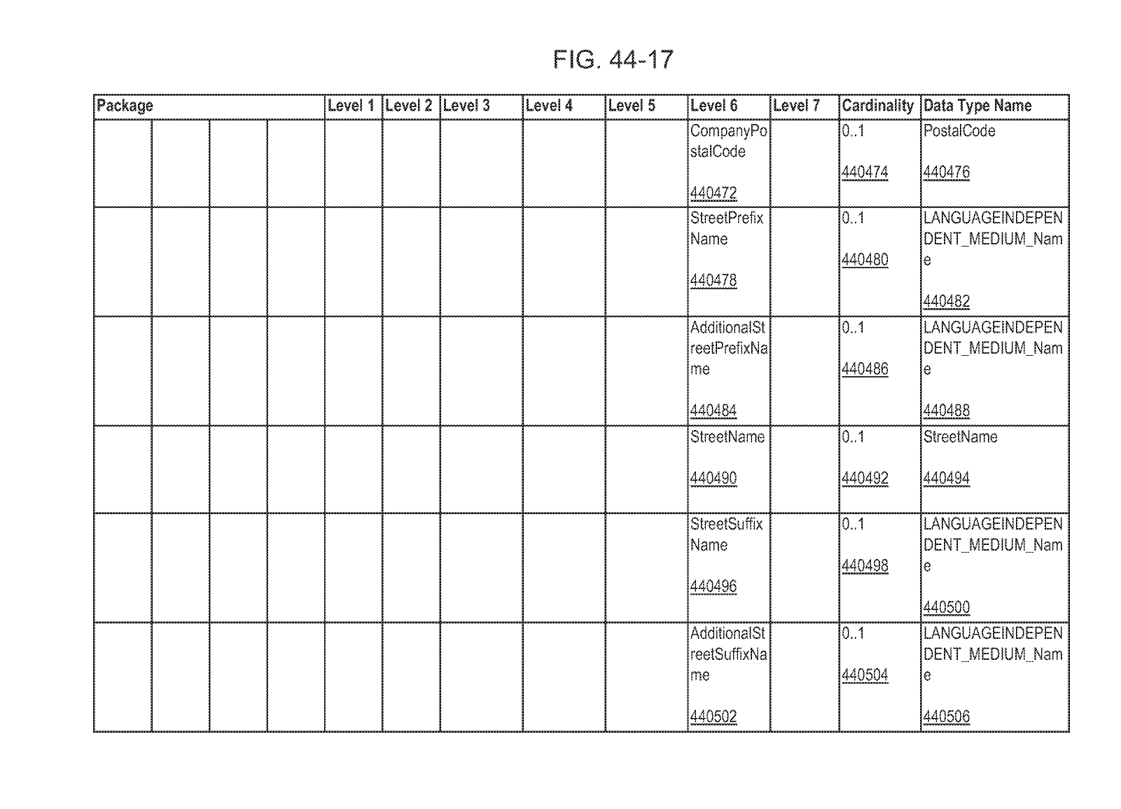

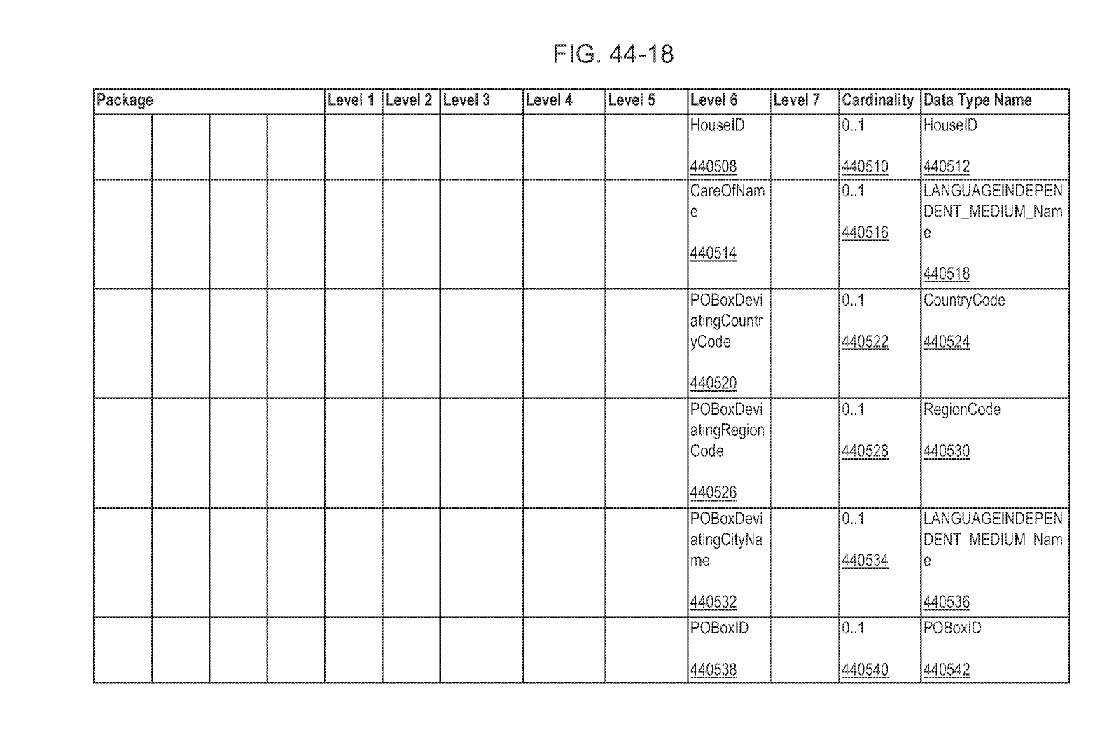

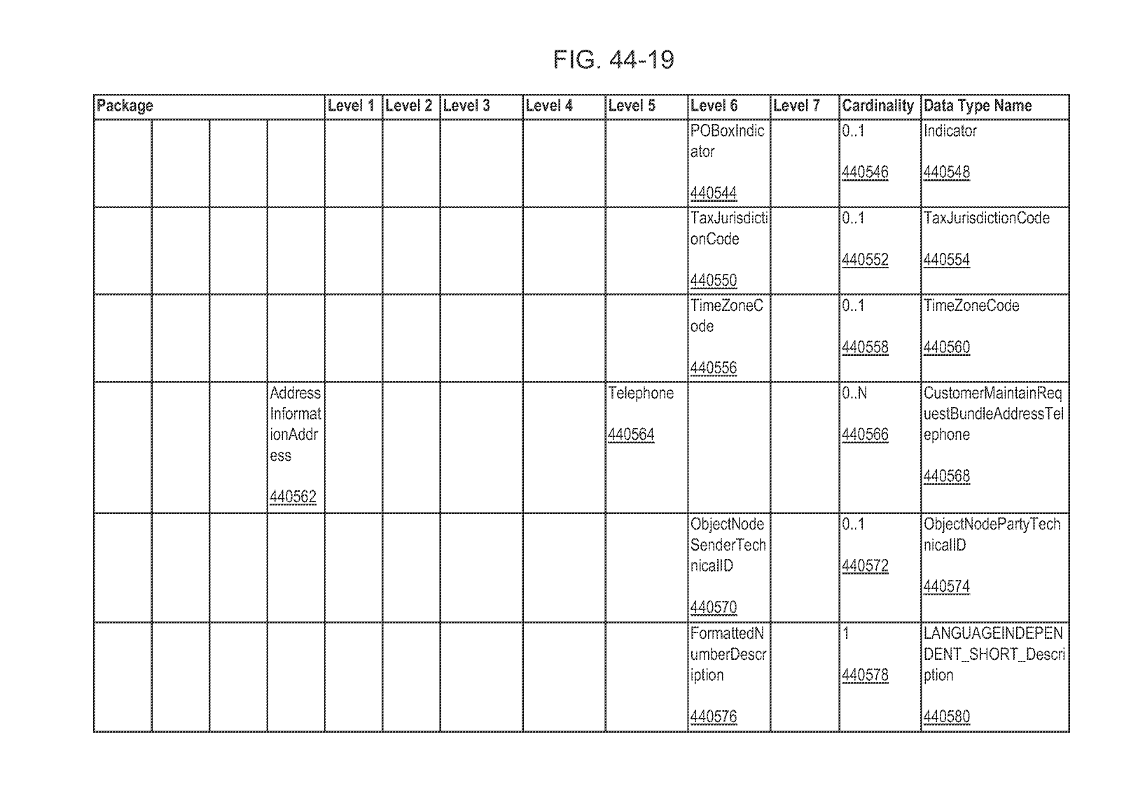

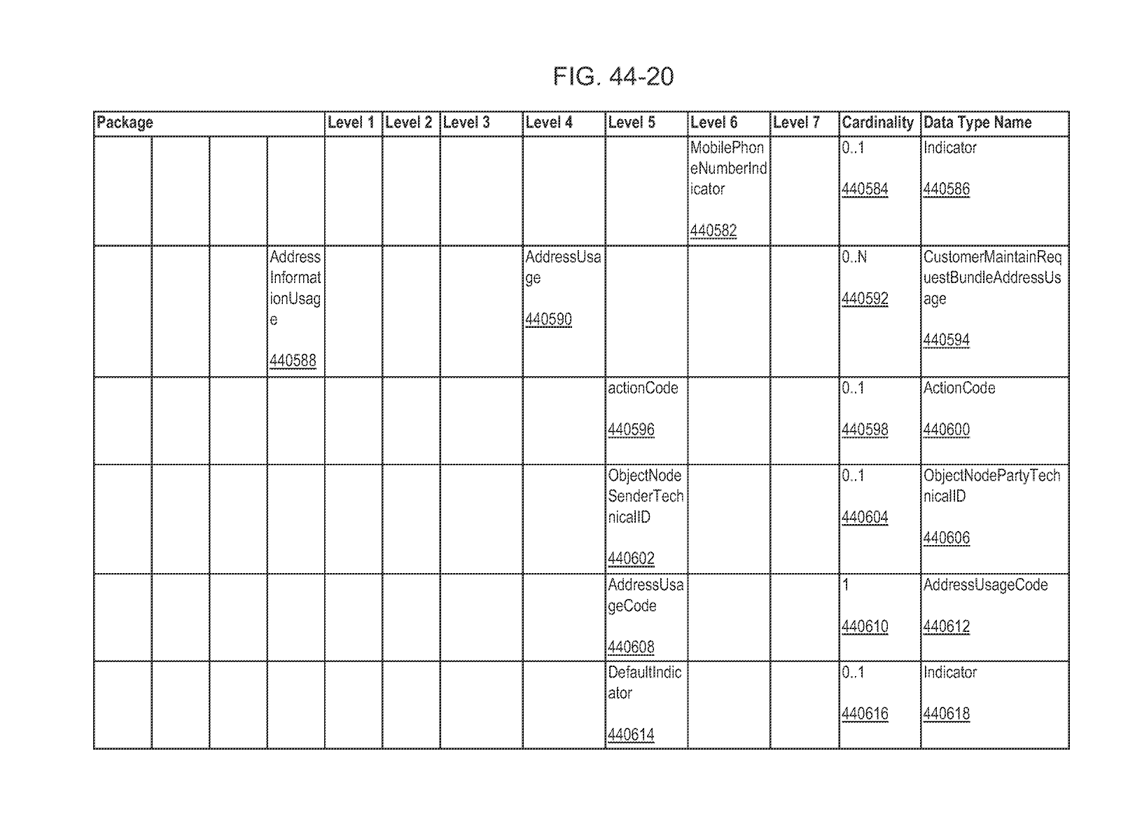

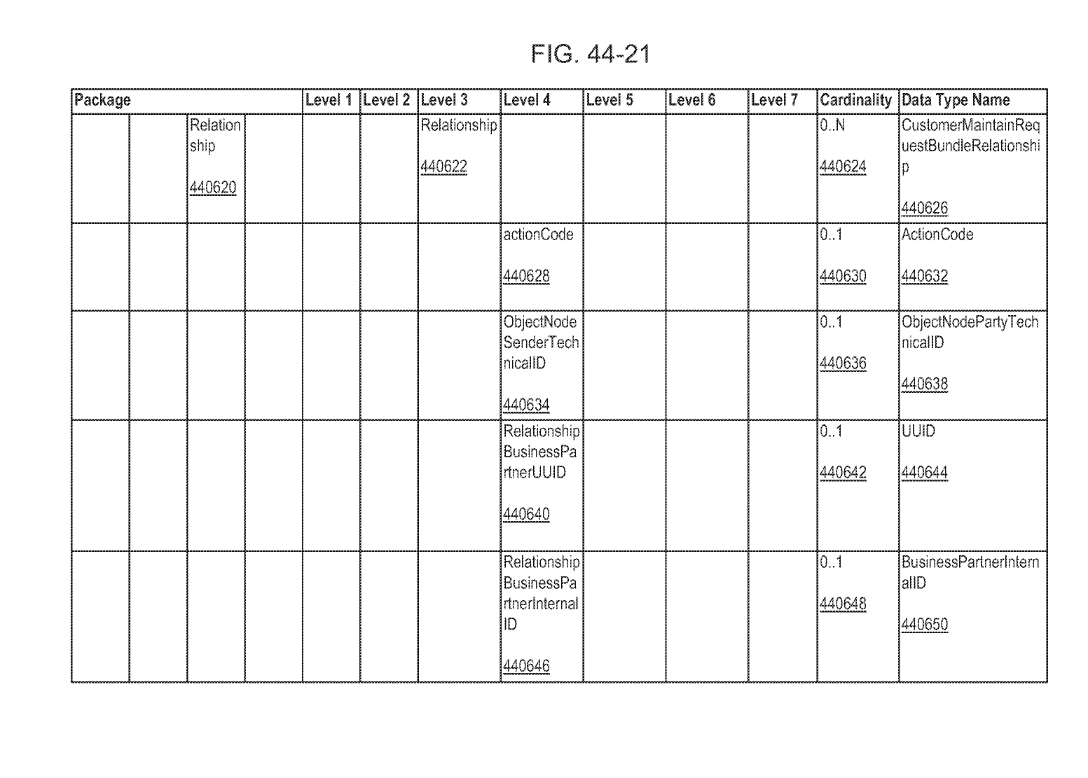

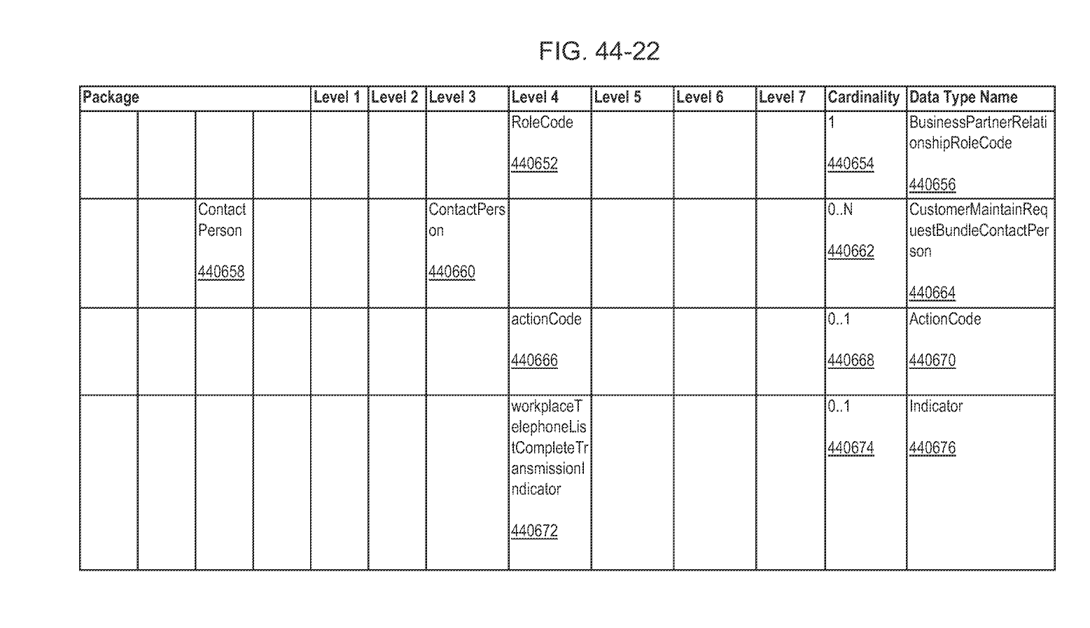

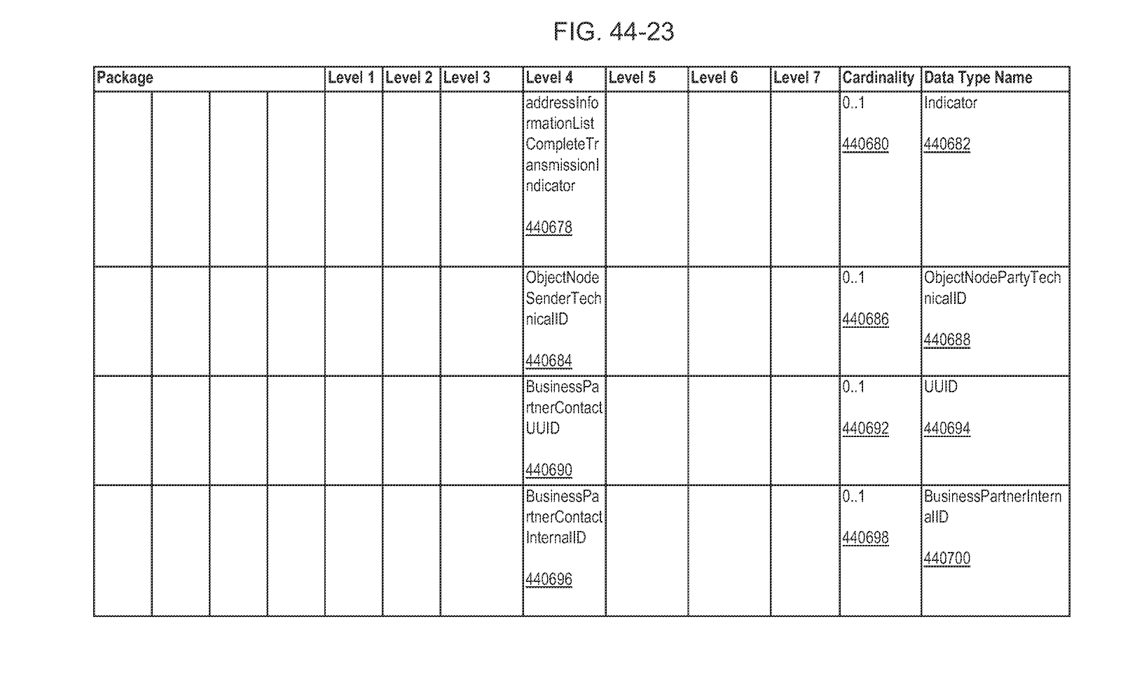

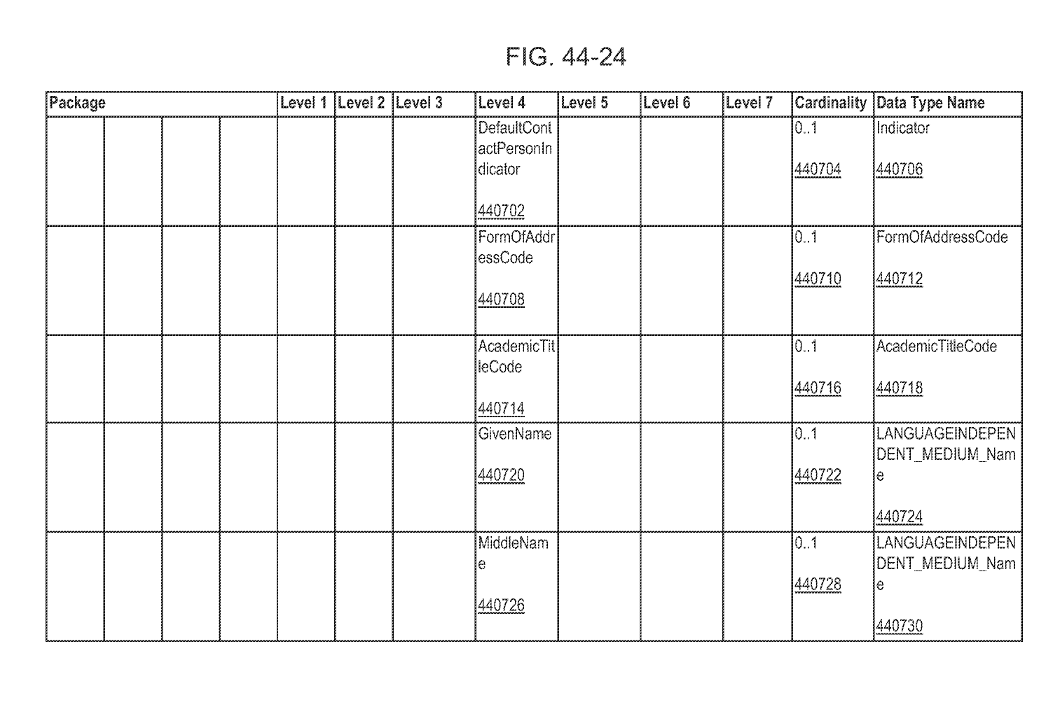

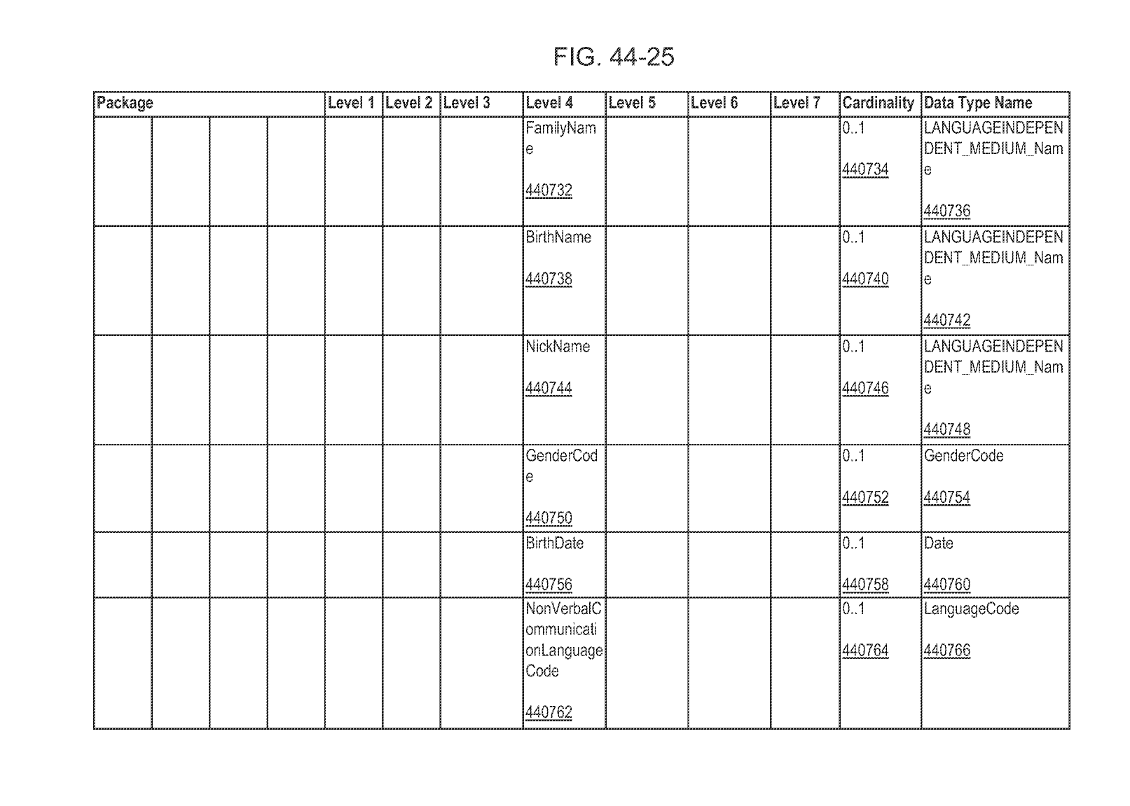

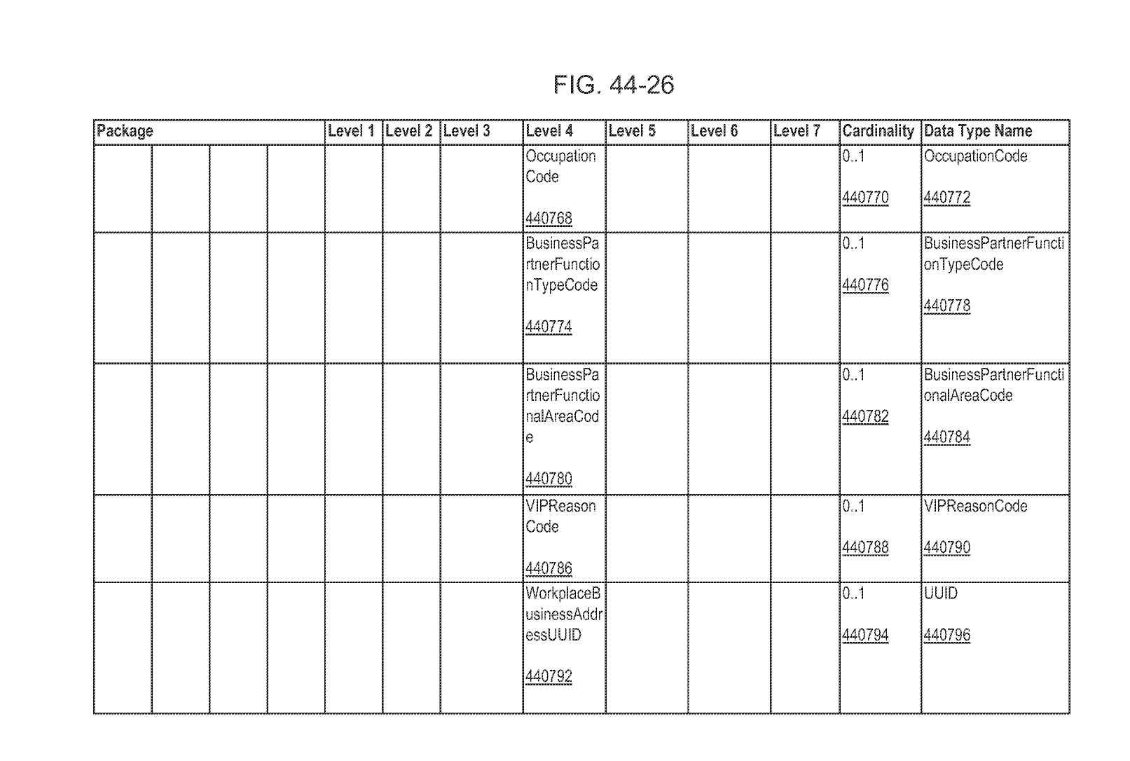

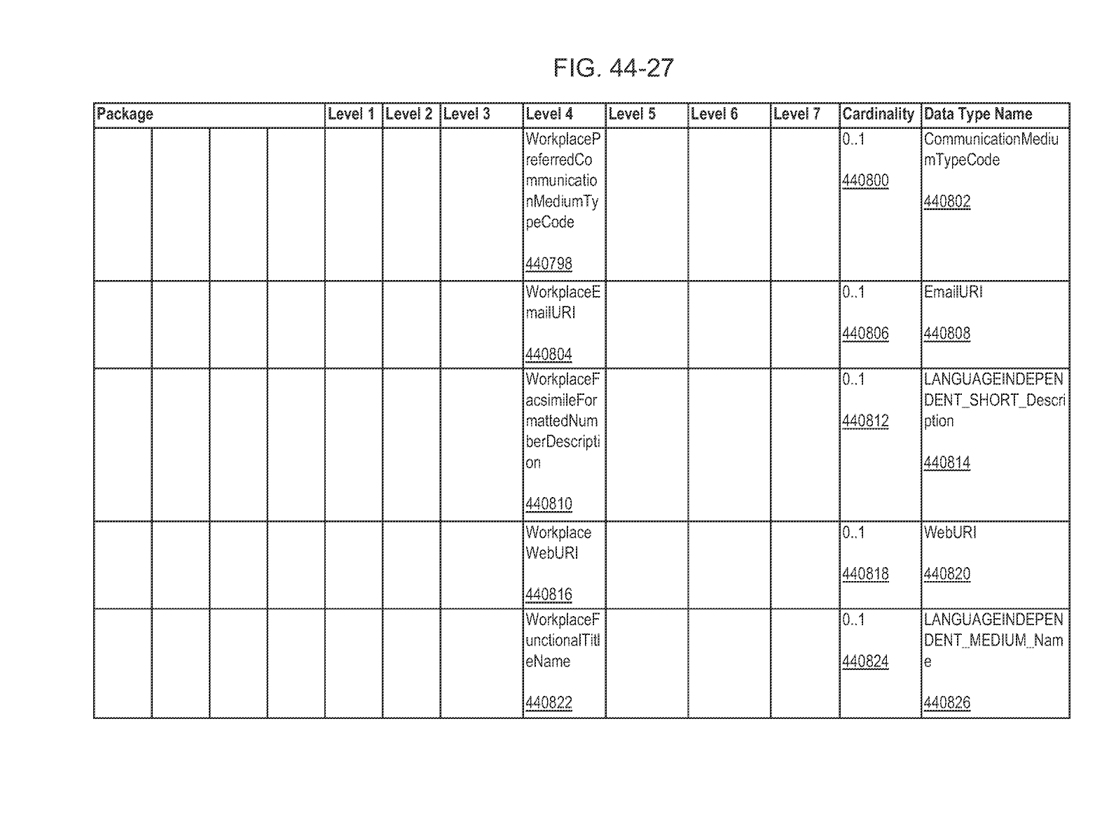

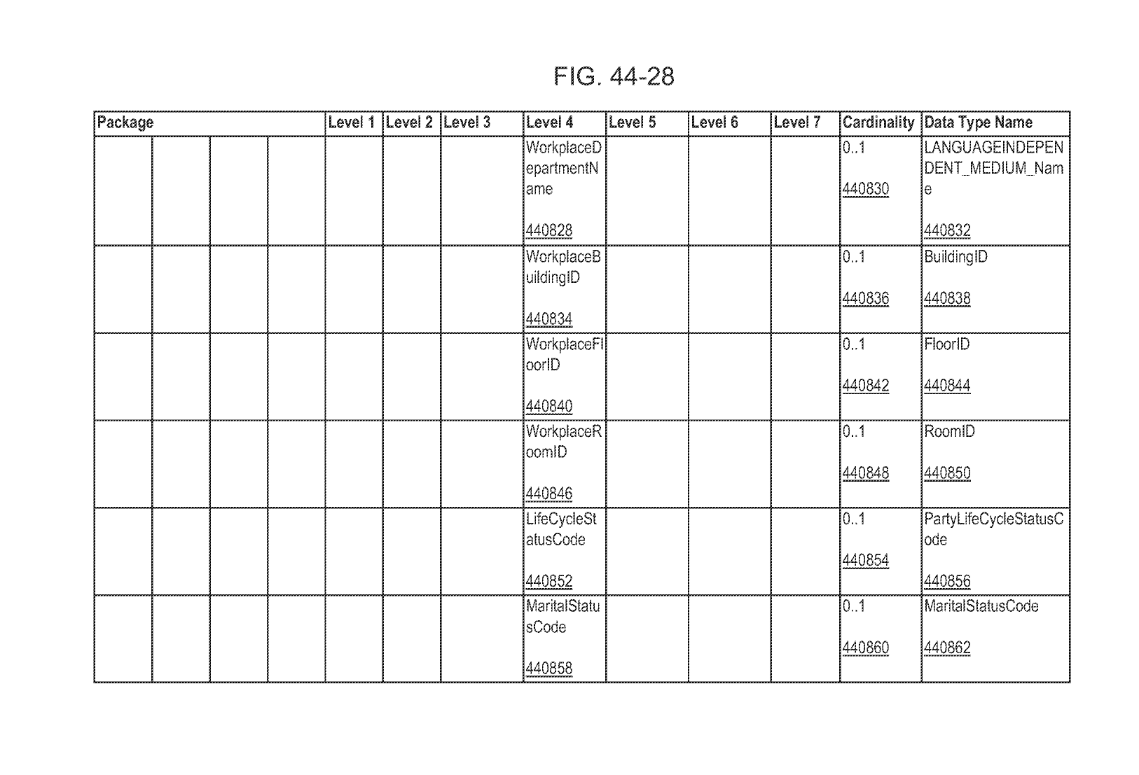

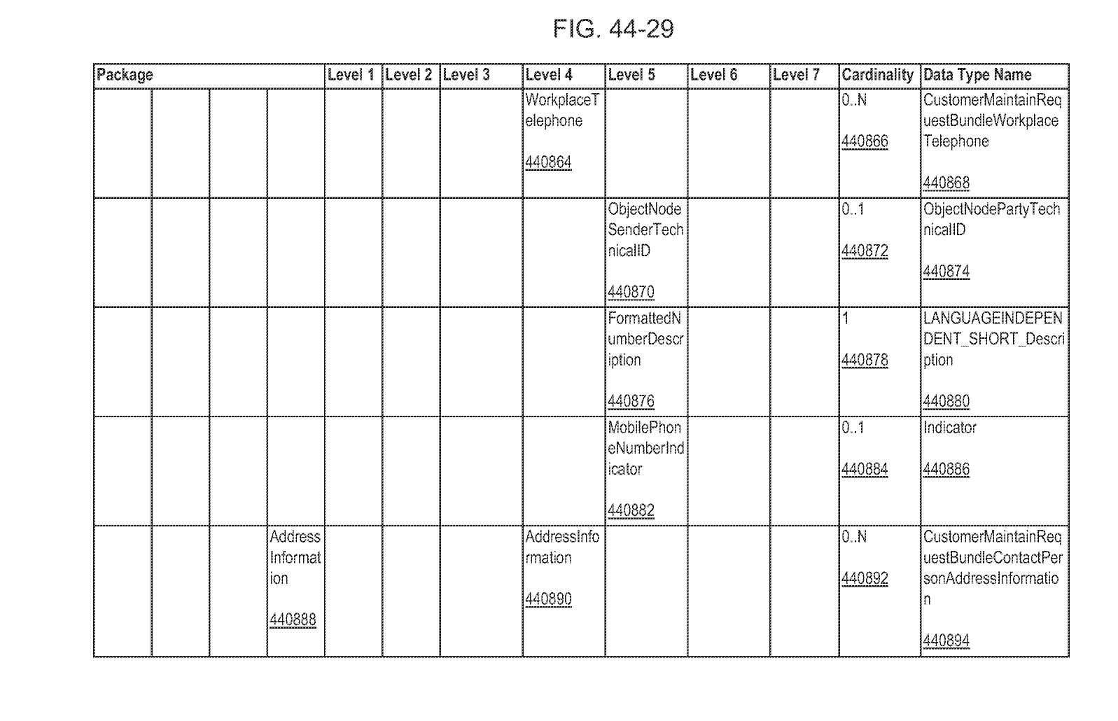

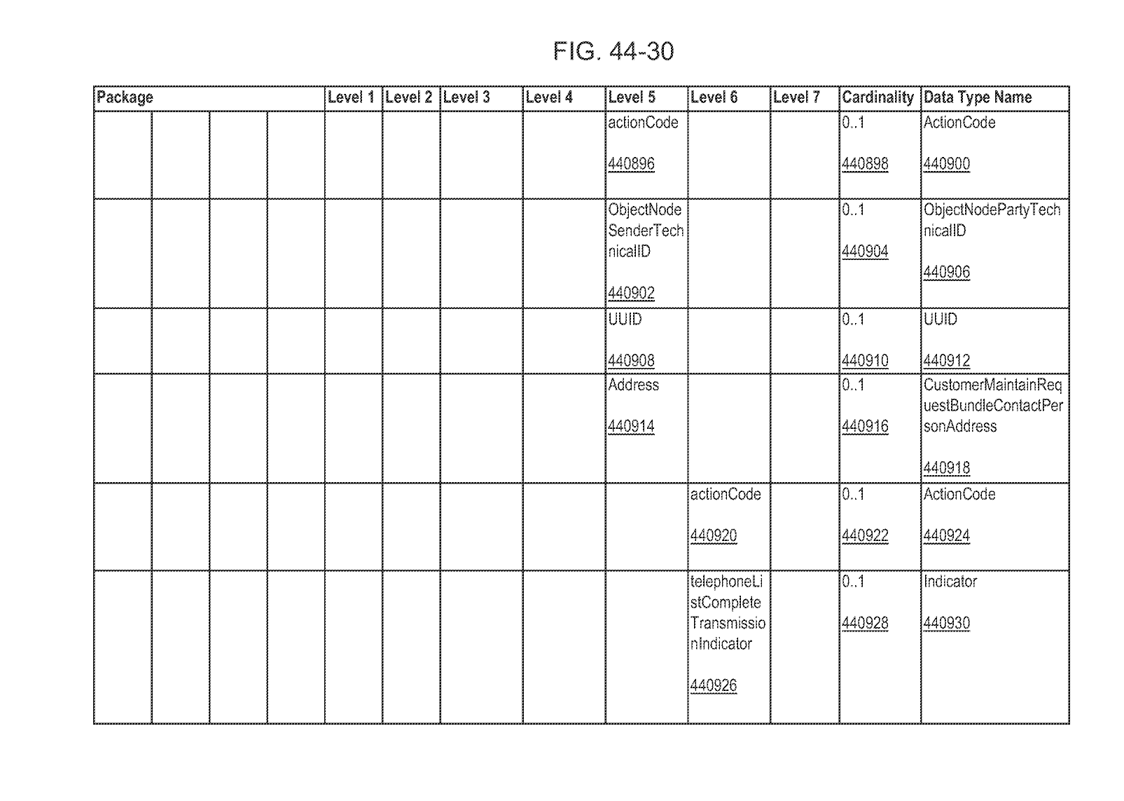

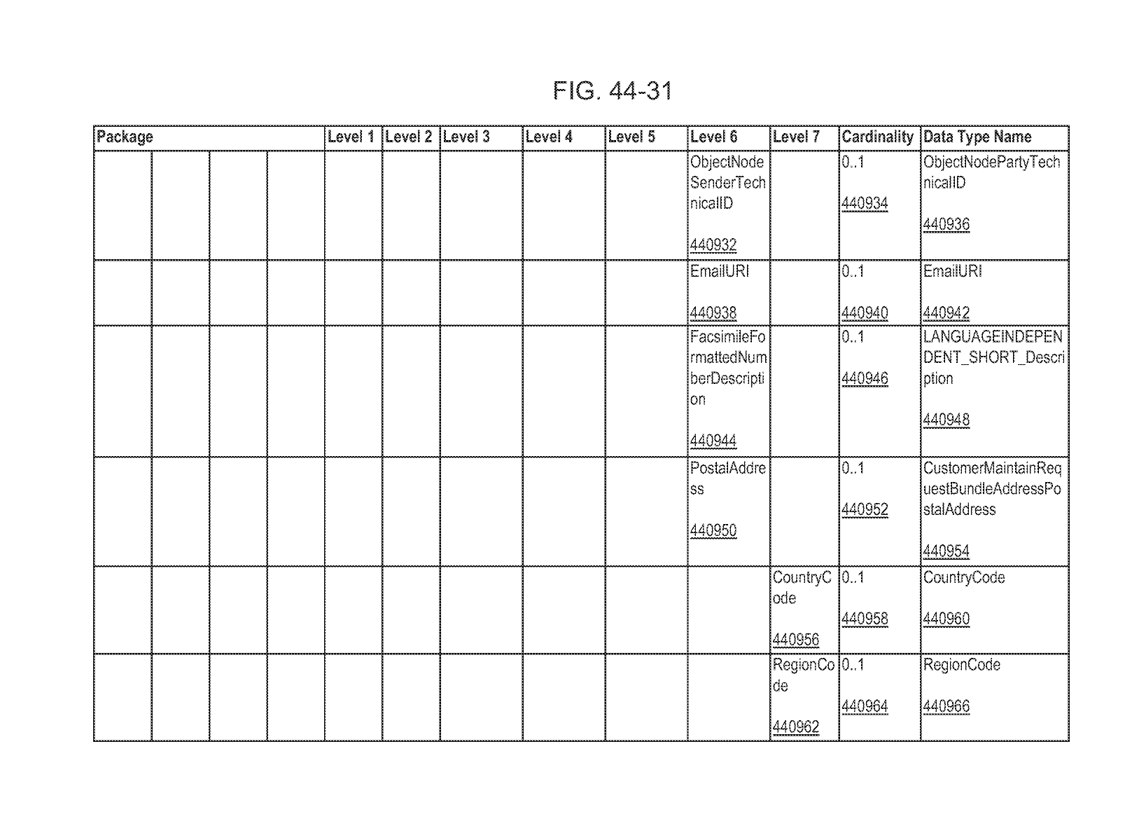

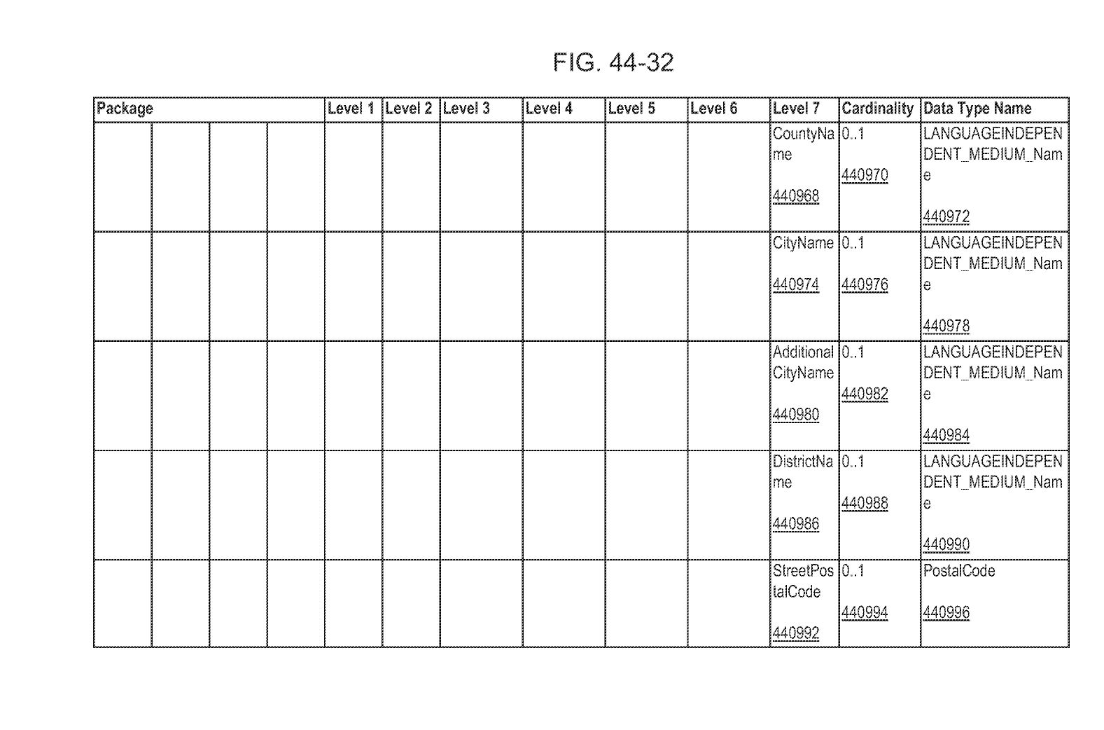

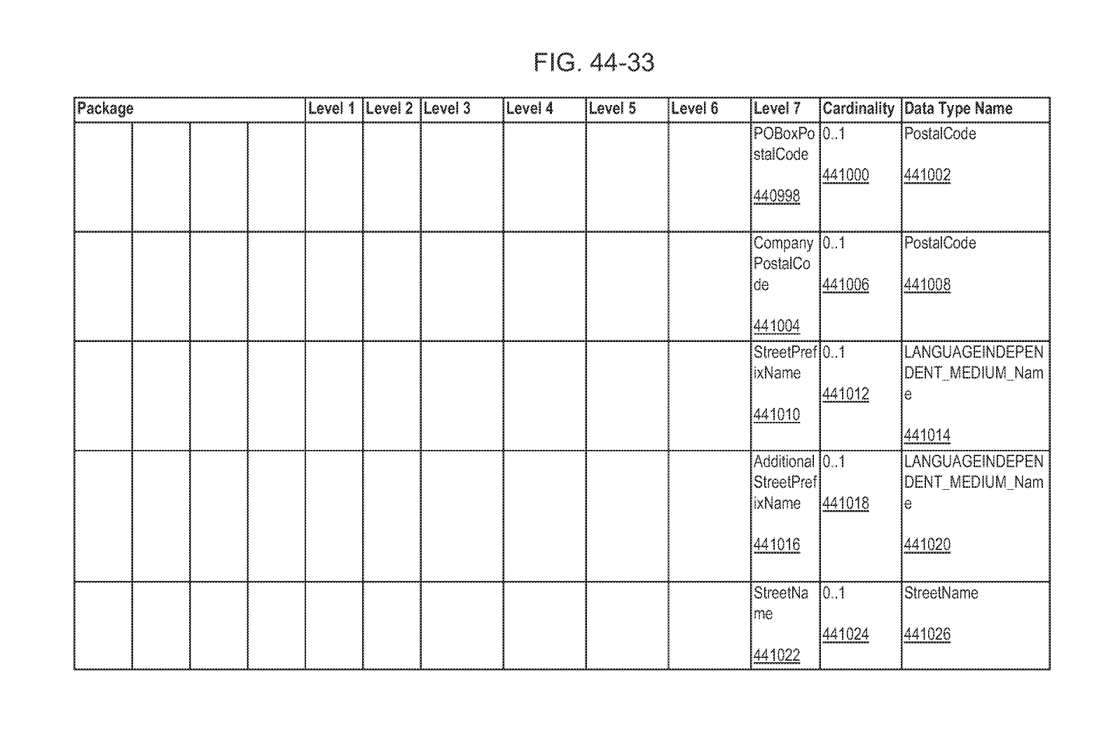

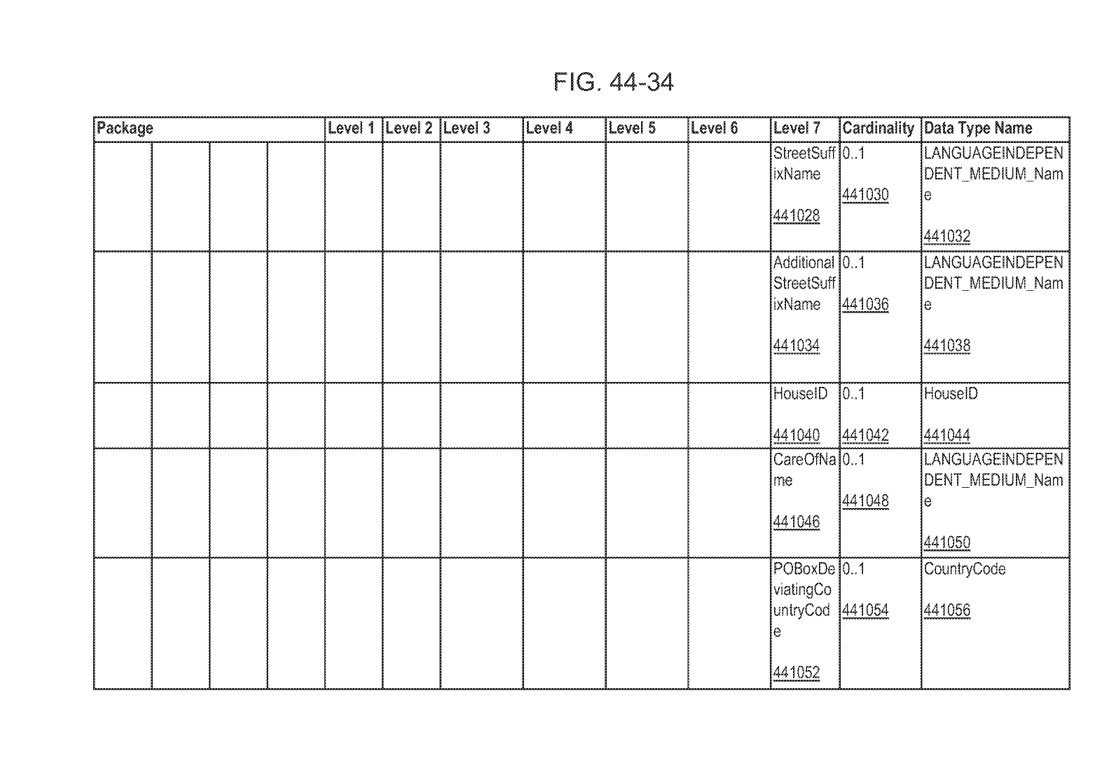

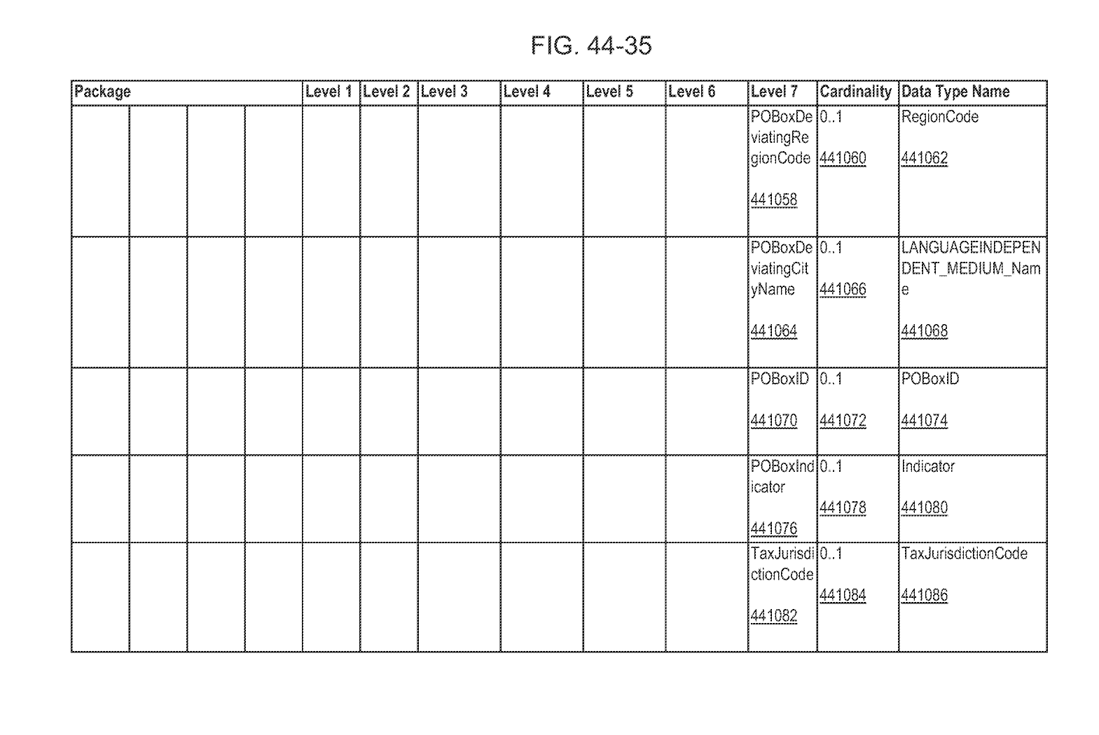

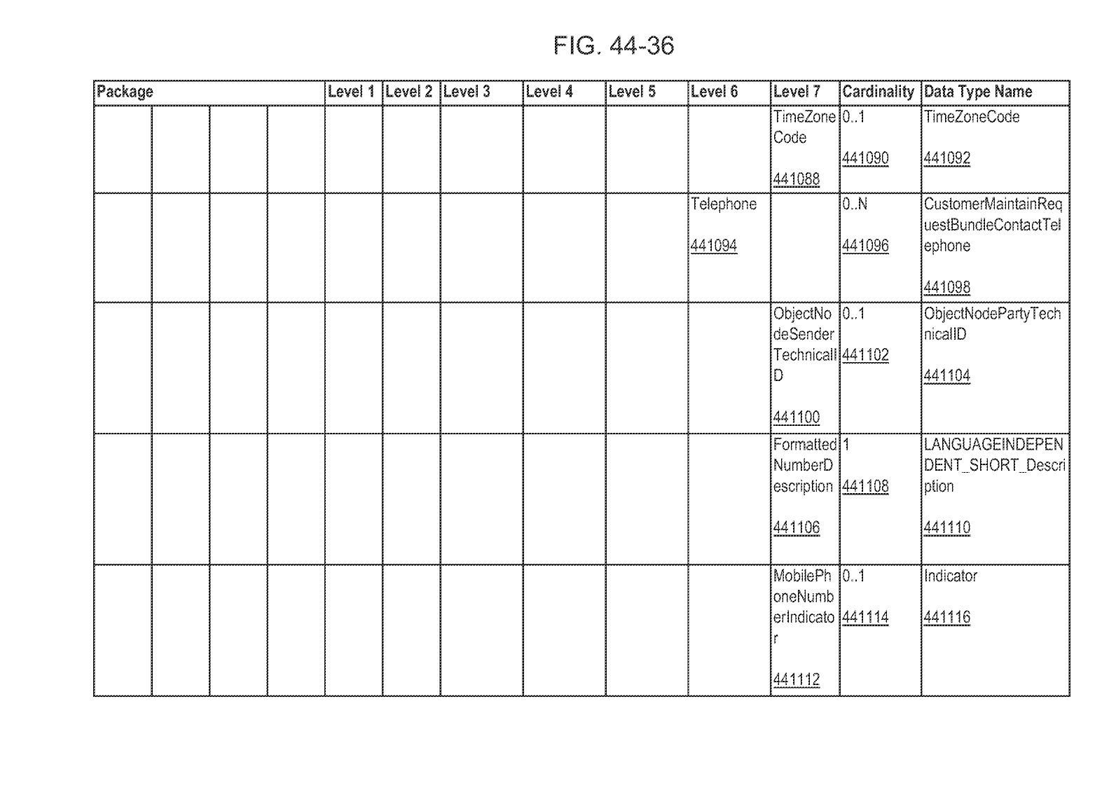

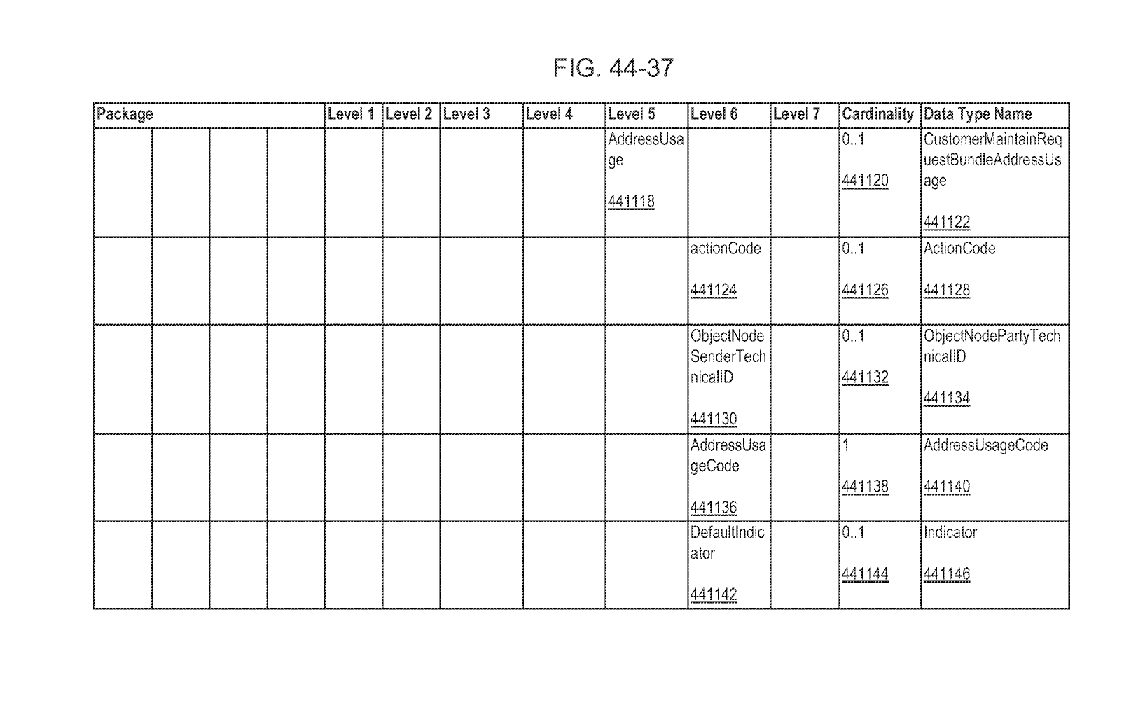

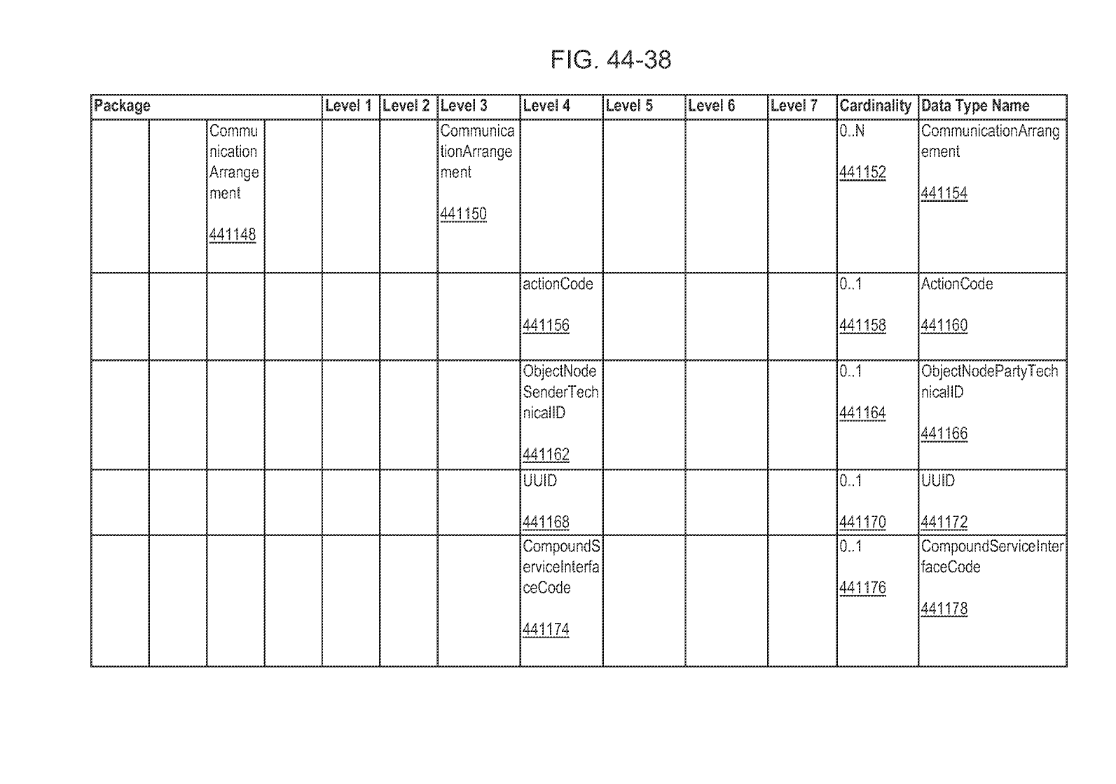

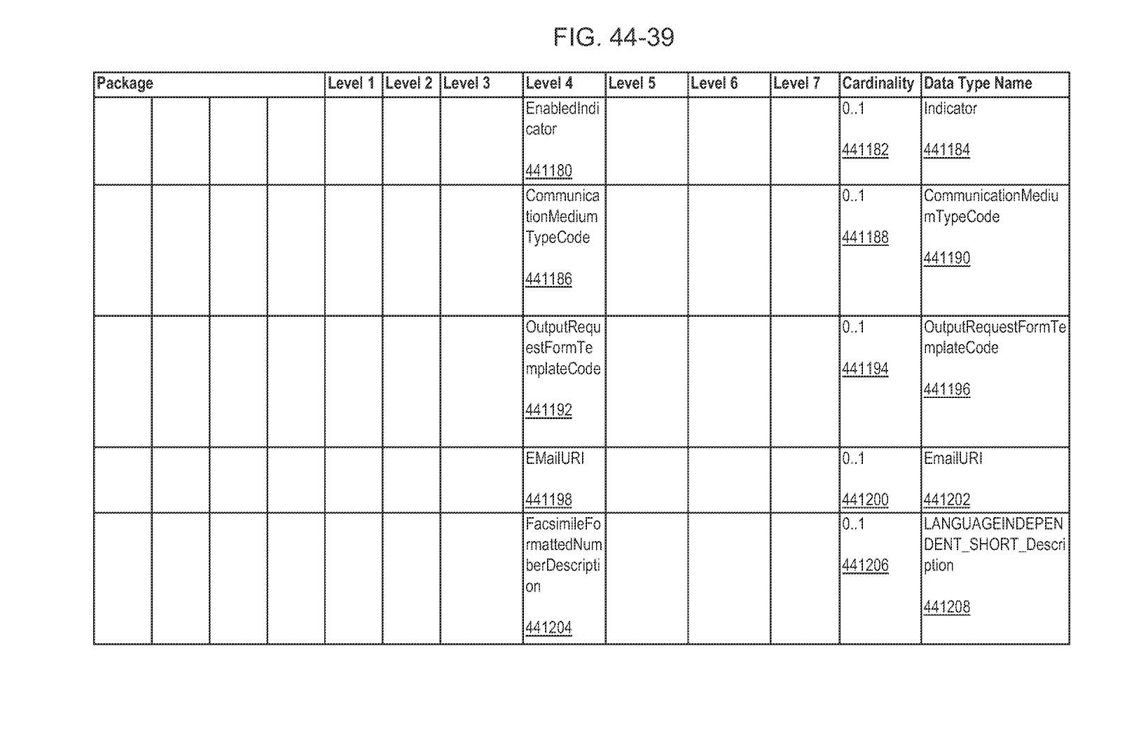

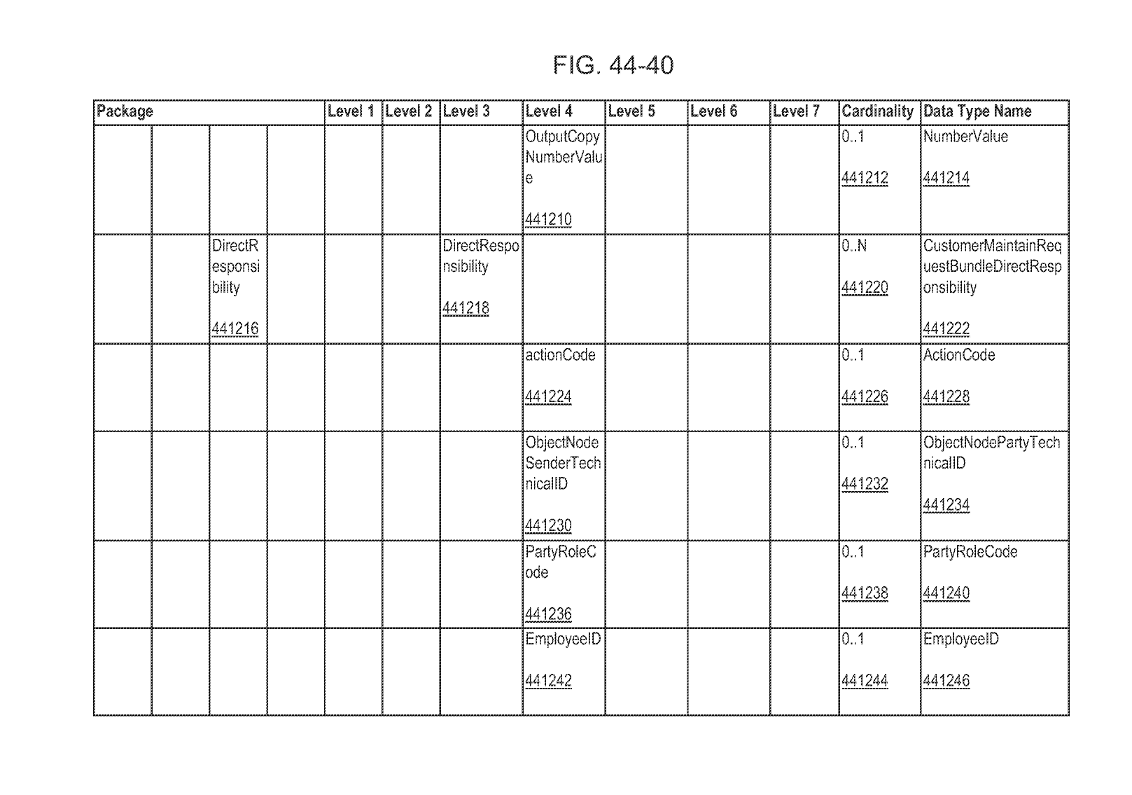

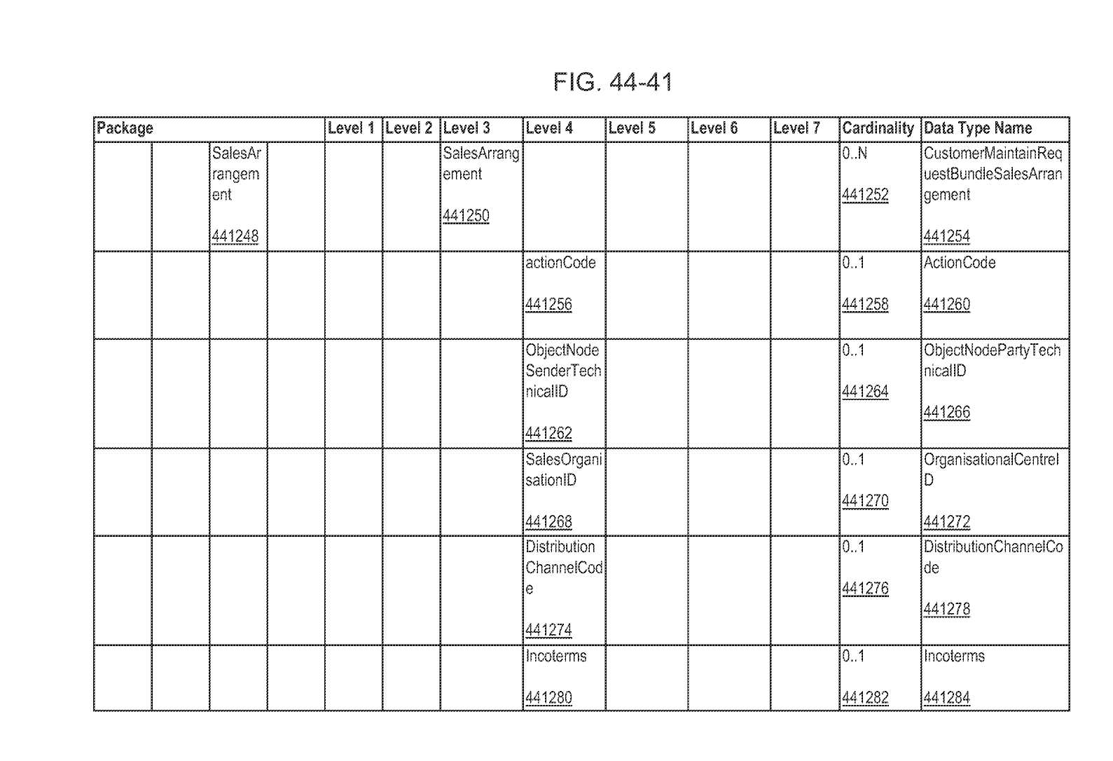

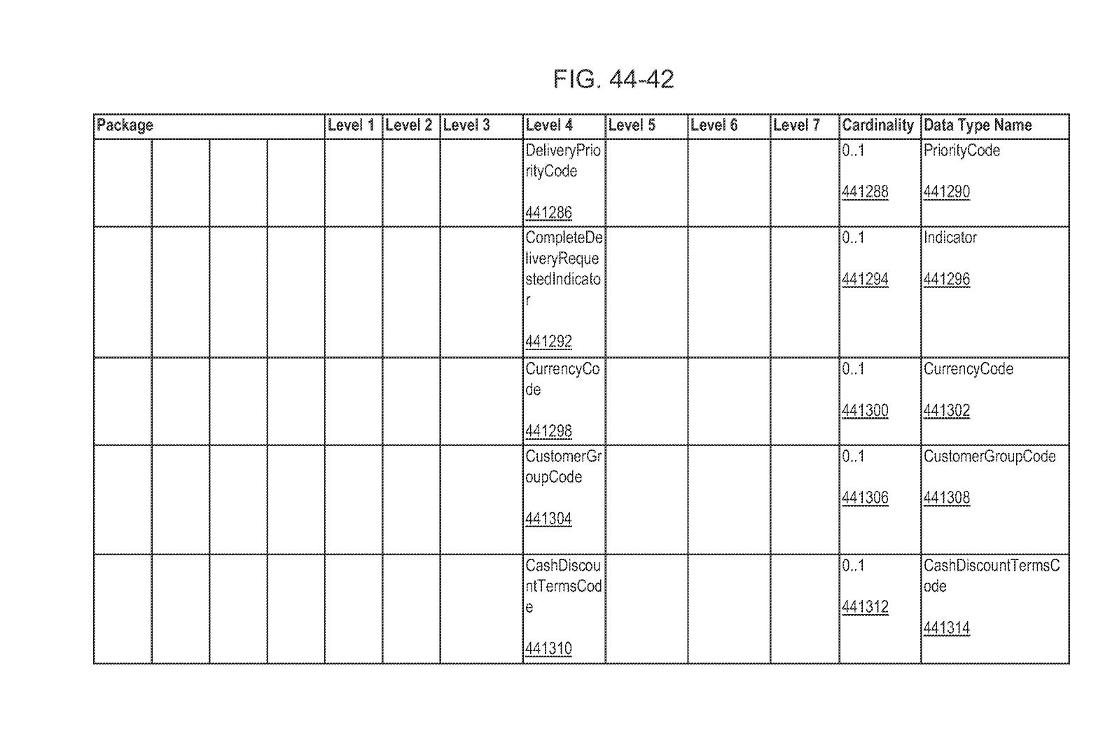

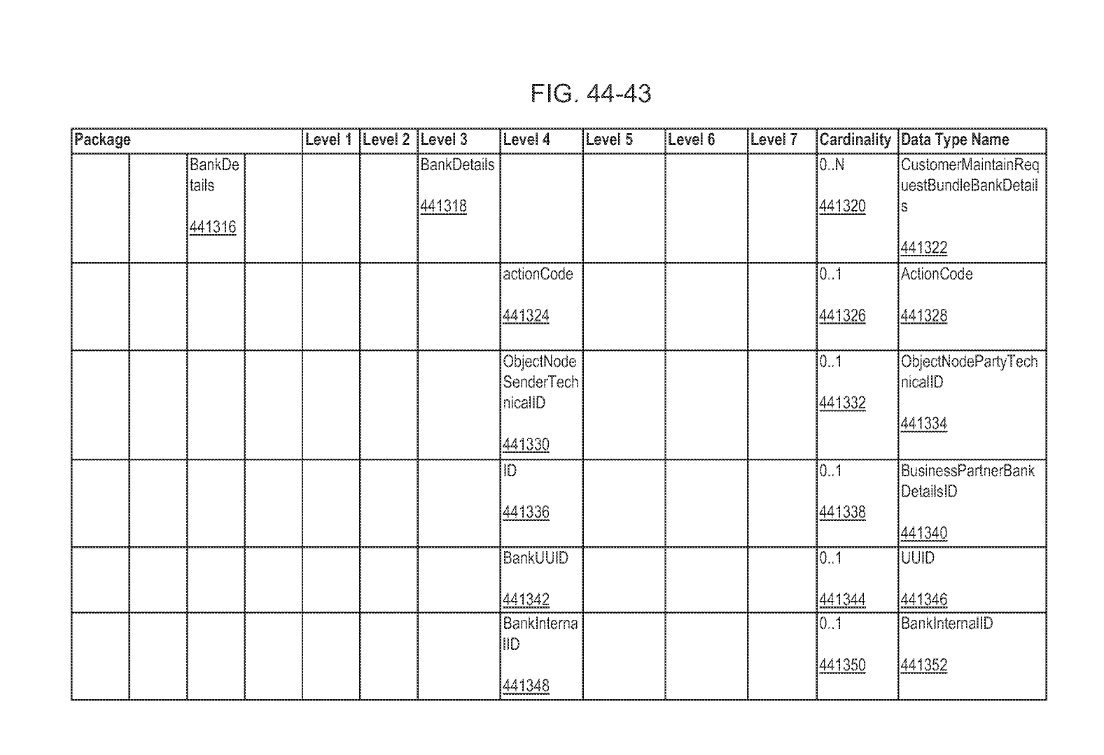

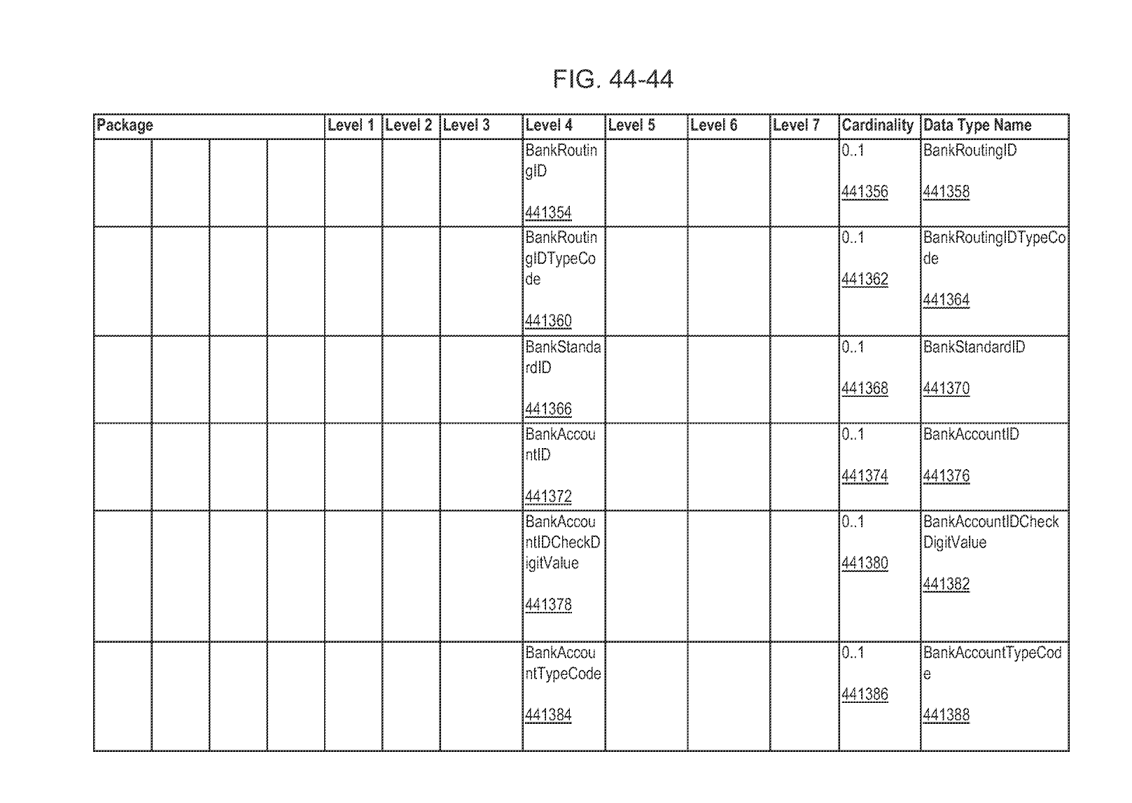

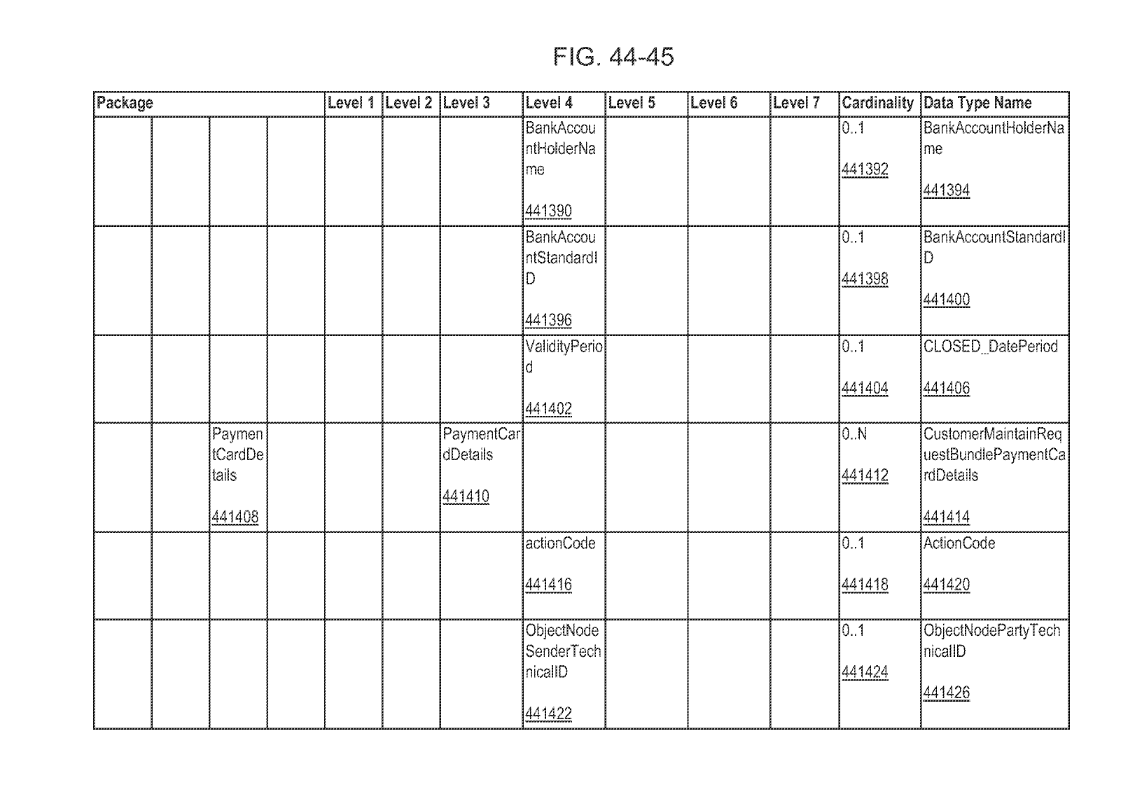

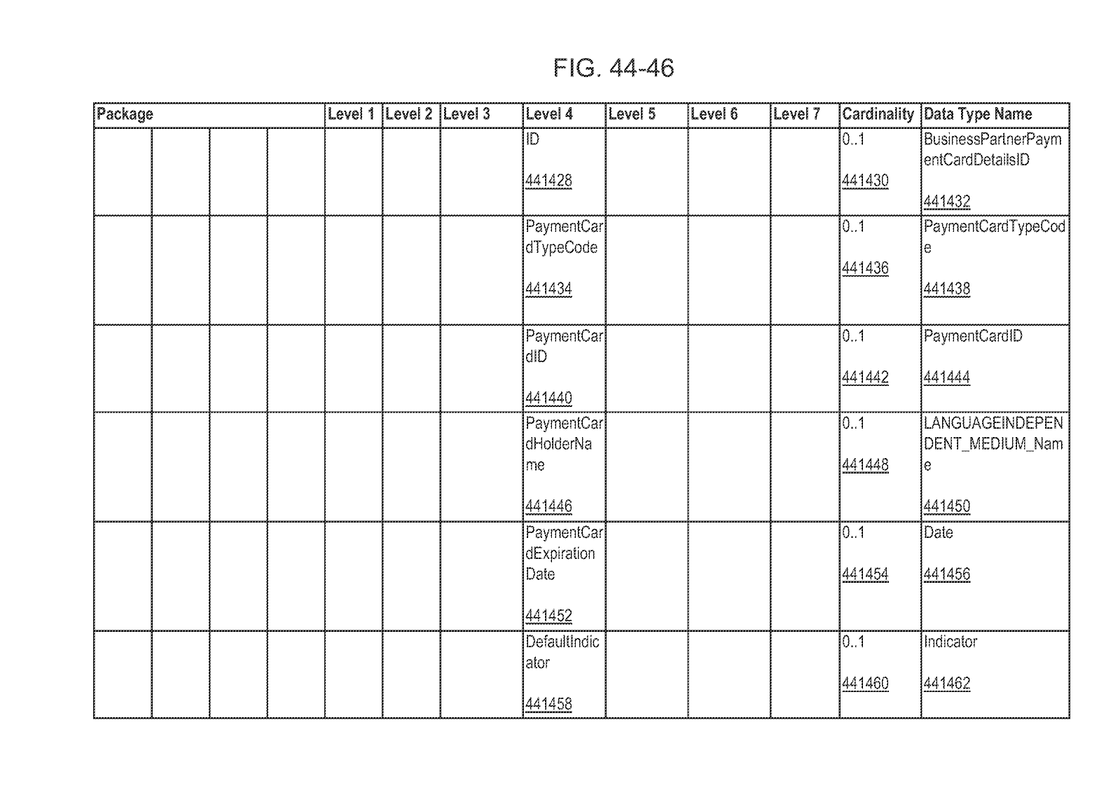

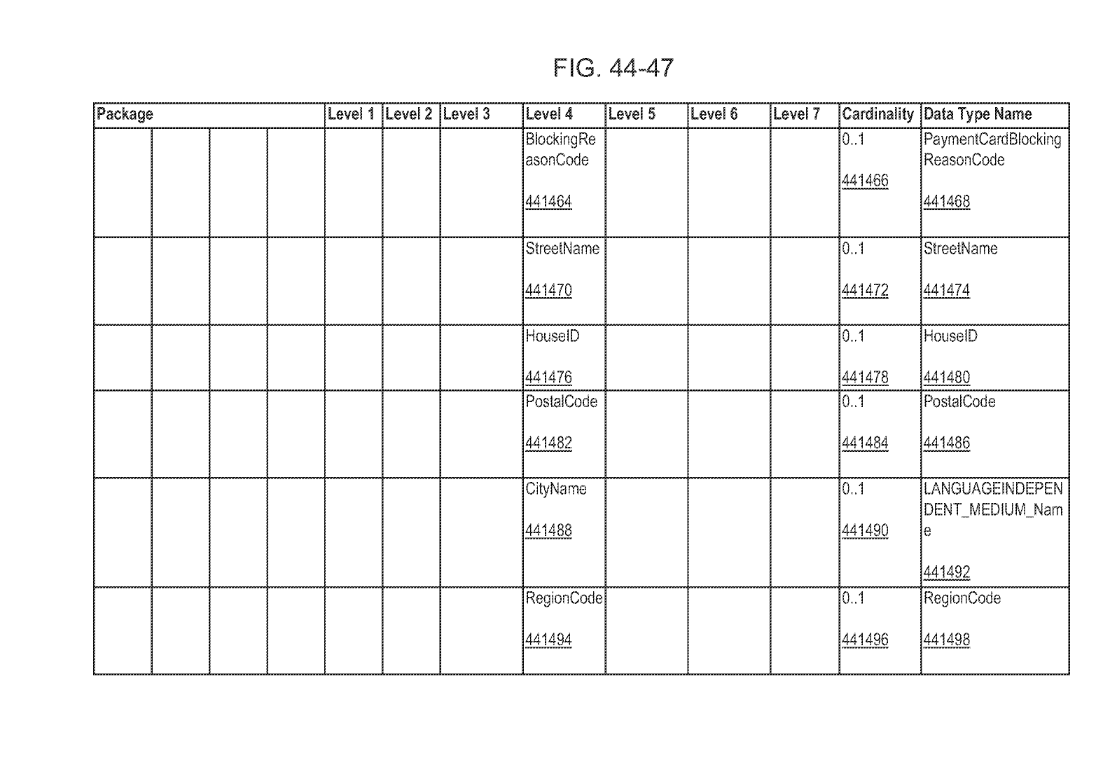

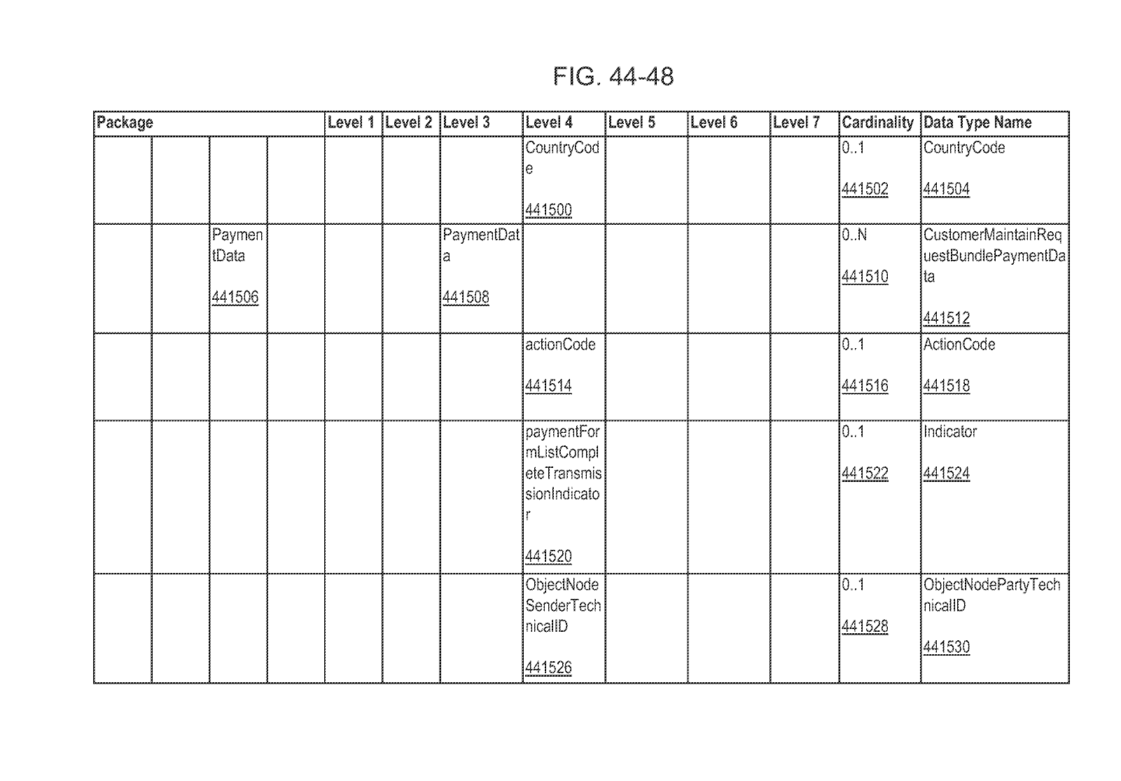

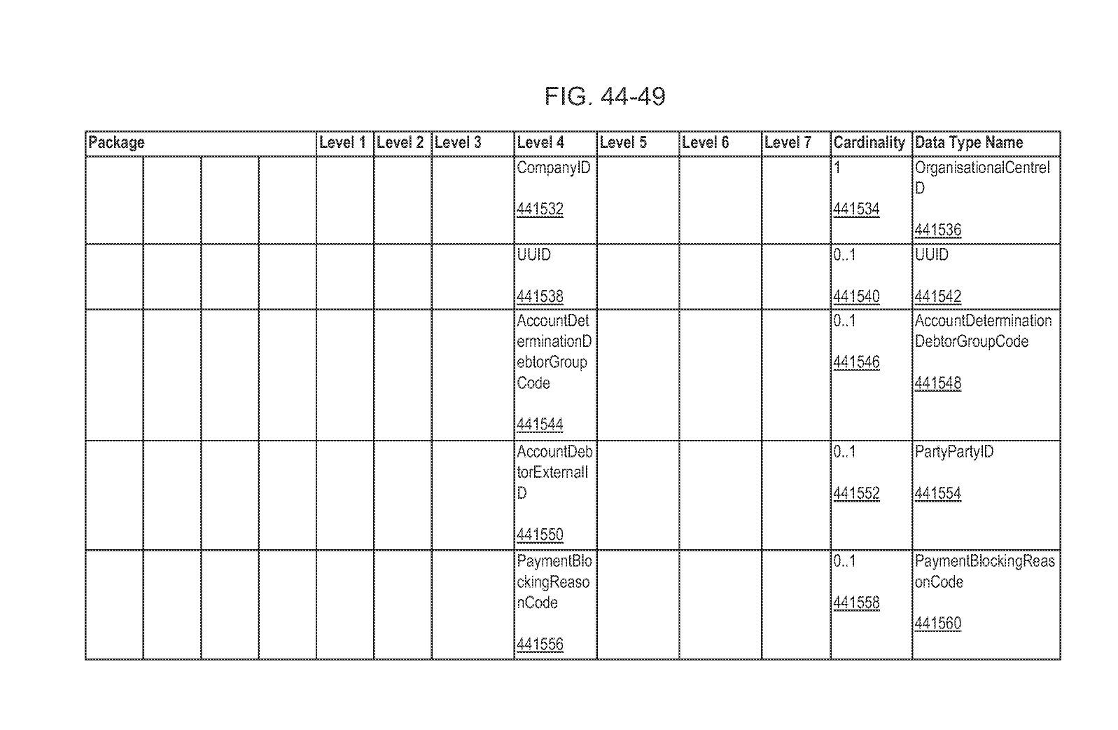

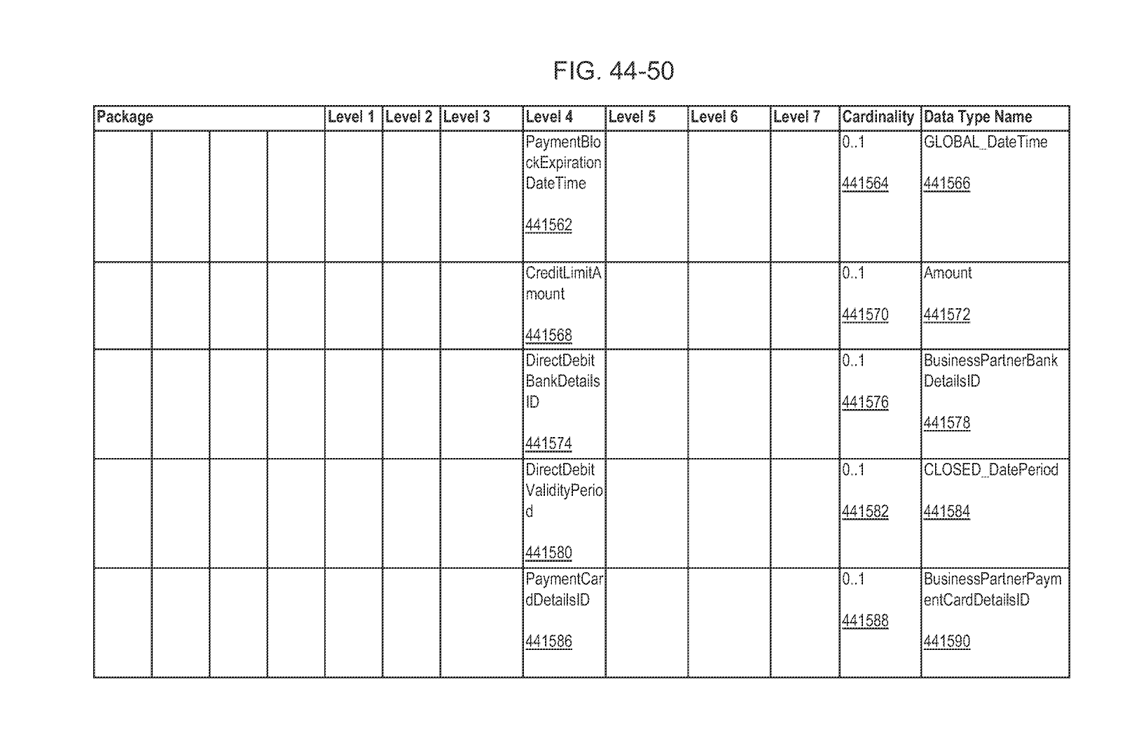

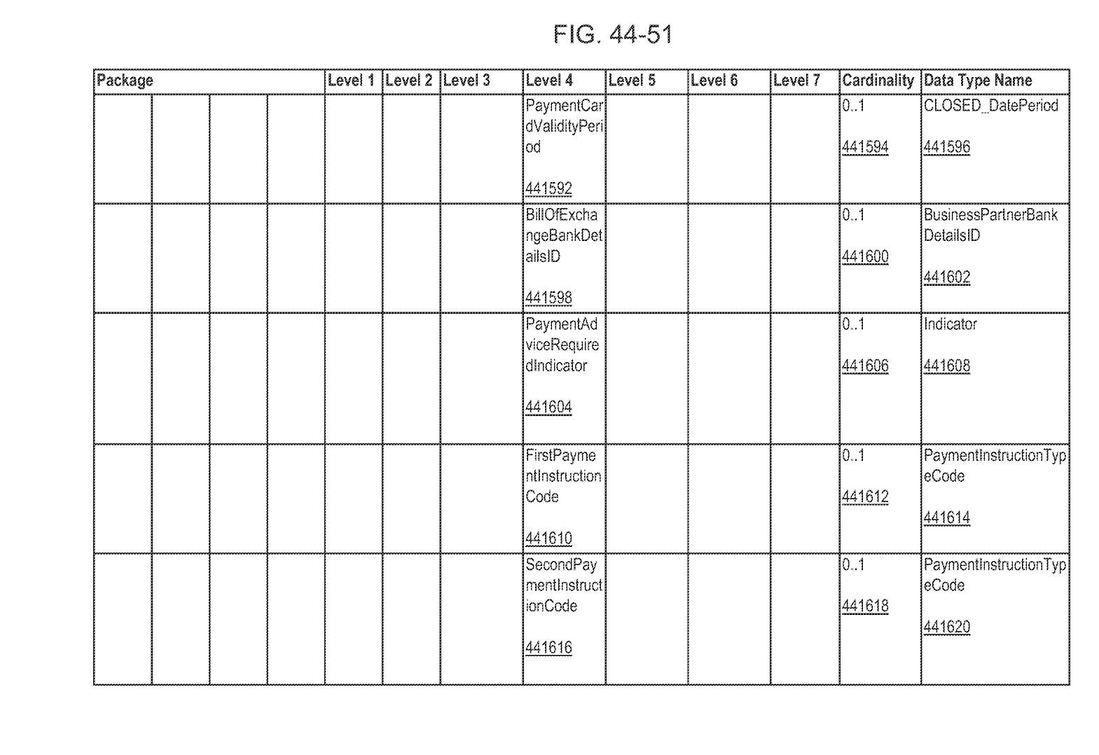

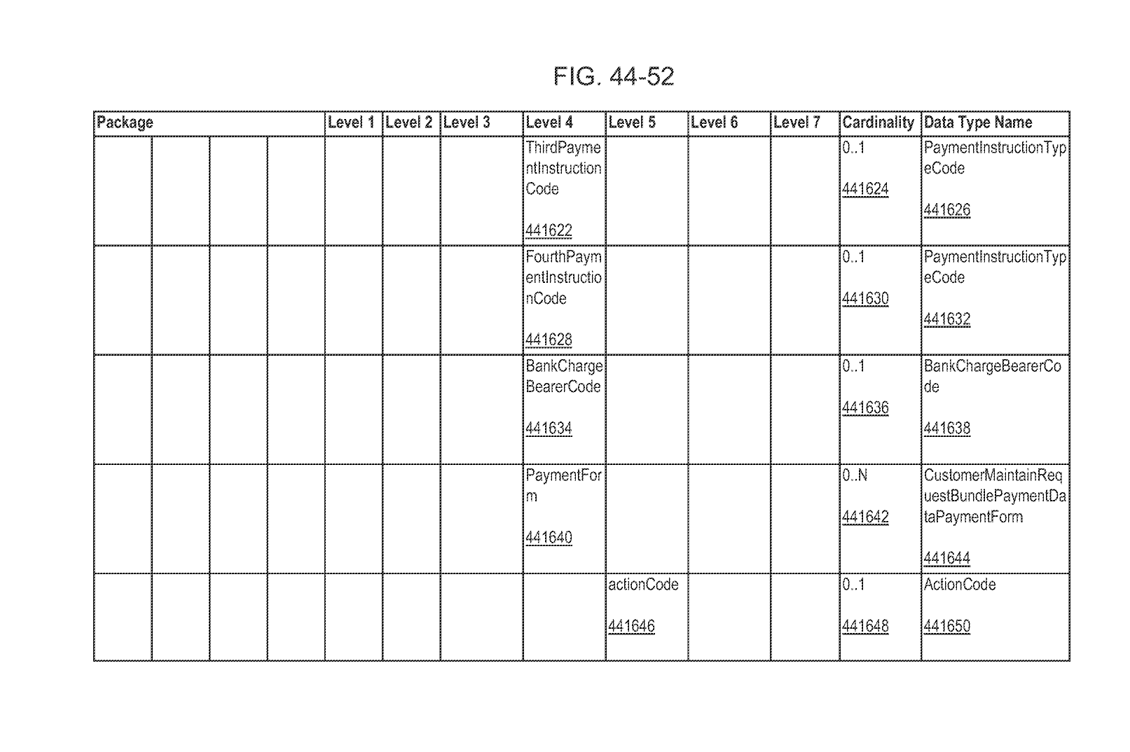

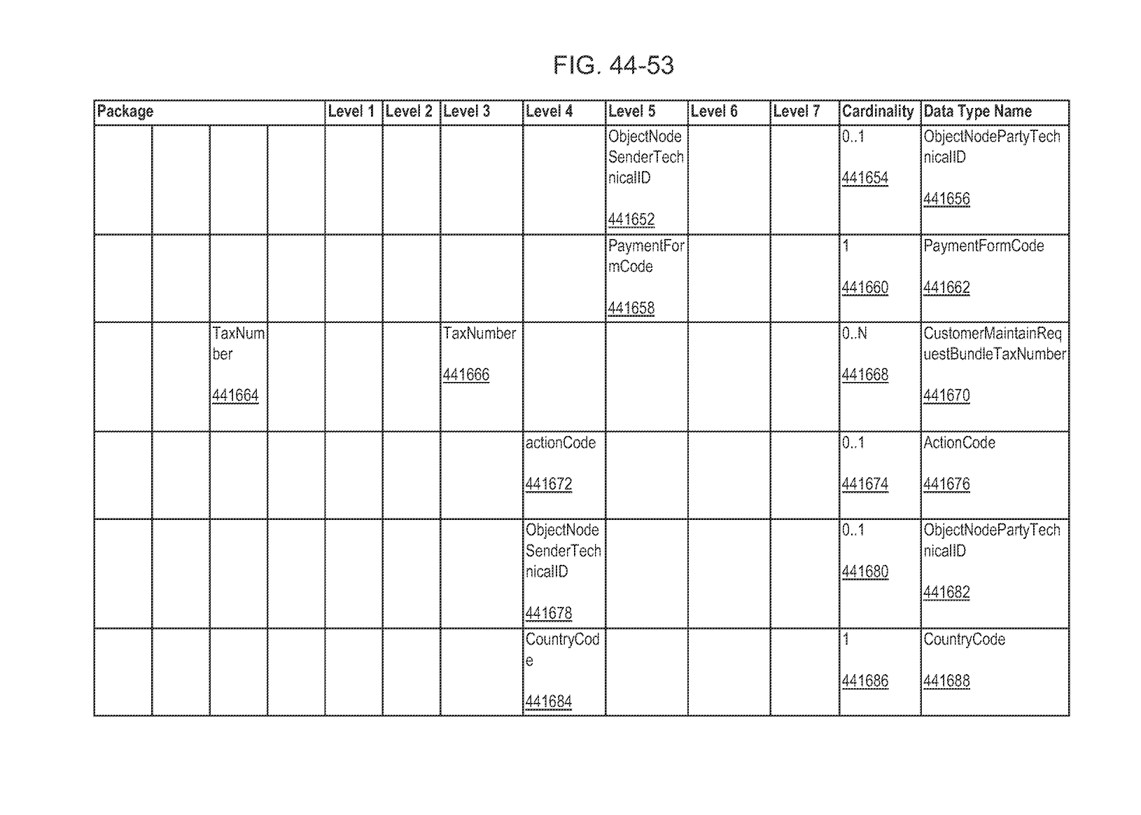

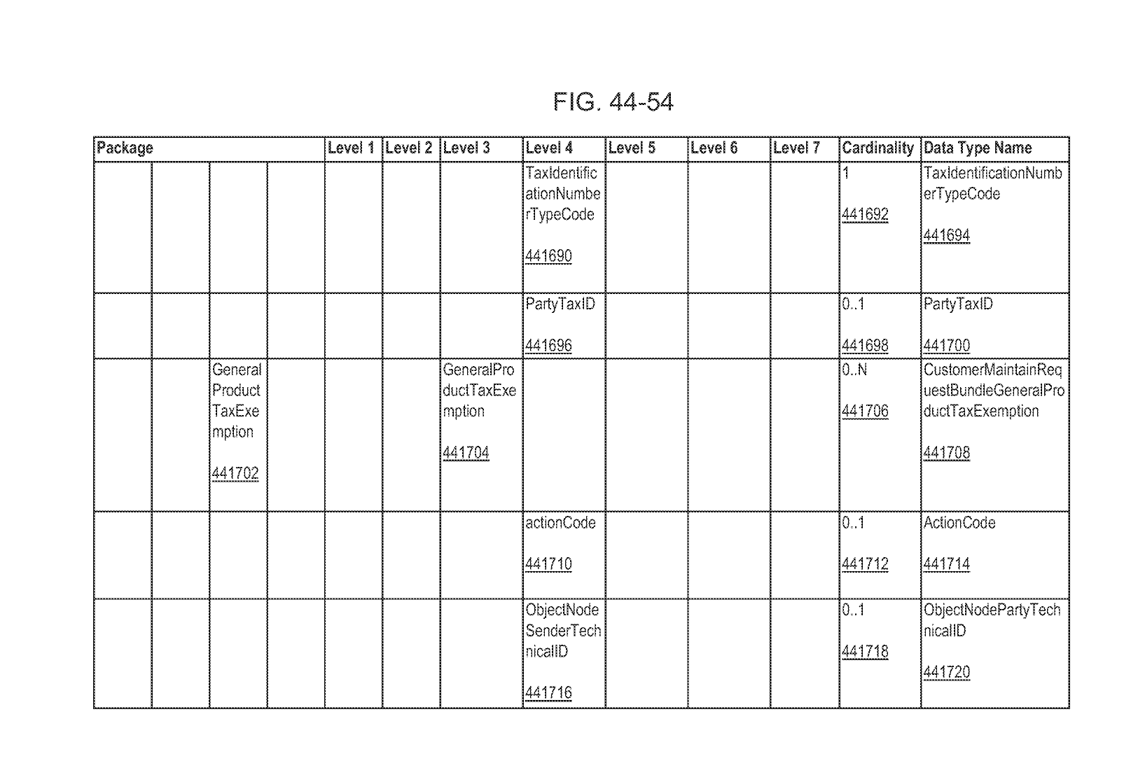

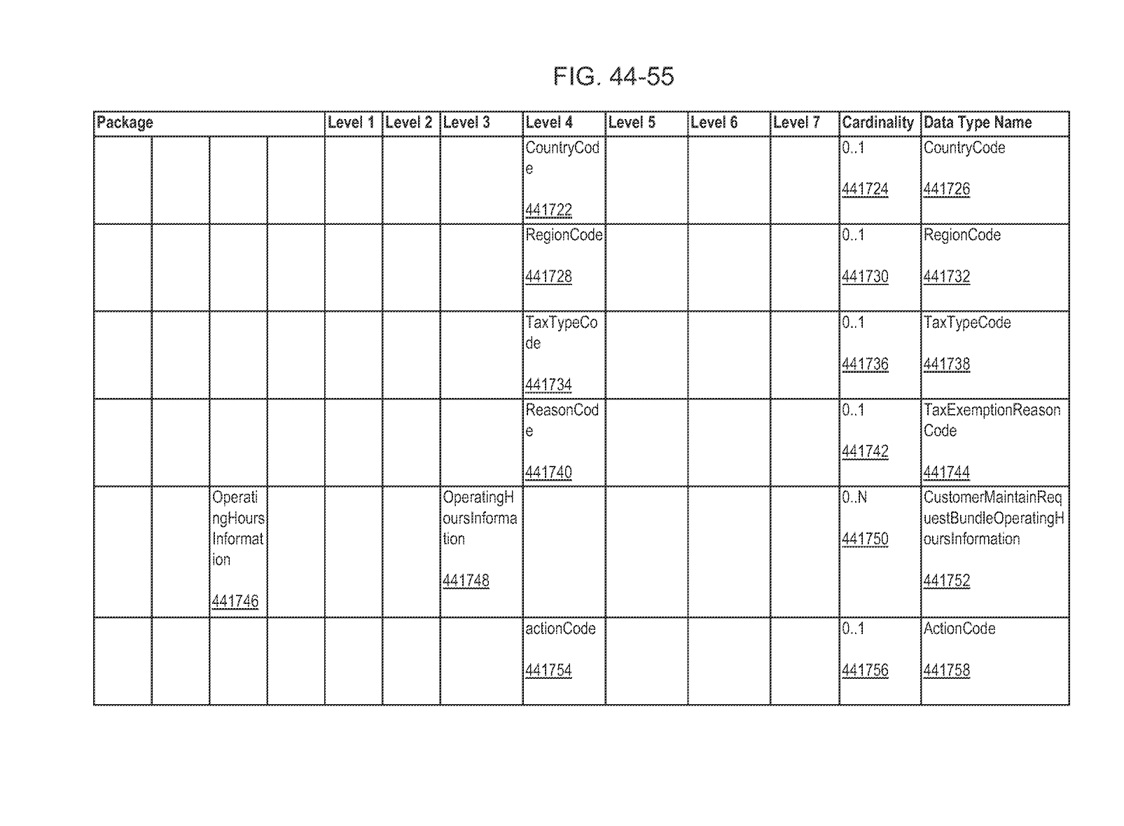

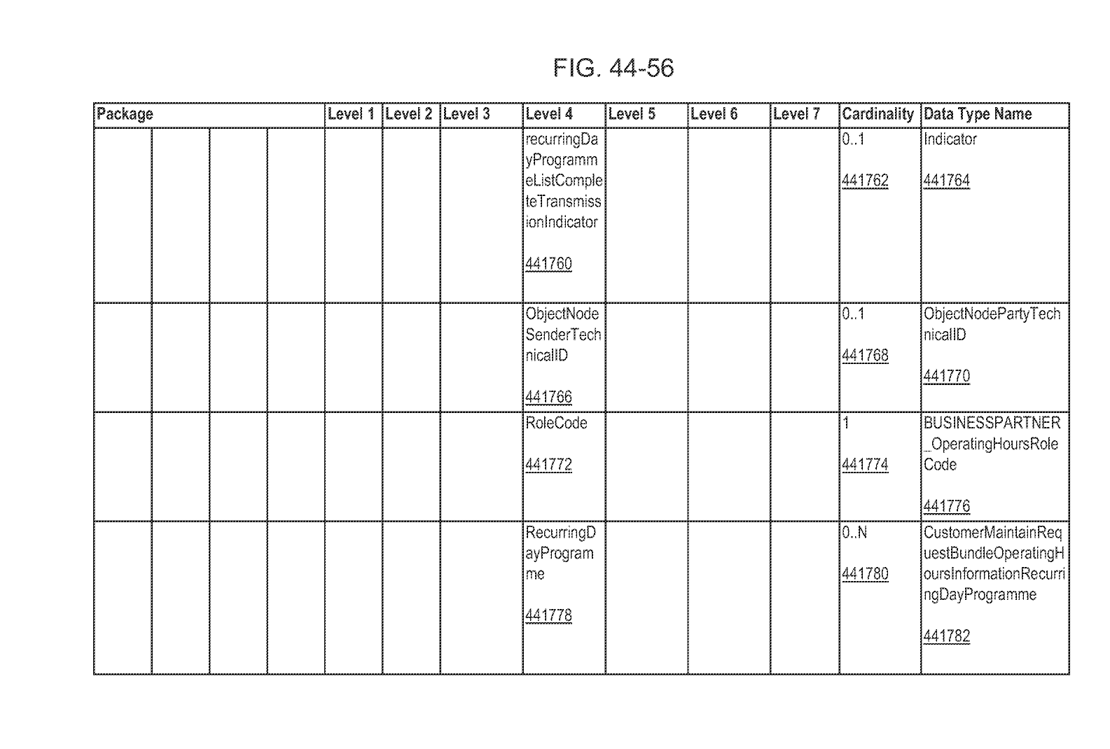

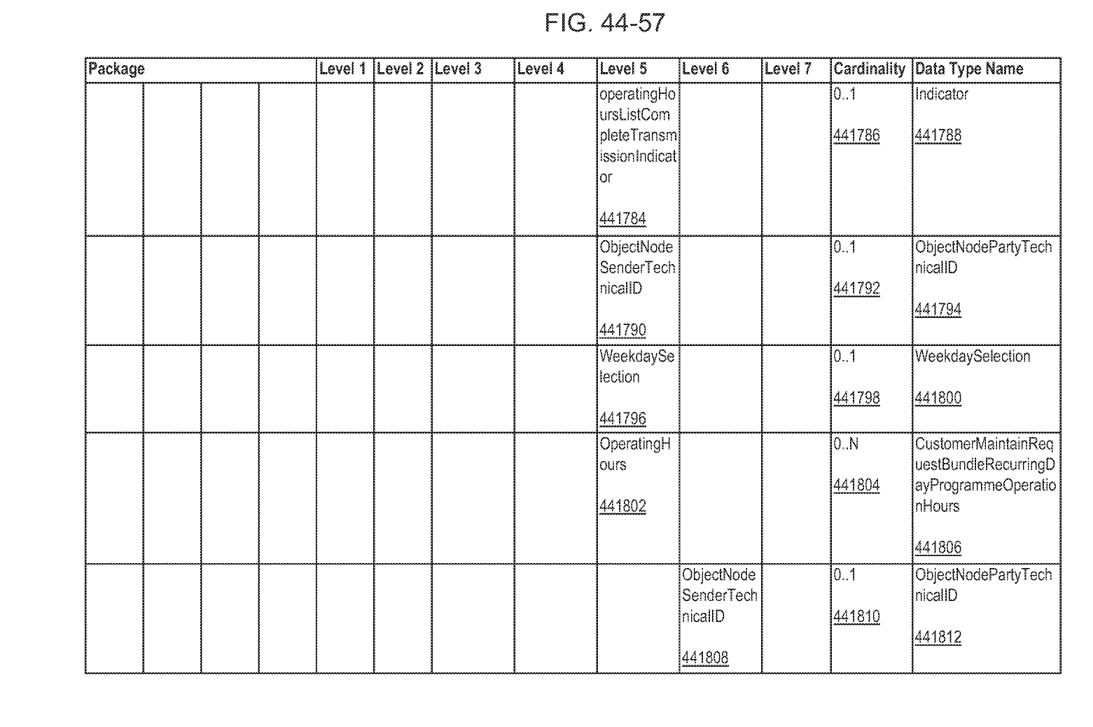

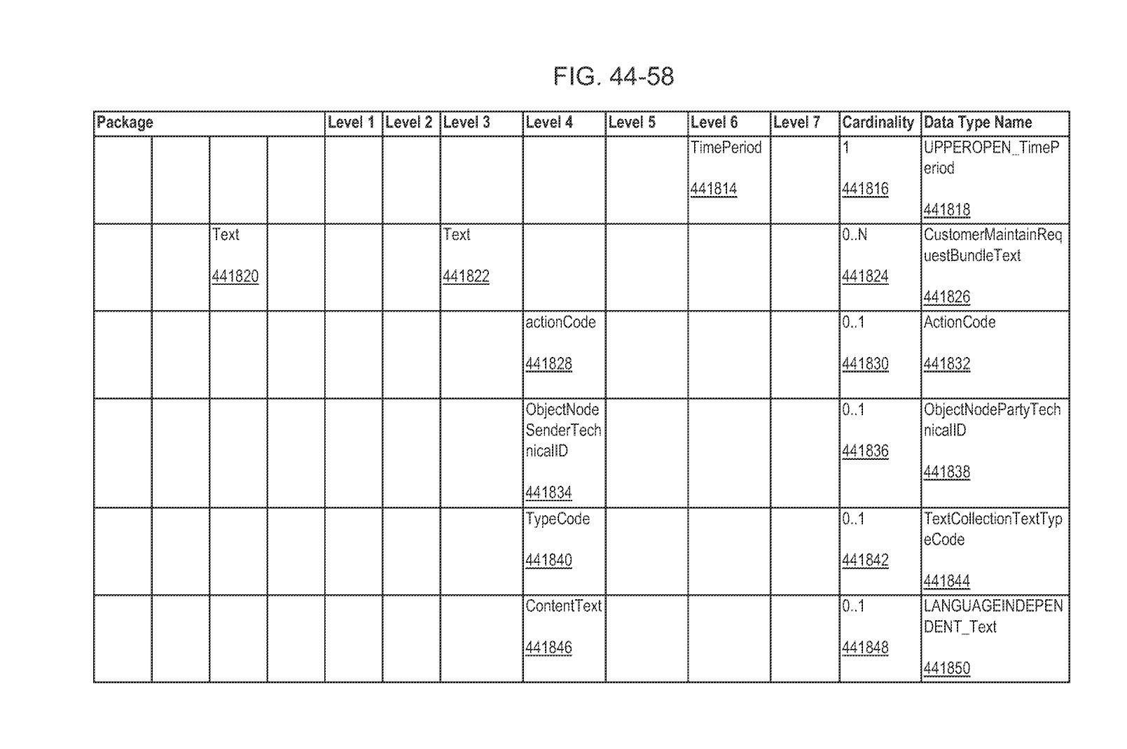

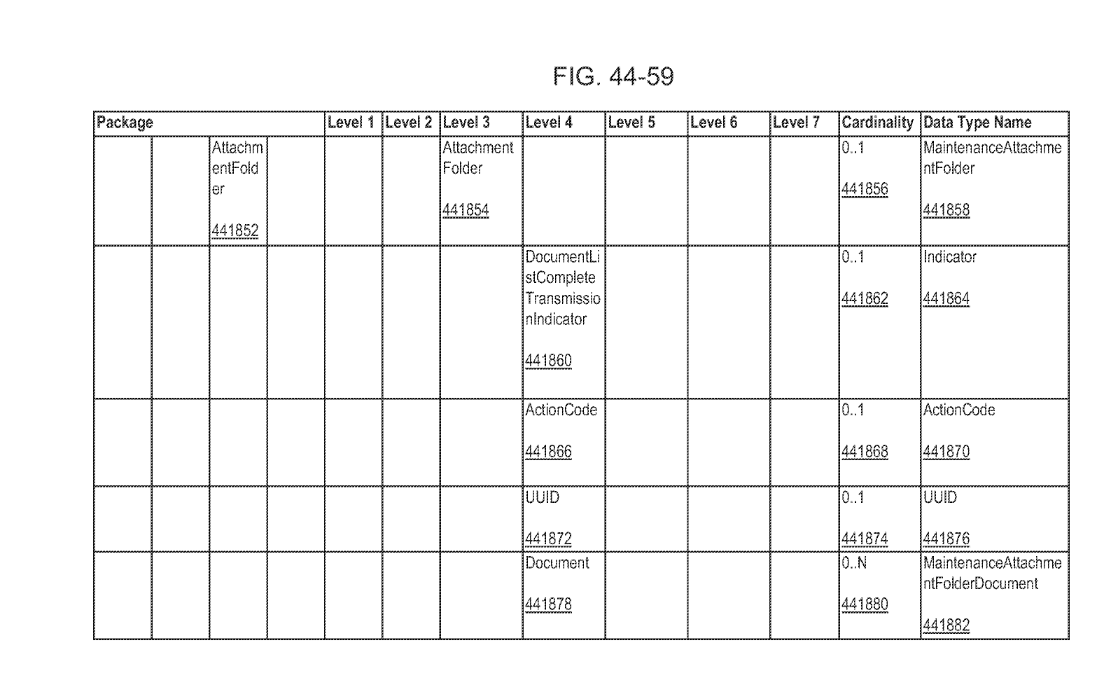

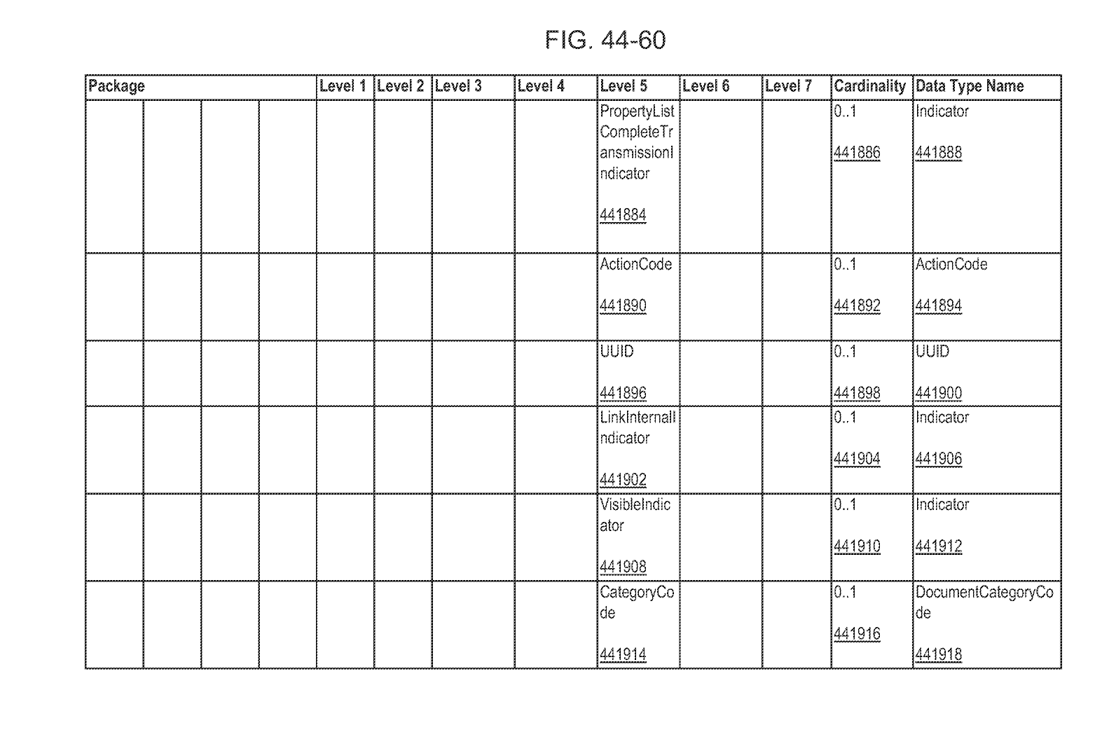

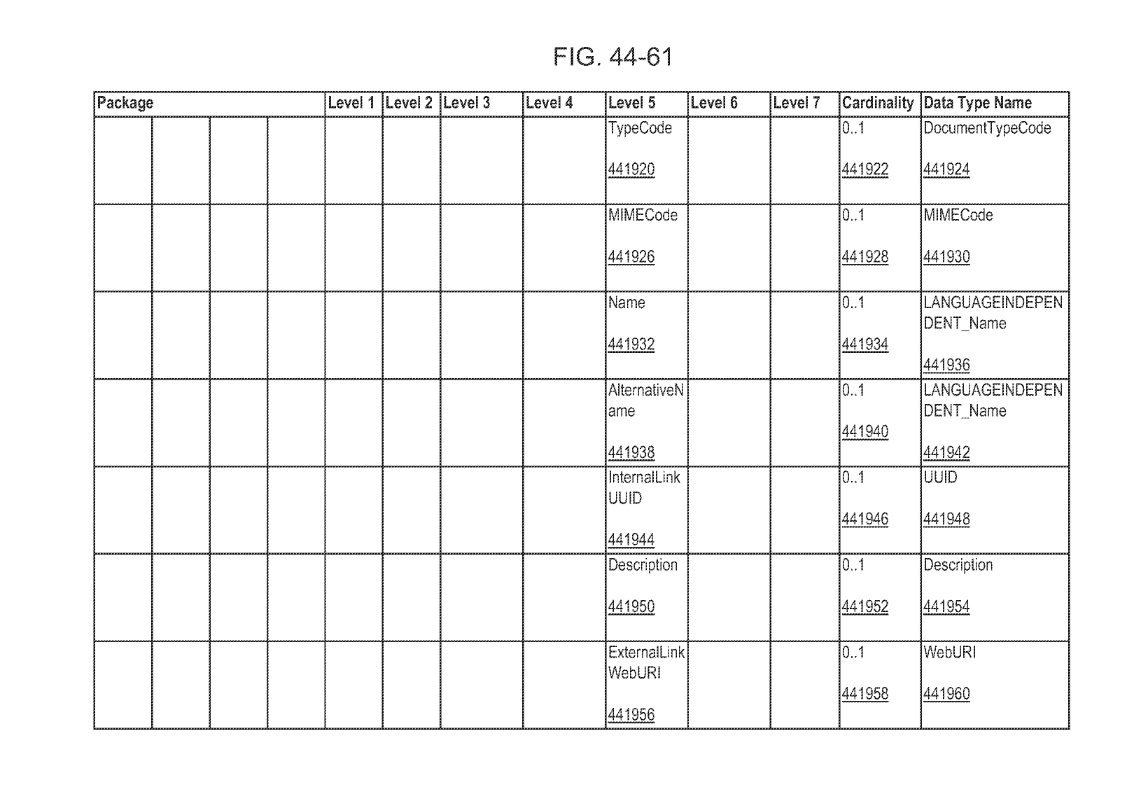

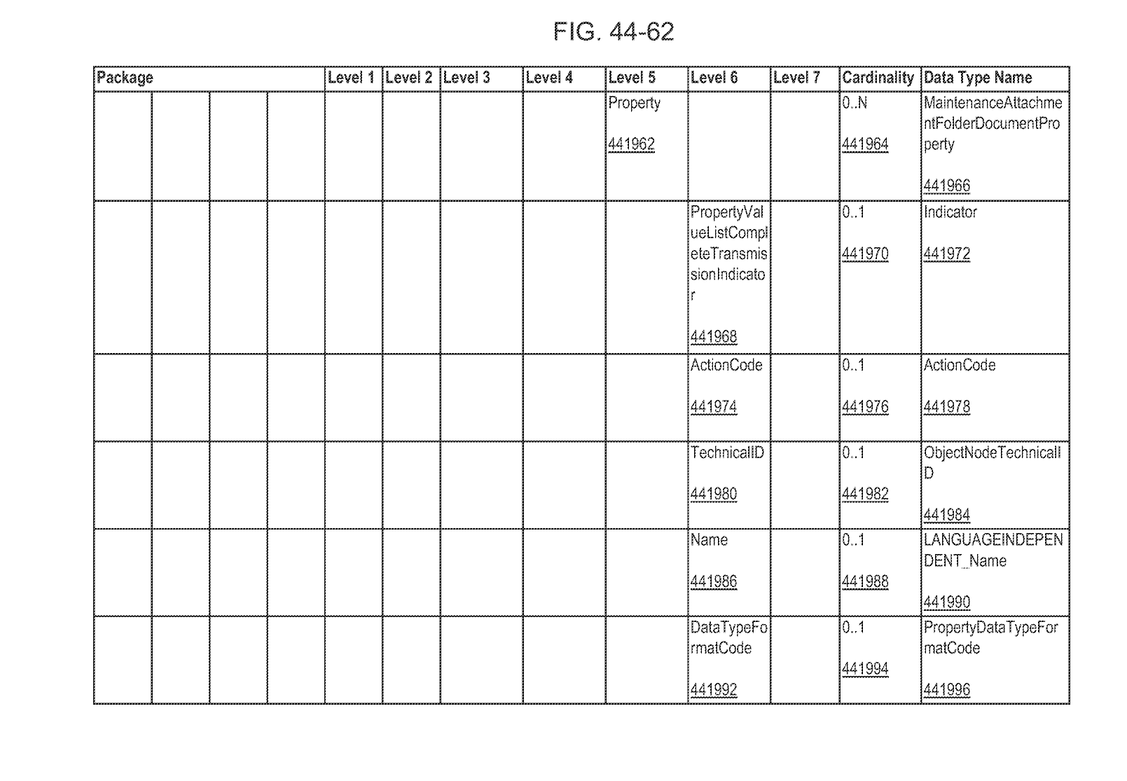

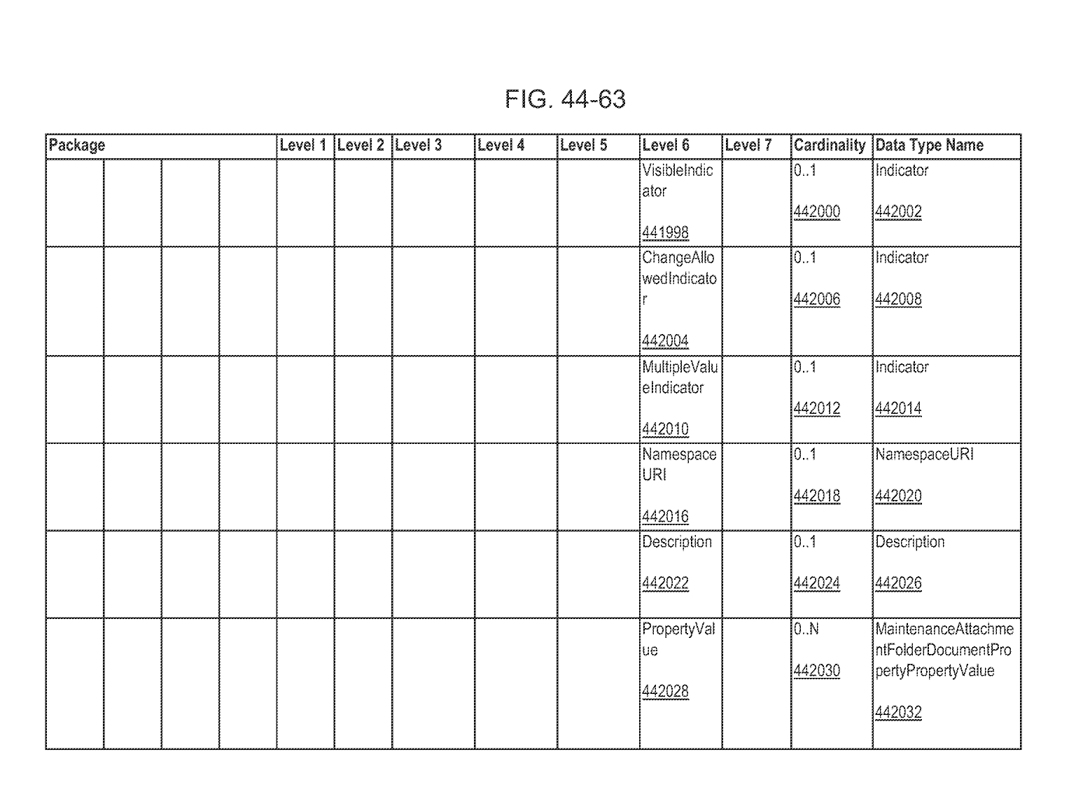

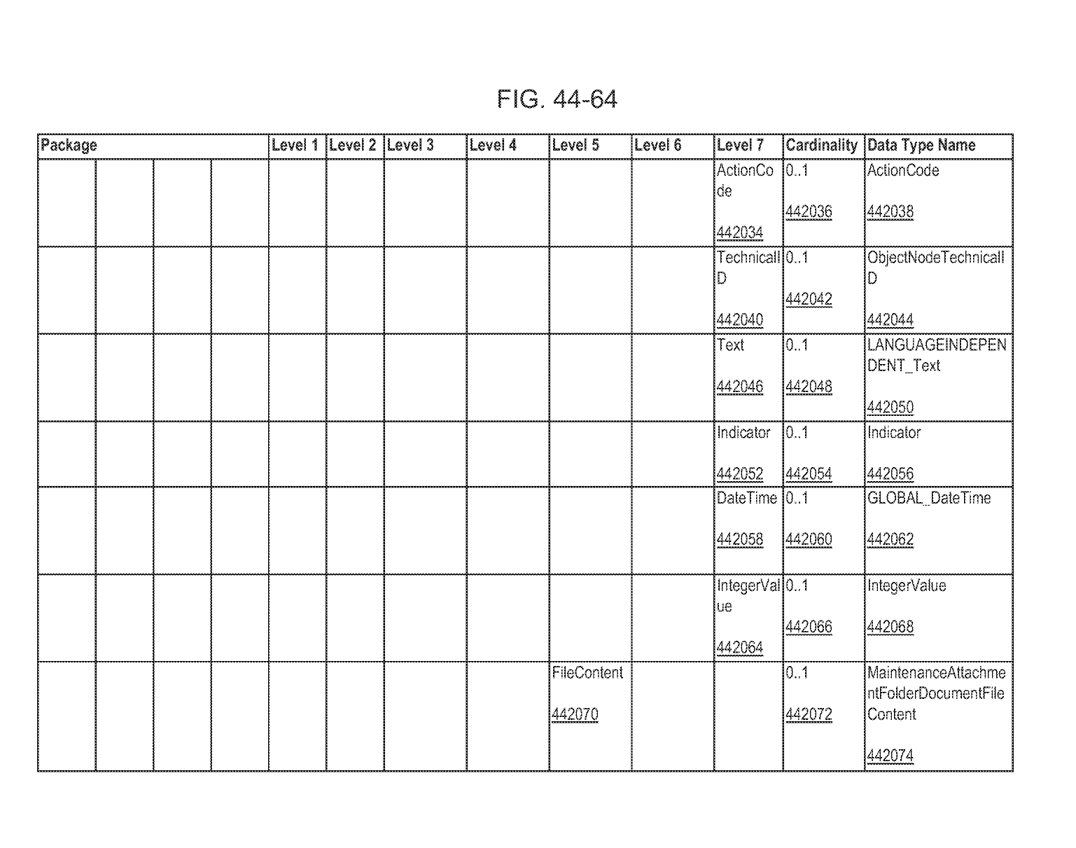

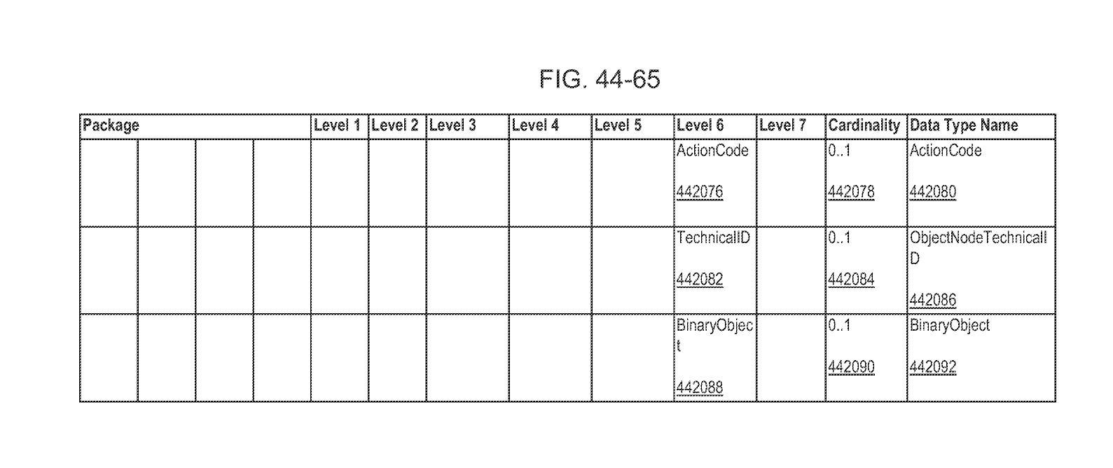

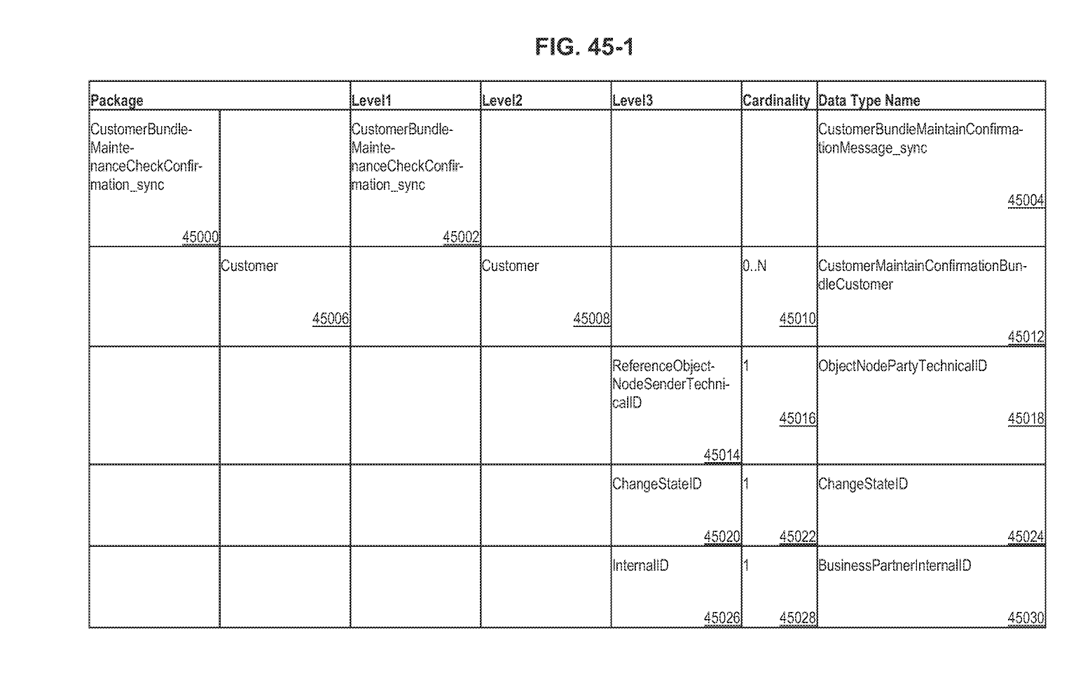

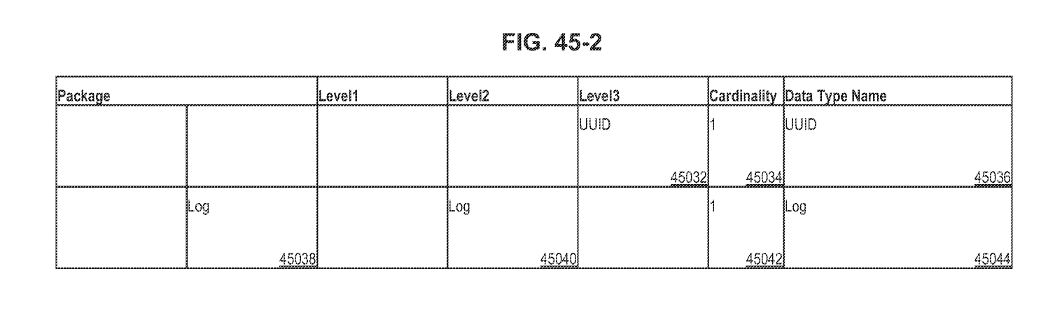

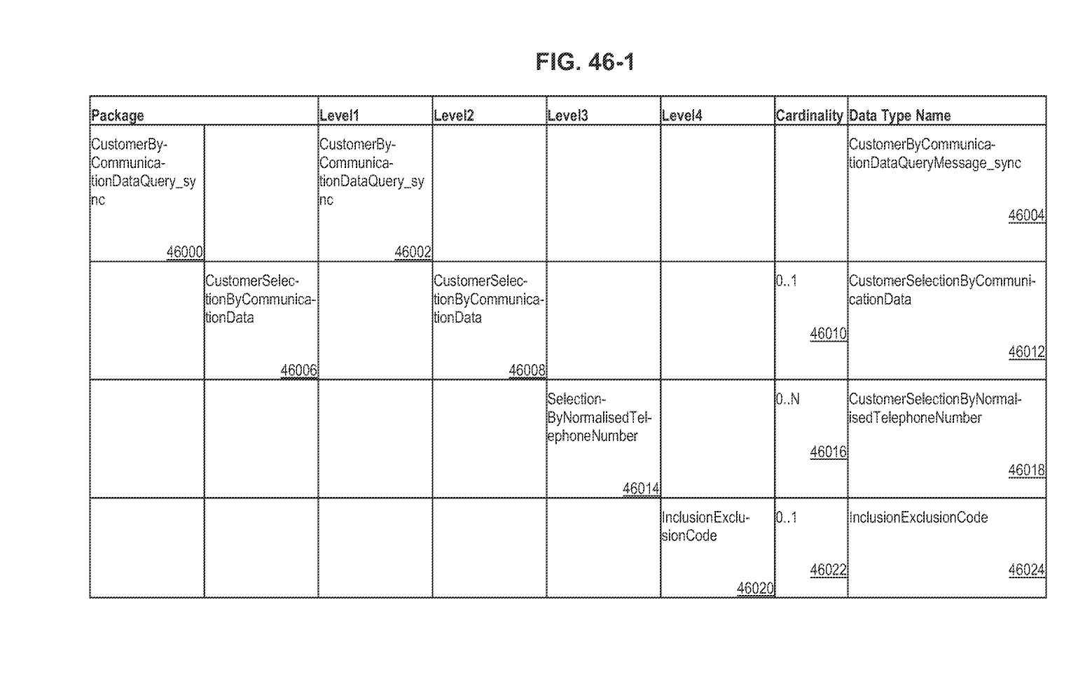

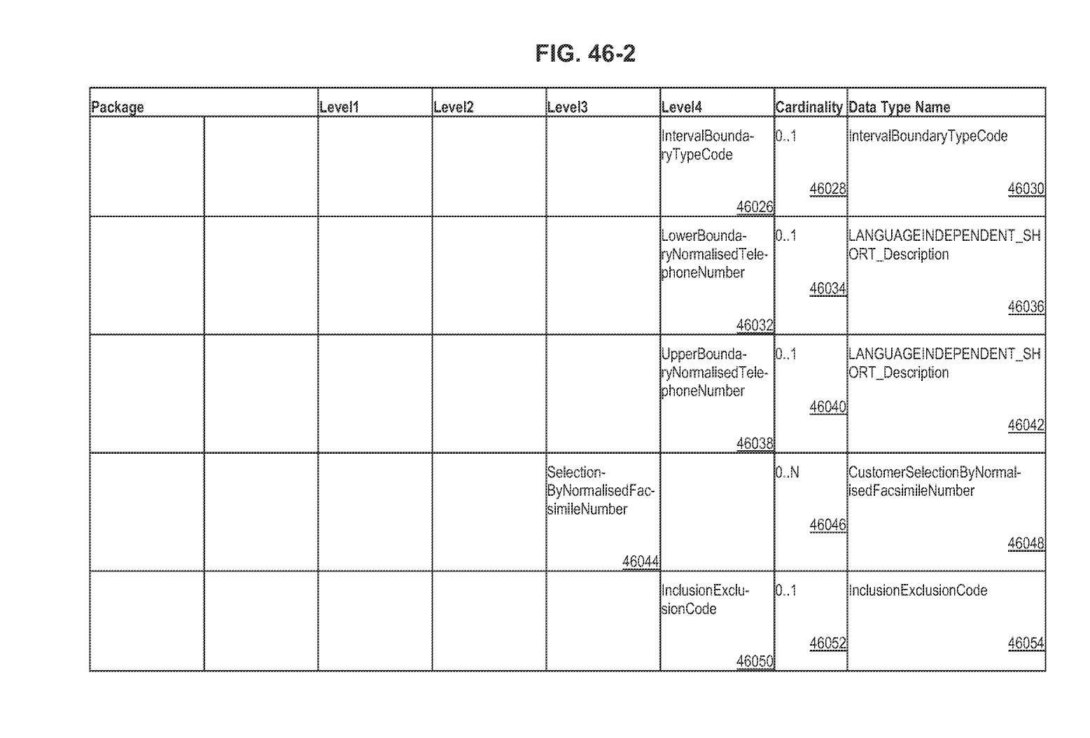

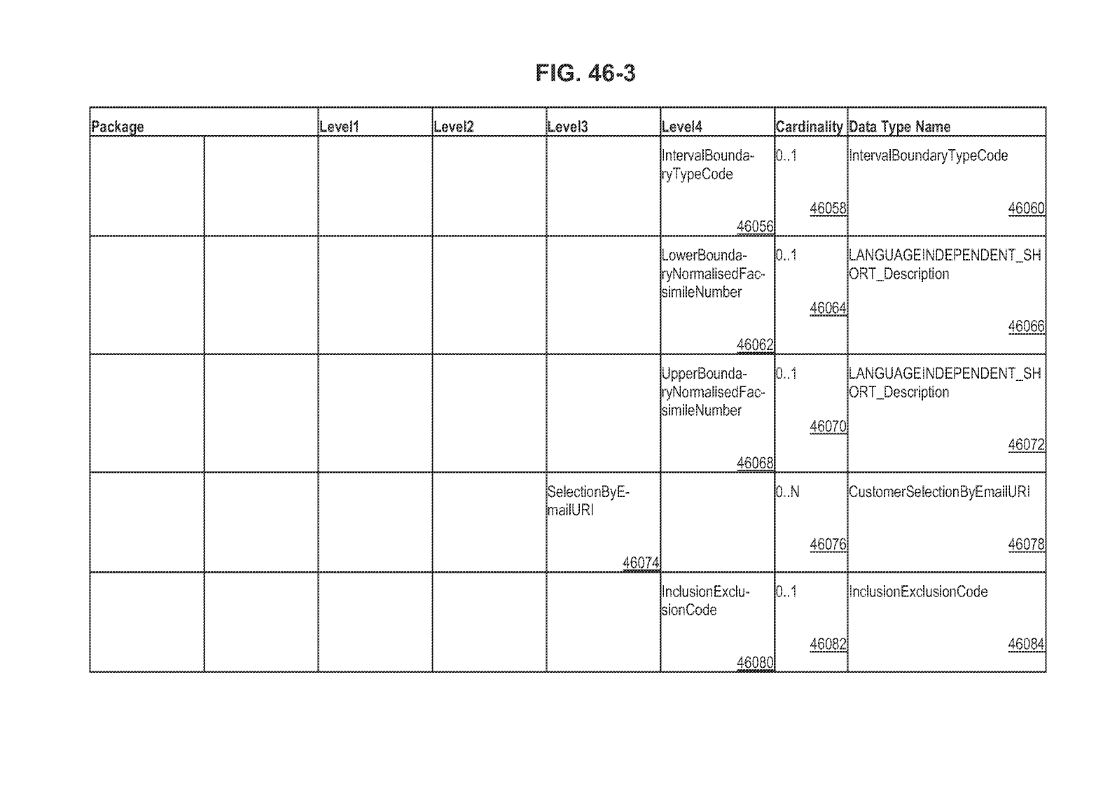

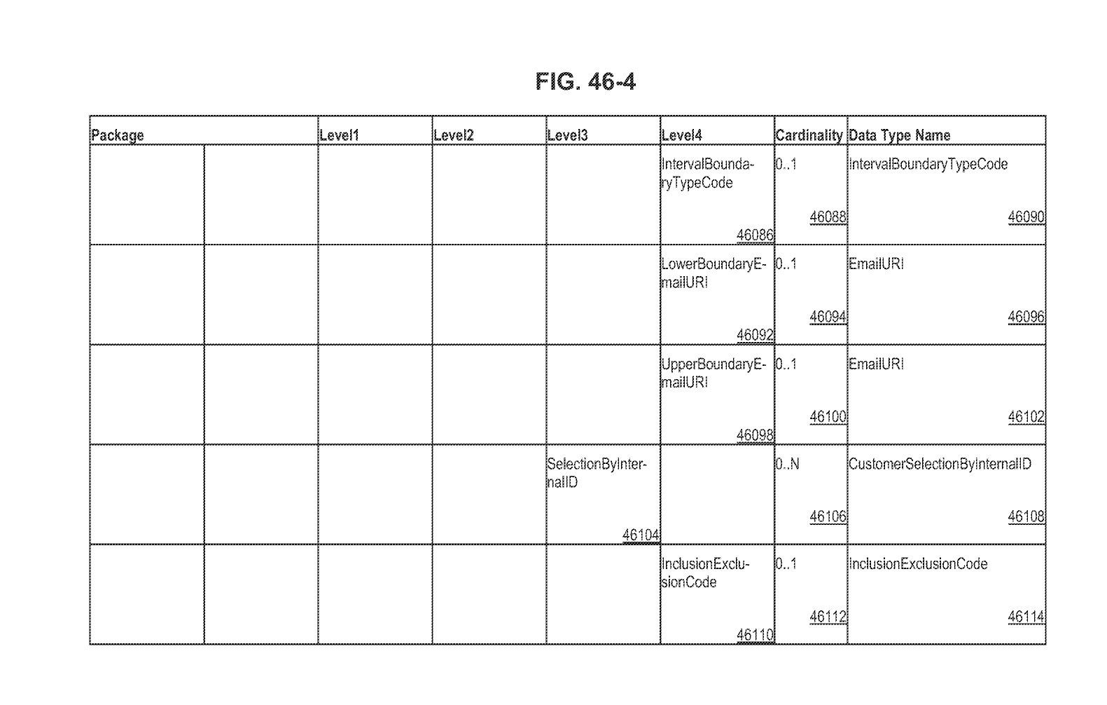

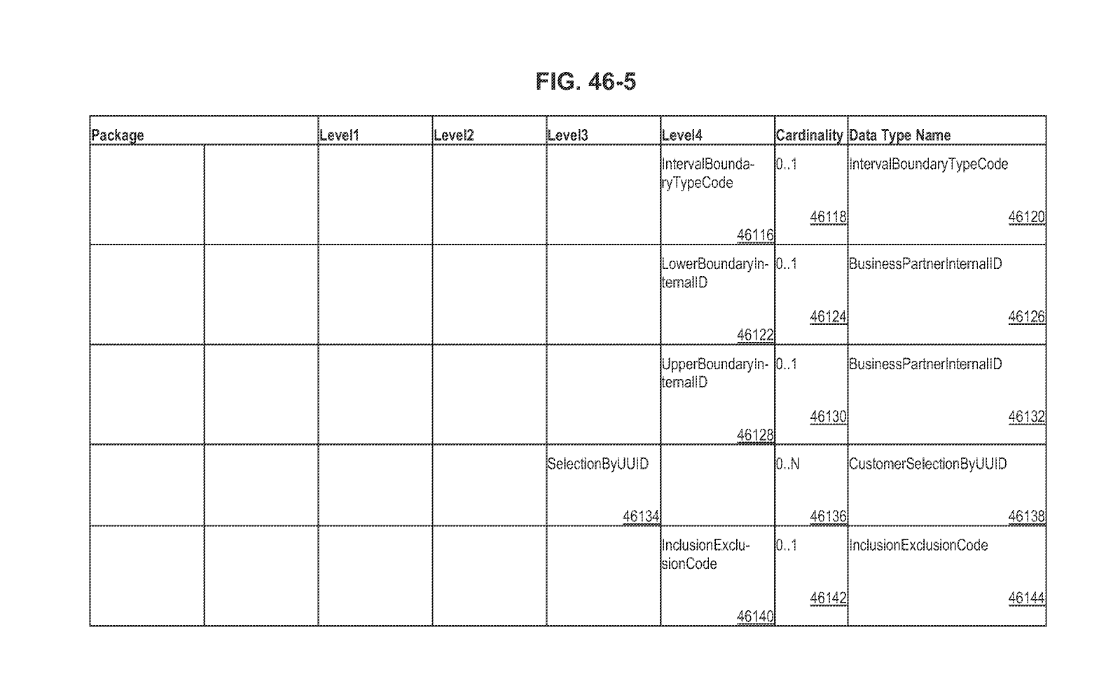

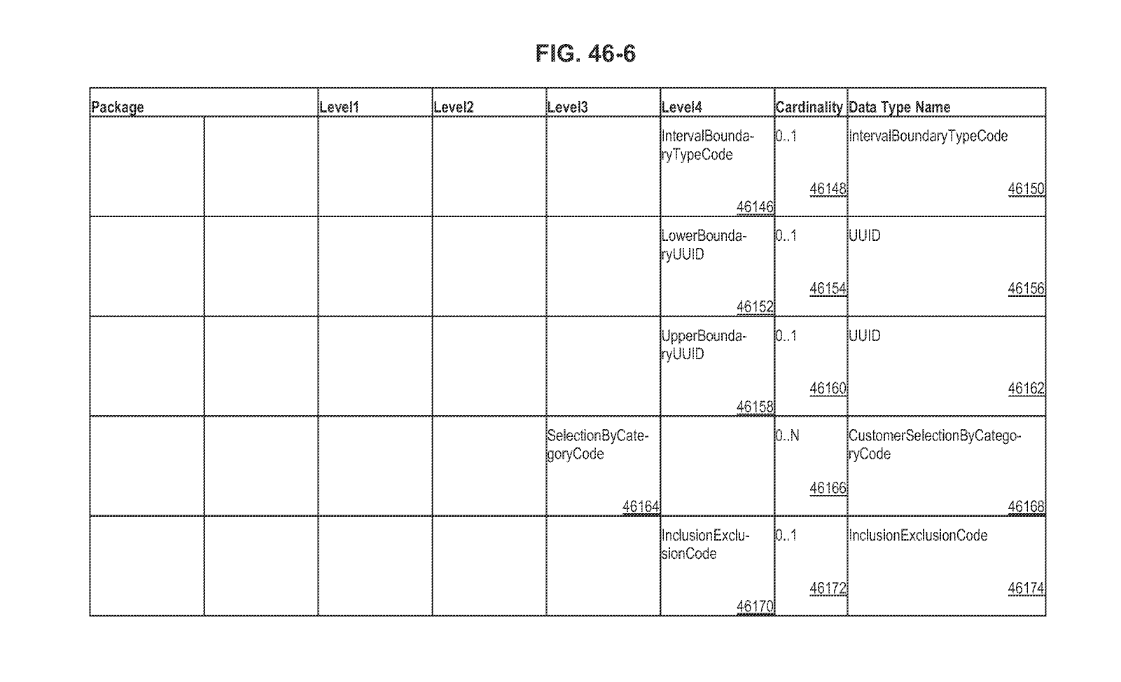

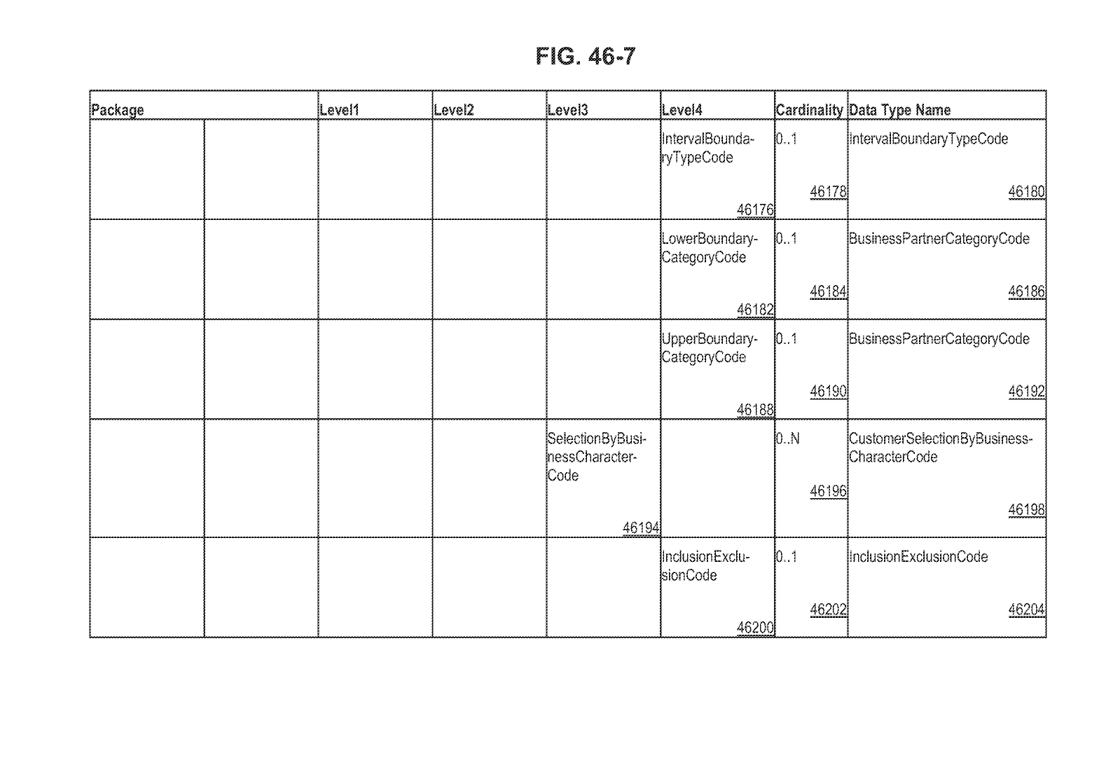

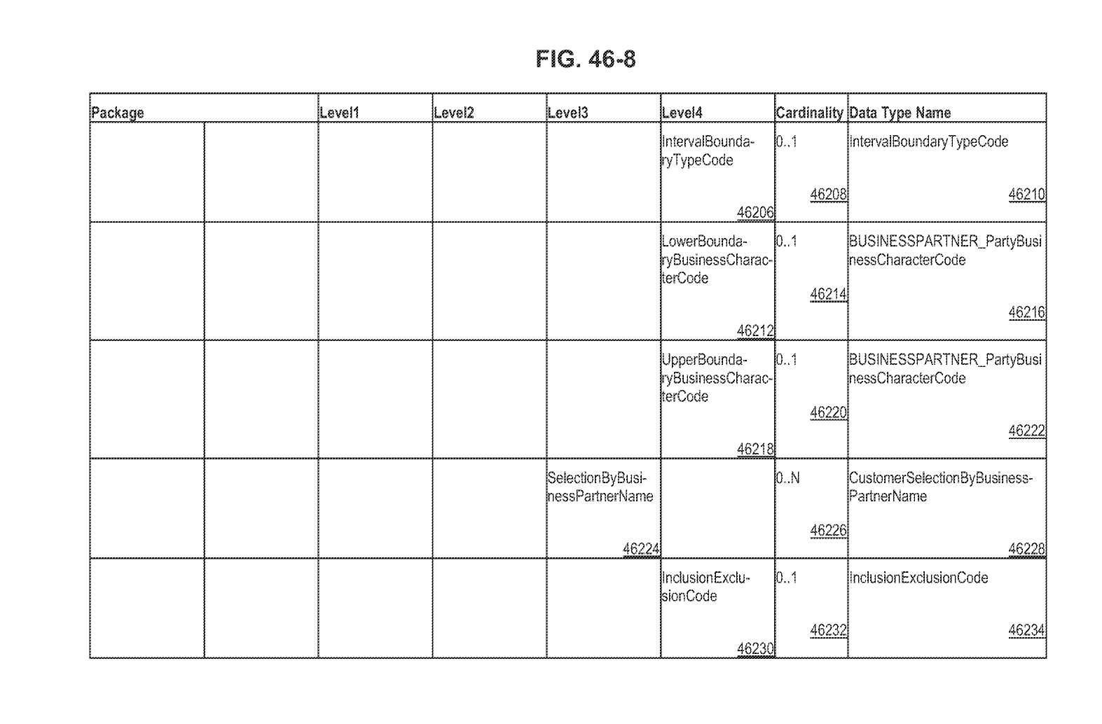

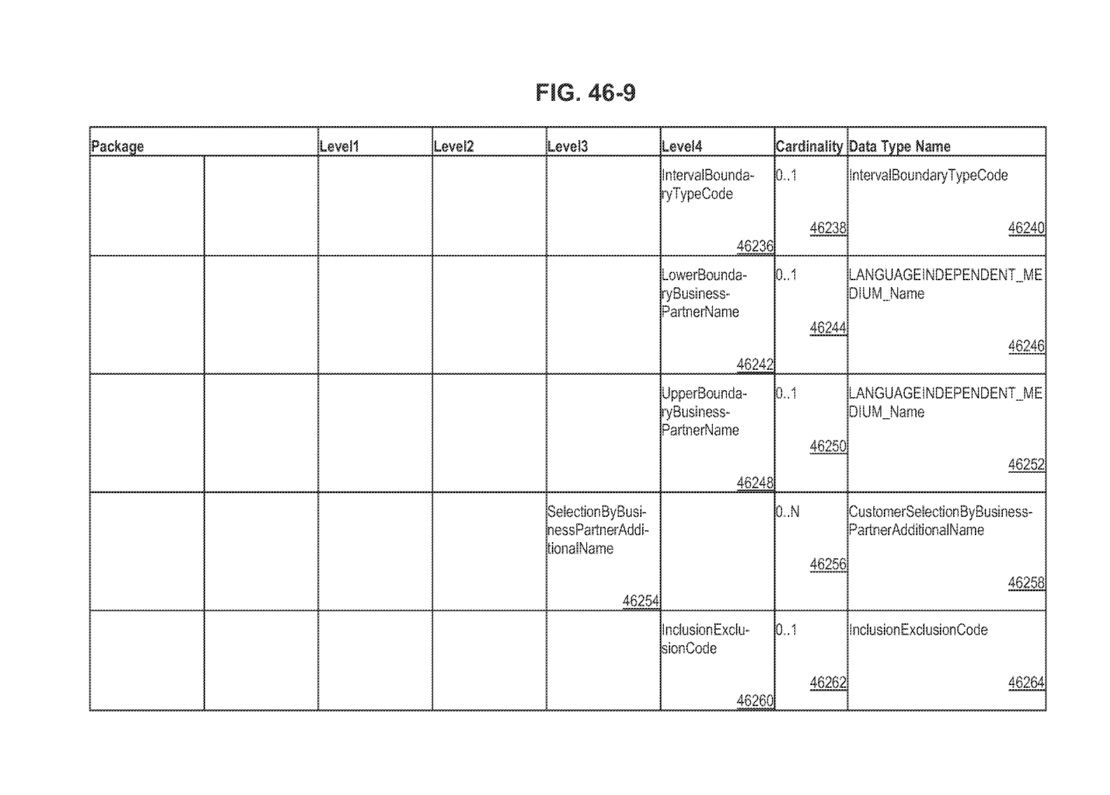

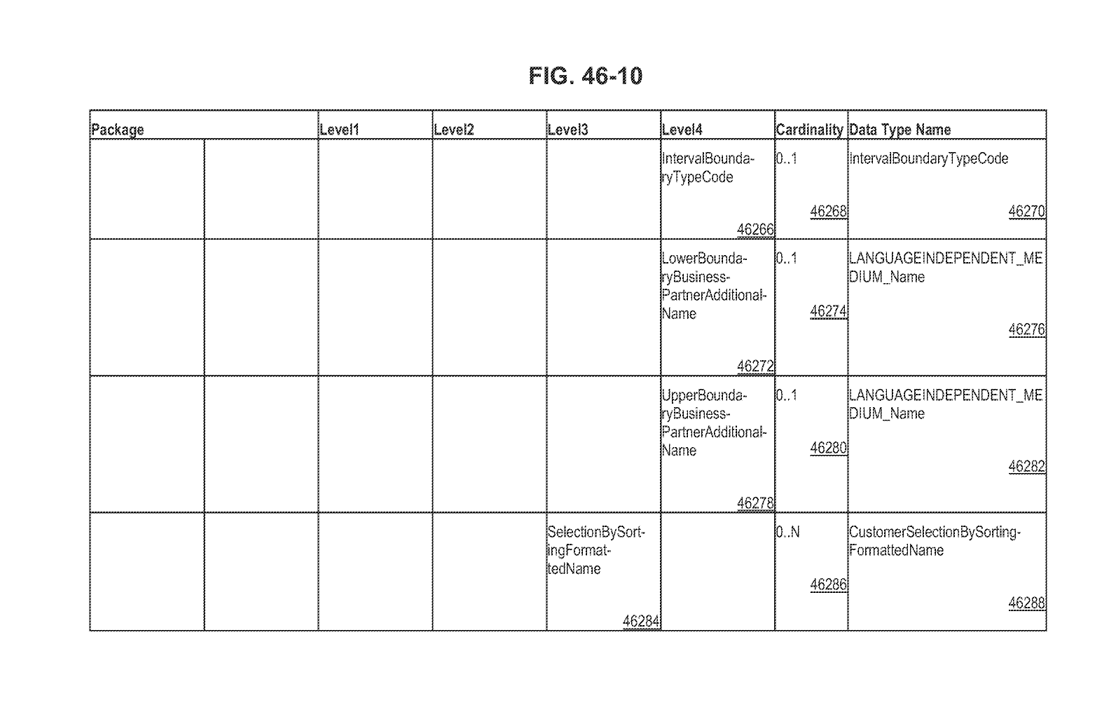

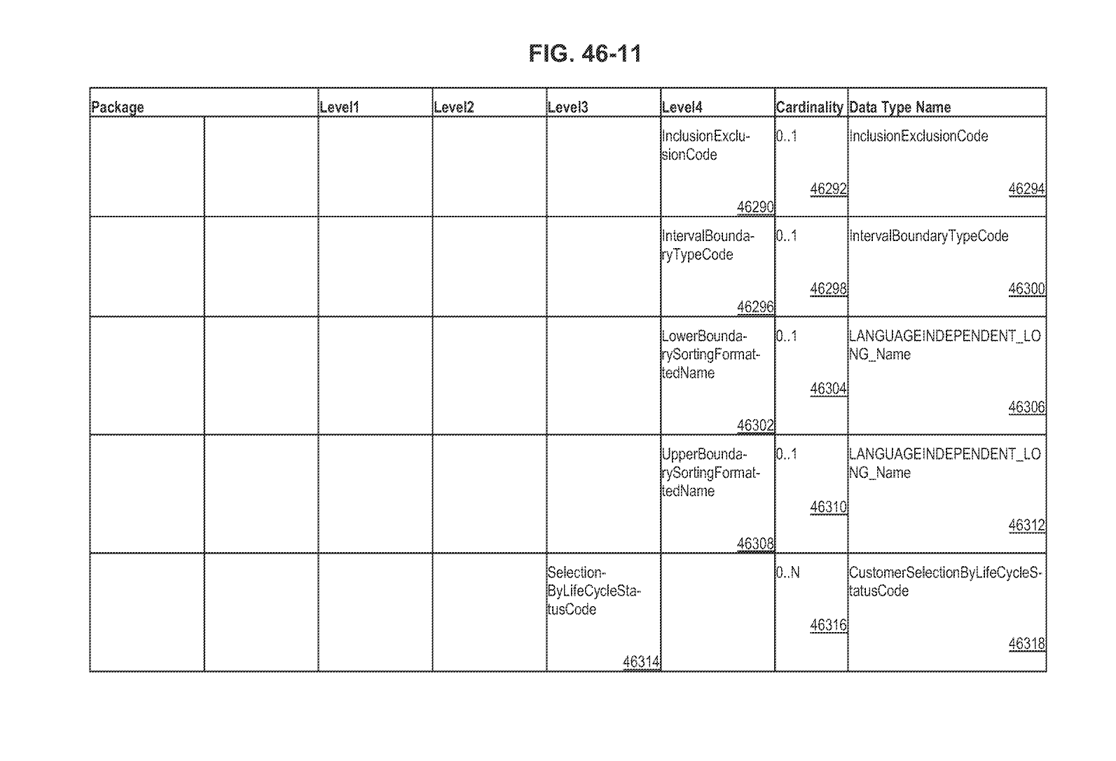

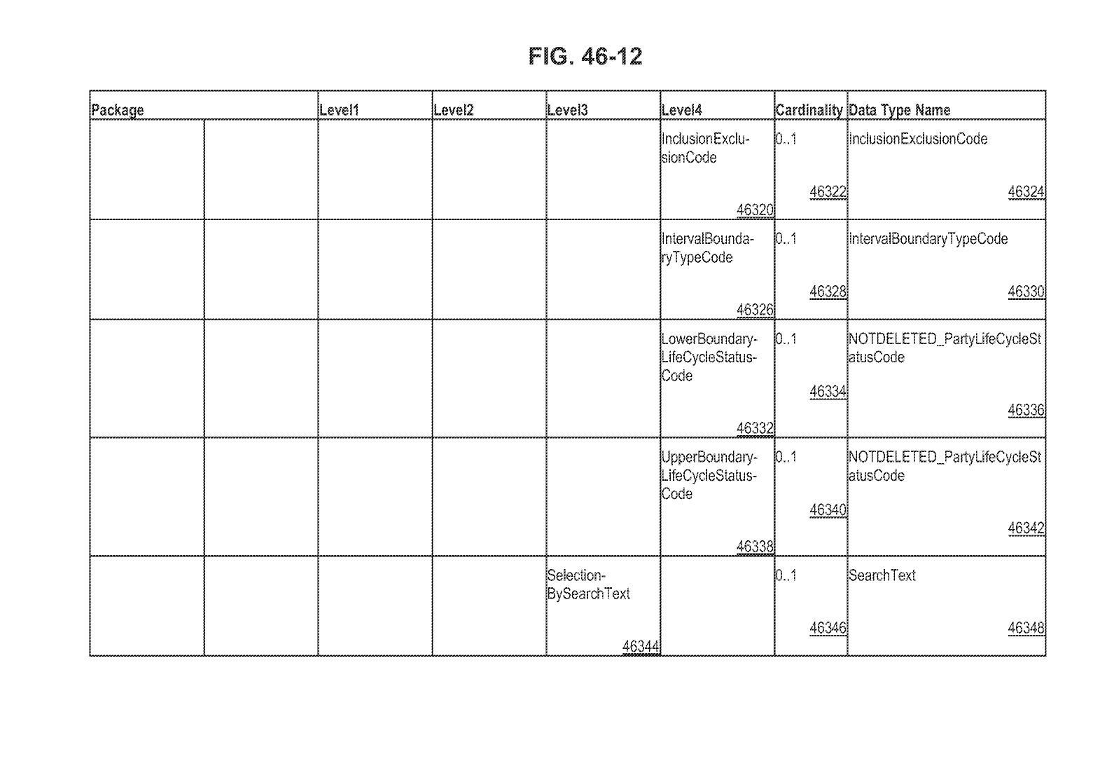

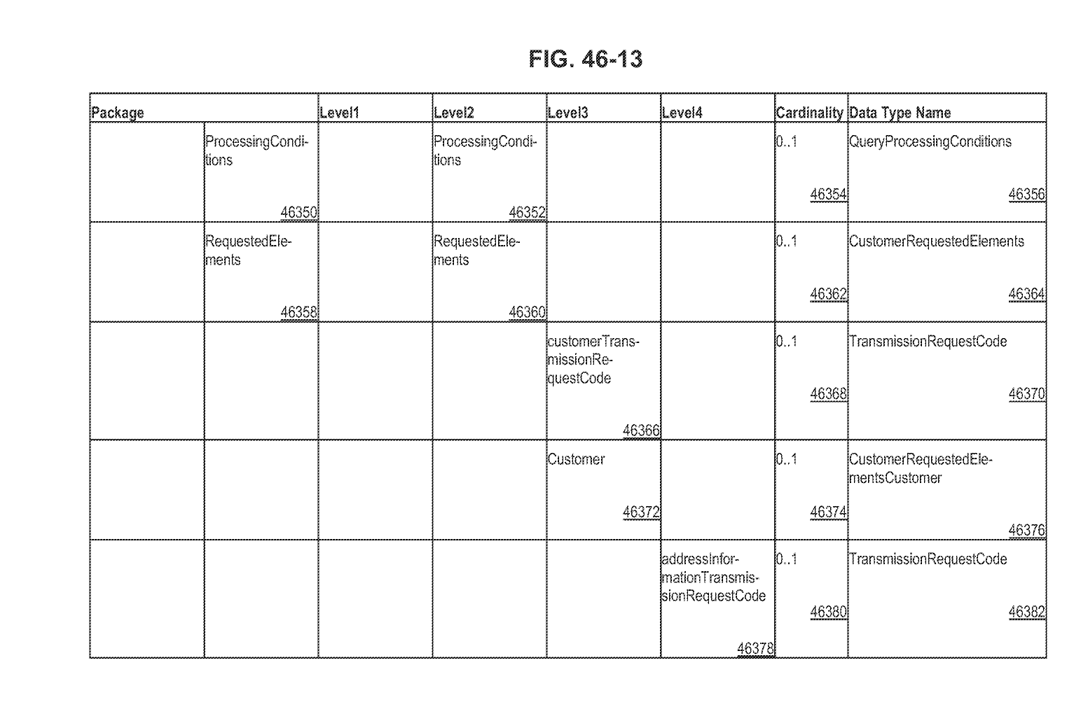

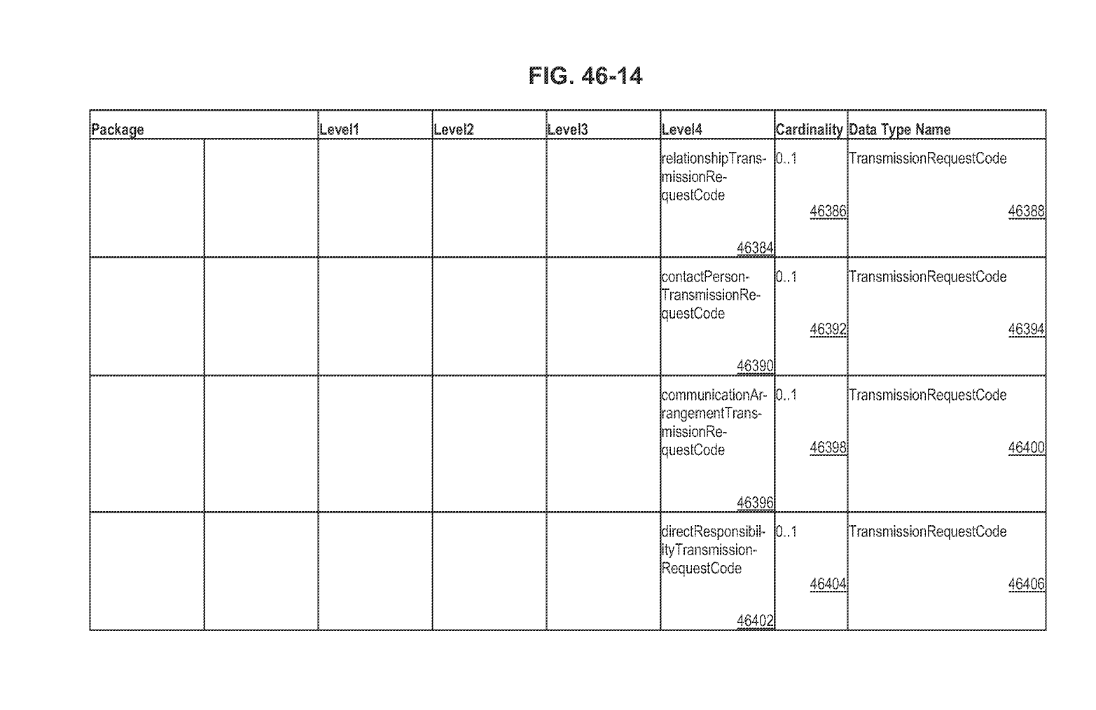

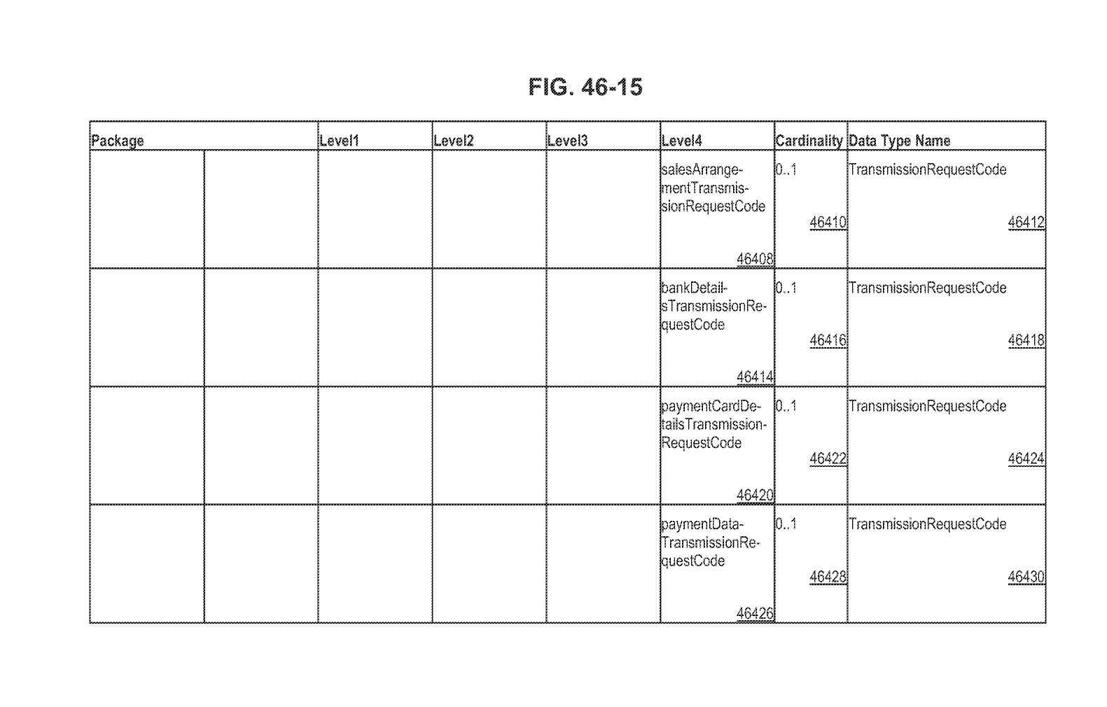

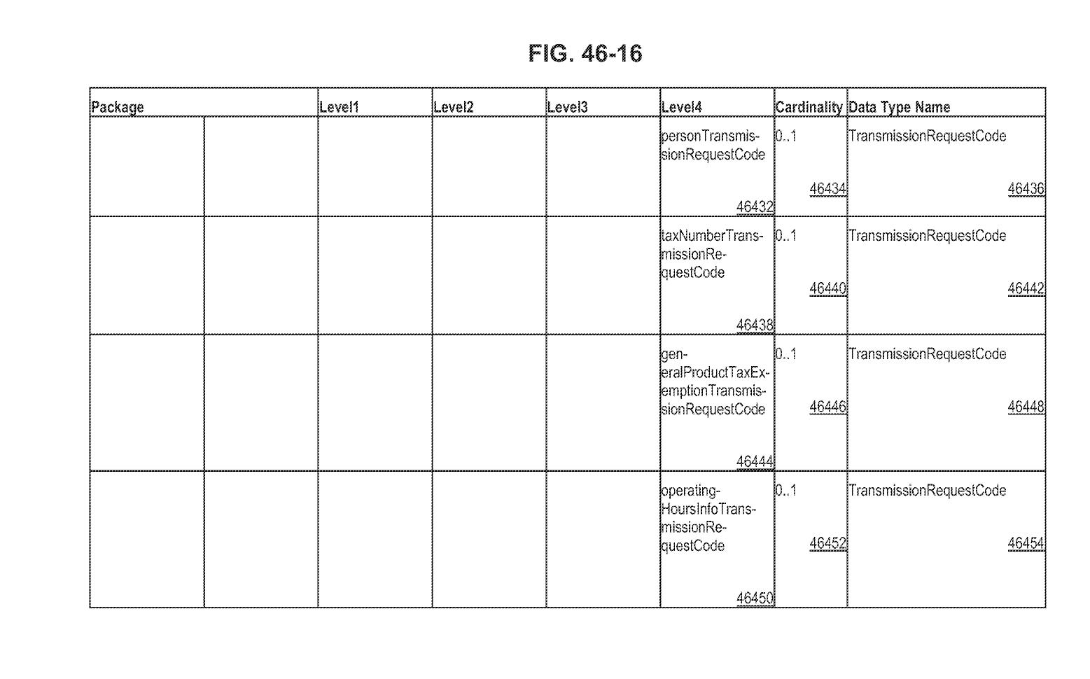

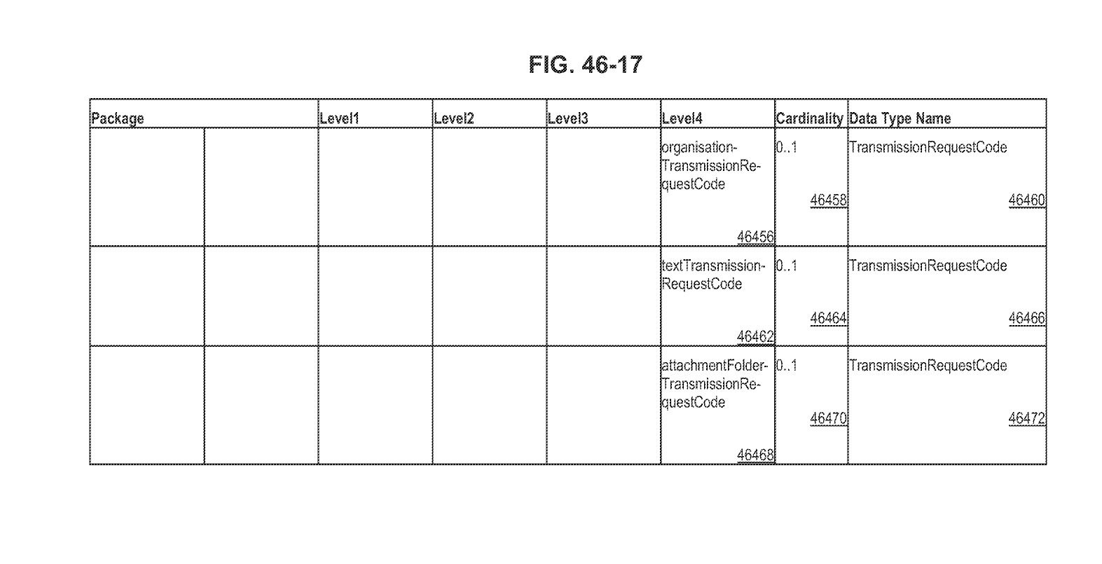

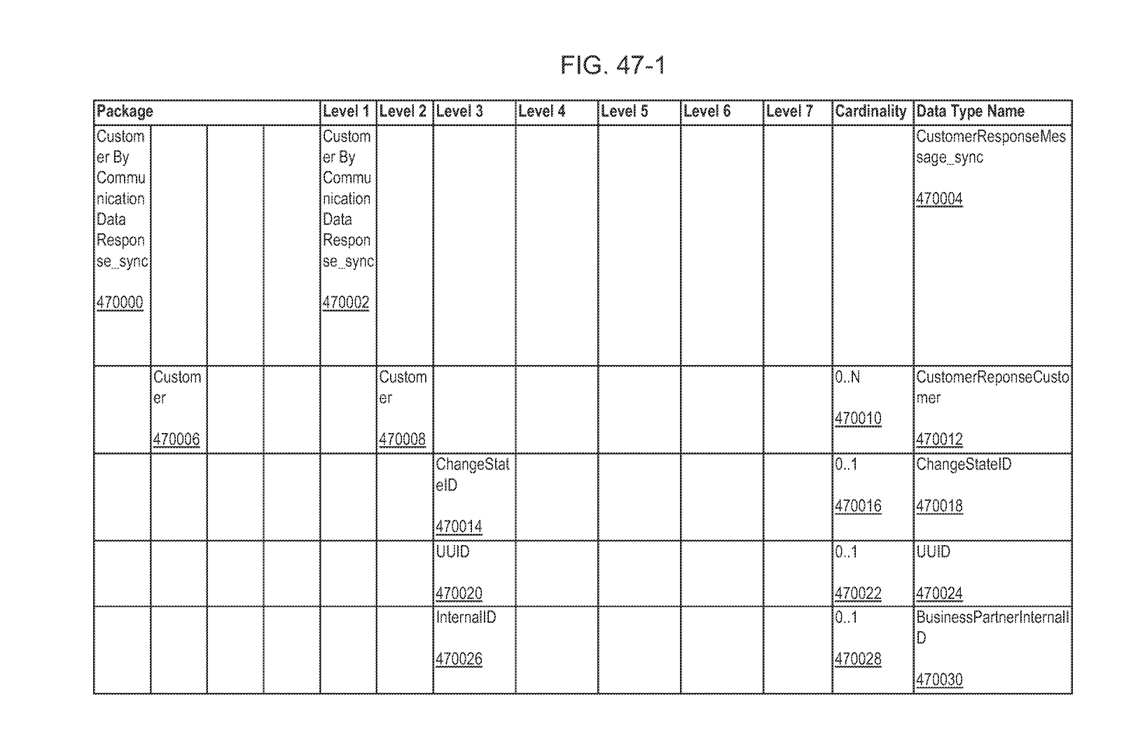

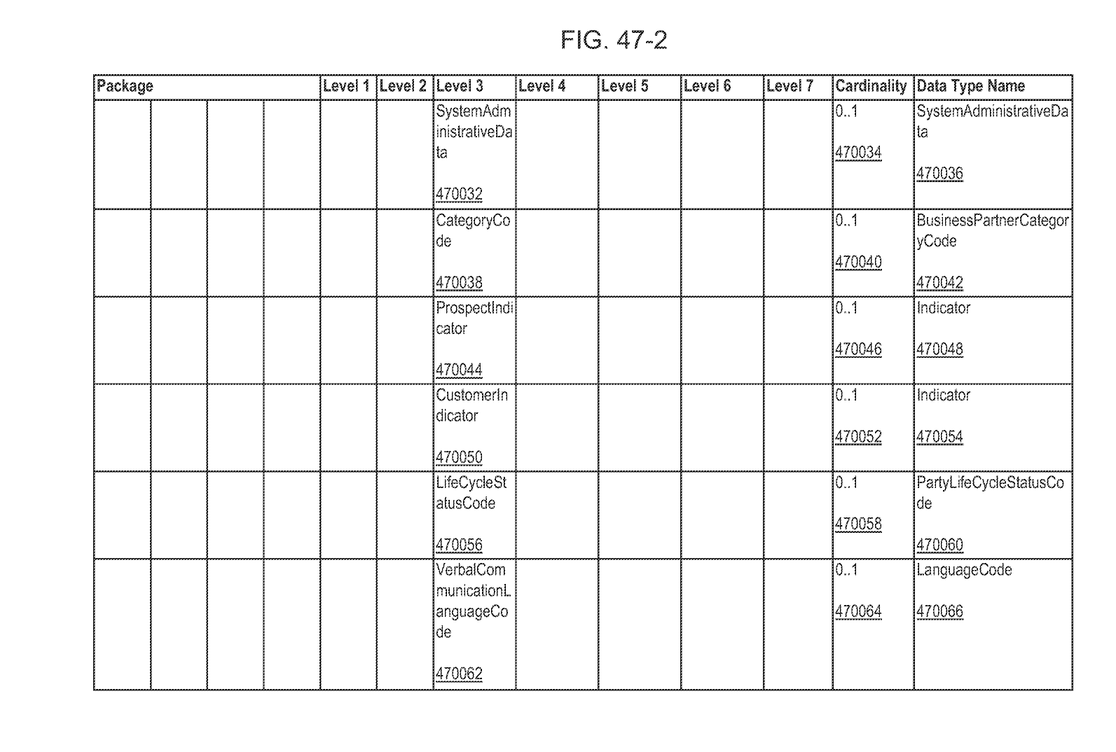

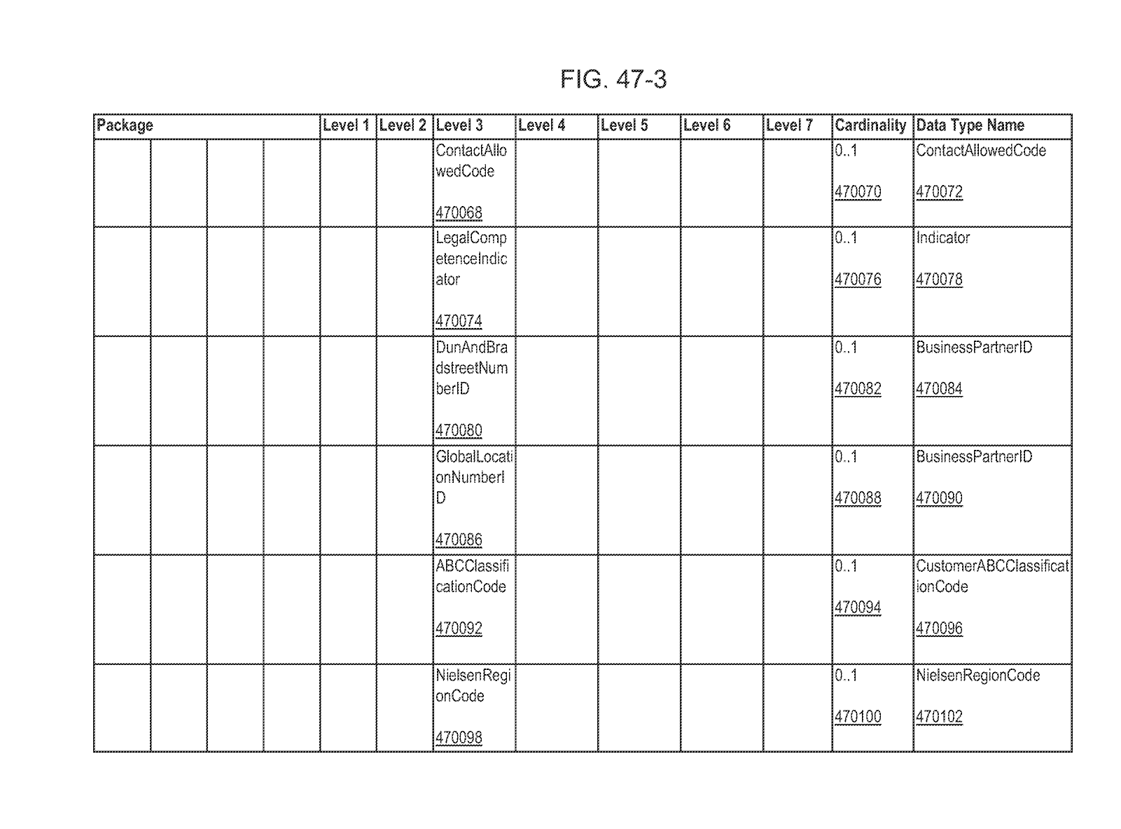

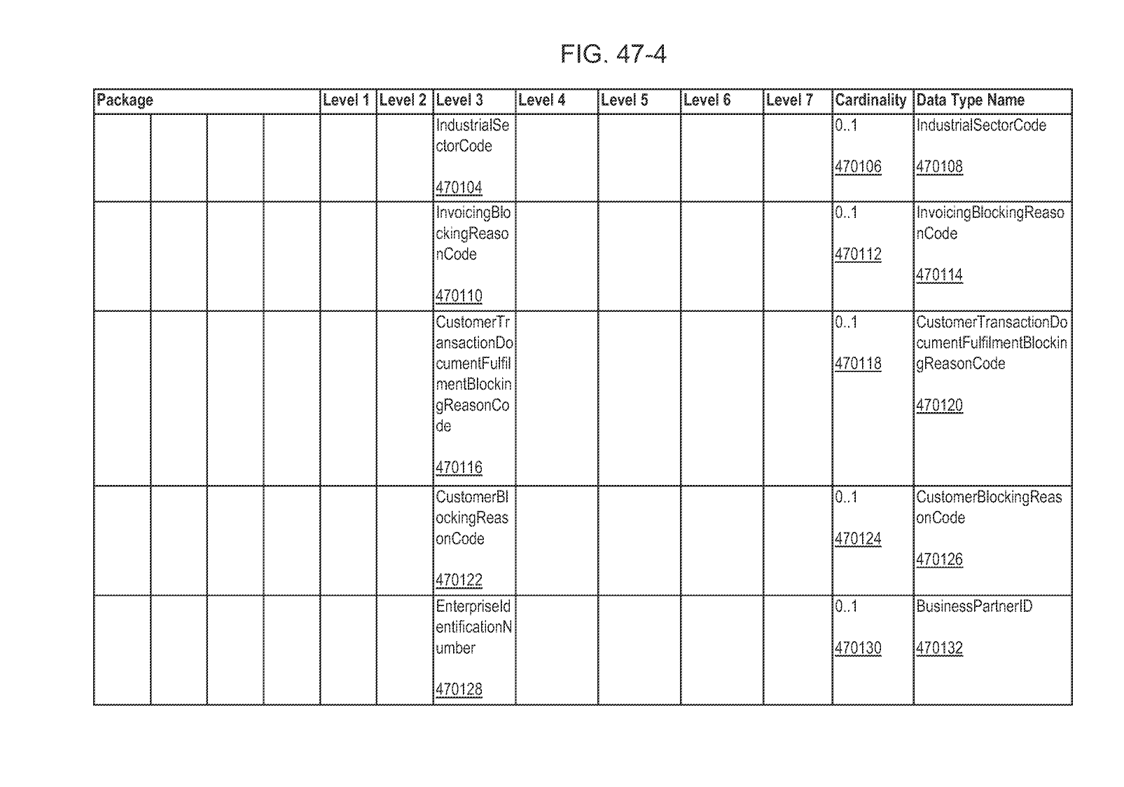

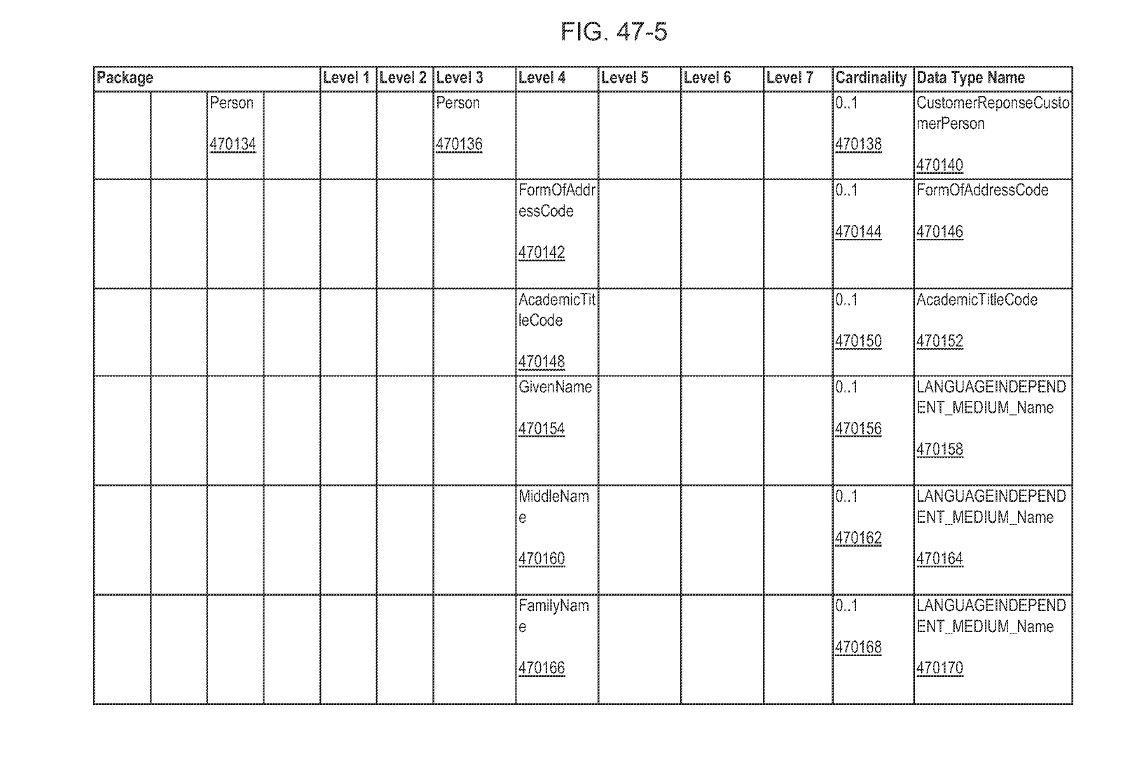

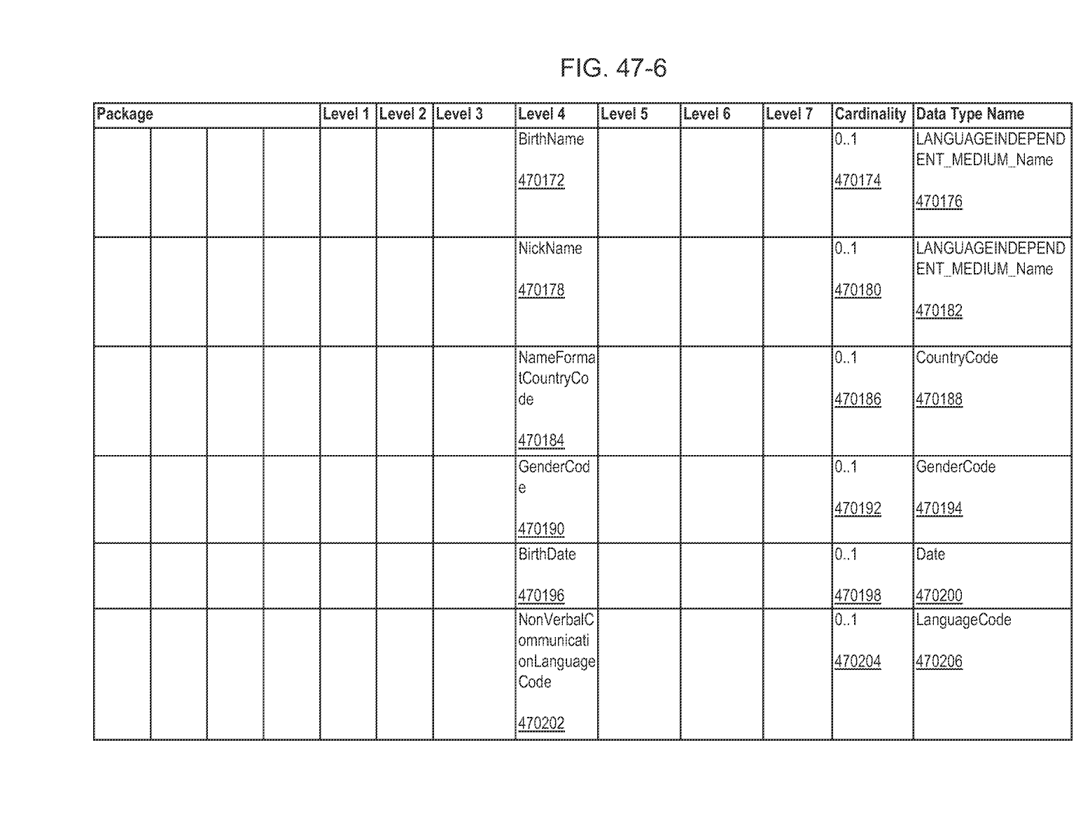

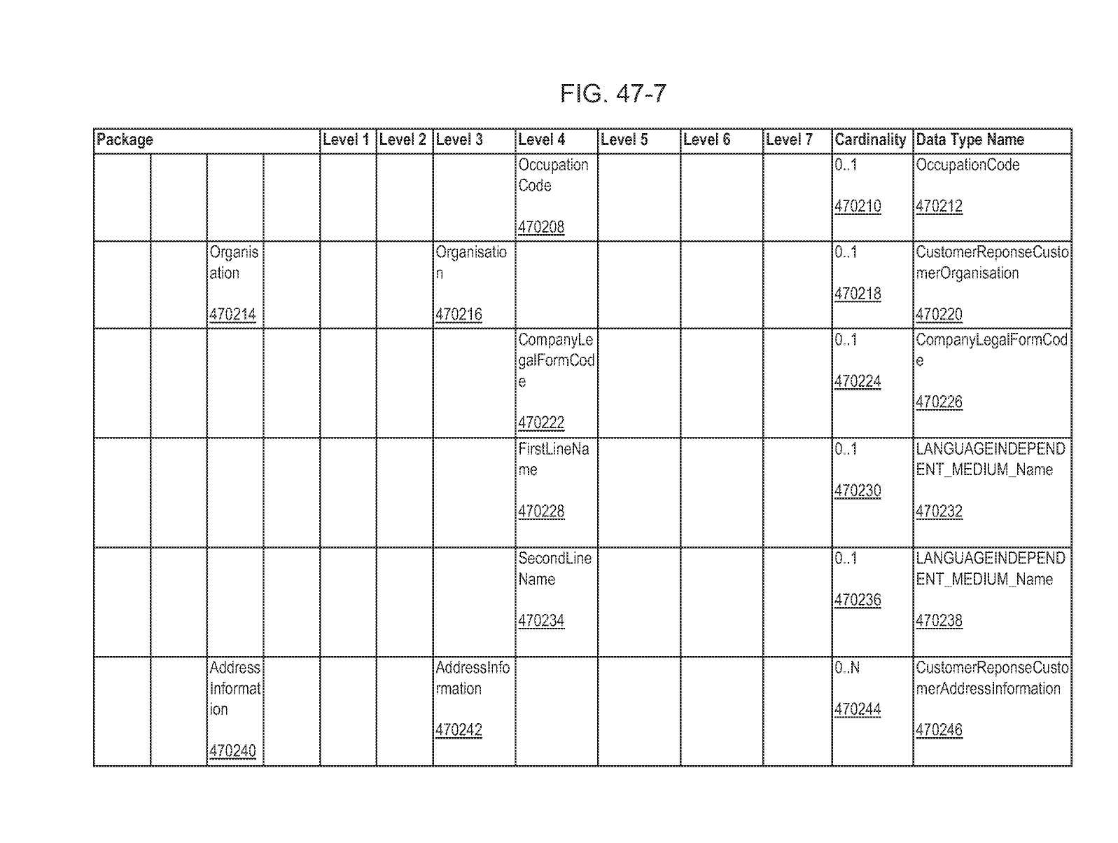

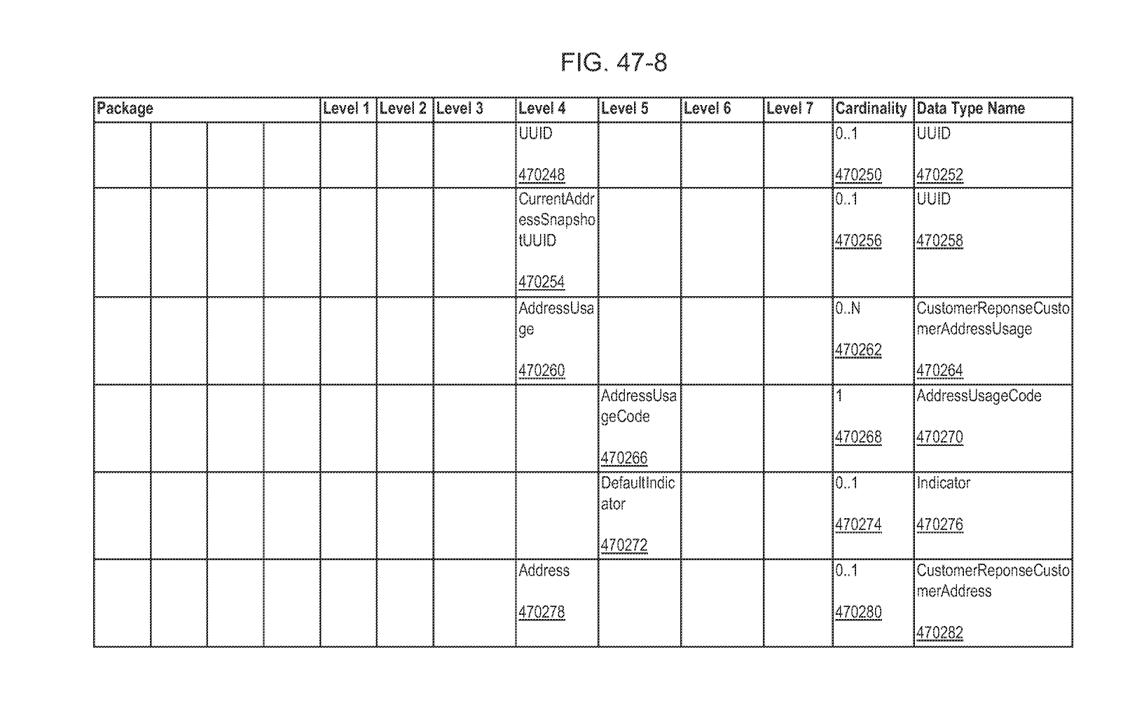

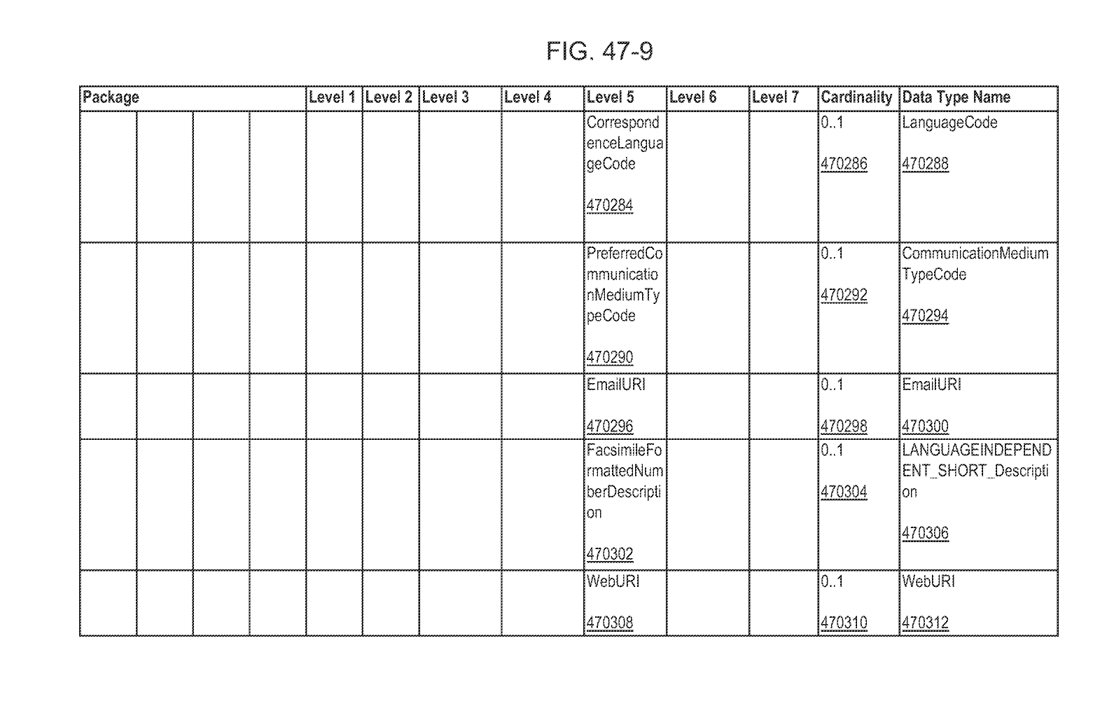

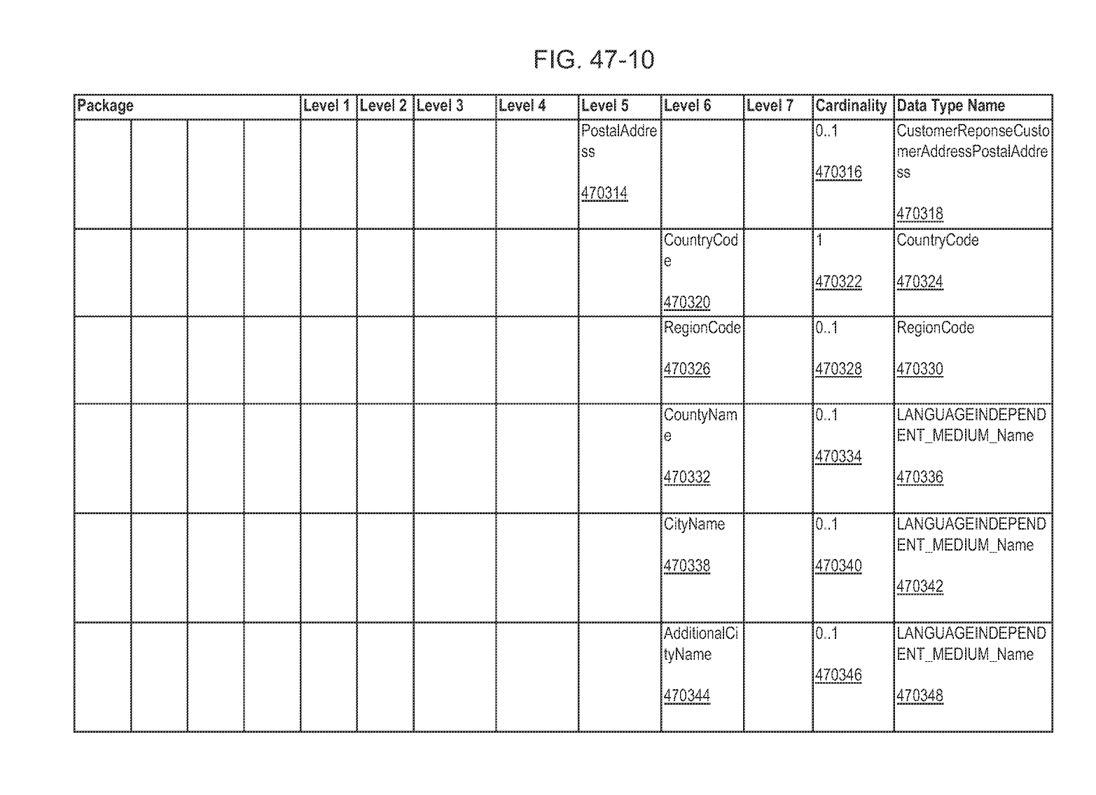

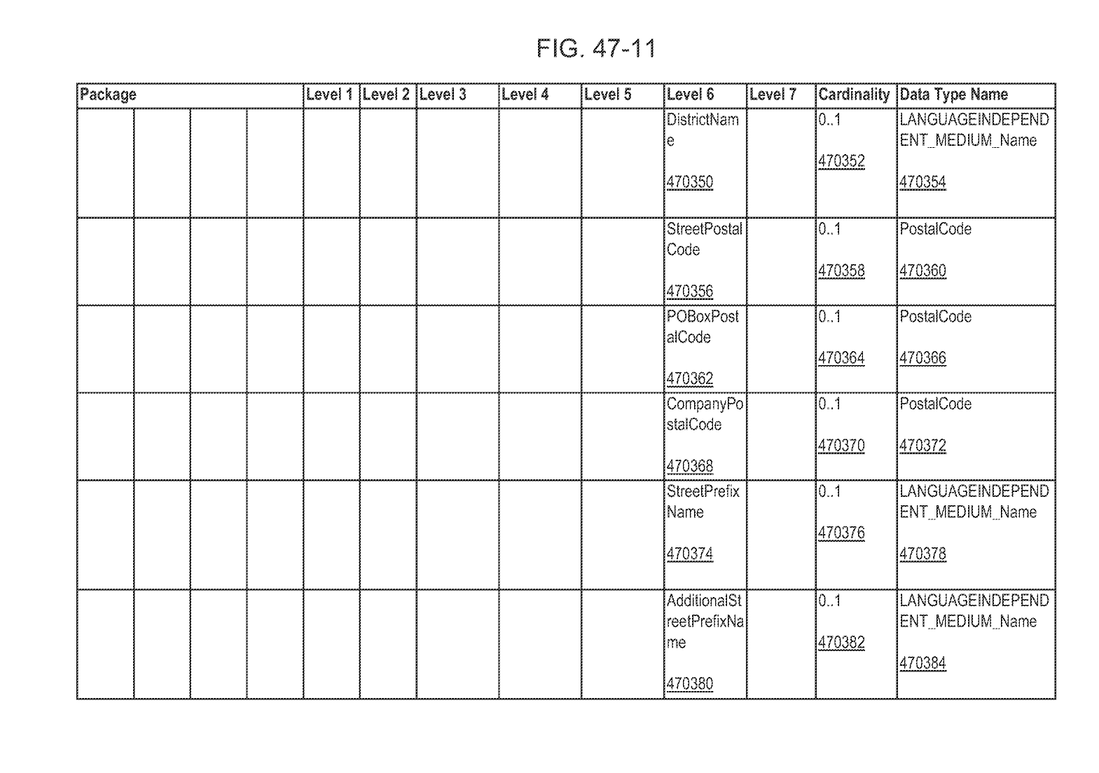

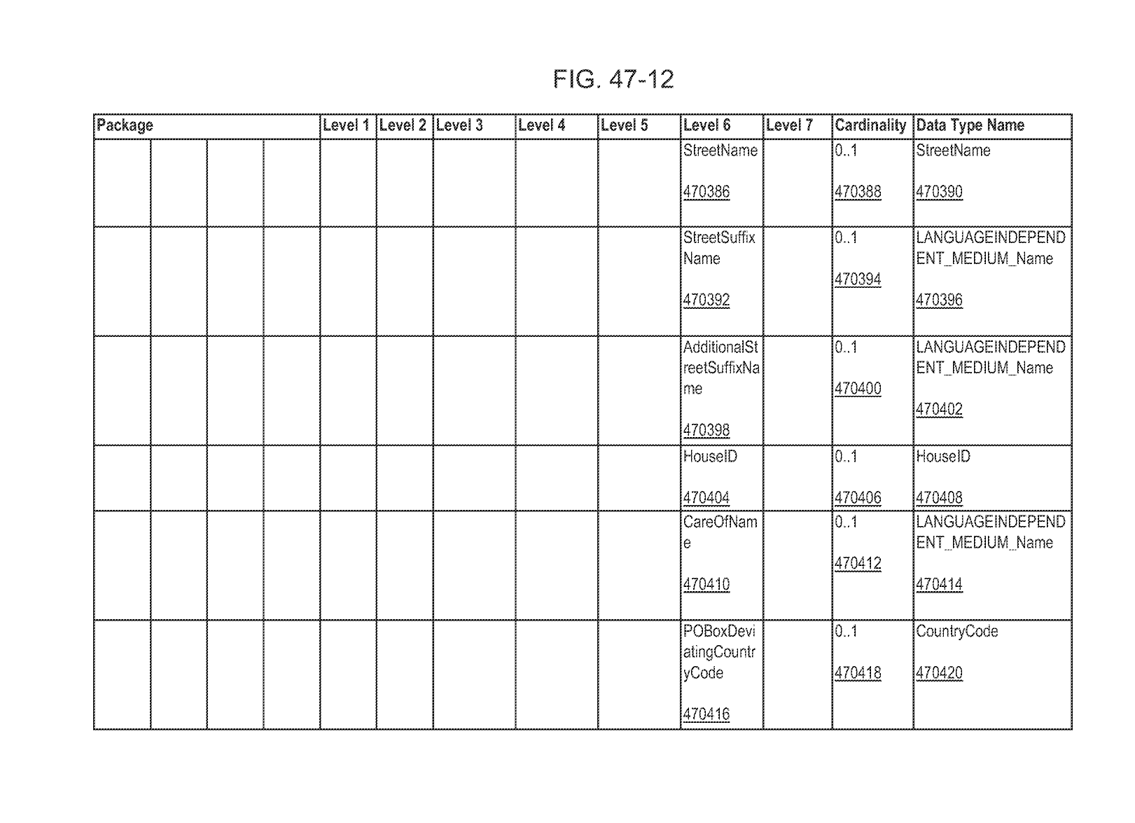

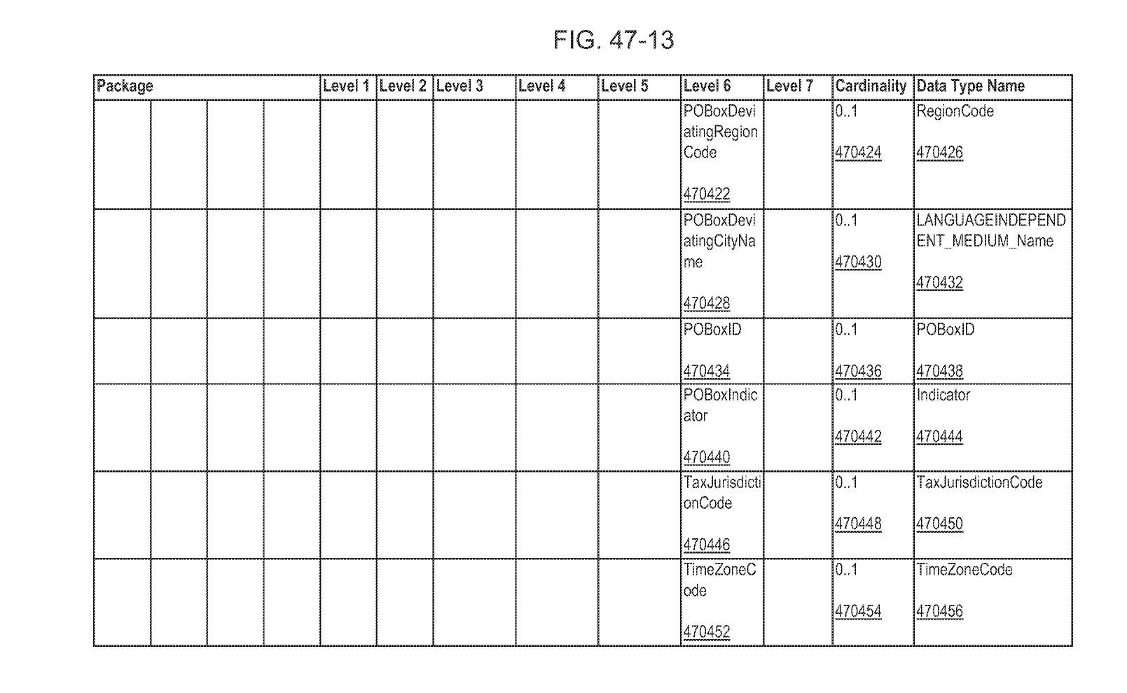

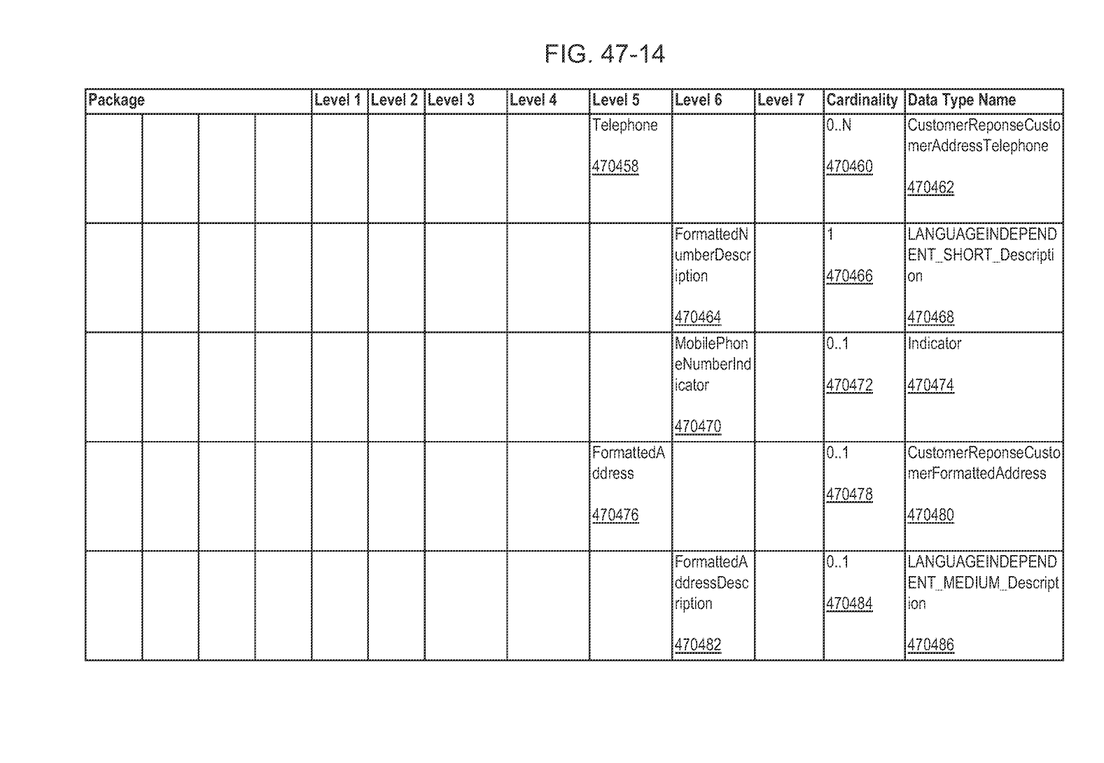

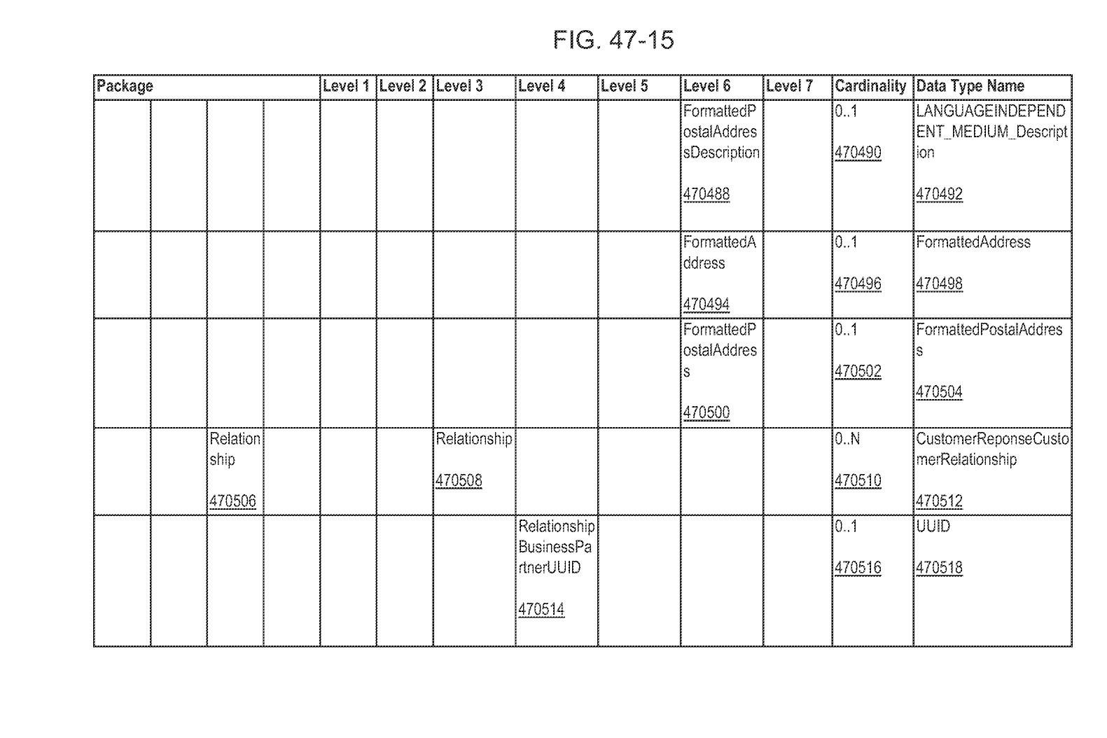

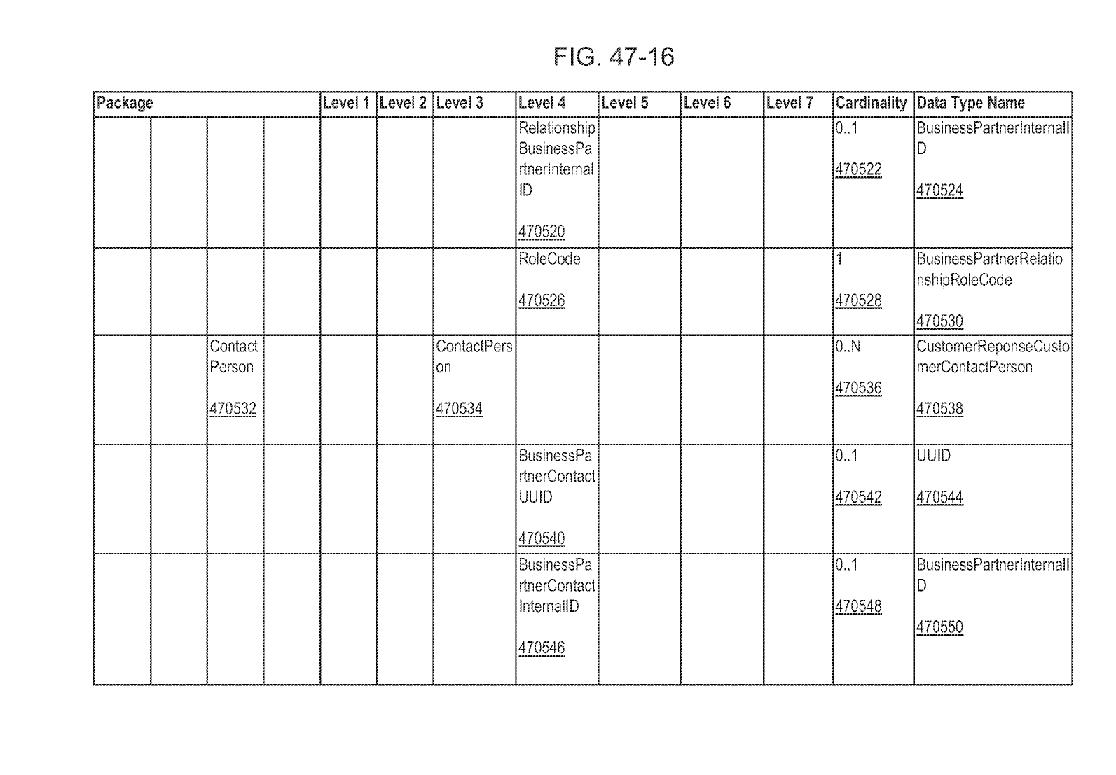

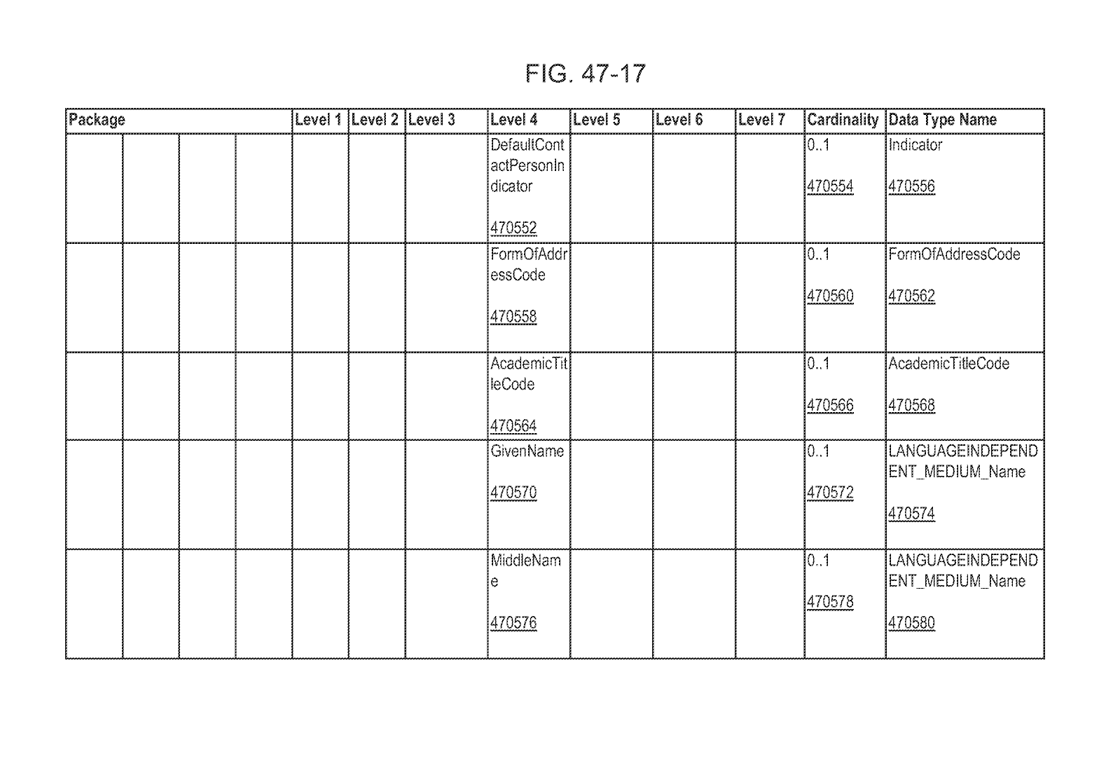

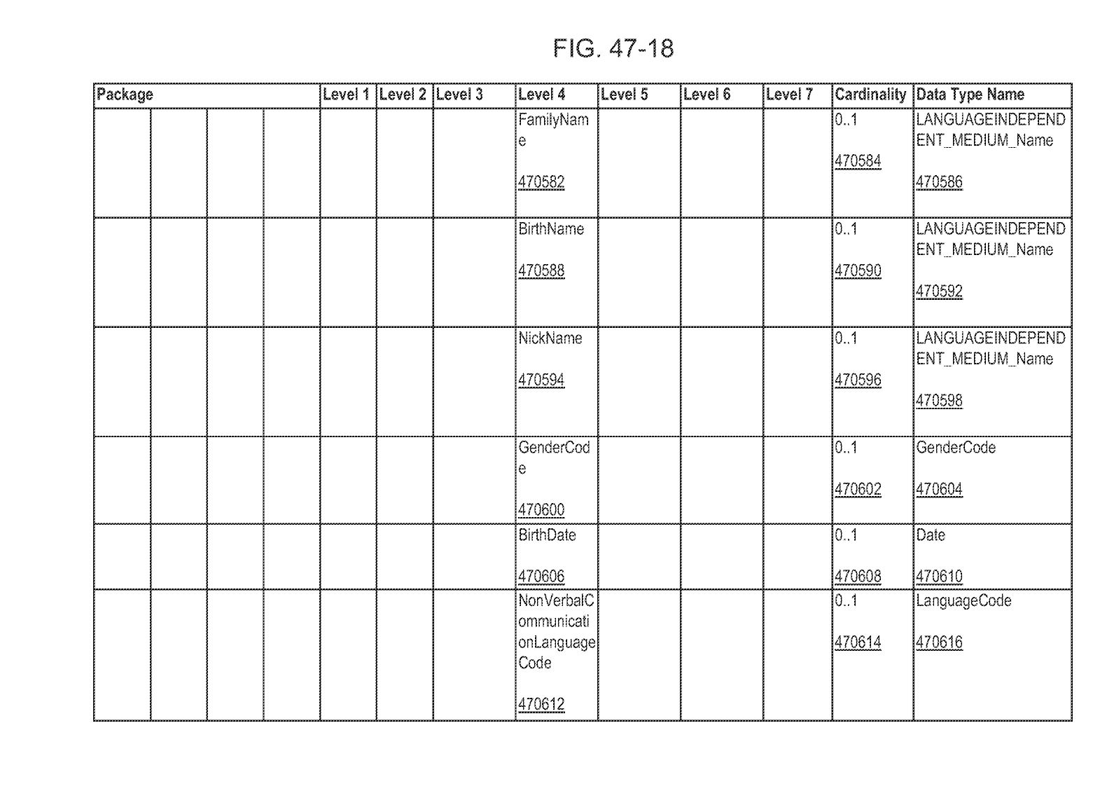

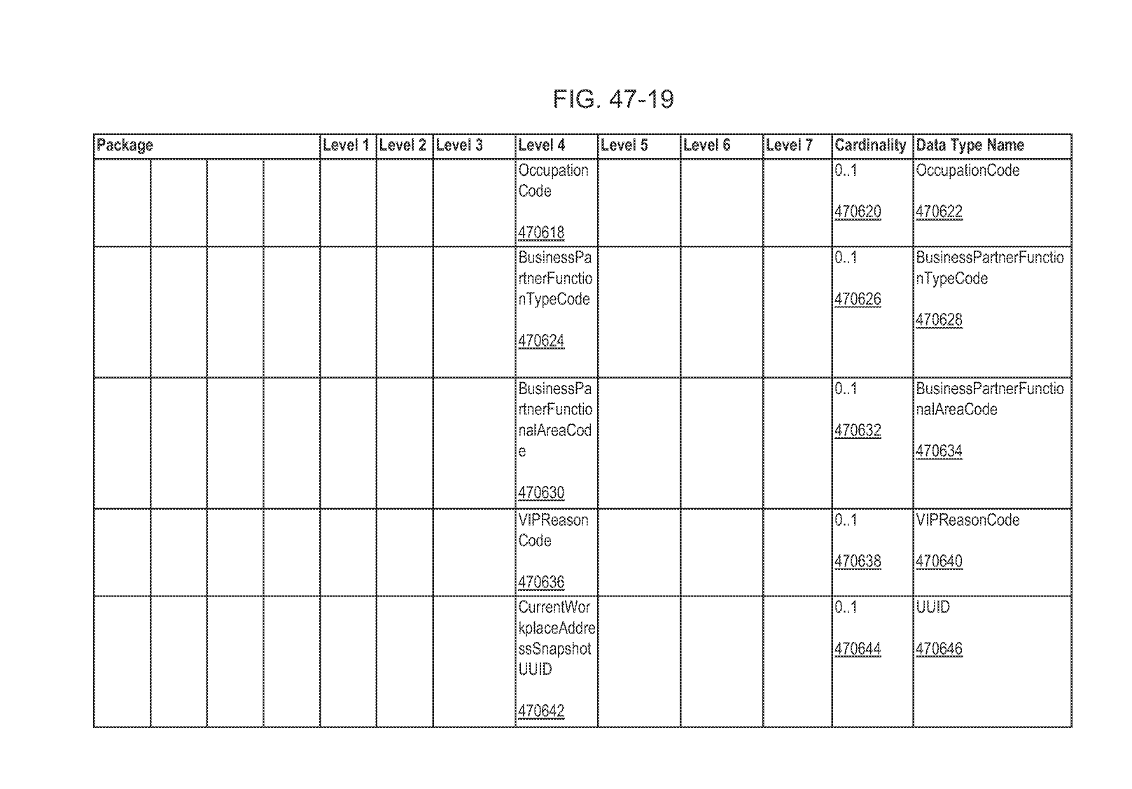

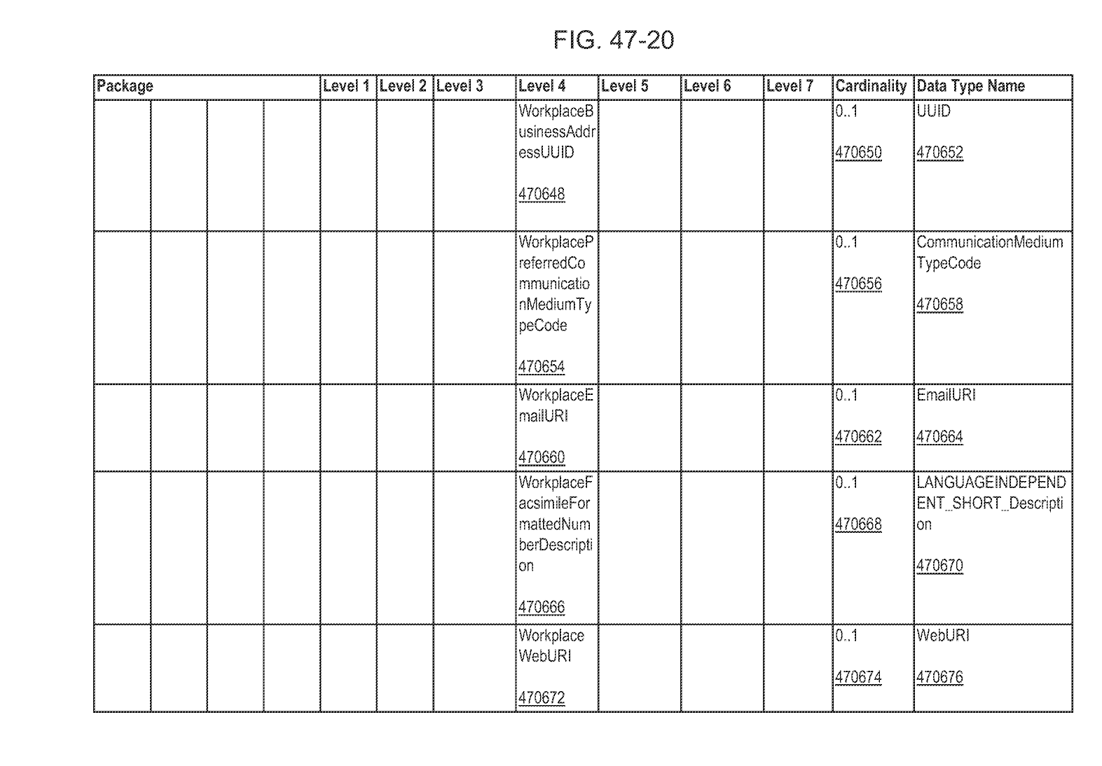

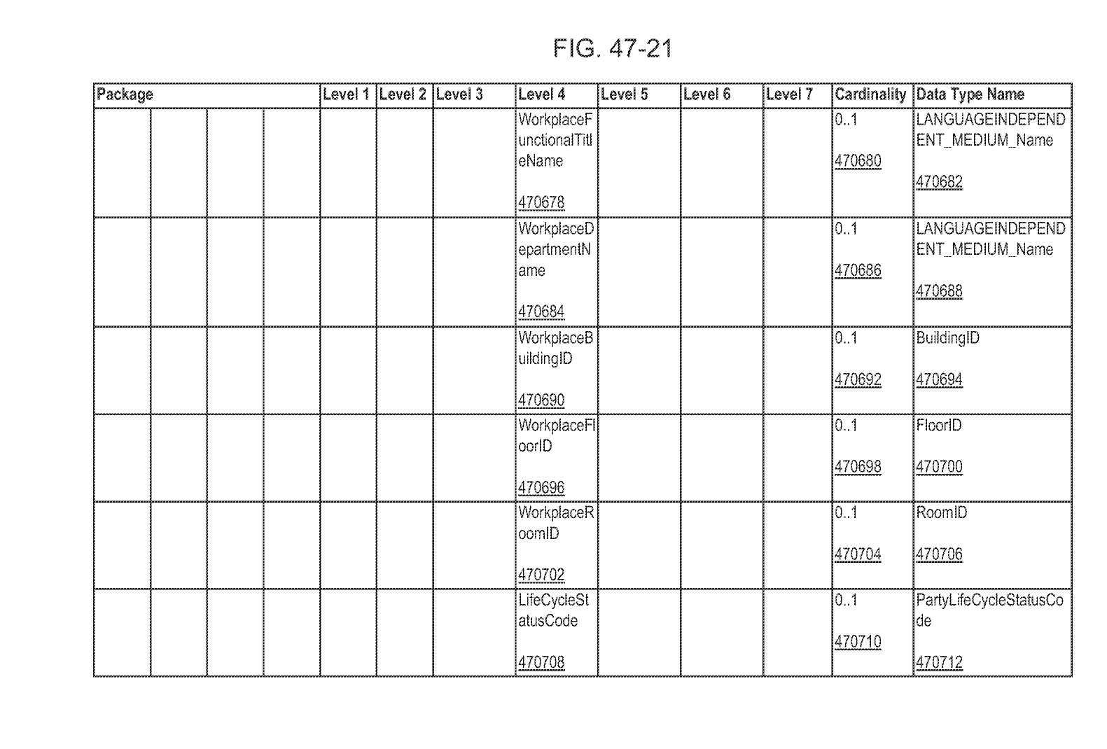

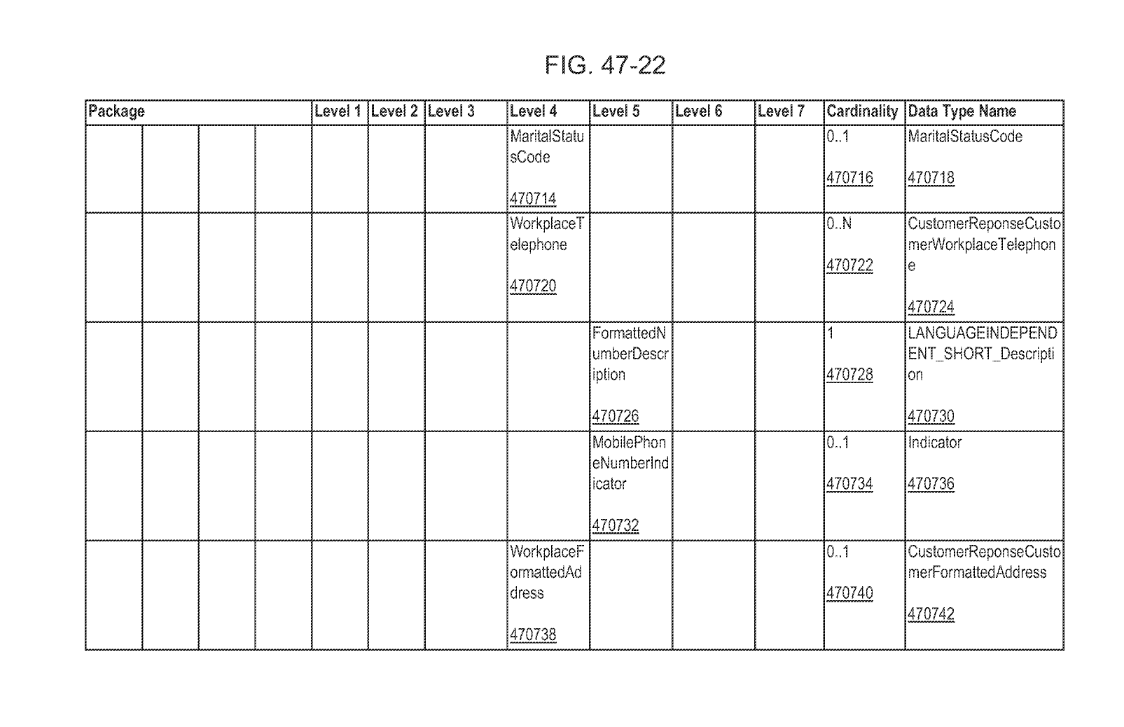

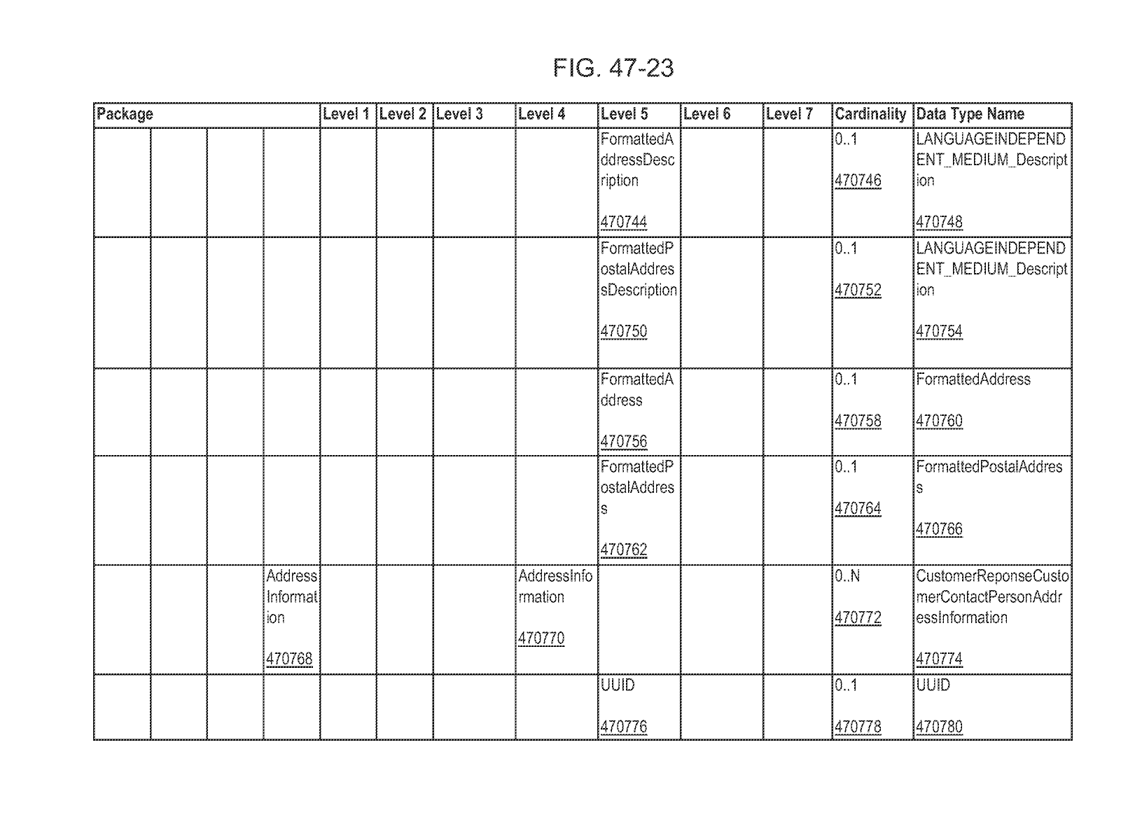

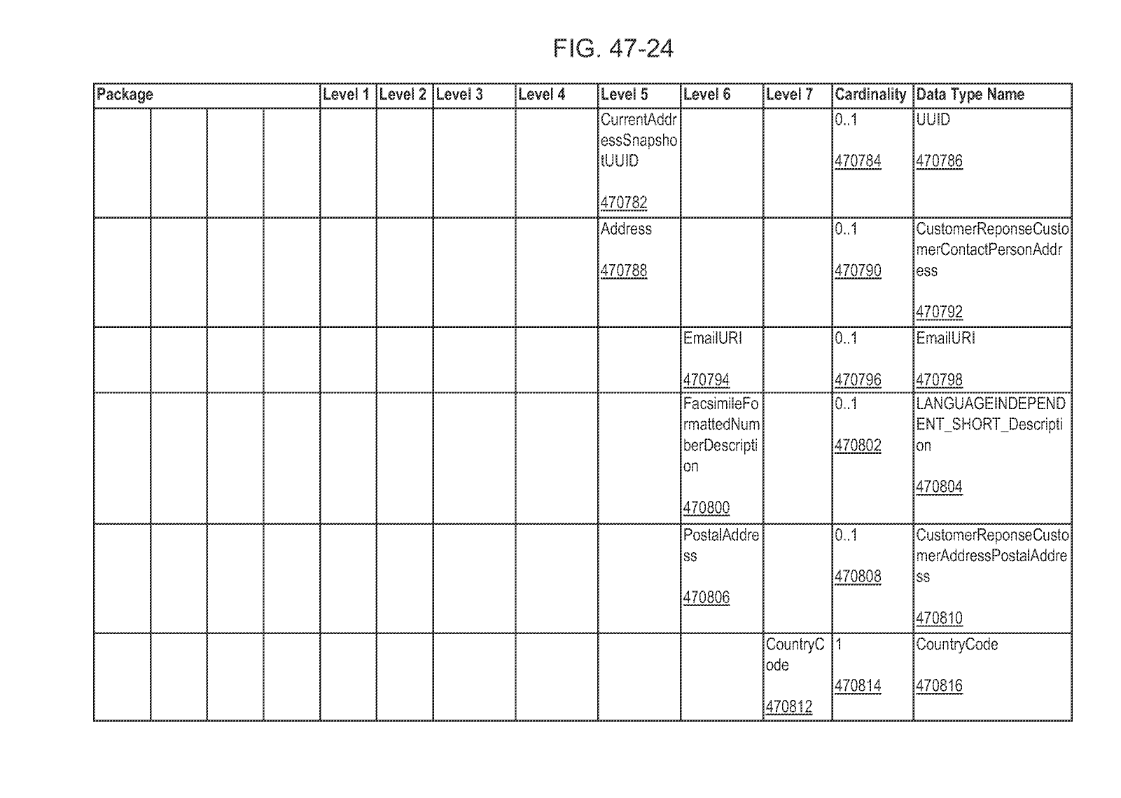

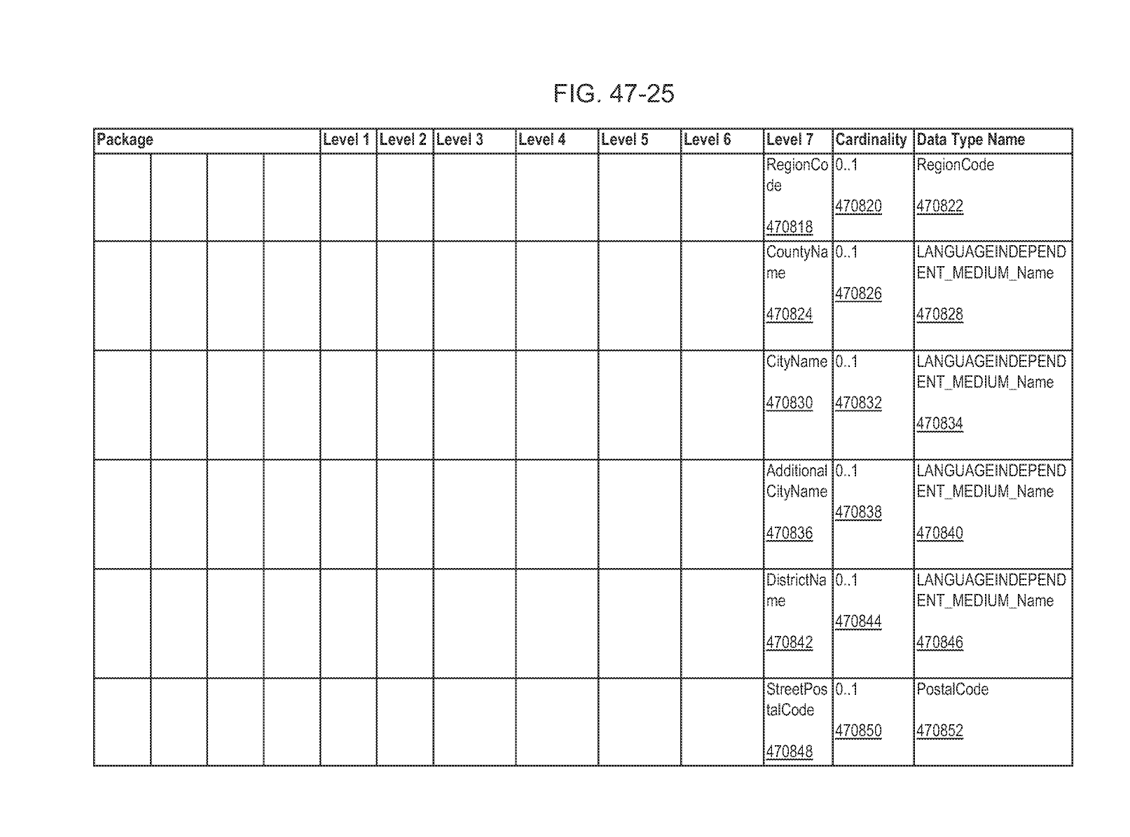

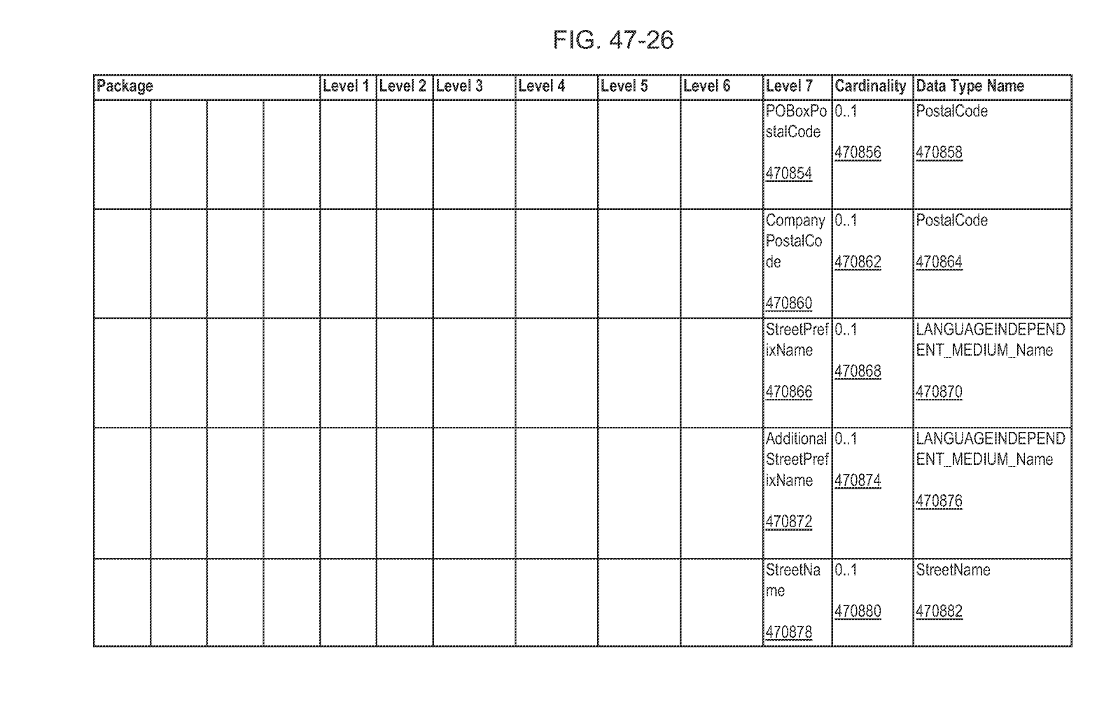

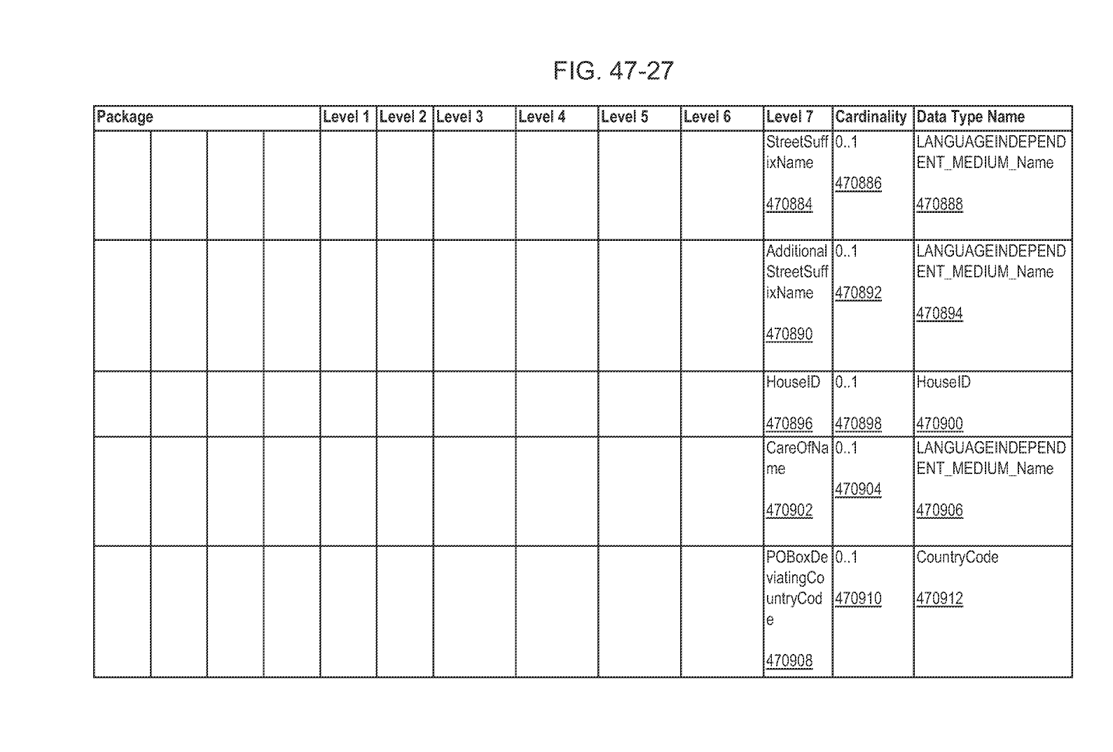

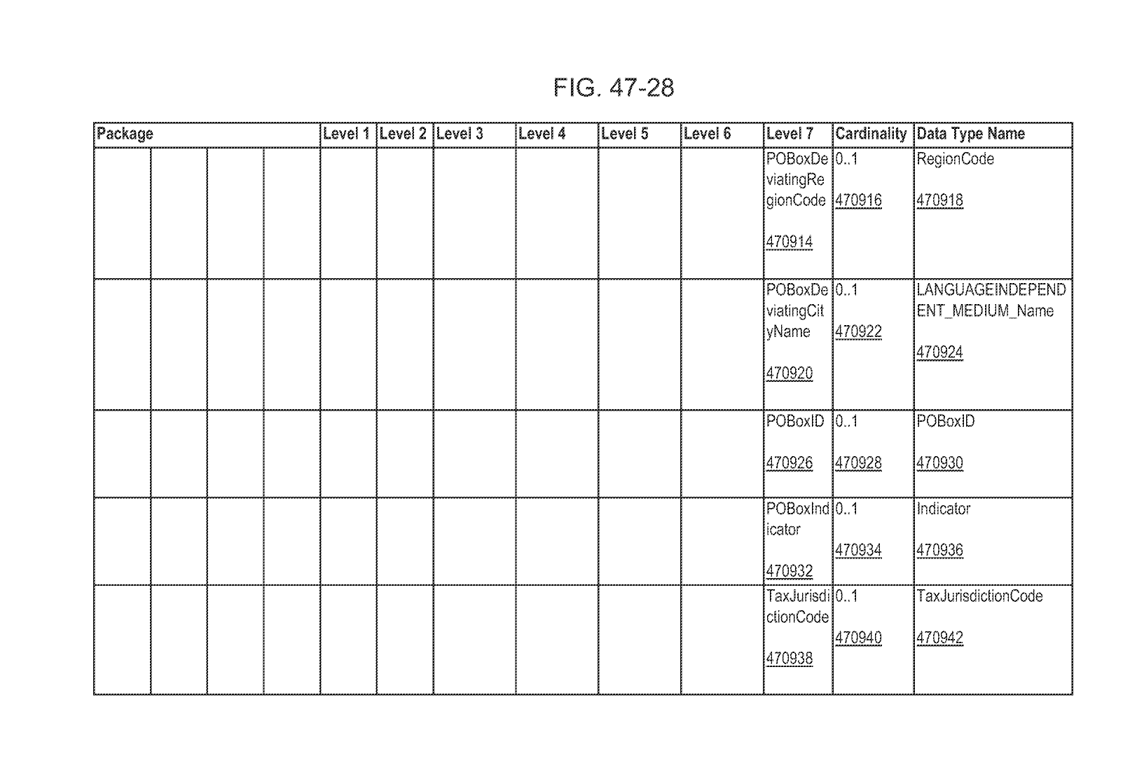

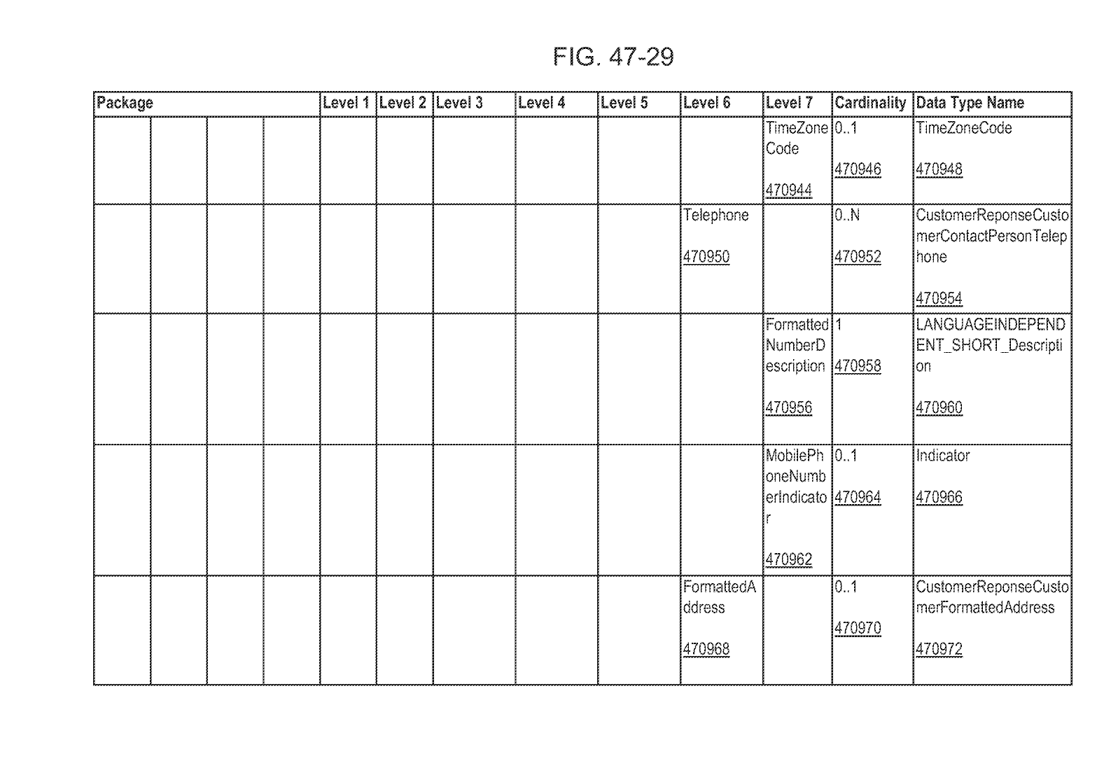

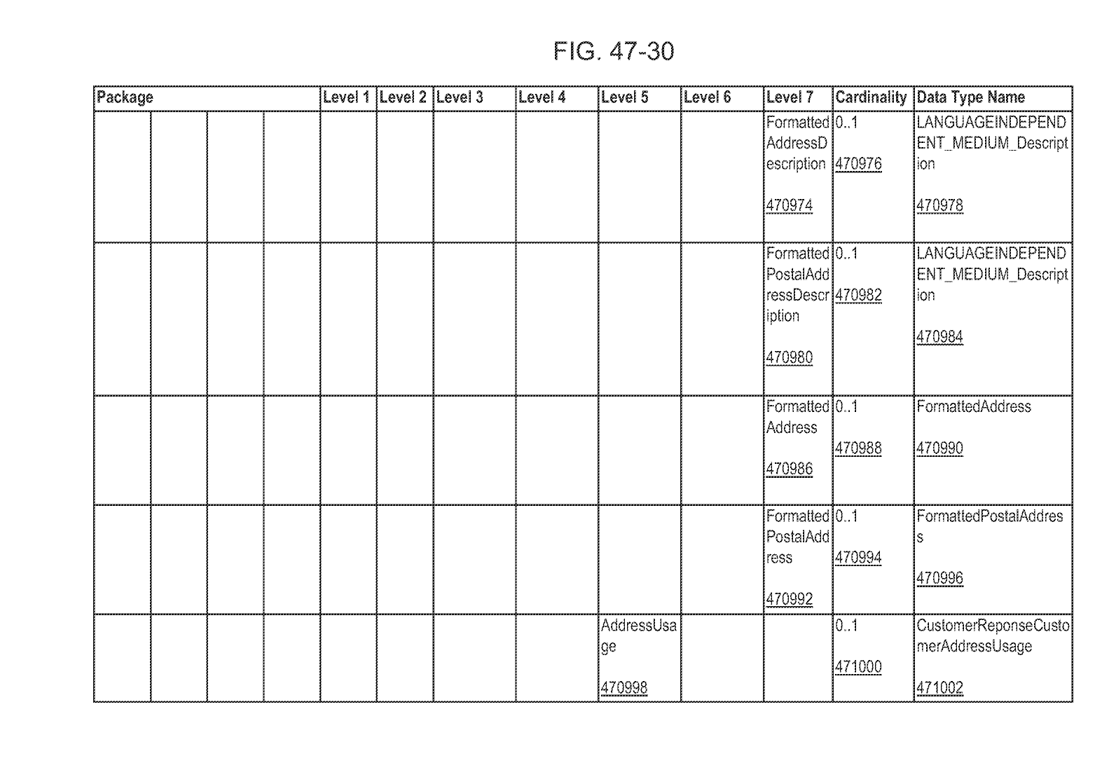

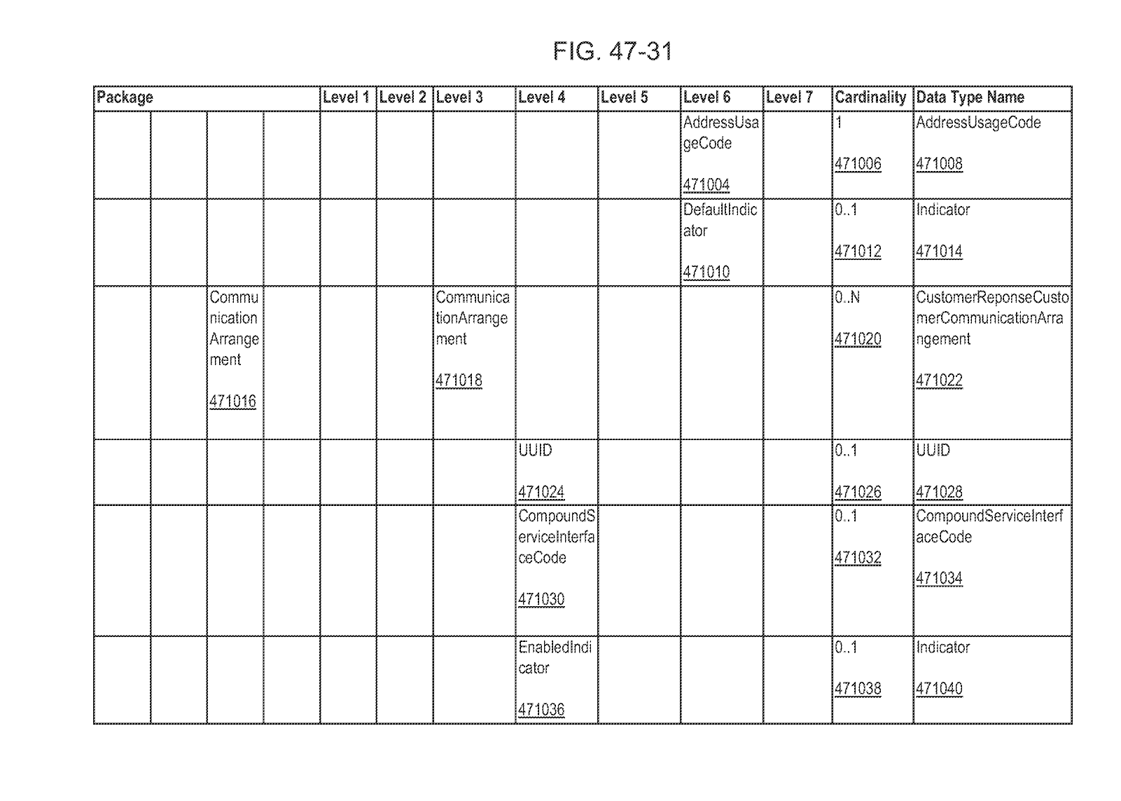

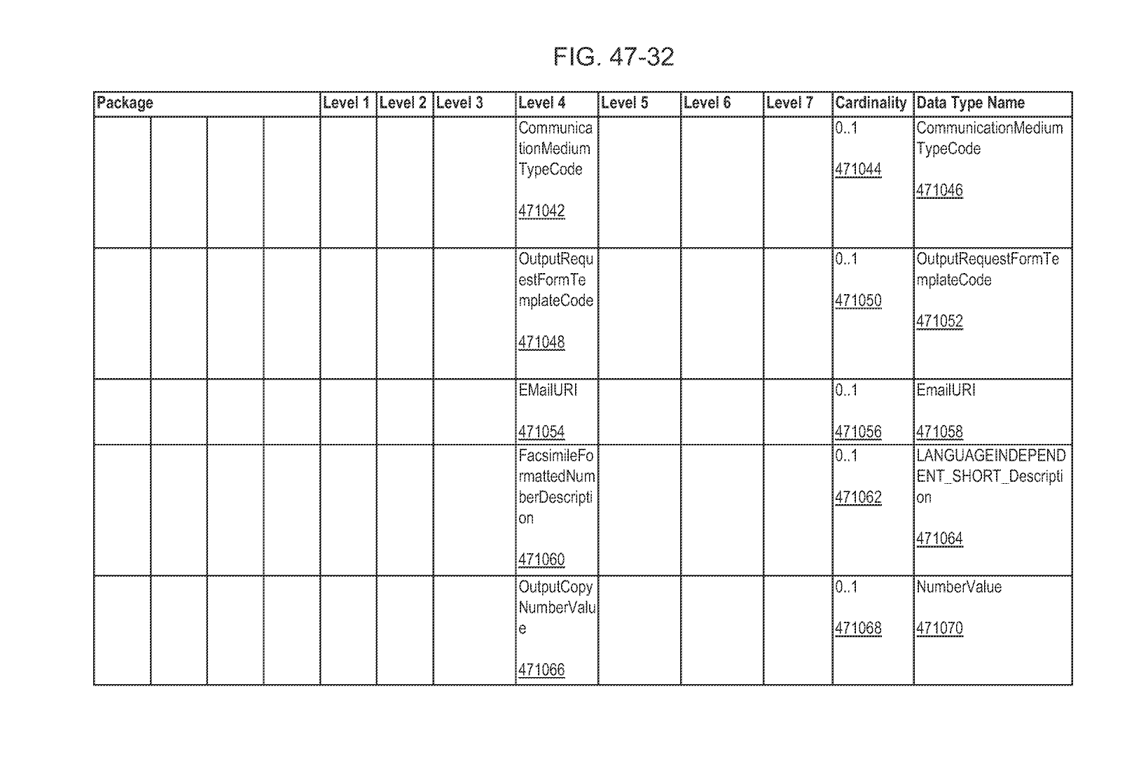

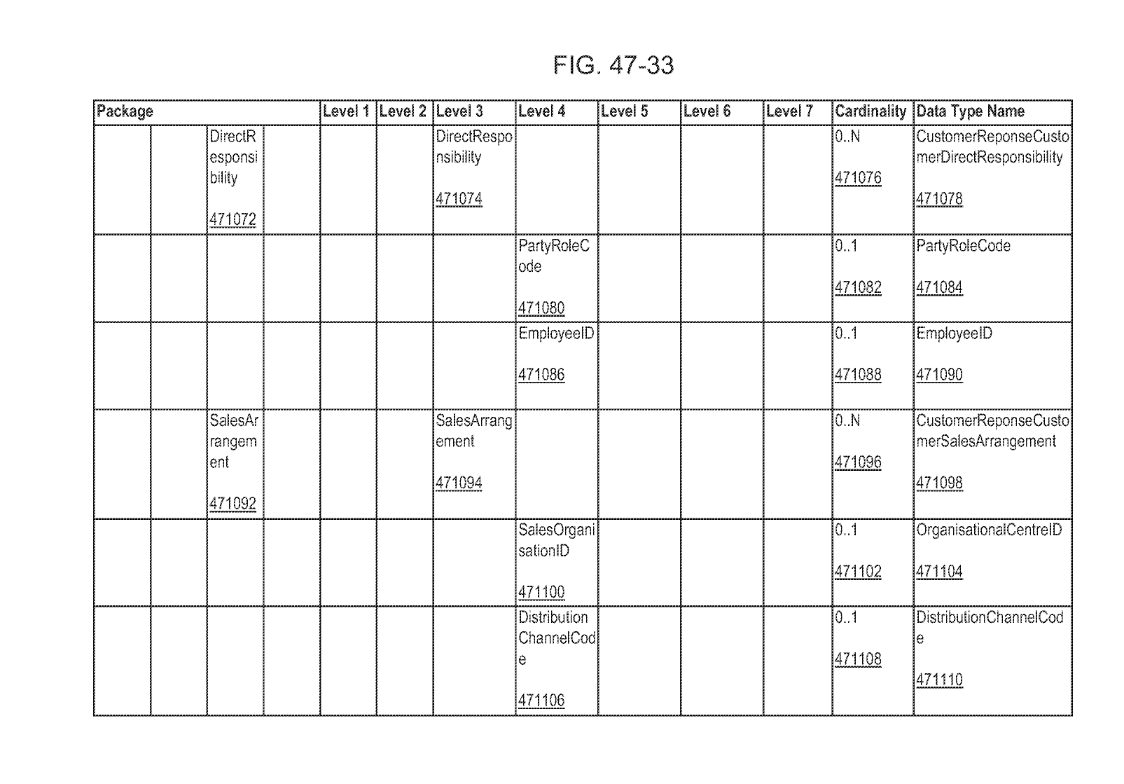

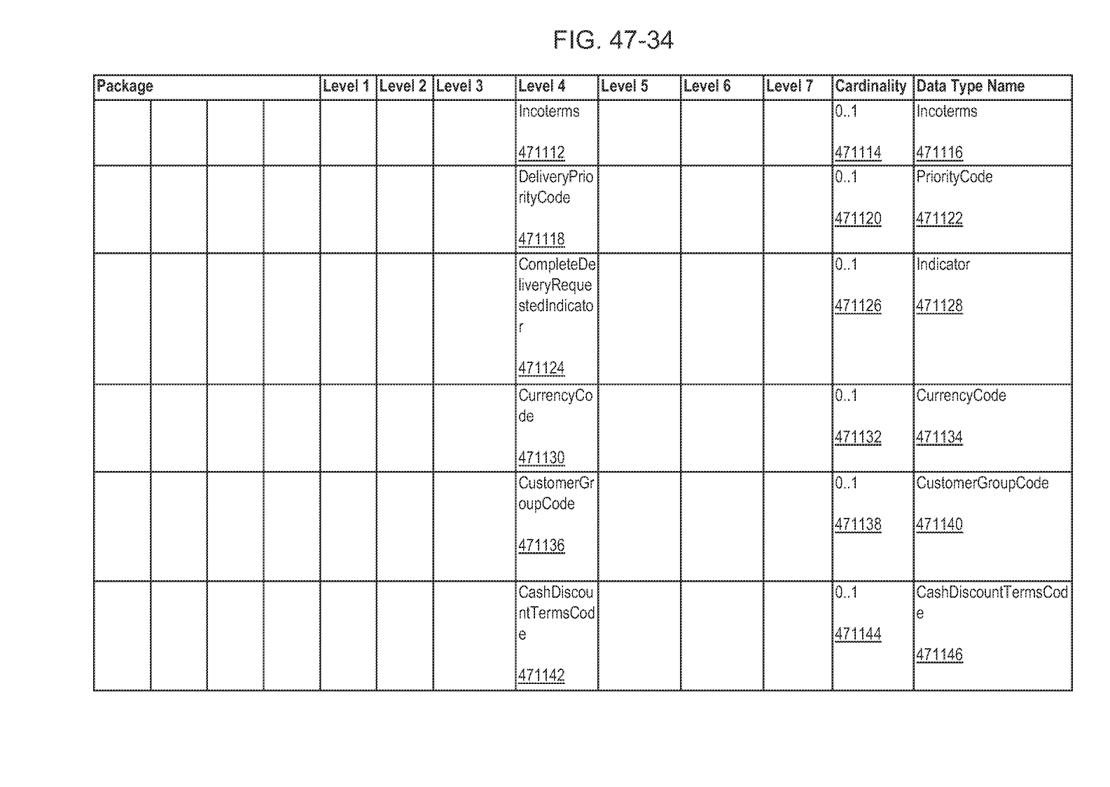

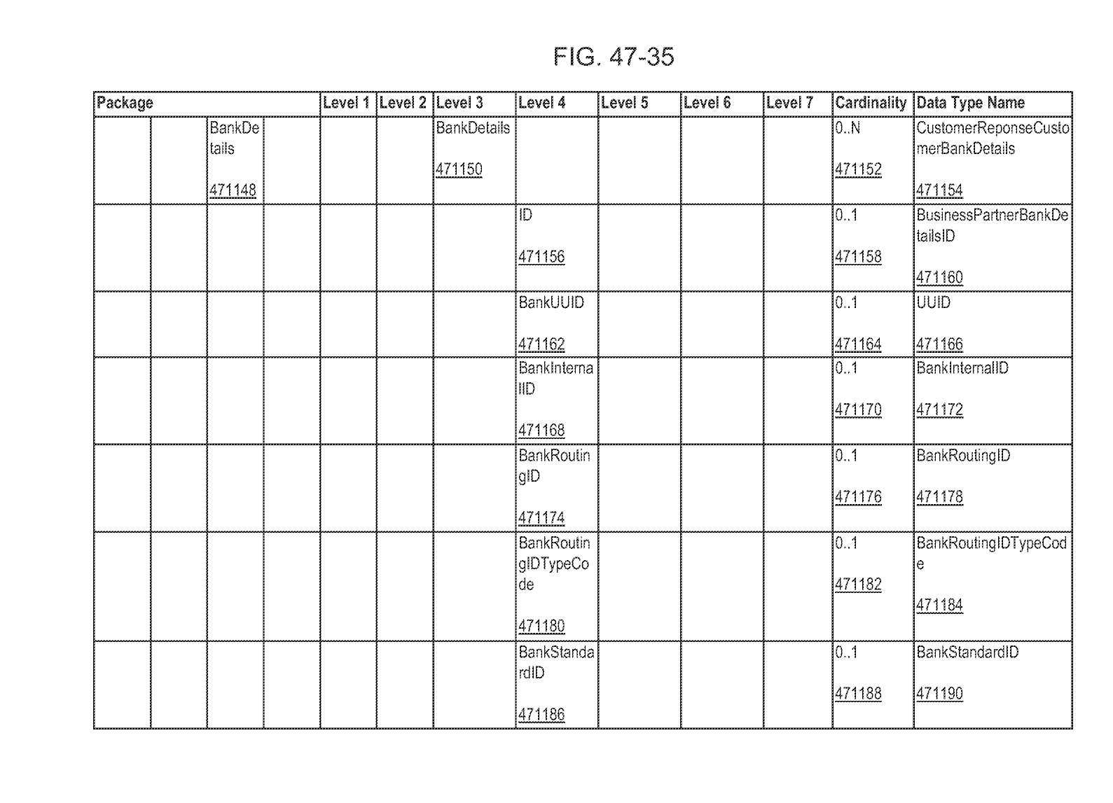

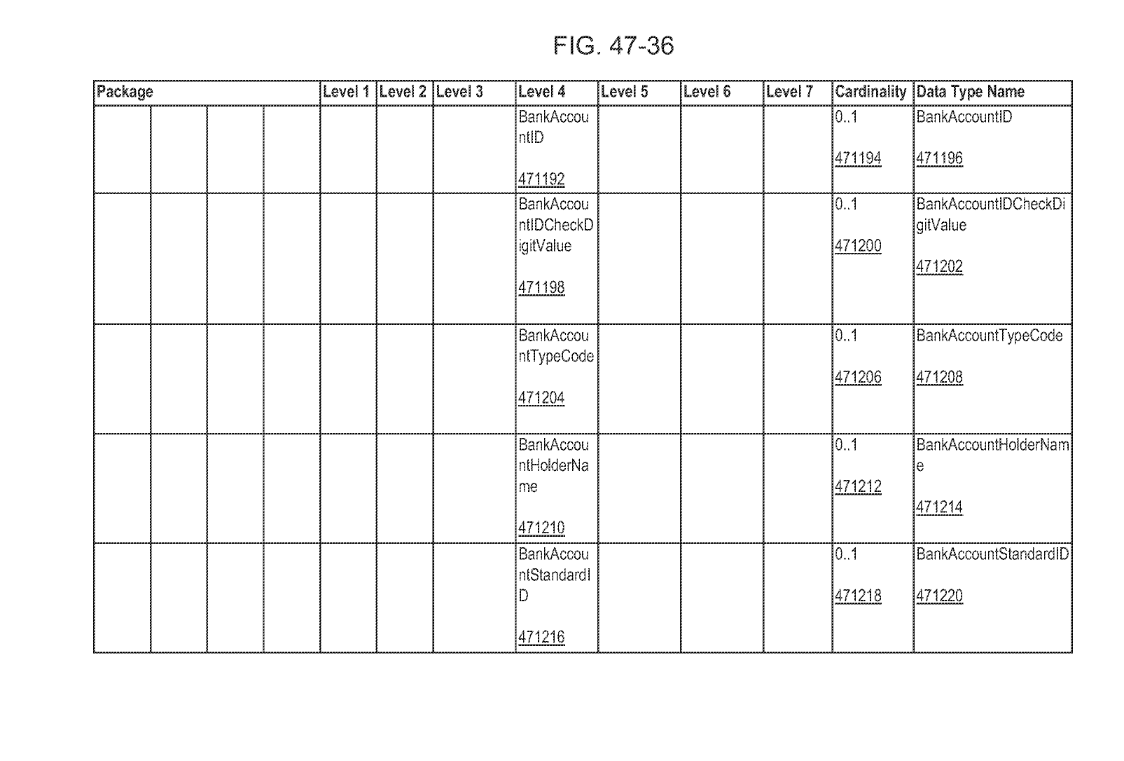

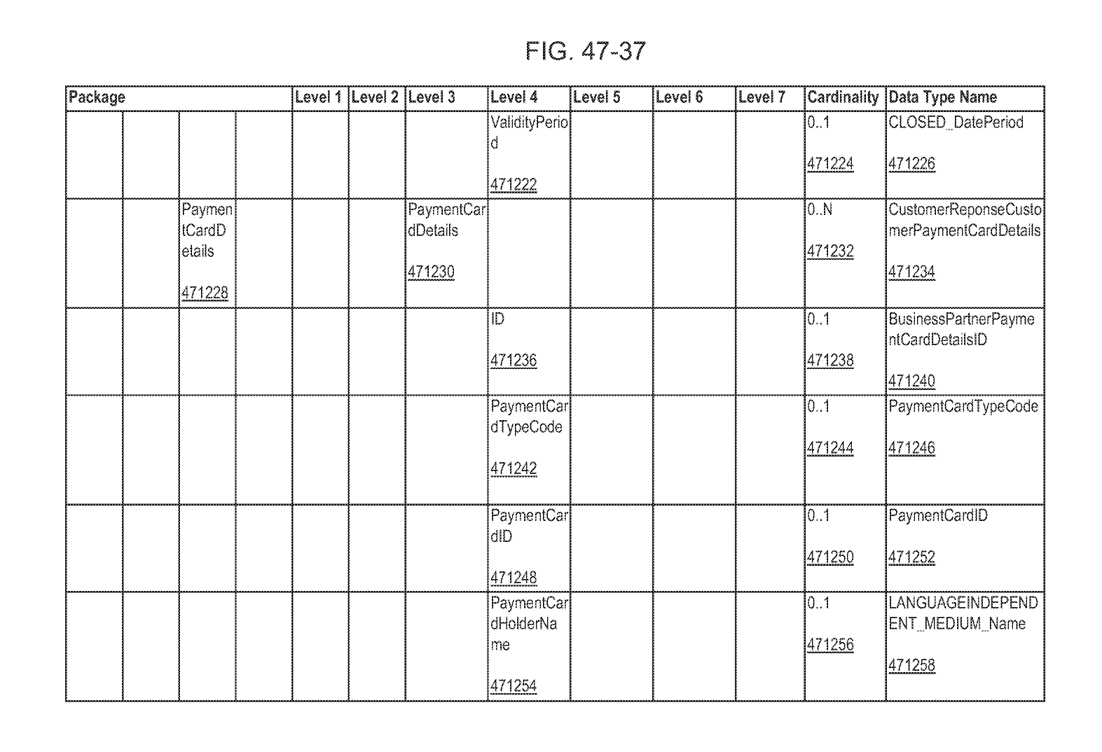

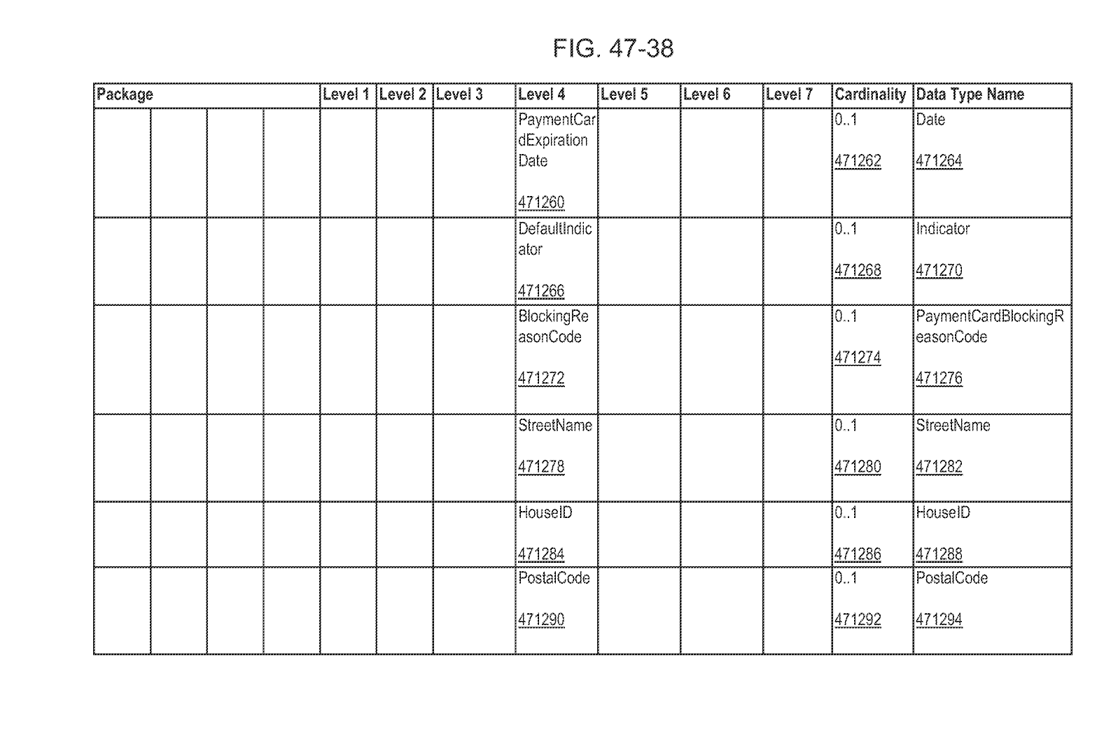

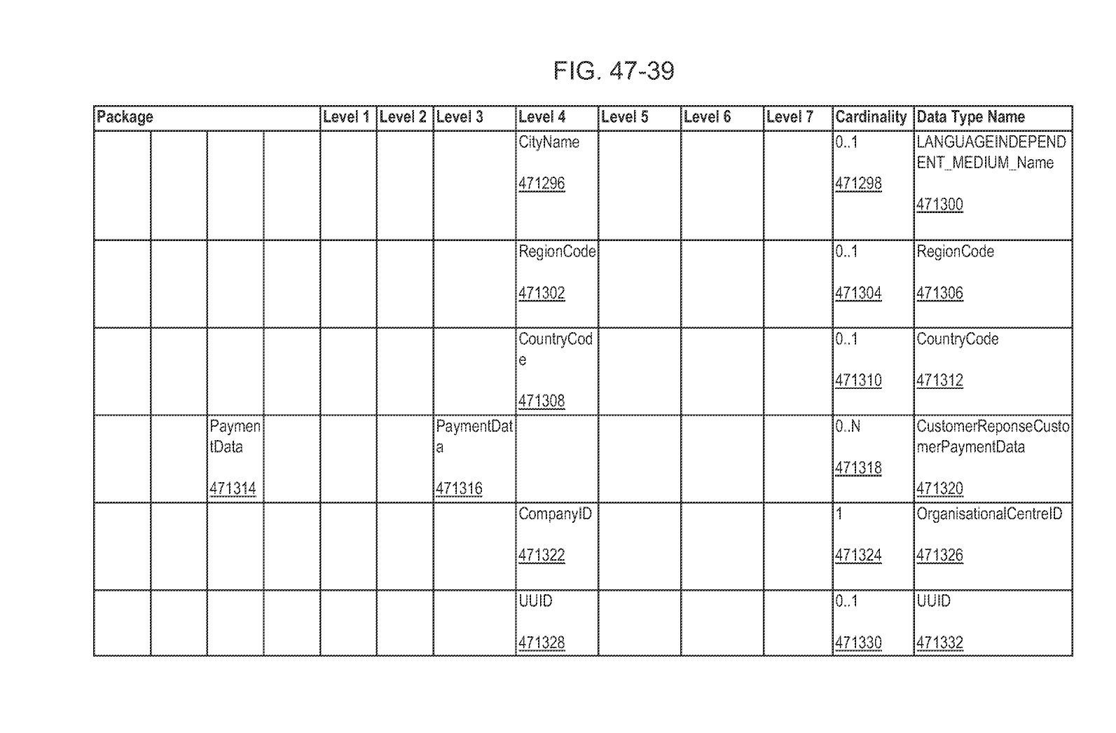

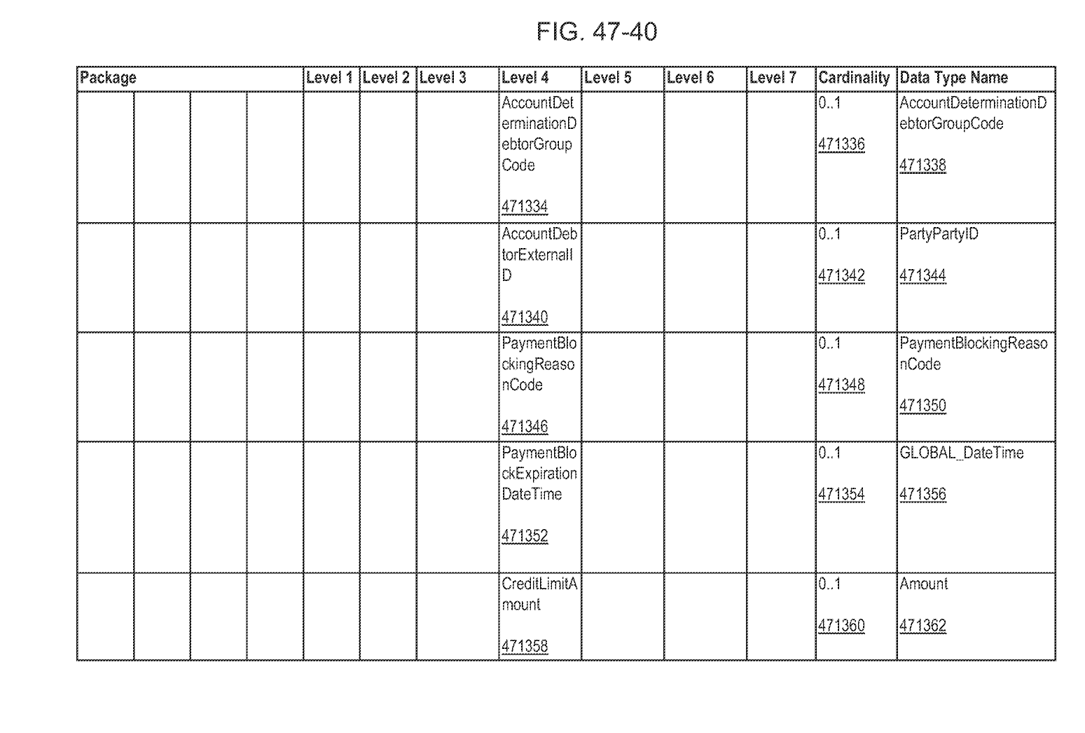

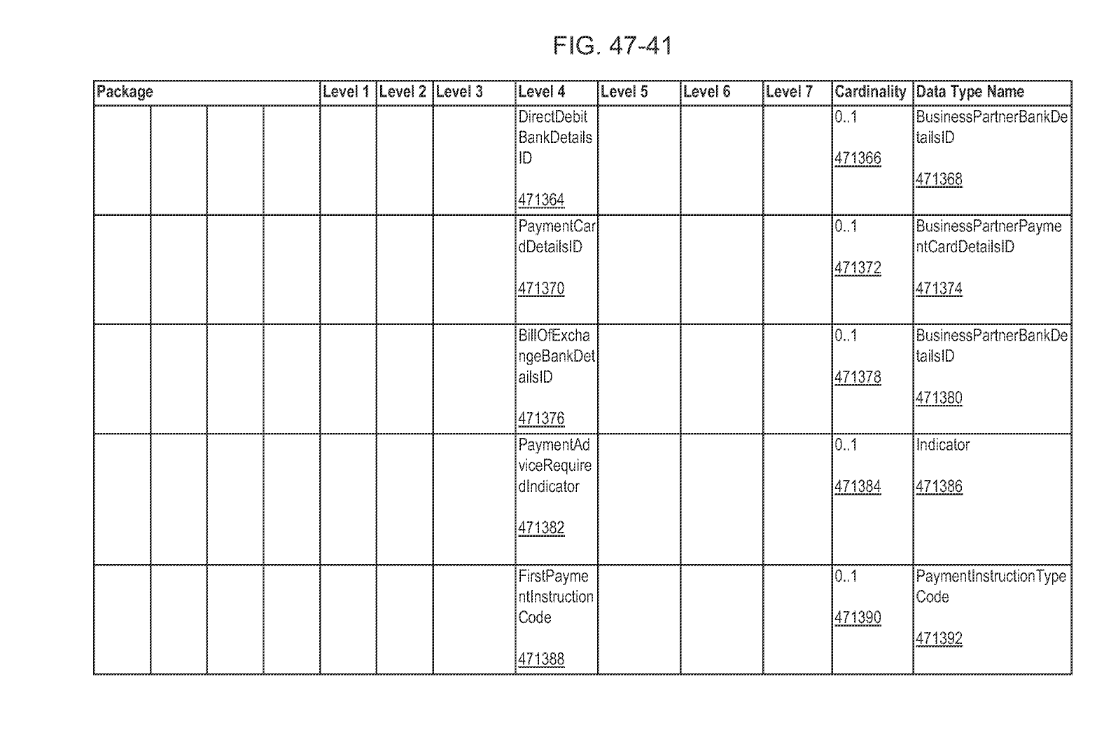

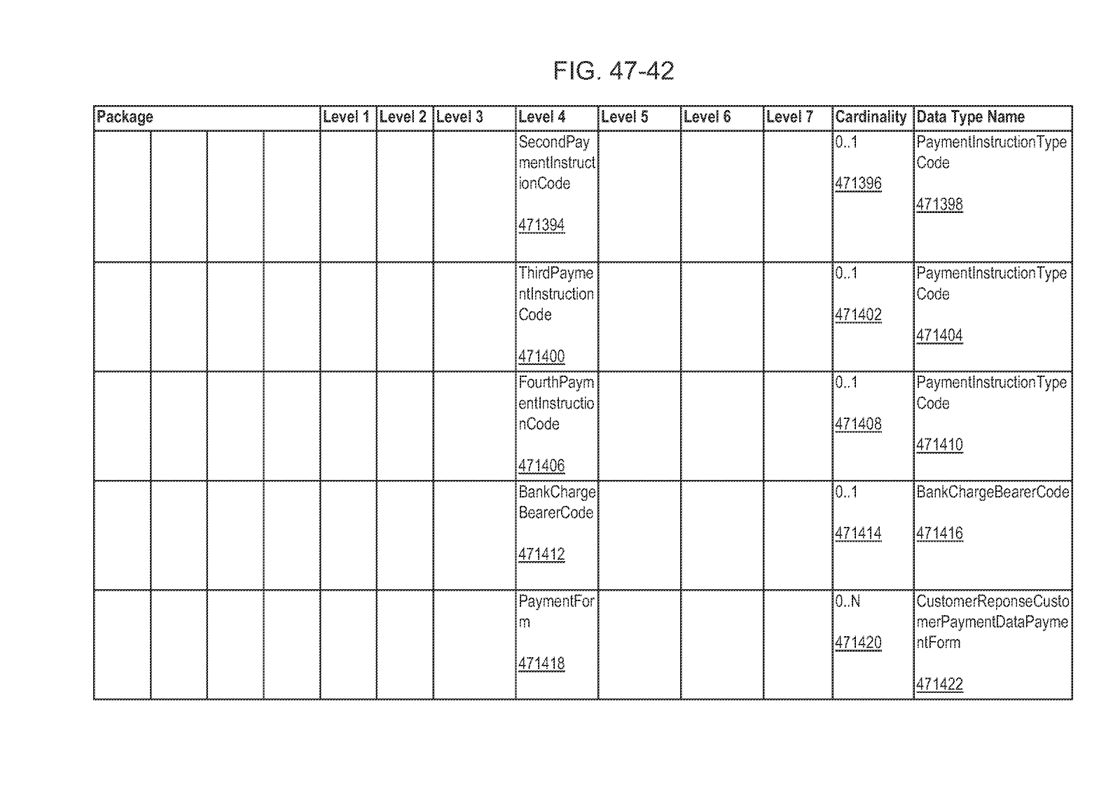

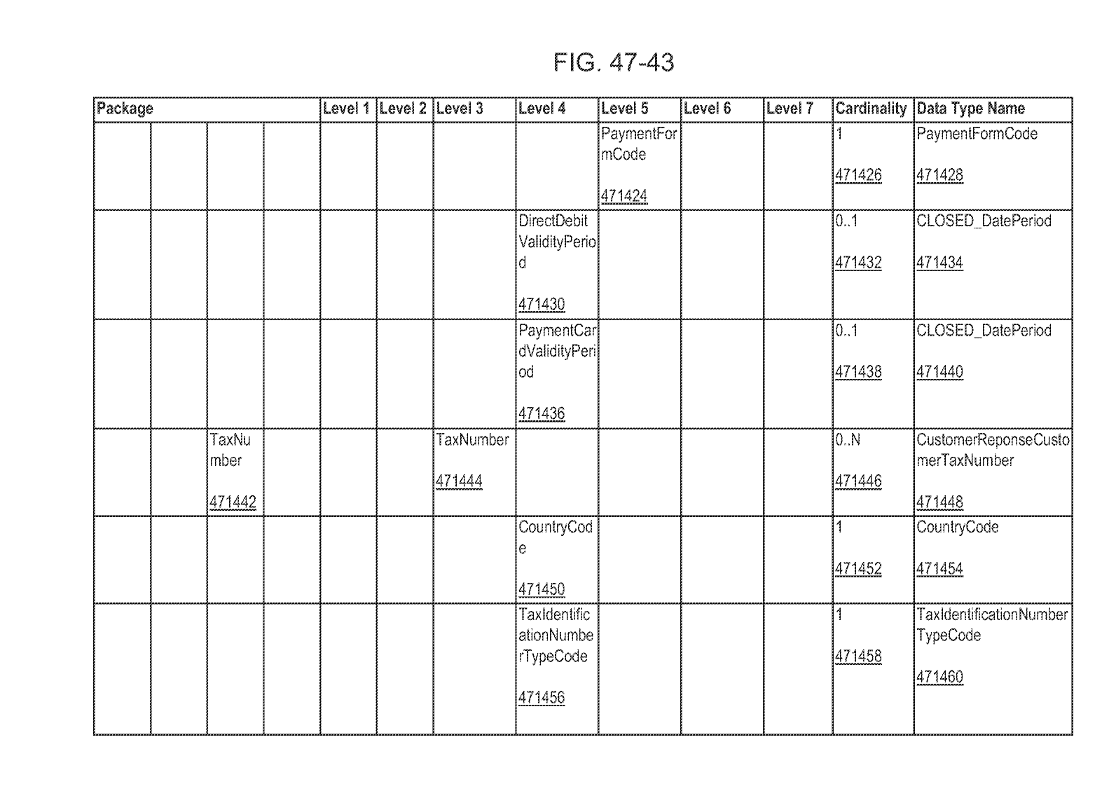

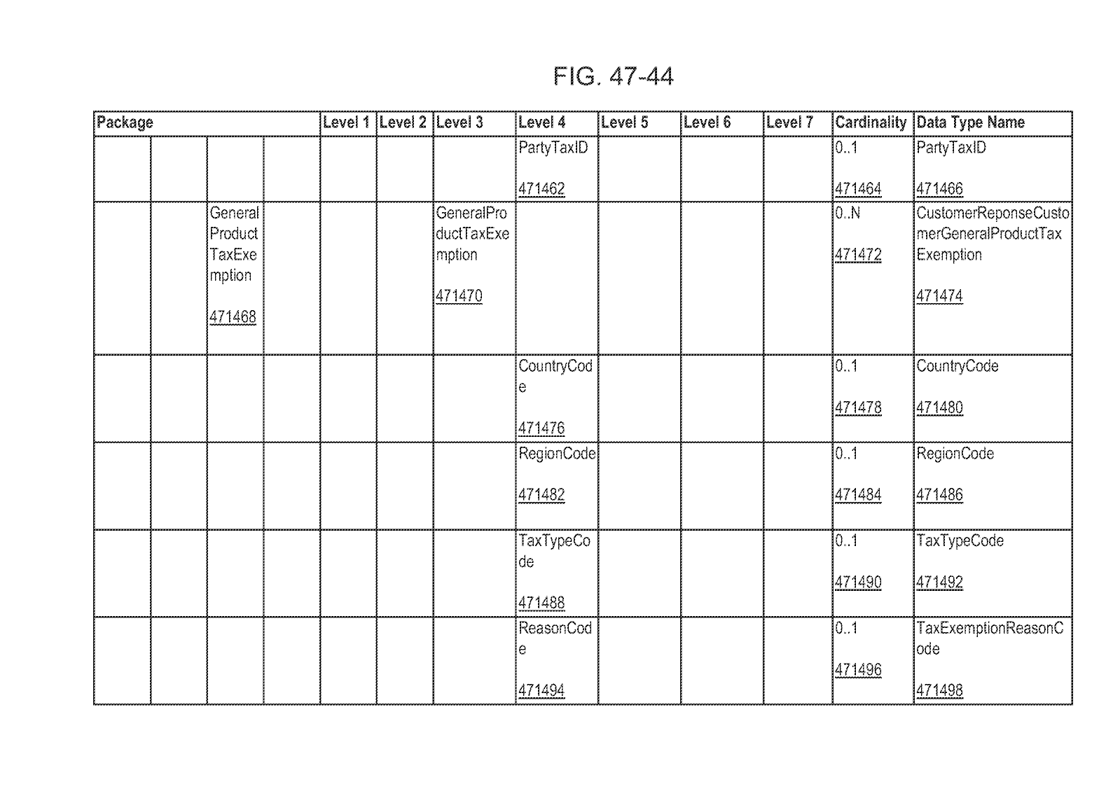

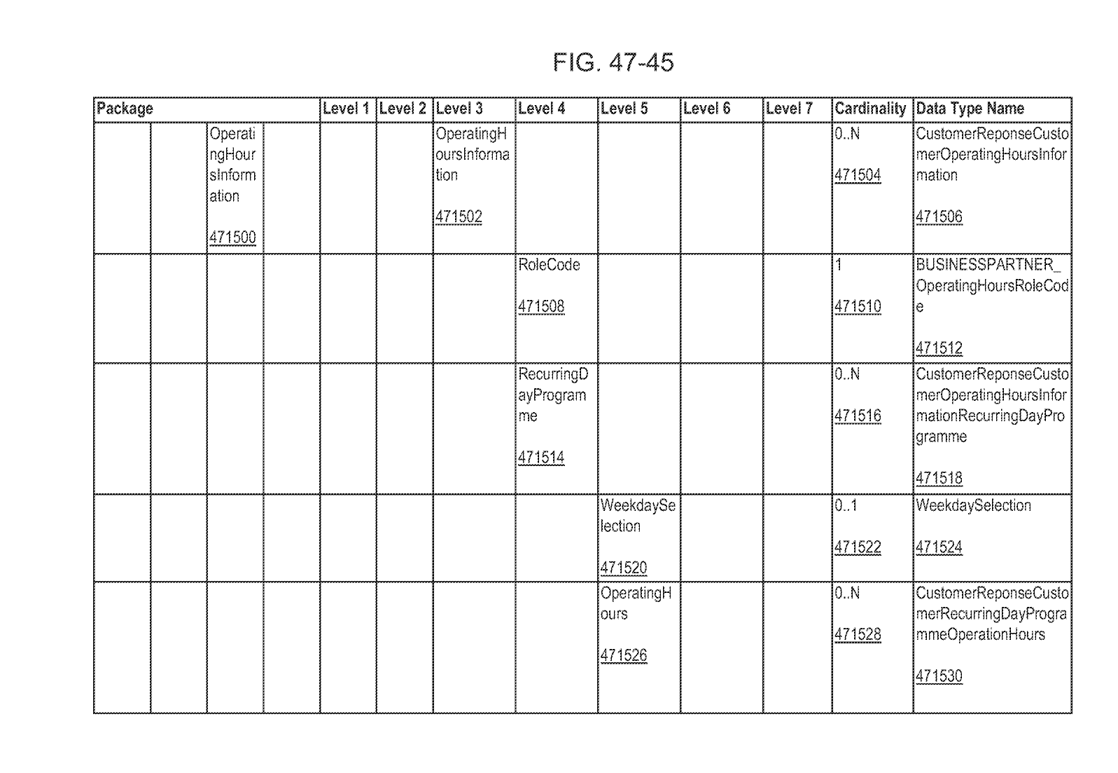

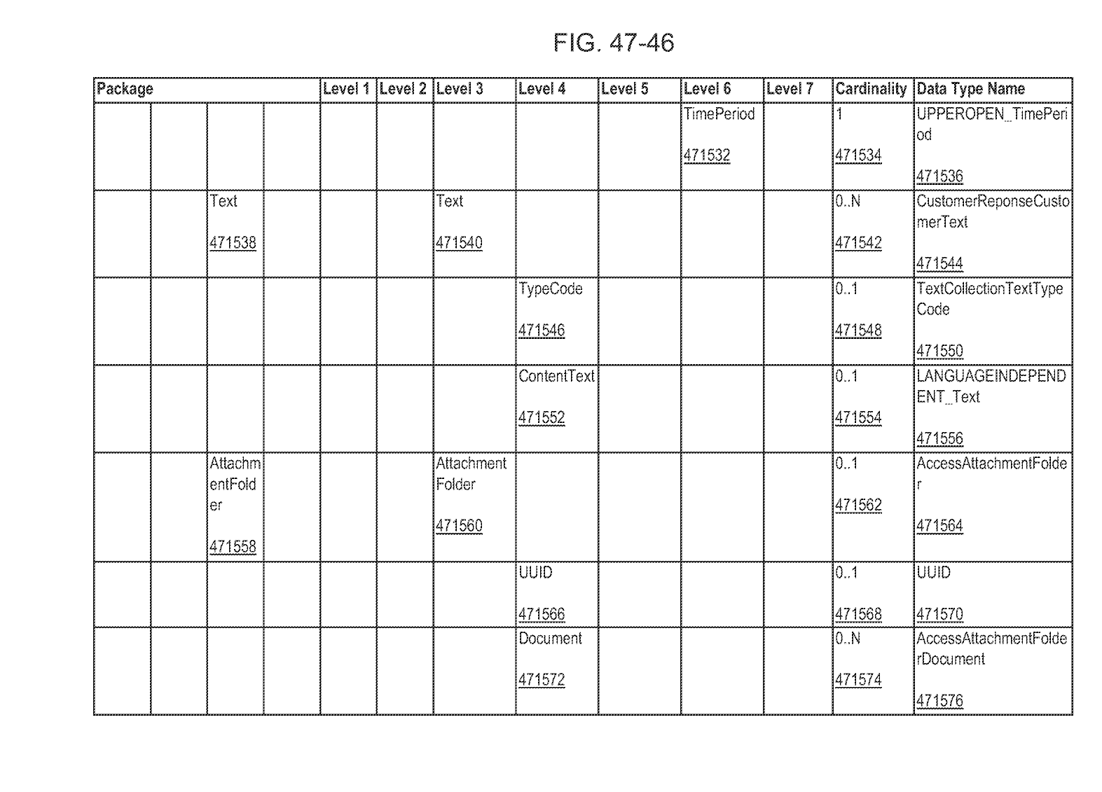

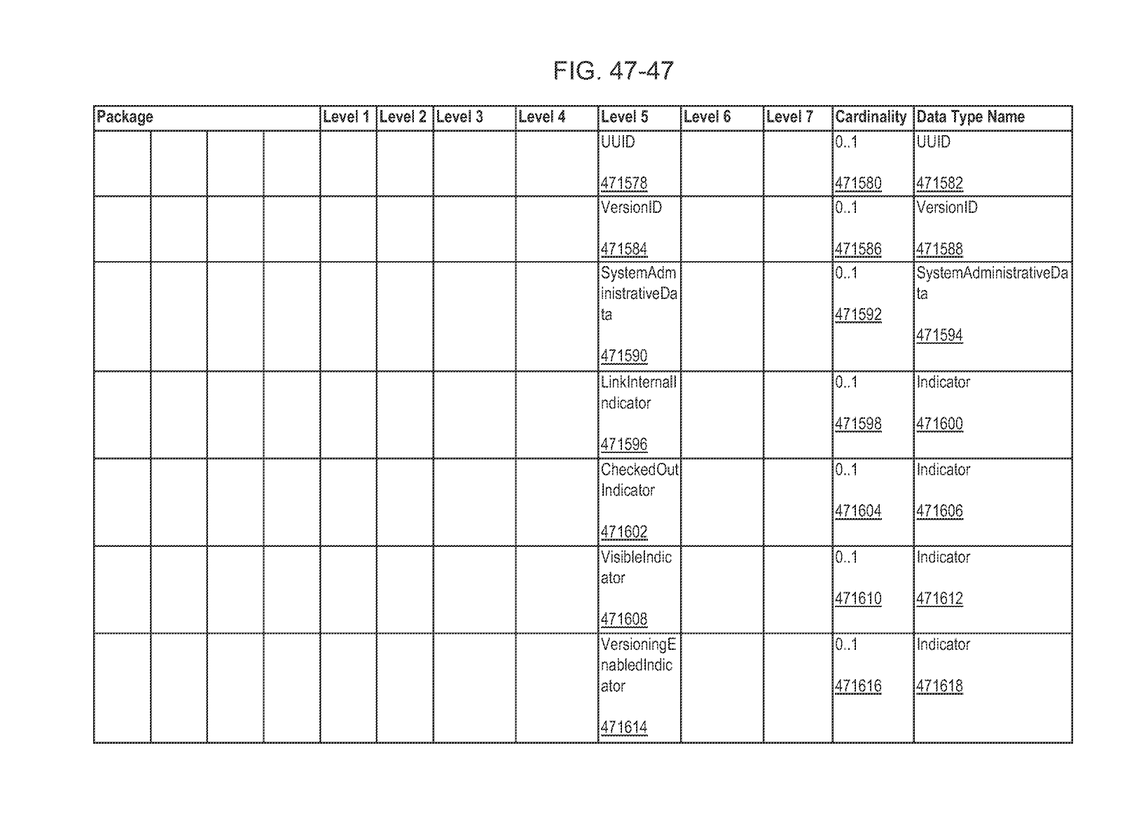

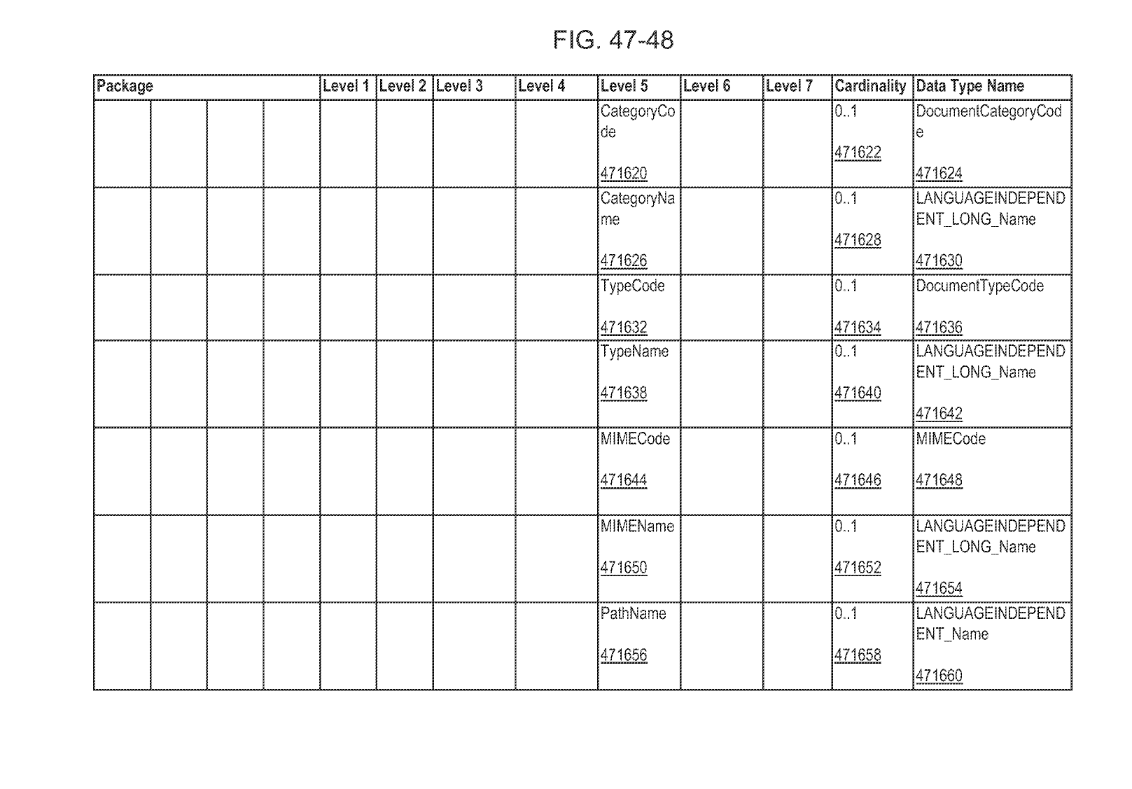

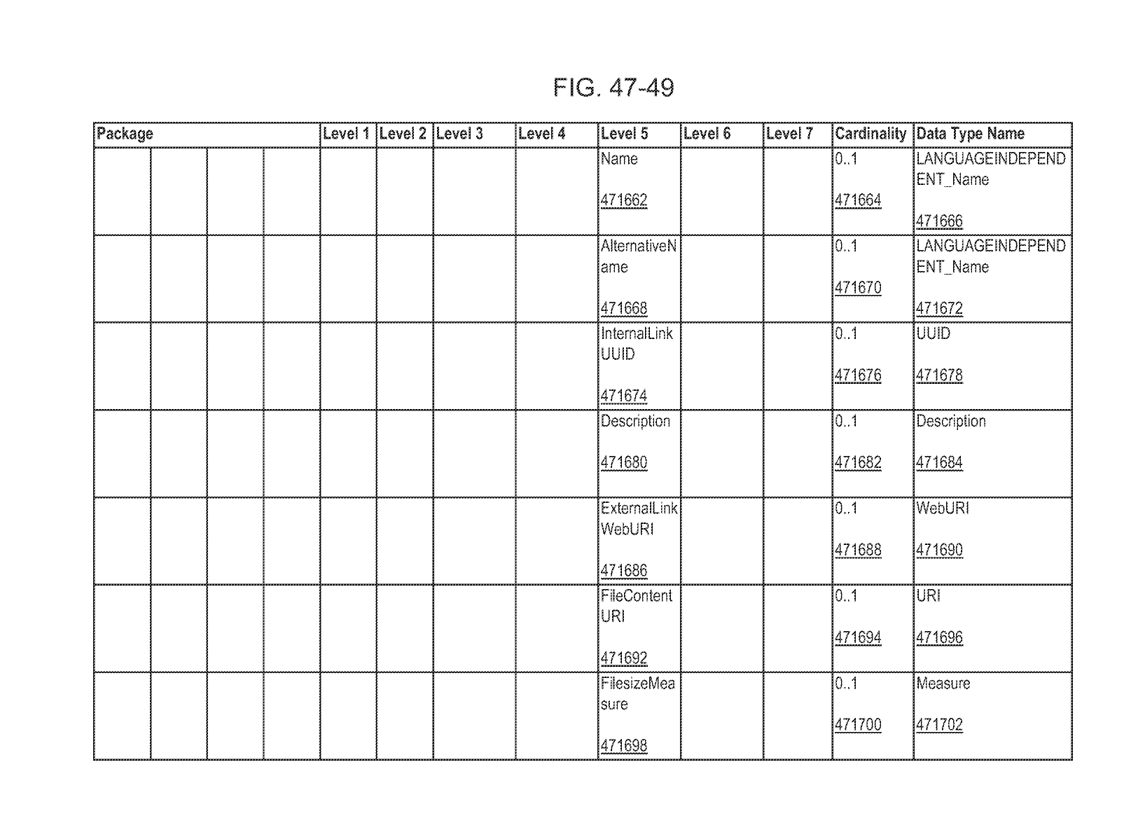

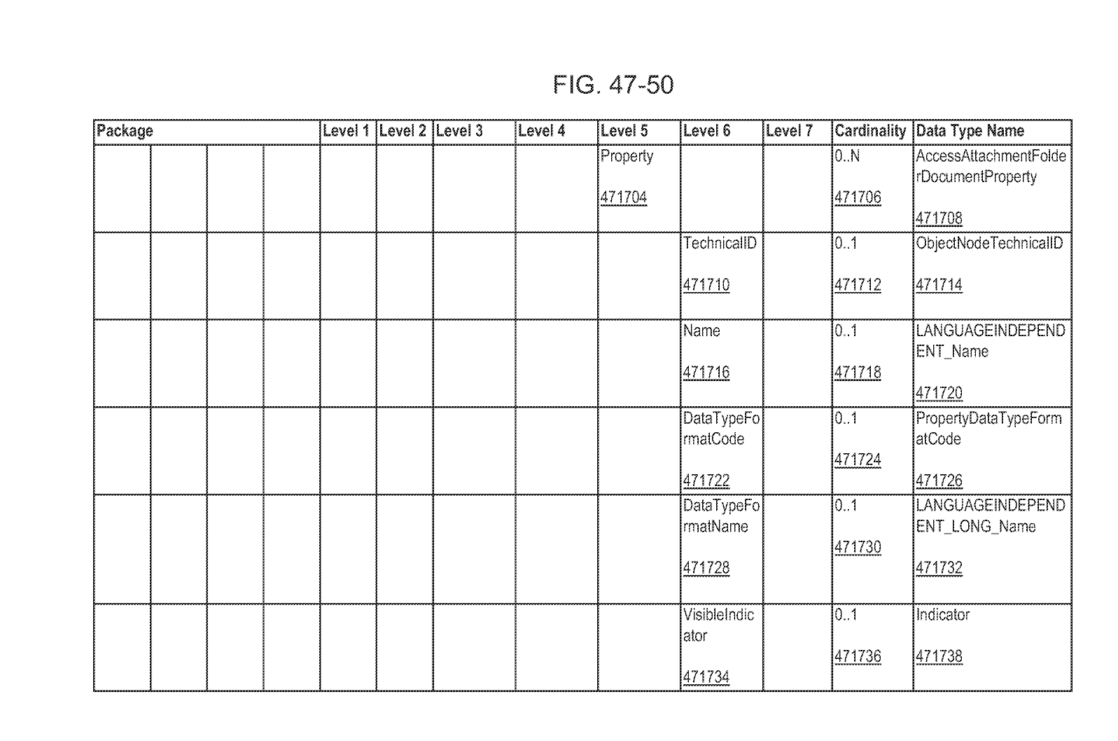

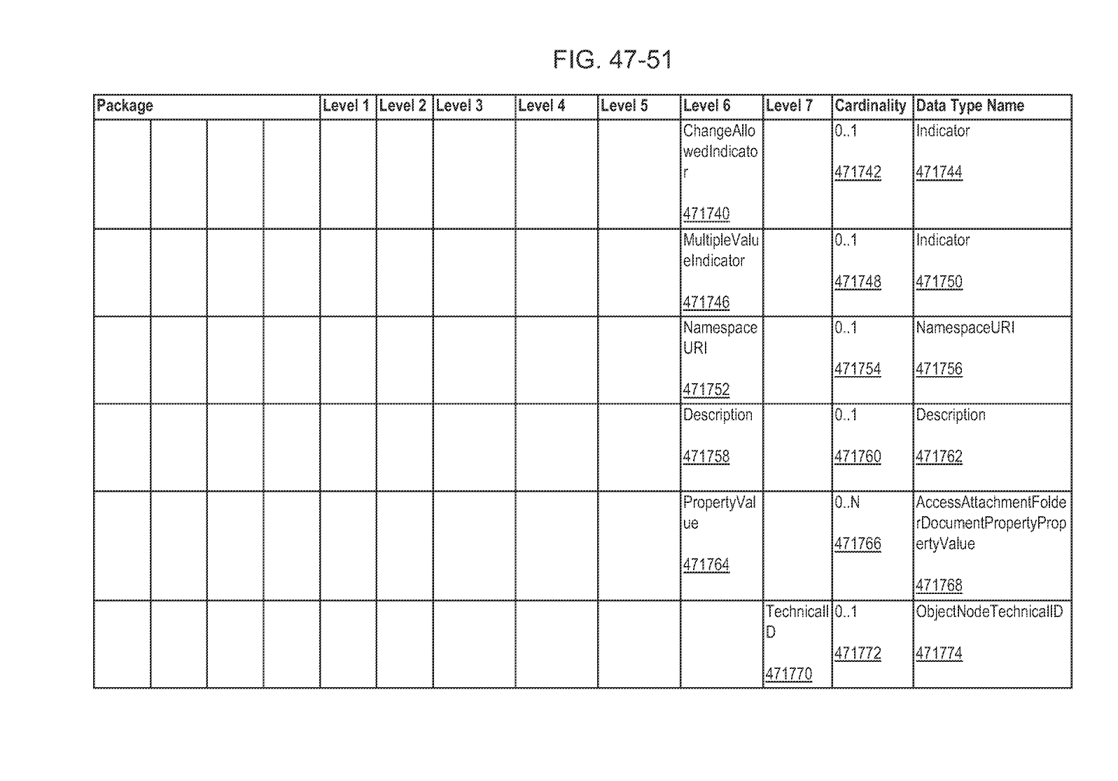

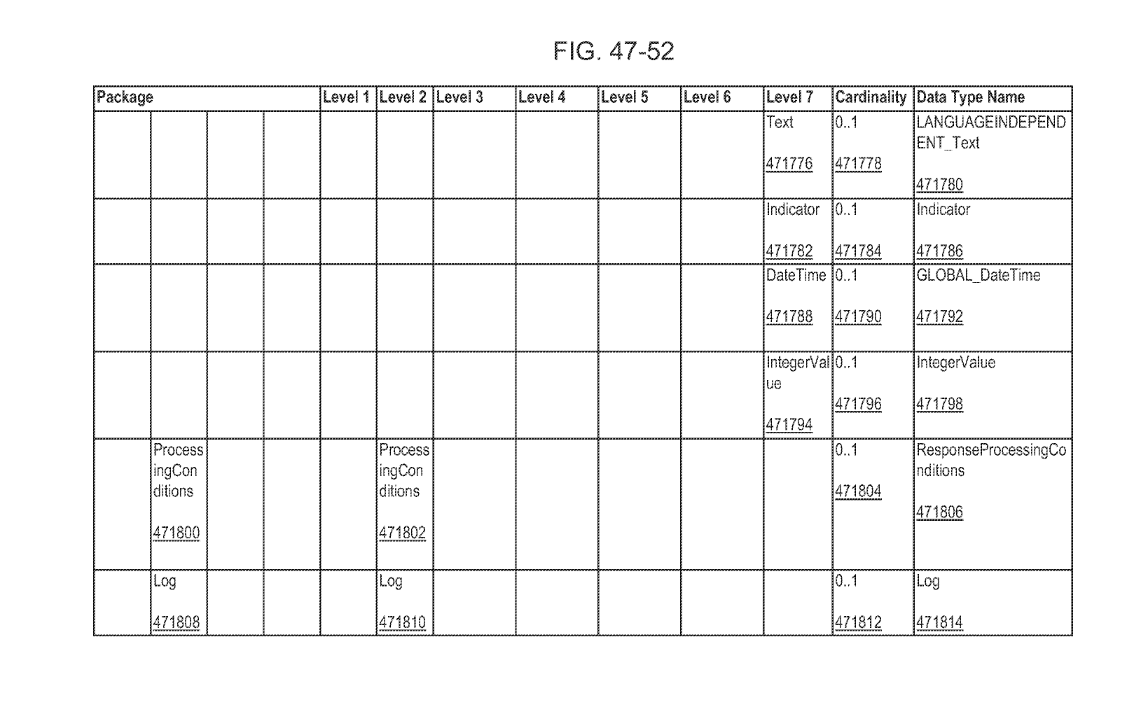

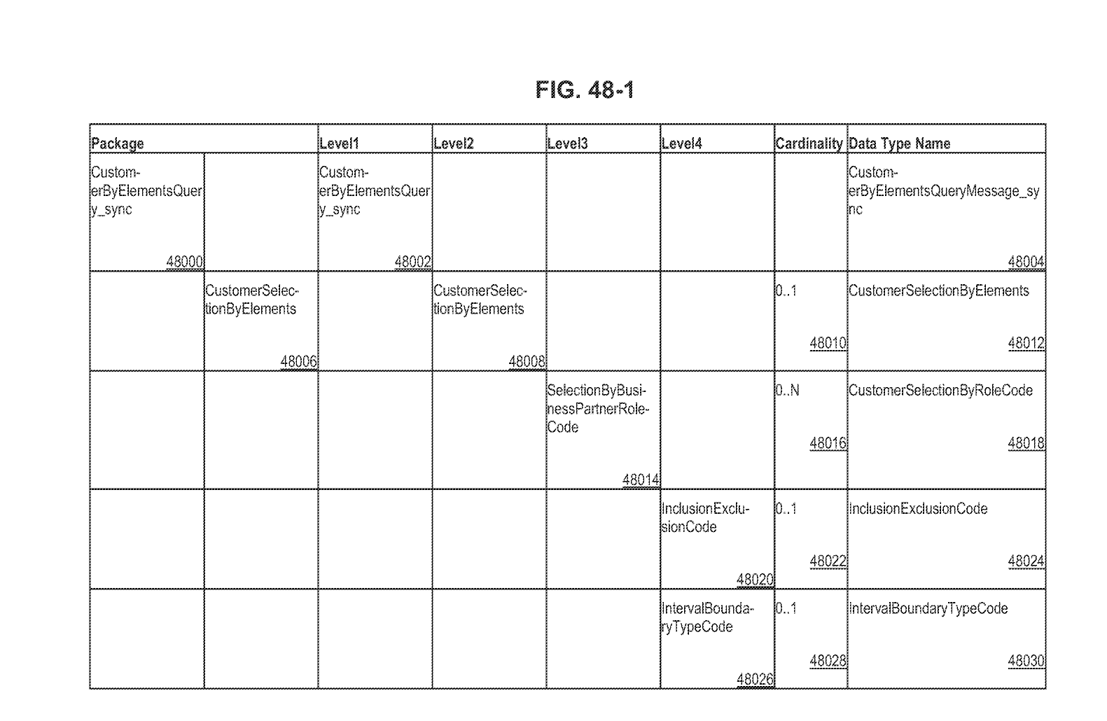

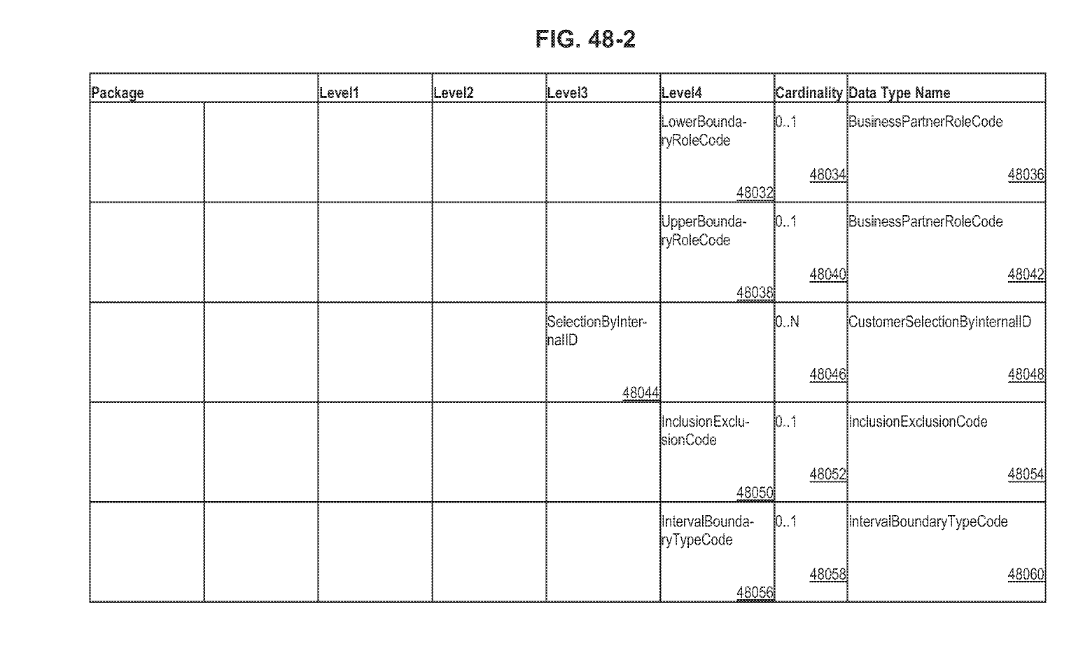

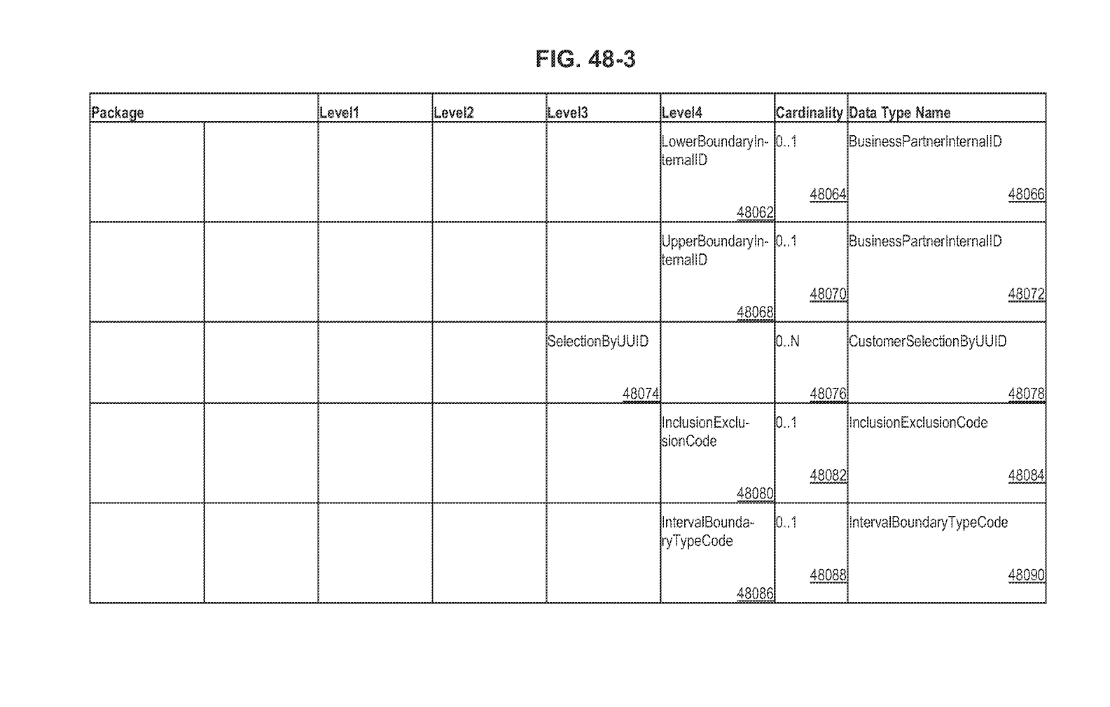

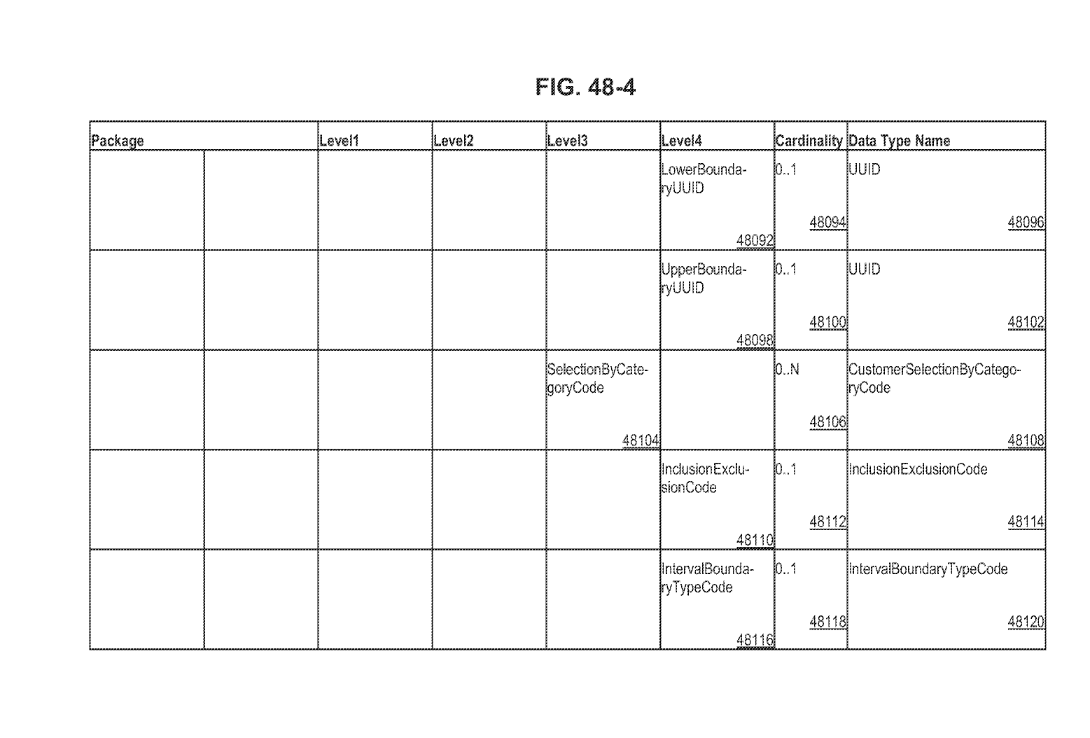

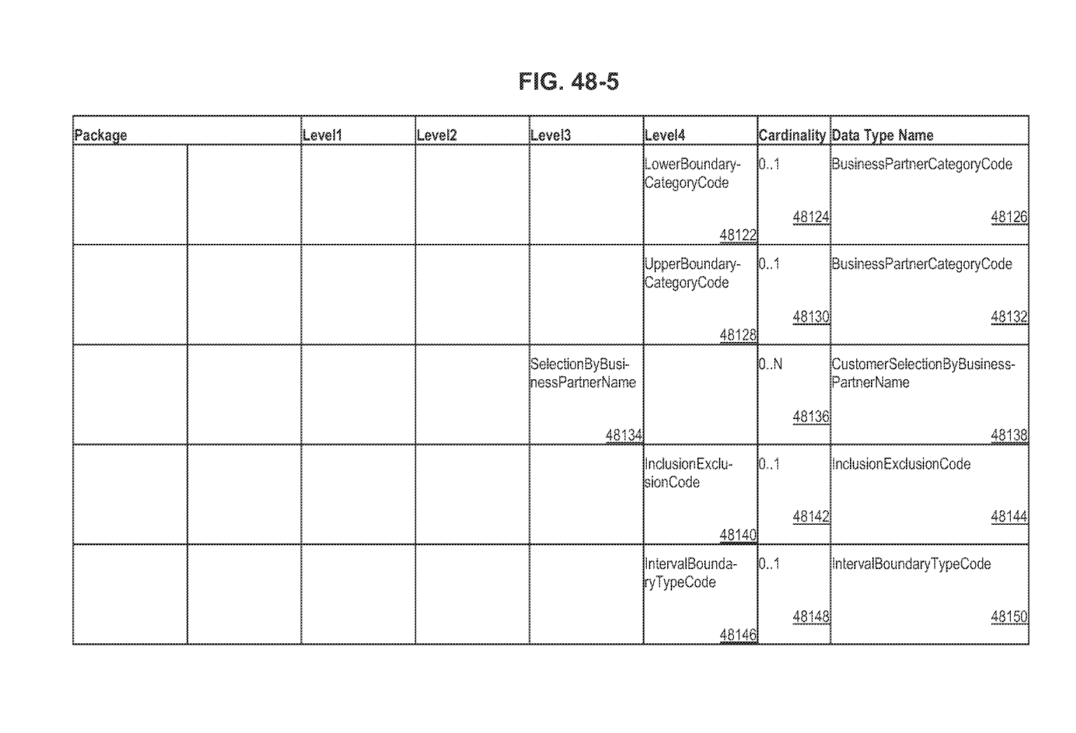

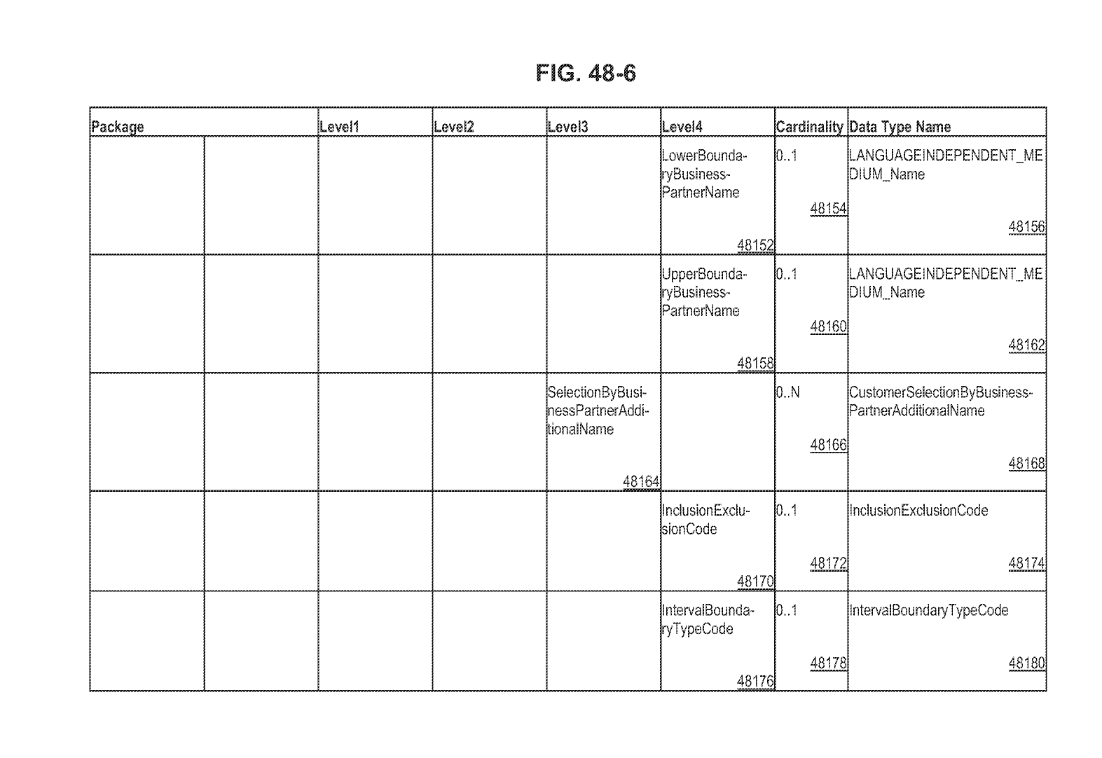

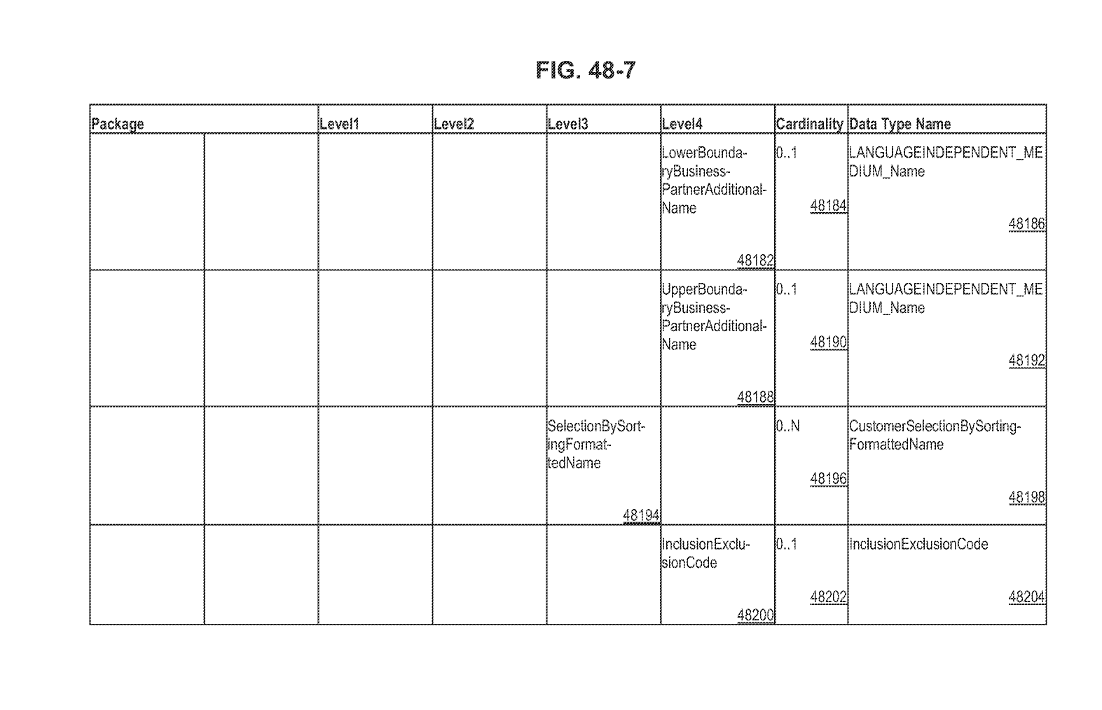

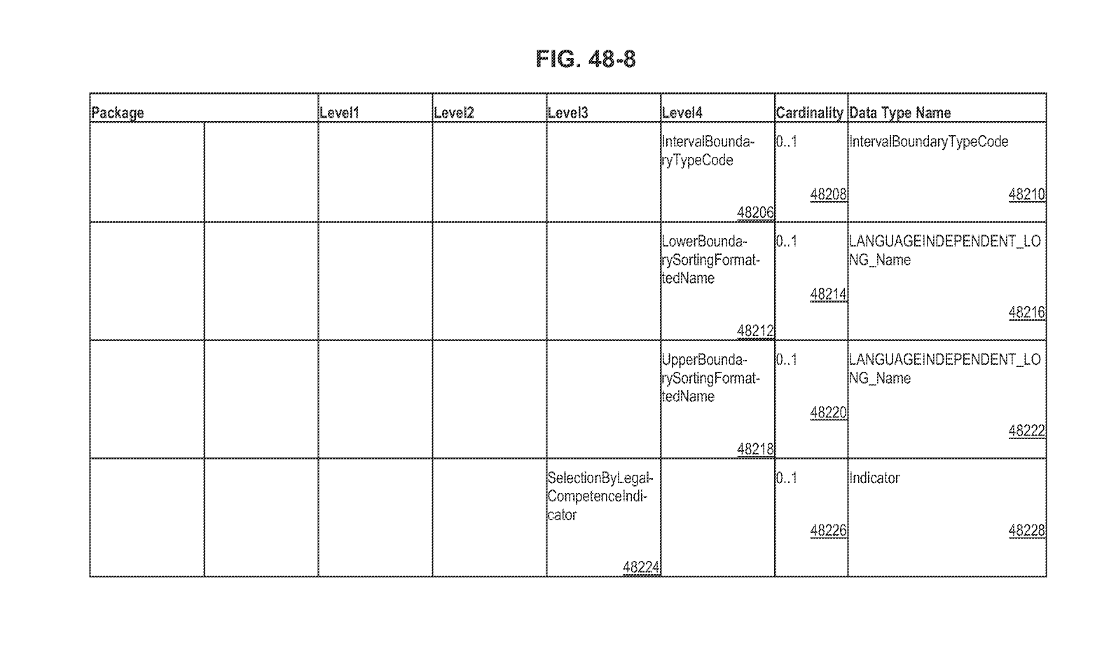

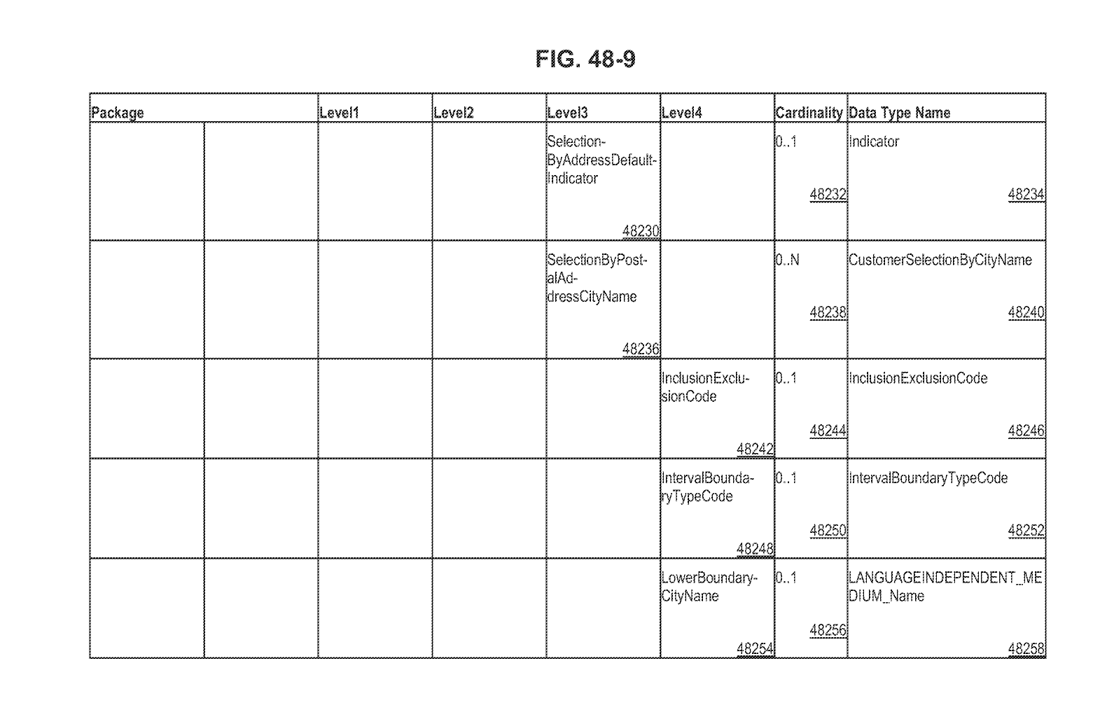

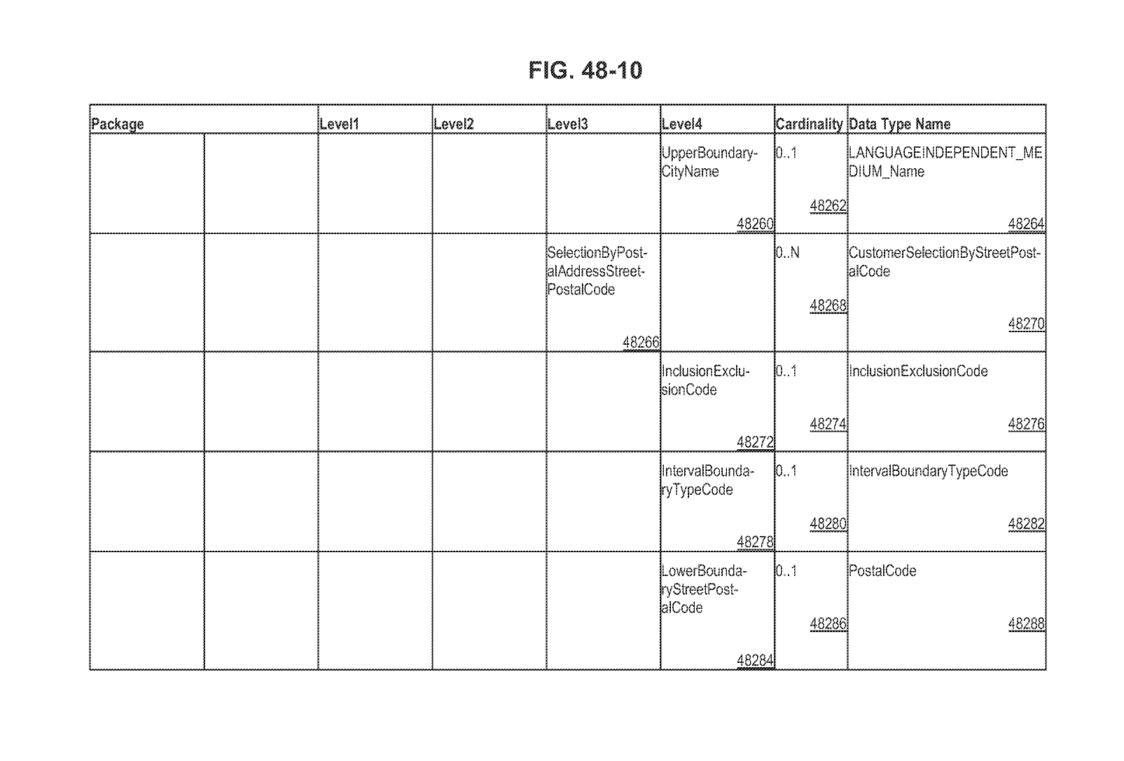

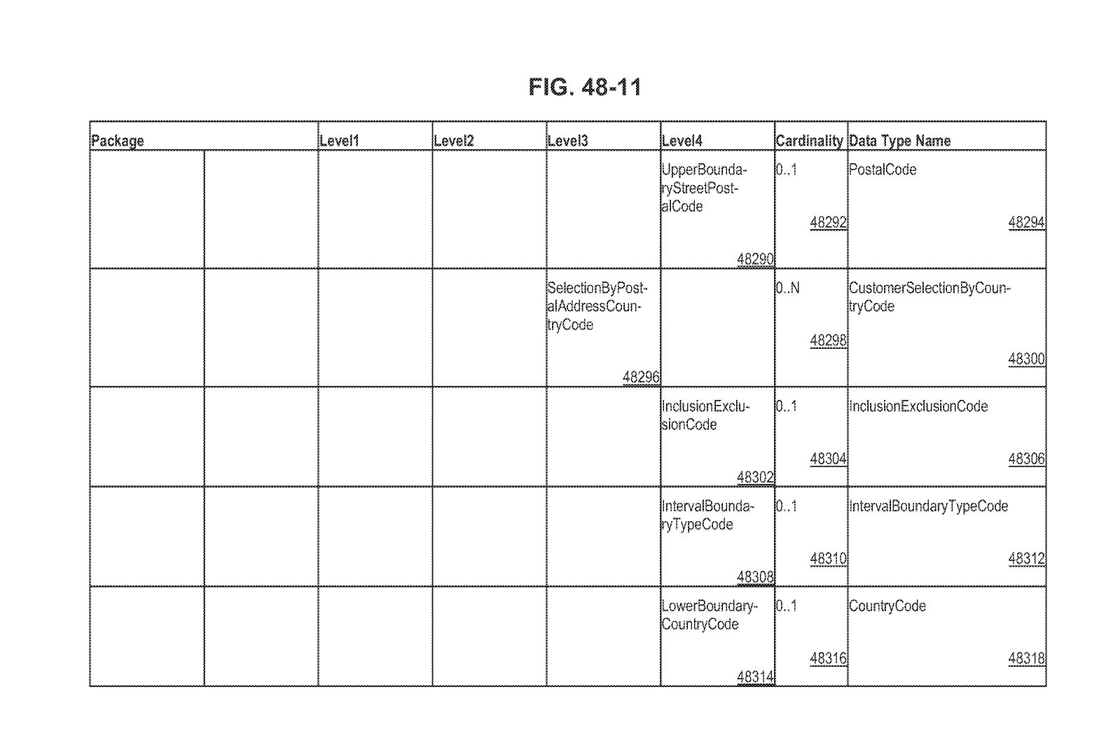

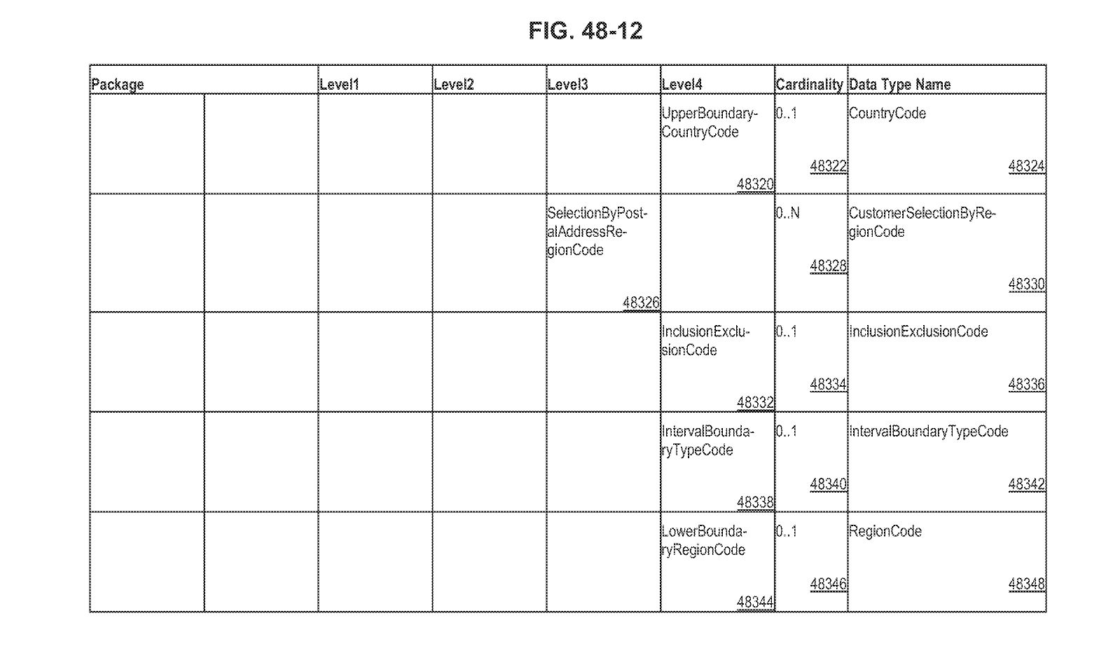

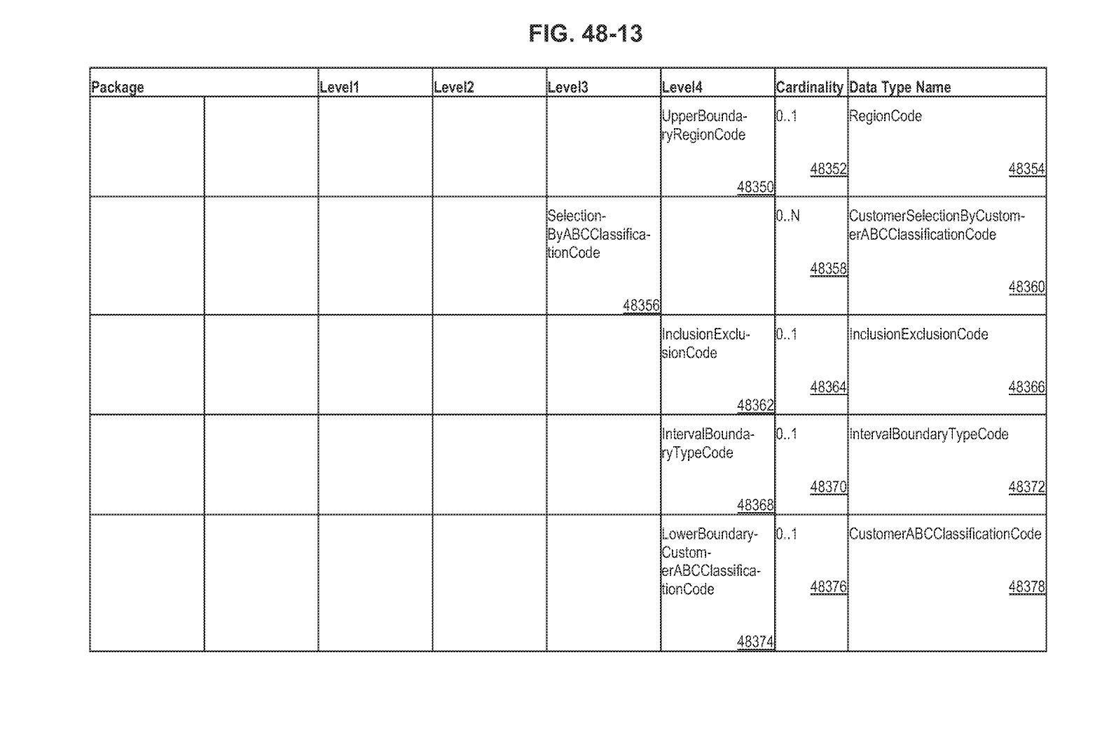

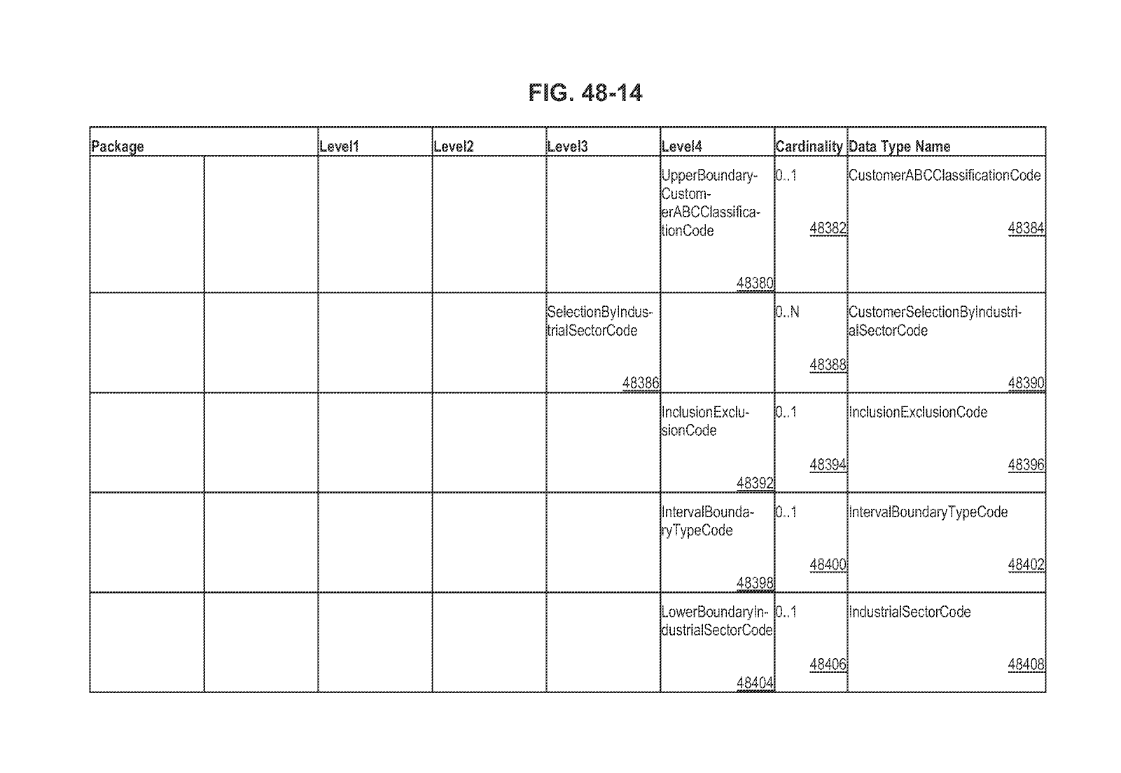

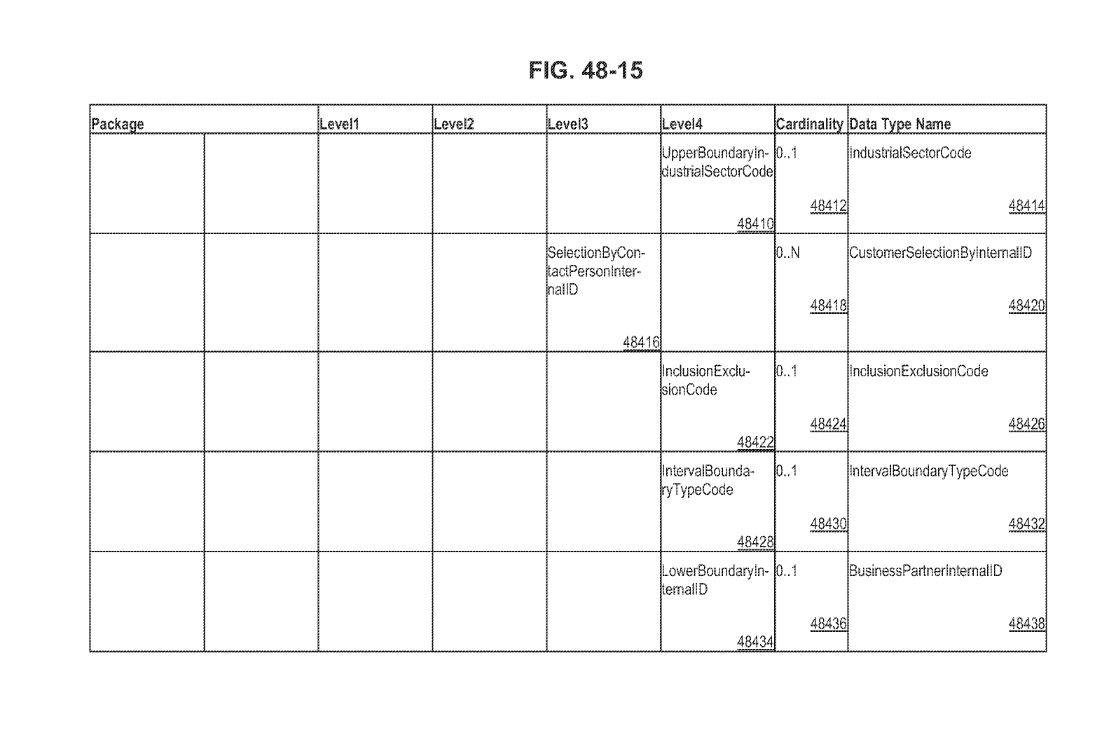

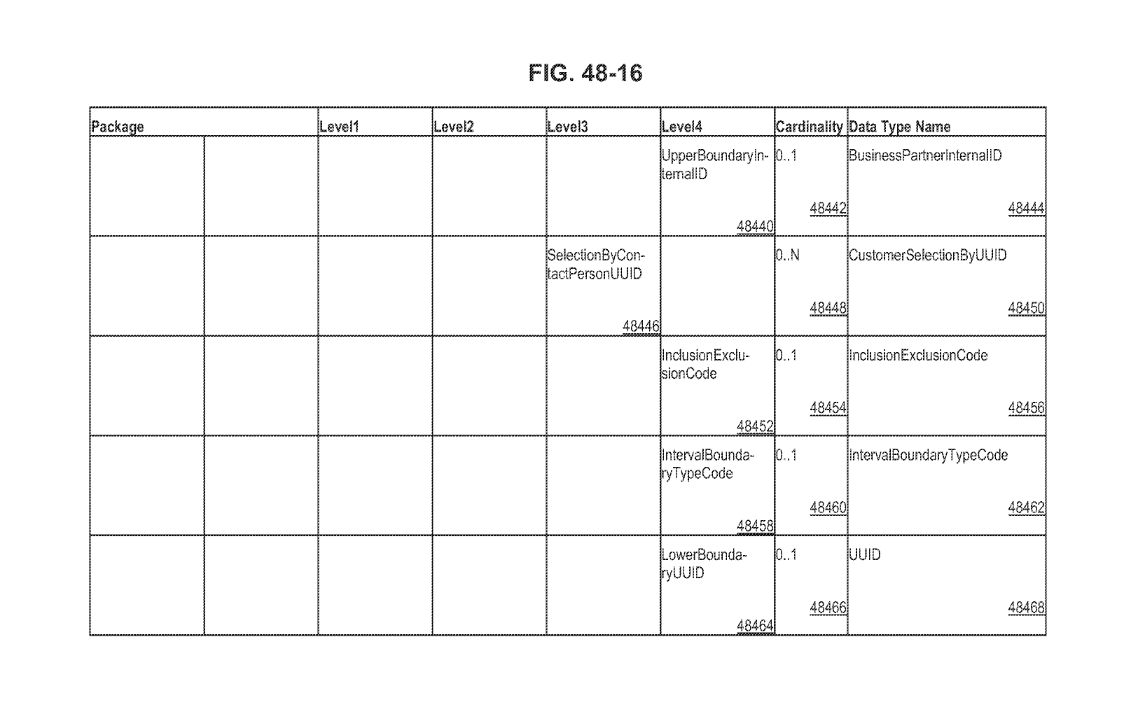

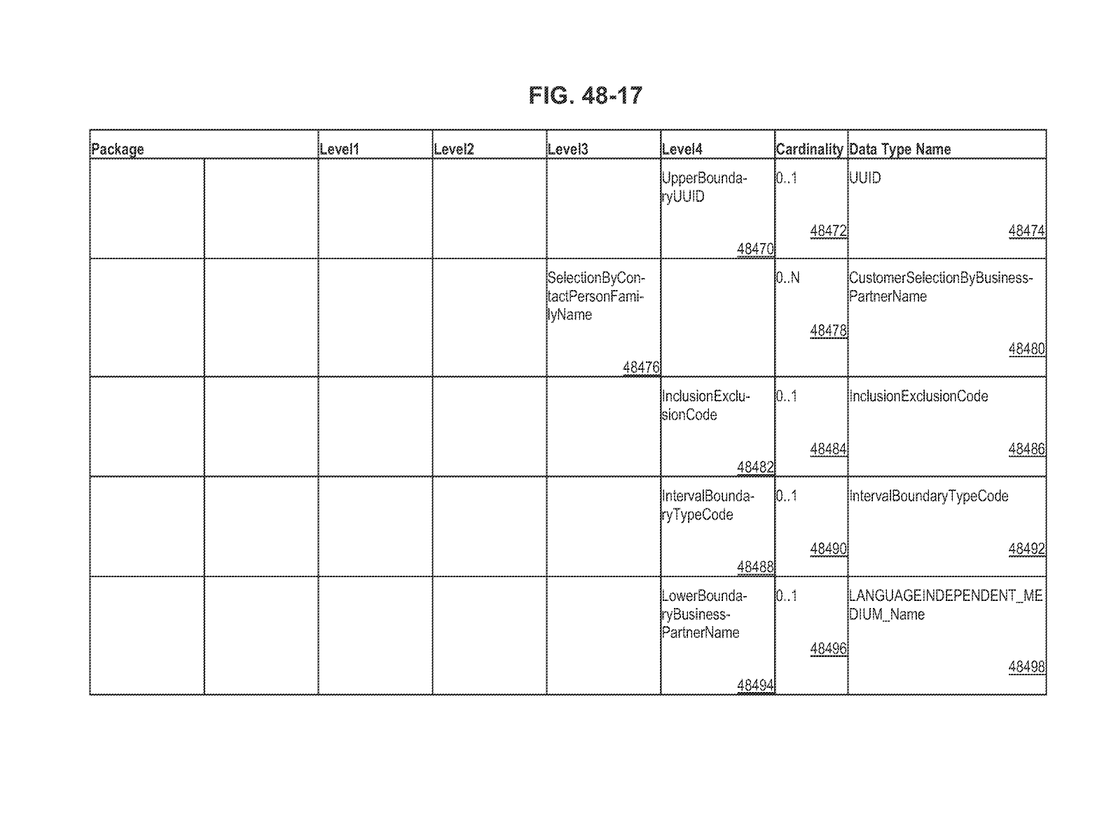

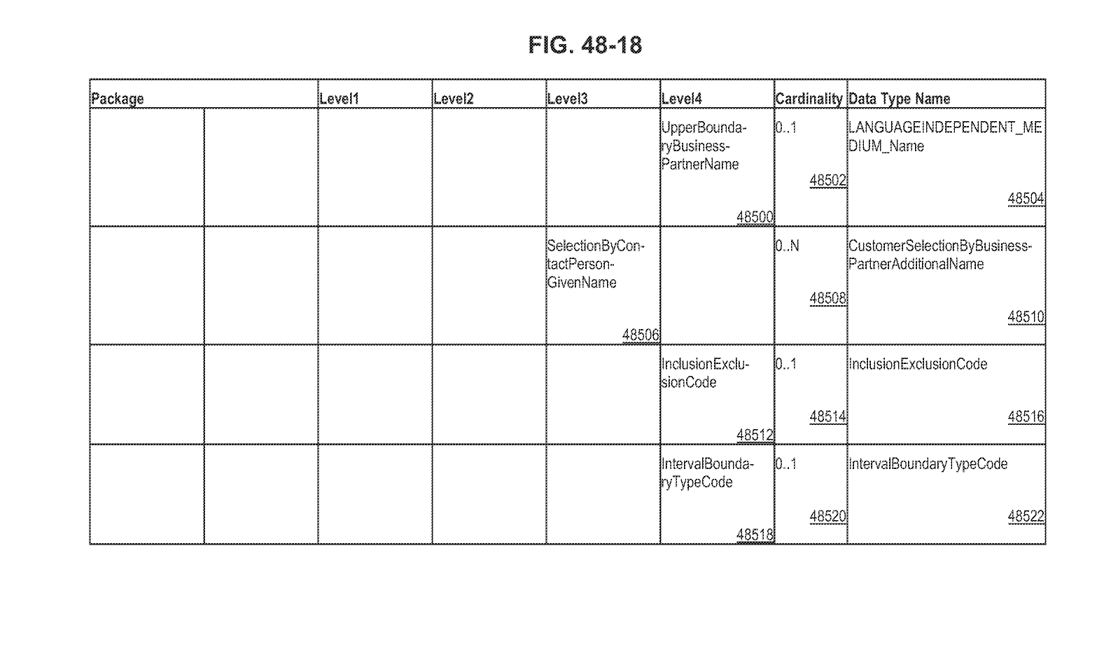

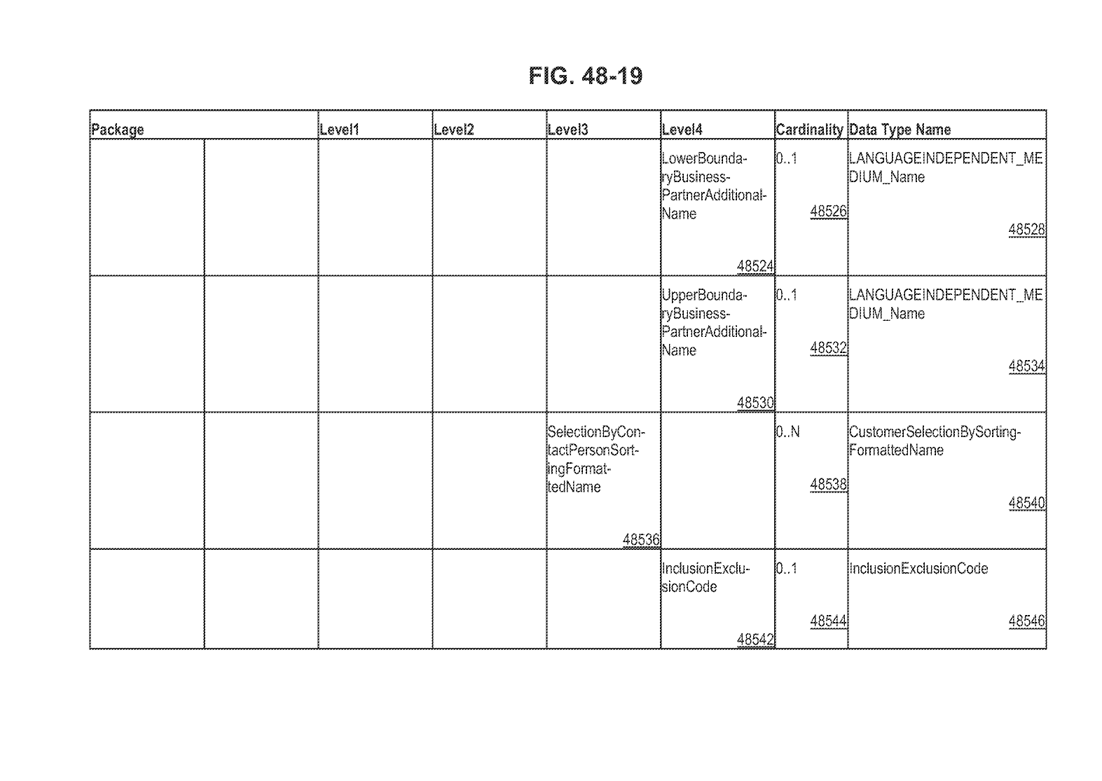

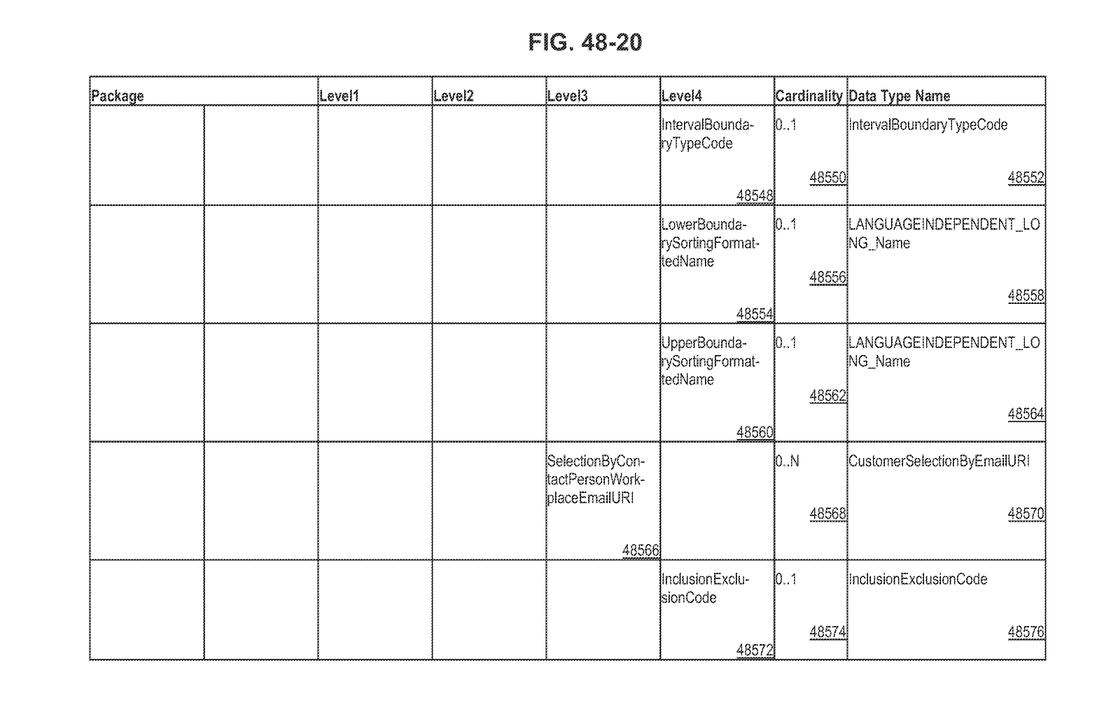

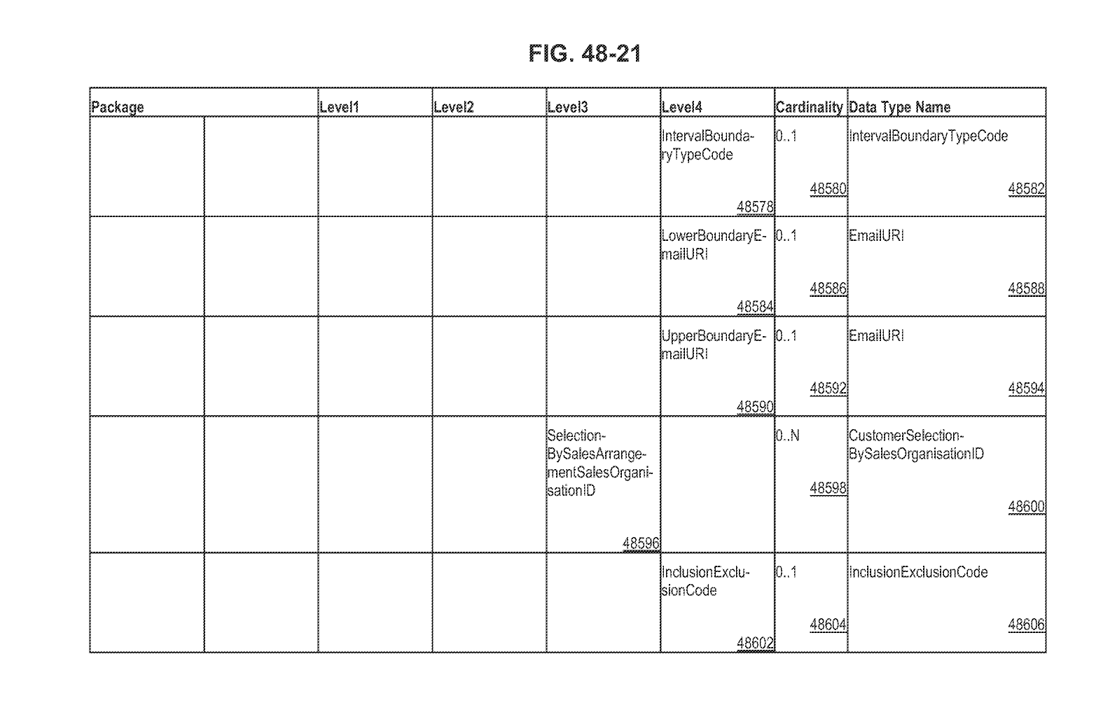

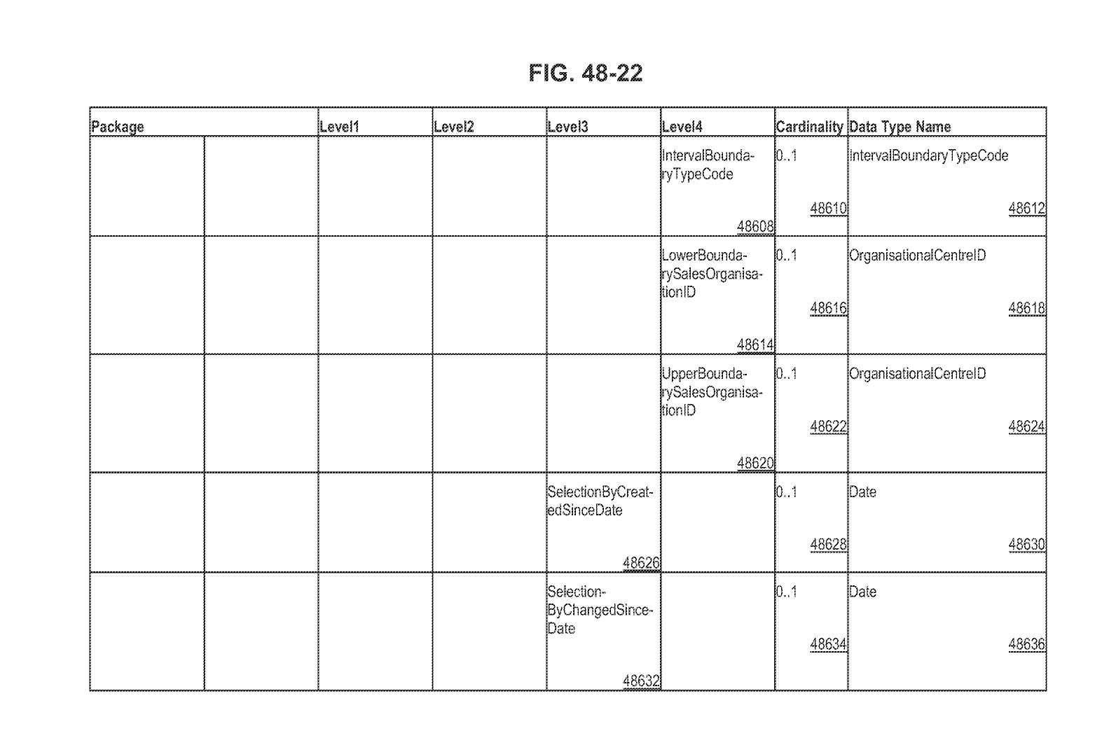

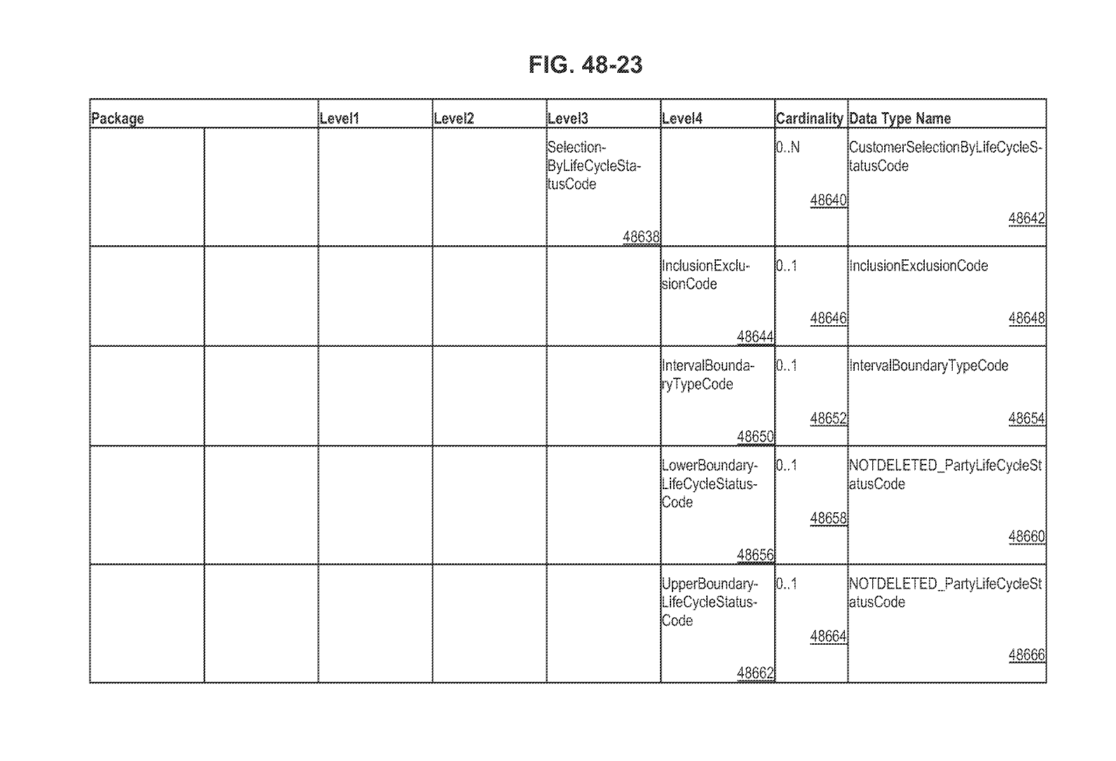

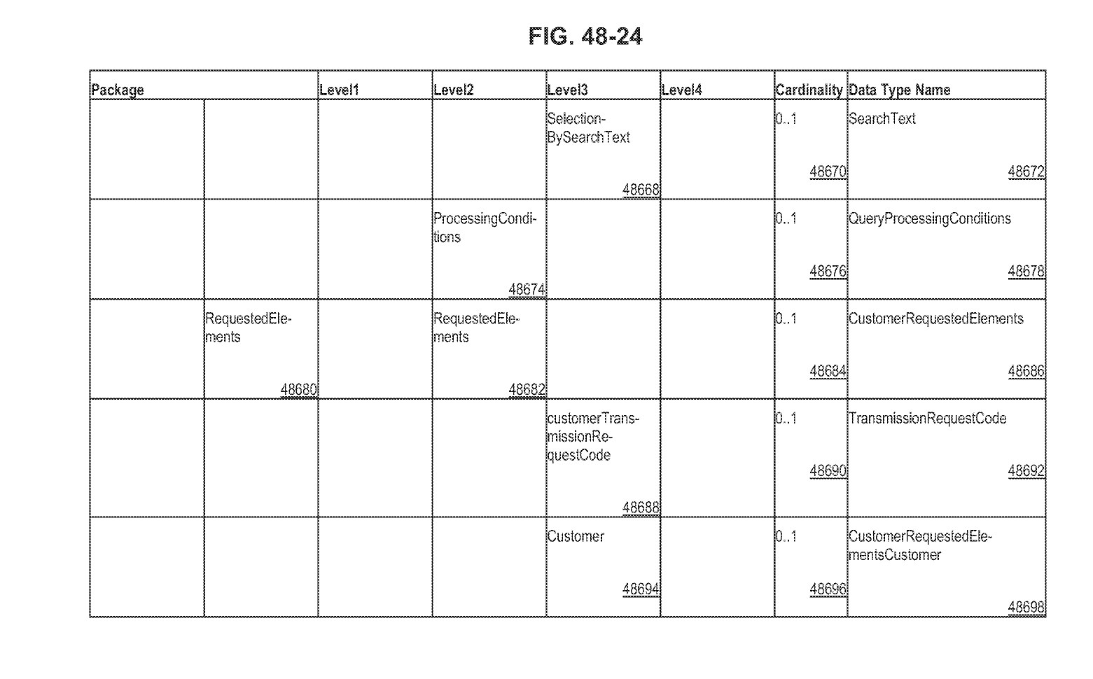

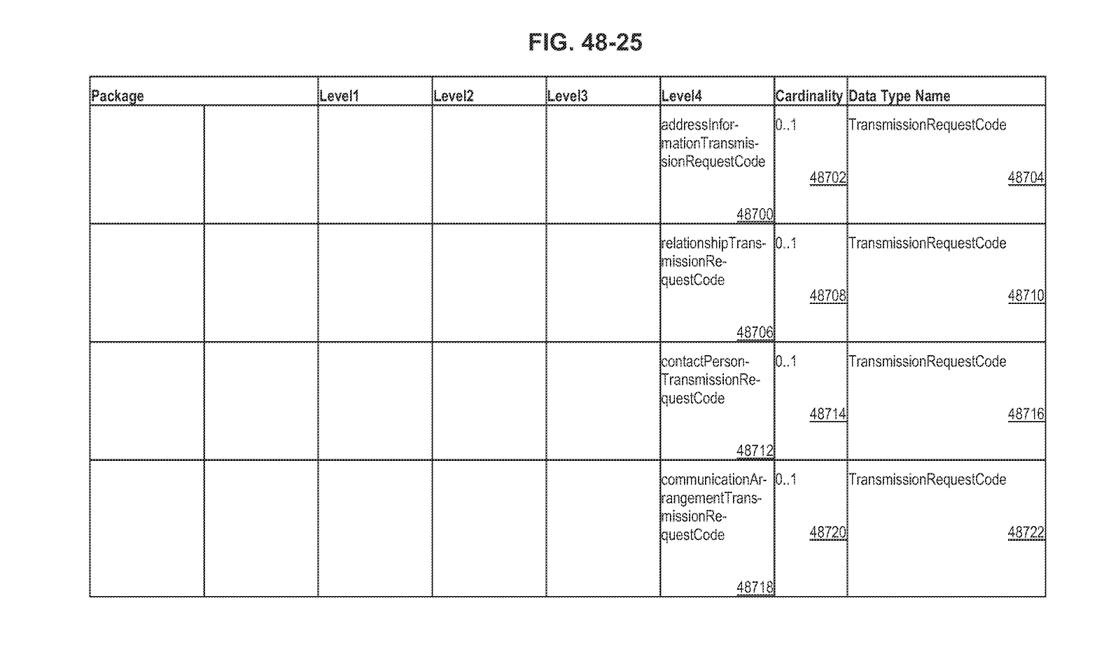

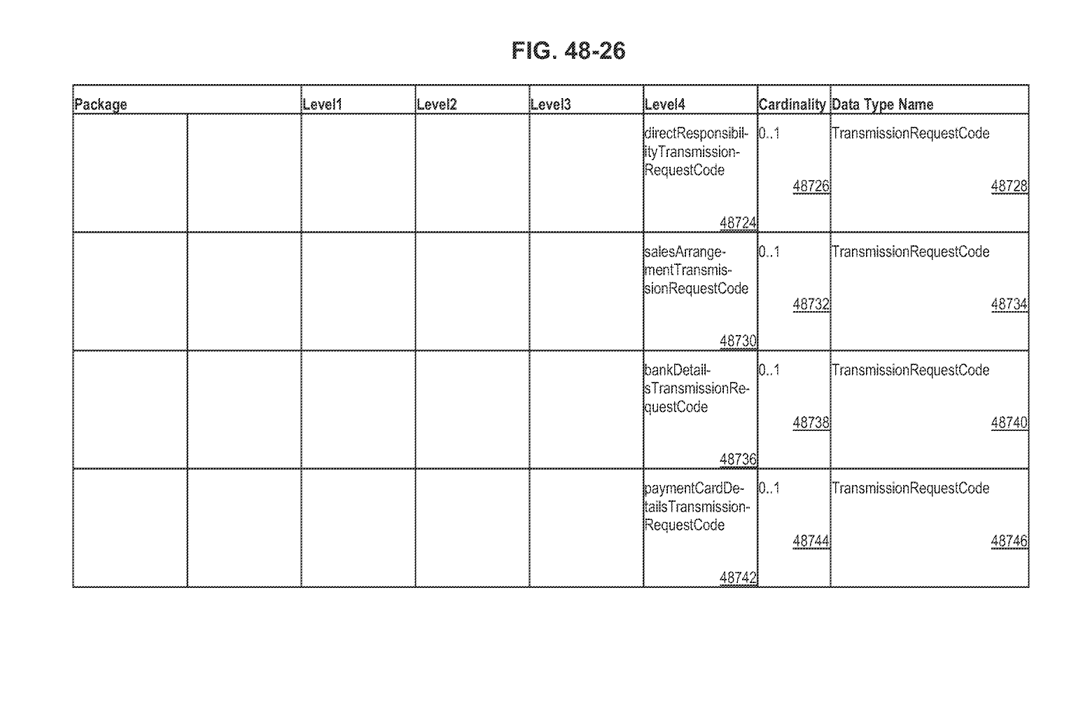

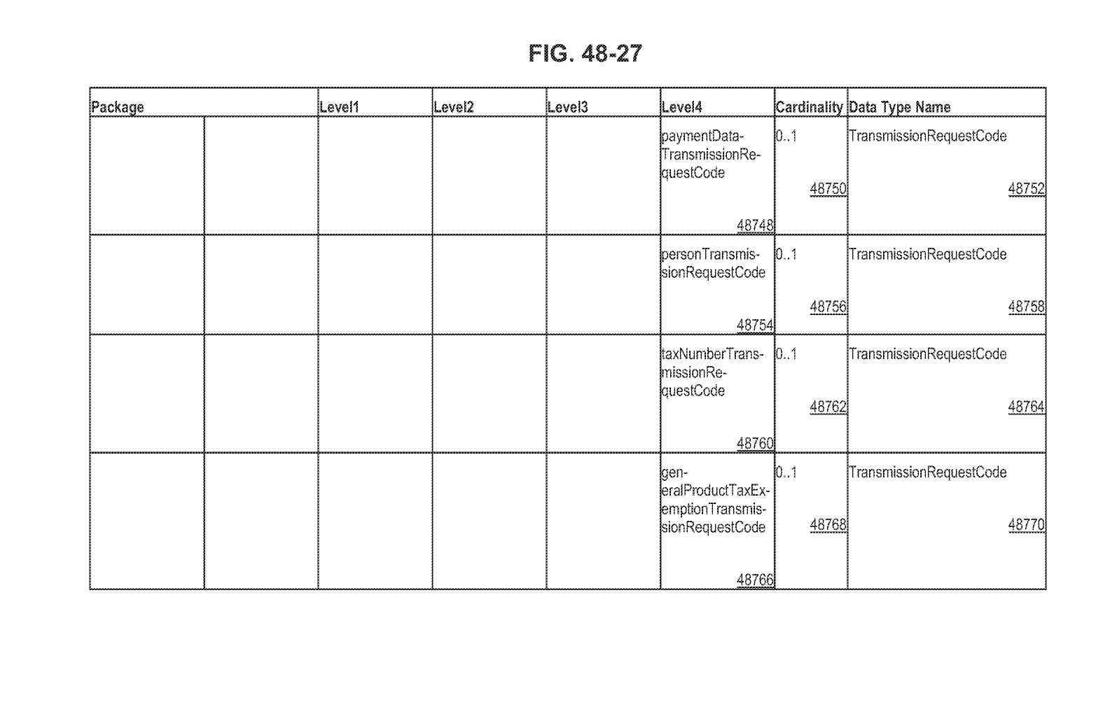

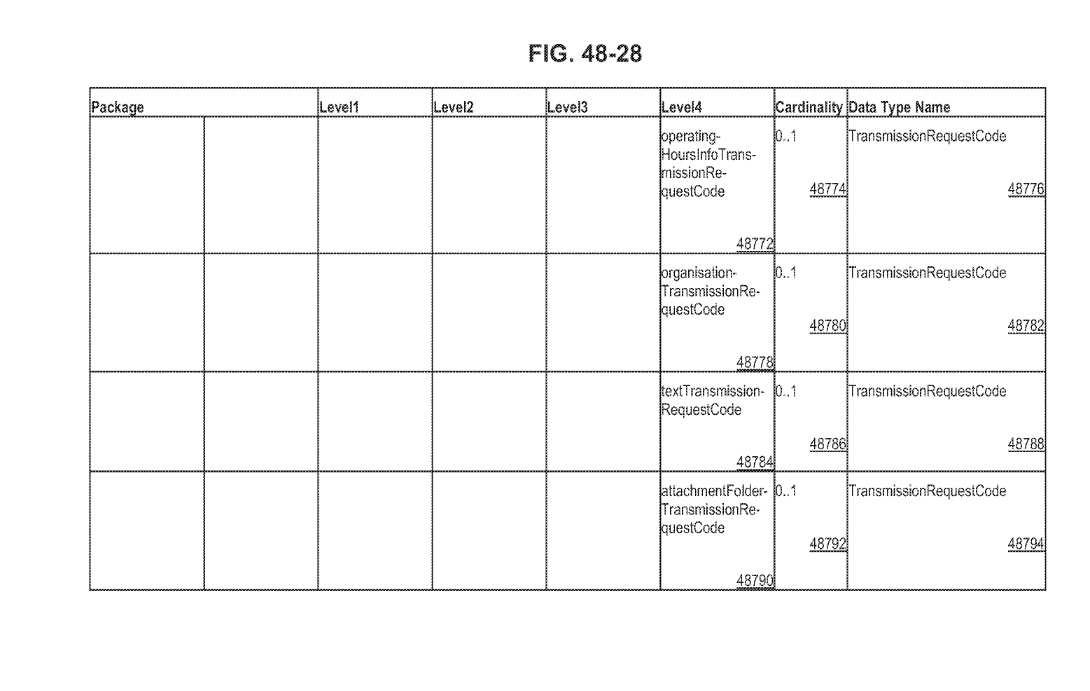

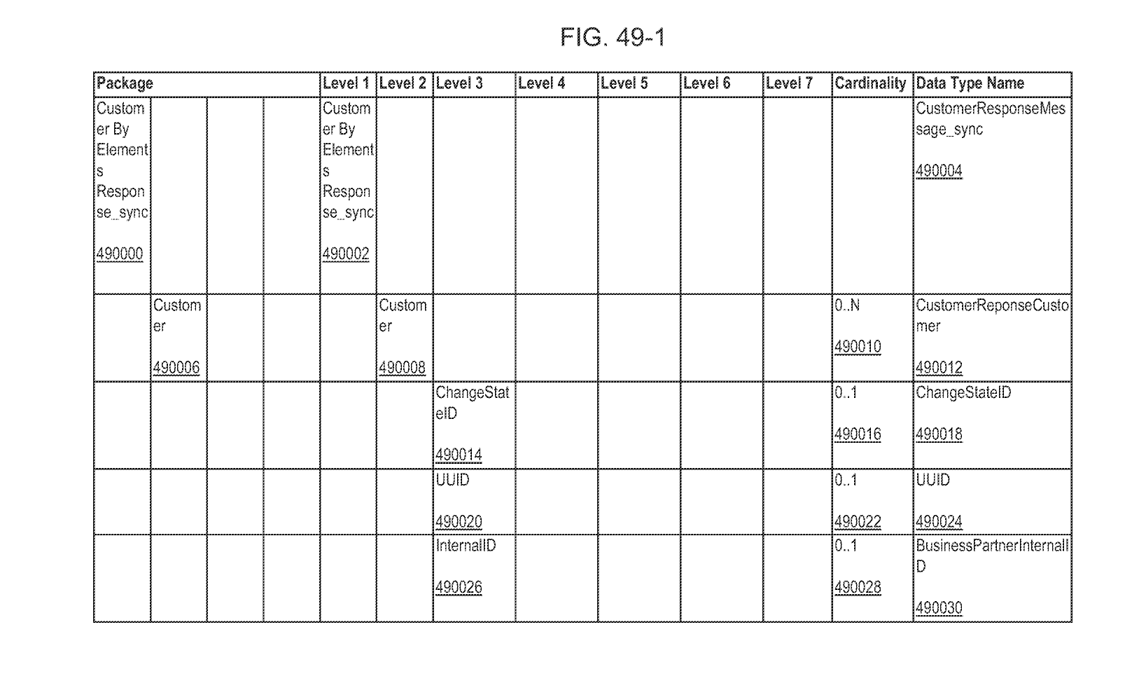

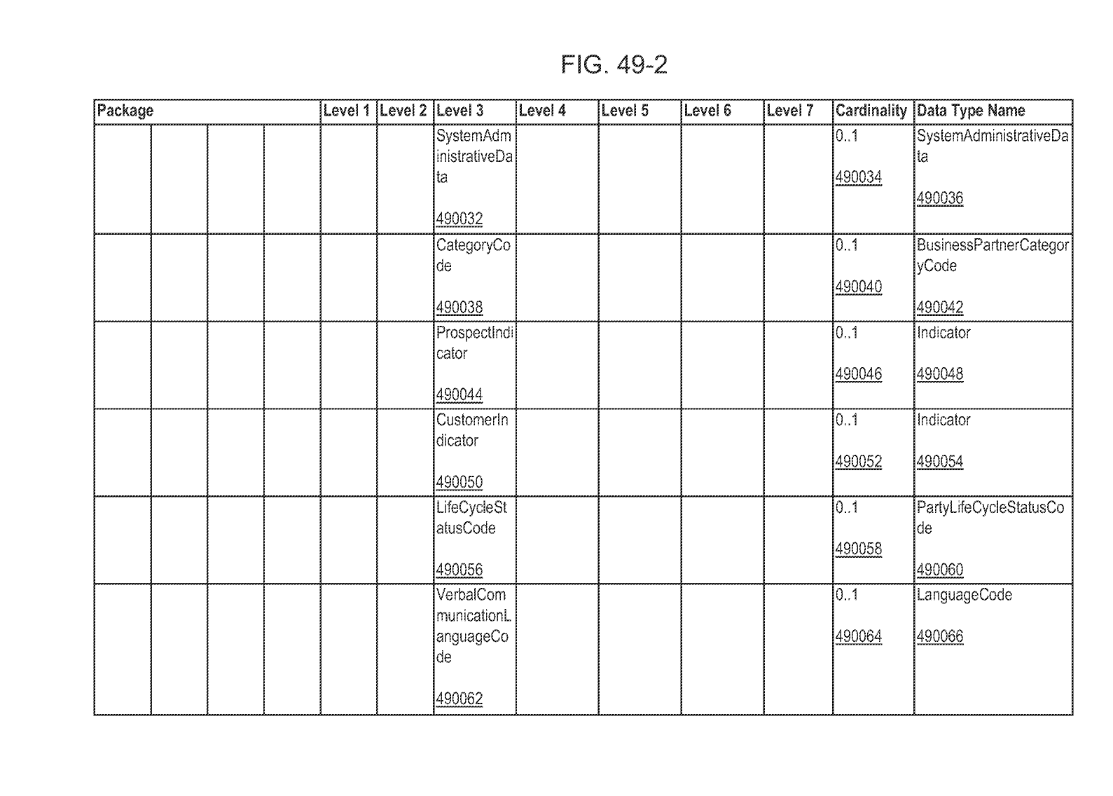

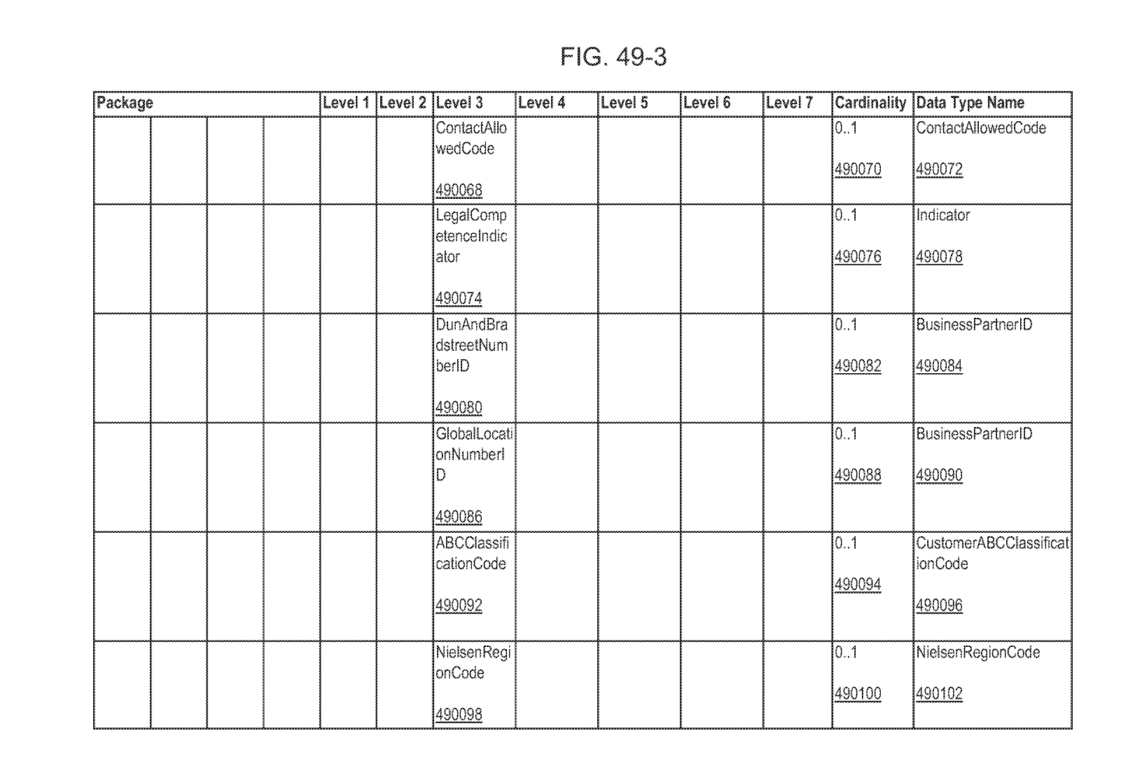

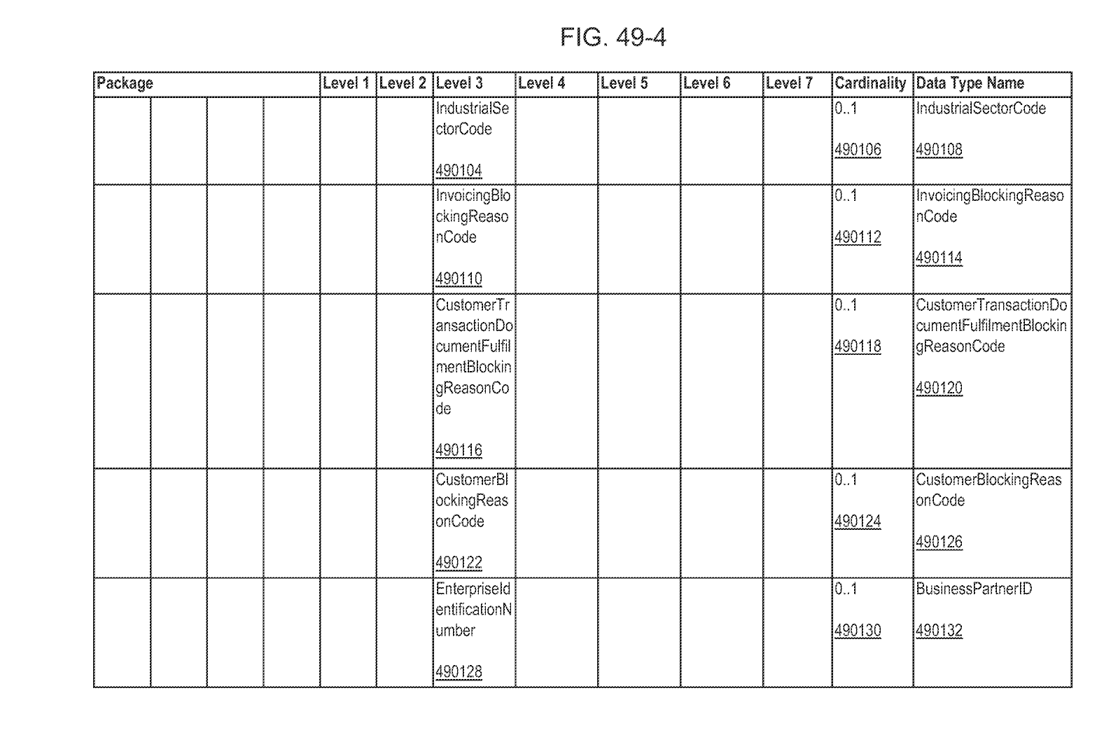

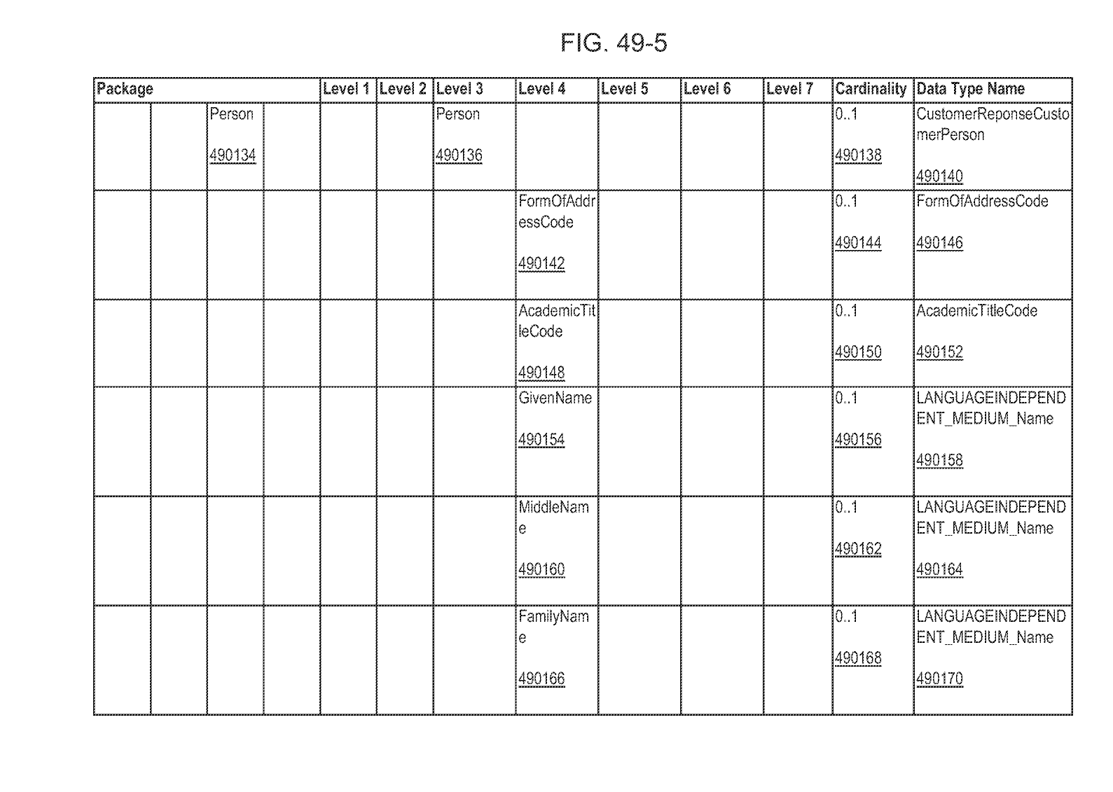

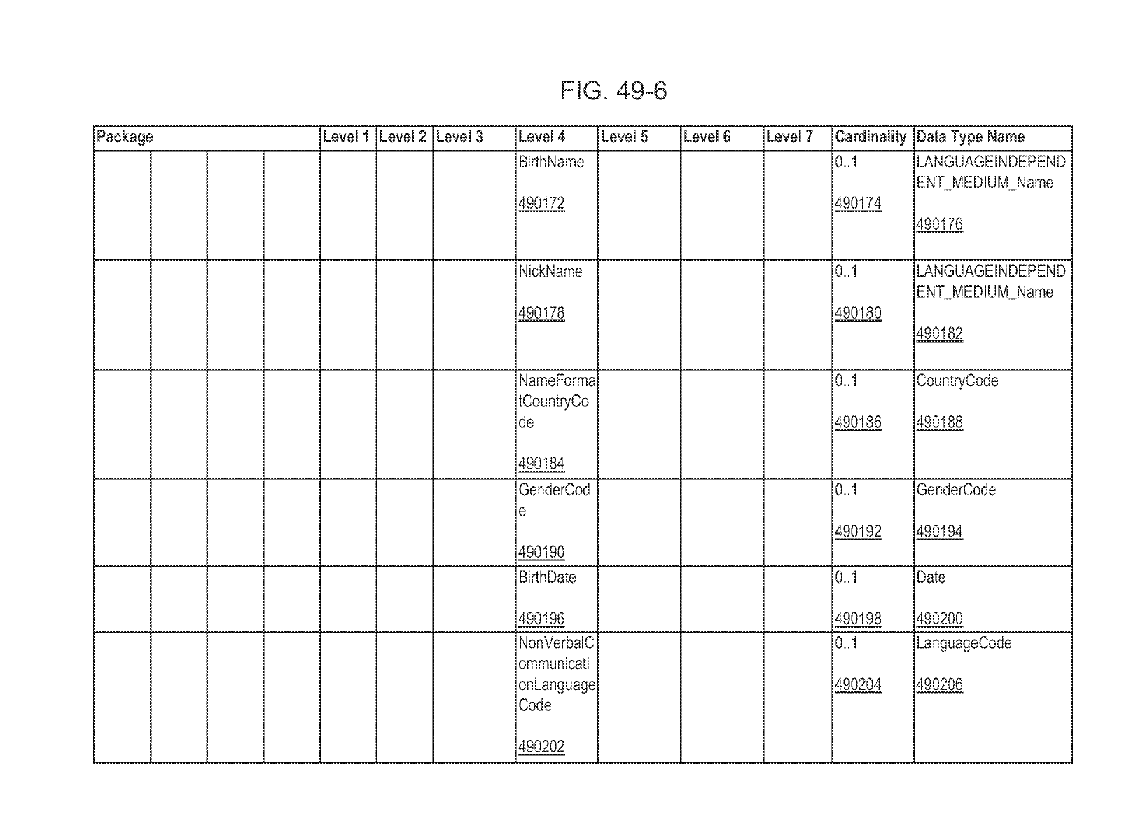

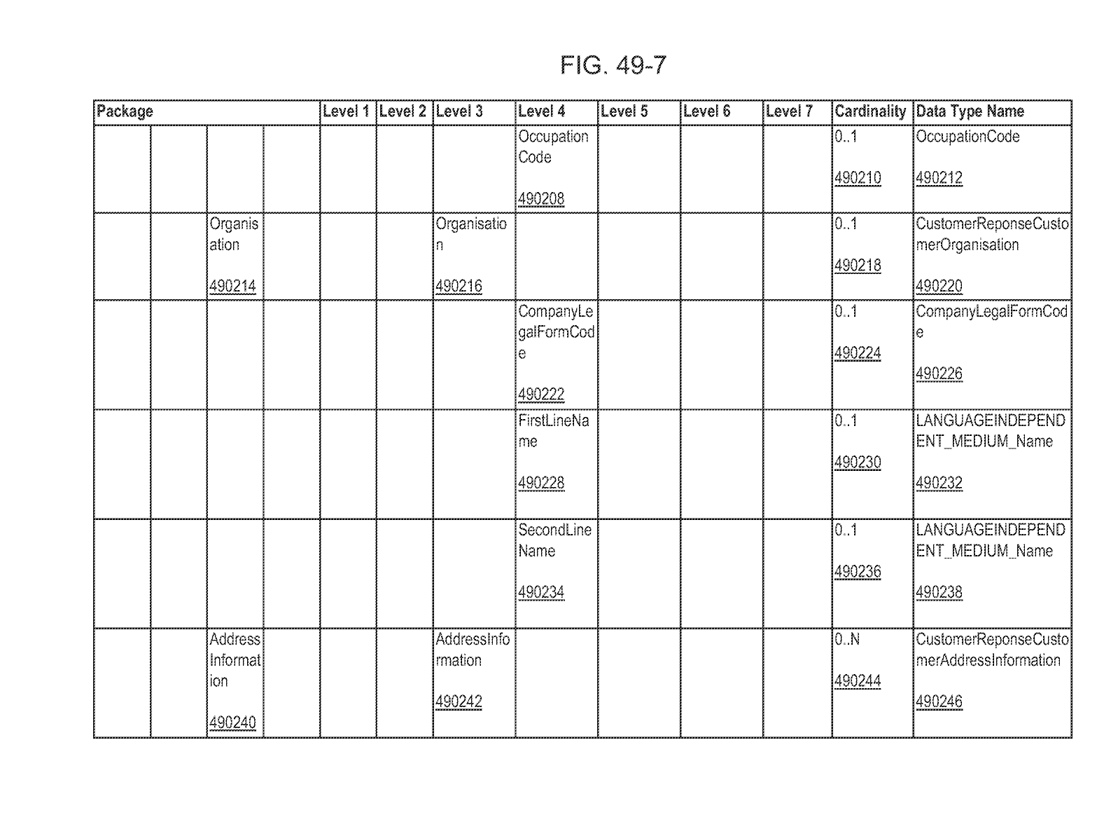

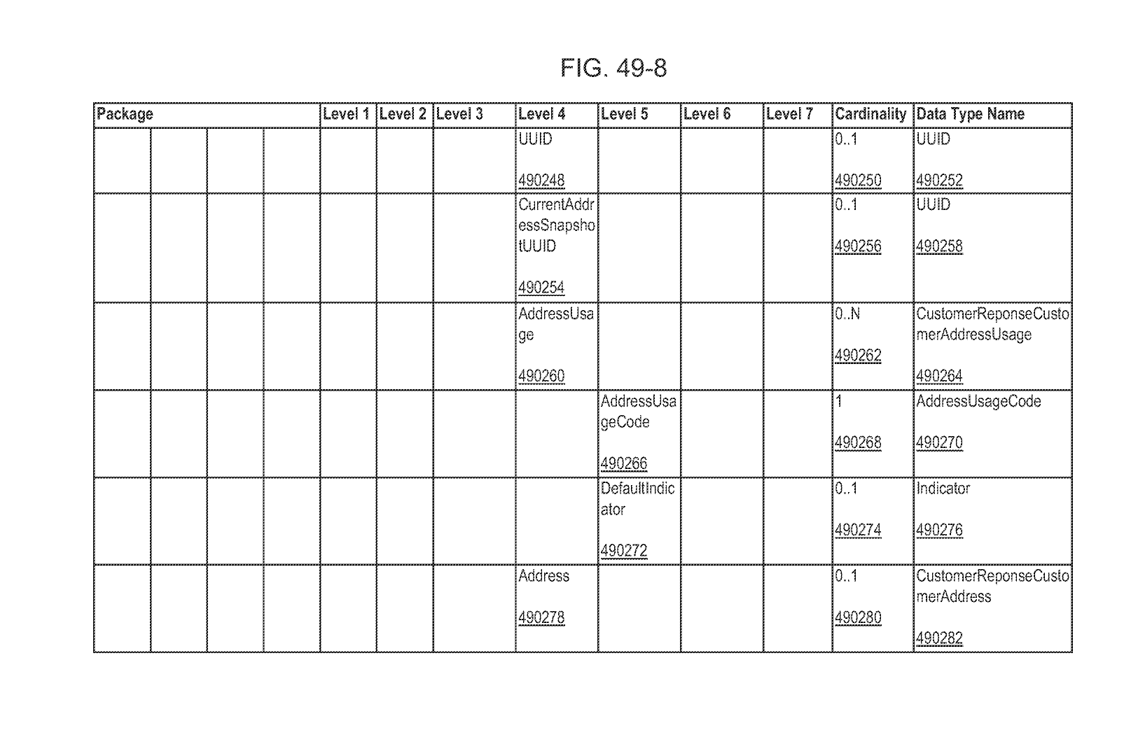

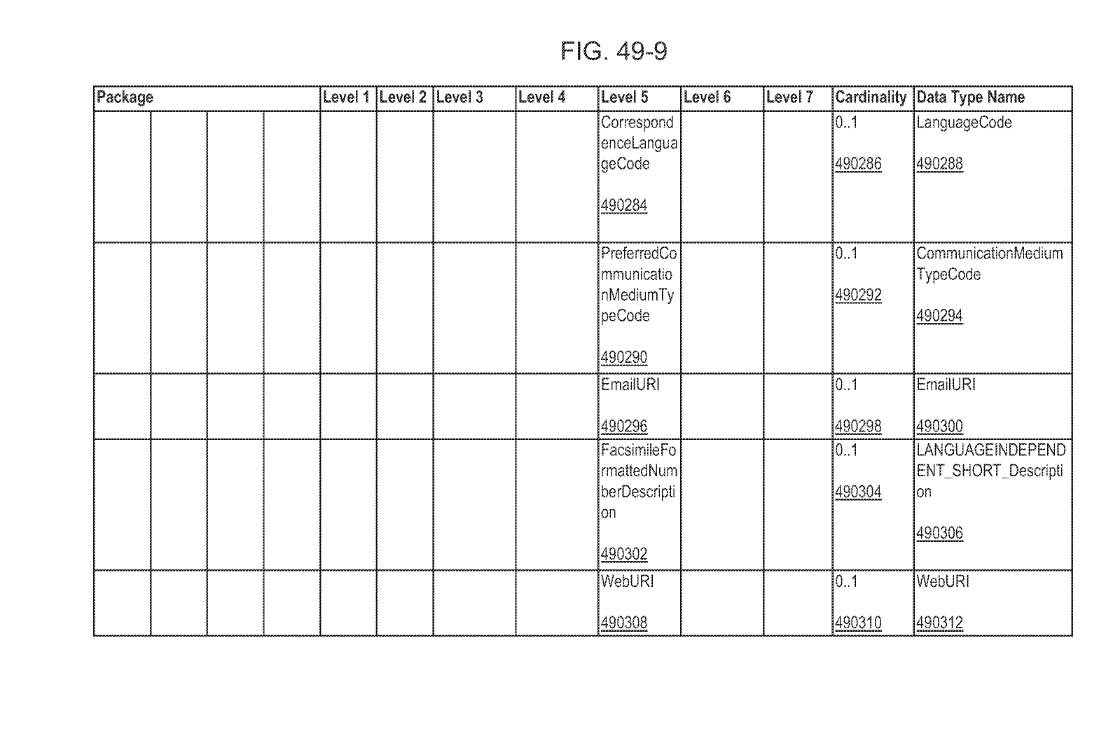

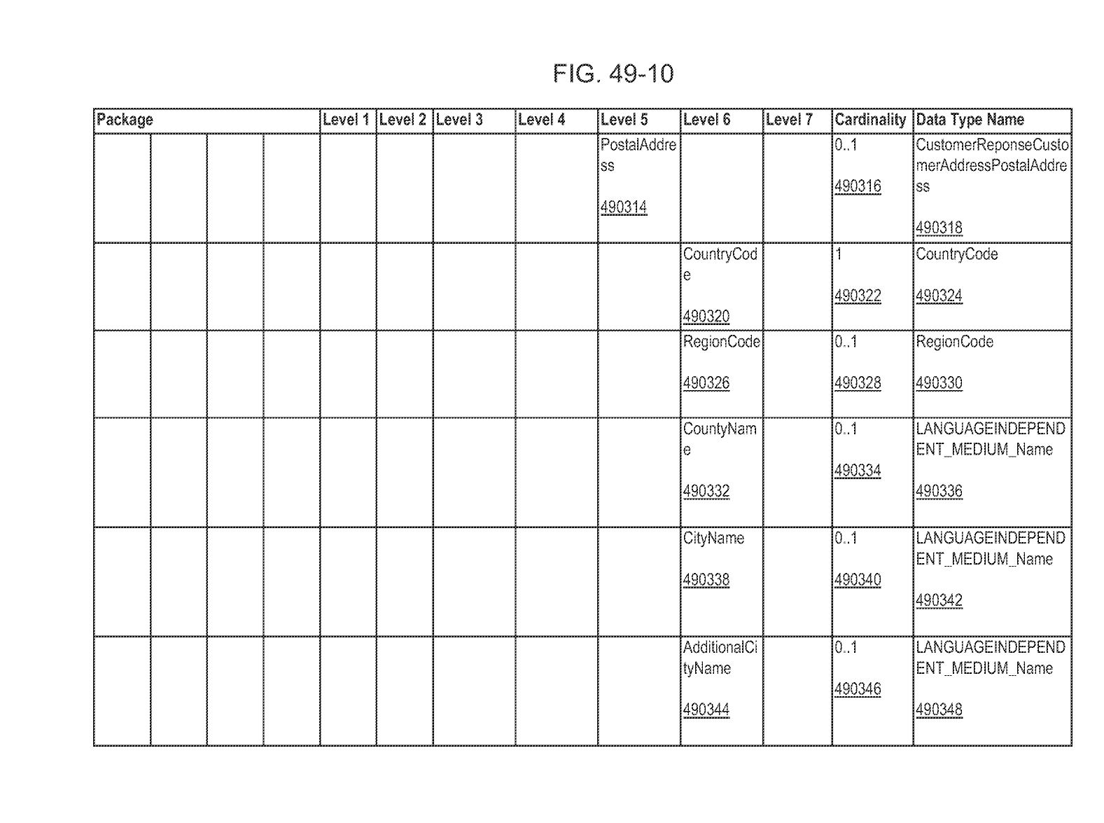

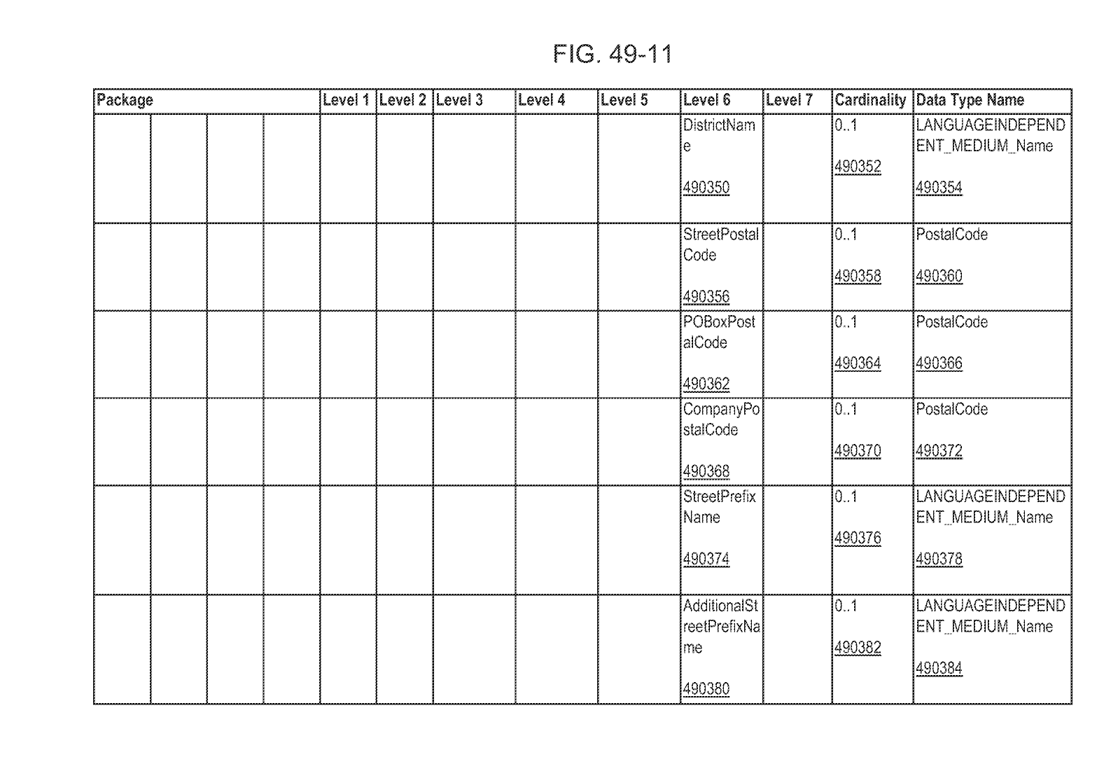

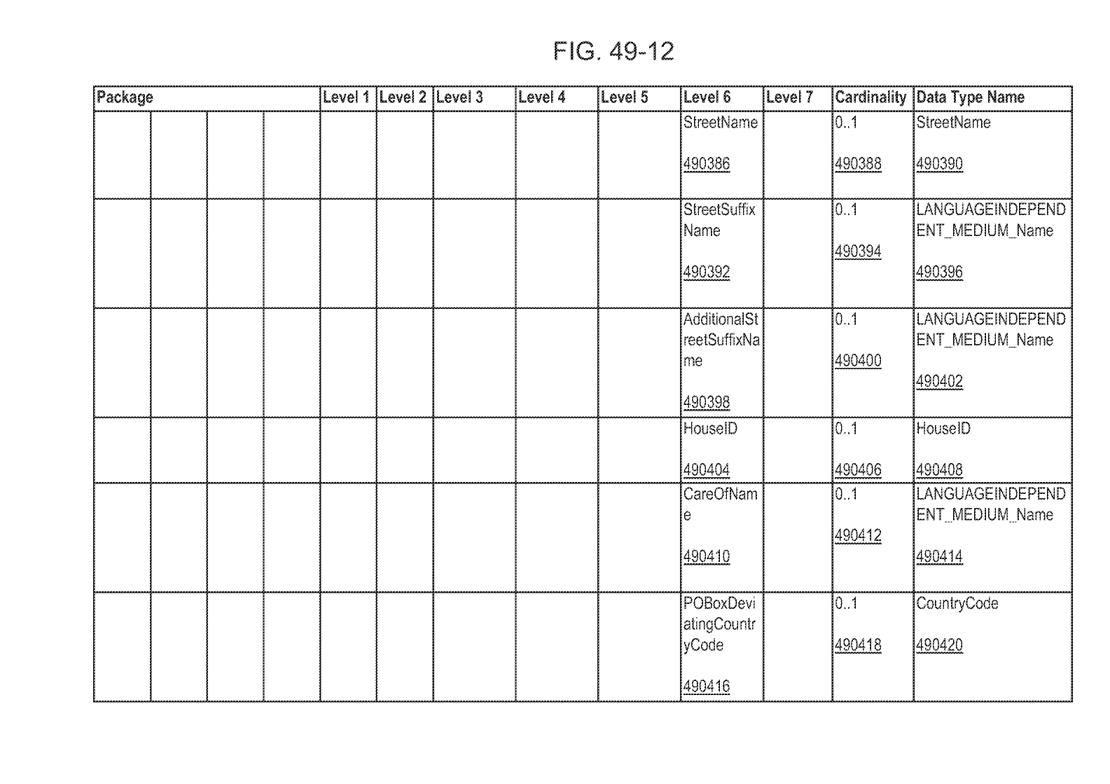

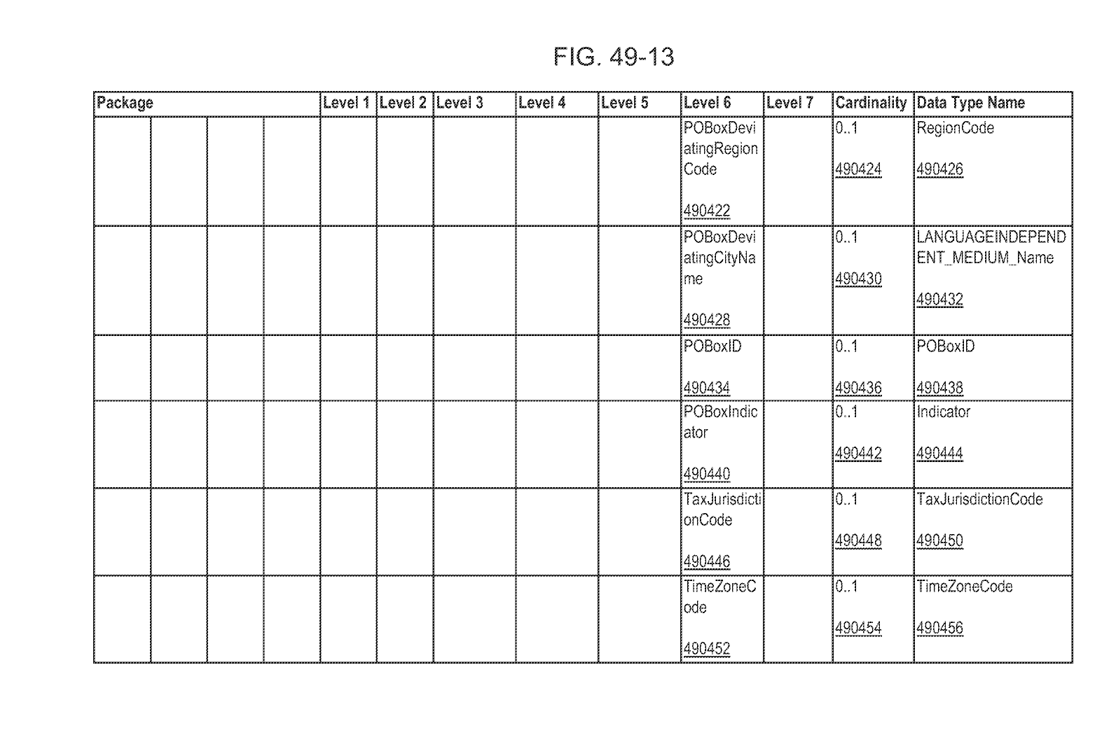

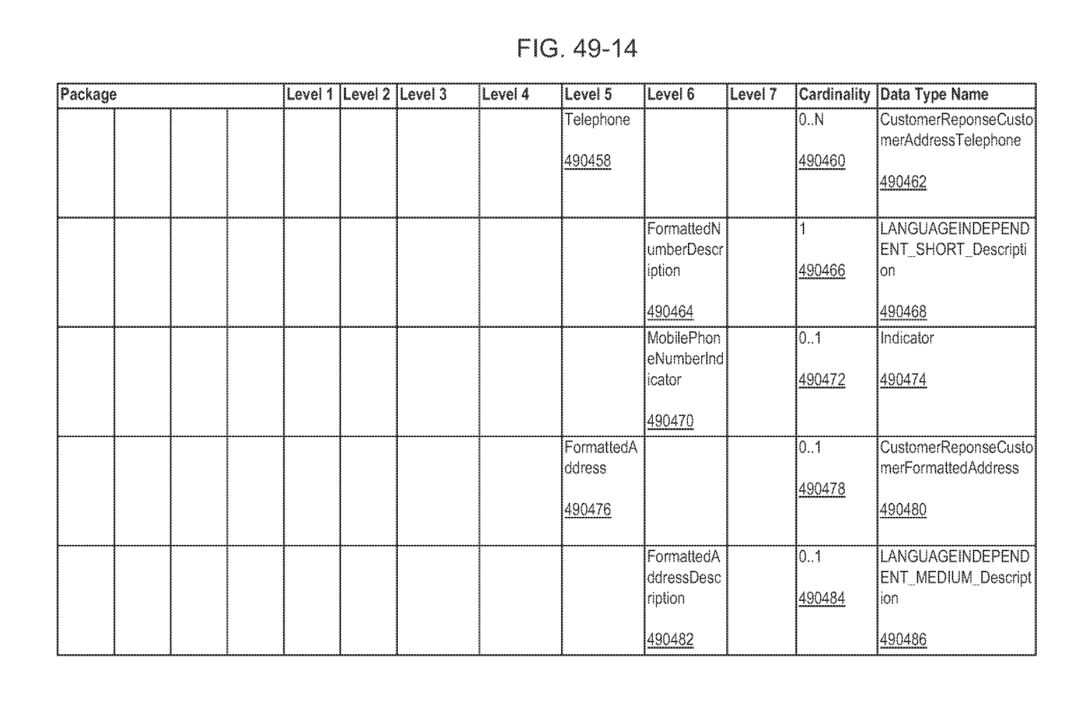

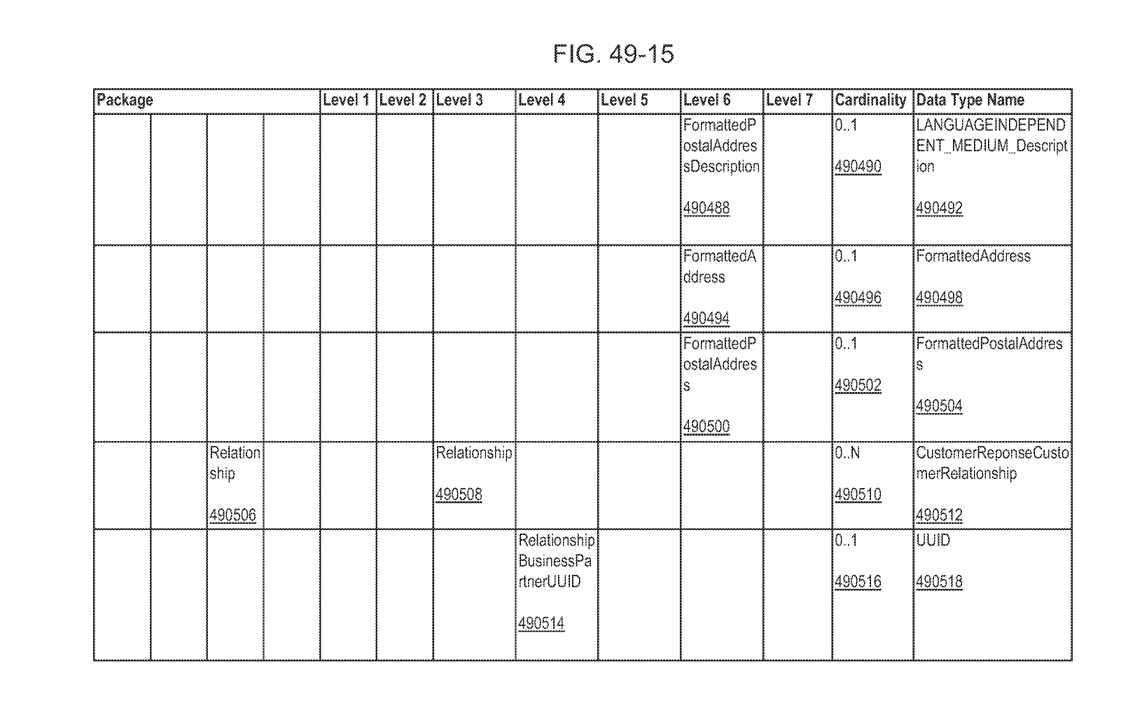

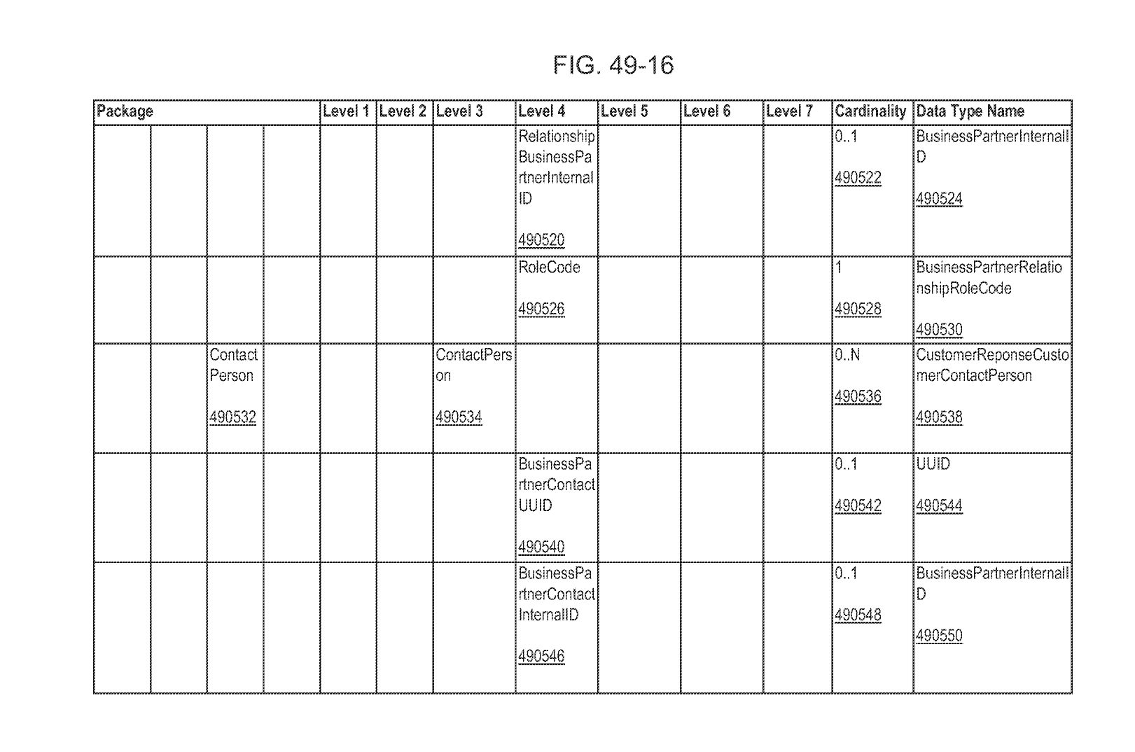

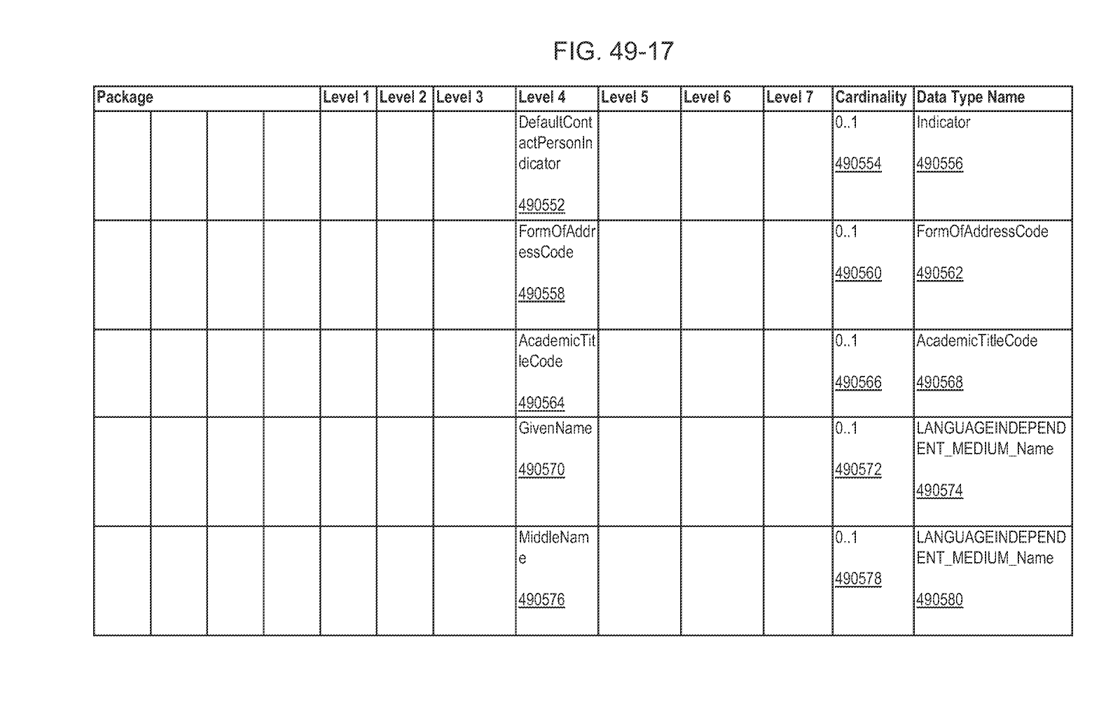

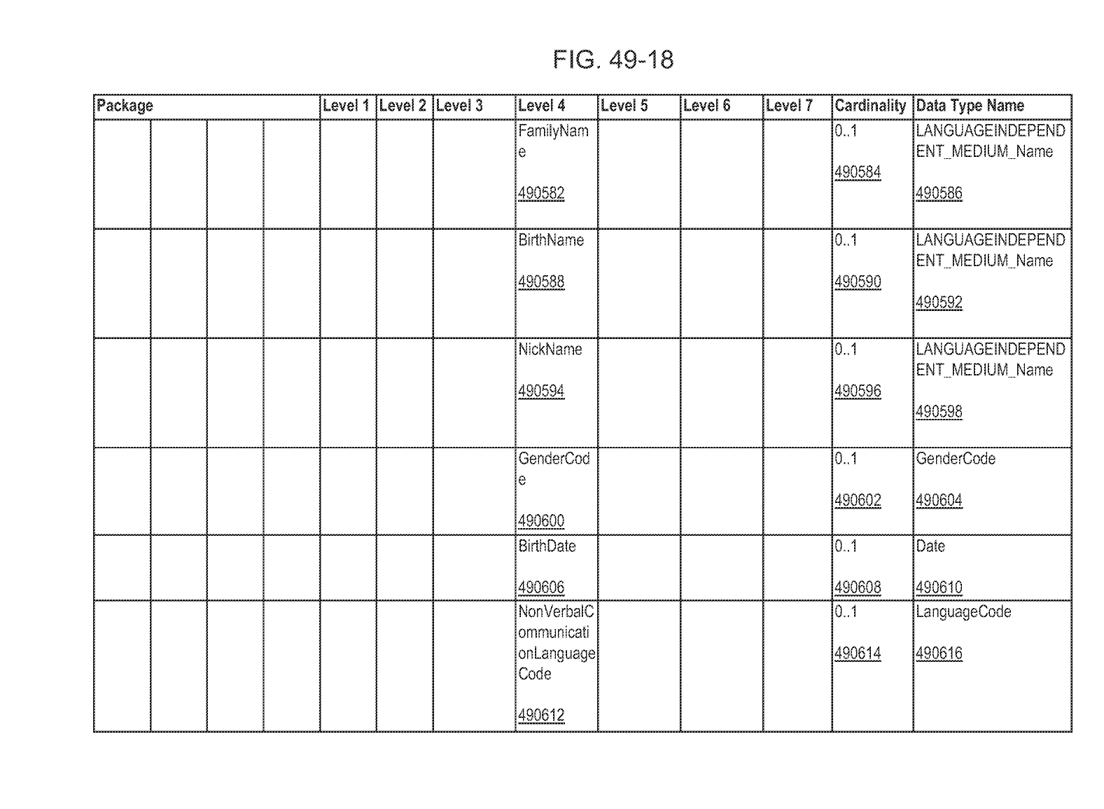

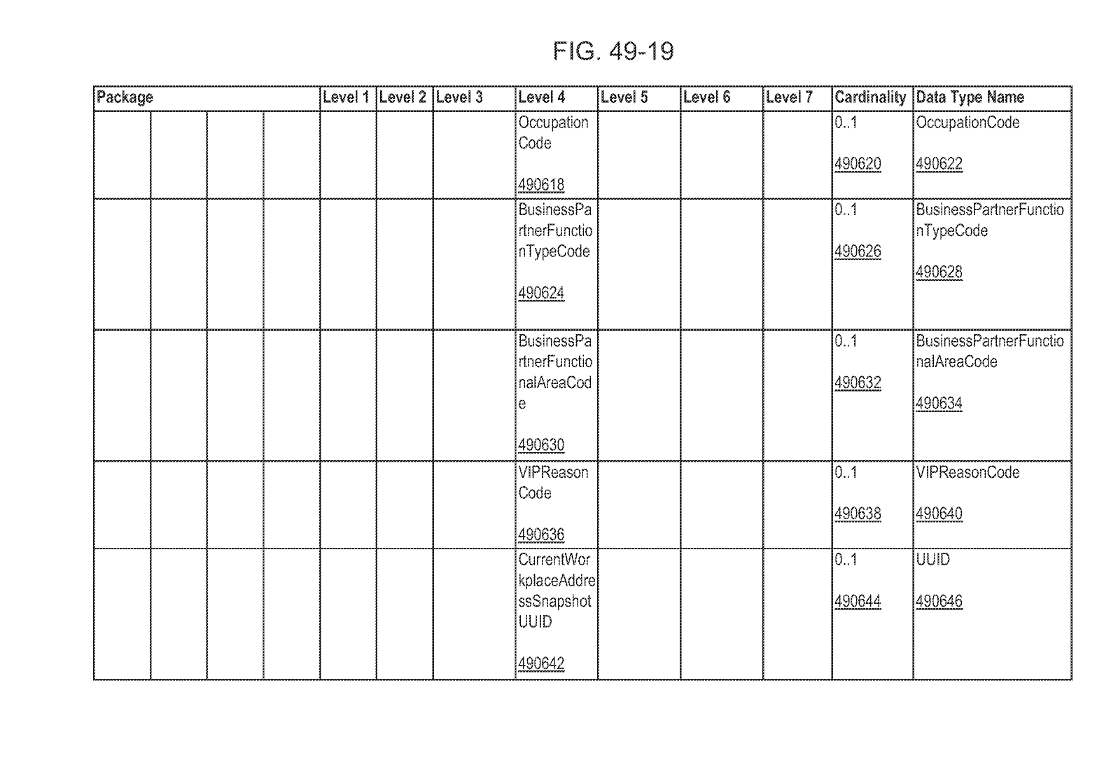

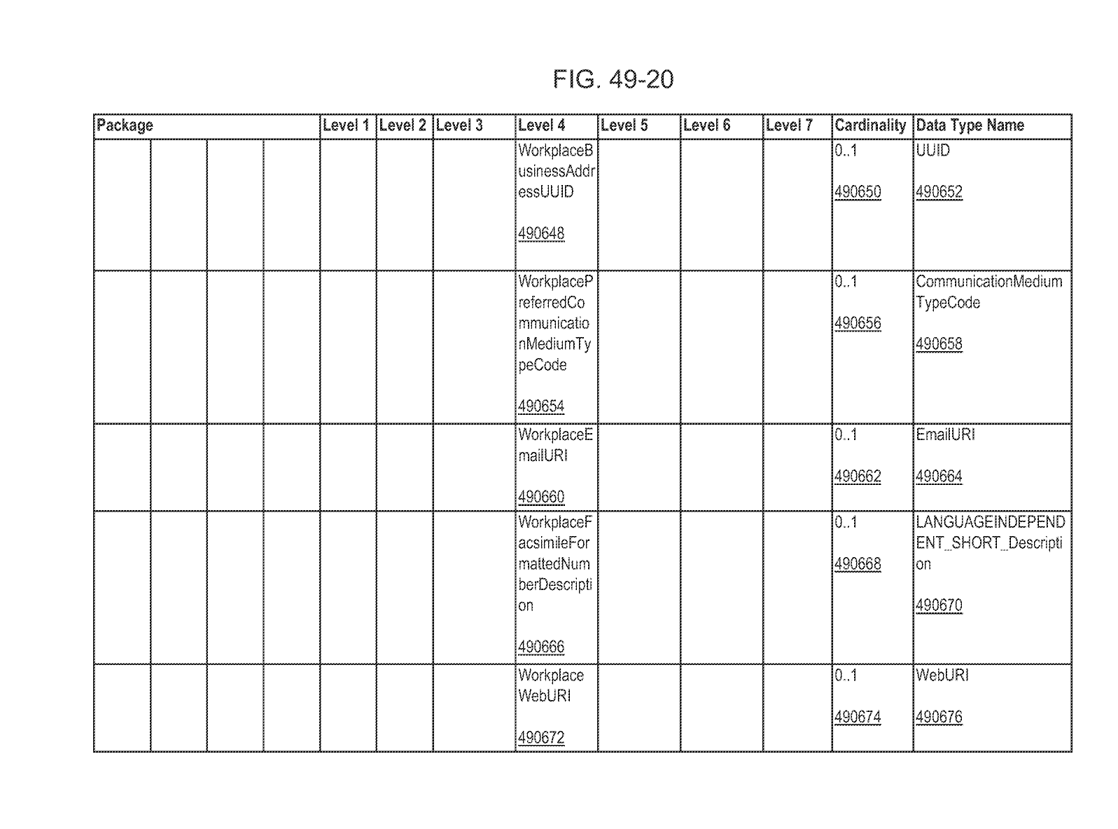

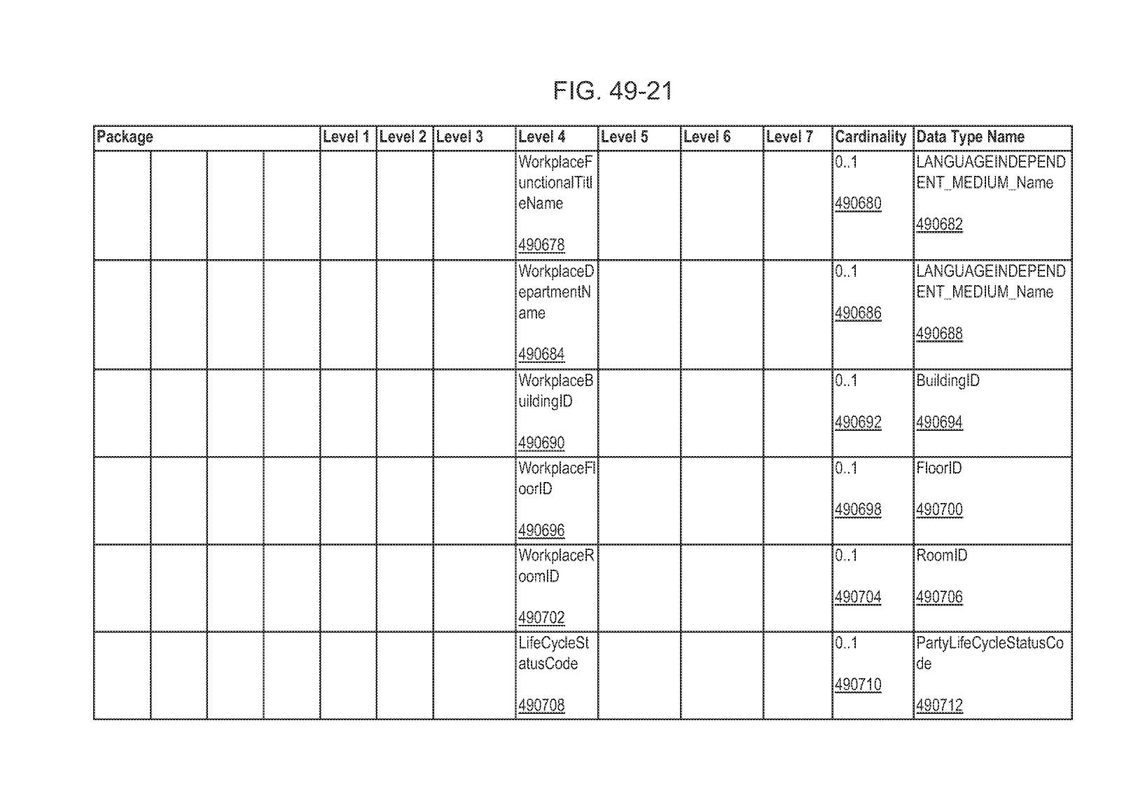

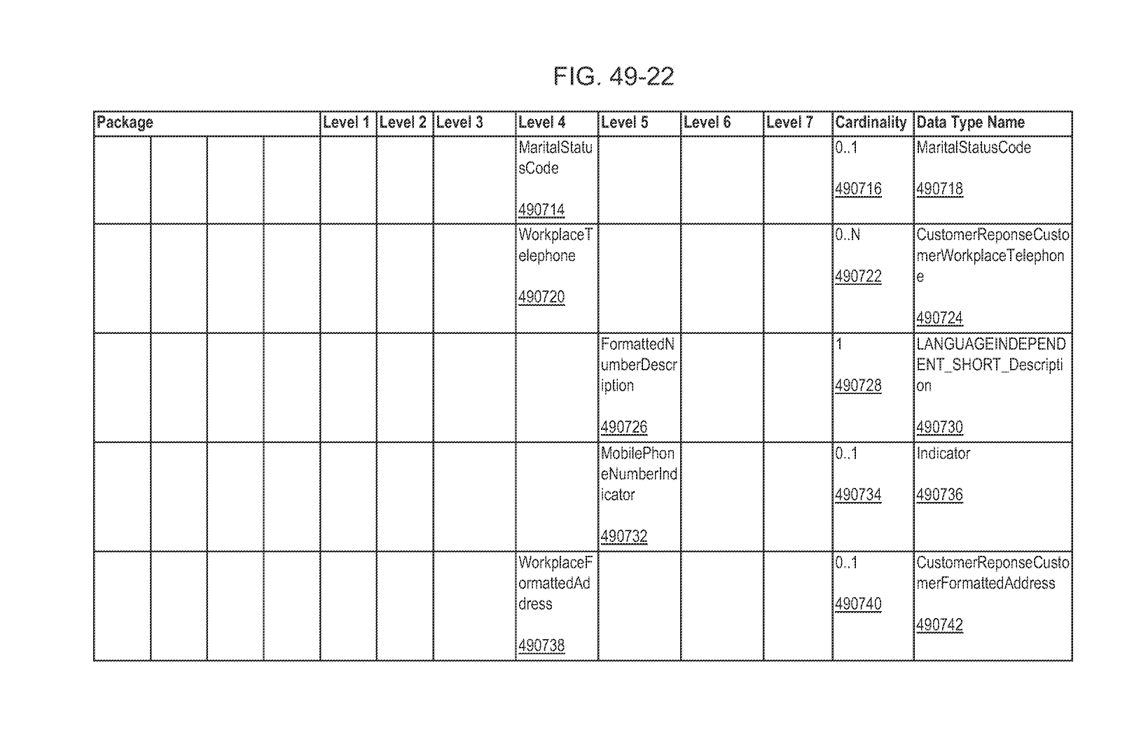

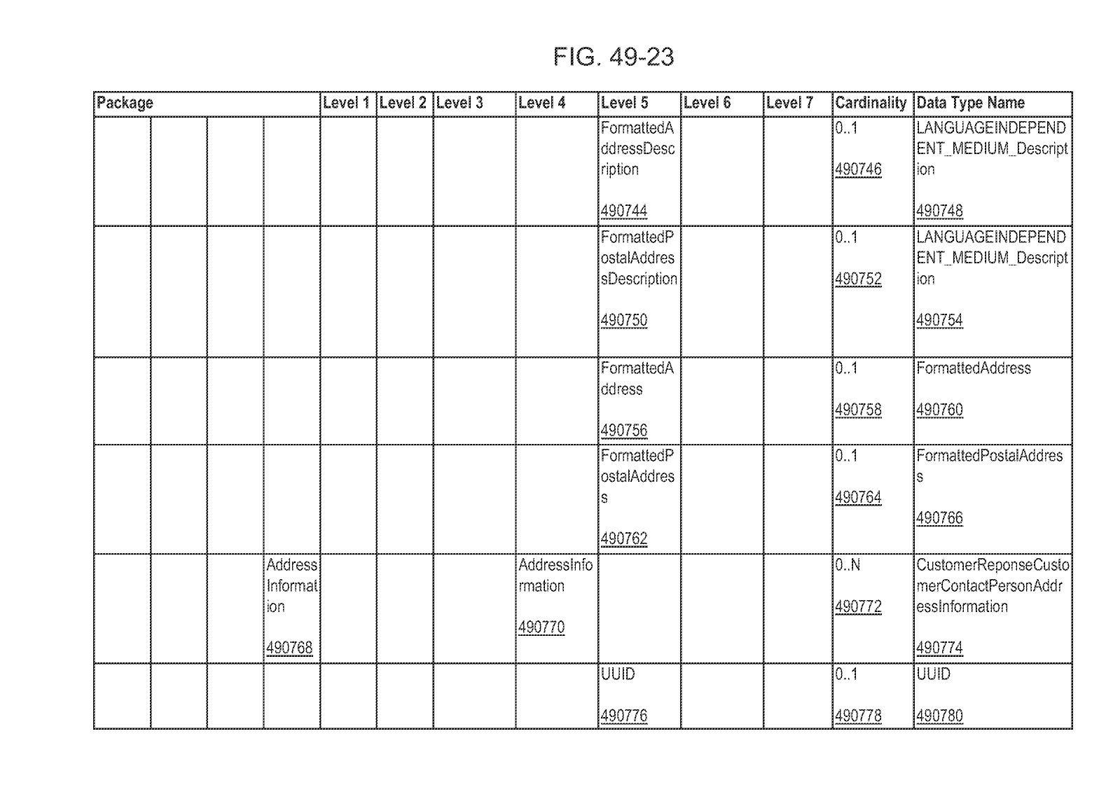

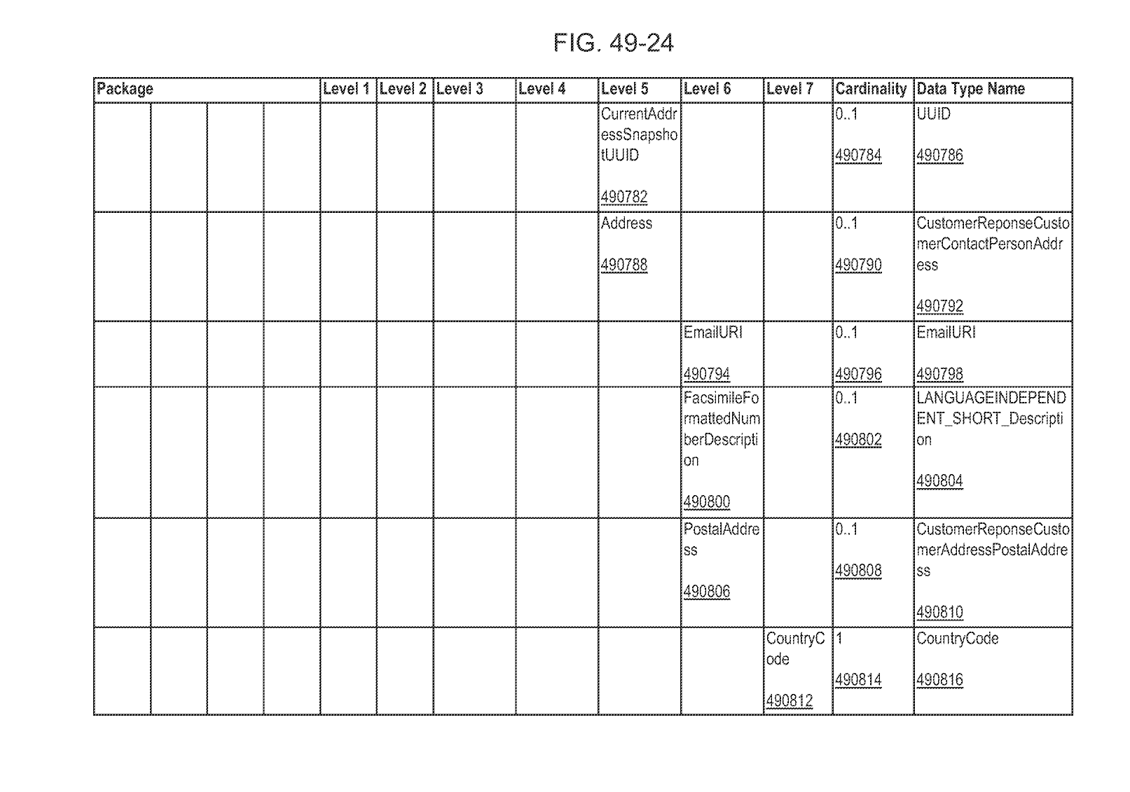

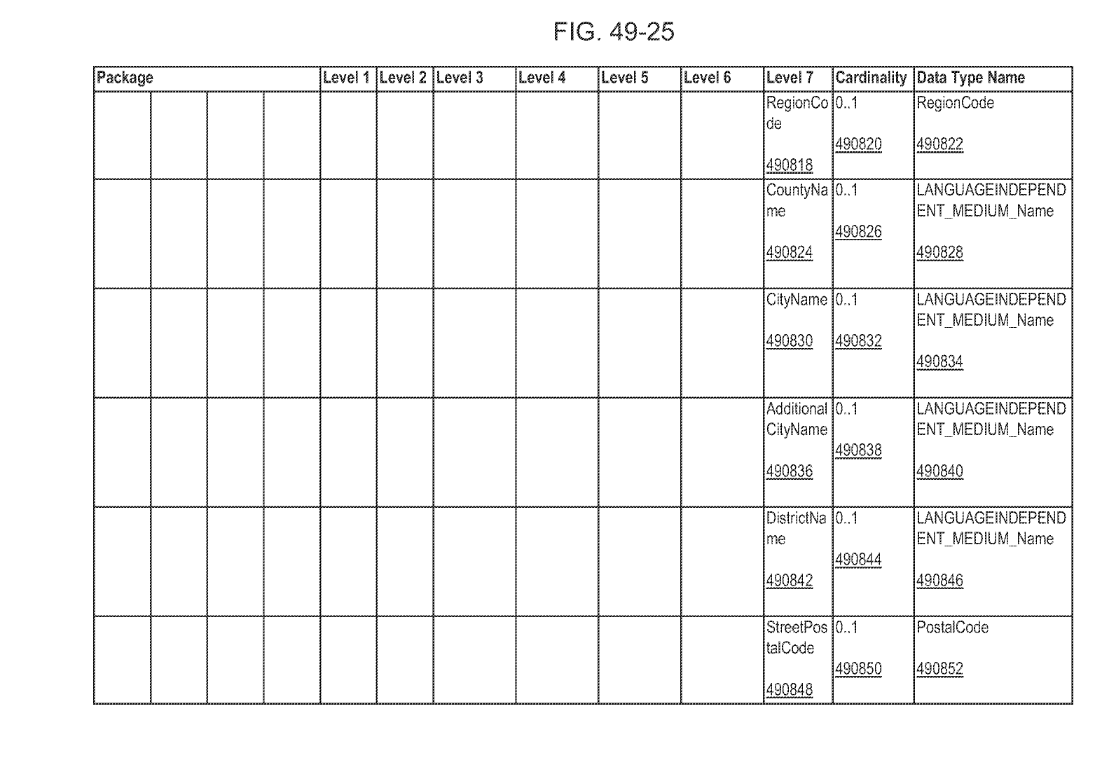

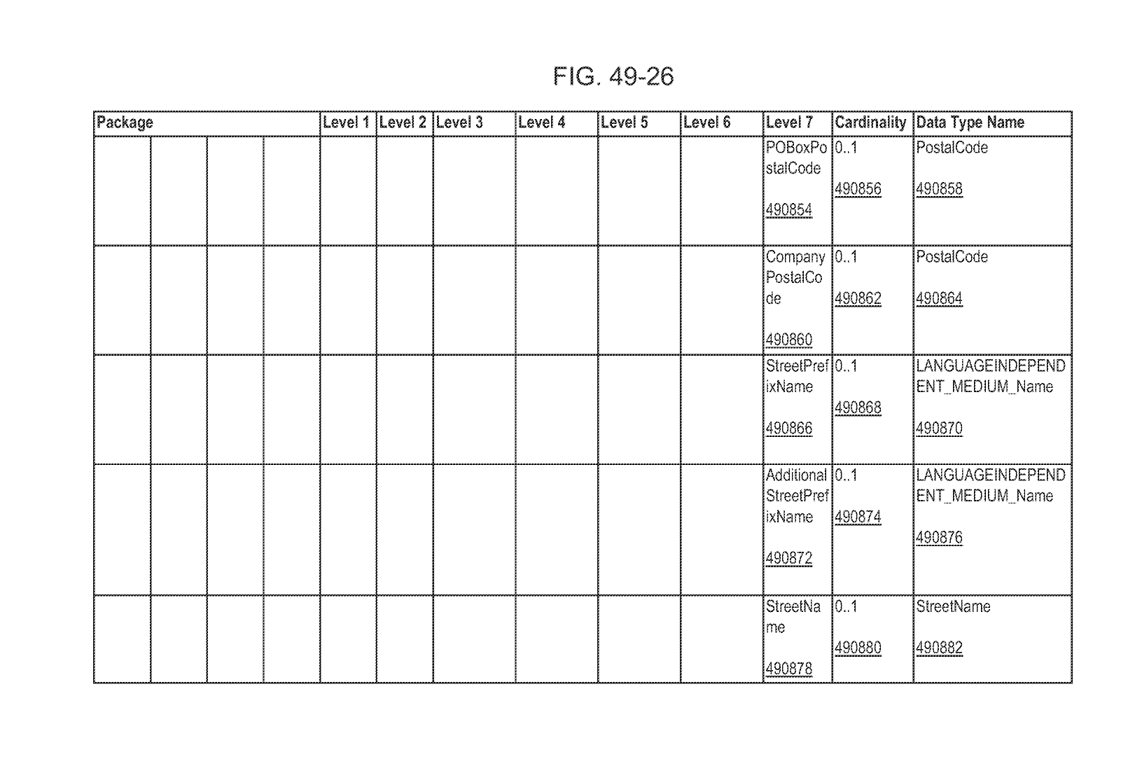

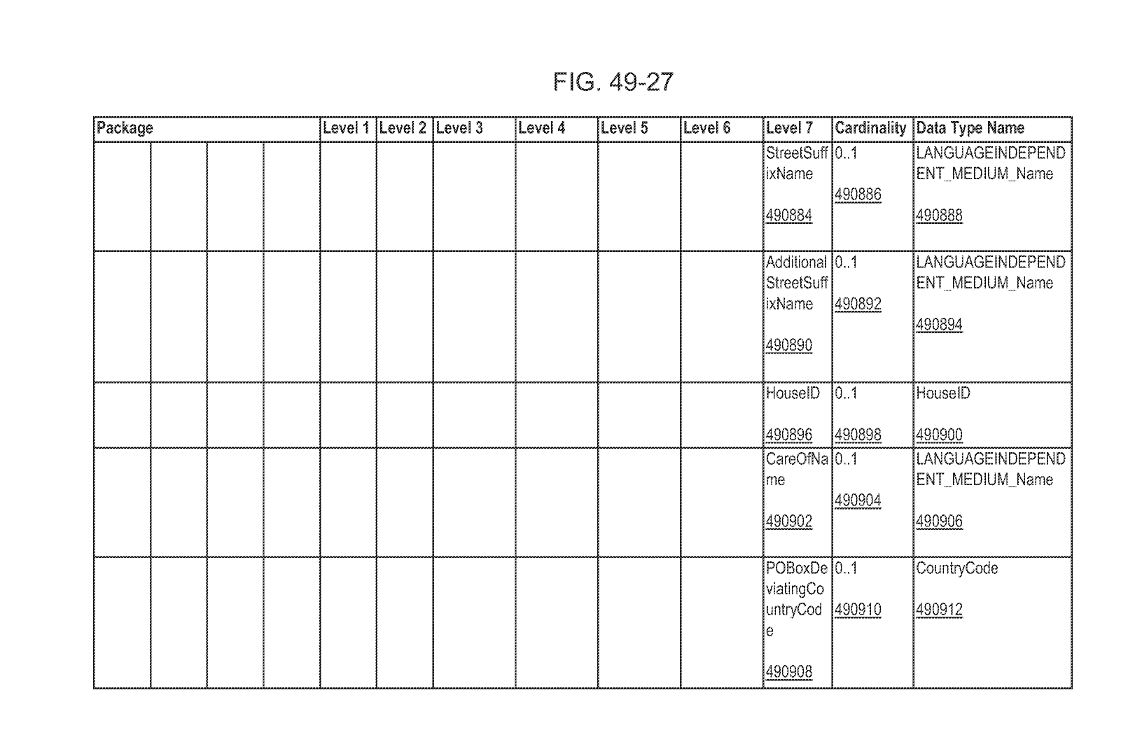

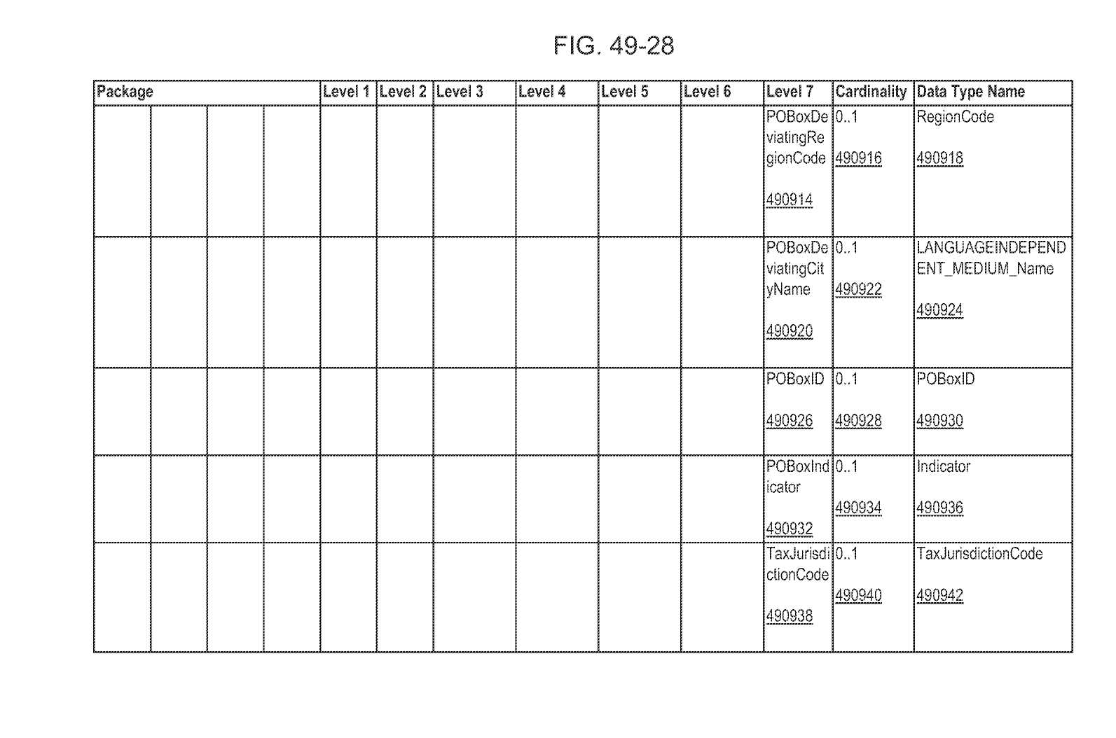

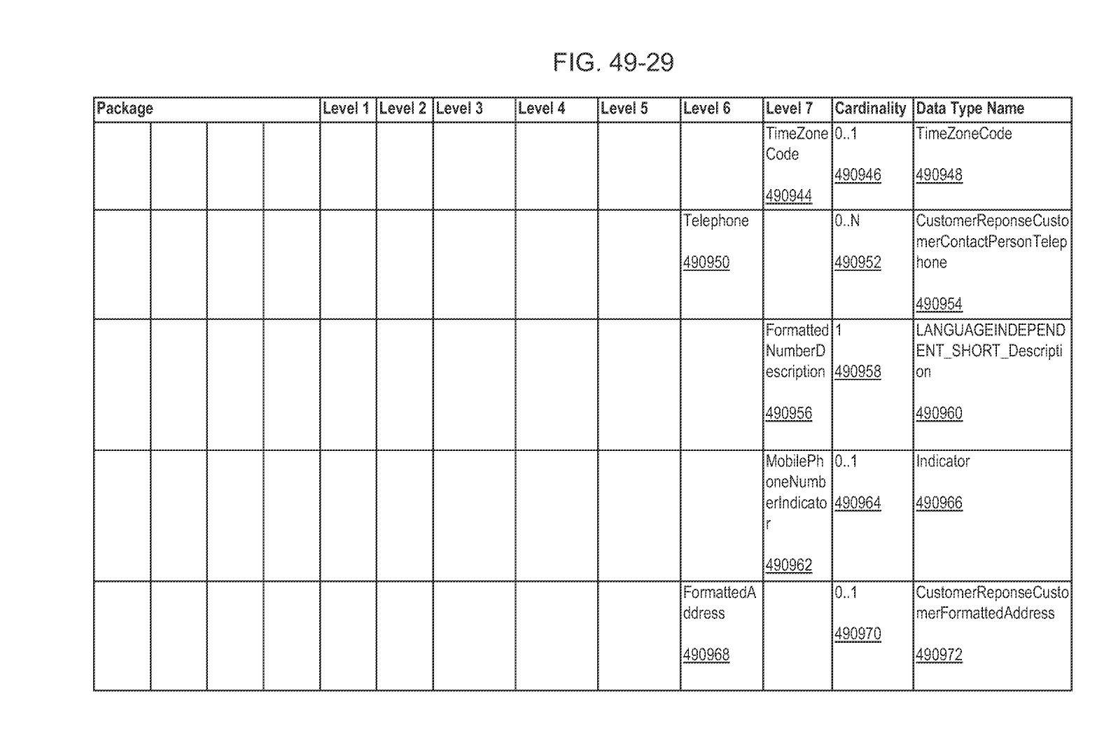

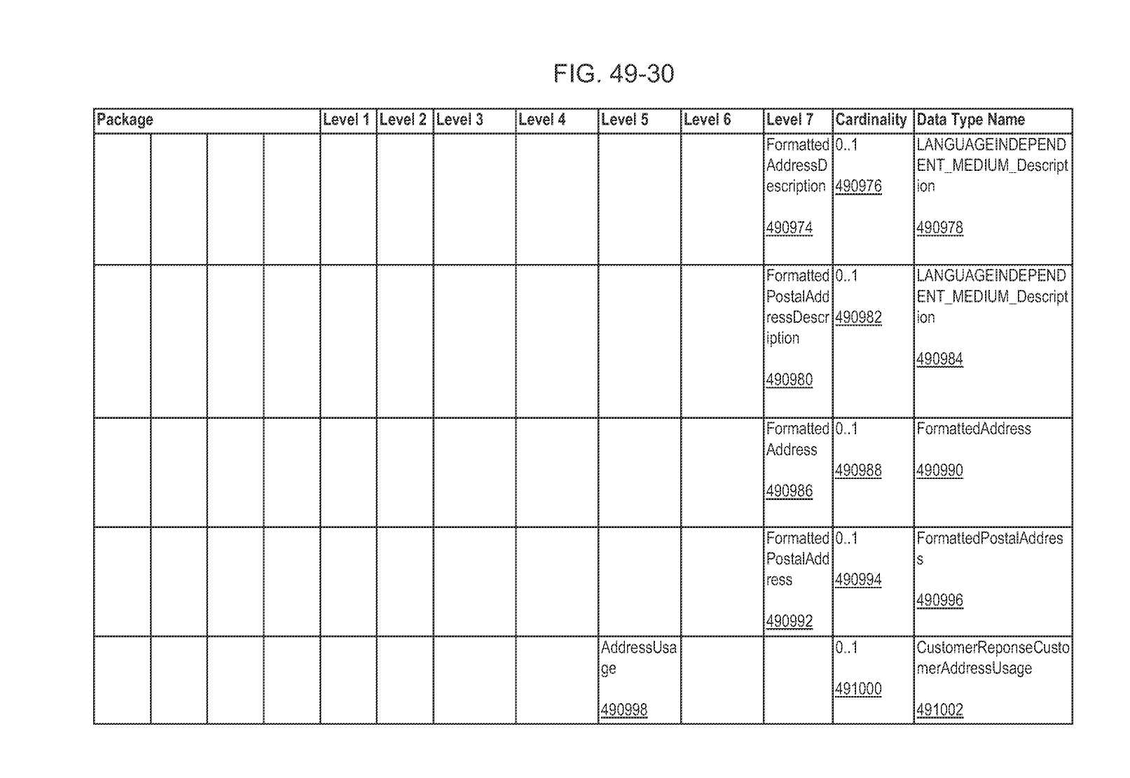

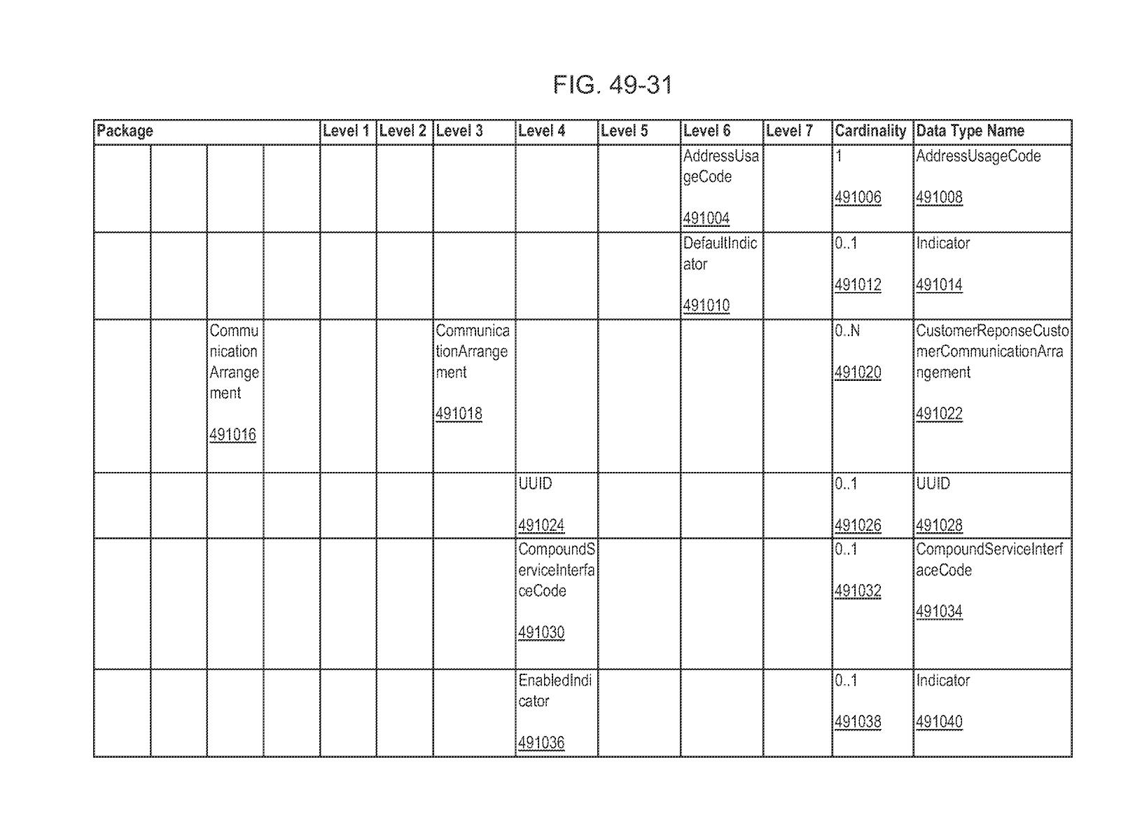

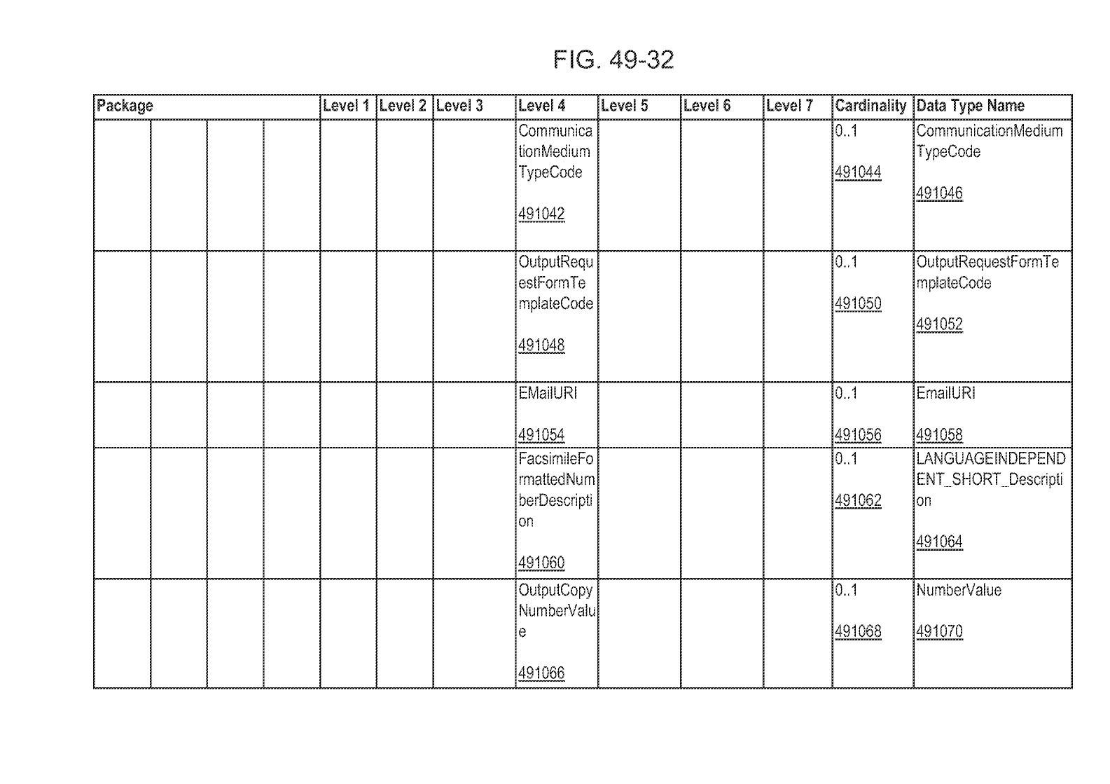

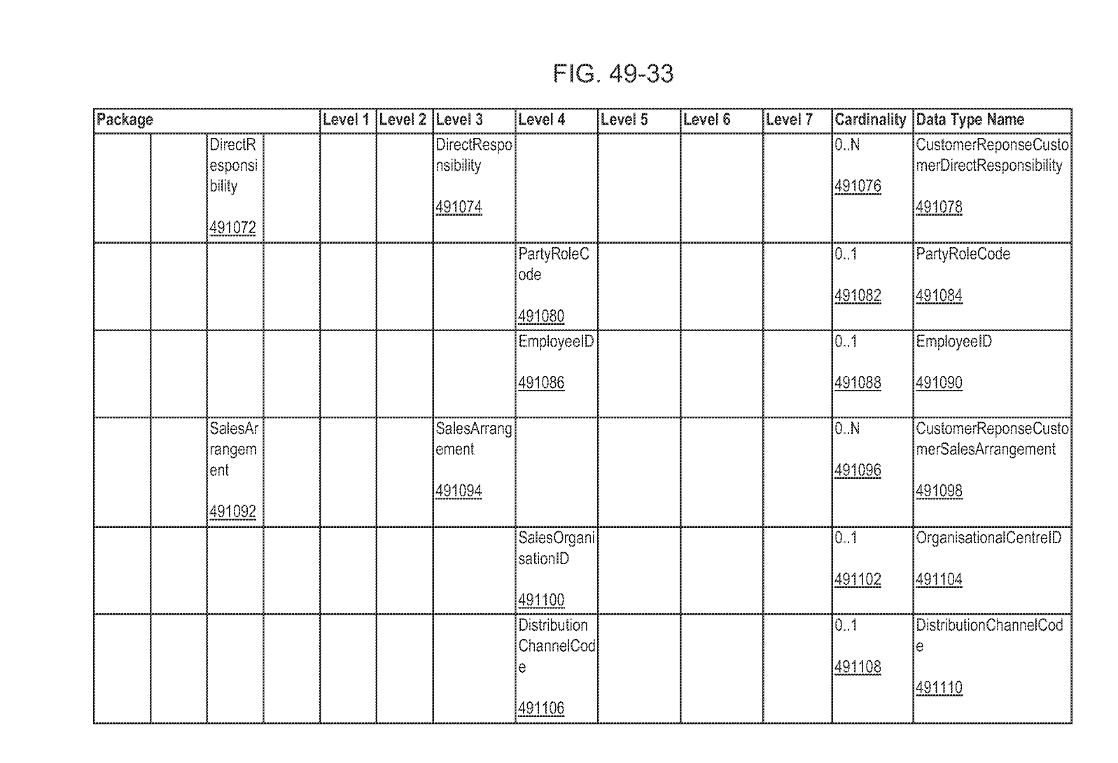

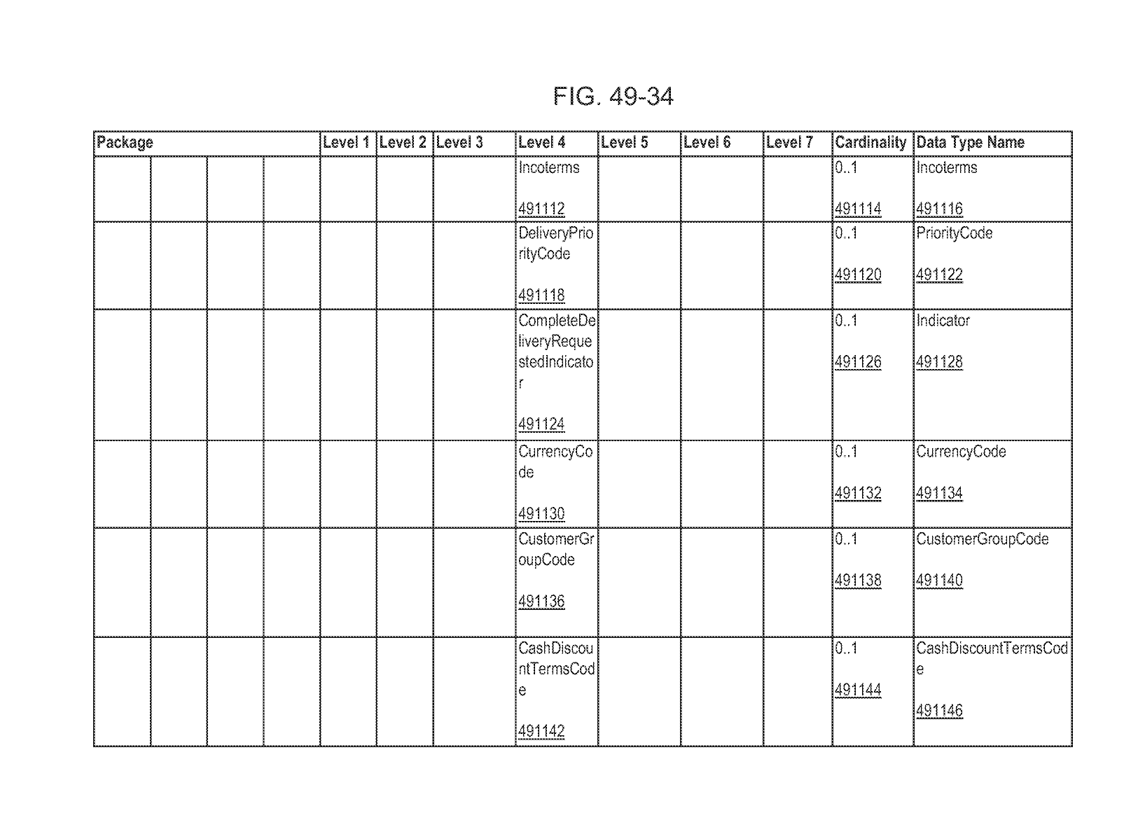

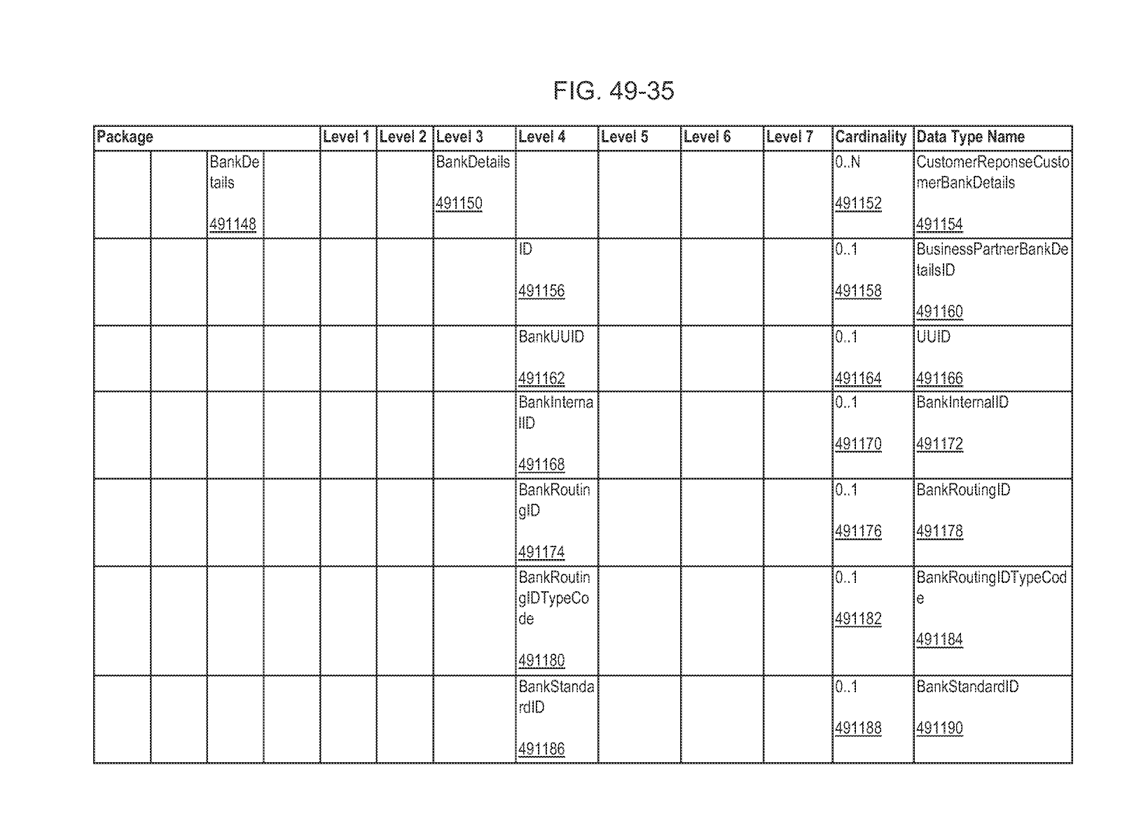

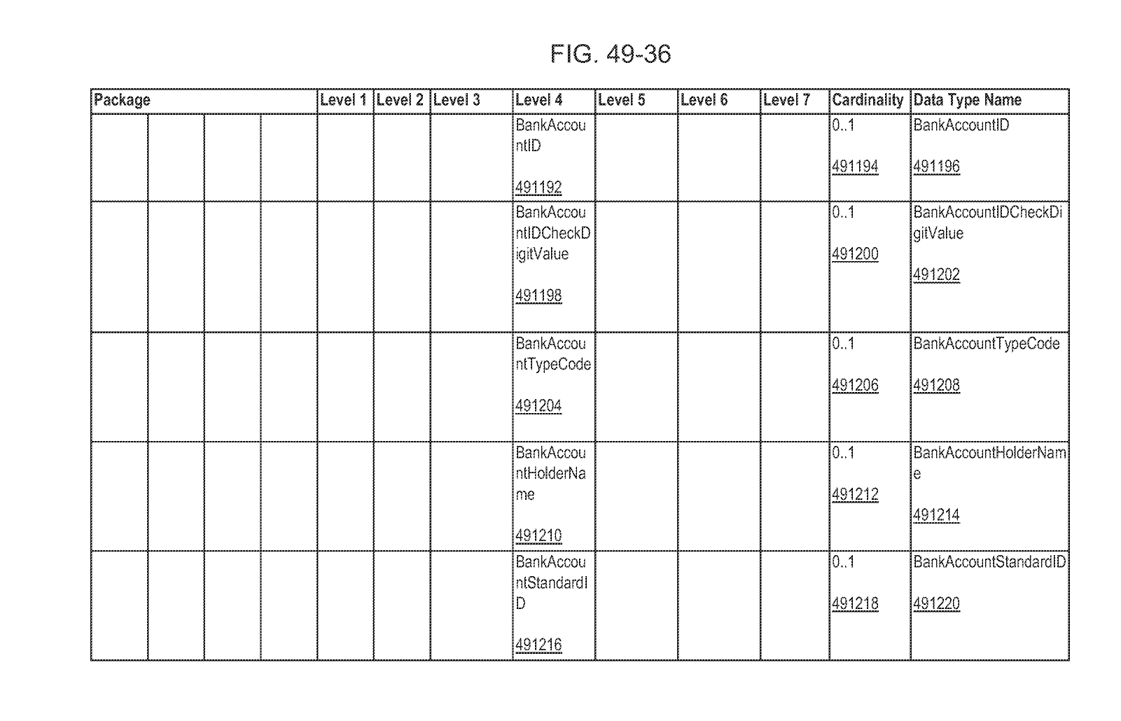

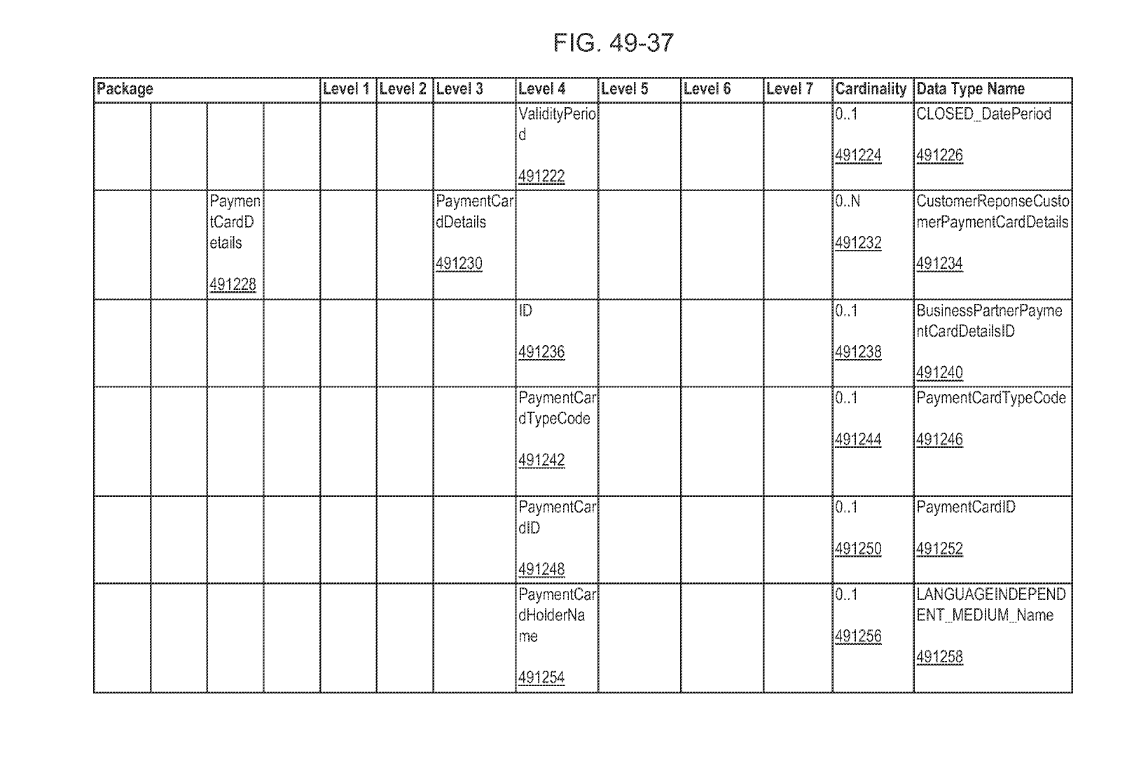

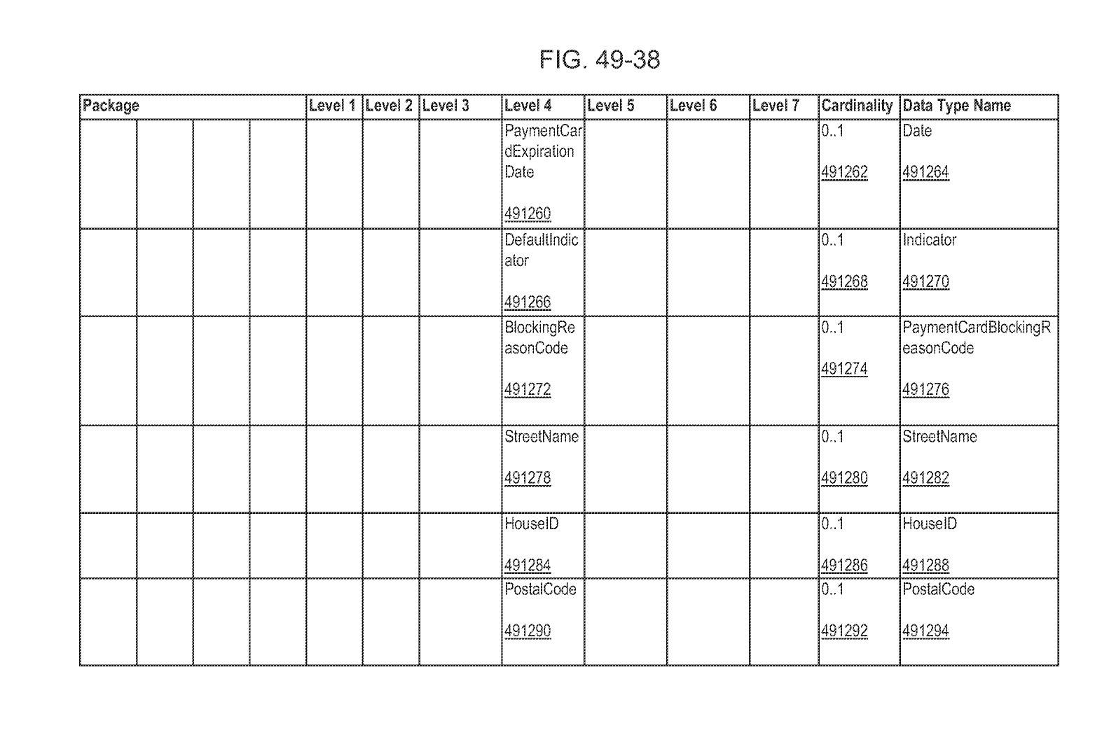

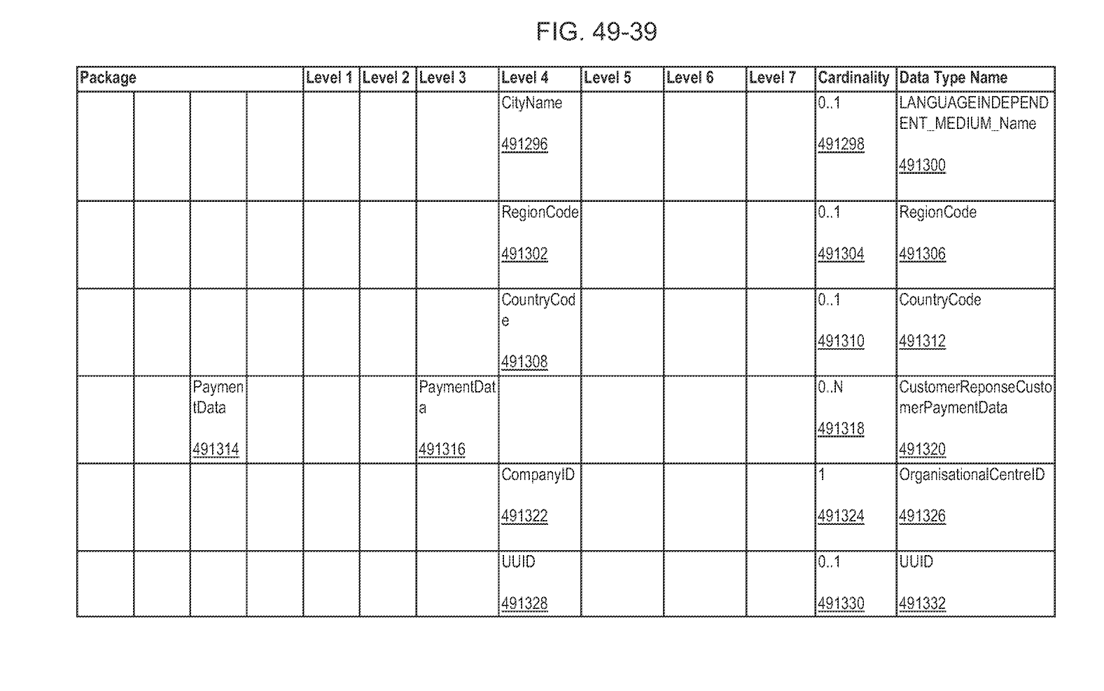

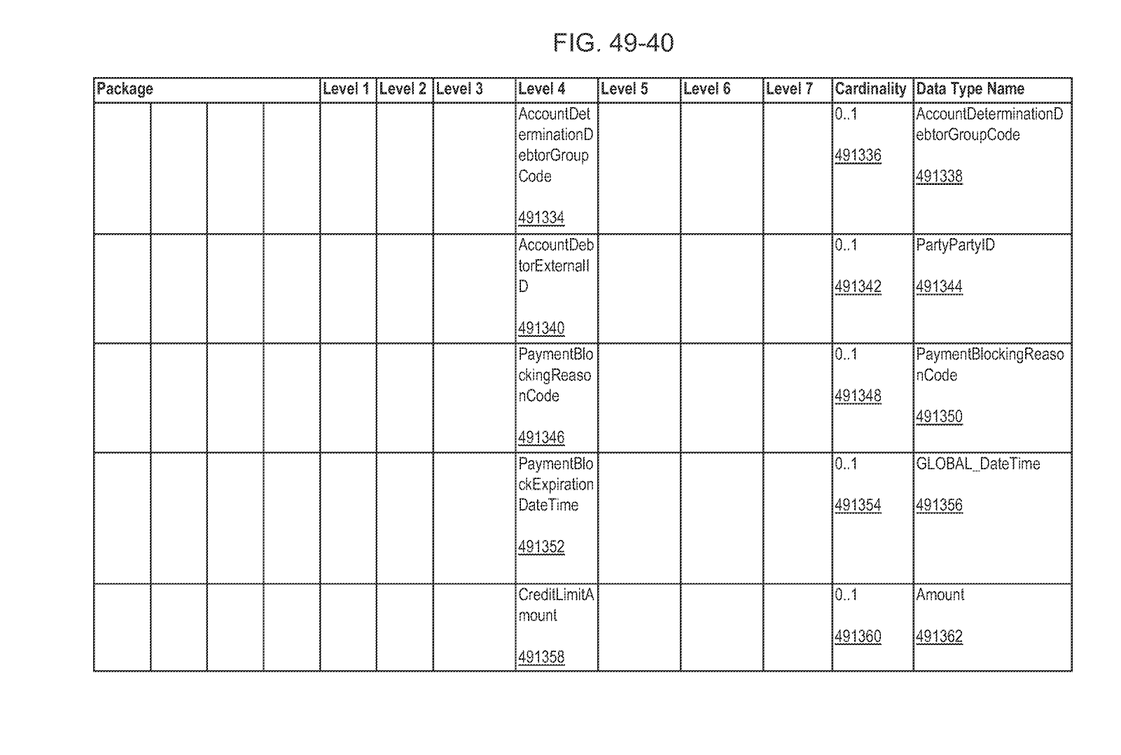

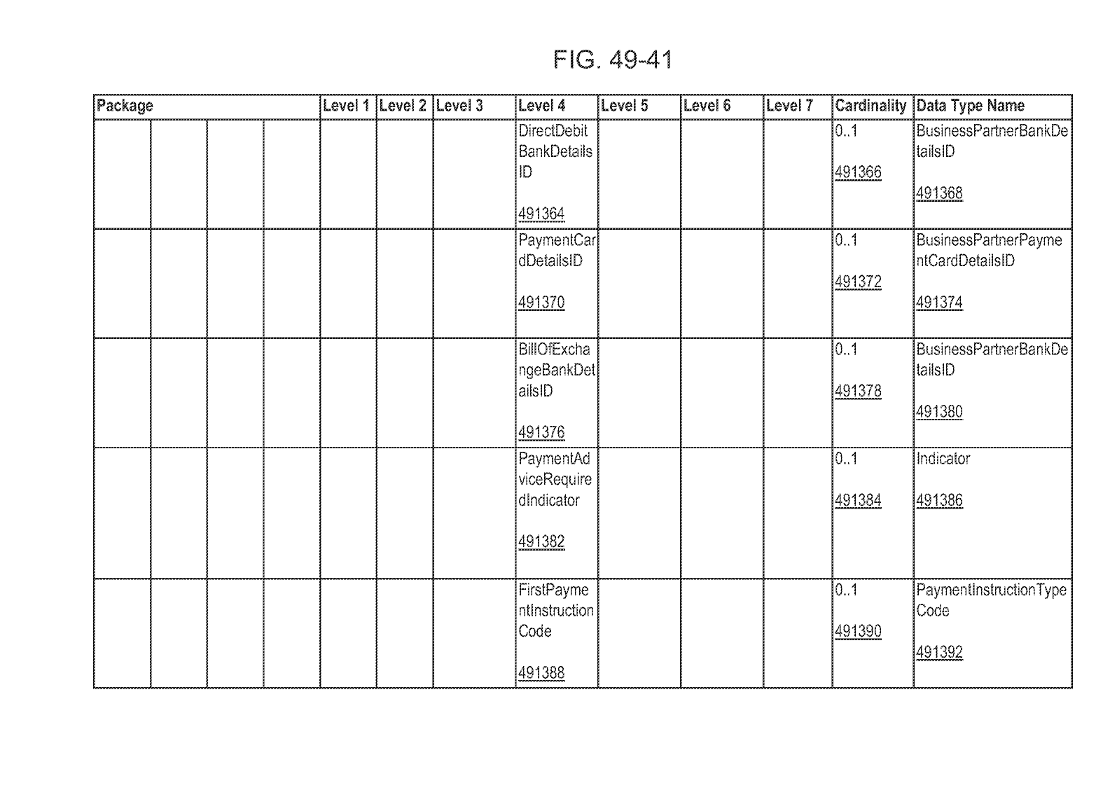

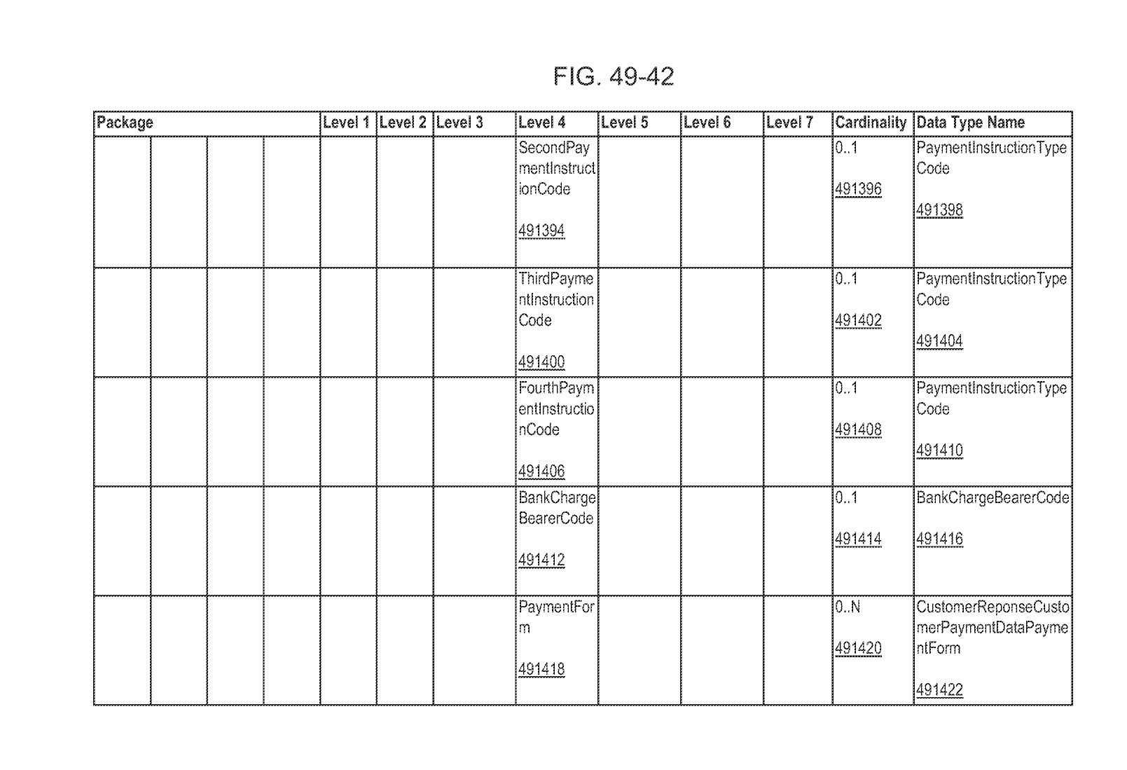

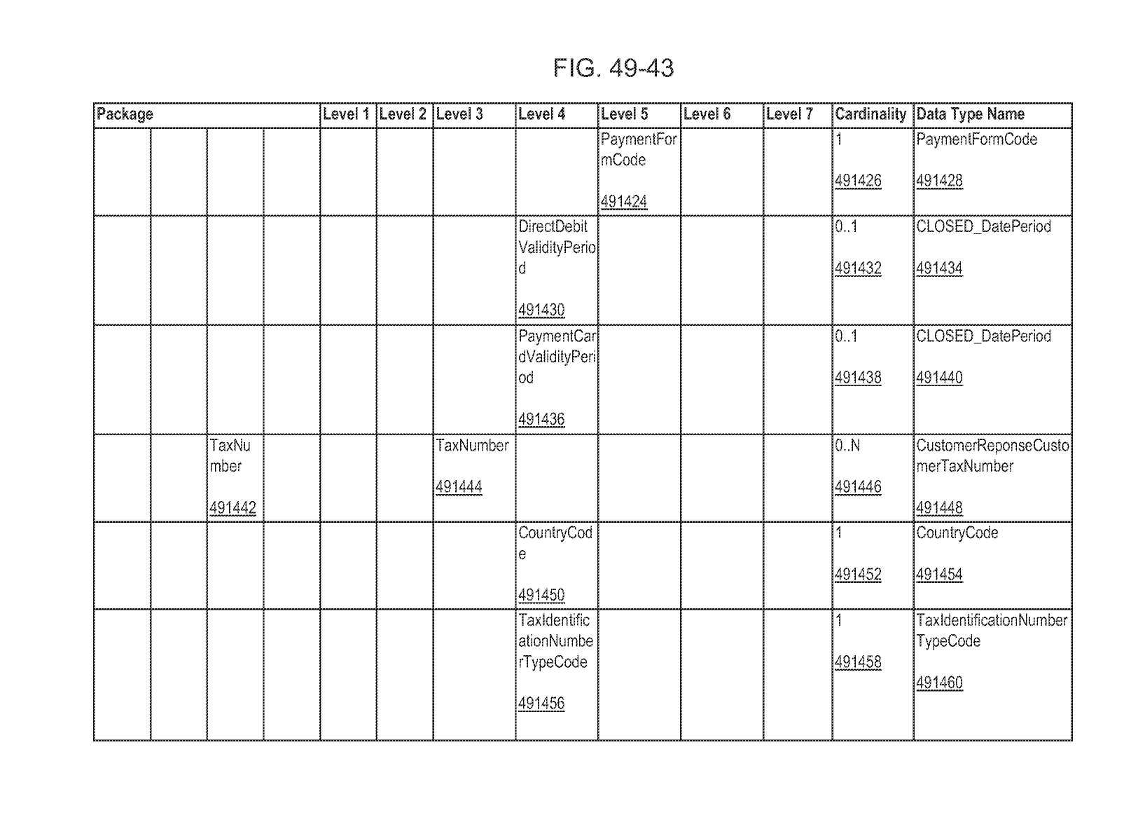

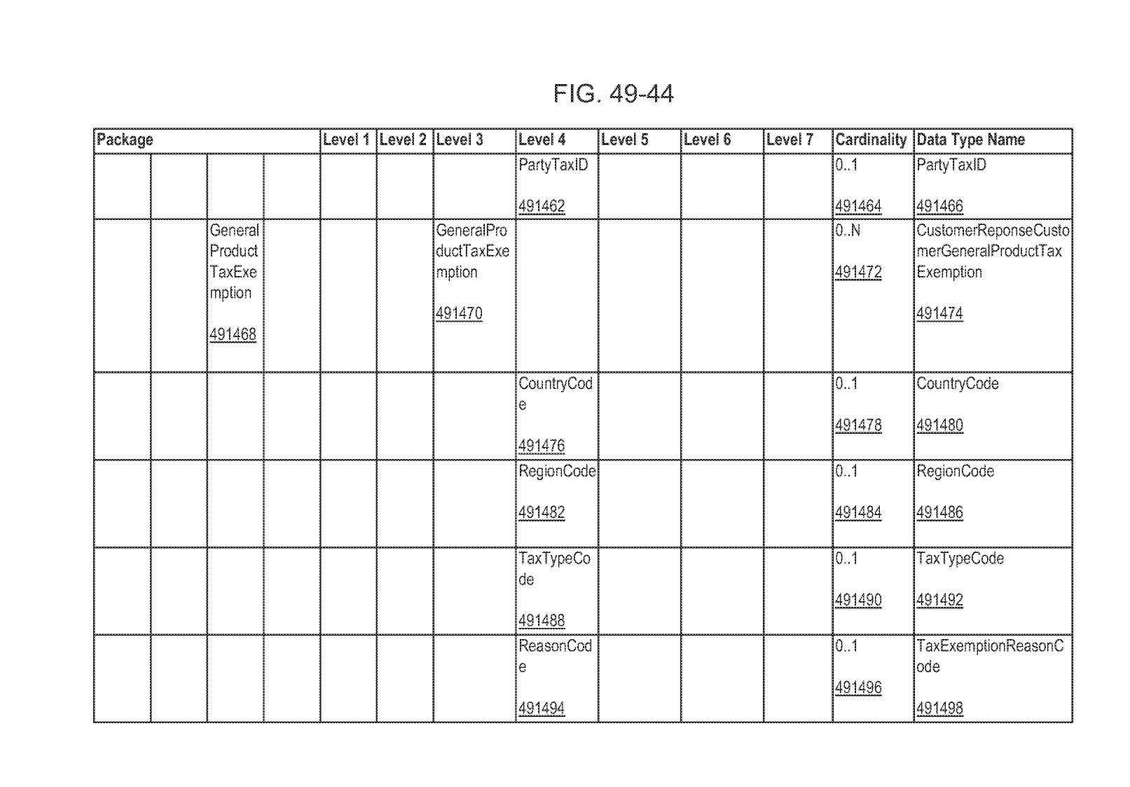

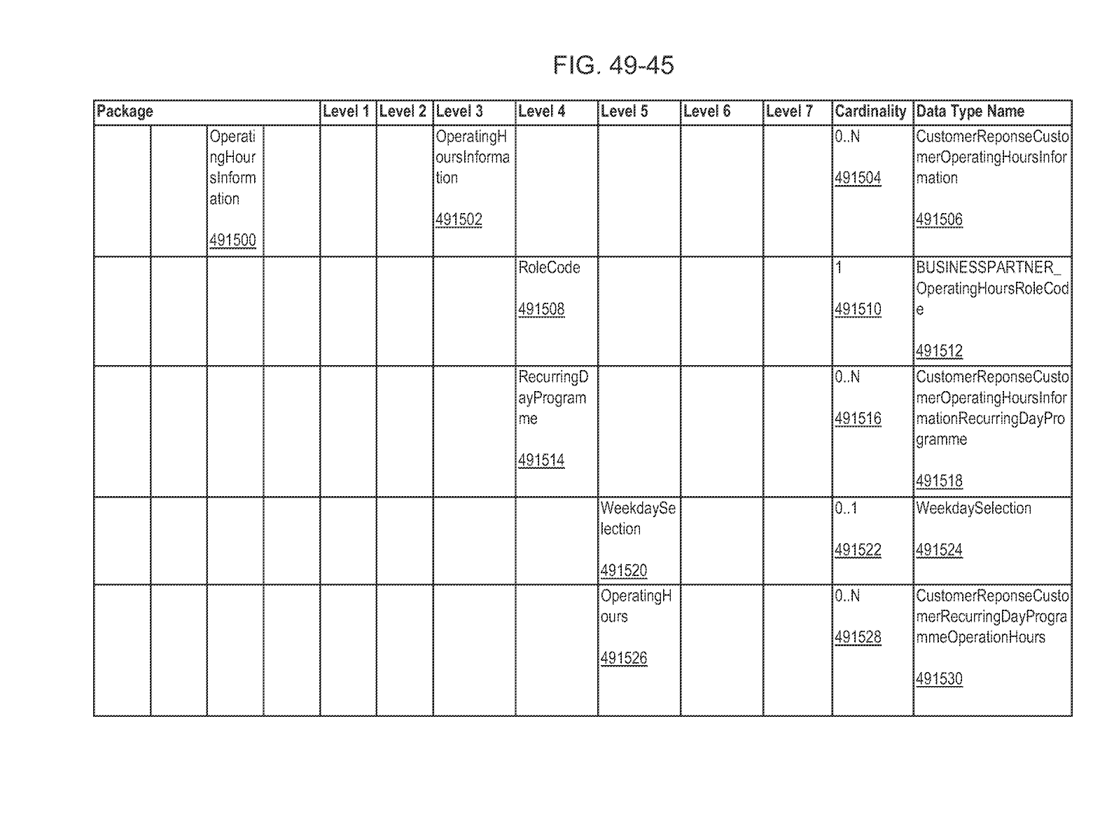

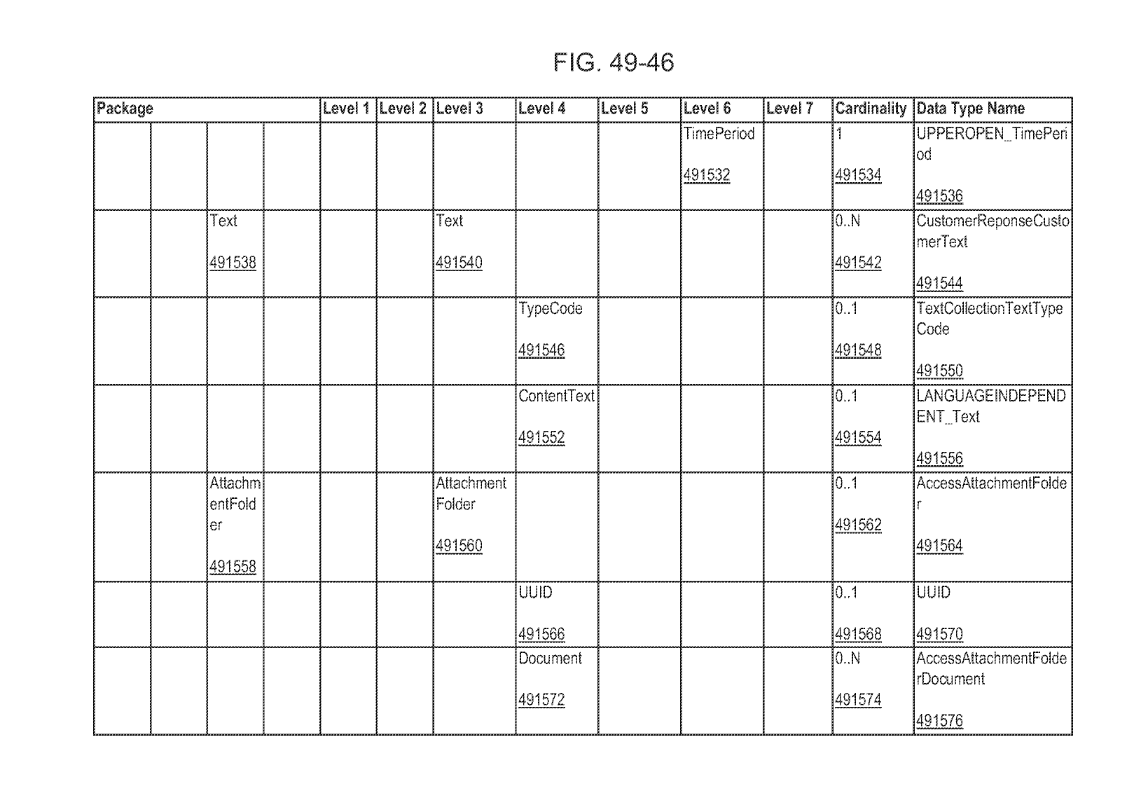

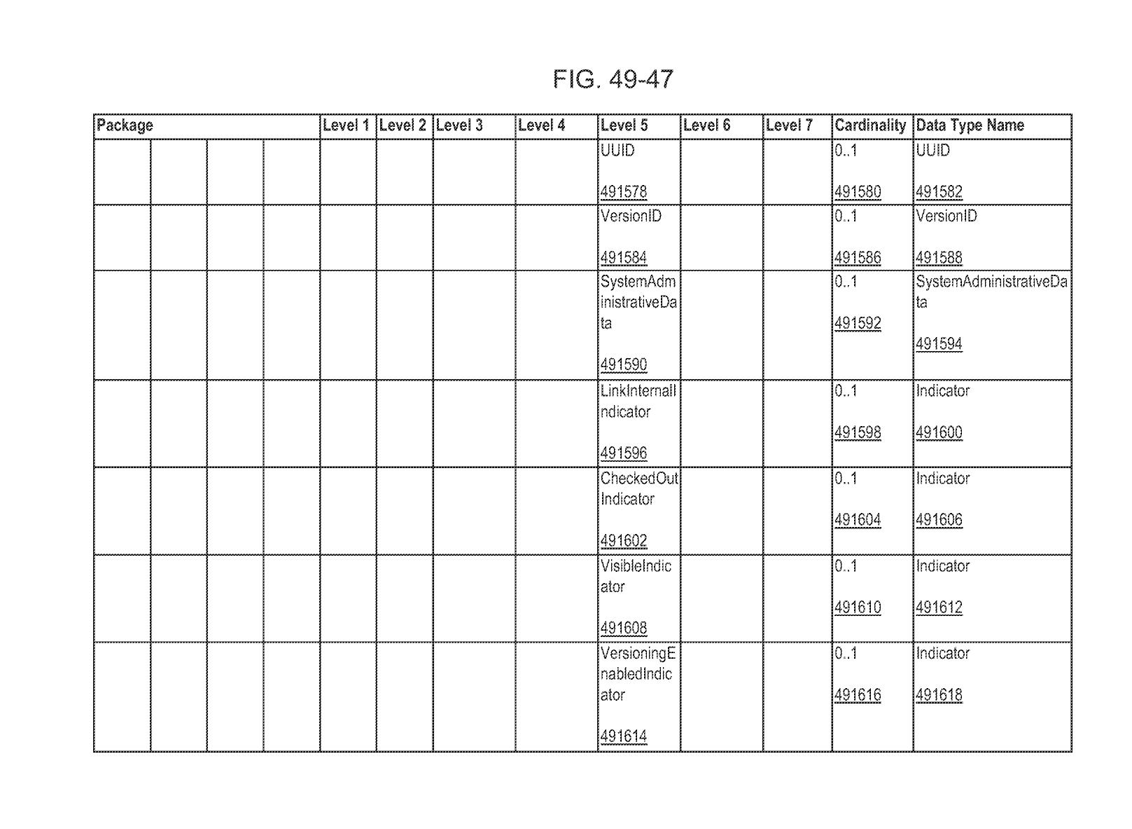

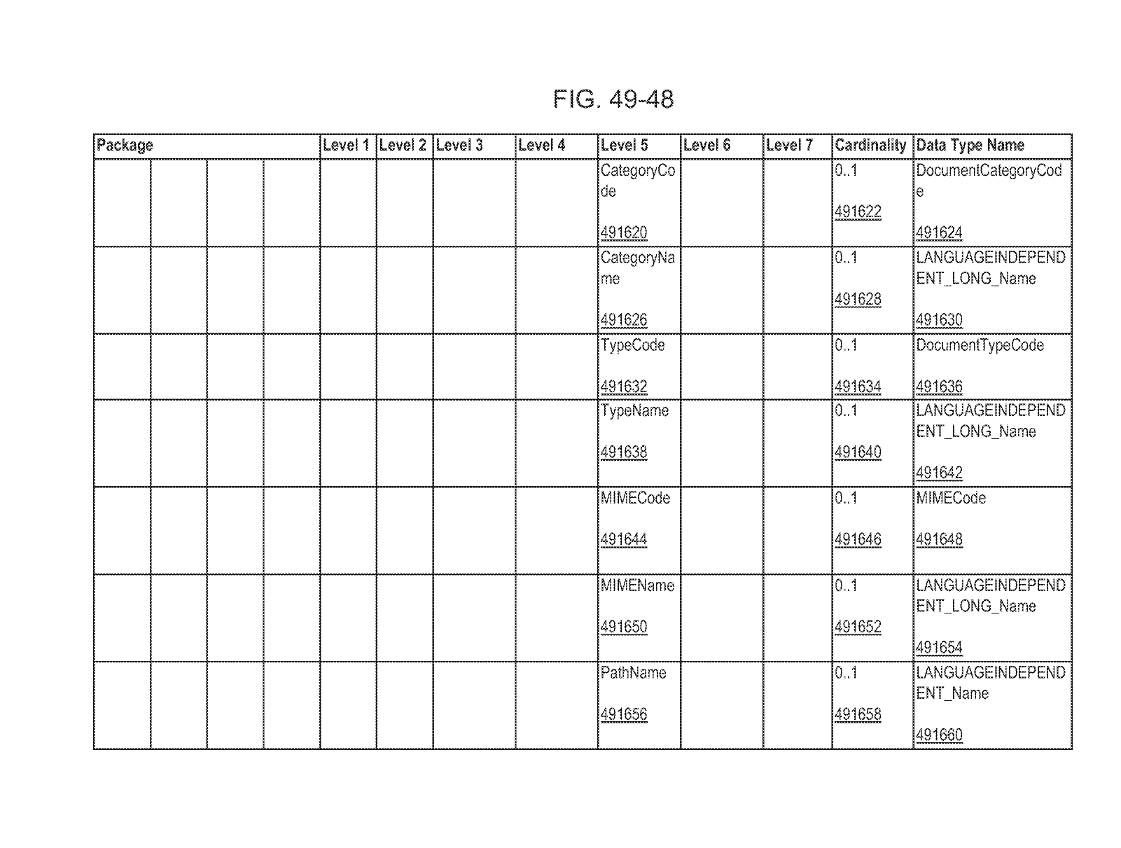

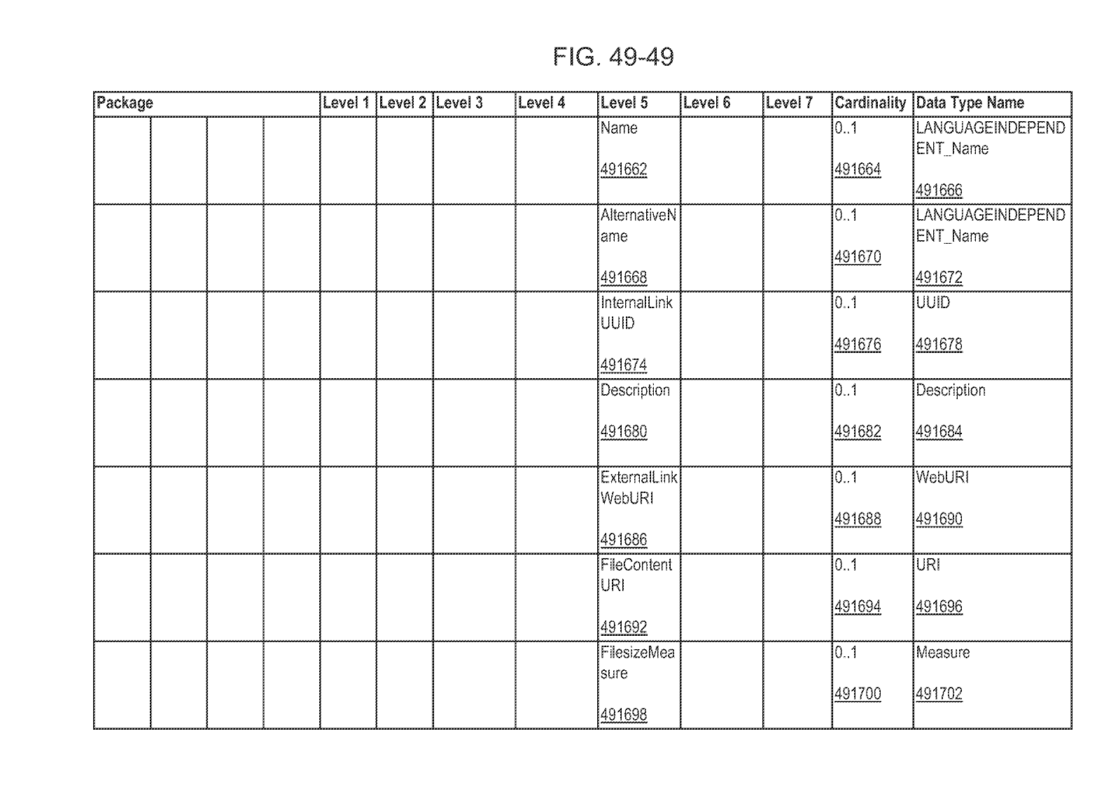

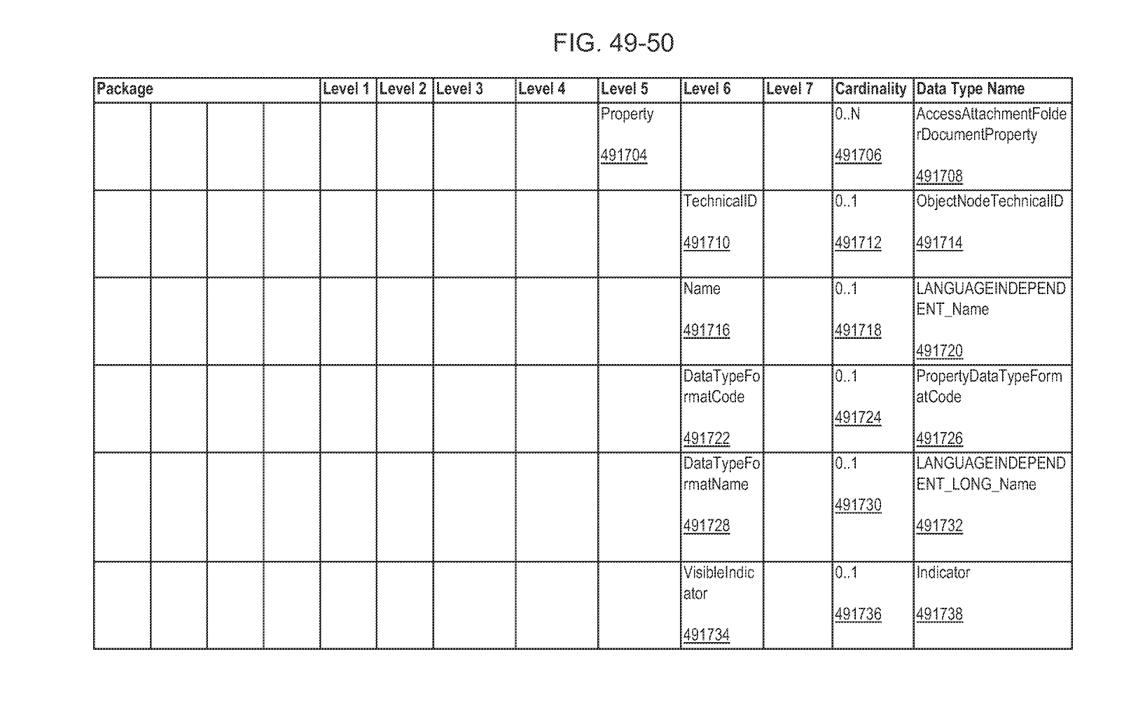

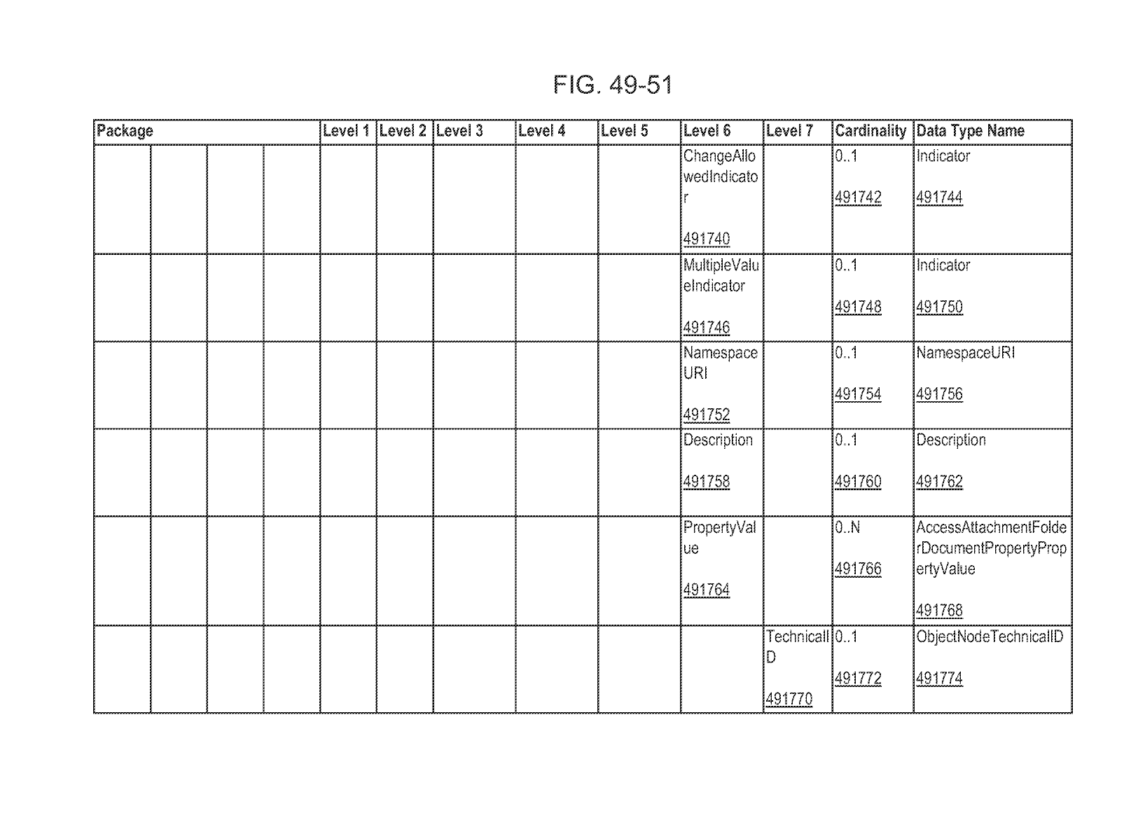

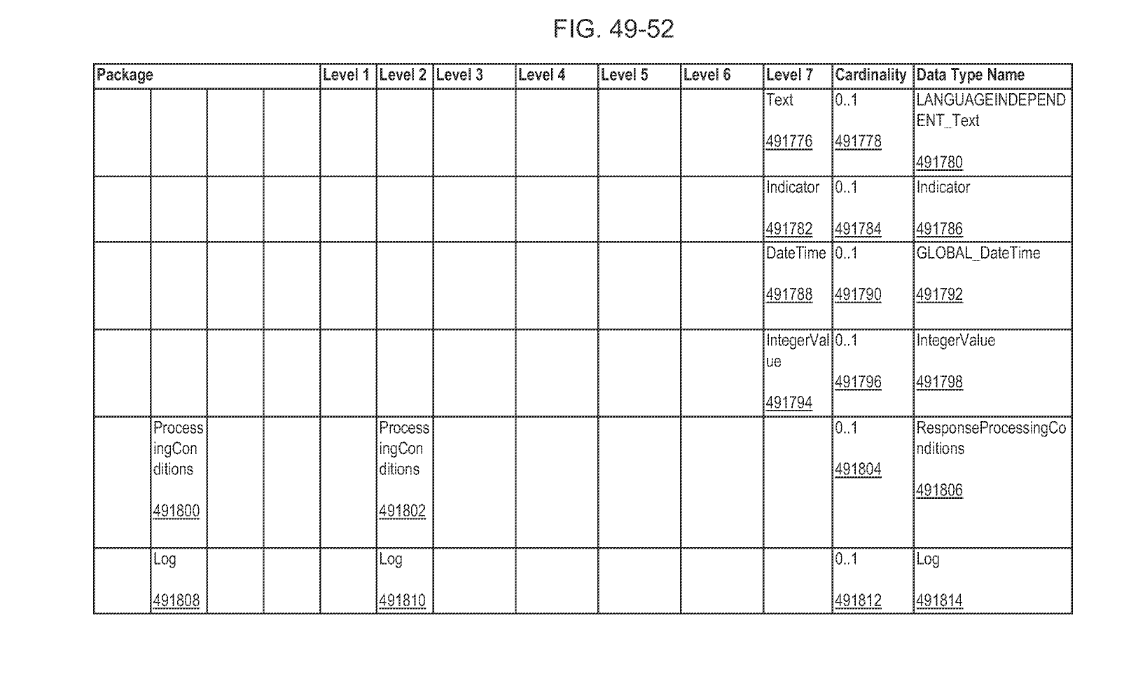

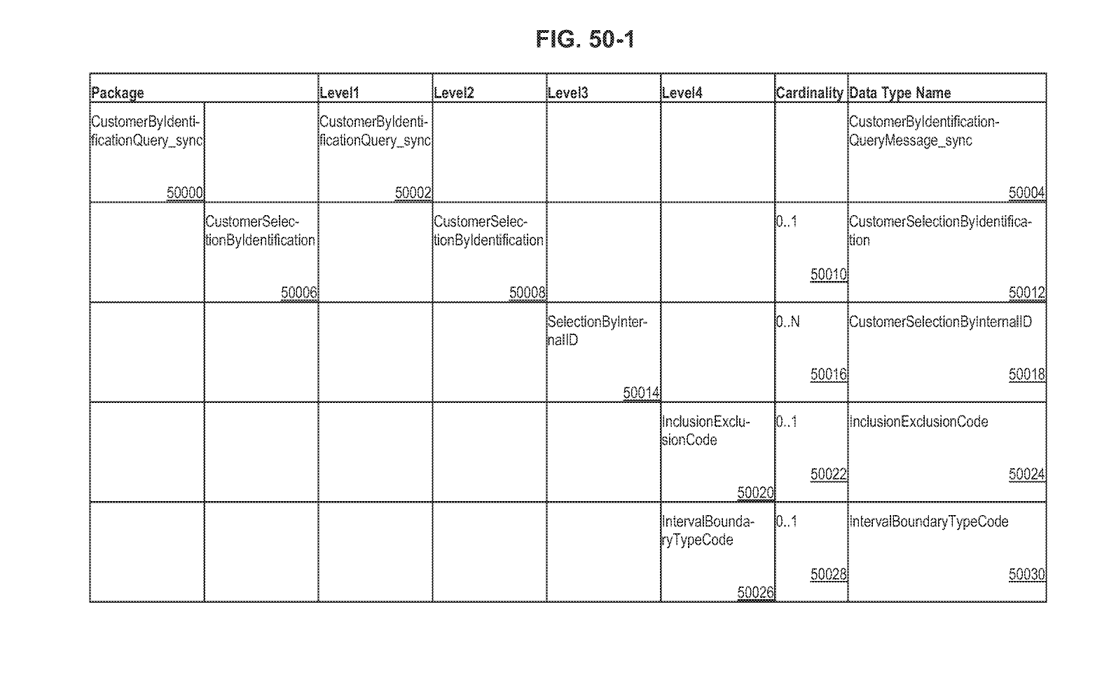

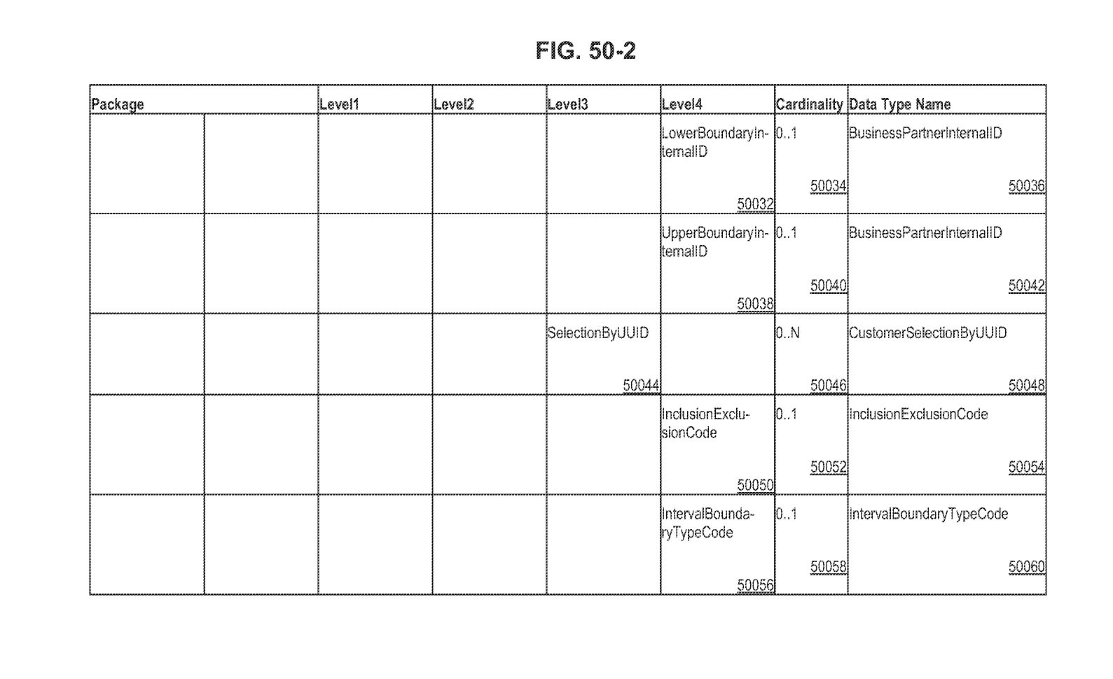

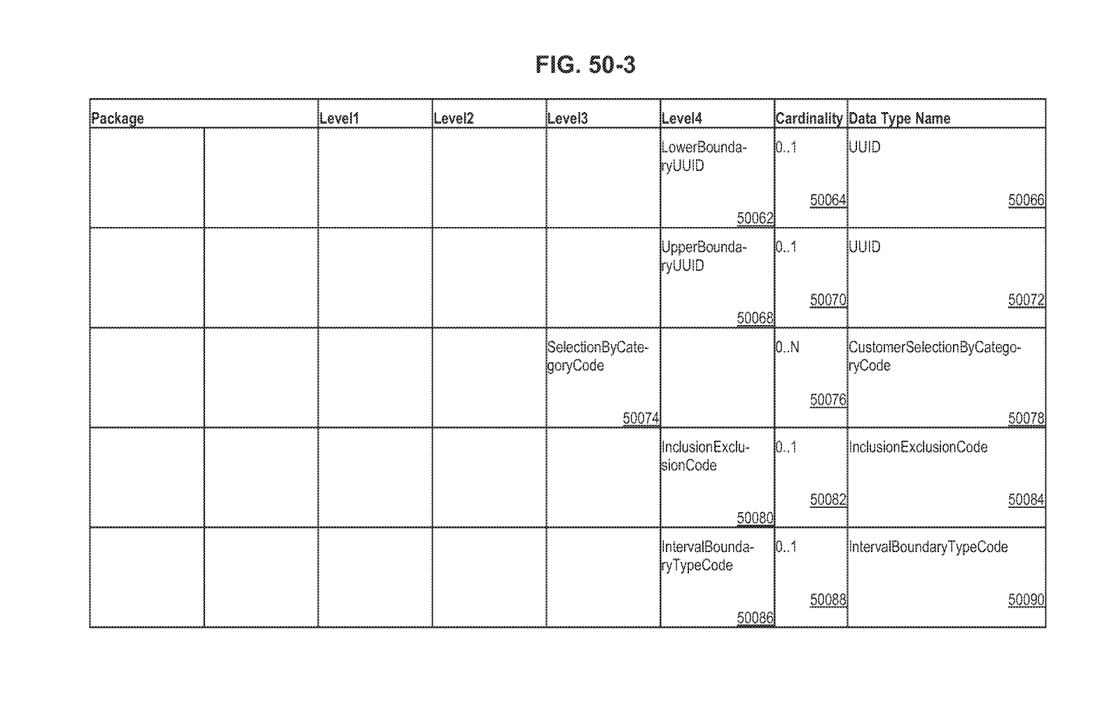

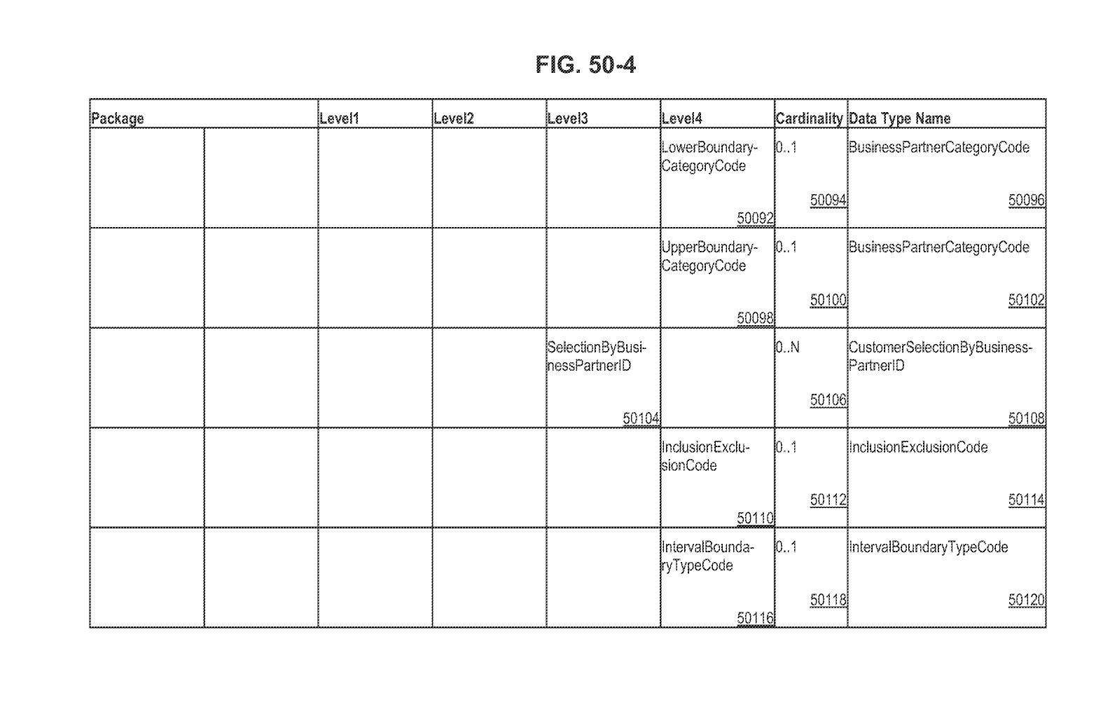

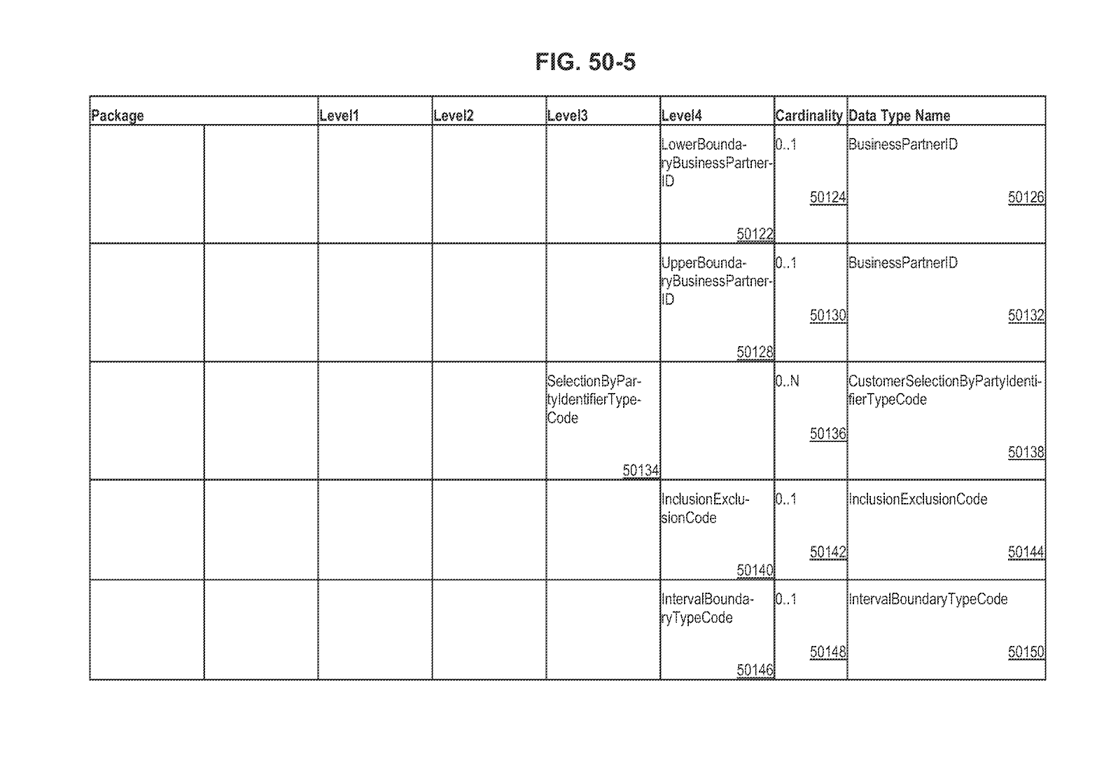

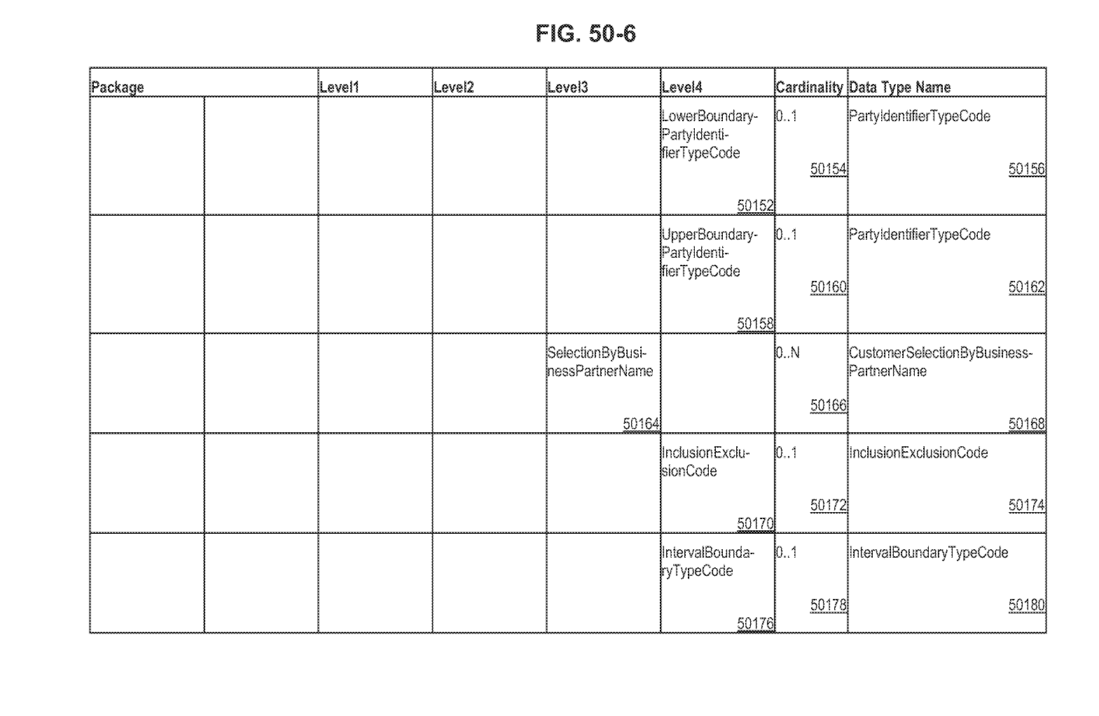

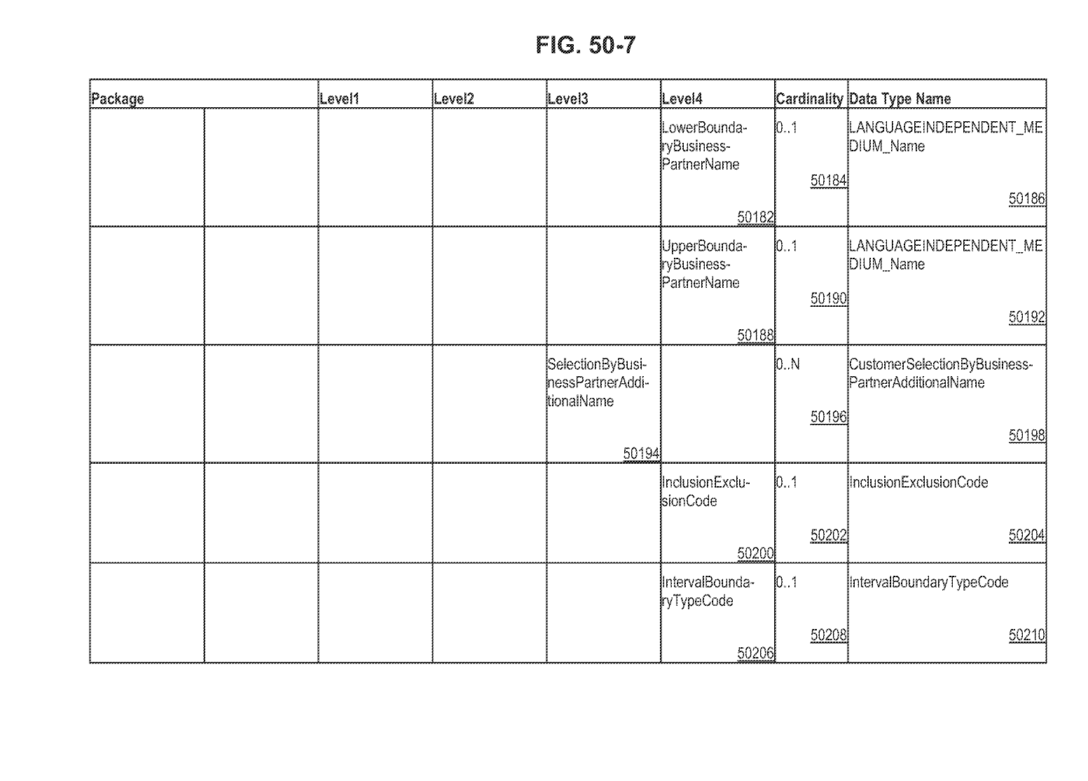

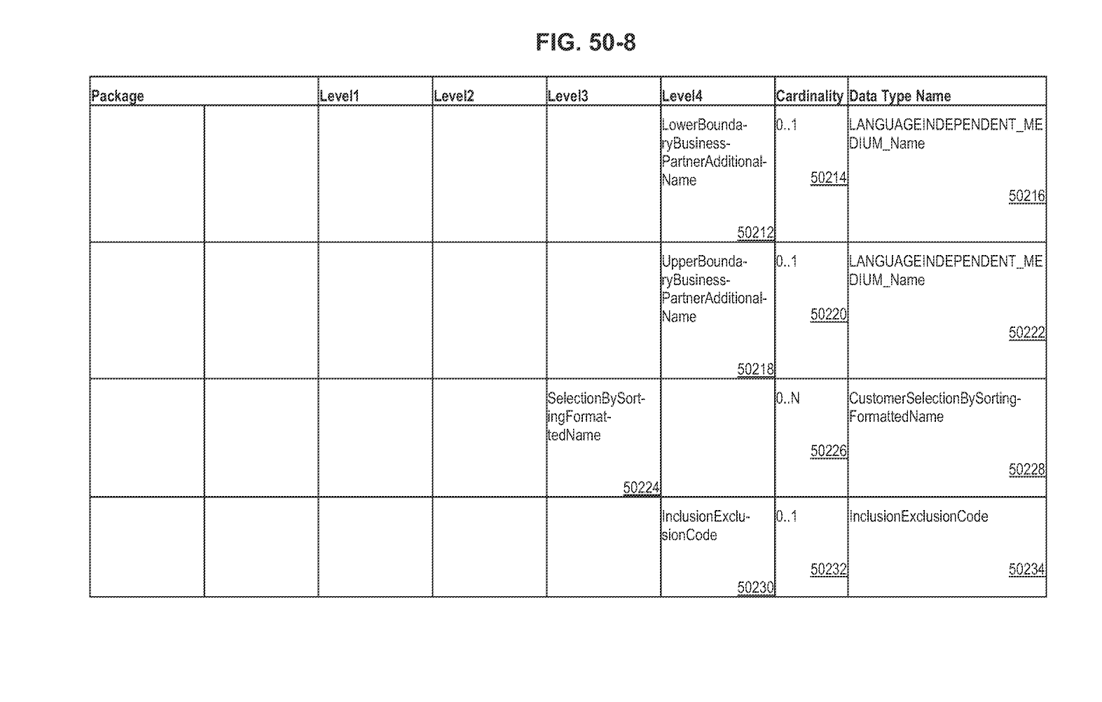

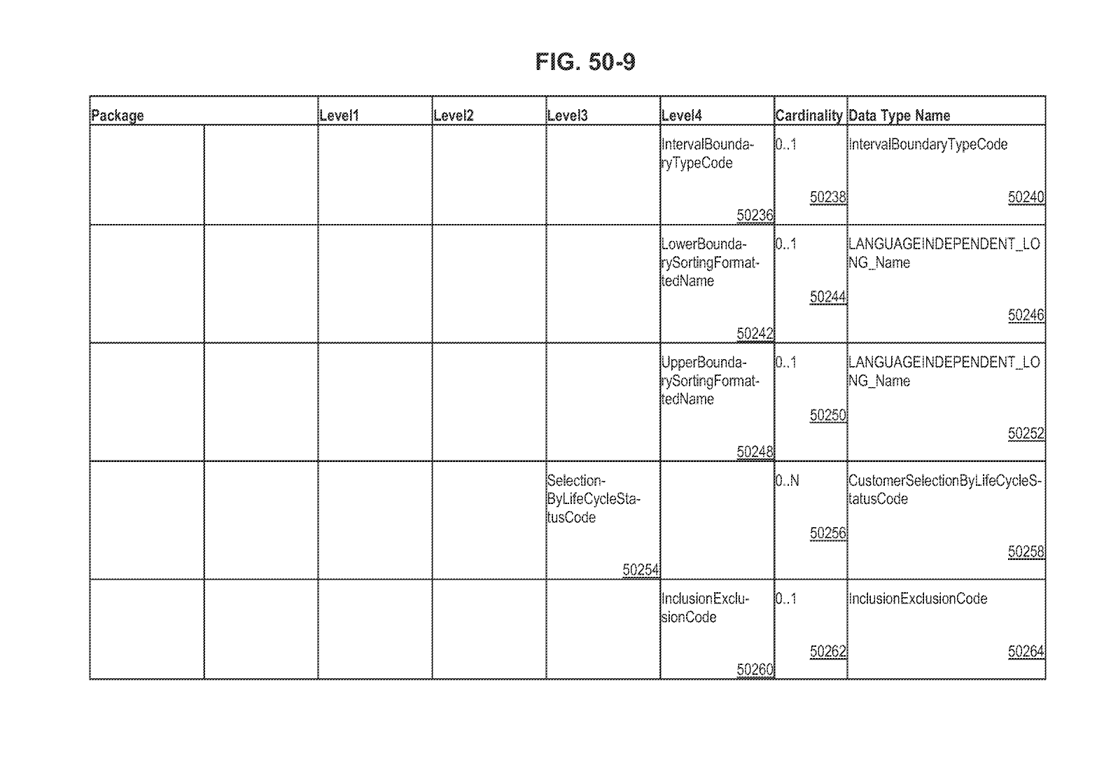

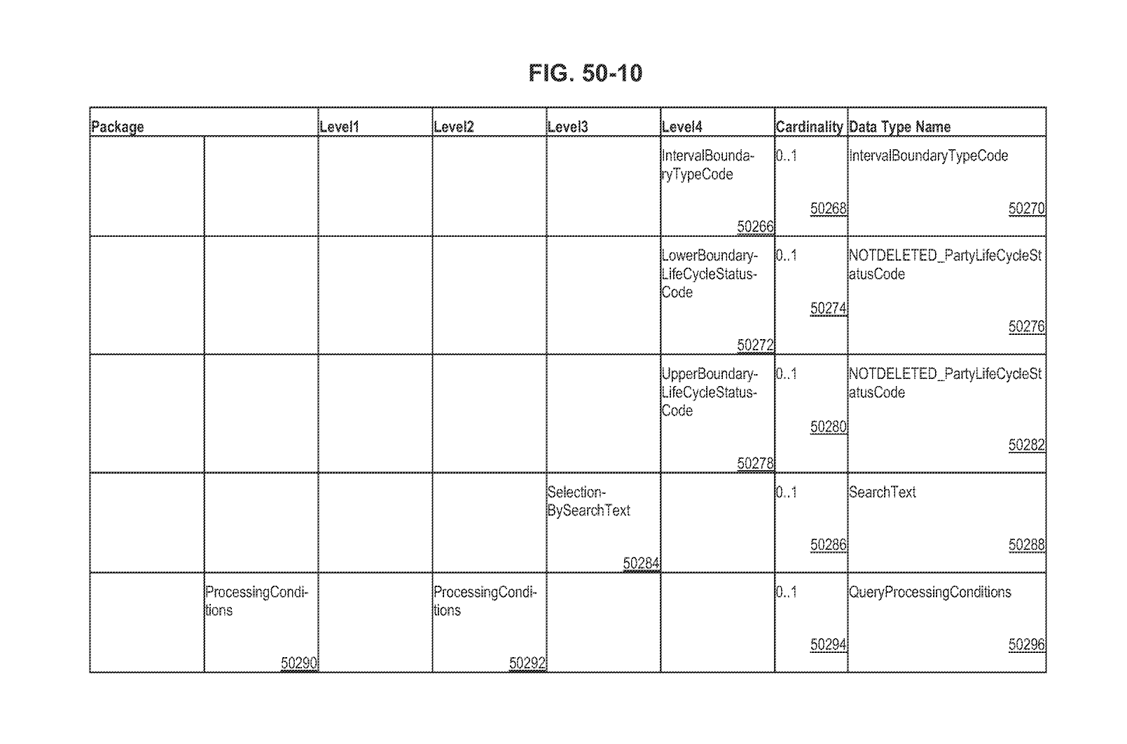

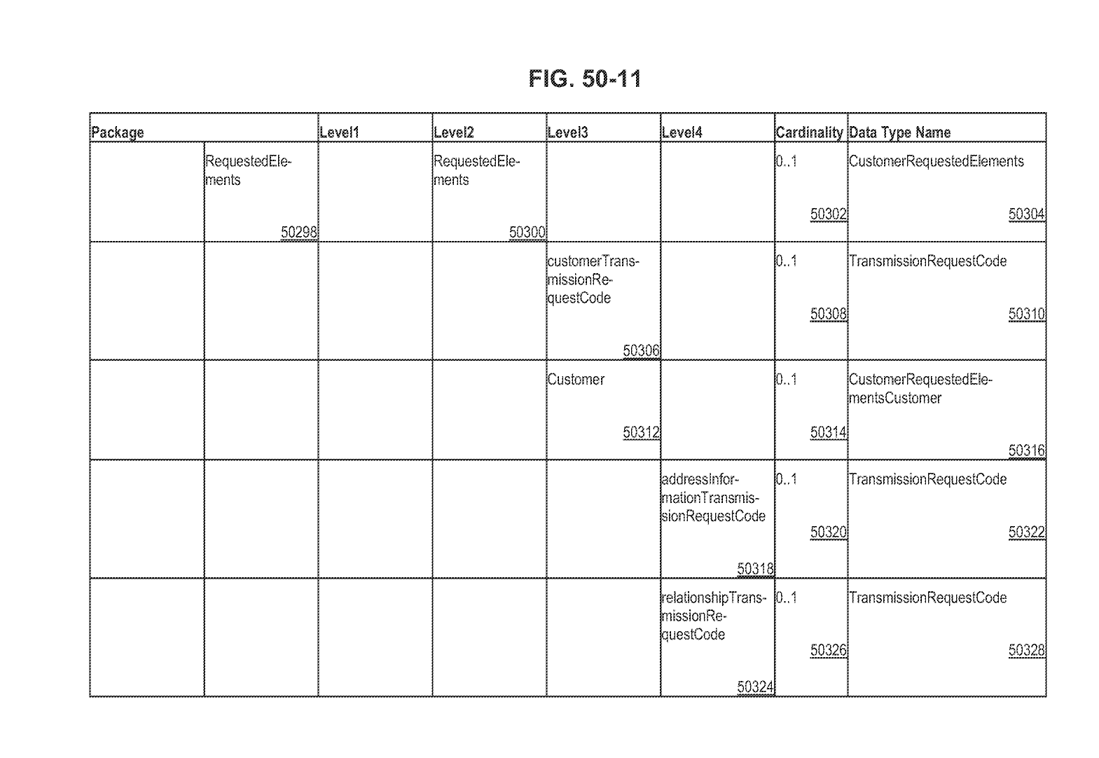

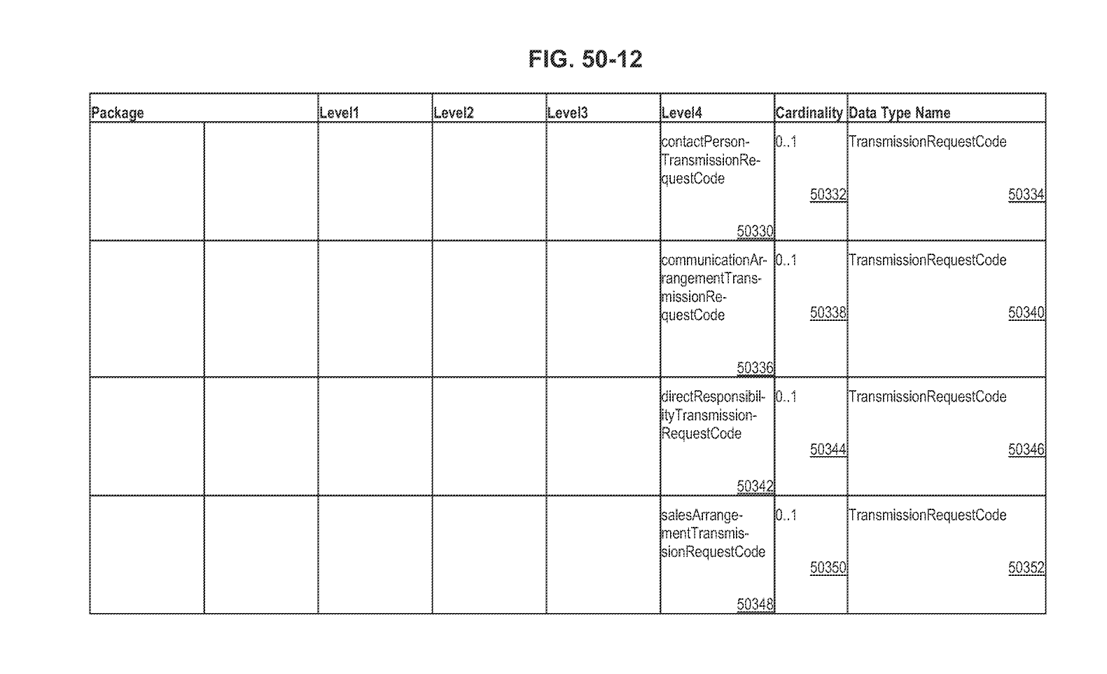

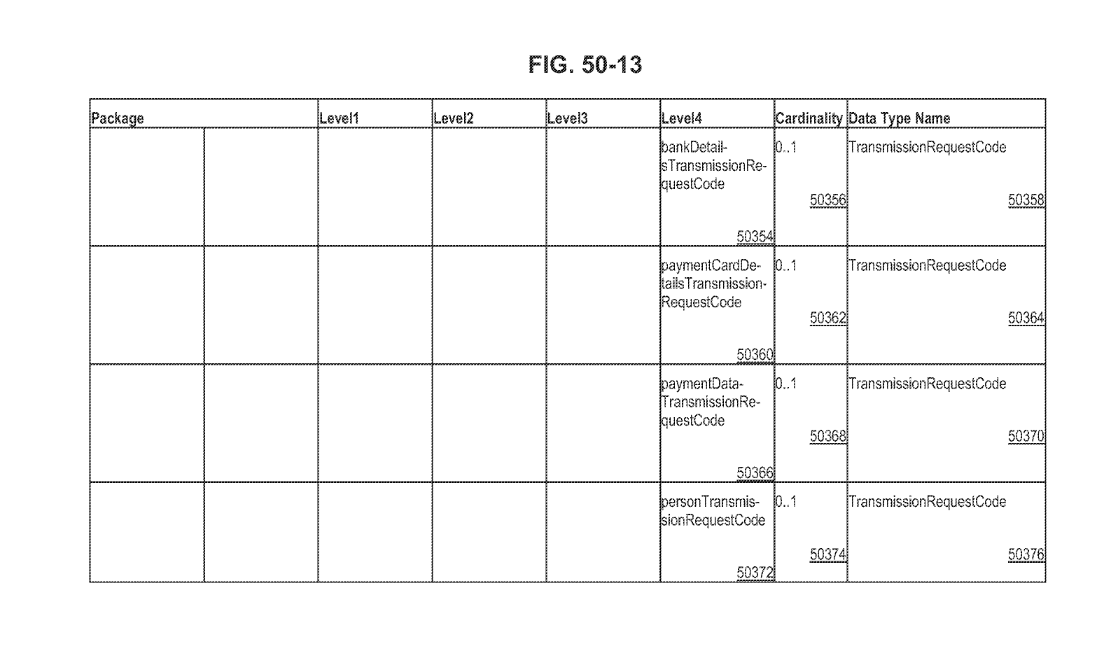

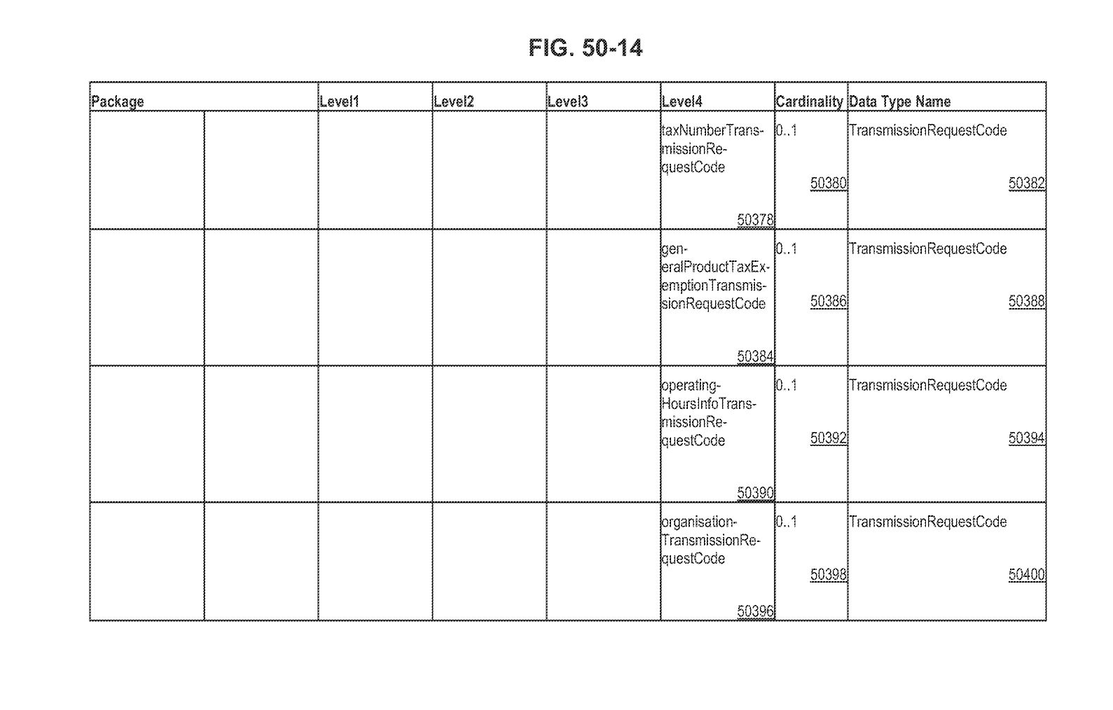

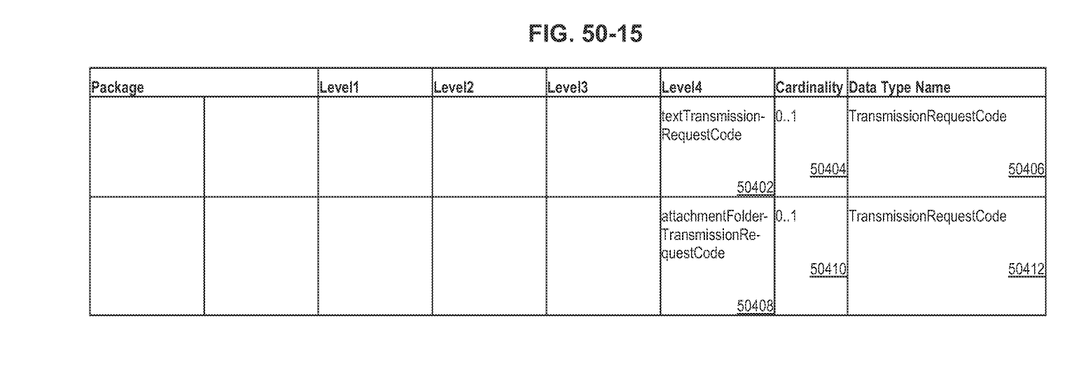

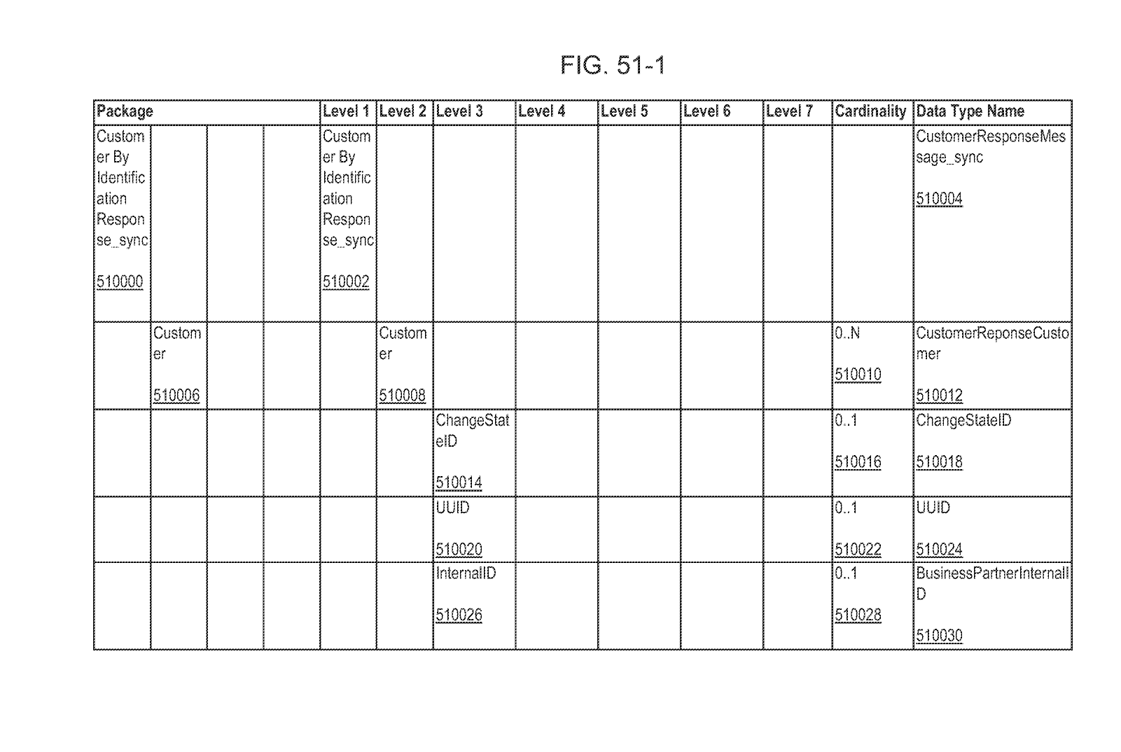

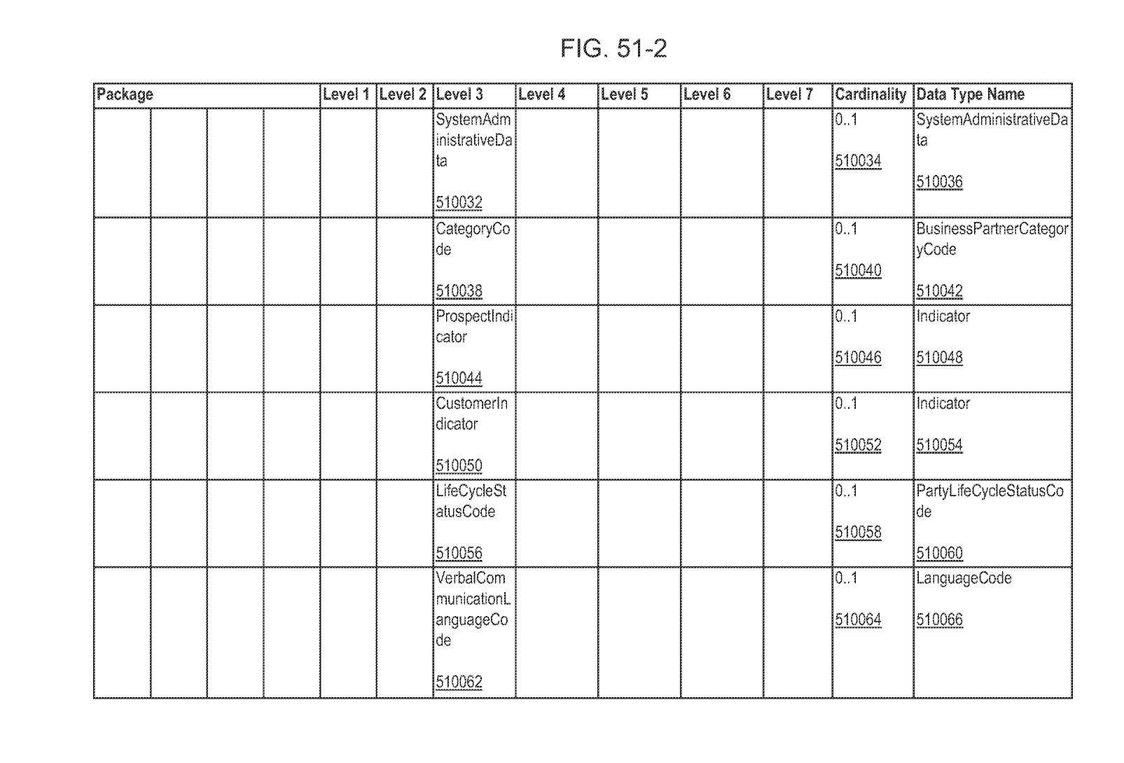

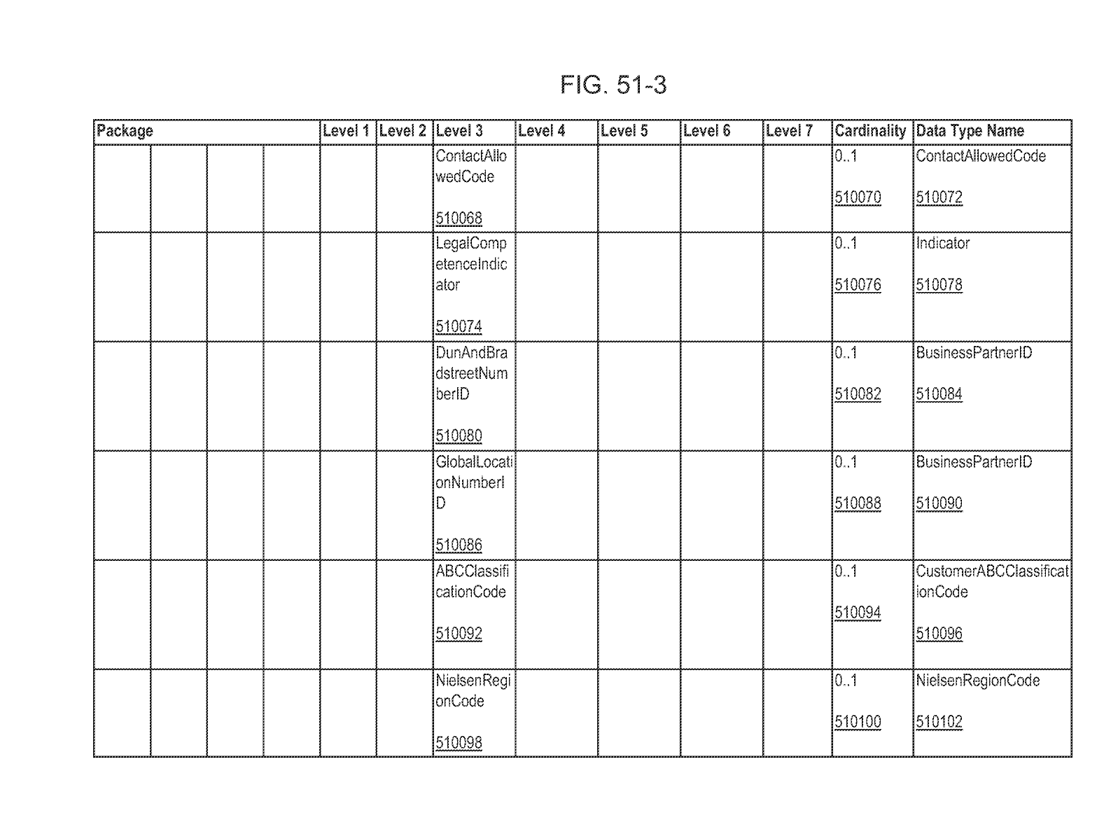

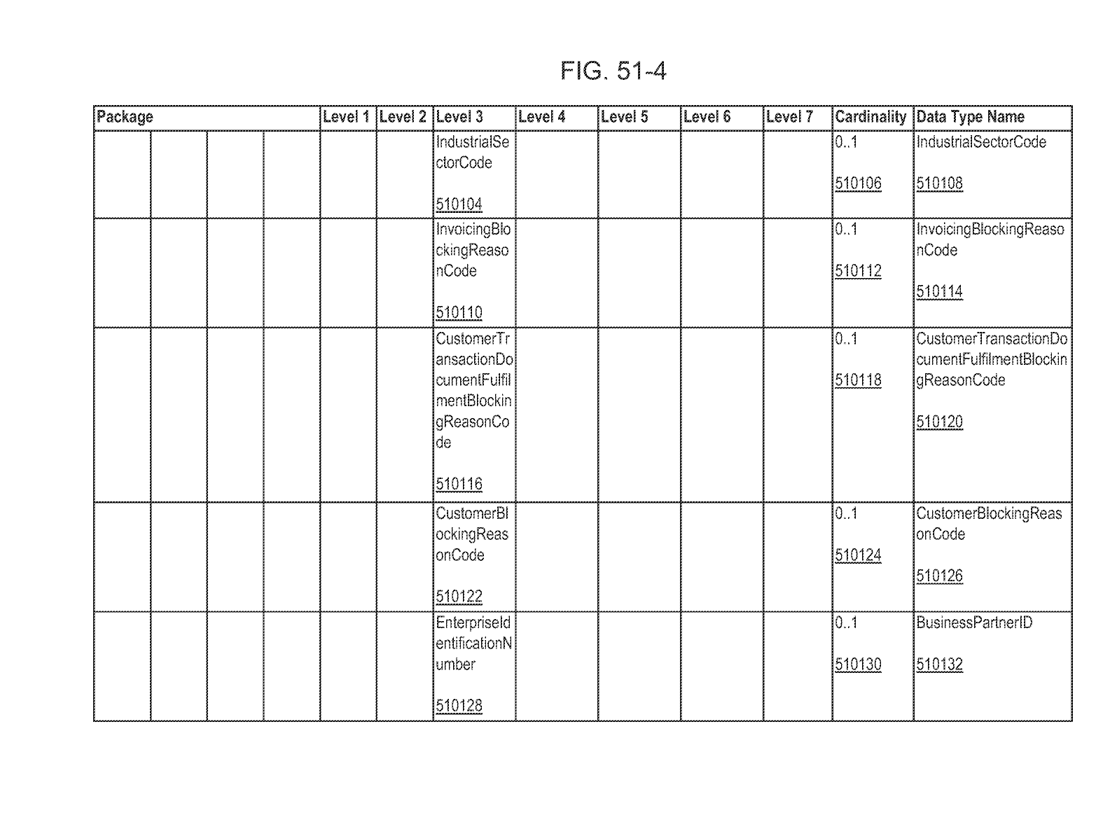

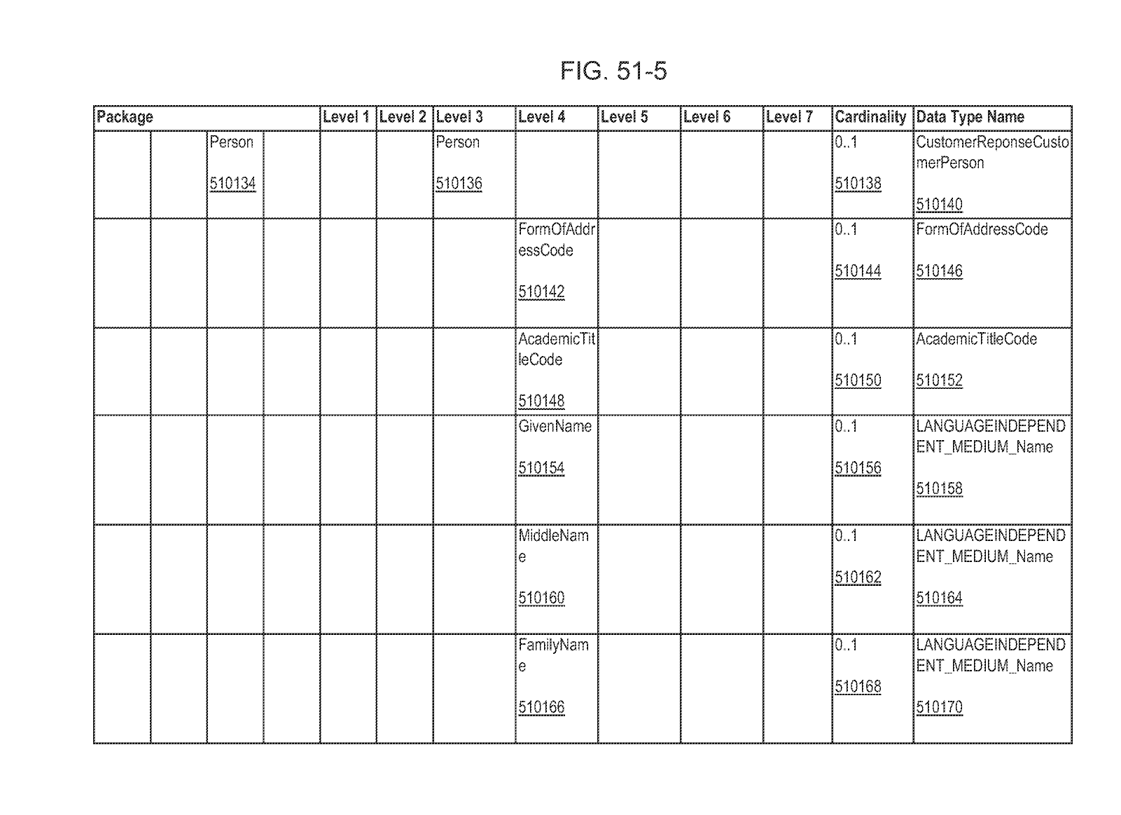

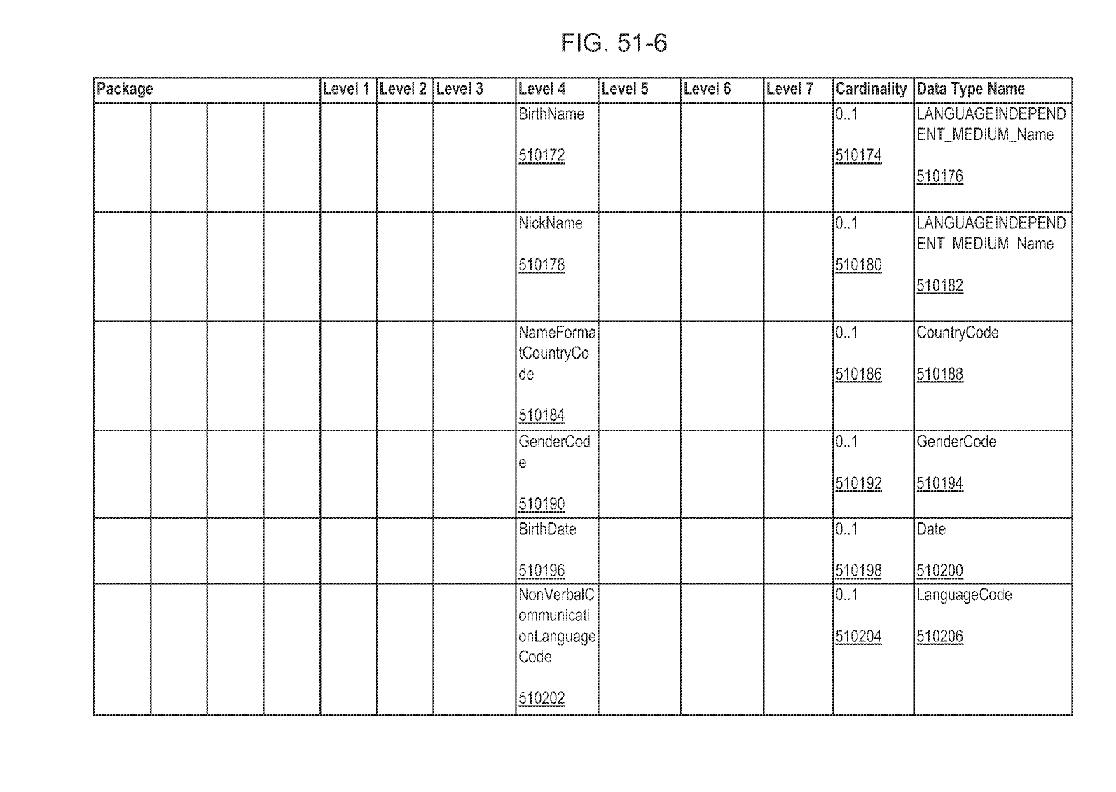

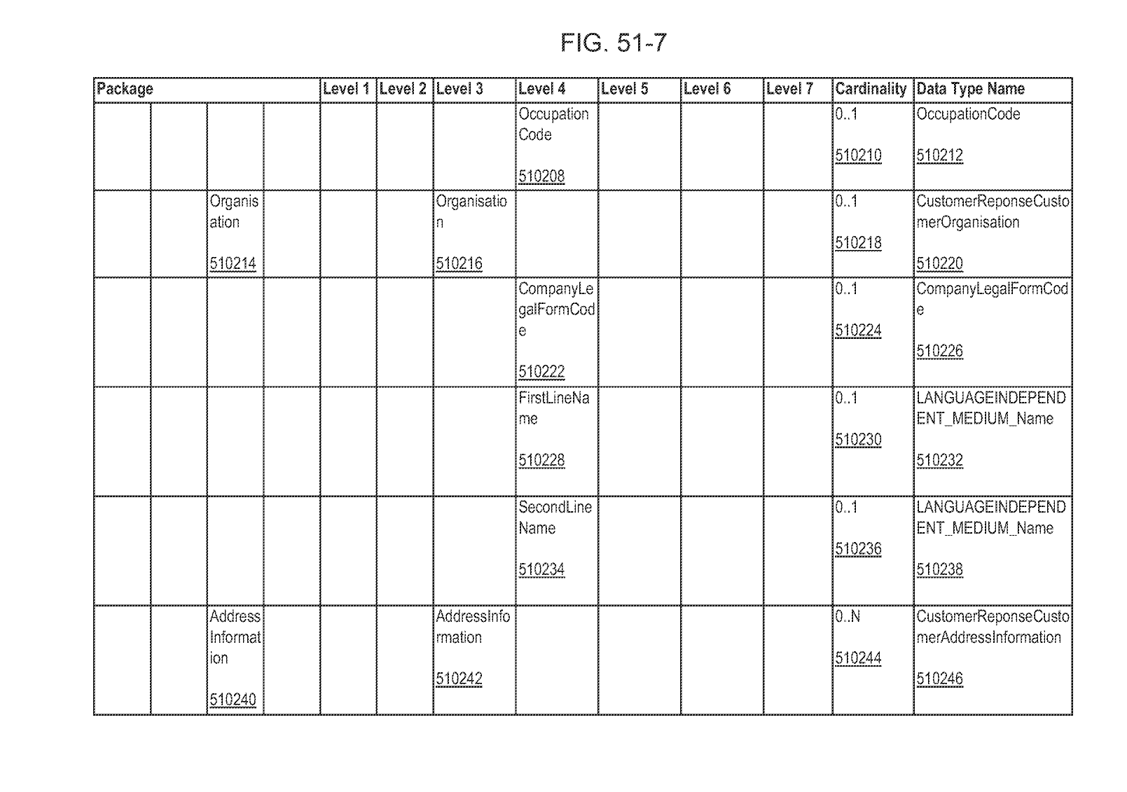

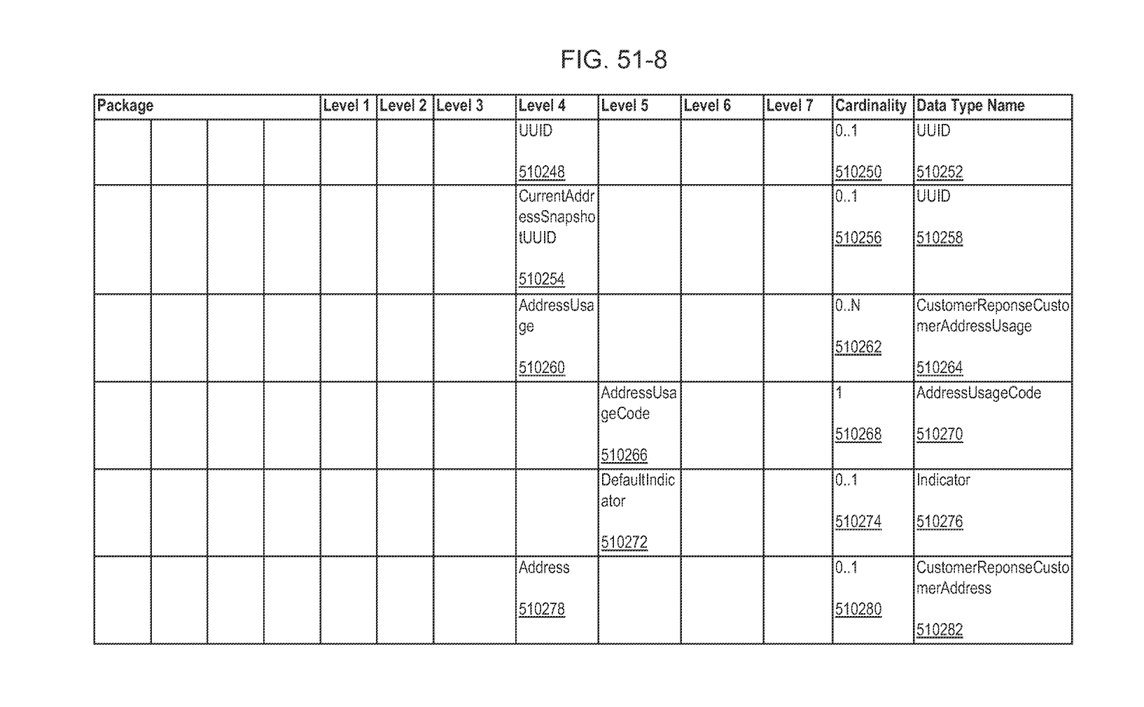

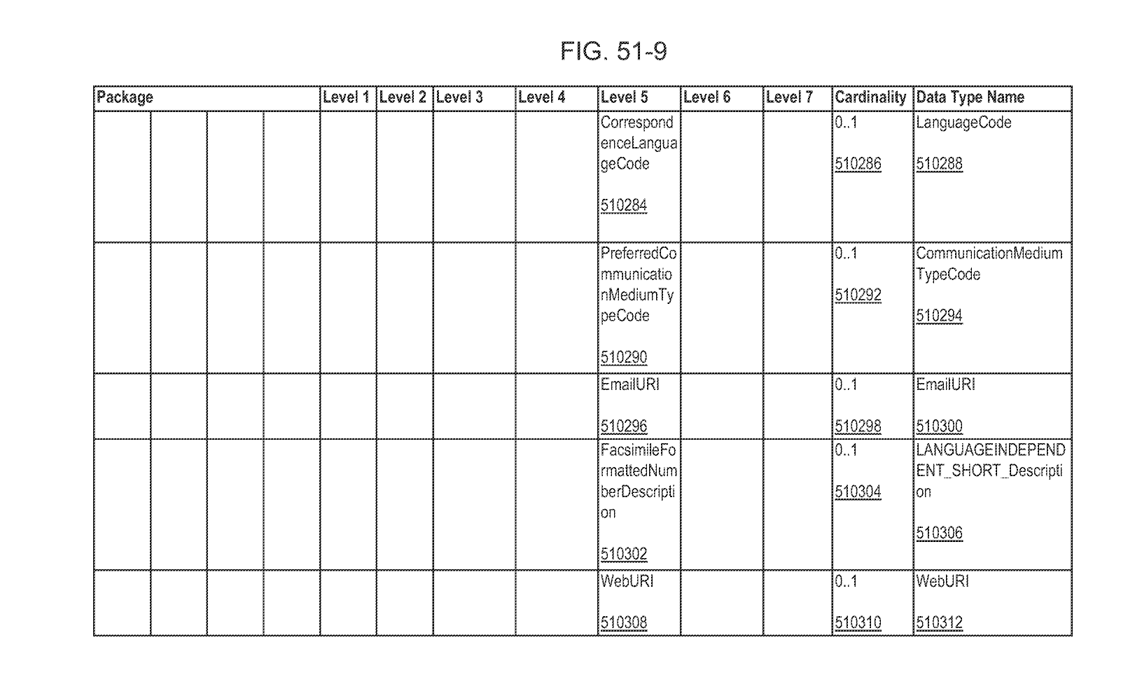

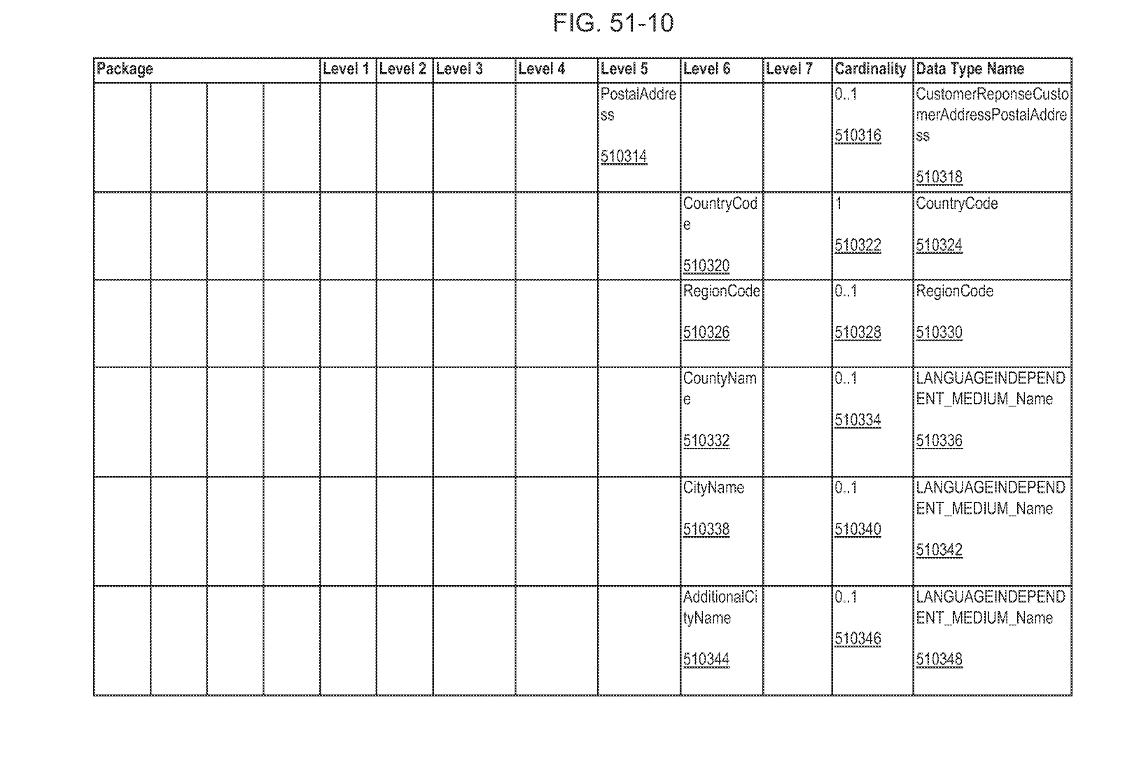

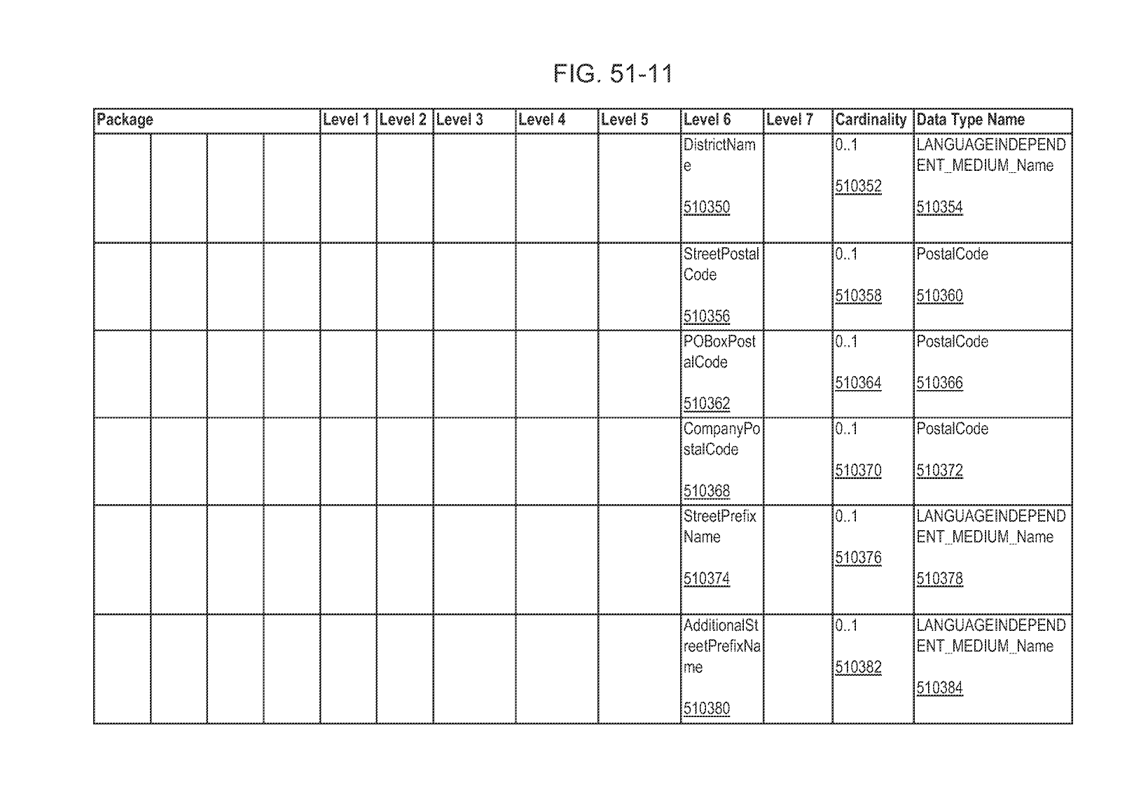

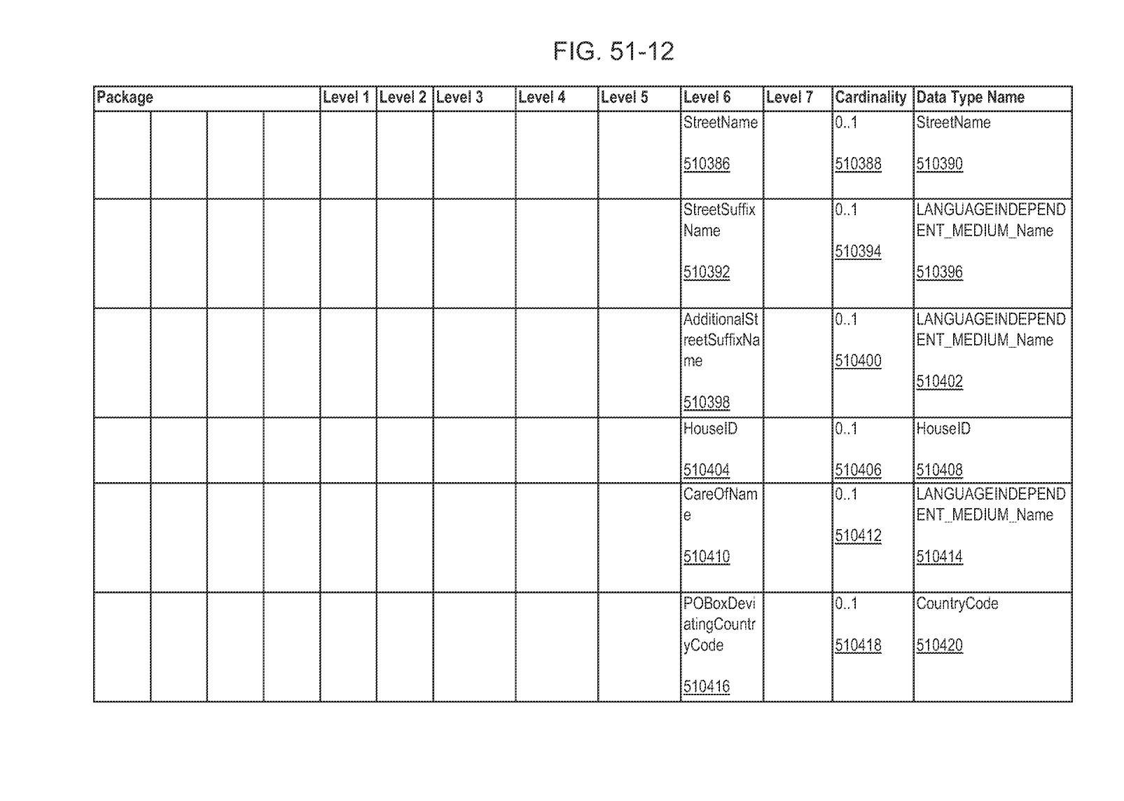

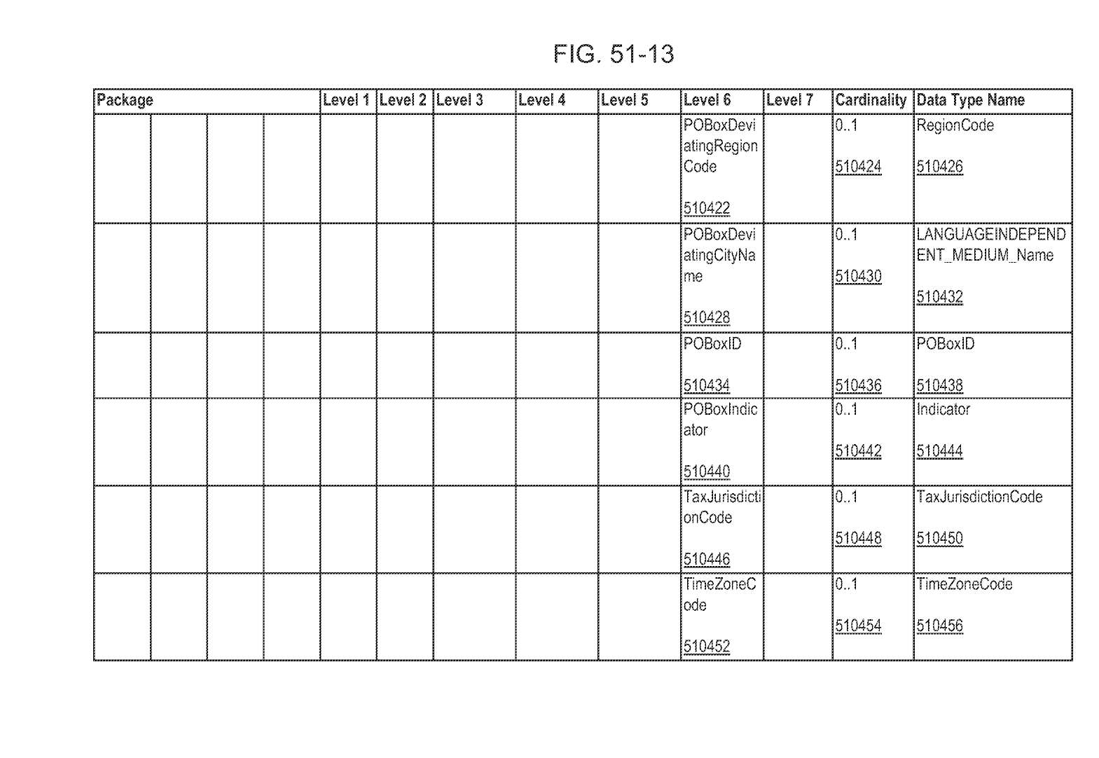

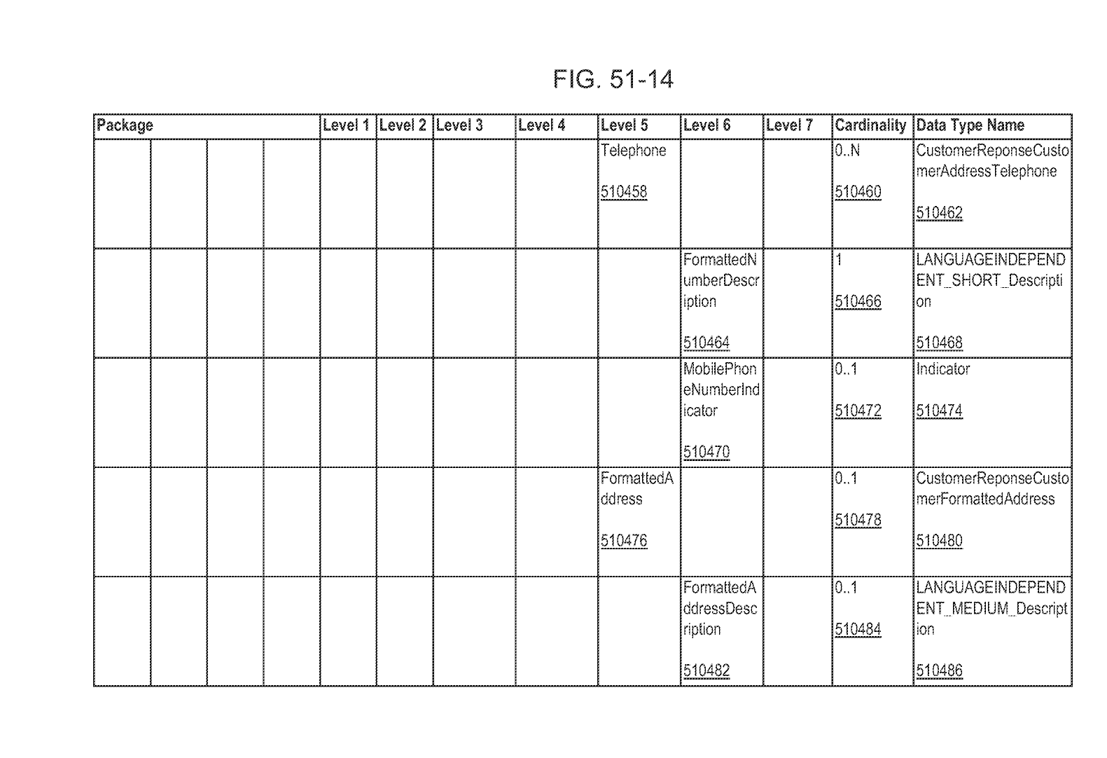

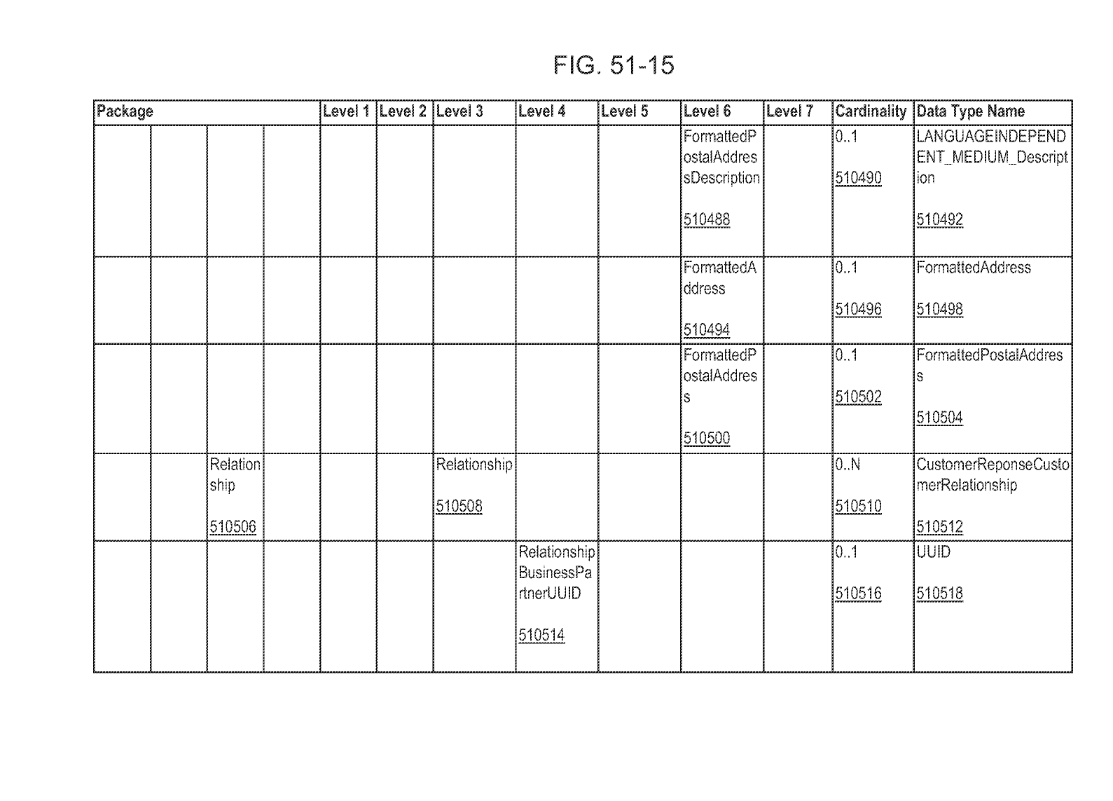

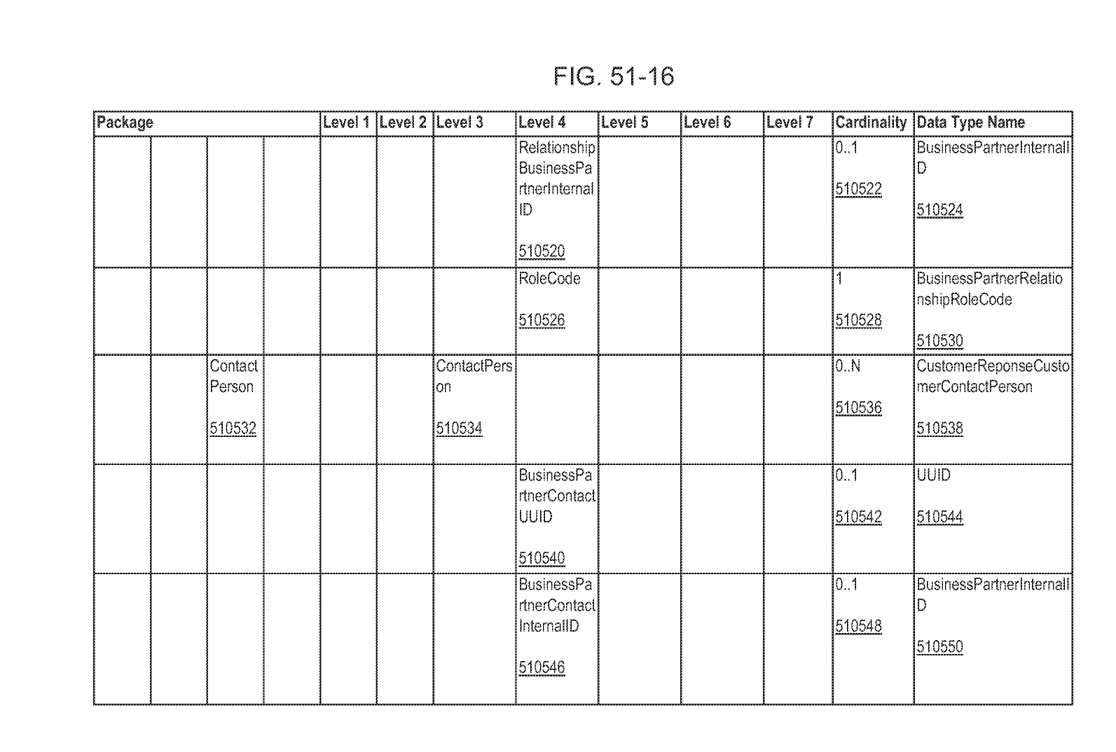

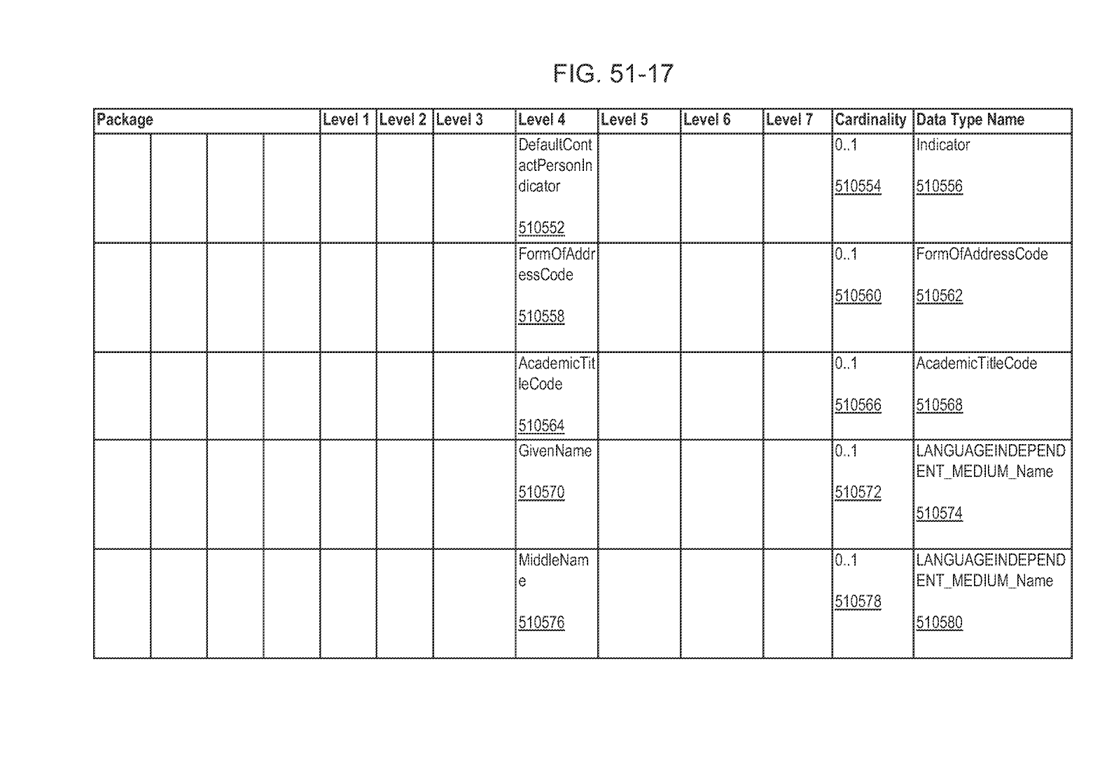

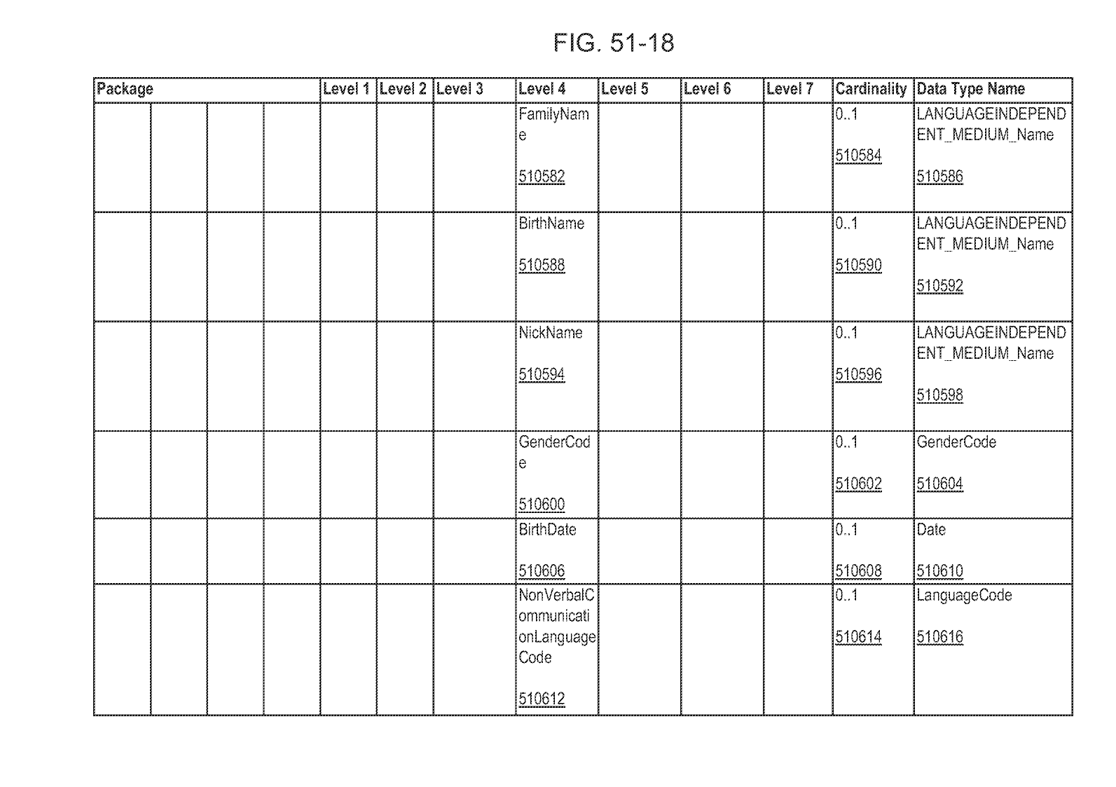

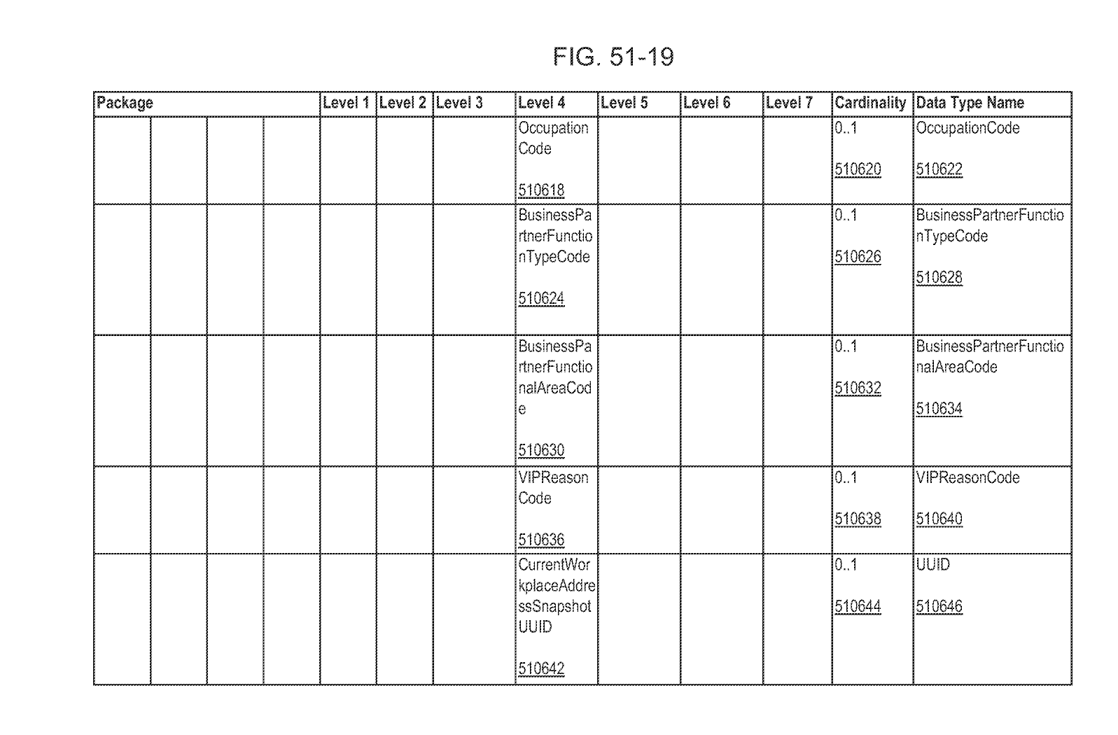

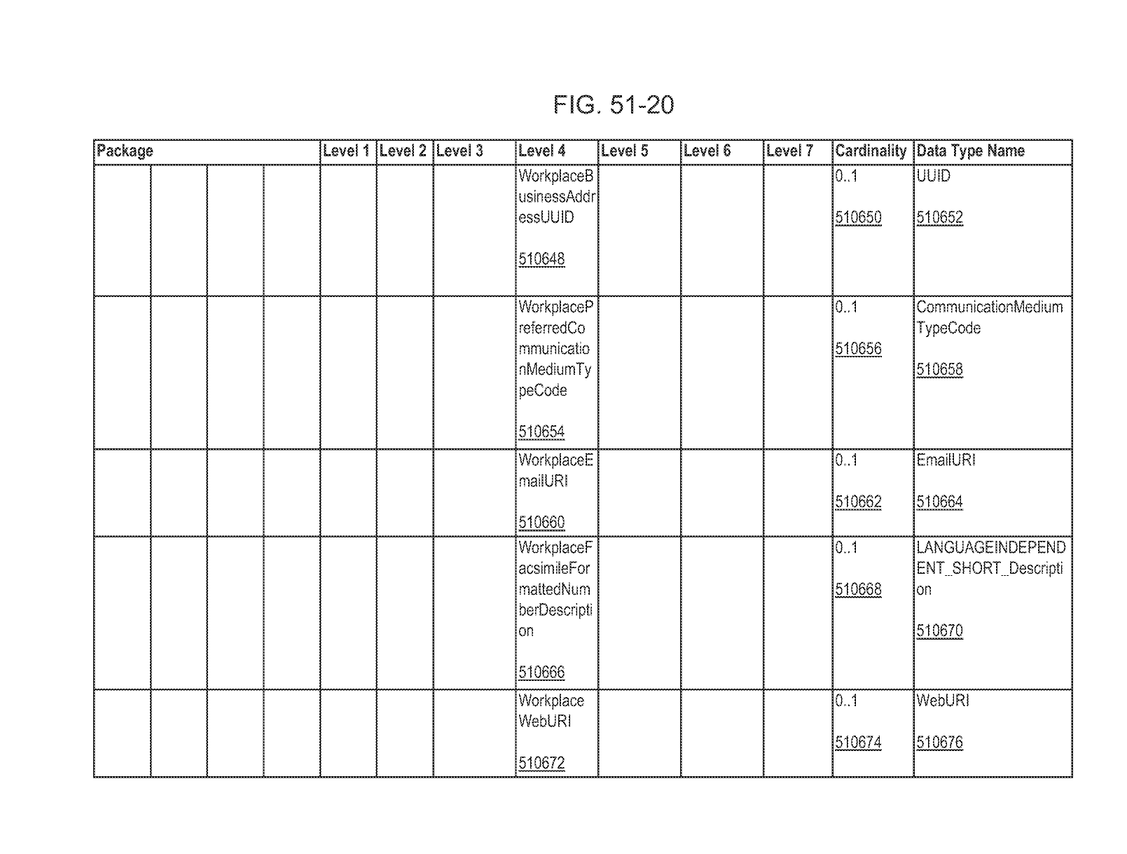

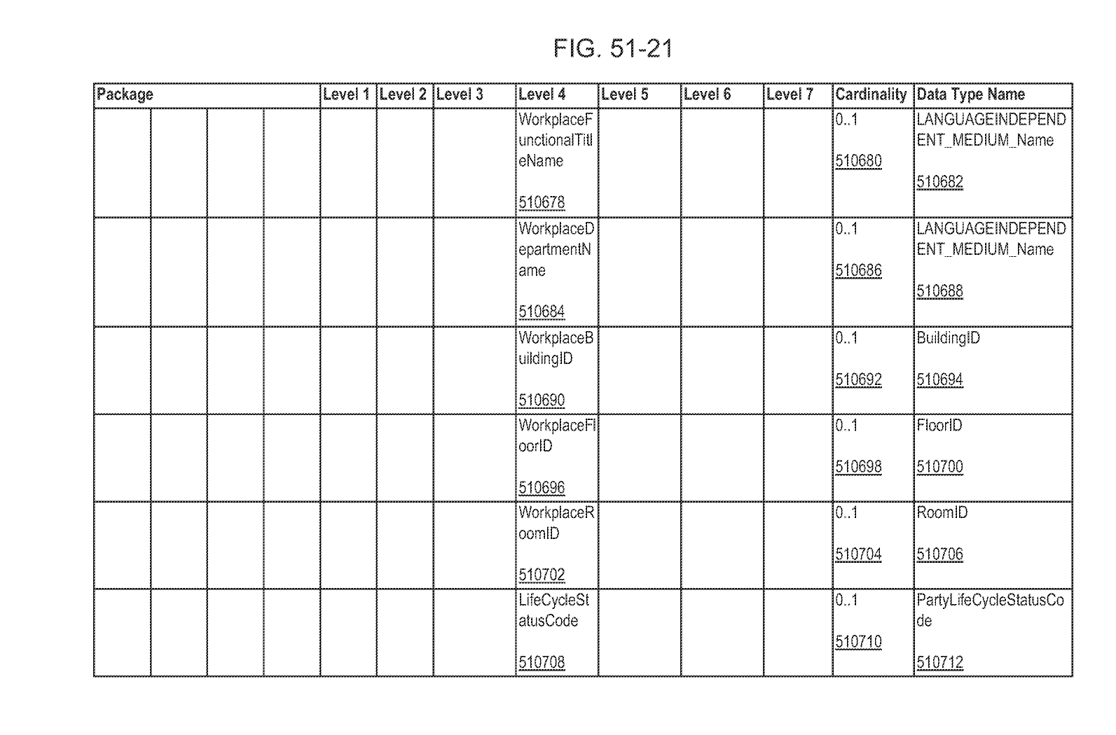

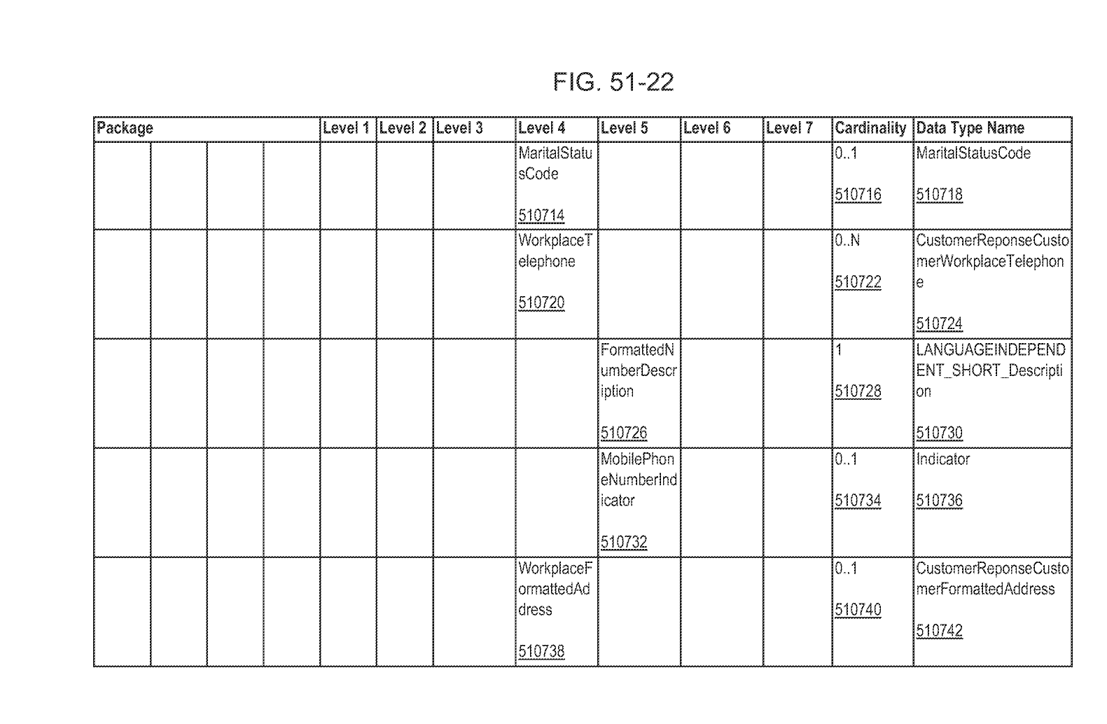

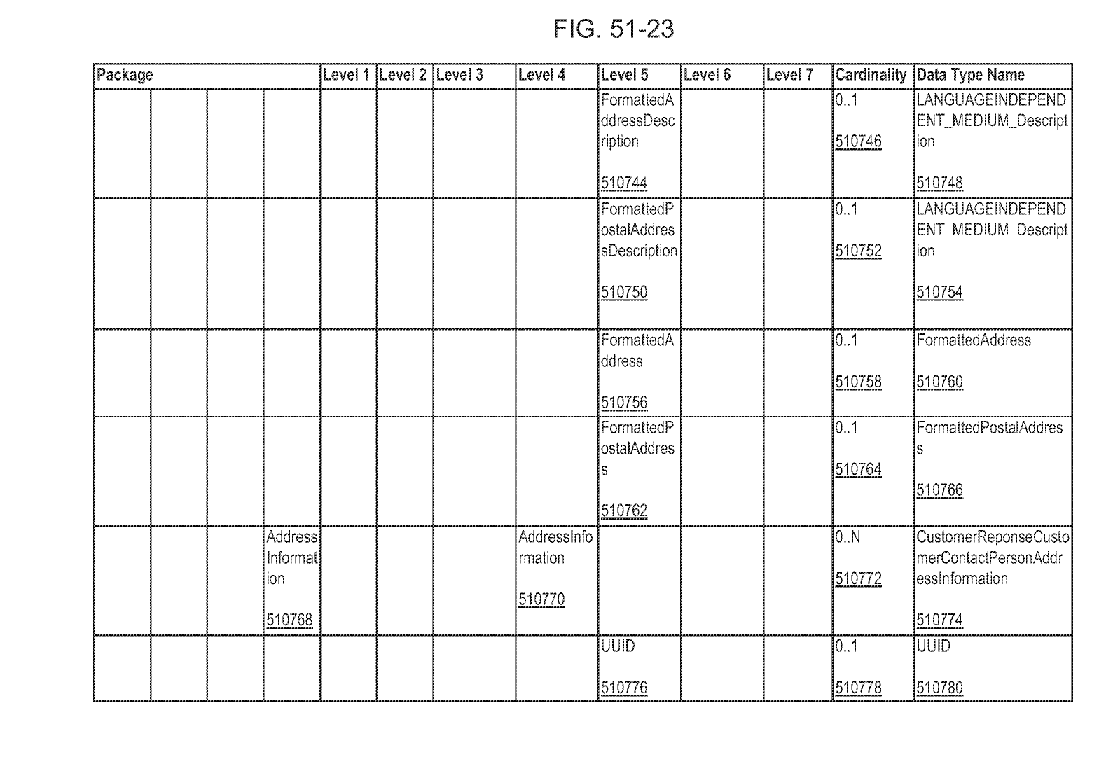

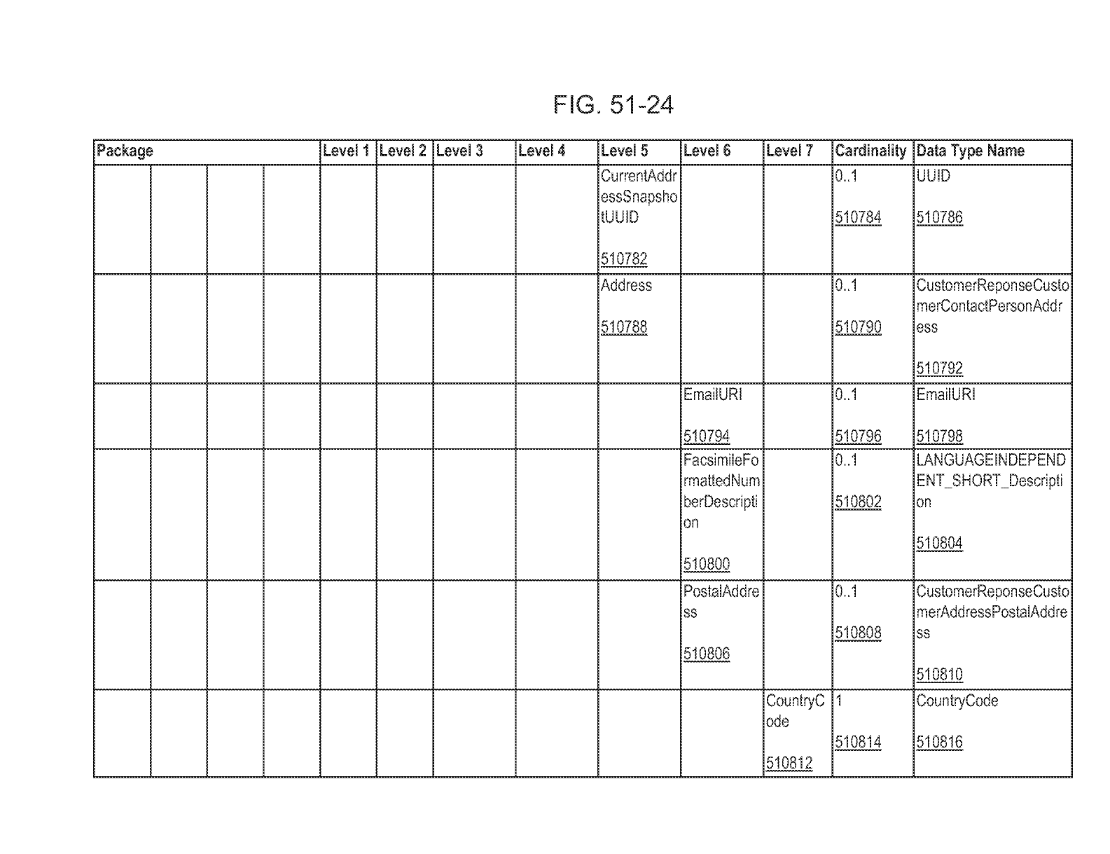

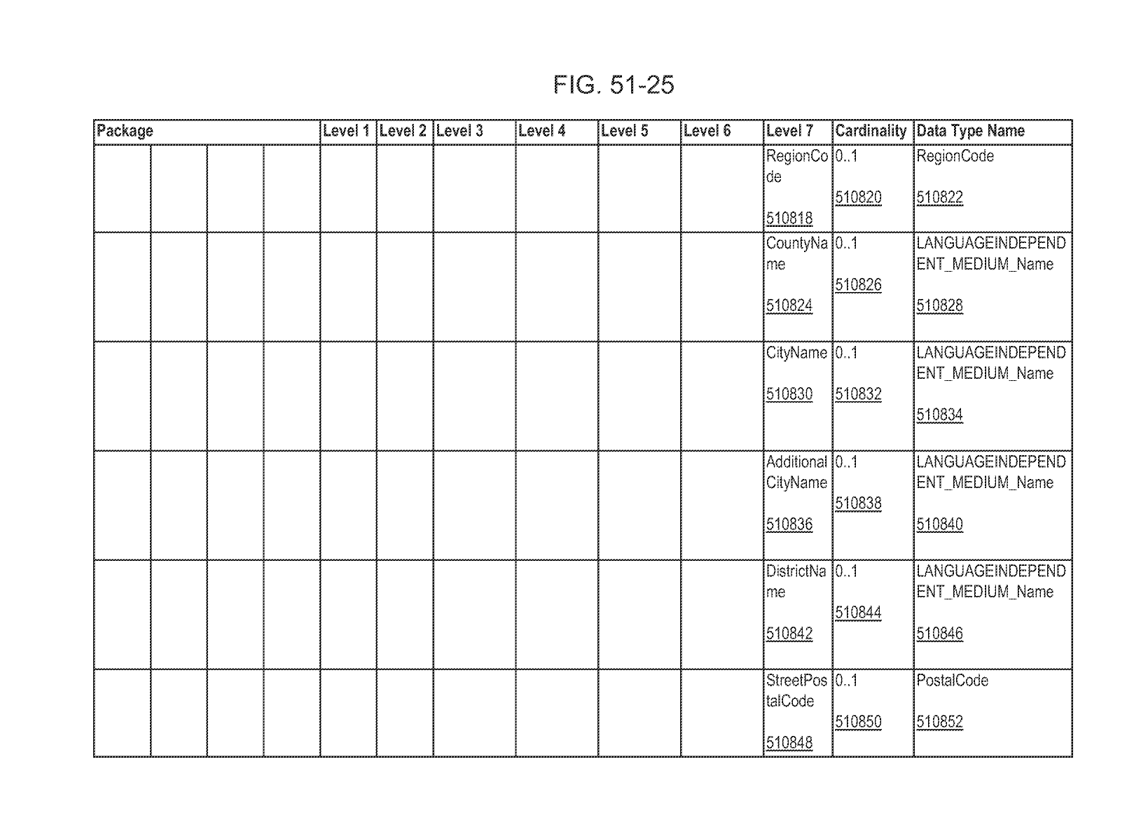

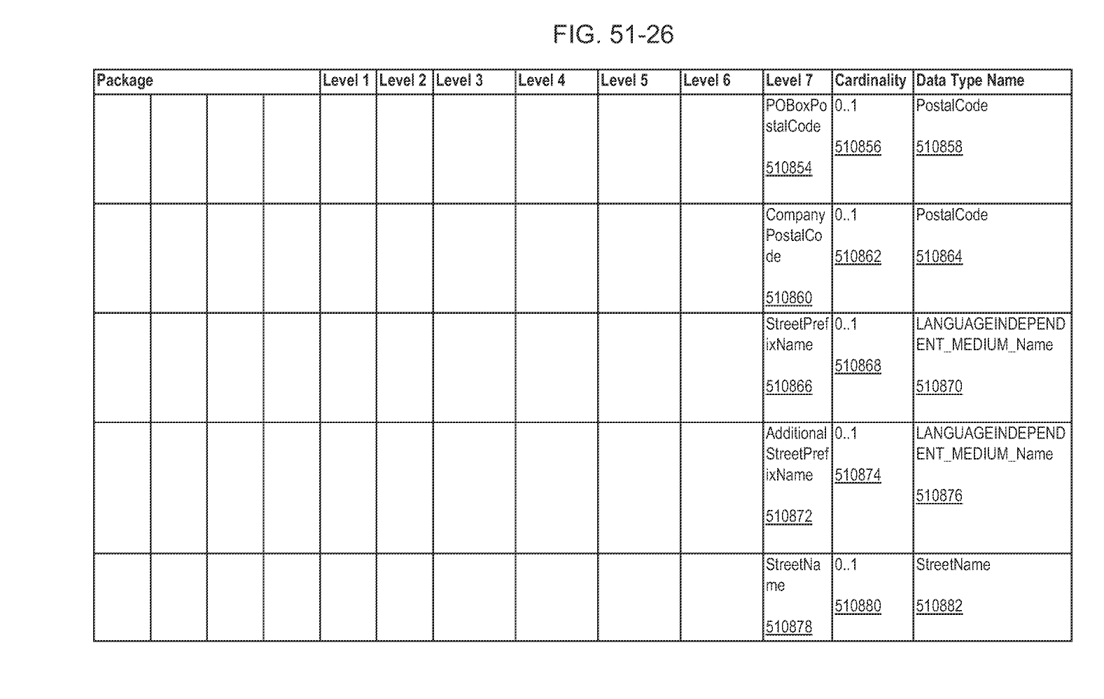

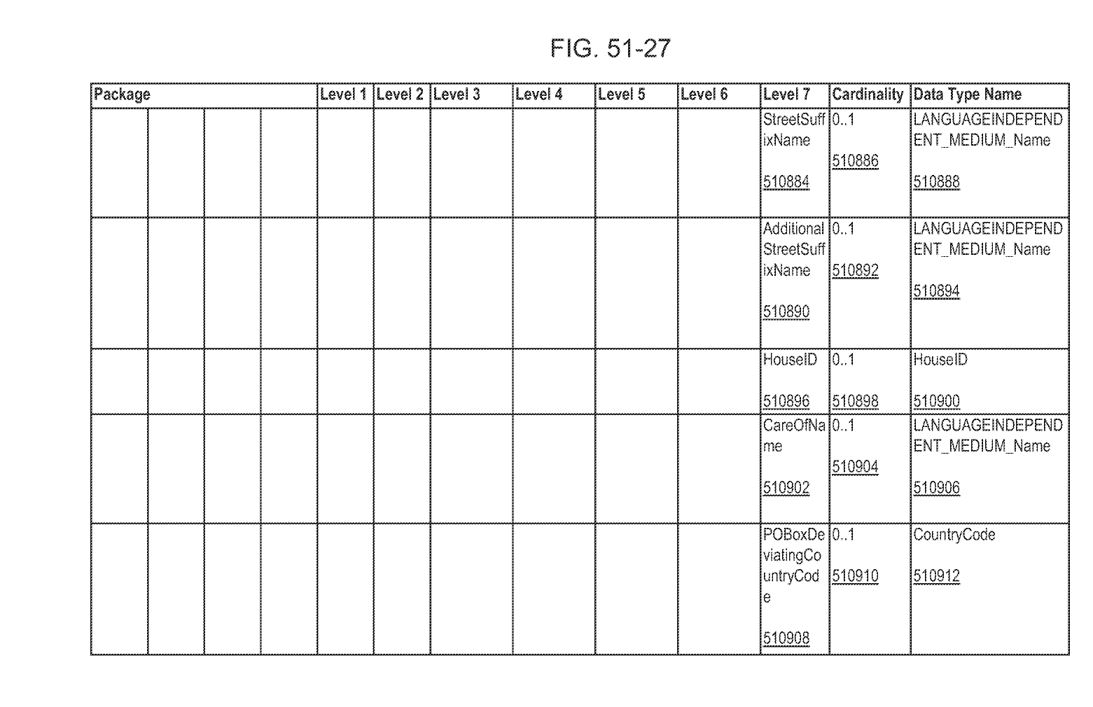

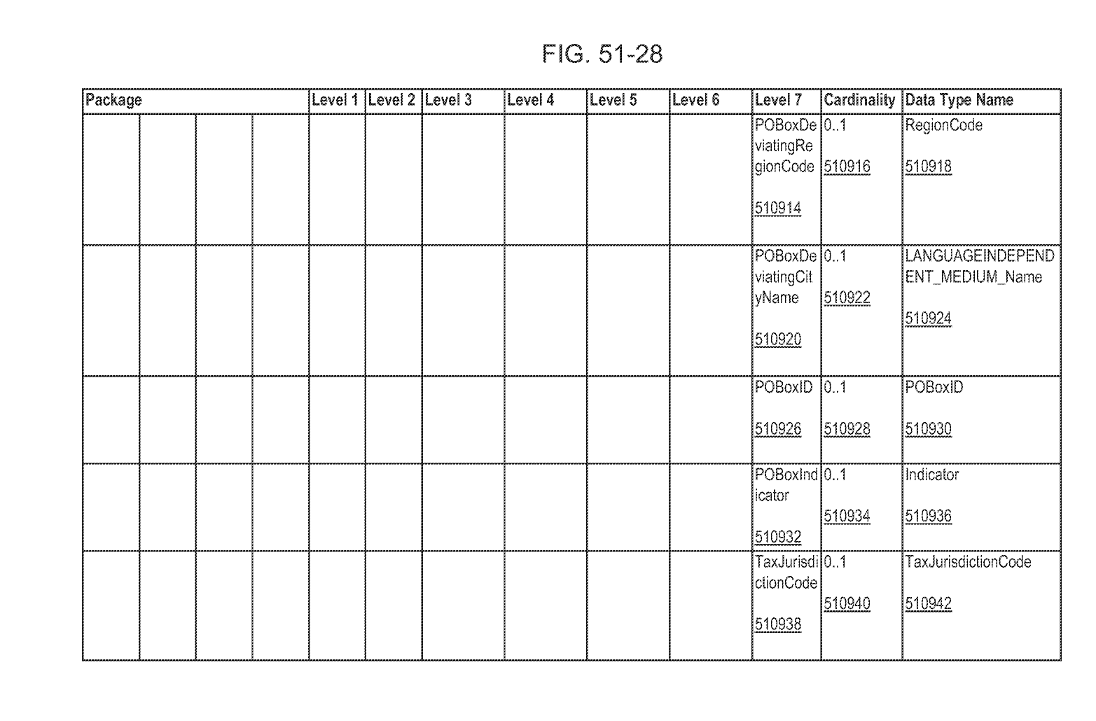

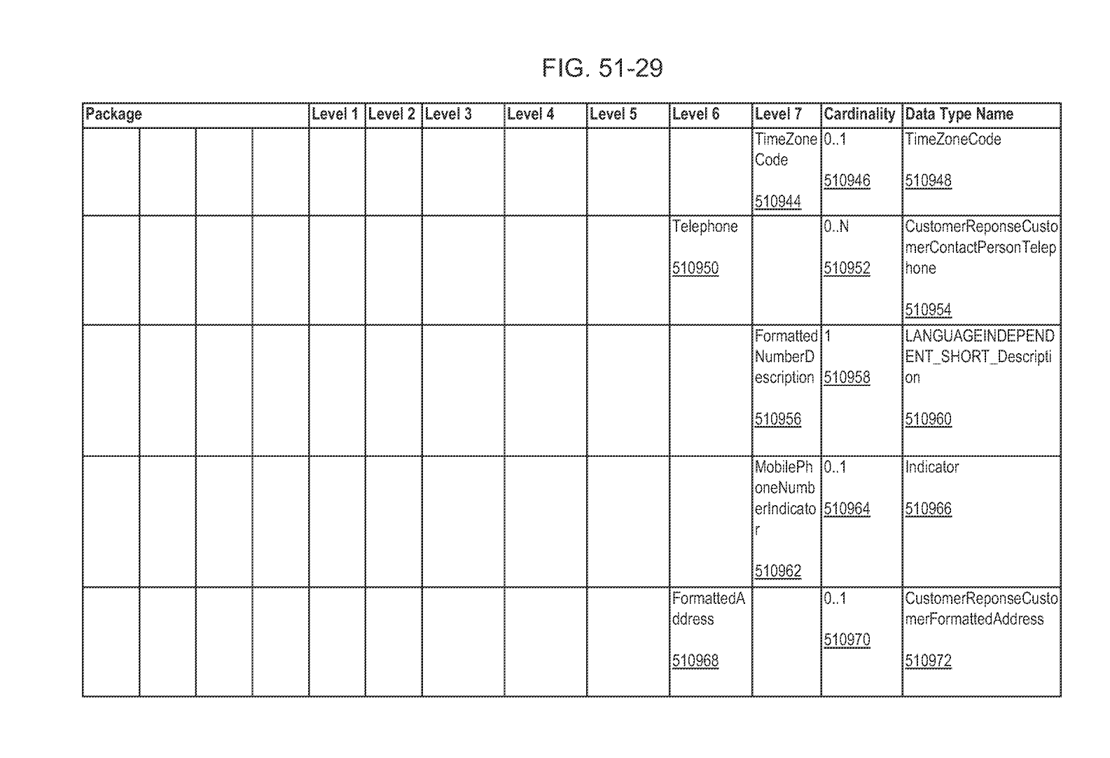

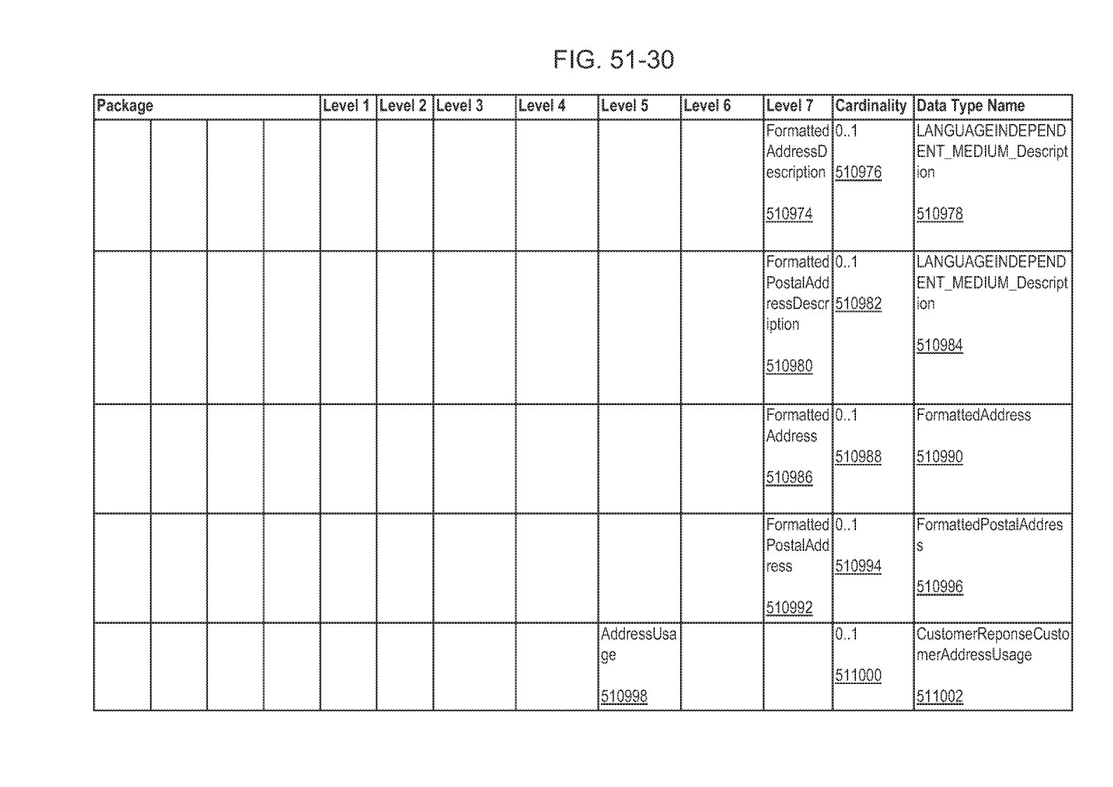

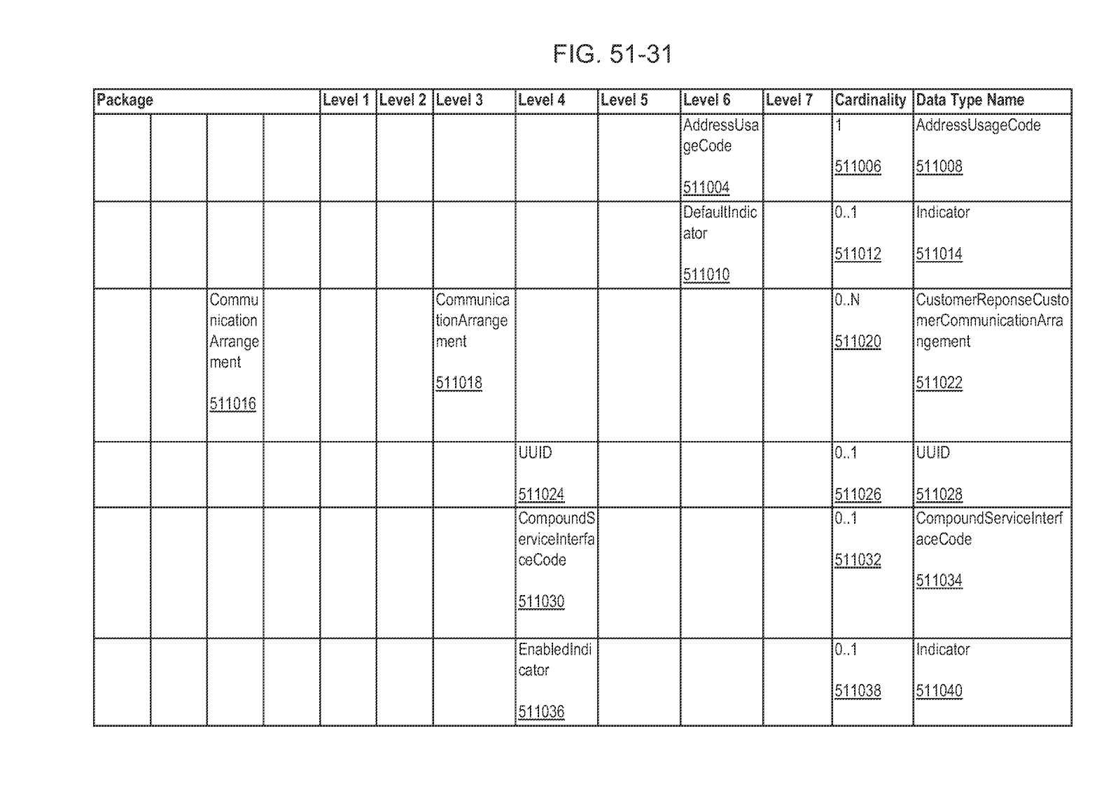

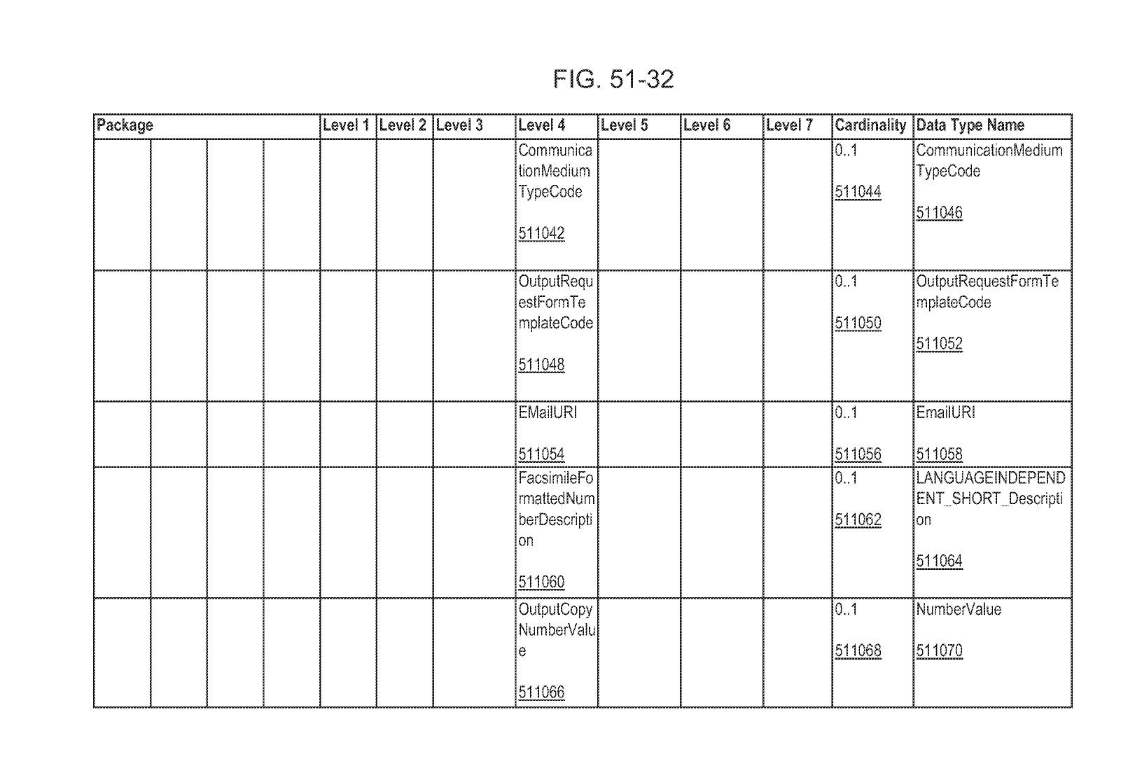

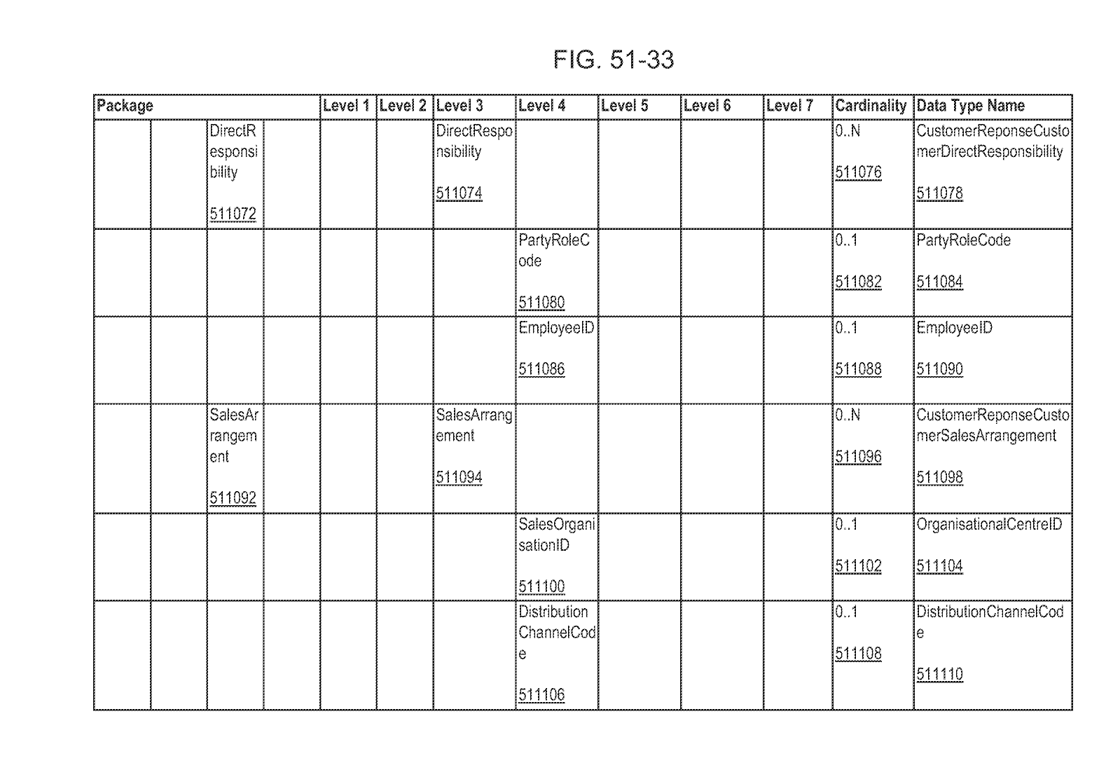

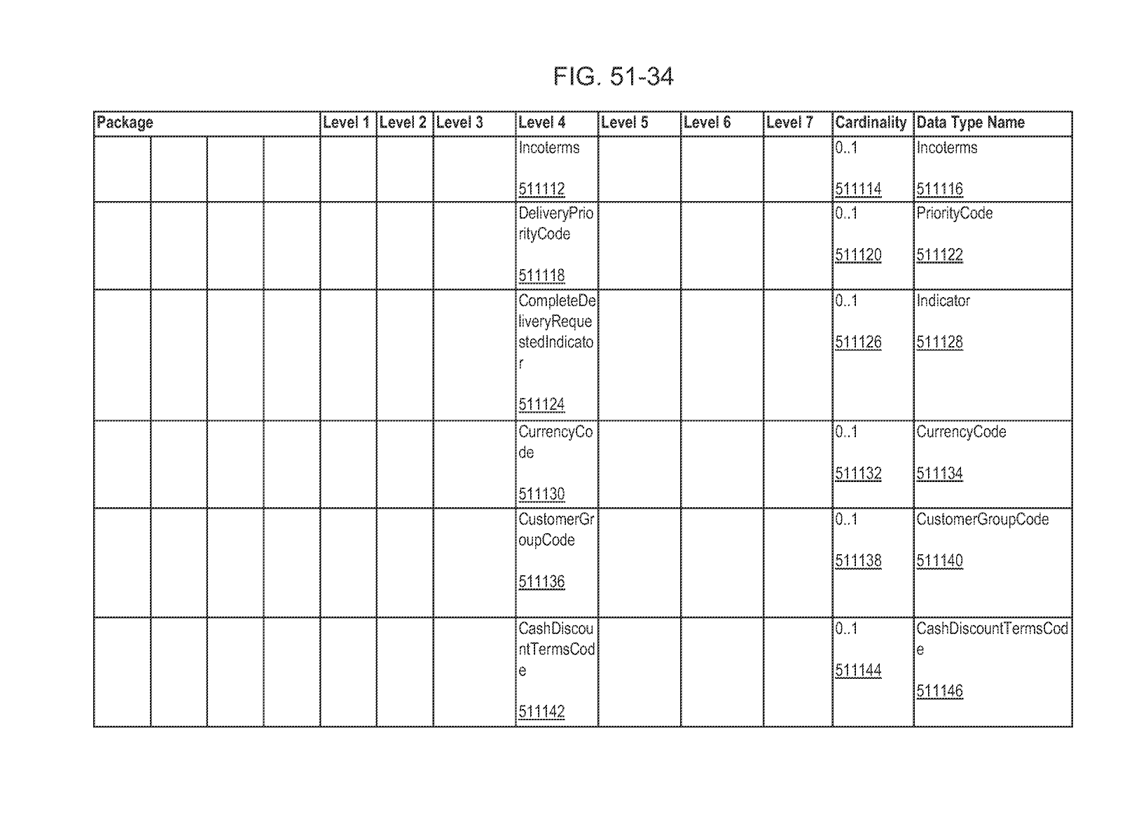

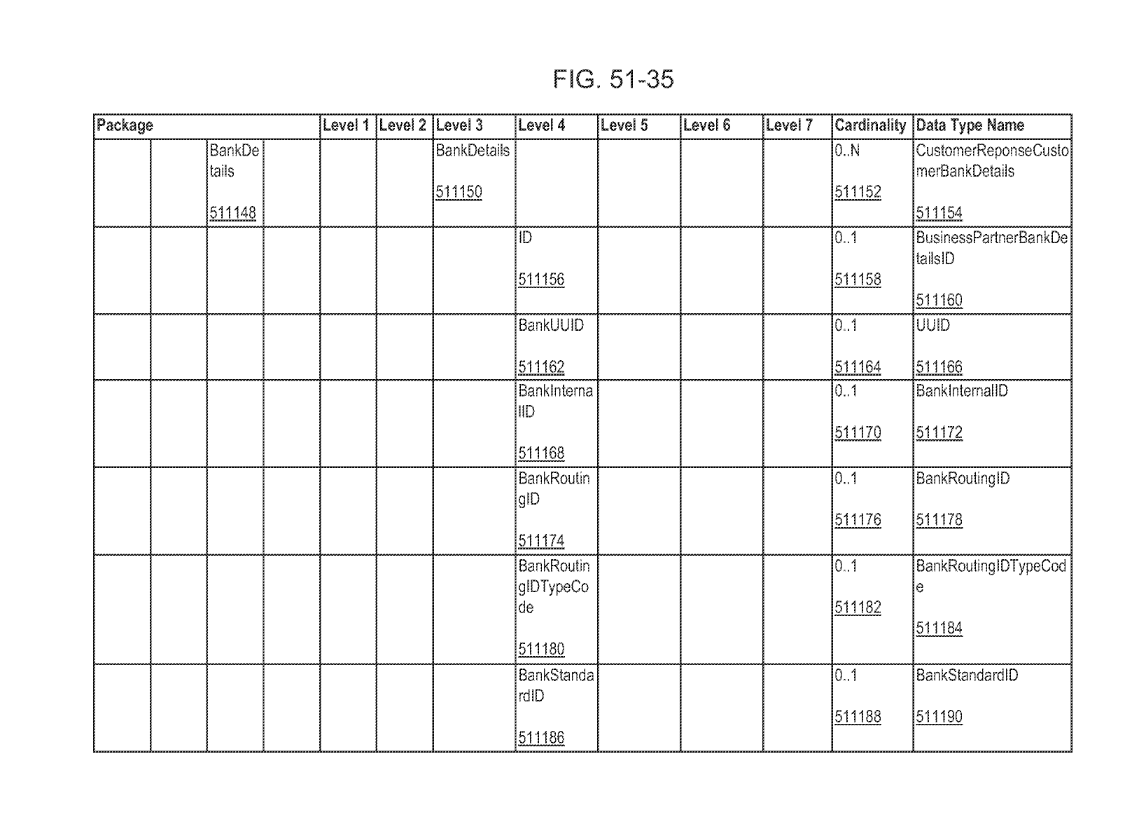

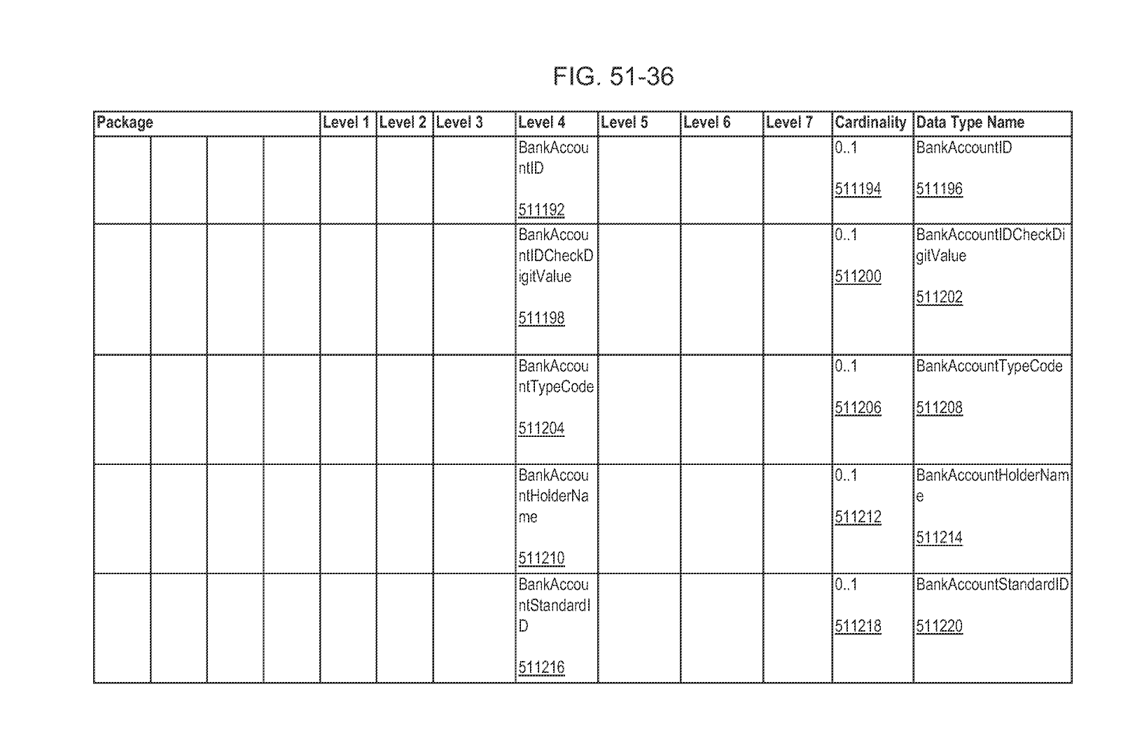

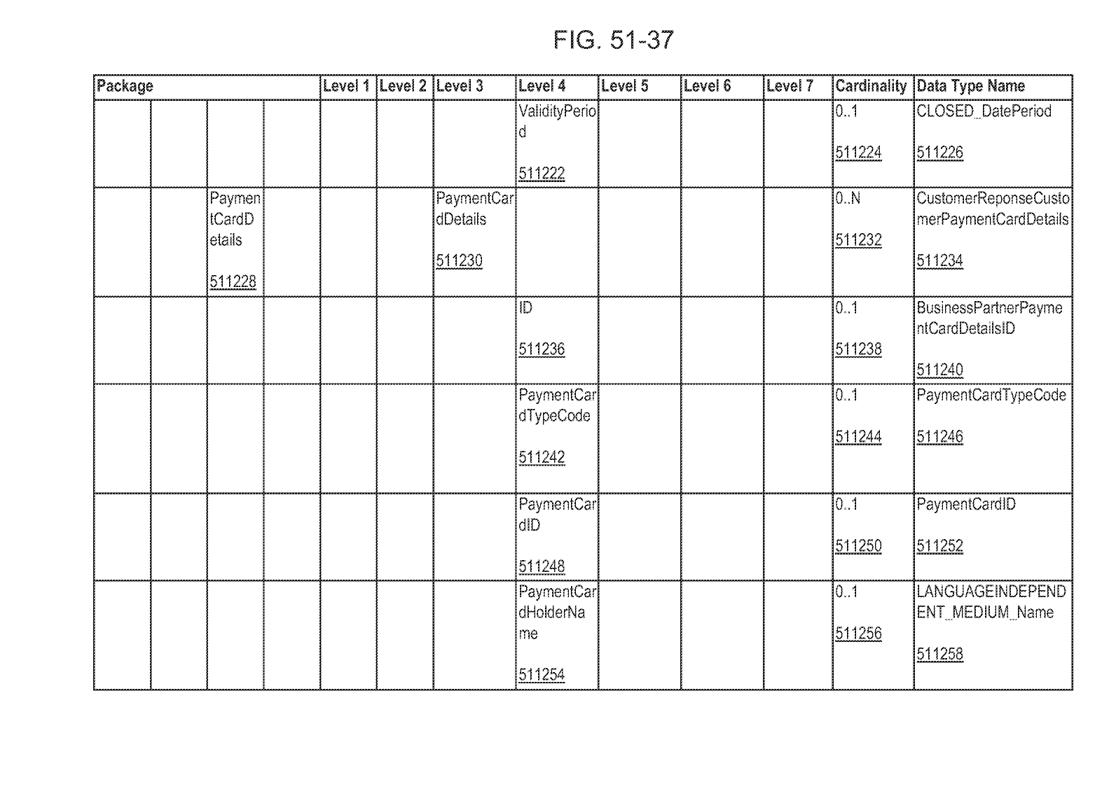

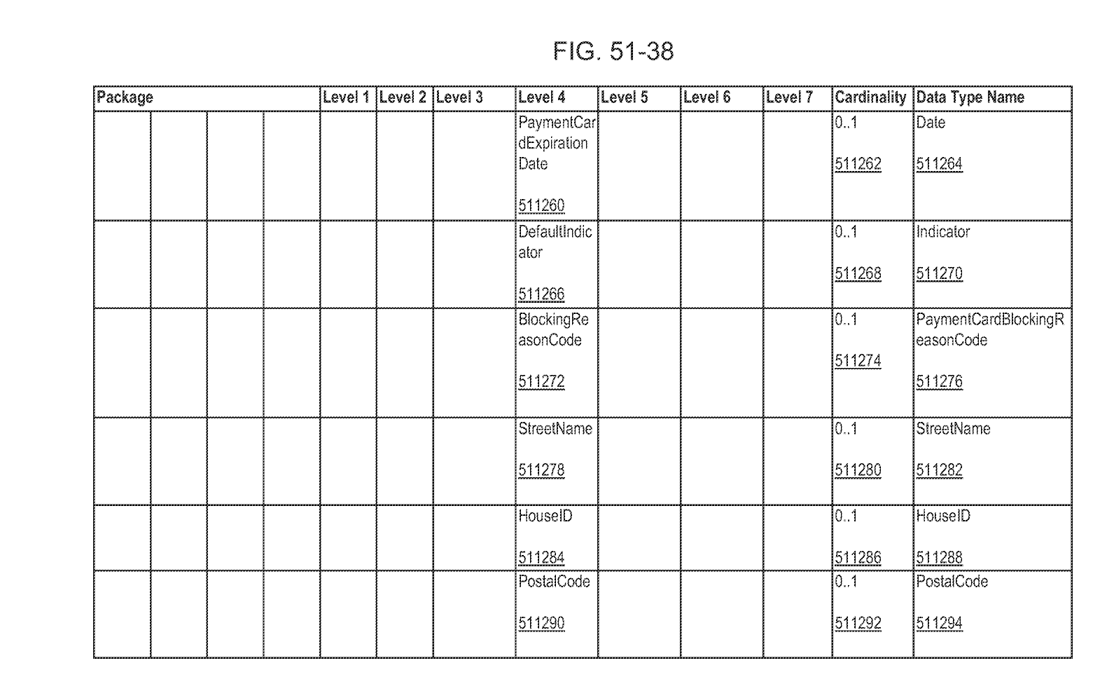

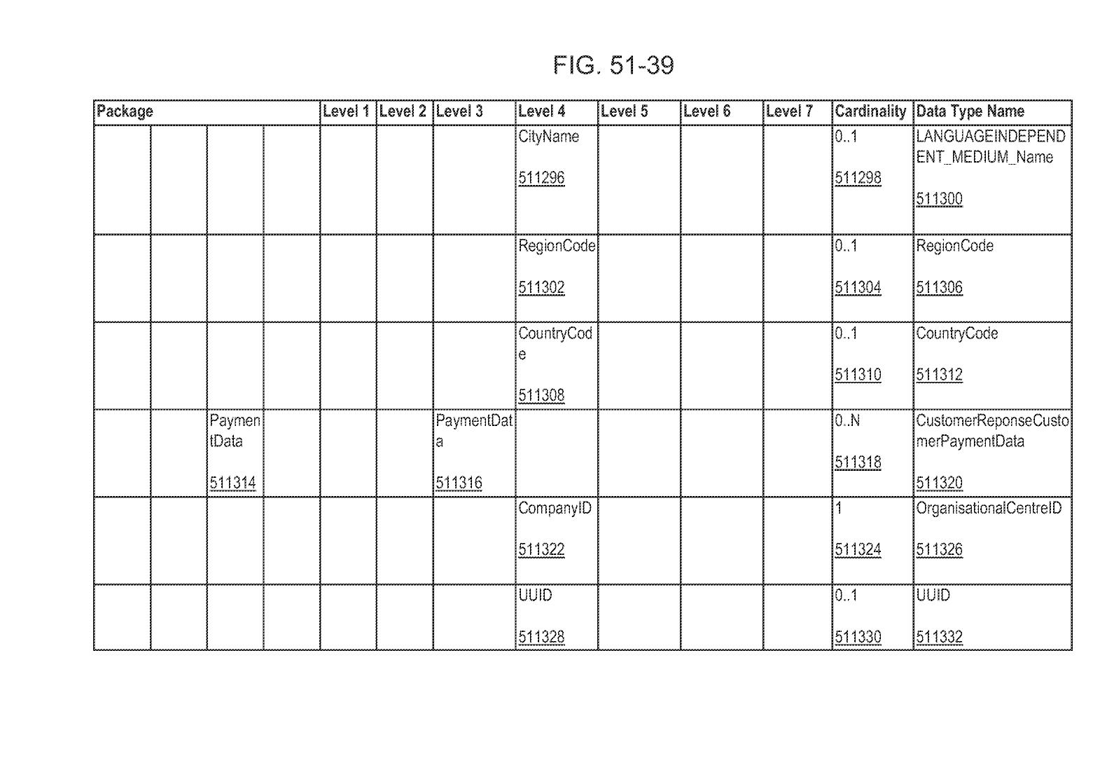

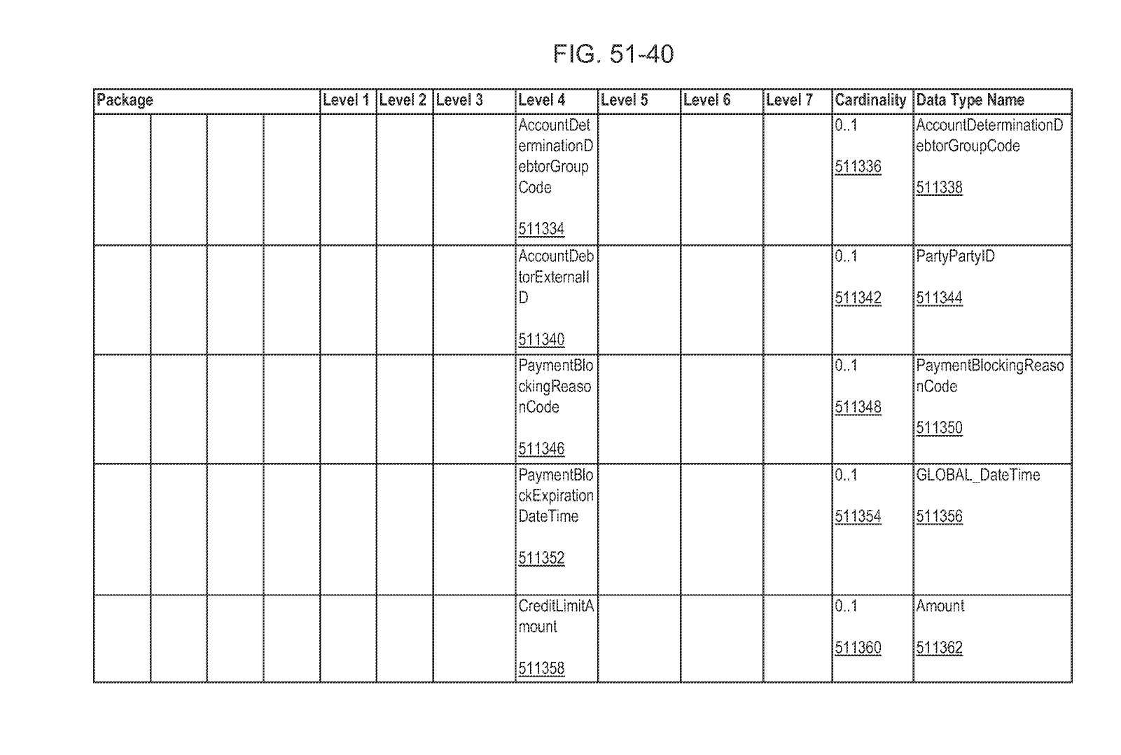

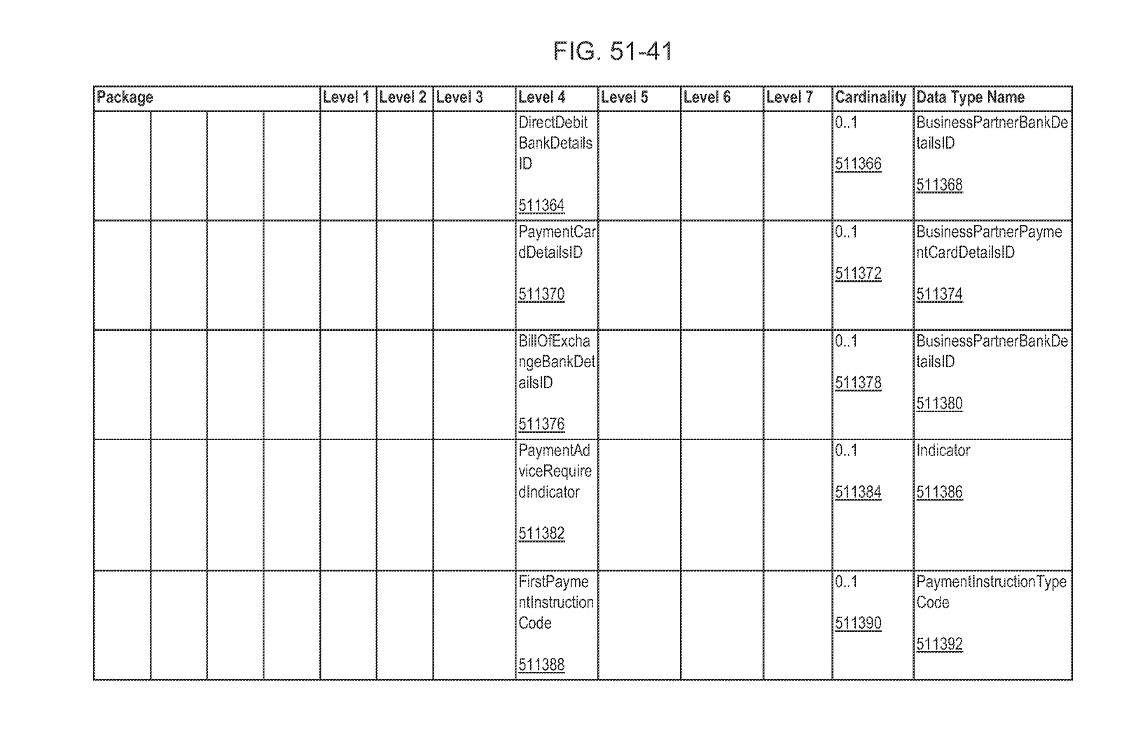

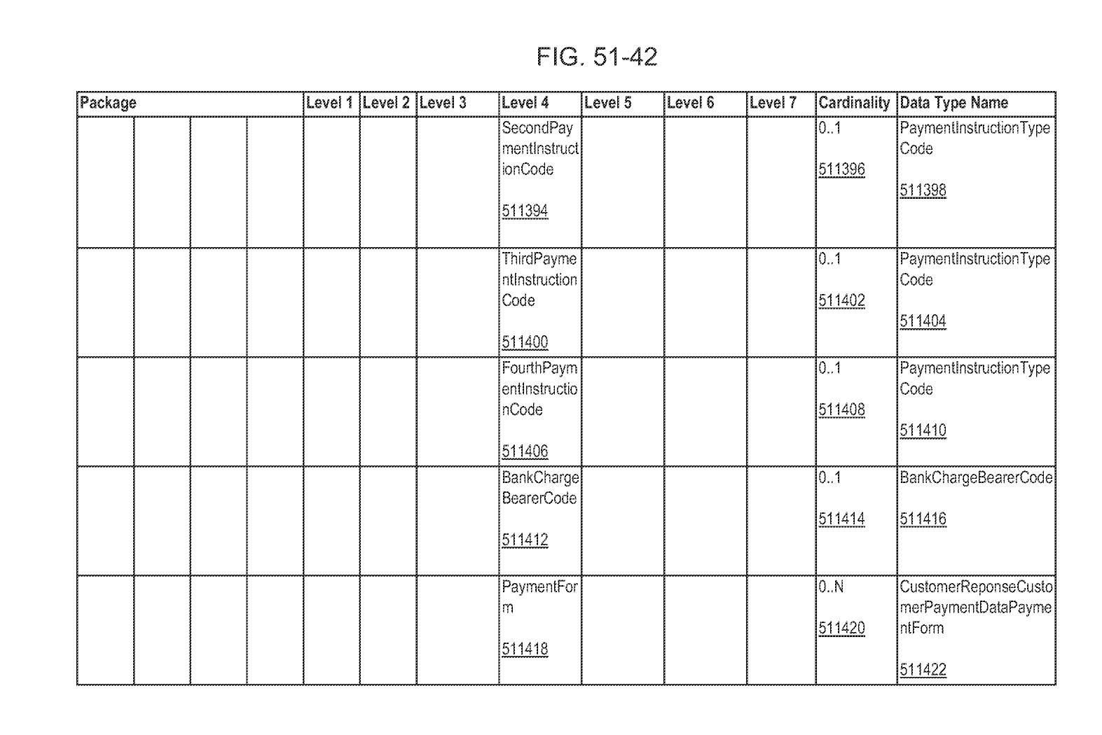

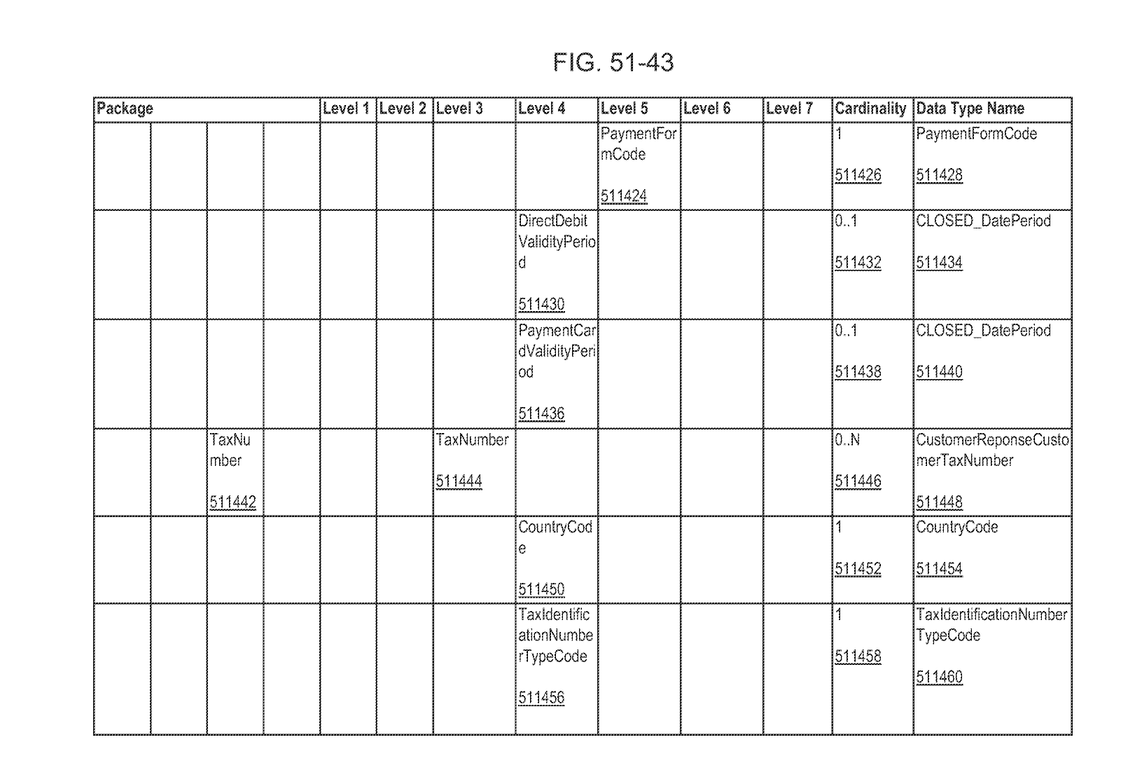

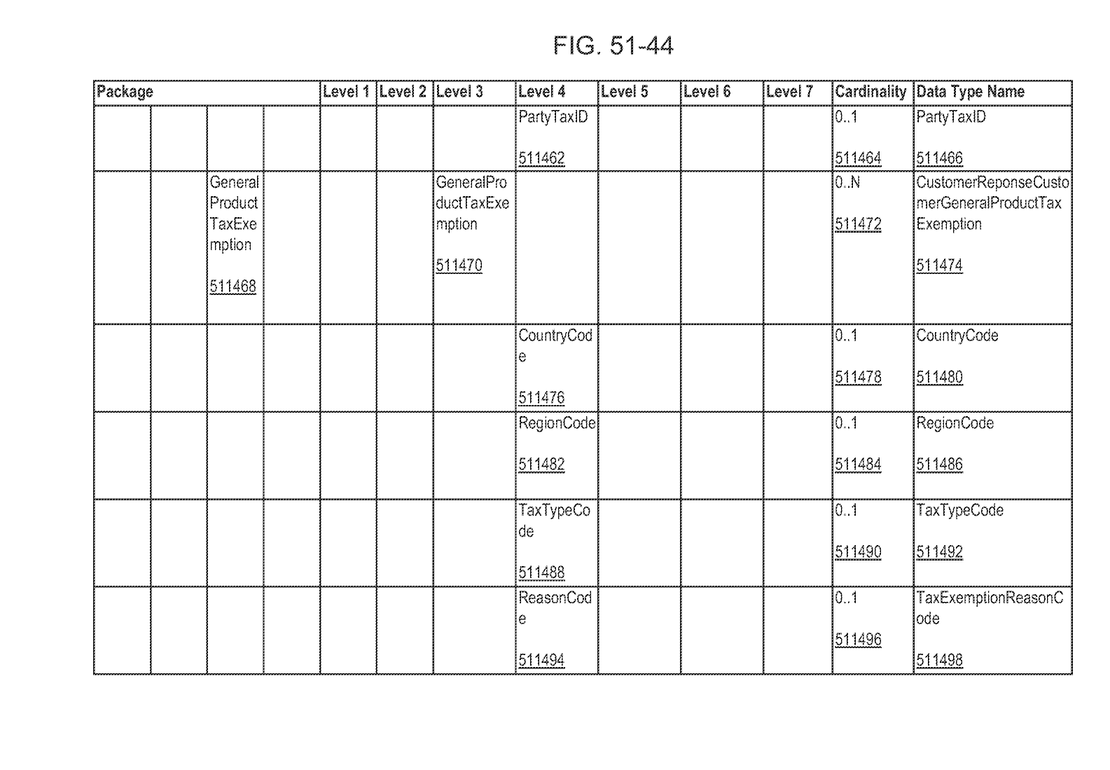

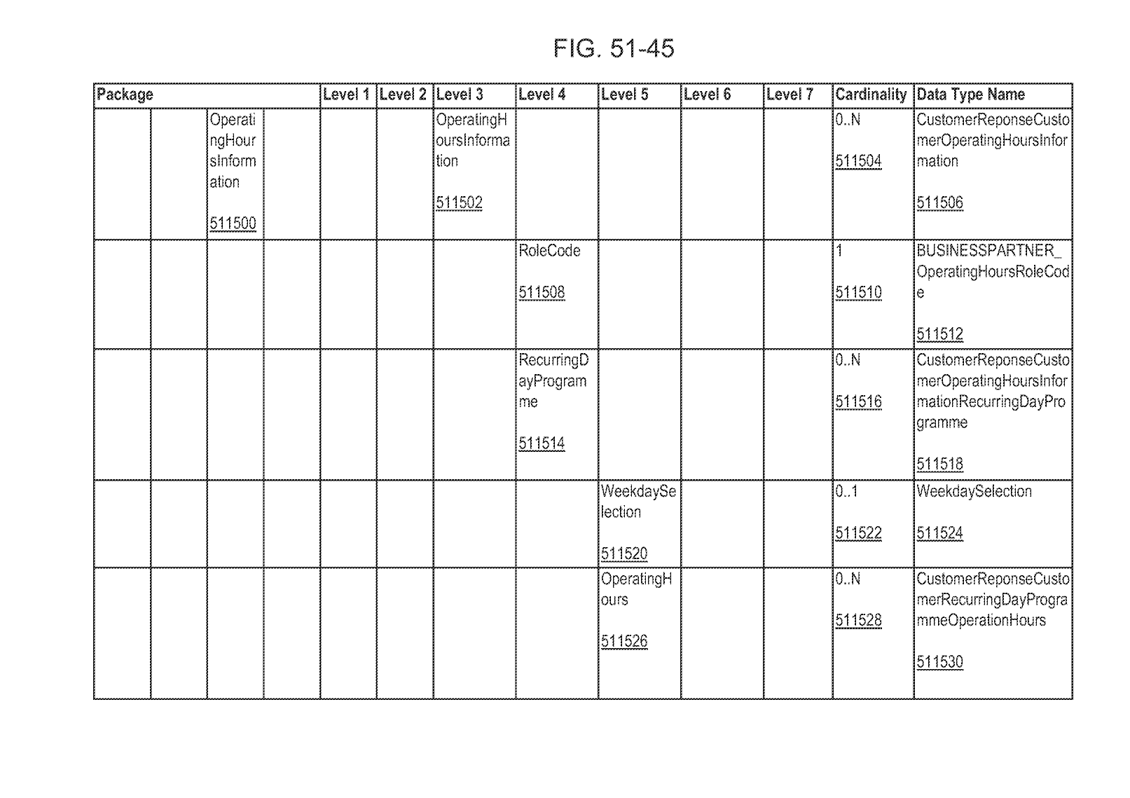

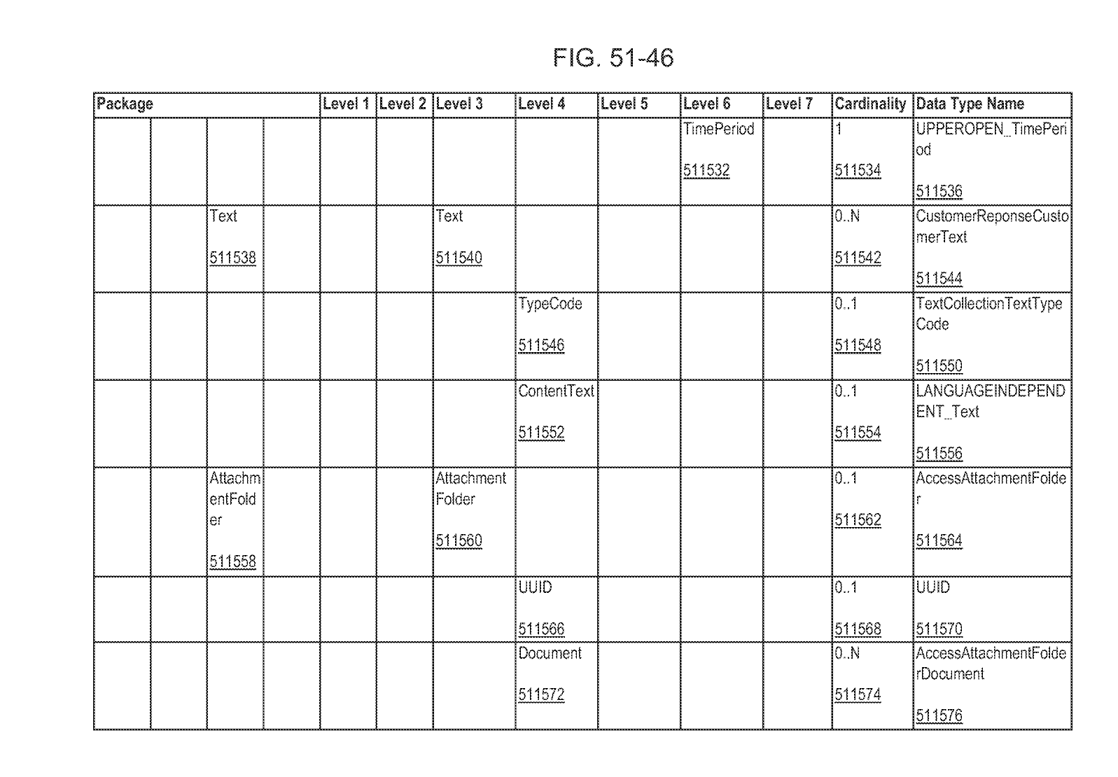

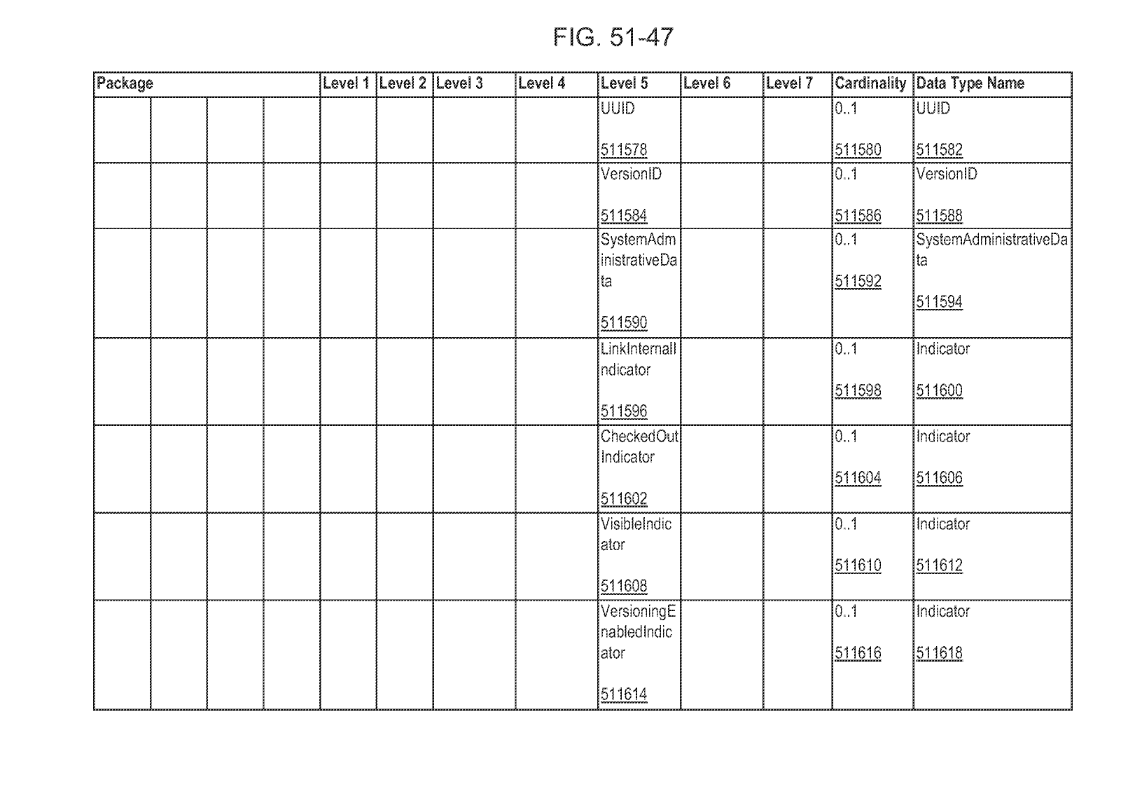

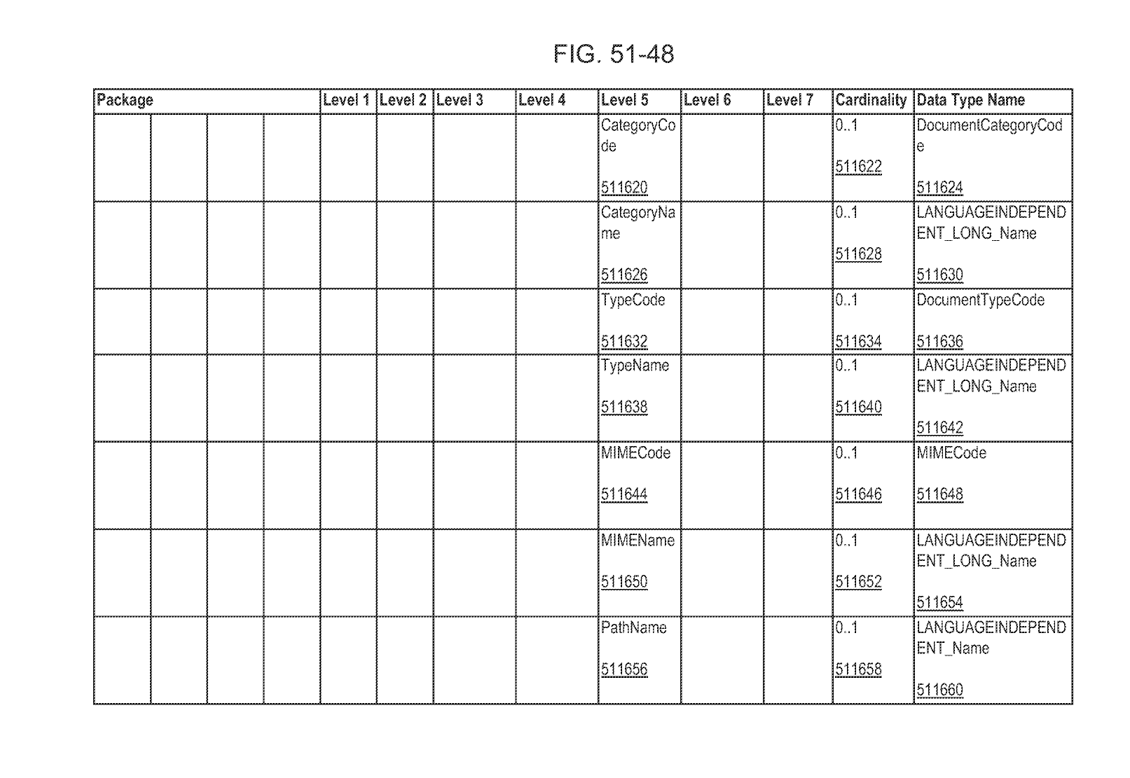

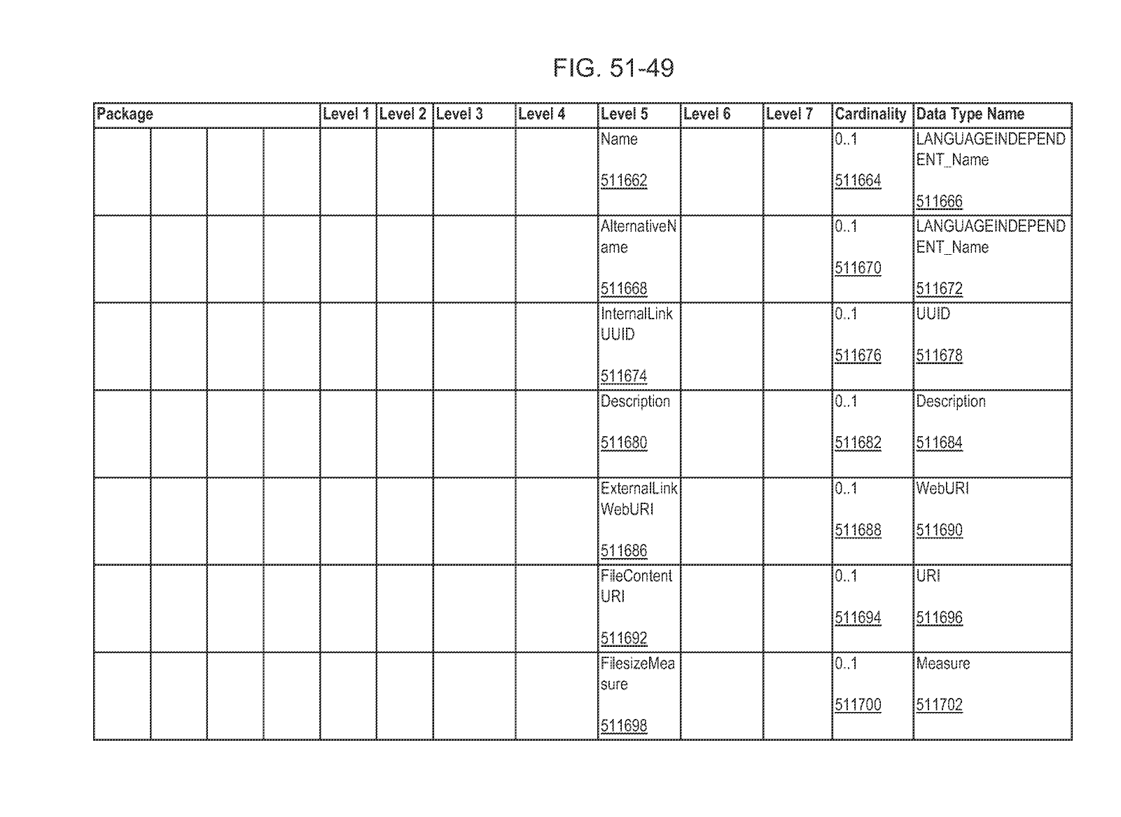

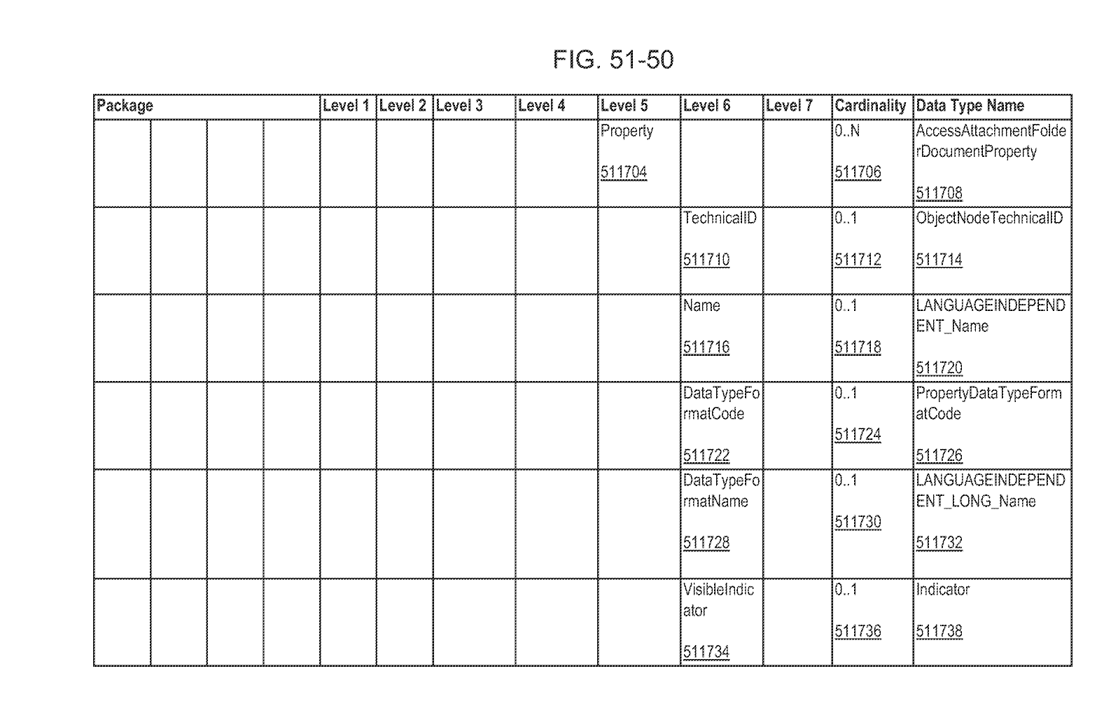

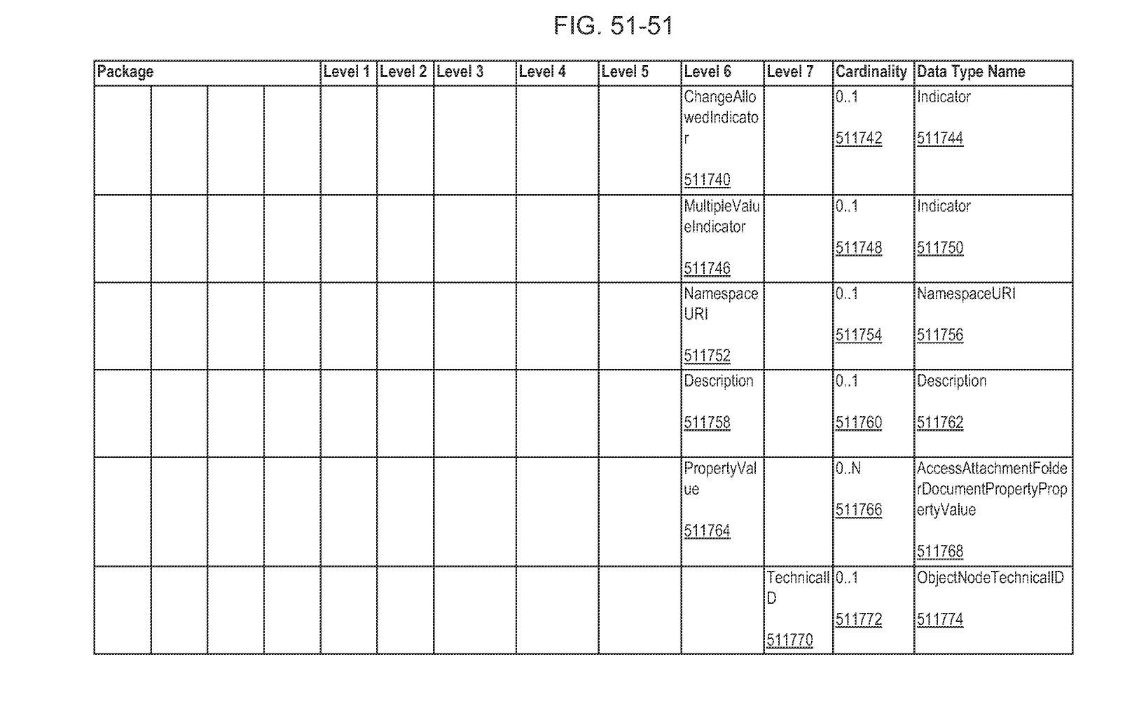

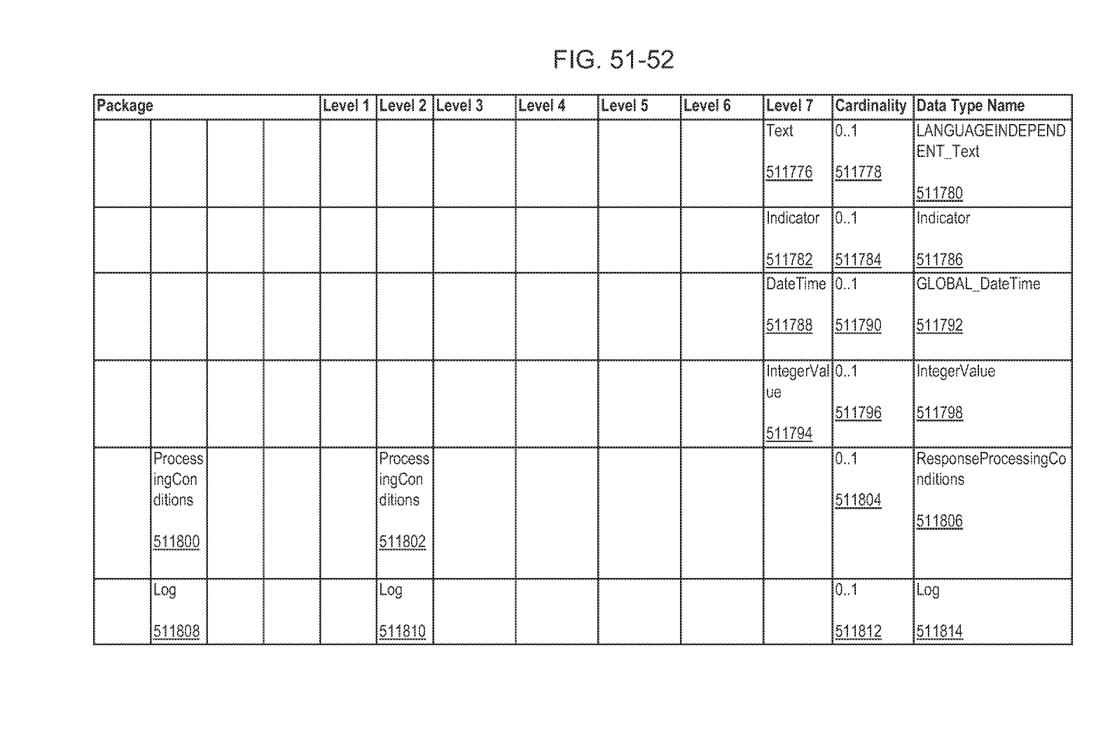

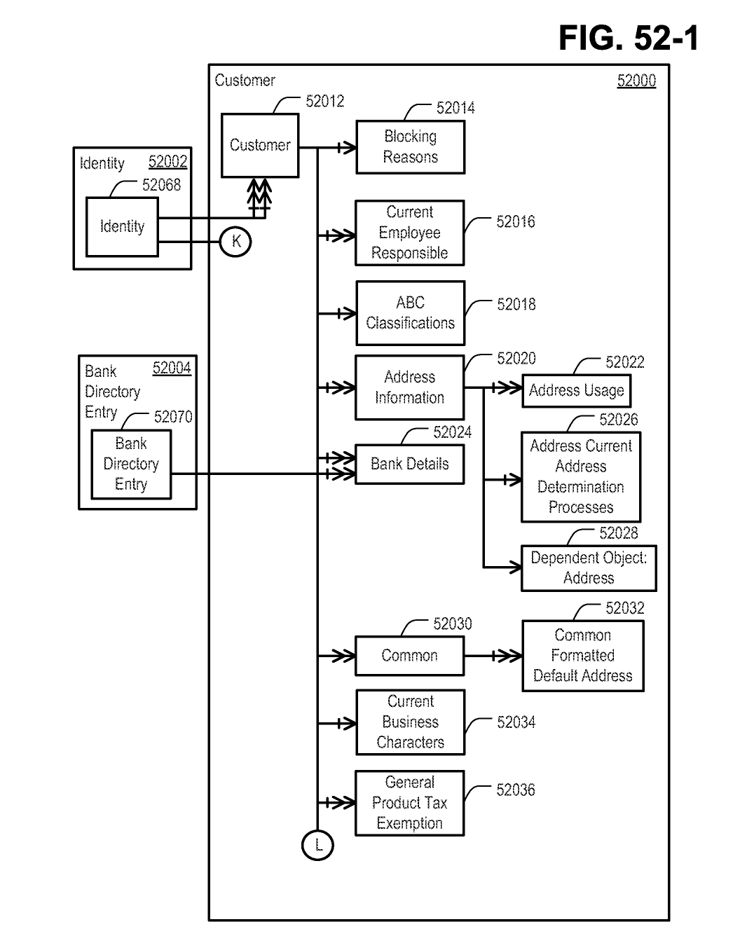

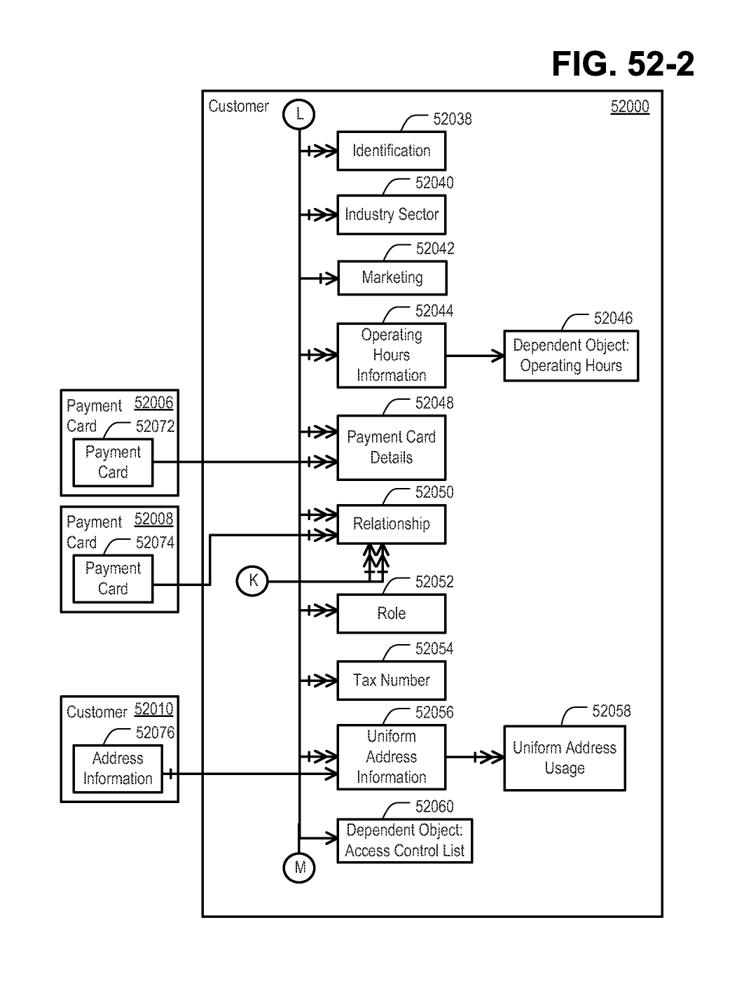

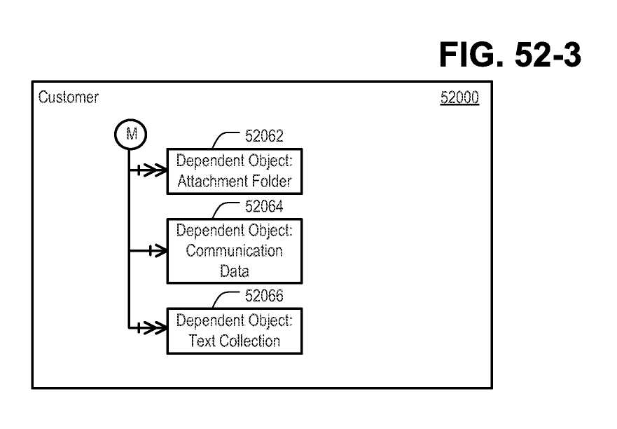

FIGS. 42-1 through 42-65 show an example configuration of an Element Structure that includes a Customer Bundle Maintain Request_sync 420000 package. Specifically, these figures depict the arrangement and hierarchy of various components such as one or more levels of packages, entities, and datatypes, shown here as 420000 through 422092. As described above, packages may be used to represent hierarchy levels. Entities are discrete business elements that are used during a business transaction. Data types are used to type object entities and interfaces with a structure. For example, the Customer Bundle Maintain Request_sync 420000 includes, among other things, a Customer Bundle Maintain Request_sync 420002. Accordingly, heterogeneous applications may communicate using this consistent message configured as such.

FIGS. 43-1 through 43-2 show an example configuration of an Element Structure that includes a CustomerBundleMaintainConfirmation_sync 43000 package. Specifically, these figures depict the arrangement and hierarchy of various components such as one or more levels of packages, entities, and datatypes, shown here as 43000 through 43044. As described above, packages may be used to represent hierarchy levels. Entities are discrete business elements that are used during a business transaction. Data types are used to type object entities and interfaces with a structure. For example, the CustomerBundleMaintainConfirmation_sync 43000 includes, among other things, a CustomerBundleMaintainConfirmation_sync 43002. Accordingly, heterogeneous applications may communicate using this consistent message configured as such.

FIGS. 44-1 through 44-65 show an example configuration of an Element Structure that includes a Customer Bundle Maintenance Check Request_sync 440000 package. Specifically, these figures depict the arrangement and hierarchy of various components such as one or more levels of packages, entities, and datatypes, shown here as 440000 through 442092. As described above, packages may be used to represent hierarchy levels. Entities are discrete business elements that are used during a business transaction. Data types are used to type object entities and interfaces with a structure. For example, the Customer Bundle Maintenance Check Request_sync 440000 includes, among other things, a Customer Bundle Maintenance Check Request_sync 440002. Accordingly, heterogeneous applications may communicate using this consistent message configured as such.

FIGS. 45-1 through 45-2 show an example configuration of an Element Structure that includes a CustomerBundleMaintenanceCheckConfirmation_sync 45000 package. Specifically, these figures depict the arrangement and hierarchy of various components such as one or more levels of packages, entities, and datatypes, shown here as 45000 through 45044. As described above, packages may be used to represent hierarchy levels. Entities are discrete business elements that are used during a business transaction. Data types are used to type object entities and interfaces with a structure. For example, the CustomerBundleMaintenanceCheckConfirmation_sync 45000 includes, among other things, a CustomerBundleMaintenanceCheckConfirmation_sync 45002. Accordingly, heterogeneous applications may communicate using this consistent message configured as such.

FIGS. 46-1 through 46-17 show an example configuration of an Element Structure that includes a CustomerByCommunicationDataQuery_sync 46000 package. Specifically, these figures depict the arrangement and hierarchy of various components such as one or more levels of packages, entities, and datatypes, shown here as 46000 through 46472. As described above, packages may be used to represent hierarchy levels. Entities are discrete business elements that are used during a business transaction. Data types are used to type object entities and interfaces with a structure. For example, the CustomerByCommunicationDataQuery_sync 46000 includes, among other things, a CustomerByCommunicationDataQuery_sync 46002. Accordingly, heterogeneous applications may communicate using this consistent message configured as such.

FIGS. 47-1 through 47-52 show an example configuration of an Element Structure that includes a Customer By Communication Data Response_sync 470000 package. Specifically, these figures depict the arrangement and hierarchy of various components such as one or more levels of packages, entities, and datatypes, shown here as 470000 through 471814. As described above, packages may be used to represent hierarchy levels. Entities are discrete business elements that are used during a business transaction. Data types are used to type object entities and interfaces with a structure. For example, the Customer By Communication Data Response_sync 470000 includes, among other things, a Customer By Communication Data Response_sync 470002. Accordingly, heterogeneous applications may communicate using this consistent message configured as such.

FIGS. 48-1 through 48-28 show an example configuration of an Element Structure that includes a CustomerByElementsQuery_sync 48000 package. Specifically, these figures depict the arrangement and hierarchy of various components such as one or more levels of packages, entities, and datatypes, shown here as 48000 through 48794. As described above, packages may be used to represent hierarchy levels. Entities are discrete business elements that are used during a business transaction. Data types are used to type object entities and interfaces with a structure. For example, the CustomerByElementsQuery_sync 48000 includes, among other things, a CustomerByElementsQuery_sync 48002. Accordingly, heterogeneous applications may communicate using this consistent message configured as such.

FIGS. 49-1 through 49-52 show an example configuration of an Element Structure that includes a Customer By Elements Response_sync 490000 package. Specifically, these figures depict the arrangement and hierarchy of various components such as one or more levels of packages, entities, and datatypes, shown here as 490000 through 491814. As described above, packages may be used to represent hierarchy levels. Entities are discrete business elements that are used during a business transaction. Data types are used to type object entities and interfaces with a structure. For example, the Customer By Elements Response_sync 490000 includes, among other things, a Customer By Elements Response_sync 490002. Accordingly, heterogeneous applications may communicate using this consistent message configured as such.

FIGS. 50-1 through 50-15 show an example configuration of an Element Structure that includes a CustomerByIdentificationQuery_sync 50000 package. Specifically, these figures depict the arrangement and hierarchy of various components such as one or more levels of packages, entities, and datatypes, shown here as 50000 through 50412. As described above, packages may be used to represent hierarchy levels. Entities are discrete business elements that are used during a business transaction. Data types are used to type object entities and interfaces with a structure. For example, the CustomerByIdentificationQuery_sync 50000 includes, among other things, a CustomerByIdentificationQuery_sync 50002. Accordingly, heterogeneous applications may communicate using this consistent message configured as such.

FIGS. 51-1 through 51-52 show an example configuration of an Element Structure that includes a Customer By Identification Response_sync 510000 package. Specifically, these figures depict the arrangement and hierarchy of various components such as one or more levels of packages, entities, and datatypes, shown here as 510000 through 511814. As described above, packages may be used to represent hierarchy levels. Entities are discrete business elements that are used during a business transaction. Data types are used to type object entities and interfaces with a structure. For example, the Customer By Identification Response_sync 510000 includes, among other things, a Customer By Identification Response_sync 510002. Accordingly, heterogeneous applications may communicate using this consistent message configured as such.

FIGS. 52-1 through 52-3 collectively illustrate an example object model for a Customer business object 52000. Specifically, the object model depicts interactions among various components of the Customer business object 52000, as well as external components that interact with the Customer business object 52000 (shown here as 52002 through 52010, and 52068 through 52076). The Customer business object 52000 includes elements 52012 through 52066, which can be hierarchical, as depicted. For example, the Customer 52012 hierarchically includes entities 52014 through 52020, among others. Some or all of the entities 52012 through 52066 can correspond to packages and/or entities in the message data types described below.

The business object Customer is a business partner to whom materials or services are offered or provided. The Customer business object belongs to the process component Business Partner Data Management. The Customer business object belongs to the deployment unit Foundation. The Customer business object is a projection of Business Partner_Template. Customers can be external or internal. In addition to general business partner data, such as address data, roles, relationship data, and bank details, a Customer business object can include data that is used for sales processes. The business object Customer has an object category of Master Data Object and a technical category of Standard Business Object.

The business object Customer is involved in the following process component interactions: Business Partner Data Management_External Business Partner Data Management_Customer Maintenance Notification, BusinessPartnerDataManagement_External Business Partner Data Management_Processing, Data Migration System_Business Partner Data Management_Customer, External Business Partner Data Management_Business Partner Data Management_Customer, External Business Partner Data Management_Business Partner Data Management_Maintain Customer, External Business Partner Data Management_Business Partner Data Management_Manage Customer, External Business Partner Data Management_Business Partner Data Management_Query Customer, and External E-Commerce System_Business Partner Data Management.

A service interface Customer Maintenance Notification Out has a technical name of BusinessPartnerDataManagementCustomerMaintenanceNotificationOut. The service interface Customer Maintenance Notification Out is part of the process component interaction Business Partner Data Management_External Business Partner Data Management_Customer Maintenance Notification, and is an interface to send notifications of customer master data maintenance to a relevant third party consumer.

A Notify of Customer Maintenance operation has a technical name of BusinessPartnerDataManagementCustomerMaintenanceNotificationOut.NotifyOfCustomer Maintenance, can be used to notify a relevant third party consumer about new or changed customer master data, and can be based on a message type Customer Maintenance Notification that is derived from the business object Customer.

A service interface Customer Replication In has a technical name of BusinessPartnerDataManagementCustomerReplicationIn. The service interface Customer Replication In is part of the following process component interactions:Data Migration System_Business Partner Data Management_Customer, and External Business Partner Data Management_Business Partner Data Management_Customer. The service interface Customer Replication In is an interface to migrate or replicate customer master data from a source system or file to a target system. A Replicate Customer operation has a technical name of BusinessPartnerDataManagementCustomerReplicationIn.ReplicateCustomer, can be used to create or update customer master data in a target system, using customer master data from a source system or file, and can be based on a message type Customer Replicate Request that is derived from the business object Customer.

A service interface Manage Customer In has a technical name of ManageCustomerIn. The service interface Manage Customer In is part of the following process component interactions: External Business Partner Data Management_Business Partner Data Management_Maintain Customer, External Business Partner Data Management_Business Partner Data Management_Manage Customer, and External E-Commerce System_Business Partner Data Management. The service interface Manage Customer In is an interface to migrate customer master data from a source system or file. A Check Maintain Bundle_V1 operation has a technical name of ManageCustomerIn.CheckMaintainBundle_V1, can be used to check if customer master data can be created, updated, or deleted without errors, and can be operation is based on a message type Customer Bundle Maintenance Check Confirmation_sync_V1 that is derived from the business object Customer and on a message type Customer Bundle Maintenance Check Request_sync_V 1 that is derived from the business object Customer.

A Maintain Bundle_V1 operation has a technical name of ManageCustomerIn.MaintainBundle_V1, can be used to create, update, or delete customer master data, and can be based on a message type Customer Bundle Maintain Confirmation_sync_V1 that is derived from the business object Customer and on a message type Customer Bundle Maintain Request_sync_V1 that is derived from the business object Customer. A Manage Customer In Check Maintain as Bundle operation has a technical name of ManageCustomerin.CheckMaintainBundle, can be used to check if customer master data can be created or updated without errors, and can be based on a message type Customer Bundle Check Maintain Confirmation_sync and on a message type Customer Bundle Check Maintain Request_sync that is derived from the business object Customer. A Manage Customer In Create Customer For Groupware has a technical name of ManageCustomerIn.CreateCustomerForGroupware, can be used to enable newly created Accounts via groupware, and can be based on a message type Create Customer For Groupware Request_Sync that is derived from the business object Customer and on a message type CustomerCreateCustomerFromGroupwareConfirmation_sync that is derived from the business object Customer. A Manage Customer In Maintain as Bundle operation has a technical name of ManageCustomerin.MaintainBundle, can be used to create, update, or delete customer master data, and can be based on a message type Customer Bundle Maintain Confirmation_sync derived from business object Customer and on message type Customer Bundle Maintain Request_sync derived from business object Customer. A Manage Customer In Read operation has a technical name of ManageCustomerin.Read, can be used to read customer master data, and can be based on message type Customer By ID Query_sync and on message type Customer By ID Response_sync.

A service interface Query Customer In has a technical name of QueryCustomerIn. The service interface Query Customer In is part of the following process component interactions: External Business Partner Data Management_Business Partner Data Management_Query Customer, and External E-Commerce System_Business Partner Data Management. The service interface Query Customer In can be used to query customer master data. A Find By Communication Data operation has a technical name of QueryCustomerin.FindByCommunicationData, can be used to find customer data by communication data, and can be based on message type Customer By Communication Data Query_sync derived from business object Customer, and on message type Customer By Communication Data Response_sync derived from business object Customer. A Find By Elements operation has a technical name of QueryCustomerin.FindByElements, can be used to find customer data by elements, and can be based on message type Customer By Elements Query_sync derived from business object Customer and on message type Customer By Elements Response_sync derived from business object Customer. A Find By Identification operation has a technical name of QueryCustomerIn.FindByIdentification, can be used to find customer data by identification, and can be based on message type Customer By Identification Query_sync derived from business object Customer.

The operation is based on message type Customer By Identification Response_sync derived from business object Customer. A FindSimpleByBusinessObjectCustomer operation has a technical name of QueryCustomerIn.FindSimpleByBusinessObjectCustomer, and can be based on message type CustomerSimpleByBusinessObjectCustomerQuery_sync derived from business object Customer and on message type CustomerSimpleByBusinessObjectCustomerResponse_sync derived from business object Customer.

A Query Contact In Find Simple By Contact Data operation has a technical name of QueryCustomerIn.FindSimpleByContactData, and can be based on message type Contact By Contact Data Request_sync derived from business object Business Partner, and on message type Contact By Contact Data Response_sync derived from business object Business Partner. A Query Customer In Find Simple By Communication Data operation has a technical name of QueryCustomerIn.FindSimpleByCommunicationData, can be used to search for customers according to communication data, and can be based on message type CustomerSimpleByCommunicationDataQuery_sync and on message type CustomerSimpleByCommunicationDataResponse_sync. A Query Customer In Find Simple By Customer Data operation has a technical name of QueryCustomerIn.FindSimpleByCustomerData, and can be based on message type Customer By Customer Data Query_sync derived from business object Customer and on message type Customer By Customer Data Response_sync derived from business object Customer. A Query Customer In Find Simple By Identification has a technical name of QueryCustomerIn.FindSimpleByIdentification, can be used to search for customers according to identification data, and can be based on message type CustomerSimpleByIdentificationQuery_sync and on message type CustomerSimpleByIdentificationResponse_sync. A Query Customer In Find Simple By Identification And Address operation has a technical name of QueryCustomerIn.FindSimpleByIdentificationAndAddress, can be used to search for customers according to identification and address data, and can be based on message type CustomerSimpleByIdentificationAndAddressQuery_sync and on message type CustomerSimpleByldentificationAndAddressResponse_sync. A Query Customer In Find Simple By Names And Key Words has a technical name of QueryCustomerIn.FindSimpleByNamesAndKeyWords, can be used to search for customers according to names and key words, and can be based on message type CustomerSimpleByNamesAndKeyWordsQuery_sync and on message type CustomerSimpleByNamesAndKeyWordsResponse_sync.

A service interface Replicate Customer Address To CoD ERP ADRUPD IDOC Out has a technical name of BusinessPartnerDataManagementReplicateCustomerAddressToCoDERPADRUPDIDOCOut. The service interface Replicate Customer Address To CoD ERP ADRUPD IDOC Out is part of the process component interaction BusinessPartnerDataManagement_External Business Partner Data Management_Processing, and can be used to replicate address master data to an enterprise resource planning (ERP) target system consuming ADRUPD IDocs, which are address master intermediate documents. An ADRUPD.ADRUPD01 operation has a technical name of BusinessPartnerDataManagementReplicateCustomerAddressToCoDERPADRUPDIDOCOut.ADRUPD.ADRUPD01.

A service interface Replicate Customer From Adr3mas IDoc In has a technical name of BusinessPartnerDataManagementReplicateCustomerFromAdr3masIDocIn. The service interface Replicate Customer From Adr3mas IDoc In is part of the process component interaction External Business Partner Data Management_Business Partner Data Management_Customer, and is an interface to replicate contact workplace address data from an ERP source system using ADR3MAS IDocs, which are intermediate documents for a workplace address type of “3”. A ADR3MAS.ADR3MAS03 operation has a technical name of BusinessPartnerDataManagementReplicateCustomerFromAdr3masIDocIn.ADR3MAS.ADR 3MAS03, and can be used to create or update workplace address data of a contact from a source ERP system using IDoc information of ADR3MAS03, which is an intermediate document for a workplace address type 3 version 03.

A service interface Replicate Customer From Adrmas IDoc In has a technical name of BusinessPartnerDataManagementReplicateCustomerAddressFromAdrmasIDocIn. The service interface Replicate Customer From Adrmas IDoc In is part of the process component interaction External Business Partner Data Management_Business Partner Data Management_Customer, and is an interface to replicate address master data from an ERP source system consuming ADRMAS IDocs, which are address master intermediate documents. A ADRMAS.ADRMAS03 operation has a technical name of BusinessPartnerDataManagementReplicateCustomerAddressFromAdrmasDocIn.ADRMAS. ADRMAS03, and can be used to create or update address data of a customer from a source ERP system using IDoc information of ADRMAS03, which is an address master intermediate version 03.

A service interface Replicate Customer From Debmas IDoc In has a technical name of BusinessPartnerDataManagementReplicateCustomerFromDebmasIDocIn. The service interface Replicate Customer From Debmas IDoc In is part of the process component interaction External Business Partner Data Management_Business Partner Data Management_Customer, and is an interface to replicate customer master data from an enterprise resource planning ERP source system using DEBMAS IDocs, which are debtor master intermediate documents. A DEBMAS.DEBMAS06 operation has a technical name of BusinessPartnerDataManagementReplicateCustomerFromDebmasIDocIn.DEBMAS.DEBM AS06, and can be used to create or update customer master data from a source ERP system using IDoc information of DEBMAS06, which is a debtor master intermediate document. version 06.

A service interface Replicate Customer To Debmas IDOC Out has a technical name of BusinessPartnerDataManagementReplicateCustomerToDebmasIDOCOut. The service interface Replicate Customer To Debmas IDOC Out is part of the process component interaction BusinessPartnerDataManagement_External Business Partner Data Management_Processing, and is an interface to replicate customer master data to an ERP target system using DEBMAS IDocs, which are debtor master intermediate documents. A DEBMAS.DEBMAS06 operation has a technical name of BusinessPartnerDataManagementReplicateCustomerToDebmasIDOCOut.DEBMAS.DEBM AS06, and can be used to send create or update of customer master data to a target ERP system using IDoc information of DEBMAS06, which is a debtor master intermediate document. version 06.

The Customer business object has a Root node. The elements located directly at the node Customer are defined by the data type BusinessPartnerElements. These elements include: UUID, InternalID, CategoryCode, NumberRangeIntervalBusinessPartnerGroupCode, ActsAsOrganisationalCentreIndicator, CreatedFromOrganisationalCentreIndicator, PartialSystemAdministrativeData, and Status. Status can include Status/LifeCycleStatusCode. UUID may be an alternative key and may be based on datatype GDT: UUID. InternalID may be an alternative key and may be based on datatype GDT: BusinessPartnerInternalID. CategoryCode may be based on datatype GDT: BusinessPartnerCategoryCode. NumberRangeIntervalBusinessPartnerGroupCode may be based on datatype GDT: NumberRangeIntervalBusinessPartnerGroupCode. ActsAsOrganisationalCentreIndicator may be based on datatype GDT: Indicator, with a qualifier of BusinessPartnerActsAsOrganisationalCentre. CreatedFromOrganisationalCentreIndicator may be based on datatype GDT: Indicator, with a qualifier of CreatedFromOrganisationalCentre. PartialSystemAdministrativeData may be based on datatype GDT: SystemAdministrativeData, with a qualifier of Partial. Status may be based on datatype BOIDT: BusinessPartnerStatus. Status/LifeCycleStatusCode is a coded representation of a life cycle status of a business partner, and may be based on datatype GDT: PartyLifeCycleStatusCode.

The following composition relationships to subordinate nodes exist: Blocking Reasons, with a cardinality of 1:C; ABCClassifications, with a cardinality of 1:C; AddressInformation, with a cardinality of 1:CN; Bank Details, with a cardinality of 1:CN; Common, with a cardinality of 1:N; CurrentBusinessCharacters, with a cardinality of 1:C; GeneralProductTaxExemption, with a cardinality of 1:CN; Identification, with a cardinality of 1:CN; IndustrySector, with a cardinality of 1:CN; Marketing, with a cardinality of 1:C; OperatingHoursInformation, with a cardinality of 1:CN; PaymentCardDetails, with a cardinality of 1:CN; Relationship, with a cardinality of 1:CN; Role, with a cardinality of 1:CN; TaxNumber, with a cardinality of 1:CN; UniformAddressInformation, with a cardinality of 1:CN; and Current Employee Responsible, with a cardinality of 1:CN, which may be filtered. The filter elements are defined by the inline structure BUP_S_CURR_EE_RESPONS_FLT_EL. These elements include PartyRoleCode, which may be optional, is a type of responsibility an employee has for a customer, and may be based on datatype GDT: PartyRoleCode.

The following composition relationships to dependent objects exist: AccessControlList, with a cardinality of 1:1, which is a list of access groups that have access to a business partner during a validity period that can be modeled using a dependent object AccessControlList; AttachmentFolder, with a cardinality of 1:CN, which is a Document that includes documents for a business partner and can be mapped using a dependent object AttachmentFolder; CommunicationData, with a cardinality of 1:C, which includes communication data of a business partner including address-independent communication data such as e-mail addresses or cell phone numbers and which can be mapped using a dependent object CommunicationData; and TextCollection, with a cardinality of 1:CN, which includes notes for a business partner and which can be mapped using a dependent object TextCollection.

The following inbound association relationships may exist: CreationIdentity, from the business object Identity/node Identity, with a cardinality of 1:CN, which is an identity that created a business partner; and LastChangeIdentity, from the business object Identity/node Identity, with a cardinality of 1:CN, which is an identity that last changed a business partner.

An Address Snapshot specialization association for navigation may exist to the business object Address Snapshot/node Root, with a target cardinality of C, which is an address snapshot of a business partner at a given point in time, and which may be filtered. The filter elements are defined by the inline structure BUP_S_ADDRESS_SNAPSHOT_FIL_EL. These elements include: PartyRoleCode, PartyRoleCategoryCode, LocationRoleCode, LocationRoleCategoryCode, IsContactPersonForBusinessPartnerUUID, Is ServicePerformerForBusinessPartnerUUID, IntercompanyIndicator, and ValidityDate. PartyRoleCode may be optional and may be based on datatype GDT: PartyRoleCode. PartyRoleCategoryCode may be optional and may be based on datatype GDT: PartyRoleCategoryCode. LocationRoleCode may be optional and may be based on datatype GDT: LocationRoleCode. LocationRoleCategoryCode may be optional and may be based on datatype GDT: LocationRoleCategoryCode. IsContactPersonForBusinessPartnerUUID may be optional and may be based on datatype GDT: UUID. IsServicePerformerForBusinessPartnerUUID may be optional and may be based on datatype GDT: UUID. IntercompanyIndicator may be optional and may be based on datatype GDT: Indicator, with a qualifier of Intercompany. ValidityDate may be optional and may be based on datatype GDT: Date.

An Address Snapshot With Name Only specialization association for navigation may exist to the business object Address Snapshot/node Root, with a target cardinality of C, which is an address snapshot that includes a business partner name at a given point in time, and which may be filtered. The filter elements are defined by the inline structure BUP_S_ASNAPSHOT_NAME_ONLY_F_EL. These elements include ValidityDate, which may be optional and may be based on datatype GDT: Date.

A Business Partner Duplicate Check specialization association for navigation may exist to the business object Business Partner Duplicate Check/node Business Partner Duplicate Check, with a target cardinality of 1, which is an association to a business partner duplicate check that has been created with an action CheckForDuplicates. The following specialization associations for navigation may exist to the business object Business Partner Relationship/node Root: DefaultHasContactPersonBusinessPartnerRelationship, with a target cardinality of C; which is a default contact person that is assigned to a selected business partner; DefaultlsContactPersonForBusinessPartnerRelationship, with a target cardinality of C, which is a default business partner of a contact person; and Business Partner Relationship, with a target cardinality of CN, which can be filtered, which represents relationships that are assigned to a selected business partner. The filter elements are defined by the inline structure BUP_S_BP_REL_FILTER_ELEMENTS. These elements include: RoleCode and DefaultIndicator. RoleCode may be optional, is a filter restriction on a role that a business partner has in a relationship to a related business partner, and may be based on datatype GDT: BusinessPartnerRelationshipRoleCode. DefaultIndicator may be optional, indicates whether only a default relationship is read, may be used with relationship types that support a default, and may be based on datatype GDT: Indicator, with a qualifier of Default.

A Communication Arrangement specialization association for navigation may exist to the business object Communication Arrangement/node Communication Arrangement, with a target cardinality of C, which can be used for direct access to a related Communication Arrangement. The following specialization associations for navigation may exist to the node Address Information Current Default Address Information, with a target cardinality of C, which is an association with a currently-valid standard address; and Address Information by Party Address Determination, with a target cardinality of CN, which may be filtered, and which returns those addresses assigned at a particular point in time to an address determination process. The filter elements are defined by the inline structure BUP_S_ADDR_INF_PTY_ADDR_DET_EL. These elements include: PartyAddressDeterminationCode, AddressUsageValidityDate, and AddressUsageDefaultIndicator. PartyAddressDeterminationCode may be optional, indicates an address determination process for which addresses are to be determined, and may be based on datatype GDT: PartyAddressDeterminationCode. AddressUsageValidityDate may be optional, is a date for determining an assignment, and may be based on datatype GDT: Date. AddressUsageDefaultIndicator may be optional, indicates whether only one address is returned, and may be based on datatype GDT: Indicator. If the AddressUsageDefaultIndicator flag is not set and several addresses are returned, then a first address is an address that has been maintained as a standard address.

The following specialization associations can exist: Default Industry Sector, to the node Industry Sector, with a target cardinality of C, which is an association with a standard industry of a standard industry system; Current Common, to the node Common, with a target cardinality of 1, which is an association with currently-valid general information for a business partner; and Current Common Formatted Default Address, to the node Common Formatted Default Address, with a target cardinality of C, which is an association with a currently-valid formatted standard address for a business partner.

An Identification by Party identifier Category specialization association for navigation may exist to the node Identification, with a target cardinality of CN, which may be filtered, and which returns alternative identifiers for a PartyidentifierCategory. The filter elements are defined by the inline structure BUP_S_IDENT_BY_PTY_ID_CAT_EL. These elements include PartyidentifierCategoryCode, which may be optional, indicates a PartyidentifierCategory for which alternative identifiers are to be determined, and may be based on datatype GDT: PartyidentifierCategoryCode. An Identification Dun and Bradstreet Number specialization association for navigation may exist to the node Identification, with a target cardinality of C, which is an association for a Dun and Bradstreet ID number.

An Operating Hours Information by Operating Hours Role specialization association for navigation may exist to the node Operating Hours Information, with a target cardinality of CN, may be filtered, and returns a specified type of operating hours. The filter elements are defined by the inline structure APC_S_OP_HOURS_BY_OPH_ROLE. These elements include OperatingHoursRoleCode, which may be optional, specifies a type of business hours to be determined, and may be based on datatype GDT: BUSINESSPARTNER_OperatingHoursRoleCode.

The following specialization associations for navigation may exist to the node Relationship: Current Default Has Contact Person, with a target cardinality of C, which is an association with a currently-valid business partner relationship used in a specialization “Has Contact Person” and which is flagged as a standard contact person; Current Default Has Service Performer, with a target cardinality of C, which is an association with a currently-valid business partner relationship used in a specialization “Has Service Performer” and which is flagged as a standard service performer; Current Default is Contact Person For, with a target cardinality of C, which is for direct access to a current default relationship of type “Is Contact Person For”; Current Default is Service Performer For, with a target cardinality of C, which is an association with a currently-valid business partner relationship used in a specialization “Is Service Performer For” and which is flagged as a standard service performer; Current Has Contact Person, with a target cardinality of CN, which can be used for direct access to current relationships of type “Has Contact Person”; Current Has Service Performer, with a target cardinality of CN; which is an association with currently-valid business partner relationships used in a specialization “Has Service Performer”; Current is Contact Person For, with a target cardinality of CN, which is an association with currently-valid business partner relationships used in a specialization “Is Contact Person For”, and which is a directed contact person relationship from person to organization; Current is Service Performer For, with a target cardinality of CN, which is an association with currently-valid business partner relationships used in a specialization “Is Service Performer For”; Has Contact Person, with a target cardinality of CN, which is an association with business partner relationships used in a specialization “Has Contact Person”, and which is a directed contact person relationship from organization to person; Has Service Performer, with a target cardinality of CN, which is an association with business partner relationships used in a specialization “Has Service Performer”; Is Contact Person For, with a target cardinality of CN, which is an association with business partner relationships used in a specialization “Is Contact Person For”, and which is a directed contact person relationship from person to organization; Is Service Performer For, with a target cardinality of CN; which is an association with service performer relationships used in a specialization “Is Service Performer For”; and Relationship by Role Code, with a target cardinality of CN, which returns those addresses assigned to a RoleCode that is assigned to a business partner at a particular point in time, and which may be filtered.

The filter elements are defined by the inline structure BUP_S_RELSHP_BY_RL_CODE_EL. These elements include: RoleCode, RelationshipValidityDate, and RelationshipTimeDependentInformationDefaultIndicator. RoleCode may be optional, defines roles for which relationships are to be determined, and may be based on datatype GDT: BusinessPartnerRelationshipRoleCode. RelationshipValidityDate may be optional, is a date for determining an assignment, and may be based on datatype GDT: Date. RelationshipTimeDependentInformationDefaultIndicator may be optional, and if set, then only one relationship is returned. If, for a point in time RelationshipValidityDate, a relationship in the subnode RelationshipTimeDependentInformation is indicated as a default relationship, then the relationship is returned, otherwise no relationship is returned. If RelationshipTimeDependentInformationDefaultIndicator has not been set, then those relationships that are valid at the point in time RelationshipValidityDate are returned for a specified RoleCode. RelationshipTimeDependentInformationDefaultIndicator may be based on datatype GDT: Indicator.

A Role by Business Character specialization association for navigation may exist to the node Role, with a target cardinality of CN, which returns those roles assigned at a particular point in time to a business partner and which are grouped by a specific business character, and which may be filtered. The filter elements are defined by the inline structure APC_S_ROLE_BY_BUS_CHAR. These elements include: BusinessCharacterCode and RoleValidityDate. BusinessCharacterCode may be optional, indicates a business character for which one or more roles of a business partner are to be determined, and may be based on datatype GDT: BUSINESSPARTNER_PartyBusinessCharacterCode. RoleValidityDate may be optional, is a date for determining an assignment, and may be based on datatype GDT: Date.

A Current Uniform Address Information by Address Types specialization association for navigation may exist to the node Uniform Address Information, with a target cardinality of CN, which returns a business partner address within a uniform format, and which may be filtered. The filter elements are defined by the inline structure BUP_S_CUR_UN_ADDR_BY_ADDR. These elements include: MasterDataMainAddressIndicator, OnlyDefaultMasterDataMainAddressIndicator, CommunicationDataIndicator, RelationshipContactPersonWorkplaceAddressIndicator, OnlyDefaultRelationshipContactPersonWorkplaceAddressIndicator, RelationshipContactPersonOnlyDefaultWorkplaceAddressIndicator, RelationshipServicePerformerWorkplaceAddressIndicator, OnlyDefaultRelationshipServicePerformerWorkplaceAddressIndicator, RelationshipServicePerformerOnlyDefaultWorkplaceAddressIndicator, and ProtectedAddressExcludeIndicator. MasterDataMainAddressIndicator may be optional, specifies if a business partner main addresses is to be shown, and may be based on datatype GDT: Indicator. OnlyDefaultMasterDataMainAddressIndicator may be optional, specifies if only a default of a business partner main addresses is to be shown, and may be based on datatype GDT: Indicator. CommunicationDataIndicator may be optional, specifies if communication data is to be shown, and may be based on datatype GDT: Indicator. RelationshipContactPersonWorkplaceAddressIndicator may be optional, specifies if workplace addresses of contact person relationships are to be shown, and may be based on datatype GDT: Indicator. OnlyDefaultRelationshipContactPersonWorkplaceAddressIndicator may be optional, specifies if only workplace addresses of a default contact person relationship are to be shown, and may be based on datatype GDT: Indicator. RelationshipContactPersonOnlyDefaultWorkplaceAddressIndicator may be optional, specifies if only default workplace addresses of contact person relationships are to be shown, and may be based on datatype GDT: Indicator. RelationshipServicePerformerWorkplaceAddressIndicator may be optional, specifies if workplace addresses of service performer relationships are to be shown, and may be based on datatype GDT: Indicator. OnlyDefaultRelationshipServicePerformerWorkplaceAddressIndicator may be optional, specifies if only workplace addresses of a default service performer relationship are to be shown, and may be based on datatype GDT: Indicator. RelationshipServicePerformerOnlyDefaultWorkplaceAddressIndicator may be optional, specifies if only default workplace addresses of service performer relationships are to be shown, and may be based on datatype GDT: Indicator. ProtectedAddressExcludeIndicator may be optional, specifies that protected addresses are not shown, and may be based on datatype GDT: Indicator, with a qualifier of Exclude.

An Object identifier Mapping specialization association for navigation may exist to the business object Object identifier Mapping/node Root, with a target cardinality of CN, which is an identifier mapping of a business partner, and which may be filtered. The filter elements are defined by the inline structure BUP_S_OBJECT_ID_MAPPING_FLT_EL. These elements include: RemoteBusinessSystemUUID and RemoteidentifierDefiningSchemeCode. RemoteBusinessSystemUUID may be optional, is a universally unique identifier of a business system where an object identified with Remote Object ID exists, and may be based on datatype GDT: UUID. RemoteidentifierDefiningSchemeCode may be optional, is a scheme code of a Remote Object ID, and may be based on datatype GDT: identifierDefiningSchemeCode.

The following specialization associations for navigation may exist: Corresponding Organisational Centre, to the business object Organisational Centre/node Organisational Centre, with a target cardinality of C, which is an organizational center that represents a same entity as a business partner; Payment Agreement, to the business object Payment Agreement/node Payment Agreement, with a target cardinality of CN, which can be used for direct access to related Payment Agreements; Customer Current Direct Employee Responsibility, to the business object Responsibility/node Single Responsibility Parameter Value Range, with a target cardinality of CN, which represents employees currently directly responsible for a customer; Sales Arrangement, to the business object Sales Arrangement/node Sales Arrangement, with a target cardinality of CN, for direct access to related Sales Arrangements; and Sales Organisation Independent Sales Arrangement, to the business object Sales Arrangement/node Sales Arrangement, with a target cardinality of C, for direct access to a related Sales Arrangement that does not depend on a Sales Organisation.

In some implementations, the elements ActsAsOrganisationalCentreIndicator, CreatedFromOrganisationalCentreIndicator and LifeCycleStatusCode are read only. In some implementations, the association CorrespondingOrganisationalCentre is active when the element ActsAsOrganisationalCentreIndicator is set. In some implementations, a category for the business objects Supplier, House Bank, Clearing House and Tax Authority is Organization. In some implementations, a category for the business object Employee is Person.

An Activate action can be used to change a status from “In Preparation” to “Active”. A Destroy action can be used to change a status from “Obsolete” to “Deleted”. A Block action can be used to change a status to “Blocked”. A Check For Duplicates action can be used to perform a duplicate check using a transformed object BusinessPartnerDuplicateCheck. As a result of the Check for Duplicates action, an instance of the transformed object BusinessPartnerDuplicateCheck can be created and the element BusinessPartnerUUID of the root node can be filled with the UUID of a business partner for which the action is performed. Search criteria can be taken from a business partner, and a duplicate check can be performed. The action elements are defined by the data type BusinessPartnerCheckForDuplicatesActionElements. These elements include: ConsumerContextBusinessPartnerTypeCode, ConsumerContextBusinessCharacterCode, SearchForPersonsIndicator, SearchForOrganisationsIndicator, and SearchForGroupsIndicator. ConsumerContextBusinessPartnerTypeCode may be optional, is a coded representation of a business partner type that specifies a context of a consumer, and may be based on datatype GDT: BusinessObjectTypeCode. ConsumerContextBusinessCharacterCode may be optional, represents a business character that specifies a context of a consumer, and may be based on datatype GDT: BUSINESSPARTNER_PartyBusinessCharacterCode. SearchForPersonsIndicator may be optional, indicates whether a business partner with a category “person” is included in a duplicate check, and may be based on datatype GDT: Indicator, with a qualifier of SearchForPersons. SearchForOrganisationsIndicator may be optional, indicates whether a business partner with a category of “organization” is included in a duplicate check, and may be based on datatype GDT: Indicator, with a qualifier of SearchForOrganisations. SearchForGroupsIndicator may be optional, indicates whether a business partner with a category of “group” is included in a duplicate check, and may be based on datatype GDT: Indicator, with a qualifier of SearchForGroups.

A Create Customer From Existing Business Partner action can be used to create a customer from an existing business partner. A Customer can be created using the business object Customer. If a customer to create exists already as a business partner but not as customer, the Create Customer From Existing Business Partner action can be used. The Create Customer From Existing Business Partner action may be performed by a user interface, an inbound agent, and other business objects. The action elements are defined by the inline structure BUP_S_CR_CUST_FROM_EX_BP_EL. These elements include: InternalID, UUID, and RoleCode. InternalID may be optional, is an internal number of a business partner to be created as a customer, and may be based on datatype GDT: BusinessPartnerInternalID. UUID may be optional, is a universal unique identifier of a business partner to be created as a customer, and may be based on datatype GDT: UUID. RoleCode represents a role to be added to a business partner, and may be based on datatype GDT: BusinessPartnerRoleCode, and can include BusinessPartnerRoleCodes belonging to a business character assigned to the business object Customer.

A FlagAsObsolete action can be used to change a status to “Obsolete”. A RevokeObsolescence action can be used to change a status from “Obsolete” to “Blocked”. An Unblock action can be used to change a status from “Blocked” to “Active”.

A Query By Address query returns a list of business partners that belong to a derived business object for which the query is executed. The street, house number, location and postal code of an address can be selected as selection parameters. The query elements are defined by the data type BusinessPartnerAddressQueryElements. These elements include: AddressDefaultIndicator, AddressPostalAddressCityName, AddressPostalAddressPostalCode, AddressPostalAddressStreetName, AddressPostalAddressHouseID, AddressPostalAddressCountryCode, ABCClassificationsCompetitorABCClassificationCode, ABCClassificationsSalesAndServicePartnerABCClassificationCode, InternalID, RoleCode, UUID, CategoryCode, BusinessPartnerName, BusinessPartnerAdditionalName, CommonSortingFormattedName, CommonKeyWordsText, CommonAdditionalKeyWordsText, CreatedSinceDate, LifeCycleStatusCode, ValidityDate, and SearchText. If AddressDefaultIndicator set, then only those business partners are selected for whom a default address corresponds to the specified address query elements. AddressDefaultIndicator may be based on datatype GDT: Indicator, with a qualifier of Default. AddressPostalAddressCityName may be based on datatype GDT: LANGUAGEINDEPENDENT_MEDIUM_Name, with a qualifier of City. AddressPostalAddressPostalCode, which may be based on datatype GDT: PostalCode, with a qualifier of Address, can be used so that those business partners whose street or PO box postal code matches the specified postal code are selected. AddressPostalAddressStreetName may be based on datatype GDT: StreetName, with a qualifier of Address. AddressPostalAddressHouseID may be based on datatype GDT: HouseID, with a qualifier of Address. AddressPostalAddressCountryCode may be based on datatype GDT: CountryCode, with a qualifier of Address. ABCClassificationsCompetitorABCClassificationCode may be based on datatype GDT: CompetitorABCClassificationCode. ABCClassificationsSalesAndServicePartnerABCClassificationCode may be based on datatype GDT: SalesAndServicePartnerABCClassificationCode. InternalID may be based on datatype GDT: BusinessPartnerInternalID. RoleCode may be based on datatype GDT: BusinessPartnerRoleCode. UUID may be based on datatype GDT: UUID. CategoryCode may be based on datatype GDT: BusinessPartnerCategoryCode. BusinessPartnerName can be used so that those business partners whose first organization name or group name, or whose last name matches the specified name are selected. If a category is also specified using query element CategoryCode, the name entered can be compared to a name component of the category. BusinessPartnerName may be based on datatype GDT: LANGUAGEINDEPENDENT_MEDIUM_Name, with a qualifier of BusinessPartner. BusinessPartnerAdditionalName can be used so that those business partners whose second organization name or group name, or whose first name matches the specified name are selected. If a category is also specified using query element CategoryCode, an entered name can be compared to a name component of the category. BusinessPartnerAdditionalName may be based on datatype GDT: LANGUAGEINDEPENDENT_MEDIUM_Name, with a qualifier of BusinessPartnerAdditional. CommonSortingFormattedName may be based on datatype GDT: LANGUAGEINDEPENDENT_LONG_Name, with a qualifier of Formatted. CommonKeyWordsText may be based on datatype GDT: KeyWordsText. CommonAdditionalKeyWordsText may be based on datatype GDT: KeyWordsText, with a qualifier of Additional. CreatedSinceDate can be used so that those business partners created on a specified date or later are selected, such as if a sub-element CreationDateTime of the root element SystemAdministrativeData includes a date that either corresponds to the specified date or has a later date. CreatedSinceDate may be based on datatype GDT: Date. LifeCycleStatusCode may be based on datatype GDT: NOTDELETED_PartyLifeCycleStatusCode. ValidityDate can be used so that data that is valid on the specified date is selected. ValidityDate may be based on datatype GDT: Date, with a qualifier of Validity. SearchText is free text including one or several word search terms used to search for a business partner, and may be based on datatype GDT: SearchText. The different terms of the search text can be matched against a subset of the query parameters.

A Query By Bank Details query returns a list of business partners that belong to a derived business object for which the query is executed. The account number and bank key of banking details can be entered as selection parameters. The query elements are defined by the inline structure BUP_S_BANK_DETAILS_QU_EL. These elements include: BankDirectoryEntryCountryCode, BankDetailsBankInternalID, BankDetailsBankAccountID, BankDetailsBankAccountStandardID, InternalID, UUID, CategoryCode, BusinessPartnerName, BusinessPartnerAdditionalName, CommonSortingFormattedName, CommonKeyWordsText, CommonAdditionalKeyWordsText, LifeCycleStatusCode, ValidityDate, and SearchText. BankDirectoryEntryCountryCode may be based on datatype GDT: CountryCode. BankDetailsBankInternalID may be based on datatype GDT: BankInternalID. BankDetailsBankAccountID may be based on datatype GDT: BankAccountID. BankDetailsBankAccountStandardID may be based on datatype GDT: BankAccountStandardID. InternalID may be based on datatype GDT: BusinessPartnerInternalID. UUID may be based on datatype GDT: UUID. CategoryCode may be based on datatype GDT: BusinessPartnerCategoryCode. BusinessPartnerName can be used so that those business partners whose first organization name or group name, or whose last name matches a specified name are selected. If a category is also specified using query element CategoryCode, the specified name can be compared to a name component of the category. BusinessPartnerCategoryCode may be based on datatype GDT: LANGUAGEINDEPENDENT_MEDIUM_Name, with a qualifier of BusinessPartner. BusinessPartnerAdditionalName can be used so that those business partners whose second organization name or group name, or whose first name matches the specified name are selected. If a category is also specified using query element CategoryCode, the specified name can be compared to a name component of a category. BusinessPartnerAdditionalName may be based on datatype GDT: LANGUAGEINDEPENDENT_MEDIUM_Name, with a qualifier of BusinessPartnerAdditional. CommonSortingFormattedName may be based on datatype GDT: LANGUAGEINDEPENDENT_LONG_Name, with a qualifier of Formatted. CommonKeyWordsText may be based on datatype GDT: KeyWordsText. CommonAdditionalKeyWordsText may be based on datatype GDT: KeyWordsText, with a qualifier of Additional. LifeCycleStatusCode may be based on datatype GDT: NOTDELETED_PartyLifeCycleStatusCode. ValidityDate can be used so that data that is valid on the specified date is selected. ValidityDate may be based on datatype GDT: Date, with a qualifier of Validity. SearchText includes free text including one or several word search terms used to search for business partners, and may be based on datatype GDT: SearchText. The different terms of the search text can be matched against a subset of the query parameters.

A Query By Business Object Customer returns a list of customers. General business partner data and attributes that exist in customers can be entered as selection parameters. The query elements are defined by the data type BusinessPartnerBusinessObjectCustomerQueryElements. These elements include: ResponsibleAgent, ResponsibilityDatePeriod, RoleCode, InternalID, UUID, CategoryCode, BusinessPartnerName, BusinessPartnerAdditionalName, CommonSortingFormattedName, CommonLegalCompetenceIndicator, AddressDefaultIndicator, AddressPostalAddressCityName, AddressPostalAddressStreetPostalCode, AddressPostalAddressCountryCode, AddressPostalAddressRegionCode, ABCClassificationsCustomerABCClassificationCode, IndustryClassificationSystemCode, IndustrialSectorCode, ContactPersonlnternalID, ContactPersonUUID, ContactPersonNameFamilyName, ContactPersonNameGivenName, ContactPersonCommonSortingFormattedName, RelationshipContactPersonWorkplaceAddressEMailURI, SalesArrangementSalesOrganisationID, BlockingReasonsBlockedIndicator, BlockingReasonslnvoicingBlockedIndicator, BlockingReasonsCustomerTransactionDocumentFulfilmentBlockedIndicator, BlockingReasonsCustomerBlockedIndicator, CreatedSinceDate, CreatedSinceDateTime, ChangedSinceDate, ChangedSinceDateTime, CreationIdentityID, LastChangeIdentityID, LifeCycleStatusCode, ValidityDate, and SearchText.

ResponsibleAgent can be used so that business partners are selected for which a specified agent is responsible. The selection of the relevant business partners can be restricted by adding certain selection criteria to the elements InternalID, AddressPostalAddressCityName, AddressPostalAddressCountryCode, AddressPostalAddressStreetPostalCode, and ABCClassificationsCustomerABCClassificationCode. These selection criteria can be determined by responsibility settings, which are based on values in the elements ResponsibleAgent, ResponsibilityTypeCode, and ResponsibilityDatePeriod. ResponsibleAgent may be based on datatype GDT: ResponsibleAgent. ResponsibilityDatePeriod can be used so that business partners are selected for which an agent is responsible within a specified period. ResponsibilityDatePeriod may be based on datatype GDT: CLOSED_DatePeriod.

RoleCode may be based on datatype GDT: BusinessPartnerRoleCode. InternalID may be based on datatype GDT: BusinessPartnerInternalID. UUID may be based on datatype GDT: UUID. CategoryCode may be based on datatype GDT: BusinessPartnerCategoryCode. BusinessPartnerName can be used so that those business partners whose first organization name or group name, or whose last name matches a specified name are selected. BusinessPartnerName may be based on datatype GDT: LANGUAGEINDEPENDENT_MEDIUM_Name, with a qualifier of BusinessPartner. BusinessPartnerAdditionalName can be used so that those business partners whose second organization name or group name, or whose first name matches a specified name are selected. BusinessPartnerAdditionalName may be based on datatype GDT: LANGUAGEINDEPENDENT_MEDIUM_Name, with a qualifier of BusinessPartnerAdditional. CommonSortingFormattedName may be based on datatype GDT: LANGUAGEINDEPENDENT_LONG_Name, with a qualifier of Formatted. If CommonLegalCompetenceIndicator is set, then legally competent business partners are selected. CommonLegalCompetenceIndicator may be based on datatype GDT: Indicator, with a qualifier of LegalCompetence. If AddressDefaultIndicator is set, then business partners are selected for whom a default address corresponds to specified address query elements. AddressDefaultIndicator may be based on datatype GDT: Indicator, with a qualifier of Default.

AddressPostalAddressCityName may be based on datatype GDT: LANGUAGEINDEPENDENT_MEDIUM_Name, with a qualifier of City. AddressPostalAddressStreetPostalCode may be based on datatype GDT: PostalCode, with a qualifier of Street. AddressPostalAddressCountryCode may be based on datatype GDT: CountryCode, with a qualifier of Address. AddressPostalAddressRegionCode may be based on datatype GDT: RegionCode, with a qualifier of Address. ABCClassificationsCustomerABCClassificationCode may be based on datatype GDT: CustomerABCClassificationCode.

IndustryClassificationSystemCode can be used so that those customers that have an industry that belongs to a specified industry classification system are selected. IndustryClassificationSystemCode may be based on datatype GDT: IndustryClassificationSystemCode. IndustrialSectorCode can be selected so that those customers that have a specified industry are selected. IndustrialSectorCode may be based on datatype GDT: IndustrialSectorCode. ContactPersonInternalID can be used so that those customers that have a contact person with a specified business partner number are selected. ContactPersonInternalID may be based on datatype GDT: BusinessPartnerInternalID. ContactPersonUUID can be used so that those customers that have a contact person with a specified UUID are selected. ContactPersonUUID may be based on datatype GDT: UUID. ContactPersonNameFamilyName can be used so that those customers that have a contact person with a specified last name are selected. ContactPersonNameFamilyName may be based on datatype GDT: LANGUAGEINDEPENDENT_MEDIUM_Name, with a qualifier of Family. ContactPersonNameGivenName can be used so that those customers that have a contact person with a specified first name are selected. ContactPersonNameGivenName may be based on datatype GDT: LANGUAGEINDEPENDENT_MEDIUM_Name, with a qualifier of Given.

ContactPersonCommonSortingFormattedName may be based on datatype GDT: LANGUAGEINDEPENDENT_LONG_Name, with a qualifier of Formatted. RelationshipContactPersonWorkplaceAddressEMailURI may be based on datatype GDT: EmailURI. SalesArrangementSalesOrganisationID can be used so that those customers that have an arrangement with a specified sales organization are selected. SalesArrangementSalesOrganisationID may be based on datatype GDT: OrganisationalCentreID. If BlockingReasonsBlockedIndicator is set, then customers are selected where the InvoicingBlockedIndicator, the CustomerTransactionDocumentFulfilmentBlockedIndicator or the CustomerBlockedIndicator is set. BlockingReasonsBlockedIndicator may be based on datatype GDT: Indicator. If BlockingReasonsInvoicingBlockedIndicator is set, then customers are selected where the InvoicingBlockedIndicator is set. BlockingReasonsInvoicingBlockedIndicator may be based on datatype GDT: Indicator. If BlockingReasonsCustomerTransactionDocumentFulfilmentBlockedIndicator is set, then customers are selected where the CustomerTransactionDocumentFulfilmentBlockedIndicator is set. BlockingReasonsCustomerTransactionDocumentFulfilmentBlockedIndicator may be based on datatype GDT: Indicator. If BlockingReasonsCustomerBlockedIndicator is set, then customers are selected where the CustomerBlockedIndicator is set. BlockingReasonsCustomerBlockedIndicator may be based on datatype GDT: Indicator.

CreatedSinceDate can be used so that those customers created on the specified date or later are selected, such as if the sub-element CreationDateTime of the root element SystemAdministrativeData includes a date that either corresponds to the specified date or has a later date. CreatedSinceDate may be based on datatype GDT: Date. CreatedSinceDateTime can be used so that those customers created on the specified date and time or later are selected, such as if the sub-element CreationDateTime of the root element SystemAdministrativeData includes a date that either corresponds to the specified date or has a later date. CreatedSinceDateTime may be based on datatype GDT: GLOBAL_DateTime.

ChangedSinceDate can be used so that those customers changed on a specified date or later are selected, such as if the sub-element LastChangeDateTime of the root element SystemAdministrativeData includes a date that either corresponds to the specified date or has a later date. ChangedSinceDate may be based on datatype GDT: Date. ChangedSinceDateTime can be used so that those customers changed on a specified date or later are selected, such as if the sub-element LastChangeDateTime of the root element SystemAdministrativeData includes a date that either corresponds to the specified date or has a later date. ChangedSinceDateTime may be based on datatype GDT: GLOBAL_DateTime. CreationIdentityID can be used so that those customers created from a specified identity are selected. CreationIdentityID may be based on datatype GDT: IdentityID. LastChangeIdentityID can be used so that those customers that are last changed from a specified identity are selected. LastChangeIdentityID may be based on datatype GDT: IdentityID. LifeCycleStatusCode may be based on datatype GDT: NOTDELETED_PartyLifeCycleStatusCode. ValidityDate can be used so that data that is valid on a specified date is selected. ValidityDate may be based on datatype GDT: Date, with a qualifier of Validity. SearchText includes free text including one or several word search terms used to search for Customers, and may be based on datatype GDT: SearchText. The different terms of the search text can be matched against a subset of the query parameters. In some implementations, the element ResponsibilityTypeCode is specified if the element ResponsibleAgent has been selected.

A Query By Communication Data query returns a list of business partners that belong to a derived business object for which the query is executed. Telephone numbers and fax numbers can be entered as selection parameters. The query elements are defined by the inline structure BUP_S_COMMU_DATA_QUERY_EL. These elements include: NormalisedPhoneNumberDescription, NormalisedFacsimileNumberDescription, EMailURI, InternalID, UUID, CategoryCode, BusinessCharacterCode, BusinessPartnerName, BusinessPartnerAdditionalName, CommonSortingFormattedName, CommonKeyWordsText, CommonAdditionalKeyWordsText, LifeCycleStatusCode, ValidityDate, and SearchText. NormalisedPhoneNumberDescription can be used so that those business partners that have an address-dependent or address-independent telephone number that matches a specified number are selected. In addition, those business partners with a category of Person and an Organization whose telephone number for a workplace address matches the specified number are selected. Also, those employees whose telephone number for a workplace address match the specified number are selected. NormalisedPhoneNumberDescription may be based on datatype GDT: LANGUAGEINDEPENDENT_SHORT_Description, with a qualifier of NormalisedTelephoneNumber. NormalisedFacsimileNumberDescription can be used so that those business partners that have an address-dependent or address-independent fax number that matches a specified number are selected. In addition, those business partners with a category of Person and an Organization whose fax number for a workplace address matches the specified number are selected. Also, those employees whose fax number for a workplace address match the specified number are selected. NormalisedFacsimileNumberDescription may be based on datatype GDT: LANGUAGEINDEPENDENT_SHORT_Description, with a qualifier of NormalisedFacsimileNumber. EMailURI can be used so that those business partners that have an address-dependent or address-independent EMail that matches a specified number are selected. In addition, those business partners with a category of Person and an Organization whose EMail for a workplace address matches the specified number are selected. Also, those employees whose EMail for a workplace address match the specified number are selected. EMailURI may be based on datatype GDT: EmailURI. InternalID may be based on datatype GDT: BusinessPartnerInternalID. UUID may be based on datatype GDT: UUID. CategoryCode may be based on datatype GDT: BusinessPartnerCategoryCode. BusinessCharacterCode may be based on datatype GDT: BUSINESSPARTNER_PartyBusinessCharacterCode. BusinessPartnerName can be used so that those business partners whose first organization name or group name, or whose last name matches a specified name are selected. If a category is also specified using query element CategoryCode, the specified name can be compared to a name component of the category. BusinessPartnerName may be based on datatype GDT: LANGUAGEINDEPENDENT_MEDIUM_Name, with a qualifier of BusinessPartner. BusinessPartnerAdditionalName can be used so that those business partners whose second organization name or group name, or whose first name matches a specified name are selected. If a category is also specified using query element CategoryCode, the specified name can be compared to a name component of the category. BusinessPartnerAdditionalName may be based on datatype GDT: LANGUAGEINDEPENDENT_MEDIUM_Name, with a qualifier of BusinessPartnerAdditional. CommonSortingFormattedName may be based on datatype GDT: LANGUAGEINDEPENDENT_LONG_Name, with a qualifier of Formatted. CommonKeyWordsText may be based on datatype GDT: KeyWordsText. CommonAdditionalKeyWordsText may be based on datatype GDT: KeyWordsText, with a qualifier of Additional. LifeCycleStatusCode may be based on datatype GDT: NOTDELETED_PartyLifeCycleStatusCode. ValidityDate can be used so that data that is valid on a specified date is selected. ValidityDate may be based on datatype GDT: Date, with a qualifier of Validity. SearchText includes free text including one or several word search terms used to search for a Business Partner, and may be based on datatype GDT: SearchText.

A Query By Contact Person query returns a list of business partners that belong to a derived business object for which the query is executed. A business partner number and a contact person name can be entered as selection parameters, for example. The query elements are defined by the data type BusinessPartnerContactPersonQueryElements. These elements include: RoleCode, InternalID, UUID, CategoryCode, BusinessPartnerName, BusinessPartnerAdditionalName, CommonSortingFormattedName, AddressDefaultIndicator, AddressPostalAddressCityName, AddressPostalAddressStreetPostalCode, AddressPostalAddressCountryCode, ABCClassificationsSalesAndServicePartnerABCClassificationCode, ContactPersonInternalID, ContactPersonUUID, ContactPersonNameFamilyName, ContactPersonNameGivenName, ContactPersonCommonSortingFormattedName, CreatedSinceDate, LifeCycleStatusCode, ValidityDate, and SearchText.

RoleCode may be based on datatype GDT: BusinessPartnerRoleCode. InternalID may be based on datatype GDT: BusinessPartnerInternalID. UUID may be based on datatype GDT: UUID. CategoryCode may be based on datatype GDT: BusinessPartnerCategoryCode. BusinessPartnerName can be used so that those business partners whose first organization name or group name, or whose last name matches a specified name are selected. BusinessPartnerName may be based on datatype GDT: LANGUAGEINDEPENDENT_MEDIUM_Name, with a qualifier of BusinessPartner. BusinessPartnerAdditionalName can be used so that those business partners whose second organization name or group name, or whose first name matches a specified name are selected. BusinessPartnerAdditionalName may be based on datatype GDT: LANGUAGEINDEPENDENT_MEDIUM_Name, with a qualifier of BusinessPartnerAdditional. CommonSortingFormattedName may be based on datatype GDT: LANGUAGEINDEPENDENT_LONG_Name, with a qualifier of Formatted. If AddressDefaultIndicator is set, then those business partners are selected for whom a default address corresponds to one or more of specified address query elements. AddressDefaultIndicator may be based on datatype GDT: Indicator, with a qualifier of Default. AddressPostalAddressCityName may be based on datatype GDT: LANGUAGEINDEPENDENT_MEDIUM_Name, with a qualifier of City. AddressPostalAddressStreetPostalCode may be based on datatype GDT: PostalCode, with a qualifier of Street. AddressPostalAddressCountryCode may be based on datatype GDT: CountryCode, with a qualifier of Address. ABCClassificationsSalesAndServicePartnerABCClassificationCode may be based on datatype GDT: SalesAndServicePartnerABCClassificationCode. ContactPersonlnternalID can be used so that those business partners that have a contact person relationship with a person that has a specified business partner number are selected. ContactPersonInternalID may be based on datatype GDT: BusinessPartnerInternalID. ContactPersonUUID can be used so that those business partners that have a contact person relationship with a person that has a specified business partner UUID are selected. ContactPersonUUID may be based on datatype GDT: UUID. ContactPersonNameFamilyName can be used so that those business partners that have a contact person relationship with a person that has a specified last name are selected. ContactPersonNameFamilyName may be based on datatype GDT: LANGUAGEINDEPENDENT_MEDIUM_Name, with a qualifier of Family. ContactPersonNameGivenName can be used so that those business partners that have a contact person relationship with a person that has a specified first name are selected. ContactPersonNameGivenName may be based on datatype GDT: LANGUAGEINDEPENDENT_MEDIUM_Name, with a qualifier of Given. ContactPersonCommonSortingFormattedName may be based on datatype GDT: LANGUAGEINDEPENDENT_LONG_Name, with a qualifier of Formatted. CreatedSinceDate can be used so that those business partners created on a specified date or later are selected, such as if the sub-element CreationDateTime of the root element SystemAdministrativeData includes a date that either corresponds to the specified date or has a later date. CreatedSinceDate may be based on datatype GDT: Date. LifeCycleStatusCode may be based on datatype GDT: NOTDELETED_PartyLifeCycleStatusCode. ValidityDate can be used so that data that is valid on a specified date is selected ValidityDate may be based on datatype GDT: Date, with a qualifier of Validity. SearchText includes free text including one or several word search terms used to search for Business Partner, and may be based on datatype GDT: SearchText.

A Query By Identification query returns a list of business partners that belong to a derived business object for which the query is executed. An alternative identifier can be entered as a selection parameter, for example. The query elements are defined by the data type BusinessPartnerIdentificationQueryElements. These elements include: IdentificationPartyidentifierTypeCode, IdentificationBusinessPartnerID, InternalID, UUID, CategoryCode, BusinessPartnerName, BusinessPartnerAdditionalName, CommonSortingFormattedName, CommonKeyWordsText, CommonAdditionalKeyWordsText, LifeCycleStatusCode, ValidityDate, and SearchText.

IdentificationPartyidentifierTypeCode may be based on datatype GDT: PartyidentifierTypeCode. IdentificationBusinessPartnerID may be based on datatype GDT: BusinessPartnerID. InternalID may be based on datatype GDT: BusinessPartnerInternalID. UUID may be based on datatype GDT: UUID. CategoryCode may be based on datatype GDT: BusinessPartnerCategoryCode. BusinessPartnerName can be used so that those business partners whose first organization name or group name, or whose last name matches a specified name are selected. If a category is also specified using query element CategoryCode, the specified name can be compared to a name component of the category. BusinessPartnerName may be based on datatype GDT: LANGUAGEINDEPENDENT_MEDIUM_Name, with a qualifier of BusinessPartner. BusinessPartnerAdditionalName can be used so that those business partners whose second organization name or group name, or whose first name matches a specified name are selected. If a category is also specified using query element CategoryCode, the specified name can be compared to a name component of the category. BusinessPartnerAdditionalName may be based on datatype GDT: LANGUAGEINDEPENDENT_MEDIUM_Name, with a qualifier of BusinessPartnerAdditional. CommonSortingFormattedName may be based on datatype GDT: LANGUAGEINDEPENDENT_LONG_Name, with a qualifier of Formatted. CommonKeyWordsText may be based on datatype GDT: KeyWordsText. CommonAdditionalKeyWordsText may be based on datatype GDT: KeyWordsText, with a qualifier of Additional. LifeCycleStatusCode may be based on datatype GDT: NOTDELETED_PartyLifeCycleStatusCode. ValidityDate can be used so that data that is valid on a specified date is selected. ValidityDate may be based on datatype GDT: Date, with a qualifier of Validity. SearchText includes free text including one or several word search terms used to search for a Business Partner, and may be based on datatype GDT: SearchText.

A Query By Identification And Address query provides a list of business partners that match selection criteria, the criteria including, for example, identification and address data. An address-related search can be performed, for example, for communication data, a partner address, an employee, and/or for a relationship workplace address. For a workplace address search, persons as well as organizations can be selected. The query can be modeled in such a way that it can represent the input parameters of the query QueryByIDAndAddress of a transformed object Party. The query elements are defined by the data type BusinessPartnerIdentificationAndAddressQueryElements. These elements include: InternalID, UUID, CategoryCode, ActsAsOrganisationalCentreIndicator, IdentificationPartyidentifierTypeCode, IdentificationBusinessPartnerID, BusinessPartnerName, BusinessPartnerAdditionalName, CommonSortingFormattedName, AddressPostalAddressCountryCode, AddressHostTypeCode, AddressDefaultIndicator, AddressPostalAddressCityName, AddressPostalAddressStreetPostalCode, AddressPostalAddressStreetName, ABCClassificationsCustomerABCClassificationCode, ABCClassificationsSupplierABCClassificationCode, ABCClassificationsSalesAndServicePartnerABCClassificationCode, ABCClassificationsCompetitorABCClassificationCode, BusinessCharacterCode, CommonLegalCompetenceIndicator, RelationshipRoleCode, RelationshipBusinessPartnerInternalID, RelationshipBusinessPartnerUUID, RelationshipBusinessPartnerSortingFormattedName, RelationshipBusinessPartnerName, RelationshipBusinessPartnerAdditionalName, RelationshipBusinessPartnerFunctionTypeCode, RelationshipBusinessPartnerFunctionalAreaCode, SupplierGroupCode, SupplierAssessmentScoreOverallPercent, EmployeePositionDescription, EmployeeJobID, EmployeeJobName, EmployeeReportingLineUnitID, LifeCycleStatusCode, ValidityDate, AllowedBusinessPartnerRelationshipRoleCode, SearchTextContactPersonContextUseIndicator, SearchTextServicePerformerContextUseIndicator, and SearchText.

InternalID may be based on datatype GDT: BusinessPartnerInternalID. UUID may be based on datatype GDT: UUID. CategoryCode may be based on datatype GDT: BusinessPartnerCategoryCode. ActsAsOrganisationalCentreIndicator may be based on datatype GDT: Indicator. IdentificationPartyidentifierTypeCode may be based on datatype GDT: PartyidentifierTypeCode. IdentificationBusinessPartnerID may be based on datatype GDT: BusinessPartnerID. BusinessPartnerName may be based on datatype GDT: LANGUAGEINDEPENDENT_MEDIUM_Name, with a qualifier of BusinessPartner. BusinessPartnerAdditionalName may be based on datatype GDT: LANGUAGEINDEPENDENT_MEDIUM_Name, with a qualifier of BusinessPartnerAdditional. CommonSortingFormattedName may be based on datatype GDT: LANGUAGEINDEPENDENT_LONG_Name, with a qualifier of Formatted. AddressPostalAddressCountryCode can be used so that those business partners that have an address within a country that matches a specified country are selected. AddressPostalAddressCountryCode may be based on datatype GDT: CountryCode, with a qualifier of Address. AddressHostTypeCode can be used so that those business partners are selected for whom a specified address host type correspond to one or more entries within corresponding address query elements, such as city, zip code, phone, fax, e-mail, and web address. AddressHostTypeCode may be based on datatype GDT: AddressHostTypeCode. If AddressDefaultIndicator is set, then those business partners are selected for whom a default address corresponds to one or more entries within corresponding address query elements, such as city, zip code, phone, fax, e-mail, and web address. AddressDefaultIndicator may be based on datatype GDT: Indicator, with a qualifier of Default. AddressPostalAddressCityName can be used so that those business partners that have an address with a city that matches a specified city are selected. AddressPostalAddressCityName may be based on datatype GDT: LANGUAGEINDEPENDENT_MEDIUM_Name, with a qualifier of City.

AddressPostalAddressStreetPostalCode can be used so that those business partners that have an address with a zip code that matches a specified zip code are selected. AddressPostalAddressStreetPostalCode may be based on datatype GDT: PostalCode, with a qualifier of Street. AddressPostalAddressStreetName can be used so that those business partners that have an address with a street name that matches a specified street name specified selected, and may be based on datatype GDT: StreetName, with a qualifier of Address. ABCClassificationsCustomerABCClassificationCode may be based on datatype GDT: CustomerABCClassificationCode. ABCClassificationsSupplierABCClassificationCode may be based on datatype GDT: SupplierABCClassificationCode. ABCClassificationsSalesAndServicePartnerABCClassificationCode may be based on datatype GDT: SalesAndServicePartnerABCClassificationCode. ABCClassificationsCompetitorABCClassificationCode may be based on datatype GDT: CompetitorABCClassificationCode. BusinessCharacterCode may be based on datatype GDT: BUSINESSPARTNER_PartyBusinessCharacterCode. CommonLegalCompetenceIndicator may be based on datatype GDT: Indicator, with a qualifier of LegalCompetence. RelationshipRoleCode can be used so that those business partners that have a relationship with a specified role code are selected. RelationshipRoleCode may be based on datatype GDT: BusinessPartnerRelationshipRoleCode. RelationshipBusinessPartnerInternalID can be used so that those business partners that have a relationship with a business partner that have a specified internal number are selected. RelationshipBusinessPartnerInternalID may be based on datatype GDT: BusinessPartnerInternalID, with a qualifier of Relationship. RelationshipBusinessPartnerUUID can be used so that those business partners that have a relationship with a business partner that have a specified universally unique identifier are selected.

RelationshipBusinessPartnerUUID may be based on datatype GDT: UUID. RelationshipBusinessPartnerSortingFormattedName can be used so that those business partners that have a relationship with a business partner whose formatted name for sorting matches a specified name are selected. RelationshipBusinessPartnerSortingFormattedName may be based on datatype GDT: LANGUAGEINDEPENDENT_LONG_Name, with a qualifier of Formatted. RelationshipBusinessPartnerName can be used so that those business partners that have a relationship with a business partner whose first organization name or group name, or whose last name matches a specified name are selected. RelationshipBusinessPartnerName may be based on datatype GDT: LANGUAGEINDEPENDENT_MEDIUM_Name, with a qualifier of BusinessPartner. RelationshipBusinessPartnerAdditionalName can be used so that those business partners that have a relationship with a business partner whose second organization name or group name, or whose first name matches a specified name are selected. RelationshipBusinessPartnerAdditionalName may be based on datatype GDT: LANGUAGEINDEPENDENT_MEDIUM_Name, with a qualifier of BusinessPartnerAdditional. RelationshipBusinessPartnerFunctionTypeCode can be used so that those business partners who have a contact person or service performer relationship where a contact person or a service performer has a specified function are selected. RelationshipBusinessPartnerFunctionTypeCode may be based on datatype GDT: BusinessPartnerFunctionTypeCode. RelationshipBusinessPartnerFunctionalAreaCode can be used so that those business partners who have a contact person or service performer relationship where the contact person or the service performer has a specified functional area are selected. RelationshipBusinessPartnerFunctionalAreaCode may be based on datatype GDT: BusinessPartnerFunctionalAreaCode. SupplierGroupCode can be used so that those suppliers that have a specified group code are selected. SupplierGroupCode may be based on datatype GDT: SupplierGroupCode. SupplierAssessmentScoreOverallPercent can be used so that those suppliers that have a specified overall supplier assessment score are selected. SupplierAssessmentScoreOverallPercent may be based on datatype GDT: SMALLNONNEGATIVE_Percent, with a qualifier of Overall. EmployeePositionDescription can be used so that those employees who have a specified position description are selected. EmployeePositionDescription may be based on datatype GDT: LONG_Description, with a qualifier of Position. EmployeeJobID can be used so that those employees who have a specified job ID are selected. EmployeeJobID may be based on datatype GDT: JobID. EmployeeJobName can be used so that those employees who have a specified job name are selected. EmployeeJobName may be based on datatype GDT: LANGUAGEINDEPENDENT_MEDIUM_Name. EmployeeReportingLineUnitID can be used so that those employees who are assigned to a reporting line unit with a specified ID are selected. EmployeeReportingLineUnitID may be based on datatype GDT: OrganisationalCentreID. LifeCycleStatusCode may be based on datatype GDT: NOTDELETED_PartyLifeCycleStatusCode. ValidityDate can be used so that data that is valid on a specified date is selected. ValidityDate may be based on datatype GDT: Date, with a qualifier of Validity.

AllowedBusinessPartnerRelationshipRoleCode can be used so that those business partners that can take over a specified relationship role are selected. AllowedBusinessPartnerRelationshipRoleCode may be based on datatype GDT: BusinessPartnerRelationshipRoleCode, with a qualifier of Allowed. AllowedBusinessPartnerRelationshipRoleCode can be used to retrieve context information and/or values for the element RelationshipBusinessPartnerInternalID and the element RoleCode. If a selected relationship role in the element RoleCode of the node Relationship is “Has Contact Person”, then business partners of the category “person” can be selected. SearchTextContactPersonContextUseIndicator specifies whether a SearchText search is to be performed in a contact person context, and may be based on datatype GDT: Indicator, with a qualifier of Use. If a SearchText search is carried out in a contact person context, a name of an organization can be taken into account. SearchTextServicePerformerContextUseIndicator specifies whether a SearchText search is to be performed in a service performer context, and may be based on datatype GDT: Indicator, with a qualifier of Use. If a SearchText search is carried out in a service performer context, the name of an organization can be taken into account. SearchText includes free text including one or several word search terms used to search for a Business Partner, and may be based on datatype GDT: SearchText

A Query By Relationship query returns a list of business partners that belong to a derived business object for which the query is executed. A relationship category and name of a business partner in question can be entered as selection parameters, for example. The query elements are defined by the data type BusinessPartnerRelationshipQueryElements. These elements include: InternalID, UUID, RoleCode, CategoryCode, BusinessPartnerName, BusinessPartnerAdditionalName, CommonSortingFormattedName, AddressPostalAddressCityName, AddressPostalAddressStreetPostalCode, AddressPostalAddressStreetName, AddressPostalAddressCountryCode, AddressPostalAddressRegionCode, AddressEMailURI, AddressPostalAddressBuildingID, AddressPostalAddressFloorID, IdentificationDunAndBradstreetNumberBusinessPartnerID, IdentityID, LifeCycleStatusCode, RelationshipRoleCode, RelationshipWorkplaceAddressBuildingID, RelationshipWorkplaceAddressFloorID, RelationshipWorkplaceAddressRoomID, RelationshipWorkplaceAddressEMailURI, RelationshipBusinessPartnerInternalID, RelationshipBusinessPartnerUUID, RelationshipBusinessPartnerRoleCode, RelationshipBusinessPartnerRoleBusinessObjectTypeCode, RelationshipBusinessPartnerCategoryCode, RelationshipBusinessPartnerName, RelationshipBusinessPartnerAdditionalName, RelationshipBusinessPartnerCommonSortingFormattedName, RelationshipBusinessPartnerAddressPostalAddressCityName, RelationshipBusinessPartnerAddressPostalAddressStreetPostalCode, RelationshipBusinessPartnerAddressPostalAddressStreetName, RelationshipBusinessPartnerAddressPostalAddressCountryCode, RelationshipBusinessPartnerAddressPostalAddressRegionCode, RelationshipBusinessPartnerIdentificationDunAndBradstreetNumberBusinessPartnerID, RelationshipBusinessPartnerAddressEMailURI, RelationshipBusinessPartnerAddressBuildingID, RelationshipBusinessPartnerAddressFloorID, RelationshipTimeDependentInformationDefaultIndicator, RelationshipBusinessPartnerRelationshipTimeDependentInformationDefaultIndicator, RelationshipBusinessPartnerLifeCycleStatusCode, ValidityDate, and SearchText.

InternalID may be based on datatype GDT: BusinessPartnerInternalID. UUID may be based on datatype GDT: UUID. RoleCode may be based on datatype GDT: BusinessPartnerRoleCode. CategoryCode may be based on datatype GDT: BusinessPartnerCategoryCode. BusinessPartnerName can be used so that those business partners whose first organization name or group name, or whose last name matches a specified name are selected. BusinessPartnerName may be based on datatype GDT: LANGUAGEINDEPENDENT_MEDIUM_Name, with a qualifier of BusinessPartner. BusinessPartnerAdditionalName can be used so that those business partners whose second organization name or group name, or whose first name matches a specified name are selected. BusinessPartnerAdditionalName may be based on datatype GDT: LANGUAGEINDEPENDENT_MEDIUM_Name, with a qualifier of BusinessPartnerAdditional. CommonSortingFormattedName may be based on datatype GDT: LANGUAGEINDEPENDENT_LONG_Name, with a qualifier of Formatted. AddressPostalAddressCityName may be based on datatype GDT: LANGUAGEINDEPENDENT_MEDIUM_Name, with a qualifier of City. AddressPostalAddressStreetPostalCode may be based on datatype GDT: PostalCode, with a qualifier of Street. AddressPostalAddressStreetName may be based on datatype GDT: StreetName, with a qualifier of Address. AddressPostalAddressCountryCode may be based on datatype GDT: CountryCode, with a qualifier of Address. AddressPostalAddressRegionCode may be based on datatype GDT: RegionCode, with a qualifier of Address. AddressEMailURI may be based on datatype GDT: EmailURI. AddressPostalAddressBuildingID may be based on datatype GDT: BuildingID. AddressPostalAddressFloorID may be based on datatype GDT: FloorID. IdentificationDunAndBradstreetNumberBusinessPartnerID can be used so that those invoicing parties that have a specified Dun and Bradstreet ID number are selected. IdentificationDunAndBradstreetNumberBusinessPartnerID may be based on datatype GDT: BusinessPartnerID. IdentityID may be used so that those business partners that have a specified IdentityID used for logging on to the system are specified. IdentityID may be based on datatype GDT: IdentityID. LifeCycleStatusCode may be based on datatype GDT: NOTDELETED_PartyLifeCycleStatusCode. RelationshipRoleCode can be used so that those business partners that have a relationship with another business partner of a specified relationship category are selected. RelationshipRoleCode may be based on datatype GDT: BusinessPartnerRelationshipRoleCode. RelationshipWorkplaceAddressBuildingID can be used so that those business partners that have a contact person or service performer relationship with a business partner where a building number of a workplace address matches a specified address are selected. RelationshipWorkplaceAddressBuildingID may be based on datatype GDT: BuildingID. RelationshipWorkplaceAddressFloorID can be used so that those business partners that have a contact person or a service performer relationship with a business partner where a floor number of a workplace address matches a specified floor number are selected. RelationshipWorkplaceAddressFloorID may be based on datatype GDT: FloorID. RelationshipWorkplaceAddressRoomID can be used so that those business partners that have a contact person or a service performer relationship with a business partner where a room number of a workplace address matches a specified room number are selected.

RelationshipWorkplaceAddressRoomID may be based on datatype GDT: RoomID RelationshipWorkplaceAddressEMailURI can be used so that those business partners that have a contact person or a service performer relationship with a business partner where an e-mail address of a workplace address matches a specified email address are selected. RelationshipWorkplaceAddressEMailURI may be based on datatype GDT: EmailURI. RelationshipBusinessPartnerInternalID can be used so that those business partners that have a relationship with a business partner with a specified internal number are selected. RelationshipBusinessPartnerInternalID may be based on datatype GDT: BusinessPartnerInternalID, with a qualifier of Relationship. RelationshipBusinessPartnerUUID can be used so that those business partners that have a relationship with a business partner that has specified UUID are selected. RelationshipBusinessPartnerUUID may be based on datatype GDT: UUID. RelationshipBusinessPartnerRoleCode may be based on datatype GDT: BusinessPartnerRoleCode. RelationshipBusinessPartnerRoleBusinessObjectTypeCode may be based on datatype GDT: BusinessObjectTypeCode. RelationshipBusinessPartnerCategoryCode can be used so that those business partners that have a relationship with a business partner that has a specified category are selected. RelationshipBusinessPartnerCategoryCode may be based on datatype GDT: BusinessPartnerCategoryCode. RelationshipBusinessPartnerName can be used so that those business partners who have a relationship with a business partner whose first organization name or group name, or whose last name matches a specified name are selected. RelationshipBusinessPartnerName may be based on datatype GDT: LANGUAGEINDEPENDENT_MEDIUM_Name, with a qualifier of BusinessPartner. RelationshipBusinessPartnerAdditionalName can be used so that those business partners who have a relationship with a business partner whose second organization name or group name, or whose first name matches a specified name are selected. RelationshipBusinessPartnerAdditionalName may be based on datatype GDT: LANGUAGEINDEPENDENT_MEDIUM_Name, with a qualifier of BusinessPartnerAdditional.

RelationshipBusinessPartnerCommonSortingFormattedName may be based on datatype GDT: LANGUAGEINDEPENDENT_LONG_Name, with a qualifier of Formatted. RelationshipBusinessPartnerAddressPostalAddressCityName can be used so that those business partners that have a relationship with another business partner that has an address with a specified town or place are selected. RelationshipBusinessPartnerAddressPostalAddressCityName may be based on datatype GDT: LANGUAGEINDEPENDENT_MEDIUM_Name, with a qualifier of City. RelationshipBusinessPartnerAddressPostalAddressStreetPostalCode can be used so that those business partners that have a relationship with another business partner that has an address with a specified postal code are selected. RelationshipBusinessPartnerAddressPostalAddressStreetPostalCode may be based on datatype GDT: PostalCode, with a qualifier of Street. RelationshipBusinessPartnerAddressPostalAddressStreetName can be used so that those business partners that have a relationship with another business partner that has a specified street address are selected. RelationshipBusinessPartnerAddressPostalAddressStreetName may be based on datatype GDT: StreetName, with a qualifier of Address. RelationshipBusinessPartnerAddressPostalAddressCountryCode can be used so that those business partners that have a relationship with another business partner that has an address with a specified country are selected. RelationshipBusinessPartnerAddressPostalAddressCountryCode may be based on datatype GDT: CountryCode, with a qualifier of Address. RelationshipBusinessPartnerAddressPostalAddressRegionCode can be used so that those business partners that have a relationship with another business partner that has an address with a specified region are selected. RelationshipBusinessPartnerAddressPostalAddressRegionCode may be based on datatype GDT: RegionCode, with a qualifier of Address. RelationshipBusinessPartnerIdentificationDunAndBradstreetNumberBusinessPartnerID can be used so that those business partners that have a relationship with another business partner that has a specified Dun and Bradstreet ID number (D-U-N-S number) are selected. RelationshipBusinessPartnerIdentificationDunAndBradstreetNumberBusinessPartnerID may be based on datatype GDT: BusinessPartnerID.

RelationshipBusinessPartnerAddressEMailURI can be used so that those business partners that have a relationship with another business partner that has a specified email address are selected. RelationshipBusinessPartnerAddressEMailURI may be based on datatype GDT: EmailURI. RelationshipBusinessPartnerAddressBuildingID can be used so that those business partners that have a relationship with another business partner that has an address with a specified building number are selected. RelationshipBusinessPartnerAddressBuildingID may be based on datatype GDT: BuildingID. RelationshipBusinessPartnerAddressFloorID can be used so that those business partners that have a relationship with another business partner that has an address with a specified floor are selected. RelationshipBusinessPartnerAddressFloorID may be based on datatype GDT: FloorID. If RelationshipTimeDependentInformationDefaultIndicator is set, then those business partners that have a relationship with another business partner that is flagged as a standard are selected. RelationshipTimeDependentInformationDefaultIndicator may be based on datatype GDT: Indicator, with a qualifier of Default. If RelationshipBusinessPartnerRelationshipTimeDependentInformationDefaultIndicator is set, then those business partners that are a standard partner for a relationship are selected. RelationshipBusinessPartnerRelationshipTimeDependentInformationDefaultIndicator may be based on datatype GDT: Indicator, with a qualifier of Default. RelationshipBusinessPartnerLifeCycleStatusCode may be based on datatype GDT: NOTDELETED_PartyLifeCycleStatusCode. ValidityDate can be used so that data that is valid on a specified date is selected. ValidityDate may be based on datatype GDT: Date, with a qualifier of Validity. SearchText includes free text including one or several word search terms used to search for a Business Partner, and may be based on datatype GDT: SearchText.

A Query By Role query returns a list of business partners that belong to a derived business object for which the query is executed. A role can be entered as a selection parameter, for example. The query elements are defined by the inline structure: BUP_S_ROLE_QU_EL. These elements include: RoleCode, InternalID, UUID, CategoryCode, BusinessPartnerName, BusinessPartnerAdditionalName, CommonSortingFormattedName, CommonKeyWordsText, CommonAdditionalKeyWordsText, LifeCycleStatusCode, ValidityDate, and SearchText.

RoleCode may be based on datatype GDT: BusinessPartnerRoleCode. InternalID may be based on datatype GDT: BusinessPartnerInternalID. UUID may be based on datatype GDT: UUID. CategoryCode may be based on datatype GDT: BusinessPartnerCategoryCode. BusinessPartnerName can be used so that those business partners whose first organization name or group name, or whose last name matches a specified name are selected. If a category is also specified using query element CategoryCode, the specified name can be compared to a name component of the category. BusinessPartnerName may be based on datatype GDT: LANGUAGEINDEPENDENT_MEDIUM_Name, with a qualifier of BusinessPartner. BusinessPartnerAdditionalName can be used so that those business partners whose second organization name or group name, or whose first name matches a specified name are selected. If a category is also specified using query element CategoryCode, the specified name can be compared to a name component of the category. BusinessPartnerAdditionalName may be based on datatype GDT: LANGUAGEINDEPENDENT_MEDIUM_Name, with a qualifier of BusinessPartnerAdditional. CommonSortingFormattedName may be based on datatype GDT: LANGUAGEINDEPENDENT_LONG_Name, with a qualifier of Formatted. CommonKeyWordsText may be based on datatype GDT: KeyWordsText. CommonAdditionalKeyWordsText may be based on datatype GDT: KeyWordsText, with a qualifier of Additional. LifeCycleStatusCode may be based on datatype GDT: NOTDELETED_PartyLifeCycleStatusCode. ValidityDate can be used so that data that is valid on a specified date specified is selected. ValidityDate may be based on datatype GDT: Date, with a qualifier of Validity. SearchText includes free text including one or several word search terms used to search for a Business Partner, and may be based on datatype GDT: SearchText.

A Query By Names And Key Words query returns a list of business partners that belong to a derived business object for which the query is executed. A name and search criteria can be entered as selection parameters, for example. The query elements are defined by the data type BusinessPartnerNamesAndKeyWordsQueryElements. These elements include: InternalID, UUID, CategoryCode, BusinessPartnerName, BusinessPartnerAdditionalName, CommonSortingFormattedName, RoleCode, CommonKeyWordsText, CommonAdditionalKeyWordsText, CommonLegalCompetenceIndicator, LifeCycleStatusCode, ValidityDate, and SearchText.

InternalID may be based on datatype GDT: BusinessPartnerInternalID. UUID may be based on datatype GDT: UUID. CategoryCode may be based on datatype GDT: BusinessPartnerCategoryCode. BusinessPartnerName can be used so that those business partners whose first organization name or group name, or whose last name matches a specified name are selected. If a category is also specified using query element CategoryCode, the specified name can be compared to a name component of the category. BusinessPartnerName may be based on datatype GDT: LANGUAGEINDEPENDENT_MEDIUM_Name, with a qualifier of BusinessPartner. BusinessPartnerAdditionalName can be used so that those business partners whose second organization name or group name, or whose first name matches a specified name are selected. If a category is also specified using query element CategoryCode, the specified name can be compared to a name component of a category. BusinessPartnerAdditionalName may be based on datatype GDT: LANGUAGEINDEPENDENT_MEDIUM_Name, with a qualifier of BusinessPartnerAdditional. CommonSortingFormattedName may be based on datatype GDT: LANGUAGEINDEPENDENT_LONG_Name, with a qualifier of Formatted. RoleCode may be based on datatype GDT: BusinessPartnerRoleCode. CommonKeyWordsText may be based on datatype GDT: KeyWordsText. CommonAdditionalKeyWordsText may be based on datatype GDT: KeyWordsText, with a qualifier of Additional. CommonLegalCompetenceIndicator may be based on datatype GDT: Indicator, with a qualifier of LegalCompetence. LifeCycleStatusCode may be based on datatype GDT: NOTDELETED_PartyLifeCycleStatusCode. ValidityDate may be based on datatype GDT: Date, with a qualifier of Validity. SearchText includes free text including one or several word search terms used to search for a Business Partner, and may be based on datatype GDT: SearchText.

A Query By Role Contact Person Or Service Performer query supplies a list of business partners with role contact person and/or service performer, whose results match selection criteria from query elements and a specified supplier role. The query can be performed by using human-readable unambiguous identifiers and indicators included in Supplier and Address. The query selects business partners whose data corresponds to the selection criteria. The query elements are defined by the data type BusinessPartnerRoleContactPersonOrServicePerformerQueryElements. These elements include: RoleCode, InternalID, UUID, CommonPersonNameFamilyName, CommonPersonNameGivenName, CommonSortingFormattedName, IdentityID, Relationship WorkplaceAddressBuildingID, RelationshipWorkplaceAddressFloorID, RelationshipWorkplaceAddressRoomID, RelationshipWorkplaceAddressEMailURI, RelationshipDefaultIndicator, RelationshipBusinessPartnerRoleCode, RelationshipBusinessPartnerInternalID, RelationshipBusinessPartnerUUID, RelationshipBusinessPartnerCommonOrganisationNameFirstLineName, RelationshipBusinessPartnerCommonOrganisationNameSecondLineName, RelationshipBusinessPartnerCommonSortingFormattedName, RelationshipBusinessPartnerAddressPostalAddressCityName, RelationshipBusinessPartnerAddressPostalAddressStreetPostalCode, RelationshipBusinessPartnerAddressPostalAddressStreetName, RelationshipBusinessPartnerAddressPostalAddressCountryCode, RelationshipBusinessPartnerAddressPostalAddressRegionCode, RelationshipBusinessPartnerVendorDunAndBradstreetNumberBusinessPartnerID, and SearchText.

RoleCode can be used to specify a role for the query, such as a role that indicates Contact Person or Service Performer. The query can provide supplier contacts with a specified role. A query without a specified supplier contact role can deliver all supplier contacts. RoleCode may be based on datatype GDT: BusinessPartnerRoleCode. InternalID may be based on datatype GDT: BusinessPartnerInternalID. UUID may be based on datatype GDT: UUID. CommonPersonNameFamilyName may be based on datatype GDT: LANGUAGEINDEPENDENT_MEDIUM_Name, with a qualifier of Family. CommonPersonNameGivenName may be based on datatype GDT: LANGUAGEINDEPENDENT_MEDIUM_Name, with a qualifier of Given. CommonSortingFormattedName may be based on datatype GDT: LANGUAGEINDEPENDENT_LONG_Name, with a qualifier of Formatted. IdentityID can be used so that those contact persons and service performers that have a specified IdentitylD used for logging on to the system are selected. IdentityID may be based on datatype GDT: IdentityID. RelationshipWorkplaceAddressBuildingID can be used so that those contact persons and service performers that have a contact person or service performer relationship with a business partner where a building number of a relationship address matches a specified building number are selected. RelationshipWorkplaceAddressBuildingID may be based on datatype GDT: BuildingID. RelationshipWorkplaceAddressFloorID can be used so that those contact persons and service performers that have a contact person or service performer relationship with a business partner where a floor number of a relationship address matches a specified floor number are selected. RelationshipWorkplaceAddressFloorID may be based on datatype GDT: FloorID. RelationshipWorkplaceAddressRoomID can be used so that those contact persons and service performers that have a contact person or service performer relationship with a business partner where a room number of a relationship address matches a specified room number are selected.

RelationshipWorkplaceAddressRoomID may be based on datatype GDT: RoomID RelationshipWorkplaceAddressEMailURI can be used so that those contact persons and service performers that have a contact person or service performer relationship with a business partner where an e-mail address of a relationship address matches a specified e-mail address are selected. RelationshipWorkplaceAddressEMailURI may be based on datatype GDT: EmailURI. RelationshipDefaultIndicator can indicate that a supplier contact is a default contact/service performer, and may be based on datatype GDT: Indicator, with a qualifier of Default. RelationshipBusinessPartnerRoleCode can be used to indicate a partner role, such as Vendor, Bidder or Invoicing Party. The query can provide supplier contacts having a specified supplier role. The query without a specified role can provide supplier contacts for all supplier roles. RelationshipBusinessPartnerRoleCode may be based on datatype GDT: BusinessPartnerRoleCode. RelationshipBusinessPartnerInternalID can be used so that those contact persons and service performers that have a contact person or service performer relationship with a business partner that has a specified business partner number are selected. RelationshipBusinessPartnerInternalID may be based on datatype GDT: BusinessPartnerInternalID, with a qualifier of Relationship. RelationshipBusinessPartnerUUID can be used so that those contact persons and service performers that have a contact person or service performer relationship with a business partner that has a specified business partner number are selected. RelationshipBusinessPartnerUUID may be based on datatype GDT: UUID. RelationshipBusinessPartnerCommonOrganisationNameFirstLineName can be used so that those contact persons and service performers that have a contact person or service performer relationship with a business partner where one or more specified name components are in a first name line of an address format are selected. RelationshipBusinessPartnerCommonOrganisationNameFirstLineName may be based on datatype GDT: LANGUAGEINDEPENDENT_MEDIUM_Name. RelationshipBusinessPartnerCommonOrganisationNameSecondLineName can be used so that those contact persons and service performers that have a contact person or service performer relationship with a business partner where one or more specified components are in a second name line of an address format are selected. RelationshipBusinessPartnerCommonOrganisationNameSecondLineName may be based on datatype GDT: LANGUAGEINDEPENDENT_MEDIUM_Name. RelationshipBusinessPartnerCommonSortingFormattedName may be based on datatype GDT: LANGUAGEINDEPENDENT_LONG_Name, with a qualifier of Formatted. RelationshipBusinessPartnerAddressPostalAddressCityName can be used so that those contact persons and service performers that have a contact person or service performer relationship with a business partner that has an address with a specified town or place are selected. RelationshipBusinessPartnerAddressPostalAddressCityName may be based on datatype GDT: LANGUAGEINDEPENDENT_MEDIUM_Name, with a qualifier of City.

RelationshipBusinessPartnerAddressPostalAddressStreetPostalCode can be used so that those contact persons and service performers that have a contact person or service performer relationship with a business partner that has an address with a specified postal code are selected. RelationshipBusinessPartnerAddressPostalAddressStreetPostalCode may be based on datatype GDT: PostalCode, with a qualifier of Street. RelationshipBusinessPartnerAddressPostalAddressStreetName can be used so that those contact persons and service performers that have a contact person or service performer relationship with a business partner that has an address with a specified street name are selected. RelationshipBusinessPartnerAddressPostalAddressStreetName may be based on datatype GDT: StreetName, with a qualifier of Address. RelationshipBusinessPartnerAddressPostalAddressCountryCode can be used so that those contact persons and service performers that have a contact person or service performer relationship with a business partner that has an address with a specified country are selected. RelationshipBusinessPartnerAddressPostalAddressCountryCode may be based on datatype GDT: CountryCode, with a qualifier of Address. RelationshipBusinessPartnerAddressPostalAddressRegionCode can be used so that those contact persons and service performers that have a contact person or service performer relationship with a business partner that has an address with a specified region are selected. RelationshipBusinessPartnerAddressPostalAddressRegionCode may be based on datatype GDT: RegionCode, with a qualifier of Address. RelationshipBusinessPartnerVendorDunAndBradstreetNumberBusinessPartnerID can be used so that those contact persons and service performers that have a contact person or service performer relationship with a business partner that has a specified Dun and Bradstreet identification number (e.g., D-U-N-S number) are selected. RelationshipBusinessPartnerVendorDunAndBradstreetNumberBusinessPartnerID may be based on datatype GDT: BusinessPartnerID. SearchText includes free text including one or several word search terms used to search for a Business Partner, and may be based on datatype GDT: SearchText.

Blocking Reasons is a description that explains why a customer is blocked for certain business transactions. The elements located directly at the node Blocking Reasons are defined by the inline structure BUP_S_BLCKG_REASON_EL. These elements include: InvoicingBlockingReasonCode, CustomerTransactionDocumentFulfilmentBlockingReasonCode, CustomerBlockingReasonCode, InvoicingBlockedIndicator, CustomerTransactionDocumentFulfilmentBlockedIndicator, and CustomerBlockedIndicator.

InvoicingBlockingReasonCode may be optional, indicates a reason why a customer cannot be invoiced, and may be based on datatype GDT: InvoicingBlockingReasonCode. CustomerTransactionDocumentFulfilmentBlockingReasonCode may be optional, indicates a reason why a customer cannot receive deliveries or services, and may be based on datatype GDT: CustomerTransactionDocumentFulfilmentBlockingReasonCode. CustomerBlockingReasonCode may be optional, indicates a reason why a customer cannot be used in business transactions, and may be based on datatype GDT: CustomerBlockingReasonCode. InvoicingBlockedIndicator specifies whether a customer can be invoiced, and may be based on datatype GDT: Indicator, with a qualifier of Blocked. CustomerTransactionDocumentFulfilmentBlockedIndicator specifies whether a customer can receive deliveries or services, and may be based on datatype GDT: Indicator, with a qualifier of Blocked. CustomerBlockedIndicator specifies whether a customer can be used in business transactions, and may be based on datatype GDT: Indicator, with a qualifier of Blocked. The following specialization associations for navigation may exist to the node Customer: Parent, with a target cardinality of 1; and Root, with a target cardinality of 1. In some implementations, the elements InvoicingBlockedIndicator, CustomerTransactionDocumentFulfilmentBlockedIndicator and CustomerBlockedIndicator are read-only.

Current Employee Responsible Transformation Node includes information for an employee that is responsible for a business partner, such as employees that are directly assigned to a customer. The elements located directly at the node Current Employee Responsible are defined by the inline structure BUP_S_CURR_EE_RESPONSIBLE_EL. These elements include: EmployeeUUID, EmployeeID, and PartyRoleCode. EmployeeUUID may be optional, is a universally unique identifier of an Employee that is directly responsible for a customer, and may be based on datatype GDT: UUID. EmployeeID may be optional, is an ID of an Employee that is directly responsible for a customer, and may be based on datatype GDT: EmployeeID. PartyRoleCode may be optional, indicates a type of responsibility an employee has for a customer, and may be based on datatype GDT: PartyRoleCode. For example, an employee can be responsible for sales or for marketing with regard to a customer. The following specialization associations for navigation may exist: Parent, to the node Customer, with a target cardinality of 1; Root, to the node Customer, with a target cardinality of 1; and Employee, to the business object Employee/node Employee, with a target cardinality of CN, which is an Employee that is directly responsible for a customer.

ABC (Activity-Based Costing) Classifications represents classifications of a business partner according to importance. An importance can be based on criteria such as business volume, profit, and purchasing volume. An ABC classification can be based on an ABC Analysis. The elements located directly at the node ABC Classifications are defined by the inline structure BUP_S_ABC_CLASSIFICATIONS_EL. These elements include CustomerABCClassificationCode, which is an ABC classification of a customer and may be based on datatype GDT: CustomerABCClassificationCode. The following specialization associations for navigation may exist to the node Customer: Parent, with a target cardinality of 1; and Root, with a target cardinality of 1.

AddressInformation includes information for an address of a business partner along with usage related to the address. AddressInformation can be time dependent on Validity Period. The elements located directly at the node Address Information are defined by the data type BusinessPartnerAddressInformationElements. These elements include: UUID, MoveDestinationAddressUUID, MoveDate, ProtectedIndicator, and ValidityPeriod.

UUID may be an alternative key, is a universal unique identifier of a business partner address, and may be based on datatype GDT: UUID. MoveDestinationAddressUUID is a universal unique identifier of a new address after a business partner has moved, and may be based on datatype GDT: UUID. MoveDate may be optional, is a date as of which an address is replaced by another address, and may be based on datatype GDT: Date, with a qualifier of Move.

ProtectedIndicator specifies whether an address is protected, and may be based on datatype GDT: Indicator, with a qualifier of Protected. Personal data of an employee can be protected for legal reasons. Protected data can be visible in an Employee business object. Other than the employee, only employees with a special authorization can view data for the employee. Employees with special authorization can include, for example, employees working in human resources. Only if an employee gives consent can personal data be shown and used in business objects other than the Employee business object.

ValidityPeriod is a period in which an address is valid, and may be based on datatype GDT: CLOSED_DatePeriod, with a qualifier of Validity. The following composition relationships to subordinate nodes exist: AddressUsage, in a 1:CN cardinality relationship; and AddressCurrentAddressDeterminationProcesses, in a 1:C cardinality relationship. The following composition relationships to dependent objects exist: Address, with a cardinality of 1:1, which is an Address that includes a postal address of a business partner and related contact information data. Data can be mapped using a dependent object PartnerAddress. The following specialization associations for navigation may exist: Parent, to the node Customer, with a target cardinality of 1; Root, to the node Customer, with a target cardinality of 1; and Address Snapshot, to the business object Address Snapshot/node Root, with a target cardinality of C, which may be filtered and which is an address snapshot that is related to an address at a given point in time. The filter elements are defined by the inline structure BUP_S_ADDRI_ADDR_SNAPSHOT_F_EL. These elements include ValidityDate, which may be optional and may be based on datatype GDT: Date. In some implementations, the element ProtectedIndicator is maintained for private addresses in the business object Employee. In some implementations, if the element ProtectedIndicator is true, the address can be displayed and maintained in the business object Employee and in all other derived business objects the address can be empty. In some implementations, if the ProtectedIndicator is false, the address can be displayed and maintained in other derived business objects.

AddressUsage includes a business, time-dependent usage of an address. An address can be used as a correspondence, delivery or bill-to party address for example. The personal data of an employee can be protected for legal reasons. Such protected data is only visible in the Employee business object. This means that apart from the employee, only people with special authorization can view the personal data. If the employee expressly gives consent, personal data may be used in other processes and in other business objects. The elements located directly at the node Address Usage are defined by the inline structure: BUP_S_ADDR_USAGE_EL. These elements include: AddressUsageCode, ValidityPeriod, and DefaultIndicator. AddressUsageCode specifies a usage type of an address, such as for delivery or a holiday address, and may be based on datatype GDT: AddressUsageCode. ValidityPeriod is a period during which an address may have a certain usage, and may be based on datatype GDT: CLOSED_DatePeriod, with a qualifier of Validity. DefaultIndicator may be optional, indicates a standard address within an address usage type, and may be based on datatype GDT: Indicator, with a qualifier of Default. In some implementations, if several addresses are assigned to an address usage at one specific time, one address can be indicated as a default address. The following specialization associations for navigation may exist: Parent, to the node Address Information, with a target cardinality of 1; and Root, to the node Customer, with a target cardinality of 1. In some implementations, in the element AddressUsageCode, a code for a private address of an employee can only be maintained in the business object Employee.

AddressCurrentAddressDeterminationProcesses specifies address determination processes for which an address can be used. AddressCurrentAddressDeterminationProcesses is a Transformation Node. Data can be derived from an AddressUsage node and changes can be likewise carried out via an AddressUsage node. To determine individual values, a check can be carried out as to whether an AddressUsageCode is assigned to an AddressDeterminationCode in a business configuration. If an assignment exists, a check can be carried out to see if the address currently has an assigned AddressUsageCode. The result of such a check can be shown in the element. Time restrictions can be applied to the validity of the data. “Current” means that the day on which data is determined for the node lies within a validity period. For example, an AddressUsageCode “Delivery Address” can be assigned to a PartyAddressDeterminationCodes of “Address Determination for Sending Goods” and “Address Determination for Sending Invoices”. In such an example, DeliveryAddressAddressDeterminationProcessRelevanceCode and BillToPartyAddressDeterminationProcessRelevanceCode can have a same value. If the address is a current delivery address or a standard delivery address, both elements can have a value of Yes or Standard. If the address is not a current delivery address, both elements can have a value of No. If, for example, the value for the element DeliveryAddressAddressDeterminationProcessRelevanceCode is changed from No to Standard, then the address can be maintained as a current delivery address via a Usage node. A value in the element BillToPartyAddressDeterminationProcessRelevanceCode can be likewise changed from No to Standard. If conflicting values are maintained in the two elements DeliveryAddressAddressDeterminationProcessRelevanceCode and BillToPartyAddressDeterminationProcessRelevanceCode, an error message can be generated.

The elements located directly at the node Address Current Address Determination Processes are defined by the inline structure BUP_S_ADDR_CURR_ADDR_DET_EL. These elements include: DefaultAddressDeterminationProcessRelevanceIndicator, InvoicingAddressDeterminationProcessRelevanceCode, BillToAddressDeterminationProcessRelevanceCode, GoodsRecipientAddressDeterminationProcessRelevanceCode, OrderingAddressDeterminationProcessRelevanceCode, ShipFromAddressDeterminationProcessRelevanceCode, DeliveryAddressDeterminationProcessRelevanceCode, PaymentAddressDeterminationProcessRelevanceCode, PaymentAdviceToAddressDeterminationProcessRelevanceCode, and EmployeePrivateAddressDeterminationProcessRelevanceCode.

DefaultAddressDeterminationProcessRelevanceIndicator is a coded representation of a relevance of an address for address determination processes to which no address is explicitly assigned, and may be based on datatype GDT: Indicator, with a qualifier of Default. InvoicingAddressDeterminationProcessRelevanceCode is a coded representation of a relevance of an address for address determination for invoices from an invoicing party, and may be based on datatype GDT: AddressDeterminationProcessRelevanceCode, with a qualifier of Invoicing. BillToAddressDeterminationProcessRelevanceCode is a coded representation of a relevance of an address for address determination when sending invoices to a bill-to party, and may be based on datatype GDT: AddressDeterminationProcessRelevanceCode, with a qualifier of BillTo. GoodsRecipientAddressDeterminationProcessRelevanceCode is a coded representation of a relevance of an address for address determination for in-house goods distribution, and may be based on datatype GDT: AddressDeterminationProcessRelevanceCode, with a qualifier of GoodsRecipient. OrderingAddressDeterminationProcessRelevanceCode is a coded representation of a relevance of an address for address determination when ordering with a vendor, and may be based on datatype GDT: AddressDeterminationProcessRelevanceCode, with a qualifier of Ordering. ShipFromAddressDeterminationProcessRelevanceCode is a coded representation of the relevance of an address for address determination for goods distribution from a vendor, and may be based on datatype GDT: AddressDeterminationProcessRelevanceCode, with a qualifier of ShipFrom. DeliveryAddressDeterminationProcessRelevanceCode is a coded representation of a relevance of an address for address determination when sending goods, and may be based on datatype GDT: AddressDeterminationProcessRelevanceCode, with a qualifier of Delivery. PaymentAddressDeterminationProcessRelevanceCode is a coded representation of a relevance of an address for address determination for paying a payee, and may be based on datatype GDT: AddressDeterminationProcessRelevanceCode, with a qualifier of Payment. PaymentAdviceToAddressDeterminationProcessRelevanceCode is a coded representation of the relevance of an address for address determination for sending an announcement of a payment transaction. The announcement specifies a reason for payment. PaymentAdviceToAddressDeterminationProcessRelevanceCode may be based on datatype GDT: AddressDeterminationProcessRelevanceCode, with a qualifier of PaymentAdviceTo. EmployeePrivateAddressDeterminationProcessRelevanceCode is a coded representation of a relevance of an address for address determination for correspondence with an employee using a private address, and may be based on datatype GDT: AddressDeterminationProcessRelevanceCode, with a qualifier of EmployeePrivate. The following specialization associations for navigation may exist: Parent, to the node Address Information, with a target cardinality of 1; and Root, to the node Customer, with a target cardinality of 1.

BankDetails includes bank details of a business partner. Bank details can include account and other information about how and when an account may be used. The elements located directly at the node Bank Details are defined by the data type BusinessPartnerBankDetailsElements. These elements include: ID, BankInternalID, BankDirectoryEntryUUID, BankAccountID, BankAccountIDCheckDigitValue, BankAccountTypeCode, BankAccountHolderName, Name, BankAccountStandardID, SubstituteBusinessPartnerBankDetailsID, SubstituteDate, ValidityPeriod, ProtectedIndicator, and Key.

ID is an identifier that identifies bank details, and may be based on datatype GDT: BusinessPartnerBankDetailsID. BanklnternalID is a bank key that uniquely identifies a bank in a bank master record, and may be based on datatype GDT: BankInternalID. BankDirectoryEntryUUID is a universal unique identifier of a bank with which an account is held, and may be based on datatype GDT: UUID. BankAccountID may be optional, is an account number from the bank details, and may be based on datatype GDT: BankAccountID. BankAccountIDCheckDigitValue may be optional, is a check digit for a bank account number, and may be based on datatype GDT: BankAccountIDCheckDigitValue. BankAccountTypeCode may be optional, specifies a type of bank account, such as a checking account, a loan account, or a savings account, and may be based on datatype GDT: BankAccountTypeCode. BankAccountHolderName may be optional, is a name of an account holder, and may be based on datatype GDT: BankAccountHolderName_V1. Name may be optional, is a name for bank details, which can be different than a name of an account holder and than a name of a bank master record, and may be based on datatype GDT: LANGUAGEINDEPENDENT_MEDIUM_Name. BankAccountStandardID may be optional, is an IBAN (International Bank Account Number) for the bank details, and may be based on datatype GDT: BankAccountStandardID. SubstituteBusinessPartnerBankDetailsID may be optional, is an identifier of new bank details after changing an account, and may be based on datatype GDT: BusinessPartnerBankDetailsID. SubstituteDate may be optional, is a date as of which bank details are replaced by another, and may be based on datatype GDT: Date, with a qualifier of Substitute. ValidityPeriod is a time frame during which bank details are valid, and may be based on datatype GDT: CLOSED_DatePeriod, with a qualifier of Validity. ProtectedIndicator indicates whether bank details are protected, and may be based on datatype GDT: Indicator, with a qualifier of Protected. Key may be an alternative key, is a key for bank details, and may be based on datatype KDT: BusinessPartnerBankDetailsKey. Key can include Key/BusinessPartnerUUID, which is a universally unique identifier of a business partner, and may be based on datatype GDT: UUID. Key can include Key/ID, which is an identifier that identifies bank details, and may be based on datatype GDT: BusinessPartnerBankDetailsID.

A BankDirectoryEntry inbound aggregation relationship may exist from the business object Bank Directory Entry/node Bank Directory Entry, with a cardinality of 1:CN, which is a bank where an account for the bank details is held. The following specialization associations for navigation may exist to the node Customer: Parent, with a target cardinality of 1; and Root, with a target cardinality of 1.

Common includes general information, some or all of which can be time-dependent, for a business partner, which can include, for example, a nationality of a person, and also a year an organization was established along with a legal form. The elements located directly at the node Common are defined by the data type BusinessPartnerCommonElements. These elements include: ValidityPeriod, KeyWordsText, AdditionalKeyWordsText, VerbalCommunicationLanguageCode, SalutationText, CorrespondenceBrailleRequiredIndicator, NaturalPersonIndicator, ContactAllowedCode, BusinessPartnerFormattedName, SortingFormattedName, BusinessPartnerName, LegalCompetenceIndicator, Person, Organisation, and Group. Person can include Person/Name, Person/GenderCode, Person/BirthPlaceName, Person/BirthDate, Person/BirthDateProtectedIndicator, Person/DeathDate, Person/MaritalStatusCode, Person/MaritalStatusProtectedIndicator, Person/NonVerbalCommunicationLanguageCode, Person/OccupationCode, Person/NationalityCountryCode, and Person/OriginCountryCode. Organisation can include Organisation/Name, Organisation/CompanyLegalFormCode, Organisation/FoundationDate, and Organisation/LiquidationDate. Group can include Group/FormOfAddressCode, Group/Name, Group/AdditionalName, and Group/PartnerGroupTypeCode.

ValidityPeriod is a period in which general data is valid, and may be based on datatype GDT: CLOSED_DatePeriod, with a qualifier of Validity. KeyWordsText may be optional, includes additional information that is defined for an object which can be interpreted when searching for the object as an additional search criterion, and may be based on datatype GDT: KeyWordsText. AdditionalKeyWordsText may be optional, includes additional information that is defined for an object which can be interpreted when searching for the object as an additional search criterion, and may be based on datatype GDT: KeyWordsText, with a qualifier of Additional. VerbalCommunicationLanguageCode may be optional, is a language used for a verbal communication with a business partner, and may be based on datatype GDT: LanguageCode, with a qualifier of Communication. SalutationText is a salutation for a business partner that can be used instead of a salutation that is generated for a letter, and may be based on datatype GDT: SalutationText. CorrespondenceBrailleRequiredIndicator indicates whether correspondence with a business partner is required in Braille, and may be based on datatype GDT: Indicator, with a qualifier of CorrespondenceBrailleRequired. NaturalPersonIndicator indicates whether a business partner is regarded as a natural person for the purposes of tax law, and may be based on datatype GDT: Indicator, with a qualifier of NaturalPerson. ContactAllowedCode may be optional, indicates whether a business partner may be contacted, and may be based on datatype GDT: ContactAllowedCode. BusinessPartnerFormattedName may be optional, is a formatted name of a business partner, and may be based on datatype GDT: LANGUAGEINDEPENDENT_LONG_Name, with a qualifier of BusinessPartnerFormatted. SortingFormattedName may be optional, is a formatted name that can be used for sorting business partners, and may be based on datatype GDT: LANGUAGEINDEPENDENT_LONG_Name, with a qualifier of Formatted. BusinessPartnerName may be optional, is a name of a business partner, such as a last name for a person, a first component of an organization name for an organization, or a group name for a group, and may be based on datatype GDT: LANGUAGEINDEPENDENT_MEDIUM_Name, with a qualifier of BusinessPartner. LegalCompetenceIndicator indicates whether a business partner has legal competence, and may be based on datatype GDT: Indicator, with a qualifier of LegalCompetence.

Person includes data for a business partner of the category Person, and may be based on datatype BOIDT: BusinessPartnerCommonPerson. Person/Name is a name of a person, and may be based on datatype GDT: PersonName. Person/GenderCode may be optional, indicates the gender of a person, and may be based on datatype GDT: GenderCode. Person/BirthPlaceName may be optional, is a name of a person's place of birth, and may be based on datatype GDT: LANGUAGEINDEPENDENT_MEDIUM_Name, with a qualifier of BirthPlace. Person/BirthDate may be optional, is a date of birth of a person, and may be based on datatype GDT: Date, with a qualifier of Birth. Person/BirthDateProtectedIndicator indicates whether the date of birth of a person is protected, and may be based on datatype GDT: Indicator, with a qualifier of Protected. Person/DeathDate may be optional, is a date of death of a person, and may be based on datatype GDT: Date, with a qualifier of Death. Person/MaritalStatusCode indicates the marital status of a person, and may be based on datatype GDT: MaritalStatusCode. Person/MaritalStatusProtectedIndicator indicates whether the marital status of a person is protected, and may be based on datatype GDT: Indicator, with a qualifier of Protected. Person/NonVerbalCommunicationLanguageCode may be optional, is a language for correspondence with a person, and may be based on datatype GDT: LanguageCode, with a qualifier of Communication. Person/OccupationCode indicates an occupation of a person, and may be based on datatype GDT: OccupationCode. Person/NationalityCountryCode may be optional, indicates a nationality of a person, and may be based on datatype GDT: CountryCode, with a qualifier of Nationality. Person/OriginCountryCode may be optional, indicates a country of origin for a person, and may be based on datatype GDT: CountryCode, with a qualifier of Origin. Organisation includes data for a business partner of the category Organization, and may be based on datatype BOIDT: BusinessPartnerCommonOrganisation. Organisation/Name is a name of an organization, and may be based on datatype GDT: OrganisationName. Organisation/CompanyLegalFormCode indicates a legal form of an organization, and may be based on datatype GDT: CompanyLegalFormCode. Organisation/FoundationDate may be optional, indicates a date of foundation of an organization, and may be based on datatype GDT: Date, with a qualifier of Foundation. Organisation/LiquidationDate may be optional, is a date of liquidation of an organization, and may be based on datatype GDT: Date, with a qualifier of Liquidation.

Group includes data for a business partner of the category Group, and may be based on datatype BOIDT: BusinessPartnerCommonGroup. Group/FormOfAddressCode is a code for a group salutation, and may be based on datatype GDT: FormOfAddressCode. Group/Name may be optional, is a name of a group, and may be based on datatype GDT: LANGUAGEINDEPENDENT_MEDIUM_Name. Group/AdditionalName may be optional, is an additional group name, and may be based on datatype GDT: LANGUAGEINDEPENDENT_MEDIUM_Name. Group/PartnerGroupTypeCode indicates a type of group, and may be based on datatype GDT: BusinessPartnerPartnerGroupTypeCode. The following composition relationships to subordinate nodes exist: CommonFormattedDefaultAddress, with a cardinality of 1:CN. The following specialization associations for navigation may exist to the node Customer: Parent, with a target cardinality of 1; and Root, with a target cardinality of 1.

In some implementations, if a business partner is a person, the datatypes BusinessPartnerCommonOrganisation and BusinessPartnerCommonGroup do not include any information. In some implementations, if a business partner is an organization, the datatypes BusinessPartnerCommonPerson and BusinessPartnerCommonGroup do not include any information. In some implementations, if the business partner is a group, the datatypes BusinessPartnerCommonPerson and BusinessPartnerCommonOrganisation do not include any information. In some implementations, the elements BusinessPartnerFormattedName, SortingFormattedName and BusinessPartnerName are read-only. In some implementations, the elements BirthDateProtectedIndicator and MaritalStatusProtectedIndicator are visible and can only be maintained in the Employee business object. In some implementations, if the BirthDateProtectedIndicator is set, then the date of birth can be maintained in the Employee business object. The date of birth can be empty and not maintainable in other derived business objects. In some implementations, if the MaritalStatusProtectedIndicator is set, then the marital status can be maintained in the Employee business object. The marital status can be empty and not maintainable in other derived business objects. In some implementations, for every point in time, one common node exists and overlaps are not allowed.

A CommonFormattedDefaultAddress is a formatted standard address of a business partner. The elements located directly at the node Common Formatted Default Address are defined by the inline structure BUP_S_COMMON_FMTD_DEF_ADDR_EL. These elements include: ValidityPeriod, FormattedAddressDescription, FormattedNameAndCityAddressDescription, and FormattedAddress. ValidityPeriod is a period in which a name of a business partner is valid, and may be based on datatype GDT: CLOSED_DatePeriod, with a qualifier of Validity. FormattedAddressDescription may be optional, is a formatted standard address of a business partner, and may be based on datatype GDT: LANGUAGEINDEPENDENT_MEDIUM_Description, with a qualifier of FormattedAddress. FormattedNameAndCityAddressDescription may be optional, is a formatted standard address of a business partner that includes only a name and city, and may be based on datatype GDT: LANGUAGEINDEPENDENT_MEDIUM_Description, with a qualifier of FormattedNameAndCityAddress. FormattedAddress is a formatted standard address of a business partner, which can include, for example, four lines, and may be based on datatype GDT: FormattedAddress. The following specialization associations for navigation may exist: Parent, to the node Common, with a target cardinality of 1; and Root, to the node Customer, with a target cardinality of 1. In some implementations, the elements of the node are read-only. In some implementations, the node is transient.

CurrentBusinessCharacters specifies currently-valid business characters of a business partner and is a Transformation node. Data for the node can be derived from the Role node and changes can likewise be carried out via the Role node. Time restrictions can be applied to validity of the data of the node. “Currently valid” means that the day on which data is determined for the node lies within a validity period.

As an example, suppose for a business character Contact Person two BusinessPartnerRoles “Contact Person for Software” and “Contact Person for Hardware” are created, whereby the latter is a standard assignment. In this example, for business partners who are currently “Contact Person for Software” or “Contact Person for Hardware”, a ContactPersonIndicator can be set. If the indicator is reset a role assignment is also reset. If the indicator is set, then a business partner can be maintained as a “Contact Person for Hardware”.

The elements located directly at the node Current Business Characters are defined by the inline structure APC_S_CURRENT_BUS_CHARACTERS. These elements include PotentialVendorIndicator, VendorIndicator, BidderIndicator, PortalProviderIndicator, InvoicingPartyIndicator, WarehouseProviderIndicator, ContactPersonIndicator, ProspectIndicator, CustomerIndicator, EmployeeIndicator, CompetitorIndicator, CarrierIndicator, FreightForwarderIndicator, SalesAndServicePartnerIndicator, EmployeeFamilyMemberIndicator, HouseBankIndicator, ClearingHouseIndicator, TaxAuthorityIndicator, ServicePerformerIndicator, PayeeIndicator, SocialInsuranceFundHeadOfficeIndicator, SocialInsuranceFundLocalOfficeIndicator, PrivateInsuranceProviderIndicator, and CustomsOfficeIndicator.

PotentialVendorIndicator indicates whether a business partner is a potential vendor, and may be based on datatype GDT: Indicator, with a qualifier of PotentialVendor. VendorIndicator indicates that a business partner is a vendor, and may be based on datatype GDT: Indicator, with a qualifier of Vendor. BidderIndicator indicates that a business partner is a bidder, and may be based on datatype GDT: Indicator, with a qualifier of Bidder. PortalProviderIndicator indicates that a business partner is a portal provider, and may be based on datatype GDT: Indicator, with a qualifier of PortalProvider. InvoicingPartyIndicator indicates that a business partner is an invoicing party, and may be based on datatype GDT: Indicator, with a qualifier of InvoicingParty. WarehouseProviderIndicator indicates that a business partner is a warehouse provider, and may be based on datatype GDT: Indicator. ContactPersonIndicator indicates that a business partner is a contact person, and may be based on datatype GDT: Indicator, with a qualifier of ContactPerson. ProspectIndicator indicates that a business partner is a prospect, and may be based on datatype GDT: Indicator, with a qualifier of Prospect. CustomerIndicator indicates that a business partner is a customer, and may be based on datatype GDT: Indicator, with a qualifier of Customer. EmployeeIndicator indicates that a business partner is an employee, and may be based on datatype GDT: Indicator, with a qualifier of Employee. CompetitorIndicator indicates that a business partner is a competitor, and may be based on datatype GDT: Indicator, with a qualifier of Competitor. CarrierIndicator indicates that a business partner is a carrier, and may be based on datatype GDT: Indicator, with a qualifier of Carrier. FreightForwarderIndicator indicates that a business partner is a freight forwarder, and may be based on datatype GDT: Indicator, with a qualifier of FreightForwarder. SalesAndServicePartnerIndicator indicates that a business partner is a sales and service partner, and may be based on datatype GDT: Indicator, with a qualifier of SalesAndServicePartner. EmployeeFamilyMemberIndicator indicates that a business partner is an employee family member, and may be based on datatype GDT: Indicator. HouseBankIndicator indicates that a business partner is a house bank, and may be based on datatype GDT: Indicator, with a qualifier of HouseBank. ClearingHouseIndicator indicates that a business partner is a clearing house, and may be based on datatype GDT: Indicator, with a qualifier of ClearingHouse. TaxAuthorityIndicator indicates that a business partner is a tax authority, and may be based on datatype GDT: Indicator, with a qualifier of TaxAuthority. ServicePerformerIndicator indicates that a business partner is a service performer, and may be based on datatype GDT: Indicator, with a qualifier of ServicePerformer. PayeeIndicator indicates that a business partner is a payee, and may be based on datatype GDT: Indicator, with a qualifier of ServicePerformer.

SocialInsuranceFundHeadOfficeIndicator indicates that a business partner is a head office of a social insurance fund, and may be based on datatype GDT: Indicator, with a qualifier of SocialInsuranceFundHeadOffice. SocialInsuranceFundLocalOfficeIndicator indicates that a business partner is a local office of a social insurance fund, and may be based on datatype GDT: Indicator, with a qualifier of SocialInsuranceFundLocalOffice. PrivateInsuranceProviderIndicator indicates that a business partner is a private insurance provider, and may be based on datatype GDT: Indicator, with a qualifier of PrivateInsuranceProvider. CustomsOfficeIndicator indicates that a business partner is a customs office, and may be based on datatype GDT: Indicator, with a qualifier of CustomsOffice. The following specialization associations for navigation may exist to the node Customer: Parent, with a target cardinality of 1; and Root, with a target cardinality of 1. In some implementations, the node is read-only in the projections Employee, House Bank, Clearing House, and Tax Authority.

GeneralProductTaxExemption is a general exemption for a business partner from product tax. General tax exemptions can arise directly from legal regulations and may not be based on business partner tax free certificates. In some implementations, time restrictions do not apply to exemptions. Exemptions can be a basis for a complete or partial exemption from product tax. Product taxes are taxes that are incurred for product-related business cases, such as purchasing, sales, or consumption. The elements located directly at the node General Product Tax Exemption are defined by the inline structure BUP_S_GNRL_PRDCT_TAX_EXMPTN_EL. These elements include: CountryCode, RegionCode, TaxTypeCode, and ReasonCode. CountryCode indicates a country to which a tax exemption applies, and may be based on datatype GDT: CountryCode. RegionCode indicates a region to which a tax exemption applies, and may be based on datatype GDT: RegionCode. TaxTypeCode specifies a type of tax to which a tax exemption refers, and may be based on datatype GDT: TaxTypeCode. ReasonCode is a reason for a tax exemption, and may be based on datatype GDT: TaxExemptionReasonCode. The following specialization associations for navigation may exist to the node Customer: Parent, with a target cardinality of 1; and Root, with a target cardinality of 1.

An Identification includes an alternative identifier for a business partner. Identifiers can be issued, for example, by an institution for administrative purposes such as passport numbers or by a business information company such as Dun and Bradstreet. For the business object Employee, the Identification node can be used for mapping an employee ID and a social security number. The elements located directly at the node Identification are defined by the inline structure BUP_S_IDENTIFICATION_EL. These elements include: PartyidentifierTypeCode, BusinessPartnerID, IdentifierIssuingAgencyName, EntryDate, AreaOfValidityCountryCode, AreaOfValidityRegionCode, ProtectedIndicator, ValidityPeriod, and EmployeeID. PartyidentifierTypeCode is a type of identification number, and may be based on datatype GDT: PartyidentifierTypeCode. BusinessPartnerID is an identification number and may be based on datatype GDT: BusinessPartnerID. IdentifierIssuingAgencyName may be optional and is a name of an agency (e.g., government agency), registry office, company (e.g., Dun and Bradstreet), an organization (e.g., the UN) that issued an identification number. IdentifierIssuingAgencyName may be based on datatype GDT: LANGUAGEINDEPENDENT_MEDIUM_Name, with a qualifier of IdentifierIssuingAgency. EntryDate may be optional, is a date on which an identification number is entered, and may be based on datatype GDT: Date, with a qualifier of Entry. AreaOfValidityCountryCode may be optional, indicates a country where an identification number is valid, and may be based on datatype GDT: CountryCode, with a qualifier of AreaOfValidity. AreaOfValidityRegionCode indicates, for example, a region, state, province, or county where an identification number is valid, and may be based on datatype GDT: RegionCode, with a qualifier of AreaOfValidity. ProtectedIndicator may be optional, indicates whether an identification number is protected, and may be based on datatype GDT: Indicator, with a qualifier of Protected. ValidityPeriod is a period in which an identifier identification number is valid, and may be based on datatype GDT: CLOSED_DatePeriod, with a qualifier of Validity. EmployeeID may be an alternative key, is an ID number of an employee, and may be based on datatype GDT: EmployeeID. The following specialization associations for navigation may exist to the node Customer: Parent, with a target cardinality of 1; and Root, with a target cardinality of 1. In some implementations, the element EmployeeID is read-only.

An IndustrySector includes the industry sector in which a business partner works. An industry sector is a classification of a company according to a main focus of the company's business activities. The elements located directly at the node Industry Sector are defined by the inline structure BUP_S_INDUSTRY_SECTOR_EL. These elements include: IndustryClassificationSystemCode, IndustrialSectorCode, and DefaultIndicator. IndustryClassificationSystemCode indicates an industrial sector system to which an industry sector is assigned, and may be based on datatype GDT: IndustryClassificationSystemCode. Industry sectors are organized in industry sector systems, which can facilitate the assigning of a business partner to an industry sector. IndustrialSectorCode indicates an industry sector to which a business partner is assigned, and may be based on datatype GDT: IndustrialSectorCode. DefaultIndicator may be optional, indicates a standard industry sector within an industry sector system, and may be based on datatype GDT: Indicator, with a qualifier of Default. The following specialization associations for navigation may exist to the node Customer: Parent, with a target cardinality of 1; and Root, with a target cardinality of 1.

Marketing includes data to indicate how a business partner is used in marketing processes. The elements located directly at the node Marketing are defined by the inline structure BUP_S_MARKETING_EL. These elements include NielsenRegionCode, which specifies a region based on geographical subdivisions of a country according to definitions of A. C. Nielsen, and may be based on datatype GDT: NielsenRegionCode. The following specialization associations for navigation may exist to the node Customer: Parent, with a target cardinality of 1; and Root, with a target cardinality of 1.

OperatingHoursInformation includes the business hours of a business partner. Visiting hours, calling hours or goods receiving hours can also be maintained for a business partner. The elements located directly at the node Operating Hours Information are defined by the inline structure BUP_S_OPER_HOURS_INF_EL. These elements include RoleCode, which specifies a type of business hours in question, and may be based on datatype GDT: BUSINESSPARTNER_OperatingHoursRoleCode. The following composition relationships to dependent objects exist: OperatingHours, with a cardinality of 1:1, which includes the business hours of a business partner. Data can be mapped using a dependent object OperatingHours. The following specialization associations for navigation may exist to the node Customer: Parent, with a target cardinality of 1; and Root, with a target cardinality of 1.

PaymentCardDetails includes a relationship of a business partner with a payment or credit card. Such a relationship can include a payment card and other details that describe the significance of a payment card for a business partner. The elements located directly at the node Payment Card Details are defined by the inline structure BUP_S_PAYMENT_CARD_EL. These elements include: ID, PaymentCardTypeCode, PaymentCardUUID, PaymentCardID, PaymentCardHolderName, PaymentCardExpirationDate, PaymentCardExpirationTimePointFormattedText, Note, DefaultIndicator, and Key. ID is an identifier identifying payment card details, and may be based on datatype GDT: BusinessPartnerPaymentCardDetailsID. PaymentCardTypeCode is a type of payment card, and may be based on datatype GDT: PaymentCardTypeCode. PaymentCardUUID is a globally unique identifier for a payment card, and may be based on datatype GDT: UUID. PaymentCardID is an identifier of a payment card, and may be based on datatype GDT: PaymentCardID. PaymentCardHolderName may be optional, is a name of a person to whom a payment card is issued, and may be based on datatype GDT: LANGUAGEINDEPENDENT_MEDIUM_Name, with a qualifier of PaymentCardHolder. PaymentCardExpirationDate may be optional, is a date until which a payment card is valid, and may be based on datatype GDT: Date, with a qualifier of Expiration. PaymentCardExpirationTimePointFormattedText may be optional, is a formatted time point until which a payment card is valid, can be a formatted representation of an expiration date, and may be based on datatype GDT: LANGUAGEINDEPENDENT_Text, with a qualifier of PaymentCardExpirationTimePointFormatted. Note may be optional, is a note concerning payment card details, and may be based on datatype GDT: LANGUAGEINDEPENDENT_SHORT_Note. DefaultIndicator may be optional, indicates a standard payment card, and may be based on datatype GDT: Indicator, with a qualifier of Default. Key may be an alternative key, is an alternative key for payment card details, and may be based on datatype KDT: BusinessPartnerPaymentCardDetailsKey. Key can include Key/BusinessPartnerUUID, which is an identifier of a business partner that is involved in a payment, and may be based on datatype GDT: UUID. A business partner identifier can be retrieved from the Root node. Key can include Key/ID, which is a unique identifier for a payment card of a business partner, and may be based on datatype GDT: BusinessPartnerPaymentCardDetailsID.

A PaymentCard inbound aggregation relationship may exist from the business object Payment Card/node Payment Card, with a cardinality of 1:CN, which is a payment or credit card of a business partner. The following specialization associations for navigation may exist to the node Customer: Parent, with a target cardinality of 1; and Root, with a target cardinality of 1. In some implementations, the element PaymentCardUUID is read-only.

Relationship, which is a transformation node, represents a business partner relationship that is a business-relevant, time-dependent relationship between two business partners. Example business partner relationships include contact person and shareholder relationships. The elements located directly at the node Relationship are defined by the inline structure BUP_S_REL_EL. These elements include: RelationshipBusinessPartnerUUID, RelationshipBusinessPartnerInternalID, RoleCode, SystemAdministrativeData, and Key. RelationshipBusinessPartnerUUID is a universal unique identifier of a business partner with whom a relationship exists, and may be based on datatype GDT: UUID. RelationshipBusinessPartnerInternalID is an identifier of a business partner with whom a relationship exists, and may be based on datatype GDT: BusinessPartnerInternalID, with a qualifier of Relationship. RoleCode determines roles that business partners have in a relationship, and may be based on datatype GDT: BusinessPartnerRelationshipRoleCode. SystemAdministrativeData includes administrative data of a relationship, such as system users and change dates/times, and may be based on datatype GDT: SystemAdministrativeData. Key may be an alternative key, is an alternative key for a business partner relationship, and may be based on datatype KDT: BusinessPartnerRelationshipKey. Key can include Key/BusinessPartnerUUID, which is a universal unique identifier of a business partner, and may be based on datatype GDT: UUID. Key can include Key/RelationshipBusinessPartnerUUID, which is a universal unique identifier of a business partner with whom a relationship exists, and may be based on datatype GDT: UUID. Key can include Key/RoleCode, which determines roles that business partners have in a relationship, and may be based on datatype GDT: BusinessPartnerRelationshipRoleCode.

The following inbound aggregation relationships may exist from the business object Business Partner/node Business Partner: RelationshipBusinessPartner, with a cardinality of 1:CN, which is an association relationship with a business partner with which a relationship exists. The following inbound association relationships may exist: CreationIdentity, from the business object Identity/node Identity, with a cardinality of 1:CN, which is an identity that created a relationship; and LastChangeIdentity, from the business object Identity/node Identity, with a cardinality of 1:CN, which is an identity that last changed a relationship. The following specialization associations for navigation may exist: Business Partner Relationship, to the business object Business Partner Relationship/node Root, with a target cardinality of 1, which is an association to a corresponding business partner relationship; Parent, to the node Customer, with a target cardinality of 1; and Root, to the node Customer, with a target cardinality of 1. In some implementations, a start and end date of a validity period are read-only. A Delete Relationship and Not Saved Relationship Business Partner action deletes a relationship and can also delete a business partner with whom a relationship exists if the business partner has not been saved.

A Role is a business role of a business partner. A role includes a business environment of a business partner and tasks rights and obligations the role is to observe in the environment. The elements located directly at the node Role are defined by the inline structure: BUP_S_ROLE_EL. These elements include: RoleCode, BusinessObjectTypeCode, BusinessCharacterCode, and ValidityPeriod. RoleCode is a role of a business partner, and may be based on datatype GDT: BusinessPartnerRoleCode. BusinessObjectTypeCode may be optional, is a type of business object to which a business partner belongs, and may be based on datatype GDT: BusinessObjectTypeCode. Whether or not a business partner belongs to the business objects derived from the business partner template can depend on a business partner role. For example, if a business partner has a role Employee then the object can belong to the business object Employee and if a business partner has a role Ship-To Party the object can belong to the business object Customer. In some implementations, all business partners belong to the business object Business Partner. A value range can include values of the business objects derived from a business partner template. BusinessCharacterCode indicates a business character that is related to a role code, and may be based on datatype GDT: BUSINESSPARTNER_PartyBusinessCharacterCode. ValidityPeriod is a period in which a business partner has a role, and may be based on datatype GDT: CLOSED_DatePeriod, with a qualifier of Validity. The following specialization associations for navigation may exist to the node Customer: Parent, with a target cardinality of 1; and Root, with a target cardinality of 1. In some implementations, the elements BusinessObjectTypeCode and BusinessCharacterCode and the start and end date of the validity period are read-only. In some implementations, the Role node is read only in the projections Employee, House Bank, Clearing House, and Tax Authority.

A TaxNumber includes an identification issued by tax authorities for those business partners liable for tax. These identifiers can differ from country to country. For example, in Germany, an identifier is represented by a tax number. The elements located directly at the node Tax Number are defined by the inline structure BUP_S_TAX_NUMBER_EL. These elements include: CountryCode, TaxIdentificationNumberTypeCode, and PartyTaxID. CountryCode indicates a country to which a tax number type is assigned, and may be based on datatype GDT: CountryCode. TaxIdentificationNumberTypeCode is a type of tax number assigned to a business partner, and may be based on datatype GDT: TaxIdentificationNumberTypeCode. PartyTaxID is a tax number to which a business partner is assigned, and may be based on datatype GDT: PartyTaxID. The following specialization associations for navigation may exist to the node Customer: Parent, with a target cardinality of 1; and Root, with a target cardinality of 1.

UniformAddressInformation includes a business partner address in a uniform format. Within a business partner, different address types that are located at separate nodes can exist. Within the UniformAddressInformation node all such addresses can be displayed in a uniform format. For example, a telephone number of all address types can be displayed at a Telephone node and a city name of all addresses can be found in a PostalAddress node of the business object UsedAddress. The elements located directly at the node Uniform Address Information are defined by the inline structure BUP_S_CUR_UNIFORM_ADDR_INF. These elements include: HostTypeCode, AddressUUID, BusinessPartnerUUID, RelationshipBusinessPartnerUUID, AddressProtectedIndicator, ValidityPeriod, and Key. HostTypeCode is a type code of an address, and may be based on datatype GDT: AddressHostTypeCode. AddressUUID is a universal unique identifier of an address, and may be based on datatype GDT: UUID. If an address is a partner address the UUID of node AddressInformation can be displayed. If the address is an employee workplace address the UUID of the node EmployeeWorkplaceAddressInformation can be displayed. If the address is a contact person or service performer relationship workplace address, the UUID of the node RelationshipContactPersonWorkplaceAddressInformation or RelationshipServicePerformerWorkplaceAddressInformation can be displayed, respectively. BusinessPartnerUUID is a universal unique identifier of a business partner, and may be based on datatype GDT: UUID. If address independent communication data or a workplace address of a contact person or service performer is displayed, then the BusinessPartnerUUID element can be filled with the UUID of the business partner. For all other address types the BusinessPartnerUUID element can be empty. RelationshipBusinessPartnerUUID is a universal unique identifier of a business partner with whom a relationship exists, and may be based on datatype GDT: UUID. If the workplace address of a contact person or service performer is displayed, then the RelationshipBusinessPartnerUUID element can be filled with the UUID of a relationship business partner. For all other address types the RelationshipBusinessPartnerUUID element can be empty. AddressProtectedIndicator specifies whether an address is protected, may be based on datatype GDT: Indicator, with a qualifier of Protected, and can be derived from the element ProtectedIndicator of the AddressInformation node. ValidityPeriod is a period in which an address is valid, may be based on datatype GDT: CLOSED_DatePeriod, with a qualifier of Validity, and can be derived from the element ProtectedIndicator of the AddressInformation node. Key may be an alternative key, is an alternative key of an address, and may be based on datatype KDT: BusinessPartnerUniformAddressInformationKey. Key can include Key/HostTypeCode, which is a type code of an address and may be based on datatype GDT: AddressHostTypeCode. Key can include Key/AddressUUID, which is a universal unique identifier of an address of a business partner and may be based on datatype GDT: UUID. Key can include Key/BusinessPartnerUUID, which is a universal unique identifier of a business partner and may be based on datatype GDT: UUID.

The following composition relationships to subordinate nodes exist: UniformAddressUsage, with a cardinality of 1:CN. An AddressInformation inbound aggregation relationship may exist from the business object Customer/node Address Information, with a cardinality of C:1, which is an association to a business partner address. The following specialization associations for navigation may exist to the business object Address Snapshot/node Root: Address Snapshot, with a target cardinality of C, which may be filtered and which is an address snapshot that is related to an address at a given point in time. The filter elements are defined by the inline structure BUP_S_UNIFA_ADDR_SNAPSHOT_F_EL. These elements include ValidityDate, which may be optional and may be based on datatype GDT: Date. The following specialization associations for navigation may exist: Business Partner Relationship Contact Person Workplace Address Information, to the business object Business Partner Relationship/node Contact Person Workplace Address Information, with a target cardinality of C, which is an association to a workplace address of a contact person relationship; Business Partner Relationship Service Performer Workplace Address Information, to the business object Business Partner Relationship/node Service Performer Workplace Address Information, with a target cardinality of C, which is an association to a workplace address of a service performer relationship; Parent, to the node Customer, with a target cardinality of 1; Root, to the node Customer, with a target cardinality of 1; Address Overview, to the business object Used Address/node Overview, with a target cardinality of 1, which is an address overview that includes address overview data and which can be read only; and Address, to the business object Used Address/node Used Address, with a target cardinality of 1, which can include address data and can be read-only. In some implementations, the elements of the node are read-only. In some implementations, a relationship workplace address is displayed for a person and not for an organisation.

UniformAddressUsage includes business, time-dependent usage of an address. An address can be used as a correspondence, delivery or bill-to party address for example. The elements located directly at the node Uniform Address Usage are defined by the inline structure BUP_S_UNIFORM_ADDR_USAGE. These elements include: AddressUsageCode, ValidityPeriod, and DefaultIndicator. AddressUsageCode specifies a usage type of an address, such as a delivery or holiday address, and may be based on datatype GDT: AddressUsageCode. ValidityPeriod is a period during which an address may have a certain usage, and may be based on datatype GDT: CLOSED_DatePeriod, with a qualifier of Validity. DefaultIndicator may be optional, indicates a standard address within an address usage type, and may be based on datatype GDT: Indicator, with a qualifier of Default. If several addresses are assigned to an address usage at one specific time, an address can be indicated as a default address. The following specialization associations for navigation may exist: Root, to the node Customer, with a target cardinality of 1; and Parent, to the node Uniform Address Information, with a target cardinality of 1. In some implementations, the node is read-only.

A number of implementations have been described. Nevertheless, it will be understood that various modifications may be made without departing from the spirit and scope of the disclosure. Accordingly, other implementations are within the scope of the following claims.

1. A computer readable medium including program code for providing a message-based interface for exchanging information about customers, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for querying information about customer data using a query by identification, the first message including a first message package derived from the common business object model, the first message package hierarchically organized in memory based on the common business object model, the first message package including:
a customer by identification query sync message entity;
a customer selection by identification package, a processing conditions package, and a requested elements package, wherein the customer selection by identification package includes a customer selection by identification entity, wherein the customer selection by identification entity including at least one of the following: one or more selections by internal identifier (ID), one or more selections by unique universal identifier (UUID), one or more selections by category code entity, one or more selections by business partner ID, one or more selections by party identifier type code, one or more selections by business partner name, one or more selections by business partner additional name, one or more selections by sorting formatted name, one or more selections by life cycle status code, and a selection by search text, wherein the processing conditions package including a processing conditions entity, and the requested elements package including a requested elements entity; and
program code for processing the first message according to the hierarchical organization of the first message package, where processing the first message includes unpacking the first message package based on the first message package's structure and the first message package's derivation from the common business object model, wherein the particular structure of the first message package is used at least in part to identify the purpose of the first message; and
program code for sending a second message to the heterogeneous application responsive to the first message, where the second message includes a second message package derived from the common business object model to provide consistent semantics with the first message package.

2. (canceled)

3. The computer readable medium of claim 1, wherein the requested elements entity includes a customer.

4. A distributed system operating in a landscape of computer systems providing message-based services defined in a service registry, the system comprising:
at least one processor operable to execute computer readable instructions embodied on non-transitory media;
a graphical user interface executable by the at least one processor and comprising computer readable instructions, embedded on non-transitory media, for querying information about customer data using a query by identification, the instructions using a request;
a first memory storing a user interface controller executable by the at least one processor for processing the request and involving a message including a first message package derived from a common business object model, where the common business object model includes business objects having relationships that enable derivation of message-based service interfaces and message packages, the first message package hierarchically organized based on the common business object model, the hierarchical organization of the first message package including:
a customer by identification query sync message entity;
a customer selection by identification package, a processing conditions package, and a requested elements package, wherein the customer selection by identification package includes a customer selection by identification entity, wherein the customer selection by identification entity including at least one of the following: one or more selections by internal identifier (ID), one or more selections by unique universal identifier (UUID), one or more selections by category code entity, one or more selections by business partner ID, one or more selections by party identifier party identifier type code, one or more selections by business partner name, one or more selections by business partner additional name, one or more selections by sorting formatted name, one or more selections by life cycle status code, and a selection by search text, wherein the processing conditions package including a processing conditions entity, and the requested elements package including a requested elements entity; and
a second memory, remote from the graphical user interface, storing a plurality of service interfaces executable by the at least one processor and derived from the common business object model to provide consistent semantics with messages derived from the common business object model, wherein one of the service interfaces is operable to process the message via the service interface according to the hierarchical organization of the first message package, where processing the message includes unpacking the first message package based on the first message package's structure and the first message package's derivation from the common business object model, wherein the particular structure of the first message package is used at least in part to identify the purpose of the message.

5. The distributed system of claim 4, wherein the first memory is remote from the graphical user interface.

6. The distributed system of claim 4, wherein the first memory is remote from the second memory.
